(19) United States
(12) Patent Application Publication
(10) Pub. No.: US 2012/0295815 A1
(43) Pub. Date: Nov. 22, 2012

(54) DIAGNOSTIC GENE EXPRESSION PLATFORM

(75) Inventors: Torbjorn Lindahl, Oslo (NO); Praveen Sharma, Oslo (NO)

(73) Assignee: DIAGENIC ASA, Oslo (NO)

(21) Appl. No.: 13/522,137

(22) PCT Filed: Jan. 14, 2011
(86) PCT No.: PCT/EP2011/050493

§ 371 Date: Jul. 13, 2012

(30) Foreign Application Priority Data
Jan. 15, 2010 (GB) 1000688.0

(51) Int. Cl. C40B 40/06; C40B 30/04

(52) U.S. Cl. 506/9; 506/16

(57) ABSTRACT

The invention provides a set of oligonucleotide probes specific to cancer, preferably breast cancer, kits containing them and their use in preparing standard and test patterns and methods of diagnosis of cancer, preferably breast cancer.

The present invention relates to oligonucleotide probes, for use in assessing gene transcript levels in a cell, which may be used in analytical techniques, particularly diagnostic techniques. Conveniently the probes are provided in kit form. Different sets of probes may be used in techniques to prepare gene expression patterns and identify, diagnose or monitor different cancers, preferably breast cancer, or stages thereof.

The identification of quick and easy methods of sample analysis for, for example, diagnostic applications, remains the goal of many researchers. End users seek methods which are cost effective, produce statistically significant results and which may be implemented routinely without the need for highly skilled individuals.

The analysis of gene expression within cells has been used to provide information on the state of those cells and importantly the state of the individual from which the cells are derived. The relative expression of various genes in a cell has been identified as reflecting a particular state within a body. For example, cancer cells are known to exhibit altered expression of various proteins and the transcripts or the expressed proteins may therefore be used as markers of that disease state.

Thus biopsy tissue may be analysed for the presence of these markers and cells originating from the site of the disease may be identified in other tissues or fluids of the body by the presence of the markers. Furthermore, products of the altered expression may be released into the bloodstream and these products may be analysed. In addition cells which have contacted disease cells may be affected by their direct contact with those cells resulting in altered gene expression and their expression or products of expression may be similarly analysed.

However, there are some limitations with these methods. For example, the use of specific tumour markers for identifying cancer suffers from a variety of defects, such as lack of specificity or sensitivity, association of the marker with disease states besides the specific type of cancer, and difficulty of detection in asymptomatic individuals.

In addition to the analysis of one or two marker transcripts or proteins, more recently, gene expression patterns have been analysed. Most of the work involving large-scale gene expression analysis with implications in disease diagnosis has involved clinical samples originating from diseased tissues or cells. For example, several publications, which demonstrate that gene expression data can be used to distinguish between similar cancer types, have used clinical samples from diseased tissues or cells (Alon et al. 1999, PNAS, 96, p 6745-6750; Golub et al. 1999, Science, 286, p 531-537; Alizadeh et al, 2000, Nature, 403, p 503-511; Bittner et al., 2000, Nature, 406, p 536-540).

However, these methods have relied on analysis of a sample containing diseased cells or products of those cells or cells which have been contacted by disease cells. Analysis of such samples relies on knowledge of the presence of a disease and its location, which may be difficult in asymptomatic patients. Furthermore, samples can not always be taken from the disease site, e.g. in diseases of the brain.

In a finding of great significance, the present inventors identified the previously untapped potential of all cells within a body to provide information relating to the state of the organism from which the cells were derived. WO98/49342 describes the analysis of the gene expression of cells distant from the site of disease, e.g. peripheral blood collected distant from a cancer site. WO04/046382, incorporated herein by reference, describes specific probes for the diagnosis of breast cancer and Alzheimer's disease.

This finding is based on the premise that the different parts of an organism's body exist in dynamic interaction with each other. When a disease affects one part of the body, other parts of the body are also affected. The interaction results from a wide spectrum of biochemical signals that are released from the diseased area, affecting other areas in the body. Although, the nature of the biochemical and physiological changes induced by the released signals can vary in the different body parts, the changes can be measured at the level of gene expression and used for diagnostic purposes.

The physiological state of a cell in an organism is determined by the pattern with which genes are expressed in it. The pattern depends upon the internal and external biological stimuli to which said cell is exposed, and any change either in the extent or in the nature of these stimuli can lead to a change in the pattern with which the different genes are expressed in the cell. There is a growing understanding that by analysing the systemic changes in gene expression patterns in cells in biological samples, it is possible to provide information on the type and nature of the biological stimuli that are acting on them. Thus, for example, by monitoring the expression of a large number of genes in cells in a test sample, it is possible to determine whether their genes are expressed with a pattern characteristic for a particular disease, condition or stage thereof. Measuring changes in gene activities in cells, e.g. from tissue or body fluids is therefore emerging as a powerful tool for disease diagnosis.

Such methods have various advantages. Often, obtaining clinical samples from certain areas in the body that is diseased can be difficult and may involve undesirable invasions in the body, for example biopsy is often used to obtain samples for cancer. In some cases, such as in Alzheimer's disease the diseased brain specimen can only be obtained post-mortem. Furthermore, the tissue specimens which are obtained are often heterogeneous and may contain a mixture of both diseased and non-diseased cells, making the analysis of generated gene expression data both complex and difficult.

It has been suggested that a pool of tumour tissues that appear to be pathogenetically homogeneous with respect to morphological appearances of the tumour may well be highly heterogeneous at the molecular level (Alizadeh, 2000, supra), and in fact might contain tumours representing essentially different diseases (Alizadeh, 2000, supra; Golub, 1999, supra). For the purpose of identifying a disease, condition, or a stage thereof, any method that does not require clinical samples to originate directly from diseased tissues or cells is highly desirable since clinical samples representing a homogeneous mixture of cell types can be obtained from an easily accessible region in the body.

Cancer of the breast is the most common cancer among women worldwide with an estimated 1,300,000 new cases and 465,000 deaths annually. To reduce breast cancer mortality, early detection and appropriate treatment play a key role. This emphasizes the importance of early detection so that treatment can be initiated as early as possible during tumour development. Mammographic screening, physical examination and self examination are the main modalities for breast cancer detection today, but only mammography screening has been shown to reduce mortality.

By the time a tumour is detectable in the breast, either by palpation or mammography, the tumour may have been present for several years and have had the ability to spread to distant organs. The growth rate of breast tumours varies considerably between subjects. Some tumours grow so rapidly that they escape a biannual screening program and hence show clinical symptoms before detection by mammography. In addition, mammographic sensitivity is significantly reduced in women with dense breast tissue, often seen in pre-menopausal women or those receiving menopausal hormone therapy. Due to the low sensitivity of mammography in women with dense breast tissue, other imaging modalities have been introduced in breast cancer screening including ultrasonography and magnetic resonance imaging (MRI). However, ultrasound is very operator-dependent, time-consuming, and is associated with many false positive results. MRI is expensive, and both the high false positives rate, limited resources and lack of universally accepted imagine guidelines restrict the use of MRI in a screening setting. The need for improved methods to accurately detect breast cancer, particularly at an early stage, is highly desirable.

We have now identified a new set of probes of surprising utility for identifying a cancer, preferably breast cancer, including early breast cancer, by gene expression profiling of cells of the individual under investigation, e.g. peripheral blood cells.

In work leading up to this invention, the inventors examined the level of expression of a large number of genes in breast cancer patients relative to normal patients. A considerable number of genes were found to exhibit altered expression and these genes could be classified according to the number of cross validation models in which they exhibited altered expression and were considered informative. Thus, for example, those with 100% frequency of occurrence correlate to those which exhibited altered expression and were considered informative in all cross validation models whereas those with 0% frequency of occurrence exhibited altered expression and were considered informative in at least one of the cross validation models. As such these genes provide a pool from which corresponding probes may be generated, particularly based on their frequency of occurrence, to generate a fingerprint of the expression of these genes in an individual. Since the expression of these genes is altered in the cancer, preferably breast cancer, individual, and may hence be considered informative for that state, the generated fingerprint from the collection of probes is indicative of that disease relative to the normal state.

Thus the invention provides a set of oligonucleotide probes which correspond to genes in a cell whose expression is affected in a pattern characteristic of a cancer, preferably breast cancer, or a stage thereof, wherein said genes are systemically affected by said cancer, preferably breast cancer, or a stage thereof. Preferably said genes are constitutively moderately or highly expressed. Preferably the genes are moderately or highly expressed in the cells of the sample but not in cells from disease (cancer, preferably breast cancer) cells or in cells having contacted such disease cells.

Such probes, particularly when isolated from cells distant to the site of disease, do not rely on the development of disease to clinically recognizable levels and allow detection of cancer, preferably breast cancer, or a stage thereof very early after the onset of said cancer, even years before other subjective or objective symptoms appear.

As used herein “systemically” affected genes refers to genes whose expression is affected in the body without direct contact with a disease cell or disease site and the cells under investigation are not disease cells.

“Contact” as referred to herein refers to cells coming into close proximity with one another such that the direct effect of one cell on the other may be observed, e.g. an immune response, wherein these responses are not mediated by secondary molecules released from the first cell over a large distance to affect the second cell. Preferably contact refers to physical contact, or contact that is as close as is sterically possible, conveniently, cells which contact one another are found in the same unit volume, for example within 1 cm³.

A “disease cell” is a cell manifesting phenotypic changes and is present at the disease site at some time during its life-span, i.e. in the present case a cancer, preferably breast cancer, cell at the tumour site or which has disseminated from the tumour.

“Moderately or highly” expressed genes refers to those present in resting cells in a copy number of more than 30-100 copies/cell (assuming an average 3×10⁵ mRNA molecules in a cell).

Specific probes having the above described properties are provided herein.

Thus in one aspect, the present invention provides a set of oligonucleotide probes, wherein said set comprises at least 10 oligonucleotides wherein each of said 10 oligonucleotides is selected from an oligonucleotide as set forth in Table 5 or derived from a sequence set forth in Table 5, or an oligonucleotide with a complementary sequence to the Table 5 sequence or the derived sequence, or a functionally equivalent oligonucleotide.

Preferably, each of said 10 probes corresponds to a different oligonucleotide as set forth in Table 5, but one or more of said oligonucleotides may be replaced by the corresponding derived, complementary or functionally equivalent oligonucleotide, i.e. replaced with an oligonucleotide that will bind to the same gene transcript. If, for example, only primers are to be used, in all likelihood all oligonucleotides will be derived oligonucleotides, e.g. will be parts of the provided sequences.

The use of such probes in products and methods of the invention, form further aspects of the invention.

Said “derived” oligonucleotides include oligonucleotides derived from the genes corresponding to the sequences provided in those tables. Table 5 provides gene identifiers for the various sequences (i.e. the gene sequence corresponding to the oligonucleotide provided). This is stated in the column entitled “ABI Probe ID” which provides the ABI 1700 identifier. Details of the genes may be obtained from the Panther Classification System for genes, transcripts and proteins (http://www.pantherdb.org/genes). Alternatively details may be obtained directly from Applied Biosystems Inc., CA, USA.

As referred to herein an “oligonucleotide” is a nucleic acid molecule having at least 6 monomers in the polymeric structure, i.e. nucleotides or modified forms thereof. The nucleic acid molecule may be DNA, RNA or PNA (peptide nucleic acid) or hybrids thereof or modified versions thereof, e.g. chemically modified forms, e.g. LNA (Locked Nucleic acid), by methylation or made up of modified or non-natural bases during synthesis, providing they retain their ability to bind to complementary sequences. Such oligonucleotides are used in accordance with the invention to probe target sequences and are thus referred to herein also as oligonucleotide probes or simply as “probes”.

“Probes” as referred to herein are oligonucleotides which bind to the relevant transcript and which allow the presence or amount of the target molecule to which they bind to be detected. Such probes may be, for example probes which act as a label for the target molecule (referred to hereinafter as labelling probes) or which allow the generation of a signal by another means, e.g. a primer.

As referred to herein a “labelling probe” refers to a probe which binds to the target sequence such that the combined target sequence and labelling probe carries a detectable label or which may otherwise be assessed by virtue of the formation of that association. For example, this may be achieved by using a labelled probe or the probe may act as a capture probe of labelled sequences as described hereinafter.

When used as a primer, the probe binds to the target sequence and optionally together with another relevant primer allows the generation of an amplification product indicative of the presence of the target sequence which may then be assessed and/or quantified. The primer may incorporate a label or the amplification process may otherwise incorporate or reveal a label during amplification to allow detection. Any oligonucleotides which bind to the target sequence and allow the generation of a detectable signal directly or indirectly are encompassed.

“Primers” refer to single or double-stranded oligonucleotides which hybridize to the target sequence and under appropriate conditions (i.e. in the presence of nucleotides and an inducing agent such as a DNA polymerase and at a suitable temperature and pH) act as a point of initiation of synthesis to allow amplification of the target sequence through elongation from the primer sequence e.g. via PCR.

In primer based methods, preferably real time quantitative PCR is used as this allows the efficient detection and quantification of small amounts of RNA in real time. The procedure follows the general RT-PCR principle in which mRNA is first transcribed to cDNA which is then used to amplify short DNA sequences with the help of sequence specific primers. Two common methods for detection of products in real-time PCR are: (1) non-specific fluorescent dyes that intercalate with any double-stranded DNA, for example SYBR green dye and (2) sequence-specific DNA probes consisting of oligonucleotides that are labelled with a fluorescent reporter which permits detection only after hybridization of the probe with its complementary DNA target for example the ABI TaqMan System (which is discussed in more detail in the Examples).

An “oligonucleotide derived from a sequence as set forth in Table 5” (or any other table) includes a part of a sequence disclosed in that Table or its complementary sequence, which satisfies the requirements of the oligonucleotide probes as described herein, e.g. in length and function. Preferably said parts have the size described hereinafter, for probes (including primers) of a suitable size for use in the invention. Thus derived oligonucleotides includes probes such as primers which correspond to a part of the disclosed sequence or the complementary sequence. More than one oligonucleotide may be derived from the sequence, e.g. to generate a pair of primers and/or a labelling probe.

As mentioned above, “derived” oligonucleotides also include oligonucleotides derived from the genes corresponding to the sequences (i.e. the presented oligonucleotides or the listed gene sequences) provided in those tables. In this case the oligonucleotide forms a part of the gene sequence of which the sequence provided in Table 5 is a part. Table 5 provides ABI 1700 gene identifiers and thus the derived oligonucleotide may form a part of said gene (or its transcript) or a complementary sequence thereof. Thus, for example, labelling probe or primer sequences may be derived from anywhere on the gene to allow specific binding to that gene or its transcript.

Preferably the oligonucleotide probes forming said set are at least 15 bases in length to allow binding of target molecules. Especially preferably said oligonucleotide probes are at least 10, 20, 30, 40 or 50 bases in length, but less than 200, 150, 100 or 50 bases, e.g. from 20 to 200 bases in length, e.g. from 30 to 150 bases, preferably 50-100 bases in length.

When that probe is a primer, similar considerations apply, but preferably said primers are from 10-30 bases in length, e.g. from 15-28 bases, e.g. from 20-25 bases in length. Usual considerations apply in the development of primers, e.g. preferably the primers have a G+C content of 50-60% and should end at the 3′-end in a G or C or CG or GC to increase efficiency, the 3′-ends should not be complementary to avoid primer dimers, primer self-complementarity should be avoided and runs of 3 or more Cs or Gs at the 3′ ends should be avoided. Primers should be of sufficient length to prime the synthesis of the desired extension product in the presence of the inducing agent.

To identify appropriate primers for performance of the invention, the gene sequences or probe sequences provided in the Table may be used to design primers or probes. Preferably said primers are generated to amplify short DNA sequences (e.g. 75 to 600 bases). Preferably short amplicons are amplified, e.g. preferably 75-150 bases. The probes and primers can be designed within an exon or may span exon junction. For example, Table 5 provides the ABI microarray probe ID and this may be used to identify corresponding ABI Taqman assay ID using Panther Classification System for Genes, transcripts and Proteins (http//www.pantherdb.org/genes) Once Taqman assays has been identified they can then be obtained from the supplier. Alternatively, the gene names and gene symbols can be used to identify the corresponding gene sequences in public databases, for example The National Center for Biotechnology Information (http://www.ncbi.nlm.nih.gov/). Alternatively, the oligonucleotide nucleotide sequences provided may be used to identify corresponding gene and transcript by aligning them to known sequences using Nucleotide Blast (Blastn) program at NCBI. Using the gene or transcript sequence, primers and probes can be designed by using freely or commercially available programs for oligonucleotide and primer design, for example The Primer Express Software by Applied Biosystems.

As referred to herein the term “complementary sequences” refers to sequences with consecutive complementary bases (i.e. T:A, G:C) and which complementary sequences are therefore able to bind to one another through their complementarity.

Reference to “10 oligonucleotides” refers to 10 different oligonucleotides. Whilst a Table 5 oligonucleotide, a Table 5 derived oligonucleotide and their functional equivalent are considered different oligonucleotides, complementary oligonucleotides are not considered different. Preferably however, the at least 10 oligonucleotides are 10 different Table 5 oligonucleotides (or Table 5 derived oligonucleotides or their functional equivalents). Thus said 10 different oligonucleotides are preferably able to bind to 10 different transcripts.

Preferably said oligonucleotides are as set forth in Table 5 or are derived from a sequence set forth in Table 5. Said derived oligonucleotides include oligonucleotides derived from the genes corresponding to the sequences provided in those tables, or the complementary sequences thereof.

In a preferred aspect, said oligonucleotides are as set forth in Table 7C or 8B or are derived from a sequence set forth in Table 7C or 8B. Oligonucleotides set forth in Table 7C are the oligonucleotides which appear in that table. Oligonucleotides set forth in Table 8B are the oligonucleotides set forth in Table 5 for which the ABI Nos of Table 5 are given in Table 8B (i.e. the oligonucleotides of Table 8B are obtained by cross-reference to Table 5). The sequences set forth in Tables 5, 7C and 8B include the provided oligonucleotide sequences as well as the gene sequences for which the gene identifier (ABI No.) is given. Said derived oligonucleotides include oligonucleotides derived from the genes corresponding to the sequences provided in those tables, or the complementary sequences thereof. Tables 7C and 8B offer a subset of probes from Table 5 which are identified by their ID Nos from Table 5. References herein to Table 5 may be considered similarly to apply also to Table 7C or 8B.

Especially preferably, the oligonucleotides are selected on the basis of their frequency of occurrence as set out in Table 5, 7C or 8B (frequency of occurrence information for the sequences of Table 8B may be derived from the corresponding sequences in Table 5). Thus, preferably, said set of probes are selected from those in Table 5, 7C or 8B having at least 10%, 20%, 30%, 40%, 50%, 60%, 70%, 80% or 100% occurrence. In a particularly preferred aspect all oligonucleotides in the set have the above % occurrence (or are derived from such oligonucleotides). In an alternative embodiment, the oligonucleotides in the set may have 0, 10, 20, 30, 40, 50, 60, 70, 80, 90 or 100% occurrence, i.e. the probes in Table 5, 7C or 8B fall into 11 sub-groups from which sets may be selected and preferably all the oligonucleotides in the set have this % occurrence.

In a preferred embodiment, said set contains all of the probes (i.e. oligonucleotides) of Table 5, 7C or 8B (or their derived, complementary sequences, or functional equivalents) or of the sub-sets described above. Thus in one aspect the set may contain all of the probes of Table 5, 7C or 8B (or their derived, complementary sequences, or functional equivalents), or in another aspect the set may contain all the probes (or their derived, complementary sequences, or functional equivalents) having 0, 10, 20, 30, 40, 50, 60, 70, 80, 90 or 100% occurrence or in another aspect may contain all of the probes (or their derived, complementary sequences, or functional equivalents) having at least 0, 10, 20, 30, 40, 50, 60, 70, 80, 90 or 100% occurrence in the tables. In a preferred aspect the sets consist of only the above described probes (or their derived, complementary sequences, or functional equivalents).

A “set” as described refers to a collection of unique oligonucleotide probes (i.e. having a distinct sequence) and preferably consists of less than 1000 oligonucleotide probes, especially less than 500, 400, 300, 200 or 100 probes, and preferably more than 10, 20, 30, 40 or 50 probes, e.g. preferably from 10 to 500, e.g. 10 to 100, 200 or 300, especially preferably 20 to 100, e.g. 30 to 100 probes. In some cases less than 10 probes may be used, e.g. from 2 to 9 probes, e.g. 5 to 9 probes.

It will be appreciated that increasing the number of probes will prevent the possibility of poor analysis, e.g. misdiagnosis by comparison to other diseases which could similarly alter the expression of the particular genes in question. Other oligonucleotide probes not described herein may also be present, particularly if they aid the ultimate use of the set of oligonucleotide probes. However, preferably said set consists only of said Table 5, 7C or 8B oligonucleotides, Table 5, 7C or 8B derived oligonucleotides, complementary sequences or functionally equivalent oligonucleotides, or a sub-set (e.g. of the size and type as described above) thereof.

Multiple copies of each unique oligonucleotide probe, e.g. 10 or more copies, may be present in each set, but constitute only a single probe.

A set of oligonucleotide probes, which may preferably be immobilized on a solid support or have means for such immobilization, comprises the at least 10 oligonucleotide probes selected from those described hereinbefore. As mentioned above, these 10 probes must be unique and have different sequences. Having said this however, two separate probes may be used which recognize the same gene but reflect different splicing events. However oligonucleotide probes which are complementary to, and bind to distinct genes are preferred.

When probes of the set are primers, in a preferred aspect pairs of primers are provided. In such cases the reference to the oligonucleotides that should be present (e.g. 10 oligonucleotides) should be scaled up accordingly, i.e. 20 oligonucleotides which correspond to 10 pairs of primers, each pair being specific for a particular target sequence. In a further alternative, the probes of the set may comprise both labelling probes and primers directed to a single target sequence (e.g. for the Taqman assay described in more detail hereinafter). In this case the reference to oligonucleotides that should be present (e.g. 10 oligonucleotides) should be scaled up to 30 oligonucleotides, i.e. 10 pairs of primers and a corresponding relevant labelled probe for a particular target sequence.

Thus in a preferred aspect the set of the invention comprises at least 20 oligonucleotides and said set comprises pairs of primers in which each oligonucleotide in said pair of primers binds to the same transcript or its complementary sequence and preferably each of the pairs of primers bind to a different transcript. In a further preferred aspect the invention provides a set of oligonucleotide probes which comprises at least 30 oligonucleotides and said set comprises pairs of primers and a labelled probe for each pair of primers in which each oligonucleotide in said pair of primers and said labelled probe bind to the same transcript or its complementary sequence and preferably each of the pairs of primers and the labelled probe bind to different transcripts. The labelled probe is “related” to its pair of primers insofar as the primers bind up or downstream of the target sequence to which the labelled probe binds on the same transcript.

As described herein a “functionally equivalent” oligonucleotide to those set forth in Table 5 or derived therefrom refers to an oligonucleotide which is capable of identifying the same gene as an oligonucleotide of Table 5 or derived therefrom, i.e. it can bind to the same mRNA molecule (or DNA) transcribed from a gene (target nucleic acid molecule) as the Table 5 oligonucleotide or the Table 5 derived oligonucleotide (or its complementary sequence). Preferably said functionally equivalent oligonucleotide is capable of recognizing, i.e. binding to the same splicing product as a Table 5 oligonucleotide or a Table 5 derived oligonucleotide. Preferably said mRNA molecule is the full length mRNA molecule which corresponds to the Table 5 oligonucleotide or the Table 5 derived oligonucleotide.

As referred to herein “capable of binding” or “binding” refers to the ability to hybridize under conditions described hereinafter.

Alternatively expressed, functionally equivalent oligonucleotides (or complementary sequences) have sequence identity or will hybridize, as described hereinafter, to a region of the target molecule to which molecule a Table 5 oligonucleotide or a Table 5 derived oligonucleotide or a complementary oligonucleotide binds. Preferably, functionally equivalent oligonucleotides (or their complementary sequences) hybridize to one of the mRNA sequences which corresponds to a Table 5 oligonucleotide or a Table 5 derived oligonucleotide under the conditions described hereinafter or has sequence identity to a part of one of the mRNA sequences which corresponds to a Table 5 oligonucleotide or a Table 5 derived oligonucleotide. A “part” in this context refers to a stretch of at least 5, e.g. at least 10 or 20 bases, such as from 5 to 100, e.g. 10 to 50 or 15 to 30 bases.

In a particularly preferred aspect, the functionally equivalent oligonucleotide binds to all or a part of the region of a target nucleic acid molecule (mRNA or cDNA) to which the Table 5 oligonucleotide or Table 5 derived oligonucleotide binds. A “target” nucleic acid molecule is the gene transcript or related product e.g. mRNA, or cDNA, or amplified product thereof. Said “region” of said target molecule to which said Table 5 oligonucleotide or Table 5 derived oligonucleotide binds is the stretch over which complementarity exists. At its largest this region is the whole length of the Table 5 oligonucleotide or Table 5 derived oligonucleotide, but may be shorter if the entire Table 5 sequence or Table 5 derived oligonucleotide is not complementary to a region of the target sequence.

Preferably said part of said region of said target molecule is a stretch of at least 5, e.g. at least 10 or 20 bases, such as from 5 to 100, e.g. 10 to 50 or 15 to 30 bases. This may for example be achieved by said functionally equivalent oligonucleotide having several identical bases to the bases of the Table 5 oligonucleotide or the Table 5 derived oligonucleotide. These bases may be identical over consecutive stretches, e.g. in a part of the functionally equivalent oligonucleotide, or may be present non-consecutively, but provide sufficient complementarity to allow binding to the target sequence.

Thus in a preferred feature, said functionally equivalent oligonucleotide hybridizes under conditions of high stringency to a Table 5 oligonucleotide or a Table 5 derived oligonucleotide or the complementary sequence thereof. Alternatively expressed, said functionally equivalent oligonucleotide exhibits high sequence identity to all or part of a Table 5 oligonucleotide. Preferably said functionally equivalent oligonucleotide has at least 70% sequence identity, preferably at least 80%, e.g. at least 90, 95, 98 or 99%, to all of a Table 5 oligonucleotide or a part thereof. As used in this context, a “part” refers to a stretch of at least 5, e.g. at least 10 or 20 bases, such as from 5 to 100, e.g. 10 to 50 or 15 to 30 bases, in said Table 5 oligonucleotide. Especially preferably when sequence identity to only a part of said Table 5 oligonucleotide is present, the sequence identity is high, e.g. at least 80% as described above.

Functionally equivalent oligonucleotides which satisfy the above stated functional requirements include those which are derived from the Table 5 oligonucleotides and also those which have been modified by single or multiple nucleotide base (or equivalent) substitution, addition and/or deletion, but which nonetheless retain functional activity, e.g. bind to the same target molecule as the Table 5 oligonucleotide or the Table 5 oligonucleotide from which they are further derived or modified. Preferably said modification is of from 1 to 50, e.g. from 10 to 30, preferably from 1 to 5 bases. Especially preferably only minor modifications are present, e.g. variations in less than 10 bases, e.g. less than 5 base changes.

Within the meaning of “addition” equivalents are included oligonucleotides containing additional sequences which are complementary to the consecutive stretch of bases on the target molecule to which the Table 5 oligonucleotide or the Table 5 derived oligonucleotide binds. Alternatively the addition may comprise a different, unrelated sequence, which may for example confer a further property, e.g. to provide a means for immobilization such as a linker to bind the oligonucleotide probe to a solid support.

Particularly preferred are naturally occurring equivalents such as biological variants, e.g. allelic, geographical or allotypic variants, e.g. oligonucleotides which correspond to a genetic variant, for example as present in a different species.

Functional equivalents include oligonucleotides with modified bases, e.g. using non-naturally occurring bases. Such derivatives may be prepared during synthesis or by post production modification.

“Hybridizing” sequences which bind under conditions of low stringency are those which bind under non-stringent conditions (for example, 6×SSC/50% formamide at room temperature) and remain bound when washed under conditions of low stringency (2×SSC, room temperature, more preferably 2×SSC, 42° C.). Hybridizing under high stringency refers to the above conditions in which washing is performed at 2×SSC, 65° C. (where SSC=0.15M NaCl, 0.015M sodium citrate, pH 7.2).

“Sequence identity” as referred to herein refers to the value obtained when assessed using ClustalW (Thompson et al., 1994, Nucl. Acids Res., 22, p 4673-4680) with the following parameters:

Pairwise alignment parameters—Method: accurate, Matrix: IUB, Gap open penalty: 15.00, Gap extension penalty: 6.66;
Multiple alignment parameters—Matrix: IUB, Gap open penalty: 15.00, % identity for delay: 30, Negative matrix: no, Gap extension penalty: 6.66, DNA transitions weighting: 0.5.

Sequence identity at a particular base is intended to include identical bases which have simply been derivatized.

As described above, conveniently said set of oligonucleotide probes may be immobilized on one or more solid supports. Single or preferably multiple copies of each unique probe are attached to said solid supports, e.g. 10 or more, e.g. at least 100 copies of each unique probe are present.

One or more unique oligonucleotide probes may be associated with separate solid supports which together form a set of probes immobilized on multiple solid support, e.g. one or more unique probes may be immobilized on multiple beads, membranes, filters, biochips etc. which together form a set of probes, which together form modules of the kit described hereinafter. The solid support of the different modules are conveniently physically associated although the signals associated with each probe (generated as described hereinafter) must be separately determinable.

Alternatively, the probes may be immobilized on discrete portions of the same solid support, e.g. each unique oligonucleotide probe, e.g. in multiple copies, may be immobilized to a distinct and discrete portion or region of a single filter or membrane, e.g. to generate an array.

A combination of such techniques may also be used, e.g. several solid supports may be used which each immobilize several unique probes.

The expression “solid support” shall mean any solid material able to bind oligonucleotides by hydrophobic, ionic or covalent bridges.

“Immobilization” as used herein refers to reversible or irreversible association of the probes to said solid support by virtue of such binding. If reversible, the probes remain associated with the solid support for a time sufficient for methods of the invention to be carried out.

Numerous solid supports suitable as immobilizing moieties according to the invention, are well known in the art and widely described in the literature and generally speaking, the solid support may be any of the well-known supports or matrices which are currently widely used or proposed for immobilization, separation etc. in chemical or biochemical procedures. Such materials include, but are not limited to, any synthetic organic polymer such as polystyrene, polyvinylchloride, polyethylene; or nitrocellulose and cellulose acetate; or tosyl activated surfaces; or glass or nylon or any surface carrying a group suited for covalent coupling of nucleic acids. The immobilizing moieties may take the form of particles, sheets, gels, filters, membranes, microfibre strips, tubes or plates, fibres or capillaries, made for example of a polymeric material e.g. agarose, cellulose, alginate, teflon, latex or polystyrene or magnetic beads. Solid supports allowing the presentation of an array, preferably in a single dimension are preferred, e.g. sheets, filters, membranes, plates or biochips.

Attachment of the nucleic acid molecules to the solid support may be performed directly or indirectly. For example if a filter is used, attachment may be performed by UV-induced crosslinking. Alternatively, attachment may be performed indirectly by the use of an attachment moiety carried on the oligonucleotide probes and/or solid support. Thus for example, a pair of affinity binding partners may be used, such as avidin, streptavidin or biotin, DNA or DNA binding protein (e.g. either the lac I repressor protein or the lac operator sequence to which it binds), antibodies (which may be mono- or polyclonal), antibody fragments or the epitopes or haptens of antibodies. In these cases, one partner of the binding pair is attached to (or is inherently part of) the solid support and the other partner is attached to (or is inherently part of) the nucleic acid molecules.

As used herein an “affinity binding pair” refers to two components which recognize and bind to one another specifically (i.e. in preference to binding to other molecules). Such binding pairs when bound together form a complex.

Attachment of appropriate functional groups to the solid support may be performed by methods well known in the art, which include for example, attachment through hydroxyl, carboxyl, aldehyde or amino groups which may be provided by treating the solid support to provide suitable surface coatings. Solid supports presenting appropriate moieties for attachment of the binding partner may be produced by routine methods known in the art.

Attachment of appropriate functional groups to the oligonucleotide probes of the invention may be performed by ligation or introduced during synthesis or amplification, for example using primers carrying an appropriate moiety, such as biotin or a particular sequence for capture.

Conveniently, the set of probes described hereinbefore is provided in kit form.

Thus viewed from a further aspect the present invention provides a kit comprising a set of oligonucleotide probes as described hereinbefore optionally immobilized on one or more solid supports.

Preferably, said probes are immobilized on a single solid support and each unique probe is attached to a different region of said solid support. However, when attached to multiple solid supports, said multiple solid supports form the modules which make up the kit. Especially preferably said solid support is a sheet, filter, membrane, plate or biochip.

Optionally the kit may also contain information relating to the signals generated by normal or diseased samples (as discussed in more detail hereinafter in relation to the use of the kits), standardizing materials, e.g. mRNA or cDNA from normal and/or diseased samples for comparative purposes, labels for incorporation into cDNA, adapters for introducing nucleic acid sequences for amplification purposes, primers for amplification and/or appropriate enzymes, buffers and solutions. Optionally said kit may also contain a package insert describing how the method of the invention should be performed, optionally providing standard graphs, data or software for interpretation of results obtained when performing the invention.

The use of such kits to prepare a standard diagnostic gene transcript pattern as described hereinafter forms a further aspect of the invention.

The set of probes as described herein have various uses. Principally however they are used to assess the gene expression state of a test cell to provide information relating to the organism from which said cell is derived. Thus the probes are useful in diagnosing, identifying or monitoring a cancer, preferably breast cancer, or a stage thereof in an organism.

Thus in a further aspect the invention provides the use of a set of oligonucleotide probes or a kit as described hereinbefore to determine the gene expression pattern of a cell which pattern reflects the level of gene expression of genes to which said oligonucleotide probes bind, comprising at least the steps of:

a) isolating mRNA from said cell, which may optionally be reverse transcribed to cDNA;

b) hybridizing the mRNA or cDNA of step (a) to a set of oligonucleotide probes or a kit as defined herein; and

c) assessing the amount of mRNA or cDNA hybridizing to each of said probes to produce said pattern.

As mentioned previously, the oligonucleotide probes may act as direct labels of the target sequence (insofar as the complex between the target sequence and the probe carries a label) or may be used as primers. In the case of the former step c) may be performed by any appropriate means of detecting the hybridized entity, e.g. if the mRNA or cDNA is labelled the retention of label in a kit may be assessed. In the case of primers, those primers may be used to generate an amplification product which may be assessed. In that case in step b) said probes are hybridized to the mRNA or cDNA and used to amplify the mRNA or cDNA or a part thereof (of the size described herein for parts or preferred sizes for amplicons) and in step c) the amount of amplified product is assessed to produce the pattern.

In the case of techniques in which both primers and labelling probes are used, in the above method the primers and labelling probes are hybridized to the mRNA or cDNA in step b) and used to amplify the mRNA or cDNA or a part thereof. This amplification causes displacement of probes binding to relevant target sequences and the generation of a signal. In this case, in step c) the amount of mRNA or cDNA hybridizing to the probes is assessed by determining the presence or amount of the signal which is generated. Thus in a preferred aspect, said probes are labelling probes and pairs of primers and in step b) said labelling probes and primers are hybridized to said mRNA or cDNA and said mRNA or cDNA or a part thereof is amplified using said primers, wherein when said labelling probe binds to the target sequence it is displaced during amplification thereby generating a signal and in step c) the amount of signal generated is assessed to produce said pattern. All modes of detection of the presence or amount of binding of the probes as described herein to the target sequence are covered by the above described method and methods of the invention described hereinafter.

The mRNA and cDNA as referred to in this method, and the methods hereinafter, encompass derivatives or copies of said molecules, e.g. copies of such molecules such as those produced by amplification or the preparation of complementary strands, but which retain the identity of the mRNA sequence, i.e. would hybridize to the direct transcript (or its complementary sequence) by virtue of precise complementarity, or sequence identity, over at least a region of said molecule. It will be appreciated that complementarity will not exist over the entire region where techniques have been used which may truncate the transcript or introduce new sequences, e.g. by primer amplification. For convenience, said mRNA or cDNA is preferably amplified prior to step b). As with the oligonucleotides described herein said molecules may be modified, e.g. by using non-natural bases during synthesis providing complementarity remains. Such molecules may also carry additional moieties such as signalling or immobilizing means.

The various steps involved in the method of preparing such a pattern are described in more detail hereinafter.

As used herein “gene expression” refers to transcription of a particular gene to produce a specific mRNA product (i.e. a particular splicing product). The level of gene expression may be determined by assessing the level of transcribed mRNA molecules or cDNA molecules reverse transcribed from the mRNA molecules or products derived from those molecules, e.g. by amplification.

The “pattern” created by this technique refers to information which, for example, may be represented in tabular or graphical form and conveys information about the signal associated with two or more oligonucleotides. Preferably said pattern is expressed as an array of numbers relating to the expression level associated with each probe.

Preferably, said pattern is established using the following linear model:

y=Xb+f Equation 1

wherein, X is the matrix of gene expression data and y is the response variable, b is the regression coefficient vector and f the estimated residual vector. Although many different methods can be used to establish the relationship provided in equation 1, especially preferably the partial Least Squares Regression (PLSR) method is used for establishing the relationship in equation 1.

The probes are thus used to generate a pattern which reflects the gene expression of a cell at the time of its isolation. The pattern of expression is characteristic of the circumstances under which that cells finds itself and depends on the influences to which the cell has been exposed. Thus, a characteristic gene transcript pattern standard or fingerprint (standard probe pattern) for cells from an individual with a cancer, preferably breast cancer, or a stage thereof may be prepared and used for comparison to transcript patterns of test cells. This has clear applications in diagnosing, monitoring or identifying whether an organism is suffering from a cancer, preferably breast cancer, or a stage thereof.

The standard pattern is prepared by determining the extent of binding of total mRNA (or cDNA or related product), from cells from a sample of one or more organisms with a cancer, preferably breast cancer, or a stage thereof, to the probes. This reflects the level of transcripts which are present which correspond to each unique probe. The amount of nucleic acid material which binds to the different probes is assessed and this information together forms the gene transcript pattern standard of a cancer, preferably breast cancer, or a stage thereof. Each such standard pattern is characteristic of a cancer, preferably breast cancer, or a stage thereof.

In a further aspect therefore, the present invention provides a method of preparing a standard gene transcript pattern characteristic of a cancer, preferably breast cancer, or a stage thereof in an organism comprising at least the steps of:

a) isolating mRNA from the cells of a sample of one or more organisms having the cancer, preferably breast cancer, or a stage thereof, which may optionally be reverse transcribed to cDNA;

b) hybridizing the mRNA or cDNA of step (a) to a set of oligonucleotides or a kit as described hereinbefore specific for said cancer, preferably breast cancer, or a stage thereof in an organism and sample thereof corresponding to the organism and sample thereof under investigation; and

c) assessing the amount of mRNA or cDNA hybridizing to each of said probes to produce a characteristic pattern reflecting the level of gene expression of genes to which said oligonucleotides bind, in the sample with the cancer, preferably breast cancer, or a stage thereof.

For convenience, said oligonucleotides are preferably immobilized on one or more solid supports.

However, in a preferred aspect, said method is performed using primers which amplify the mRNA or cDNA or a part thereof and the amount of amplified product is assessed to produce the pattern. As described hereinbefore, both labelled probes and primers may be used in preferred aspects of the invention.

The standard pattern for various cancers, preferably breast cancers, and different stages thereof using particular probes may be accumulated in databases and be made available to laboratories on request.

“Disease” samples and organisms or “cancer” samples and organisms as referred to herein refer to organisms (or samples from the same) with abnormal cell proliferation e.g. in a solid mass such as a tumour. Such organisms are known to have, or which exhibit, the cancer (e.g. breast cancer) or stage thereof under study.

“Cancer” as referred to herein includes stomach, lung, breast, prostate gland, bowel, skin, colon and ovary cancer, preferably breast cancer.

“Breast cancer” as referred to herein includes all types of breast cancer including ductal carcinoma in situ (DCIS), lobular carcinoma in situ (LCIS), invasive ductal breast cancer, invasive lobular breast cancer, inflammatory breast cancer, Paget's disease and rare types of breast cancer such as medullary breast cancer, mucinous (mucoid or colloid) breast cancer, tubular breast cancer, adenoid cystic carcinoma of the breast, papillary breast cancer, metaplastic breast cancer, angiosarcoma of the breast, phyllodes or cytosarcoma phyllodes, lymphoma of the breast and basal type breast cancer.

The methods described herein may be used to identify or diagnose whether an individual has any cancer, e.g. any breast cancer, or whether a particular cancer, e.g. particular breast cancer is present by developing the appropriate classification models for those conditions.

“Stages” thereof refer to different stages of cancer which may or may not exhibit particular physiological or metabolic changes, but do exhibit changes at the genetic level which may be detected as altered gene expression. It will be appreciated that during the course of cancer (or its treatment) the expression of different transcripts may vary. Thus at different stages, altered expression may not be exhibited for particular transcripts compared to “normal” samples. However, combining information from several transcripts which exhibit altered expression at one or more stages through the course of the cancer can be used to provide a characteristic pattern which is indicative of a particular stage of the cancer. Thus for example different stages in cancer, e.g. pre-stage I (e.g. stage 0), stage I, stage II, II or IV can be identified. In preferred aspects, the methods described herein may be used to detect stage 0 cancers, e.g. in the case of breast cancer, DCIS or LCIS, e.g. before the breast shows any signs of metastasis and/or has moved beyond the breast ducts and can be used to distinguish between different stages of the disease.

“Normal” as used herein refers to organisms or samples which are used for comparative purposes. Preferably, these are “normal” in the sense that they do not exhibit any indication of, or are not believed to have, any disease or condition that would affect gene expression, particularly in respect of cancer, e.g. breast cancer for which they are to be used as the normal standard. However, it will be appreciated that different stages of a cancer, preferably breast cancer, may be compared and in such cases, the “normal” sample may correspond to the earlier stage of cancer, preferably breast cancer.

As used herein a “sample” refers to any material obtained from the organism, e.g. human or non-human animal under investigation which contains cells and includes, tissues, body fluid or body waste or in the case of prokaryotic organisms, the organism itself. “Body fluids” include blood, saliva, spinal fluid, semen, lymph. “Body waste” includes urine, expectorated matter (pulmonary patients), faeces etc. “Tissue samples” include tissue obtained by biopsy, by surgical interventions or by other means e.g. placenta. Preferably however, the samples which are examined are from areas of the body not apparently affected by the cancer, preferably breast cancer. The cells in such samples are not disease cells, i.e. cancer cells, have not been in contact with such disease cells and do not originate from the site of the cancer. The “site of disease” is considered to be that area of the body which manifests the disease in a way which may be objectively determined, e.g. a tumour, e.g. in breast cancer the site of disease is the breast. Preferably, peripheral blood is used for diagnosis, and the blood does not require the presence of malignant or disseminated cells from the cancer in the blood.

It will however be appreciated that the method of preparing the standard transcription pattern and other methods of the invention are also applicable for use on living parts of eukaryotic organisms such as cell lines and organ cultures and explants.

As used herein, reference to “corresponding” sample etc. refers to cells preferably from the same tissue, body fluid or body waste, but also includes cells from tissue, body fluid or body waste which are sufficiently similar for the purposes of preparing the standard or test pattern. When used in reference to genes “corresponding” to the probes, this refers to genes which are related by sequence (which may be complementary) to the probes although the probes may reflect different splicing products of expression.

“Assessing” as used herein refers to both quantitative and qualitative assessment which may be determined in absolute or relative terms.

The invention may be put into practice as follows.

To prepare a standard transcript pattern for a cancer, preferably breast cancer, or a stage thereof, sample mRNA is extracted from the cells of tissues, body fluid or body waste according to known techniques (see for example Sambrook et. al. (1989), Molecular Cloning: A laboratory manual, 2nd Ed., Cold Spring Harbor Laboratory Press, Cold Spring Harbor, N.Y.) from an individual or organism with a cancer, preferably breast cancer, or a stage thereof.

Owing to the difficulties in working with RNA, the RNA is preferably reverse transcribed to form first strand cDNA. Cloning of the cDNA or selection from, or using, a cDNA library is not however necessary in this or other methods of the invention. Preferably, the complementary strands of the first strand cDNAs are synthesized, i.e. second strand cDNAs, but this will depend on which relative strands are present in the oligonucleotide probes. The RNA may however alternatively be used directly without reverse transcription and may be labelled if so required.

Preferably the cDNA strands are amplified by known amplification techniques such as the polymerase chain reaction (PCR) by the use of appropriate primers. Alternatively, the cDNA strands may be cloned with a vector, used to transform a bacteria such as E. coli which may then be grown to multiply the nucleic acid molecules. When the sequence of the cDNAs are not known, primers may be directed to regions of the nucleic acid molecules which have been introduced. Thus for example, adapters may be ligated to the cDNA molecules and primers directed to these portions for amplification of the cDNA molecules. Alternatively, in the case of eukaryotic samples, advantage may be taken of the polyA tail and cap of the RNA to prepare appropriate primers.

To produce the standard diagnostic gene transcript pattern or fingerprint for a cancer, preferably breast cancer, or a stage thereof, the above described oligonucleotide probes are used to probe mRNA or cDNA of the diseased sample to produce a signal for hybridization to each particular oligonucleotide probe species, i.e. each unique probe. A standard control gene transcript pattern may also be prepared if desired using mRNA or cDNA from a normal sample. Thus, mRNA or cDNA is brought into contact with the oligonucleotide probe under appropriate conditions to allow hybridization. Alternatively, specific primer sequences for highly and moderately expressed genes can be designed and methods such as quantitative RT-PCR can be used to determine the levels of highly and moderately expressed genes, particularly the genes as described herein. Hence, a skilled practitioner may use a variety of techniques which are known in the art for determining the relative level of mRNA in a biological sample.

When multiple samples are probed, this may be performed consecutively using the same probes, e.g. on one or more solid supports, i.e. on probe kit modules, or by simultaneously hybridizing to corresponding probes, e.g. the modules of a corresponding probe kit.

To identify when hybridization occurs and obtain an indication of the number of transcripts/cDNA molecules which become bound to the oligonucleotide probes, it is necessary to identify a signal produced when the transcripts (or related molecules) hybridize (e.g. by detection of double stranded nucleic acid molecules or detection of the number of molecules which become bound, after removing unbound molecules, e.g. by washing, or by detection of a signal generated by an amplified product).

In order to achieve a signal, either or both components which hybridize (i.e. the probe and the transcript) may carry or form a signalling means or a part thereof. This “signalling means” is any moiety capable of direct or indirect detection by the generation or presence of a signal. The signal may be any detectable physical characteristic such as conferred by radiation emission, scattering or absorption properties, magnetic properties, or other physical properties such as charge, size or binding properties of existing molecules (e.g. labels) or molecules which may be generated (e.g. gas emission etc.). Techniques are preferred which allow signal amplification, e.g. which produce multiple signal events from a single active binding site, e.g. by the catalytic action of enzymes to produce multiple detectable products.

Conveniently the signalling means may be a label which itself provides a detectable signal. Conveniently this may be achieved by the use of a radioactive or other label which may be incorporated during cDNA production, the preparation of complementary cDNA strands, during amplification of the target mRNA/cDNA or added directly to target nucleic acid molecules.

Appropriate labels are those which directly or indirectly allow detection or measurement of the presence of the transcripts/cDNA. Such labels include for example radiolabels, chemical labels, for example chromophores or fluorophores (e.g. dyes such as fluorescein and rhodamine), or reagents of high electron density such as ferritin, haemocyanin or colloidal gold. Alternatively, the label may be an enzyme, for example peroxidase or alkaline phosphatase, wherein the presence of the enzyme is visualized by its interaction with a suitable entity, for example a substrate. The label may also form part of a signalling pair wherein the other member of the pair is found on, or in close proximity to, the oligonucleotide probe to which the transcript/cDNA binds, for example, a fluorescent compound and a quench fluorescent substrate may be used. A label may also be provided on a different entity, such as an antibody, which recognizes a peptide moiety attached to the transcripts/cDNA, for example attached to a base used during synthesis or amplification.

A signal may be achieved by the introduction of a label before, during or after the hybridization step. Alternatively, the presence of hybridizing transcripts may be identified by other physical properties, such as their absorbance, and in which case the signalling means is the complex itself.

The amount of signal associated with each oligonucleotide probe is then assessed. The assessment may be quantitative or qualitative and may be based on binding of a single transcript species (or related cDNA or other products) to each probe, or binding of multiple transcript species to multiple copies of each unique probe. It will be appreciated that quantitative results will provide further information for the transcript fingerprint of a cancer, preferably breast cancer, or a stage thereof which is compiled. This data may be expressed as absolute values (in the case of macroarrays) or may be determined relative to a particular standard or reference e.g. a normal control sample.

Furthermore it will be appreciated that the standard diagnostic gene pattern transcript may be prepared using one or more disease (cancer, preferably breast cancer) samples (and normal samples if used) to perform the hybridization step to obtain patterns not biased towards a particular individual's variations in gene expression.

The use of the probes to prepare standard patterns and the standard diagnostic gene transcript patterns thus produced for the purpose of identification or diagnosis or monitoring of a cancer, preferably breast cancer, or a stage thereof in a particular organism forms a further aspect of the invention.

Once a standard diagnostic fingerprint or pattern has been determined for a cancer, preferably breast cancer, or a stage thereof using the selected oligonucleotide probes, this information can be used to identify the presence, absence or extent or stage of the cancer, preferably breast cancer, in a different test organism or individual.

To examine the gene expression pattern of a test sample, a test sample of tissue, body fluid or body waste containing cells, corresponding to the sample used for the preparation of the standard pattern, is obtained from a patient or the organism to be studied. A test gene transcript pattern is then prepared as described hereinbefore as for the standard pattern.

In a further aspect therefore, the present invention provides a method of preparing a test gene transcript pattern comprising at least the steps of:

a) isolating mRNA from the cells of a sample of said test organism, which may optionally be reverse transcribed to cDNA;

b) hybridizing the mRNA or cDNA of step (a) to a set of oligonucleotides or a kit as described hereinbefore specific for a cancer, preferably breast cancer, or a stage thereof in an organism and sample thereof corresponding to the organism and sample thereof under investigation; and

c) assessing the amount of mRNA or cDNA hybridizing to each of said probes to produce said pattern reflecting the level of gene expression of genes to which said oligonucleotides bind, in said test sample.

In a preferred aspect, said method is performed using primers which amplify the mRNA or cDNA or a part thereof and the amount of amplified product is assessed to produce the pattern. As described hereinbefore, both labelled probes and primers may be used in preferred aspects of the invention.

This test pattern may then be compared to one or more standard patterns to assess whether the sample contains cells which exhibit gene expression indicative of the individual having a cancer, preferably breast cancer, or a stage thereof.

Thus viewed from a further aspect the present invention provides a method of diagnosing or identifying or monitoring a cancer, preferably breast cancer, or a stage thereof in an organism, comprising the steps of:

a) isolating mRNA from the cells of a sample of said organism, which may optionally be reverse transcribed to cDNA;

b) hybridizing the mRNA or cDNA of step (a) to a set of oligonucleotides or a kit as described hereinbefore specific for said cancer, preferably breast cancer, or a stage thereof in an organism and sample thereof corresponding to the organism and sample thereof under investigation;

c) assessing the amount of mRNA or cDNA hybridizing to each of said probes to produce a characteristic pattern reflecting the level of gene expression of genes to which said oligonucleotides bind, in said sample; and

d) comparing said pattern to a standard diagnostic pattern prepared according to the method of the invention using a sample from an organism corresponding to the organism and sample under investigation to determine the degree of correlation indicative of the presence of said cancer, preferably breast cancer, or a stage thereof in the organism under investigation.

The method up to and including step c) is the preparation of a test pattern as described above.

In a preferred aspect, said method is performed using primers which amplify the mRNA or cDNA or a part thereof and the amount of amplified product is assessed to produce the pattern. As described hereinbefore, both labelled probes and primers may be used in preferred aspects of the invention.

As referred to herein, “diagnosis” refers to determination of the presence or existence of a cancer, preferably breast cancer, or a stage thereof in an organism. “Monitoring” refers to establishing the extent of a cancer, preferably breast cancer, particularly when an individual is known to be suffering from cancer, preferably breast cancer, for example to monitor the effects of treatment or the development of cancer, preferably breast cancer, e.g. to determine the suitability of a treatment or provide a prognosis. In a preferred aspect, the patient may be monitored after treatment, e.g. by surgery, radiation and/or chemotherapy to determine the efficacy of the treatment by reversion to normal patterns of expression.

Thus in a preferred aspect the present invention provides a method of monitoring a cancer, preferably breast cancer, or a stage thereof in an organism, comprising the steps of a) to d) as described above wherein said monitoring is performed after treatment of said cancer, preferably breast cancer, in said organism to determine the efficacy of said treatment. The degree of correlation between the pattern generated for the sample and the standard cancer, preferably breast cancer (or stage thereof) will indicate whether gene expression typical of cancer, preferably breast cancer, is still present and hence the success of the treatment. Reversion to normal expression patterns (by comparison with normal standard patterns) are indicative of successful treatment.

The presence of a cancer, preferably breast cancer, or a stage thereof may be determined by determining the degree of correlation between the standard and test samples' patterns. This necessarily takes into account the range of values which are obtained for normal and diseased samples. Although this can be established by obtaining standard deviations for several representative samples binding to the probes to develop the standard, it will be appreciated that single samples may be sufficient to generate the standard pattern to identify a cancer, preferably breast cancer, if the test sample exhibits close enough correlation to that standard. Conveniently, the presence, absence, or extent of a cancer, preferably breast cancer, or a stage thereof in a test sample can be predicted by inserting the data relating to the expression level of informative probes in test sample into the standard diagnostic probe pattern established according to equation 1.

Data generated using the above mentioned methods may be analysed using various techniques from the most basic visual representation (e.g. relating to intensity) to more complex data manipulation to identify underlying patterns which reflect the interrelationship of the level of expression of each gene to which the various probes bind, which may be quantified and expressed mathematically. Conveniently, the raw data thus generated may be manipulated by the data processing and statistical methods described hereinafter, particularly normalizing and standardizing the data and fitting the data to a classification model to determine whether said test data reflects the pattern of a cancer, preferably breast cancer, or a stage thereof.

The methods described herein may be used to identify, monitor or diagnose a cancer, preferably breast cancer, or its stage or progression, for which the oligonucleotide probes are informative. “Informative” probes as described herein, are those which reflect genes which have altered expression in the cancer, preferably breast cancer, in question, or particular stages thereof. Individual probes described herein may not be sufficiently informative for diagnostic purposes when used alone, but are informative when used as one of several probes to provide a characteristic pattern, e.g. in a set as described hereinbefore.

Preferably said probes correspond to genes which are systemically affected by a cancer, preferably breast cancer, or a stage thereof. Especially preferably said genes, from which transcripts are derived which bind to probes of the invention, are moderately or highly expressed. The advantage of using probes directed to moderately or highly expressed genes is that smaller clinical samples are required for generating the necessary gene expression data set, e.g. less than 1 ml blood samples.

Furthermore, it has been found that such genes which are already being actively transcribed tend to be more prone to being influenced, in a positive or negative way, by new stimuli. In addition, since transcripts are already being produced at levels which are generally detectable, small changes in those levels are readily detectable as for example, a certain detectable threshold does not need to be reached.

Thus in a further aspect the present invention provides a set of probes as described hereinbefore for use in diagnosis or identification or monitoring the progression of a cancer, preferably breast cancer, or a stage thereof.

The diagnostic method may be used alone as an alternative to other diagnostic techniques or in addition to such techniques. For example, methods of the invention may be used as an alternative or additive diagnostic measure to diagnosis using imaging techniques such as Magnetic Resonance Imagine (MRI), ultrasound imaging, nuclear imaging or X-ray imaging, for example in the identification and/or diagnosis of tumours.

The methods of the invention may be performed on cells from prokaryotic or eukaryotic organisms which may be any eukaryotic organisms such as human beings, other mammals and animals, birds, insects, fish and plants, and any prokaryotic organism such as a bacteria.

Preferred non-human animals on which the methods of the invention may be conducted include, but are not limited to mammals, particularly primates, domestic animals, livestock and laboratory animals. Thus preferred animals for diagnosis include mice, rats, guinea pigs, cats, dogs, pigs, cows, goats, sheep, horses. Particularly preferably a cancer, preferably breast cancer, of humans is diagnosed, identified or monitored.

As described above, the sample under study may be any convenient sample which may be obtained from an organism. Preferably however, as mentioned above, the sample is obtained from a site distant to the site of disease and the cells in such samples are not disease cells, have not been in contact with such cells and do not originate from the site of the disease. In such cases, although preferably absent, the sample may contain cells which do not fulfil these criteria. However, since the probes of the invention are concerned with transcripts whose expression is altered in cells which do satisfy these criteria, the probes are specifically directed to detecting changes in transcript levels in those cells even if in the presence of other, background cells.

The methods of generating standard and test patterns and diagnostic techniques rely on the use of informative oligonucleotide probes to generate the gene expression data. In some cases it will be necessary to select these informative probes for a particular method, e.g. to diagnose a particular cancer, preferably breast cancer, or stage thereof, from a selection of available probes, e.g. the Table 5 oligonucleotides, the Table 5 derived oligonucleotides, their complementary sequences and functionally equivalent oligonucleotides. Said derived oligonucleotides include oligonucleotides derived from the genes corresponding to the sequences provided in those tables for which gene identifiers are provided. The following methodology describes a convenient method for identifying such informative probes, or more particularly how to select a suitable sub-set of probes from the probes described herein.

Probes for the analysis of a particular cancer, preferably breast cancer, or stage thereof, may be identified in a number of ways known in the prior art, including by differential expression or by library subtraction (see for example WO98/49342). As described in WO04/046382 and as described hereinafter, in view of the high information content of most transcripts, as a starting point one may also simply analyse a random sub-set of mRNA or cDNA species corresponding to the family of sequences described herein and pick the most informative probes from that sub-set. In the present case, probes from which the selection may be made are provided. The following method describes the use of immobilized oligonucleotide probes (e.g. the probes of the invention) to which mRNA (or related molecules) from different samples are bound to identify which probes are the most informative to identify a cancer, preferably breast cancer, e.g. a disease sample. Alternatively, the sub-sets described hereinbefore may be used for the methods described herein. The method below describes how to identify sub-sets of probes from those which are disclosed herein or how to identify additional informative probes that could be used in conjunction with probes disclosed herein. The method also describes the statistical methods used for diagnosis of samples once the probes have been selected.

The immobilized probes can be derived from various unrelated or related organisms; the only requirement is that the immobilized probes should bind specifically to their homologous counterparts in test organisms. Probes can also be derived or selected from commercially available or public databases and immobilized on solid supports, or as mentioned above they can be randomly picked and isolated from a cDNA library and immobilized on a solid support.

The length of the probes immobilised on the solid support should be long enough to allow for specific binding to the target sequences. The immobilised probes can be in the form of DNA, RNA or their modified products or PNAs (peptide nucleic acids). Preferably, the probes immobilised should bind specifically to their homologous counterparts representing highly and moderately expressed genes in test organisms. Conveniently the probes which are used are the probes described herein.

The gene expression pattern of cells in biological samples can be generated using prior art techniques such as microarray or macroarray as described below or using methods described herein. Several technologies have now been developed for monitoring the expression level of a large number of genes simultaneously in biological samples, such as, high-density oligoarrays (Lockhart et al., 1996, Nat. Biotech., 14, p 1675-1680), cDNA microarrays (Schena et al, 1995, Science, 270, p 467-470) and cDNA macroarrays (Maier E et al., 1994, Nucl. Acids Res., 22, p 3423-3424; Bernard et al., 1996, Nucl. Acids Res., 24, p 1435-1442).

In high-density oligoarrays and cDNA microarrays, hundreds and thousands of probe oligonucleotides or cDNAs, are spotted onto glass slides or nylon membranes, or synthesized on biochips. The mRNA isolated from the test and reference samples are labelled by reverse transcription with a red or green fluorescent dye, mixed, and hybridised to the microarray. After washing, the bound fluorescent dyes are detected by a laser, producing two images, one for each dye. The resulting ratio of the red and green spots on the two images provides the information about the changes in expression levels of genes in the test and reference samples. Alternatively, single channel or multiple channel microarray studies can also be performed.

The generated gene expression data needs to be preprocessed since, several factors can affect the quality and quantity of the hybridising signals. For example, variations in the quality and quantity of mRNA isolated from sample to sample, subtle variations in the efficiency of labelling target molecules during each reaction, and variations in the amount of unspecific binding between different microarrays can all contribute to noise in the acquired data set that must be corrected for prior to analysis. For example, measurements with low signal /noise ratio can be removed from the data set prior to analysis.

The data can then be transformed for stabilizing the variance in the data structure and normalized for the differences in probe intensity. Several transformation techniques have been described in the literature and a brief overview can be found in Cui, Kerr and Churchill http://www.jax.org/research/churchill/research/expression/Cui-Transform.pdf. Several methods have been described for normalizing gene expression data (Richmond and Somerville, 2000, Current Opin. Plant Biol., 3, p 108-116; Finkelstein et al., 2001, In “Methods of Microarray Data Analysis. Papers from CAMDA, Eds. Lin & Johnsom, Kluwer Academic, p 57-68; Yang et al., 2001, In “Optical Technologies and Informatics”, Eds. Bittner, Chen, Dorsel & Dougherty, Proceedings of SPIE, 4266, p 141-152; Dudoit et al, 2000, J. Am. Stat. Ass., 97, p 77-87; Alter et al 2000, supra; Newton et al., 2001, J. Comp. Biol., 8, p 37-52). Generally, a scaling factor or function is first calculated to correct the intensity effect and then used for normalising the intensities. The use of external controls has also been suggested for improved normalization.

One other major challenge encountered in large-scale gene expression analysis is that of standardization of data collected from experiments performed at different times. We have observed that gene expression data for samples acquired in the same experiment can be efficiently compared following background correction and normalization. However, the data from samples acquired in experiments performed at different times requires further standardization prior to analysis. This is because subtle differences in experimental parameters between different experiments, for example, differences in the quality and quantity of mRNA extracted at different times, differences in time used for target molecule labelling, hybridization time or exposure time, can affect the measured values. Also, factors such as the nature of the sequence of transcripts under investigation (their GC content) and their amount in relation to the each other determines how they are affected by subtle variations in the experimental processes. They determine, for example, how efficiently first strand cDNAs, corresponding to a particular transcript, are transcribed and labelled during first strand synthesis, or how efficiently the corresponding labelled target molecules bind to their complementary sequences during hybridization. Batch to batch differences in the manufacturing lots is also a major factor for variation in the generated expression data.

Failure to properly address and rectify for these influences leads to situations where the differences between the experimental series may overshadow the main information of interest contained in the gene expression data set, i.e. the differences within the combined data from the different experimental series. Hence, when required the expression data should be batch-adjusted prior to data analysis.

Monitoring the expression of a large number of genes in several samples leads to the generation of a large amount of data that is too complex to be easily interpreted. Several unsupervised and supervised multivariate data analysis techniques have already been shown to be useful in extracting meaningful biological information from these large data sets. Cluster analysis is by far the most commonly used technique for gene expression analysis, and has been performed to identify genes that are regulated in a similar manner, and or identifying new/unknown tumour classes using gene expression profiles (Eisen et al., 1998, PNAS, 95, p 14863-14868, Alizadeh et al. 2000, supra, Perou et al. 2000, Nature, 406, p 747-752; Ross et al, 2000, Nature Genetics, 24(3), p 227-235; Herwig et al., 1999, Genome Res., 9, p 1093-1105; Tamayo et al, 1999, Science, PNAS, 96, p 2907-2912).

In the clustering method, genes are grouped into functional categories (clusters) based on their expression profile, satisfying two criteria: homogeneity—the genes in the same cluster are highly similar in expression to each other; and separation—genes in different clusters have low similarity in expression to each other.

Examples of various clustering techniques that have been used for gene expression analysis include hierarchical clustering (Eisen et al., 1998, supra; Alizadeh et al. 2000, supra; Perou et al. 2000, supra; Ross et al, 2000, supra), K-means clustering (Herwig et al., 1999, supra; Tavazoie et al, 1999, Nature Genetics, 22(3), p. 281-285), gene shaving (Hastie et al., 2000, Genome Biology, 1(2), research 0003.1-0003.21), block clustering (Tibshirani et al., 1999, Tech report Univ Stanford.) Plaid model (Lazzeroni, 2002, Stat. Sinica, 12, p 61-86), and self-organizing maps (Tamayo et al. 1999, supra). Also, related methods of multivariate statistical analysis, such as those using the singular value decomposition (Alter et al., 2000, PNAS, 97(18), p 10101-10106; Ross et al. 2000, supra) or multidimensional scaling can be effective at reducing the dimensions of the objects under study.

However, methods such as cluster analysis and singular value decomposition are purely exploratory and only provide a broad overview of the internal structure present in the data. They are unsupervised approaches in which the available information concerning the nature of the class under investigation is not used in the analysis. Often, the nature of the biological perturbation to which a particular sample has been subjected is known. For example, it is sometimes known whether the sample whose gene expression pattern is being analysed derives from a diseased or healthy individual. In such instances, discriminant analysis can be used for classifying samples into various groups based on their gene expression data.

In such an analysis one builds the classifier by training the data that is capable of discriminating between member and non-members of a given class. The trained classifier can then be used to predict the class of unknown samples. Examples of discrimination methods that have been described in the literature include Support Vector Machines (Brown et al, 2000, PNAS, 97, p 262-267), Nearest Neighbour (Dudoit et al., 2000, supra), Classification trees (Dudoit et al., 2000, supra), Voted classification (Dudoit et al., 2000, supra), Weighted Gene voting (Golub et al. 1999, supra), and Bayesian classification (Keller et al. 2000, Tec report Univ of Washington). Also a technique in which PLS (Partial Least Square) regression analysis is first used to reduce the dimensions in the gene expression data set followed by classification using logistic discriminant analysis and quadratic discriminant analysis (LD and QDA) has been described (Nguyen & Rocke, 2002, Bioinformatics, 18, p 39-50 and 1216-1226).

A challenge that gene expression data poses to classical discriminatory methods is that the number of genes whose expression are being analysed is very large compared to the number of samples being analysed. However in most cases only a small fraction of these genes are informative in discriminant analysis problems. Moreover, there is a danger that the noise from irrelevant genes can mask or distort the information from the informative genes. Several methods have been suggested in literature to identify and select genes that are informative in microarray studies, for example, t-statistics (Dudoit et al, 2002, J. Am. Stat. Ass., 97, p 77-87), analysis of variance (Kerr et al., 2000, PNAS, 98, p 8961-8965), Neighbourhood analysis (Golub et al, 1999, supra), Ratio of between groups to within groups sum of squares (Dudoit et al., 2002, supra), Non parametric scoring (Park et al., 2002, Pacific Symposium on Biocomputing, p 52-63) and Likelihood selection (Keller et al., 2000, supra).

In the methods described herein the gene expression data that has been normalized and standardized is analysed by using Partial Least Squares Regression (PLSR). Although PLSR is primarily a method used for regression analysis of continuous data, it can also be utilized as a method for model building and discriminant analysis using a dummy response matrix based on a binary coding. The class assignment is based on a simple dichotomous distinction such as breast cancer (class 1)/healthy (class 2), or a multiple distinction based on multiple disease diagnosis such as breast cancer (class 1)/ovarian cancer (class 2)/healthy (class 3). The list of diseases for classification can be increased depending upon the samples available corresponding to other cancers or stages thereof.

PLSR applied as a classification method is referred to as PLS-DA (DA standing for Discriminant analysis). PLS-DA is an extension of the PLSR algorithm in which the Y-matrix is a dummy matrix containing n rows (corresponding to the number of samples) and K columns (corresponding to the number of classes). The Y-matrix is constructed by inserting 1 in the kth column and −1 in all the other columns if the corresponding ith object of X belongs to class k. By regressing Y onto X, classification of a new sample is achieved by selecting the group corresponding to the largest component of the fitted, ŷ(x)=(ŷ₁(x), ŷ₂(x), . . . , ŷₖ(x)). Thus, in a −1/1 response matrix, a prediction value below 0 means that the sample belongs to the class designated as −1, while a prediction value above 0 implies that the sample belongs to the class designated as 1.

It is usually recommended to use PLS-DA as a starting point for the classification problem due to its ability to handle collinear data, and the property of PLSR as a dimension reduction technique. Once this purpose has been satisfied, it is possible to use other methods such as Linear discriminant analysis, LDA, that has been shown to be effective in extracting further information, Indahl et al. (1999, Chem. and Intell. Lab. Syst., 49, p 19-31). This approach is based on first decomposing the data using PLS-DA, and then using the scores vectors (instead of the original variables) as input to LDA. Further details on LDA can be found in Duda and Hart (Classification and Scene Analysis, 1973, Wiley, USA).

The next step following model building is of model validation. This step is considered to be amongst the most important aspects of multivariate analysis, and tests the “goodness” of the calibration model which has been built. In this work, a cross validation approach has been used for validation. In this approach, one or a few samples are kept out in each segment while the model is built using a full cross-validation on the basis of the remaining data. The samples left out are then used for prediction/classification. Repeating the simple cross-validation process several times holding different samples out for each cross-validation leads to a so-called double cross-validation procedure. This approach has been shown to work well with a limited amount of data, as is the case in the Examples described here. Also, since the cross validation step is repeated several times the dangers of model bias and overfitting are reduced.

Once a calibration model has been built and validated, genes exhibiting an expression pattern that is most relevant for describing the desired information in the model can be selected by techniques described in the prior art for variable selection, as mentioned elsewhere. Variable selection will help in reducing the final model complexity, provide a parsimonious model, and thus lead to a reliable model that can be used for prediction. Moreover, use of fewer genes for the purpose of providing diagnosis will reduce the cost of the diagnostic product. In this way informative probes which would bind to the genes of relevance may be identified.

We have found that after a calibration model has been built, statistical techniques like Jackknife (Effron, 1982, The Jackknife, the Bootstrap and other resampling plans. Society for Industrial and Applied mathematics, Philadelphia, USA), based on resampling methodology, can be efficiently used to select or confirm significant variables (informative probes). The approximate uncertainty variance of the PLS regression coefficients B can be estimated by:

$${S}^{2} B = {\sum }_{m = 1}^{M} {( ( B - {B}_{m} ) g )}^{2}$$

where
S²B=estimated uncertainty variance of B;
B=the regression coefficient at the cross validated rank A using all the N objects;
Bₘ=the regression coefficient at the rank A using all objects except the object(s) left out in cross validation segment m; and
g=scaling coefficient (here: g=1).

In our approach, Jackknife has been implemented together with cross-validation. For each variable the difference between the B-coefficients Bᵢ in a cross-validated sub-model and Bₜₒₜ for the total model is first calculated. The sum of the squares of the differences is then calculated in all sub-models to obtain an expression of the variance of the Bᵢ estimate for a variable. The significance of the estimate of Bᵢ is calculated using the t-test. Thus, the resulting regression coefficients can be presented with uncertainty limits that correspond to 2 Standard Deviations, and from that significant variables are detected.

No further details as to the implementation or use of this step are provided here since this has been implemented in commercially available software, The Unscrambler, CAMO ASA, Norway. Also, details on variable selection using Jackknife can be found in Westad & Martens (2000, J. Near Inf. Spectr., 8, p 117-124).

The following approach can be used to select informative probes from a gene expression data set:

a) keep out one unique sample (including its repetitions if present in the data set) per cross validation segment;

b) build a calibration model (cross validated segment) on the remaining samples using PLSR-DA;

c) select the significant genes for the model in step b) using the Jackknife criterion;

d) repeat the above 3 steps until all the unique samples in the data set are kept out once (as described in step a). For example, if 75 unique samples are present in the data set, 75 different calibration models are built resulting in a collection of 75 different sets of significant probes;

e) select the most significant variables using the frequency of occurrence criterion in the generated sets of significant probes in step d). For example, a set of probes appearing in all sets (100%) are more informative than probes appearing in only 50% of the generated sets in step d). Such a method is performed in Example 1.

Once the informative probes for a disease have been selected, a final model is made and validated. The two most commonly used ways of validating the model are cross-validation (CV) and test set validation. In cross-validation, the data is divided into k subsets. The model is then trained k times, each time leaving out one of the subsets from training, but using only the omitted subset to compute error criterion, RMSEP (Root Mean Square Error of Prediction). If k equals the sample size, this is called “leave-one-out” cross-validation. The idea of leaving one or a few samples out per validation segment is valid only in cases where the covariance between the various experiments is zero. Thus, one sample at-a-time approach can not be justified in situations containing replicates since keeping only one of the replicates out will introduce a systematic bias to the analysis. The correct approach in this case will be to leave out all replicates of the same samples at a time since that would satisfy assumptions of zero covariance between the CV-segments.

The second approach for model validation is to use a separate test-set for validating the calibration model. This requires running a separate set of experiments to be used as a test set. This is the preferred approach given that real test data are available.

The final model is then used to identify the cancer, preferably breast cancer, or a stage thereof in test samples. For this purpose, expression data of selected informative genes is generated from test samples and then the final model is used to determine whether a sample belongs to a diseased or non-diseased class, i.e. whether the sample is from an individual with the cancer, preferably breast cancer, or a stage thereof.

Preferably a model for classification purposes is generated by using the data relating to the probes identified according to the above described method and/or the probes described hereinbefore. Such oligonucleotides may be of considerable length, e.g. if using cDNA (which is encompassed within the scope of the term “oligonucleotide”). The identification of such cDNA molecules as useful probes allows the development of shorter oligonucleotides which reflect the specificity of the cDNA molecules but are easier to manufacture and manipulate. Preferably the sample is as described previously.

The above described model may then be used to generate and analyse data of test samples and thus may be used for the diagnostic methods of the invention. In such methods the data generated from the test sample provides the gene expression data set and this is normalized and standardized as described above. This is then fitted to the calibration model described above to provide classification.

To identify genes that are expressed in high or moderate amount among the isolated population for use in methods of the invention, the information about the relative level of their transcripts in samples of interest can be generated using several prior art techniques. Both non-sequence based methods, such as differential display or RNA fingerprinting, and sequence-based methods such as microarrays or macroarrays can be used for the purpose. Alternatively, specific primer sequences for highly and moderately expressed genes can be designed and methods such as quantitative RT-PCR can be used to determine the levels of highly and moderately expressed genes. Hence, a skilled practitioner may use a variety of techniques which are known in the art for determining the relative level of mRNA in a biological sample.

Especially preferably the sample for the isolation of mRNA in the above described method is as described previously and is preferably not from the site of disease and the cells in said sample are not disease cells and have not contacted disease cells, for example the use of a peripheral blood sample.

The following examples are given by way of illustration only in which the Figures referred to are as follows:

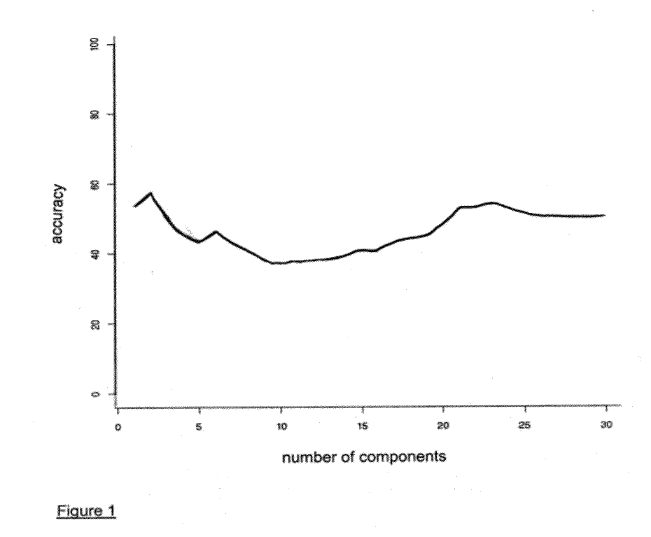

FIG. 1 shows the accuracy of the prediction model across all the PLSR components when probes with a 0% frequency of occurrence are removed from the preprocessed gene expression data (11217 probes);

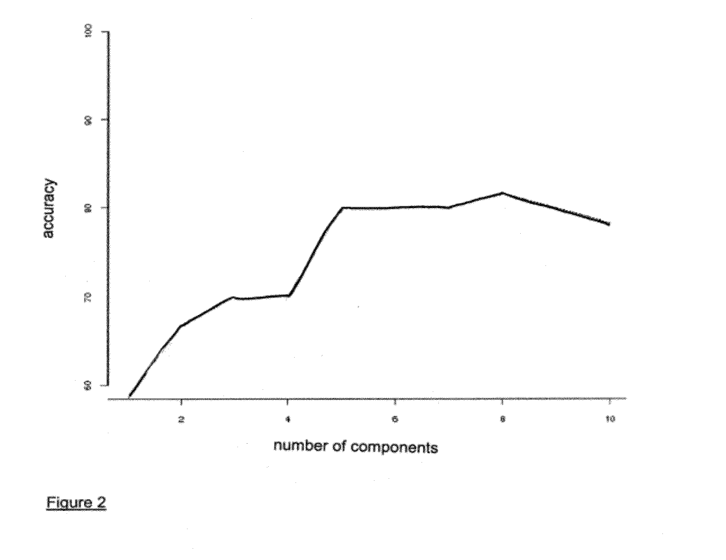

FIG. 2 shows the accuracy of the prediction model across different PLS components using a 96 assay format in TaqMan LDA analysis; and

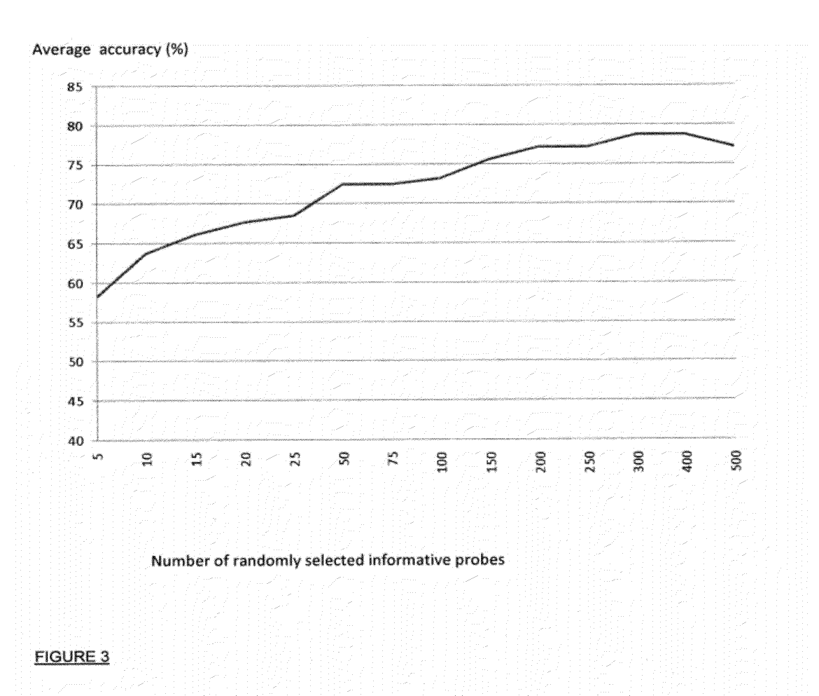

FIG. 3 shows the efficacy of a random selection of 5 or more probes from the Table 5 oligonucleotides and their accuracy in correct classification of breast cancer samples.

### EXAMPLE 1

### Identification of informative probes and their use for diagnosis of breast cancer

### Materials and Methods

### Subject Information and Blood Sampling for Microarray Experiments

Two hundred blood samples were collected between 2002 and 2004 at two Norwegian hospitals (Ullevål University Hospital and Haukeland University Hospital) after written informed consent under approval from the Regional Ethical Committee of Norway (Ref. no. 416-01151). The subjects included were randomly selected from women called in for a second examination after a first suspect screening mammogram. The samples were collected prior to a clinical examination that includes diagnostic mammography and biopsy or fine needle aspiration in the case of a positive mammographic finding. Cytology revealed whether the findings were of malignant or benign origin. For the subjects with no abnormal mammographic findings, the standard of truth was mammography alone.

From each woman, 2.5 ml blood was collected in PAXgene™ tubes (PreAnalytiX, Hombrechtikon, Switzerland) and left overnight at room temperature before storing at −80° C. until use. As a result of method development and testing of various gene expression platforms, only 121 of the 200 samples initially collected were included in this study. The diagnostic mammograms and histopathology reports revealed that out of these 121 women, 57 had invasive breast cancer, 10 had ductal carcinoma in situ (DCIS) and 54 had no sign of malignant disease. Of these latter 54, 12 had benign findings including fibroadenomas, cysts and some unspecified findings (table 1).

Regarding the breast cancer subjects, tumour stage, grade and other relevant clinical data were recorded (tables 1 and 2). The individuals in the test and control groups were balanced in relation to age, menopausal status and previous menopausal hormone therapy (table 3). In addition to the 121 samples, five blood samples were collected from two healthy women at multiple time points (biological replicates), three blood samples from pregnant women, and one sample from a breast feeding healthy woman were collected, leaving 130 samples from 127 individuals for gene expression analysis (table 1).

### Study Design

To control for technical variability such as different microarray production batches, lot variations of reagents and kits, day to day variations and effects related to different laboratory operators, a strict experimental design was followed. Samples were randomly divided into batches of 10, containing equal numbers of samples from women with breast cancer and those with no sign of the disease. All samples within each batch were handled together through each experimental step by one operator alone and the operators were blind to cancer status. Two control samples were included in each batch following the same experimental procedures as the other 10. These control samples were composed of total RNA isolated from one healthy female. The order of the samples within each batch was randomized. In order to correct for any batch variations, we used the batch adjustment method described by Tibshirani (Tibshirani et al., 2002, PNAS, 99, p 6567-6572). A total of 13 batches including 130 samples and 26 technical controls were thus analyzed.

### RNA Extraction

PAXgene™ tubes were thawed overnight in batches of 12 tubes and total RNA was extracted according to the manufacturer's protocol. Total RNA was stored at −80° C. prior to analyses. RNA quality and quantity measures were conducted using the 2100 Bioanalyzer (Agilent Technologies, California, USA) and the NanoDrop ND-1000 spectrophotometer (Thermo Scientific, Delaware, USA) respectively.

### Microarray Procedure

Microarray gene expression studies were conducted using single channel Applied Biosystems Human Genome Survey microarrays v2.0 containing 32,878 probes representing 29,098 genes. From each sample, 500 ng total RNA was amplified and labelled according to the NanoAmp RT-IVT Labeling Kit Protocol and hybridized onto the array for 16 hours at 55° C. Following hybridization, slides were manually washed and prepared according to manufacturers' recommendation before image capturing using the AB1700 reader. Identification and quantification of gene expression signals, signal-to-noise ratios and flagging of failed spots were conducted using the Applied Biosystems Expression System software. Raw data files were exported for further analysis.

### Data Analysis

Data analysis was performed using R(R Development Core Team. R: A Language and Environment for Statistical Computing. 2009) and tools from the Bioconductor project (Gentleman et al., 2004, Genome Biol., 5, R80), adapted to our needs. Data was preprocessed in the following way: data were log 2 transformed while individual measurements with signal-to-noise<3 or flag values>8191 were set as missing. Probes with more than 5% missing values over all 156 arrays were excluded. Preprocessing left 156 samples and 11217 probes for further analyses. Data were standardized (i.e. centred and scaled) and missing values were imputed with k-nearest neighbours imputation (Troyanskaya et al., 2001, Bioinformatics, 17, p 520-525) using k=10. Principal components analysis and ANOVA tests for each gene revealed that there were large batch-effects present in the data. Similar batch effects have previously been reported for the same type of data (Dumeaux V, et al., under revision). Each probe was individually treated for batch effects using a one way ANOVA procedure as described by Tibshirani (Tibshirani et al., 2002, supra). The 26 technical control samples were then excluded. For the biological replicates (multiple samples from one subject), signal intensities were averaged for each probes. Thus, 127 arrays, one from each individual remained for analysis. Finally, within-array normalization was conducted by global mean subtraction.

### Identification of Probes on the Basis of Occurrence Criterion

The processed data obtained above was used to isolate the informative probes by:
a) keeping one unique sample (including all repetitions of the selected sample) out per cross validation segment;
b) building a calibration model (cross validated) on the remaining samples using PLSR-DA;
c) selecting the set of significant genes for the model in step b using the Jackknife criterion;
d) repeating steps a), b) and c) until all the unique samples were kept out once (hence, in all 127 different calibration models were built (after repeating step b) 127 times), resulting in 127 different sets of significant probes (after repeating step c) 127 times));
e) selecting significant variables using the frequency of occurrence criterion amongst the 127 different sets of significant probes.

In the above method the gene expression data served as predictors for predicting a dummy-coded response vector. The response vector was given the value −1 or 1 for each sample depending on it being a healthy control or a breast cancer sample, respectively. A new gene expression sample was classified as diseased if the predicted value was larger than zero and as healthy otherwise.

Partial Least Squares Regression (PLSR) (Nguyen & Rocke, 2002, Bioinformatics, 18, p 1625-1632; Wold: Estimation of principal components and related models by iterative least squares. In Multivariate Analysis. Edited by Krishnaiah PR. New York: Academic Press; 1966, p 391-420) with double cross-validation was used to construct and test our classifier. PLSR with leave-one-out cross-validation (LOO-CV) was used in combination with Jackknife testing (Gidskehaug et al., 2007, BMC Bioinformatics, 8, p 346; Wu: Jackknife, bootstrap and other resampling plans in regression analysis. The Annals of Statistics, 1986, 14, p 1261-1350) to select significant probes. In more detail, LOO-CV gives the optimal number of components and a set of regression coefficients associated with each probe and Jackknife feature selection was used to select probes with regression coefficients different from 0 (p-value≦0.05). A PLSR model was rebuilt on these significant probes and LOO-CV was again used to select the optimal number of components. Finally, the analysis described above was incorporated in an independent loop of LOO-CV in order to test classifier accuracy (Varma & Simon, 2006, BMC Bioinformatics, 7, p 91).

Thus, the selected informative probes based on occurrence criterion were used to construct a classification model. The identified informative probes were grouped based on their frequency of occurrence. For example, probes informative in all of the 127 cross validation models were grouped under 100%, probes informative in only 90% of the cross validation models were grouped under 90%, while probes appearing as informative in at least one cross validation segment were grouped under 0%.

### Results

Table 4, lists the number of probes identified based on frequency of occurrence criterion and the estimated diagnostic accuracy of gene expression signatures based on these probes. In order to avoid any selection bias and to obtain unbiased estimates of accuracy, a triple cross validation approach was used, since the gene selection procedure was based on a inner double cross validation routine. The results show that an accuracy of about 75% is expected from probes grouped between 0-90% following frequency of occurrence criterion.

FIG. 1 show that when 0% probes (probes that have been identified as informative in at least one of the 127 cross validation models) were taken out of the data, the accuracy of a model based on the remaining data significantly drops across all the PLSR components (maximum 57%), indicating that most of the relevant diagnostic information has now been mined out of this data.

Table 5, lists the oligonucleotide sequences of the identified probes and their gene sequences identified by the ABI 1700 number. The probe numbering provided in this table denotes the sequence number for the presented sequences.

### EXAMPLE 2

### Verification of Sub-Sets of the Informative Probes for Different Samples and on Different Platforms

Example 1 led to the identification of a set of gene probes (0%-100% of occurrence) that can be used to construct diagnostically relevant gene expression signatures. However, there could have been questions over the reliability of identified probes in predicting future samples. It is known that variables identified as informative from one particular experiment can be data driven. Apart from depending on the sample cohort being used, the platform used to measure the expression data may also affect data quality. Hence if a set of gene probes has been identified as informative in one platform it need not retain diagnostic relevance if another platform is used for data generation. This is because the platform-specific noise component may vary among the different platforms. Also if the gene expression changes being measured are subtle in nature, small technical differences in processes arising for example due to subtle laboratory to laboratory variations, may also affect the measured value from individual gene probes dictating whether they retain or lose their informational content.

Hence, to test the validity of identified probes under different scenarios we broadened our analysis. To test whether the diagnostic information of identified probes was retained in an independent experiment performed in a different laboratory using a novel sample cohort, we reanalyzed the data of a study where data was generated using a new sample cohort (Table 6A, 40 samples, 20 breast cancer, and 20 non-breast cancer) in a different laboratory but using the same ABI platform.

Table 6B, shows that all the different sets of probes (0%-100%) retained their diagnostic information even when the experiments were performed at a different laboratory and a new sample cohort was used. Diagnostic models were developed using probes that corresponded to 0%-100% probes of study 1 (Example 1) and were present in the new data following preprocessing of the gene expression data (study 2). The accuracy was estimated by cross-validation.

To further test the effect of different platforms we analyzed some of the informative probes that were present on the customized array that we had developed containing certain informative probes identified in study 1 (Example 1). One customized array was based on microarray technology but was provided by a different platform provider (Codelink, GE). The other relied on a quantitative real time PCR technology.

The Codelink study (study 3) included a new and independent cohort of breast cancer and non-breast cancer samples as compared to our previous experiments (Table 7A). 30 mer oligonucleotides were designed for some of the probes listed in Table 5. The probes used are provided in Table 7C which also provides the corresponding gene identified by reference to the ABI 1700 gene identifier (see Table 5).

In cases when it was difficult to design good primers from oligonucleotide sequences provided in Table 5, ABI probe ID, oligonucleotide sequence and gene name was used to identify the relevant transcripts. For some cases multiple oligonucleotides primers were also designed for a specific transcript. This was to make sure that at least one oligonucleotide would efficiently hybridize to its corresponding transcript.

Data preprocessing was mainly as described in Example 1. Table 7B shows the estimated accuracy based on corresponding 0%-100% probes that were present in our customized Codelink platform for all of studies 1 to 3. The results again showed that the different sets of probes (0%-100%) retained their diagnostic informational content even when a different microarray platform was used.

In study 4 a TaqMan protocol was used. The TaqMan system detects PCR products using the 5′ nuclease activity of Taq DNA polymerase on fluorogenic DNA probes during each extension cycle. The Taqman probe (normally 25 mer) is labelled with a fluorescent reporter dye at the 5′-end and a fluorescent quencher dye at the 3′-end. When the probe is intact, the quencher dye reduces the emission intensity of the reporter dye. If the target sequence is present the probe anneals to the target and is cleaved by the 5′ nuclease activity of Taq DNA polymerase as the primer extension proceeds. As the cleavage of the probes separates the reporter dye from the quencher dye, the reporter dye fluorescence increases as a function of PCR cycle number. The greater the initial concentration of the target nucleic acid, the sooner a significant increase in fluorescence is observed.

The “TaqMan probe” consists of a fluorophore covalently attached to the 5′-end of the oligonucleotide probe and a quencher at the 3′-end. Normally, a 25-mer oligonucleotide is preferred but the length can vary. The key point is that the oligonucleotide probe should specifically bind to target sequence. Several different fluorophores (e.g. 6-carboxyfluorescein, acronym: FAM, or tetrachlorofluorescin, acronym: TET) and quenchers (e.g. tetramethylrhodamine, acronym: TAMRA, or dihydrocyclopyrroloindole tripeptide minor groove binder, acronym: MGB) can be used to attach at the respective 5′ and 3′-ends (and these form preferred labels for use in the invention).

For TaqMan LDA, cDNA was prepared from total RNA isolated from 60 samples (Table 8A). Gene expression analysis was conducted on ABI Prism 7900HT Fast System using 384 selected assays, including endogenous controls. Assays with either missing values or an average ct>30 were removed prior to data analysis (166 assays in total). Using the data of 208 assays in TaqMan LDA (see Table 8B which lists the 208 assays linked to their gene identifier (ABI 1700, see Table 5) and function) we identified a limited number of assays suitable for a 96-assay format including assays for normalization and quality control.

FIG. 2 shows the accuracy of a model using the 96 assay format (across different PLS components). At the optimal 5 PLS component, the developed signature correctly predicted the class of 49/60 samples (82%). Again, the results show that diagnostic information was retained in the probes derived from Example 1 (study 1) even when a different platform and technology was used to develop a gene expression signature.

FIG. 3 shows the accuracy of using 5 or more probes randomly selected from Table 5 in correct classification of breast cancer samples.

TABLE 1
Clinical characteristics of the subjects
included in the study (n = 127)

| Diagnosis | Number of samples |
|---|---|
| Total Breast Cancer | 67 |
| Pure DCIS | 10 |
| Invasive Ductal Carcinoma (IDC) | 49 |
| Invasive Lobular Carcinoma (ILC) | 4 |
| Other invasive | 4 |
| Invasive Tubular Carcinoma (ITC) | 2 |
| Medullary Carcinoma | 1 |
| Other/mixed cases | 1 |
| Total Non-malignant | 63* |
| Benign changes | 12 |
| Fibroadenoma | 1 |
| Fibroadenoma and haematoma | 1 |
| Cyst | 6 |
| Unspecified findings | 4 |
| No mammographic findings | 42 |
| Controls | 9 |
| Breast feeding | 1 |
| Pregnant | 3 |
| Menstrual cycle (2 subjects) | 5 |
| Total samples | 130* |

*Data from biological replicates were merged leaving 127 assays for analyses.

TABLE 2
ER and PR status among the 67 breast cancers samples:

| Status | Number of samples |
|---|---|
| ER+/PR+ | 36 |
| ER−/PR− | 7 |
| ER+/PR− | 7 |
| ER−/PR+ | 1 |
| Unknown | 16 |

TABLE 3
Subject demographics

| | Breast Cancer | Healthy |
|---|---|---|
| Demographic information | N = 67 | N = 60 |
| Age | | |
| Mean | 58 | 56 |
| Min | 38 | 37 |
| Max | 82 | 70 |
| Not registered | 9 | 10 |
| Menopausal status | | |
| Pre-menopausal | 14 | 15 |
| Post Menopausal | 37 | 29 |
| Unknown | 16 | 16 |
| Menopausal hormone therapy | | |
| Yes | 13 | 13 |
| No | 54 | 57 |

TABLE 4
Diagnostic accuracy of probes by frequency of occurrence

| | Number of | | | | |
|---|---|---|---|---|---|
| Frequency of | informative | | | | |
| occurrence | probes | Accuracy | Sensitivity | Specificity | AUC |
| 0% | 1511 | 76.38 | 76.12 | 76.67 | 0.85 |
| 10% | 873 | 77.17 | 77.61 | 76.67 | 0.87 |
| 20% | 786 | 78.74 | 80.60 | 76.67 | 0.88 |
| 30% | 748 | 80.31 | 82.09 | 78.33 | 0.89 |
| 40% | 731 | 80.31 | 82.09 | 78.33 | 0.89 |
| 50% | 707 | 78.74 | 79.10 | 78.33 | 0.89 |
| 60% | 677 | 77.95 | 77.61 | 78.33 | 0.89 |
| 70% | 645 | 78.74 | 79.10 | 78.33 | 0.90 |
| 80% | 606 | 78.74 | 79.10 | 78.33 | 0.90 |
| 90% | 538 | 80.31 | 77.61 | 83.33 | 0.90 |
| 100% | 282 | 72.44 | 70.15 | 75.00 | 0.84 |

TABLE 5
Sequences identified

| Probe | | % | | |
|---|---|---|---|---|
| No./ | ABI | (Freq. | | |
| SEQ ID | Probe | of | | |
| No. | ID | occur.) | Oligonucleotide Sequences | Gene name/symbol |
| 1 | 100100 | 0 | AAAAAGAGTTTACGCCTTACGACTACAGCCAGTCAGACTTCAAGGCTTTTGCTGGAAACA | exosome component 10; EXOSC10 |
| 2 | 100348 | 0 | AAAACTGCTGTGAACCTCACAGGCAGGTTAAACAAGTATGGAGTGATCAGGCCCAGATTT | similar to ribosomal protein S15a; unassigned |
| 3 | 100410 | 0 | AAAAGAGCAACAAAGACTCCAGAACCCACTCTACCTCCTCAATCCCTTGGCCATCTGTGG | LOC339483 |
| 4 | 101108 | 0 | AAACTAAAAACTAGGAAAGTGTTAACTATCGTTGCCCACCGAATTTGAGGTAGCAAAAAA | protein kinase D3; PRKD3 |
| 5 | 101835 | 0 | AAAGTAATCATCGTTCAGGCCCAACCCTTAGGTTTAAAAAGTCAGGTTGTCCATCCCATT | checkpoint suppressor 1; CHES1 |
| 6 | 102210 | 0 | AAATGATTCCATGGCTCCCTGTAGTACTTCTACAAAGCATCTATCACAATTGTAATTAAT | Unassigned |
| 7 | 102907 | 0 | AACAGTCATGATGCTATGGACTCCTACTACGACTACATATGGGATGTTACCATTTTGGAA | integrator complex subunit 8; INTS8 |
| 8 | 103366 | 0 | AACCGCGTGGCTGTTTTTGAACTGCCTGGAACCTAAGACCCTGAATTCTTTTCCCCCCCA | MGC16037 |
| 9 | 103423 | 0 | AACCTCACTGAAACCTGCTCCGTGCCCGGATGTTGATCATGCTGGTGGCTTGGTTACTGT | ubiquinol-cytochrome c reductase, 6.4 kDa |
| | | | | subunit; UQCR |
| 10 | 103587 | 0 | AACGCATTCATGAATTTCCAGTGTTCAGTAAATAGCAGCTATGTGTGTGCAAAATAAAAG | fibroblast growth factor binding protein 2; FGFBP2 |
| 11 | 103604 | 0 | AACGCTACAGCGTGGACAAATCTCTCAGCCACCCCTGGTTACAGGAGTACCAGACGTGGC | protein kinase D2; PRKD2 |
| 12 | 103617 | 0 | AACGGATCCATATCAGGAAGACAATCTGAAGAGCAGAGATCTCCAAAAACTAAGCATTTC | 5-azacytidine induced 2; AZI2 |
| 13 | 103944 | 0 | AACTGGACCGCGCACGACAGGACCTGCCCTCTAGCCTCGTGGGTCTGTTCCCCAGGGCCC | Fas (TNFRSF6) binding factor 1; FBF1 |
| 14 | 105417 | 0 | AAGCGGGATCTTGTACTCTCTAAACTGGTCCACAATGTGCATAACCACATCACCAATGAC | chromosome 14 open reading frame 93; C14orf93 |
| 15 | 105431 | 0 | AAGCGTTCATAATAACTTGCGAATTGGCCCTGATGTTCTAGCATGTGATTACTTCACTCC | UBIQUITIN-LIKE PROTEIN SUMO/SMT3-RELATED |
| 16 | 105605 | 0 | AAGGAAACAGGTGACTAGAAGGGCCTGAGGATTACAGTGAACCTGACCATTCAGAACAGA | unassigned |
| 17 | 105816 | 0 | AAGGATGTCATTGAAGAGTATTTCAAATGCAAGAAATGAAGAAATAAATCTTTGGCTCAC | RPS12 |
| 18 | 105950 | 0 | AAGGCTGGACTCCATGACTATATATACATACATCTATCTACATCTGCCTGTGTACACACA | GRB2-related adaptor protein 2; GRAP2 |
| 19 | 105963 | 0 | AAGGCTTCAGAGTAGATATCTCTGCCAATGTGAGGACAGAAGGACTGGTGCGACCCCCCA | unassigned |
| 20 | 105974 | 0 | AAGGGAAAGCTCCCAAAGCATCCTATCATTGTGAAGGCCAAATTCTTCAGAAGAAGAGCA | 60S RIBOSOMAL PROTEIN L27A |
| 21 | 106212 | 0 | AAGGTTTTACTGTCTTAAAGCTGTCTTTCTGAGATCTAATTCCAAGGACTTCTCCACAGC | chromosome 20 open reading frame 108; C20orf108 |
| 22 | 106334 | 0 | AAGTCCAGGGTTGCTTGGTTTACTGGTTTATAAGAAATCTGAAAGCACCTCTGACATTCC | NECAP endocytosis associated 2; NECAP2 |
| 23 | 106517 | 0 | AAGTGTCTGGGCCCTGCCTTCACACCAGCCACACGGGCTGCCTGGAGCCAACTCTACGGG | neuroglobin; NGB |
| 24 | 106796 | 0 | AATACTGAGAGATTTGGTCAGAATTTGAGGCCAGTTTCCTAGCTCATTGCTAGTCAGGAA | actin related protein ⅔ complex, subunit 5, |
| | | | | 16 kDa; ARPC5 |
| 25 | 107117 | 0 | AATCCGACAGTACTGCAATCACTGGCGAAATTTTGCTGACATTGATGATTCCTGGAAAAG | galactosidase, alpha; GLA |
| 26 | 107344 | 0 | AATGAATGATGAAGGAGATCATGACCCAGTTCCTCTACCAAATGTTAATGCAGCAATATT | SKP1-RELATED |
| 27 | 107499 | 0 | AATGCCAGTCCTCATGTAACCTCAGGTATCTTCAGCTTGTGGAGAATAAATCTGGTTTAA | DENN/MADD domain containing 3; DENND3 |
| 28 | 108442 | 0 | ACAACAGTCACGTTGACCATCAGTGGAGTCCAGGCAGAAGACGAGGCTGACTATTACTGT | IGLV3-25 |
| 29 | 108594 | 0 | ACAAGCAGCATTAAGACTGAAGTTGGAATATTCTGTTGACCATAAAACCTTGATATCATT | progesterone receptor membrane component |
| | | | | 2; PGRMC2 |
| 30 | 109438 | 0 | ACAGAGGCCGTGGCAGGGAAACAGGCTTTGCCTTTGTAACCTTTGATGAACATGACTCCA | unassigned |
| 31 | 109557 | 0 | ACAGCCAGGCATTCACCCAGCAGGTGCACCAGTGCATCGAGTGCTGCCCTGTGCCTCTGG | UNCHARACTERIZED |
| 32 | 109729 | 0 | ACAGGCCATGACCTTGAAGTGAAAGTCTTCTGTTGCTATTGTGGGCTCAAATATTTGGTC | ring finger protein 141; RNF141 |
| 33 | 109841 | 0 | ACAGTCCACTGAATGGGTATAATGAATTGCAGTATATACGTATGATTGCTTTTTAAGTGA | neuroplastin; NPTN |
| 34 | 109943 | 0 | ACAGTTCCCTTCAGTCTGGTCAGTCCGTTATCTCCCTGCTGAGCTCAGAAGAATTAAAAA | interleukin 16 (lymphocyte chemoattractant |
| | | | | factor); IL16 |
| 35 | 109946 | 0 | ACAGTTGAAGACCGTTTTGTACTAAGTCTCATTTTGTATACTGGTAAAAACTACATGCTT | SFT2 domain containing 1; SFT2D1 |
| 36 | 109974 | 0 | ACAGTTTTGCCTGCGAGCTTCCTCCGGTGCTCTTATTGACCTGTTCTGACCCCTGCGCTA | OLFACTORY RECEPTOR MOR160 |
| 37 | 110081 | 0 | ACATCAACTACTTCGCCTCCGACGAGCTGACGGTCAAGACCAAGGATGGCATGGTGGAGA | HEAT-SHOCK PROTEIN BETA-1, HSPB1 |
| 38 | 110188 | 0 | ACATCTCCACTGCCCCCAAAGACCTCCGTTGAACATTCTGTATGGAAAAGAGCCCTGGAG | chromosome 1 open reading frame 183; C1orf183 |
| 39 | 110417 | 0 | ACATTCACGATCTGGACTCGAACTCCTTTGAACTGGACTTACAGTTTTCCGAAGATGAGA | 3-phosphoinositide dependent protein kinase- |
| | | | | 1; PDPK1 |
| 40 | 111298 | 0 | ACCCATCTTCAGTGTCTTACTTGTACTGTATCACATTCCATACCCTCATTTAATTCTTAA | tankyrase, TRF1-interacting ankyrin-related ADP- |
| | | | | ribose polymerase 2; TNKS2 |
| 41 | 111542 | 0 | ACCCTCCTGCTCAATGGCTACCAGACACTGGAAGACTTCAAAGAGCTGCGAGAAACACAC | chromosome X open reading frame 9; CXorf9 |
| 42 | 111685 | 0 | ACCGATGAAGAGGTTTGAGTAGATGTACAAATCAAGTAATGGTTTGAACACCTTTAATAA | karyopherin alpha 4 (importin alpha 3); KPNA4 |
| 43 | 111712 | 0 | ACCGCCTAAAAGTGTATCAGGGTCTTTATTGTGTGGCTATTCGTGATTTCAAACAGGCAG | proteasome (prosome, macropain) 26S subunit, non- |
| | | | | ATPase, 6; PSMD6 |
| 44 | 111979 | 0 | ACCTCATGATATTTTTCGTCAGAGAAAACAGAACACAAGTAGACCACCATCTATGCATGT | KIAA1429; KIAA1429 |
| 45 | 112290 | 0 | ACCTGTGATGAAAACATCTGTAACTACTAGCCCACAGAGTGACATGATGAGGGAGCAACT | MCM3 minichromosome maintenance deficient 3 (S. cerevisiae) |
| | | | | associated protein; MCM3AP |
| 46 | 112443 | 0 | ACCTTTCAGGCCAGACAGGAGCACCTGACCAAAGGCTTCACAGCCGCCCTCACCGCCCGG | glycoprotein IX (platelet); GP9 |
| 47 | 112800 | 0 | ACGCTTGTACATGAAGTGTGGAAGGACTCTGCCACAATGTCCCTGGACCCTGAGGAAGAG | transglutaminase 3 (E polypeptide, protein-glutamine- |
| | | | | gamma-glutamyltransferase); TGM3 |
| 48 | 112894 | 0 | ACGGCGAGGGCGGCTGCATCACTGCGGAGGACTGCCCCTGCGTGCACAATGAGGCCAGCT | mucin 5AC, oligomeric mucus/gel-forming; MUC5AC |
| 49 | 112908 | 0 | ACGGCTGGAATCCCTCTGTGTGCATGAACTTCTGTGCCGCCTTCCTTAGCTTTGCCCAGA | dom-3 homolog Z (C. elegans); DOM3Z |
| 50 | 113959 | 0 | ACTGAGCGACTGGGAAAACTCGGCTCTACATCTCACCCAGAACGGCTTTTAGAAACACCA | phosphopantothenoylcysteine decarboxylase; PPCDC |
| 51 | 113961 | 0 | ACTGAGGAAATGAGACAGCACGTGACAAATCCTTAAAGGATACACACATGACAGGAAGGA | DKFZp547G183 |
| 52 | 114782 | 0 | ACTTGTCAGGAGTTGAGACTTCCCTGCCGGATTCTATTTTGAAAGTAAATGGTCTTCCCT | testis specific, 14; TSGA14 |
| 53 | 115039 | 0 | AGAAAAGTCCTATCAATTACAGAAGCTATACGAACAAAGAAAAATGGTCATGTACCTCAA | sorting nexin family member 27; SNX27 |
| 54 | 115178 | 0 | AGAAAGGGTAGTTCAAAGAGTCTGTCTTGAGATCTGATTTTTTCCCCCTTTACCTAGCTG | TNF receptor-associated factor 4; TRAF4 |
| 55 | 115648 | 0 | AGAAGGACAAACCTGAGAAAGAATTAAAAGCCTTTTGTGCTGATCAACTTGATGTCTTTT | RNA RECOGNITION RRM/RNP DOMAIN |
| 56 | 115680 | 0 | AGAAGGCTTCCACACTCAAATCTCTAAGTATTTCTCTGAGCGTGGTGATGCAGTGACTAA | proteasome (prosome, macropain) activator subunit 1 |
| | | | | (PA28 alpha); PSME1 |
| 57 | 116198 | 0 | AGACCGGCGAAAGAAGGAACGAGTTGAAGCAGTTAATATGGCTGAAGGAATCATTCACGA | heat shock 70 kDa protein 9 (mortalin); HSPA9 |
| 58 | 116281 | 0 | AGACGGAAGCCTGAAAACTCCTCAGACTCCAGCACCTCCCTTTTACAAACTGACGTTTGT | unassigned |
| 59 | 116964 | 0 | AGAGGCCTCTGTGCCCAGCCTGATTCTCTGCTCCCAGGAGCCAGTGACATGAGGTGCAGA | pescadillo homolog 1, containing BRCT domain |
| | | | | (zebrafish); PES1 |
| 60 | 117180 | 0 | AGAGTTGTTGCTGCCCGTATTAGGCCACACAGTGGAACCCCATTTATATCATAGCAGAAG | mannosidase, alpha, class 2A, member 2; MAN2A2 |
| 61 | 117405 | 0 | AGATGAAGAGCCGAATACCTGTGGTGCTCCTGGCCTGTGGCTCCTTTAACCCCATCACCA | nicotinamide nucleotide adenylyltransferase |
| | | | | 3; NMNAT3 |
| 62 | 117989 | 0 | AGCACCTCAGCAGCCAGAACAGATATTTCAGTGAAGCTGACAAAATCAAAGTGGCCCAGG | IMP (inosine monophosphate) dehydrogenase |
| | | | | 2; IMPDH2 |
| 63 | 118098 | 0 | AGCAGAGAGAAGCCTGAGCCTGGCCCCAGTTTTTCATTTGTAGAACCTGGGATTCAAACT | unassigned |
| 64 | 118423 | 0 | AGCATTACGGGTTTTCGTTGAGTCTGTTTTAAGGTATGGCTTGCCAGTGAACTTCCAAGC | ATPase, H+ transporting, lysosomal 42 kDa, V1 |
| | | | | subunit C1; ATP6V1C1 |
| 65 | 118485 | 0 | AGCCAACATCACGTTTTGTTAGCTGTGATTTACCTTTGTCCGTTTAAAAGACTTCACGGA | myotubularin related protein 15; MTMR15 |
| 66 | 118631 | 0 | AGCCATAATGTTGAACAGAATTGGAGTATTTTCTTTATAATTTCTTGAACAGGCAAATGA | unassigned |
| 67 | 118635 | 0 | AGCCATCACTTCAACATTGTGATAATCCTTCACAGCAAGAAACCGAATAAAATACTAACA | BTB (POZ) domain containing 1; BTBD1 |
| 68 | 118644 | 0 | AGCCATGAACATGTTGAGTGAGCATGCTGGAGAATGAGAGACCACATGAAGCAGAAACAT | mixed lineage kinase domain-like; MLKL |
| 69 | 118743 | 0 | AGCCCCCACCGTGGAGACCTCTGACCCTTATGCTGATGATCCTGTACGTCACCCAGCCCT | sulfite oxidase; SUOX |
| 70 | 118954 | 0 | AGCCTCGTGAACGTCCACGGTGCTGTGCTGTACGACAAGTTCATCCGGCCTGAGGGAGAG | interferon stimulated exonuclease gene 20 kDa; ISG20 |
| 71 | 119044 | 0 | AGCCTTCACCATCTCTGCCTATACAGATGGACACACTCCCTGCCTGTGCTGCTGCTAGAC | unassigned |
| 72 | 119207 | 0 | AGCGGATGGTGCCCTGACTCCATCTGGATTCCTTGACGTGTCTCAGACTGGGTCCCTGAG | unassigned |
| 73 | 119578 | 0 | AGCTGACCTCACTGGCATTAACTGATGTGCCCTACCTGTTCAGCCCCCATCTGGGCCTCG | unassigned |
| 74 | 119696 | 0 | AGCTGGAAGGCCGTGATGCCATCTTCAAGCAGTTTCATTTCAAAGACTTCAACAGGGCCT | pterin-4 alpha-carbinolamine dehydratase/dimerization |
| | | | | cofactor of hepatocyte nuclear factor 1 alpha |
| | | | | (TCF1); PCBD1 |
| 75 | 119843 | 0 | AGCTTCAAATGAGTTTCAAGGGAATTTTCCCATGTGAAAAAAGGAGAGAACACTGGCATC | vitamin K epoxide reductase complex, subunit 1-like 1 |
| | | | | pseudogene; unassigned |
| 76 | 119977 | 0 | AGGAAAACATGCACTTCGAGATCTGCCCCTGGTCCAGCTACCTCACTGGTGCCTGGAAGC | adenosine deaminase; ADA |
| 77 | 120075 | 0 | AGGAACCTACAGGATTCTAAGGTTTCCTAGGTCACTGAACAACTAATCTTGGTCCCTGAA | adaptor-related protein complex 3, mu 2 |
| | | | | subunit; AP3M2 |
| 78 | 120408 | 0 | AGGAGACCGTCAGGCCGCATGTAGACAATGCTGCTAAGAAACAGAACAAAATGCCACCCC | DNA segment, Chr 15, Wayne State University 75, |
| | | | | expressed; unassigned |
| 79 | 120440 | 0 | AGGAGATAAGTTTCCATGCACTTTGGTGGCACAGAAAATTGACCTGCCGGAGTACCAGGG | inosine triphosphatase (nucleoside triphosphate |
| | | | | pyrophosphatase); ITPA |
| 80 | 120553 | 0 | AGGAGGCCCGCACACCGGTACACTCGTGGACACCTACACACTCCATAGGAGATCCTGGCT | G protein-coupled receptor 172A; GPR172A |
| 81 | 120701 | 0 | AGGATGGCAAGGATTAAAAGAATATGATCAAGCATTGGCTGATCTTAAGAAAGCTCAGGG | peptidylprolyl isomerase D (cyclophilin D); PPID |
| 82 | 120770 | 0 | AGGATTTTGTATCCCCGGCCTACTTGAAGAAGTGGTCAGCTAAAGGAATCCAGGTTGTTG | membrane interacting protein of RGS16; unassigned |
| 83 | 120859 | 0 | AGGCAGCAGCCCAGTCCCCATGTTCTGTCCCCTCACAGGTTCCTACCCCCGGCTTCTTCT | sorting nexin 26; SNX26 |
| 84 | 120923 | 0 | AGGCATTAGGTTTCCCAACTGCTTTGTGCTGATATCAGAACAGCAGAAATTAAATGTGAA | aquaporin 9; AQP9 |
| 85 | 121011 | 0 | AGGCCCGTCACAAGATCCAGGCCAAGTATCTGGACCAGATGGAGGACCTGTATGAAGACT | arsA arsenite transporter, ATP-binding, homolog 1 |
| | | | | (bacterial); ASNA1 |
| 86 | 121045 | 0 | AGGCCTAGATTTGAAATAATGTTTTGTACTTCGGTAAGATGGAAAACTTAGTGATTCACT | EF-hand domain family, member A1; EFHA1 |
| 87 | 121204 | 0 | AGGCTGAGGTCTCCTGGGAATTCTCACCCGCTCTCCTGCTGCTAAGGAAATGACGTCAAT | Unassigned |
| 88 | 121257 | 0 | AGGCTTATTAGAAGAATGAACTAAGGTGTCTACCATGATTATTTTTCTAAGCTGGTTGGT | ribosomal protein L7; RPL7 |
| 89 | 121369 | 0 | AGGGACCCTGGTTTGGACTAGACCTTTGGAGGCCGAGTGTTATCCCTGGCTTCTGGAGGG | F-box protein 41; FBXO41 |
| 90 | 122004 | 0 | AGGTGTCGCAGGCAGCAGCGGAACTCCTGGCTTTCTGCGAGACGCATGCCAAAGATGACC | guanine nucleotide binding protein (G protein), gamma |
| | | | | 8; GNG8 |
| 91 | 122087 | 0 | AGGTTGGTCTCGGCCCAGTTTCCCATTGATCACTTCACACACATCTTCATCGATGAGGCT | Mov10, Moloney leukemia virus 10, homolog |
| | | | | (mouse); MOV10 |
| 92 | 122196 | 0 | AGTAAGACTGAAGCAGACATGGAAGAGTATATATGGGAAAATAGCTCATCAGAAAGAAAT | mitochondrial ribosomal protein S35; MRPS35 |
| 93 | 122376 | 0 | AGTAGCTGGTGCTGCTCCAGCTGAGGAAGAAAGTGGAAGCAAAGAAAGAAGAATCCGAGG | similar to 60S acidic ribosomal protein P1; unassigned |
| 94 | 122416 | 0 | AGTATAACAGACACTATACCAAAATACCAAGCAACTGTTTTGAGAACCCAGACTTAAAAT | exocyst complex component 1; EXOC1 |
| 95 | 123331 | 0 | AGTGTATCGACGGATAACAGAGTTCACATATTCAAACCTGTATCTGTGCAGGCAATGTGG | slingshot homolog 2 (Drosophila); SSH2 |
| 96 | 124046 | 0 | ATAAATTCATGAAAGAAGCCACGACGAATGCACCATTCAGATTGAATAAGAAAGACAGAA | serpin peptidase inhibitor, clade B (ovalbumin), |
| | | | | member 1; SERPINB1 |
| 97 | 124143 | 0 | ATAAGGAATTTGGTAATGATGAAAGCAATTTTGGAGGTGGTGGAAGCTACAATGATTTTG | Unassigned |
| 98 | 124299 | 0 | ATACAGATGTTTTCCCTTGTGGCAGTCTTCAGCCTCCTCTACCCTACATGATCTGGAGCA | alcohol dehydrogenase 1A (class I), alpha |
| | | | | polypeptide; ADH1A |
| 99 | 124735 | 0 | ATATAACAACATTCAGATGACTCTCCCGAAAACTTACACCATAGCTAATCAATTTCCTCT | phenylalanine-tRNA synthetase-like, beta |
| | | | | subunit; FARSLB |
| 100 | 124823 | 0 | ATATCCACACAGAAGAATTGATATCAGGTTGATACCCAAAGATCAGTATTACTGTGGTGT | polymerase (DNA directed), beta; POLB |
| 101 | 125008 | 0 | ATATTTACACACAGCACATATATGCACAAAATAGCCTGCCCTTCCCACATGTCTCCCTAA | GTPase activating Rap/RanGAP domain-like |
| | | | | 1; GARNL1 |
| 102 | 125012 | 0 | ATATTTCACTTTCTCTTTGACTTTAGACCTTTTGAAGTCTGTATAAACTTGTTTTGAAAT | GRIP and coiled-coil domain containing 2; GCC2 |
| 103 | 125096 | 0 | ATCAACCCTCCGCCCGACACGAGGCTGGAGCCCAGTGACATTGTCTATCTCATCCGCTCC | potassium channel, subfamily T, member 1; KCNT1 |
| 104 | 125266 | 0 | ATCACGCGCCCCTGATGGAACTTTTCTGCTGTTGTGAAGTACTTTTATCCATTTGCTTCT | melanoma associated antigen (mutated) 1; MUM1 |
| 105 | 126449 | 0 | ATCTGATGACTGCTTTGTGCTGGACAACGGGCTCTGTGGCAAGATCTATATCTGGAAGGG | capping protein (actin filament), gelsolin-like; CAPG |
| 106 | 126905 | 0 | ATGACAATGCTTCTCTGTGACTCAAACCAGGAATTTCCAAAGATTTCAAGCCAGGGAGAA | solute carrier family 31 (copper transporters), member |
| | | | | 2; SLC31A2 |
| 107 | 126985 | 0 | ATGACGATGAGGATGACACCCCAGTGAAGACGGTTCTGTCCTCCCCATGTGACTCCCGGG | family with sequence similarity 53, member A; FAM53A |
| 108 | 127008 | 0 | ATGACTCTGCCCATCCCCATCCTTTCAGCACAACTCCGTTATTGTGGAAGAAATGTCATT | olfactory receptor, family 56, subfamily A, member |
| | | | | 3; OR56A3 |
| 109 | 127068 | 0 | ATGAGATAGTCTTATAAGAATCACGATTTTCTACACCTGTCATTGAGCCAAGAAAGTCCA | tryptophan rich basic protein; WRB |
| 110 | 127385 | 0 | ATGCAGAGGGACAAAGGGCTGTGCTACACTTCCCAGTTACATTCTGAAGCTCATAAATGT | malonyl-CoA decarboxylase; MLYCD |
| 111 | 127609 | 0 | ATGCGCGAGATCGCTCAGGACTTTAAGACCGACCTGCGCTTCCAGAGCTCGGCCGTGATG | histone cluster 3, H3; HIST3H3 |
| 112 | 127663 | 0 | ATGCTCAGCGTGAGGCTGGAGCAGCAGCTGACAGTGGCAGTCCTGGCCCAGGGTGACGGT | unassigned |
| 113 | 127830 | 0 | ATGGAACCTACTGCAAAAAGATTGTCCAAAATGCCTAAGAAAATACTCCTCTGATGCATT | solute carrier family 38, member 1; SLC38A1 |
| 114 | 127856 | 0 | ATGGAATTTGTAAGTTTATGTCTAAAGAGCTTTAGTCCTAGAGGACCTGAGTCTGCTATA | adrenergic, beta-2-, receptor, surface; ADRB2 |
| 115 | 128088 | 0 | ATGGCCGCCGCCAAGCAGTGCAAGGGCATCGTGGACTGCATCGTCCGCATCCCCAAAGAT | ADP, ATP CARRIER PROTEIN |
| 116 | 128154 | 0 | ATGGCTTCATCGACAAGGAAGATTTGCATGATATGCTTGCTTCTCTAGGGAAGAATCCCA | myosin regulatory light chain MRLC2; unassigned |
| 117 | 128211 | 0 | ATGGGATTTGGCCTTTTTGATTAAATTCCTGCTCCCCTGCAAATAAAGCCTTTTTACACA | ribosomal protein, large, P2; RPLP2 |
| 118 | 128232 | 0 | ATGGGCGCAGAGGCTTTTCCAGTGTGTATAAATCCATGAAAATAAACGCCACCTGCACCC | phosphatidylinositol transfer protein, membrane- |
| | | | | associated 1; PITPNM1 |
| 119 | 128501 | 0 | ATGTCAAAGGAAATCAGCAGTGATAGATGAAGGGTTCGCAGCGAGAGTCCCGGACTTGTC | inner membrane protein, mitochondrial |
| | | | | (mitofilin); IMMT |
| 120 | 128603 | 0 | ATGTCTGTGCAGCCTTACACTCTGTCTTTACAGAAGCAAATAGTACACAAAAGATCTATT | PHD finger protein 2; PHF2 |
| 121 | 129530 | 0 | ATTCTCTAAAGAATCAGATTGGAGATAAAGAAAAGCTGGGAGGTAAACTTTCCTCTGAAG | heat shock 70 kDa protein 5 (glucose-regulated |
| | | | | protein, 78 kDa); HSPA5 |
| 122 | 129671 | 0 | ATTGAGACACATTACCTGAATAAGCAGGTGAAAGCCATCAAAGAATTGGGTGAGCACGTG | ferritin, heavy polypeptide 1; FTH1 |
| 123 | 129999 | 0 | ATTTAAAGAGATCTGTGTACTGTTTACTTCCCACTTCCCAGAATCCCTTGTATCTCCTTT | phosphoinositide-3-kinase, class 2, beta |
| | | | | polypeptide; PIK3C2B |
| 124 | 130267 | 0 | ATTTGCCTGATTTAAGTGTCTGAGAAACAAATCTTTGTTCTCTTAGGCTGCAATGGAACA | eukaryotic translation initiation factor 3, subunit 1 |
| | | | | alpha, 35 kDa; EIF3S1 |
| 125 | 130323 | 0 | ATTTGTAAACCTGTCTCTAATTTGTAATTTTGTAAACCCTGTCTCTCATATTTTGTAAAA | lymphocyte transmembrane adaptor 1; LAX1 |
| 126 | 130335 | 0 | ATTTGTATCATGTAATGAACTAAACCACCTGTAATTTTGTACCGTATGTGTCTTTCCATC | kinesin family member 13B; KIF13B |
| 127 | 130358 | 0 | ATTTGTTTAAATGTCTACATTCTTTCTAATAAACTGTTGGAAGACTTCTTGGCTGTCCTT | Unassigned |
| 128 | 130560 | 0 | CAAAAAGTGCGTTAGAAACACTTCAAGAAGAAAAGCCTGAGCTGACCGTCGTCTTTGAGC | NLR family, pyrin domain containing 3; NLRP3 |
| 129 | 131059 | 0 | CAAATGTCATGAGAAGTTTGATTCAGTAACTTGTGATGGAGGATTCTTTGGTATCTTACT | pleckstrin homology domain containing, family F (with |
| | | | | FYVE domain) member 2; PLEKHF2 |
| 130 | 131259 | 0 | CAACATCTTTCCTCCTGTGGTCAACATCACATGGCTGAGCAATGGGCAGTCAGTCACAGA | major histocompatibility complex, class II, DQ alpha |
| | | | | 1; HLA-DQA1 |
| 131 | 131334 | 0 | CAACCCGGCCTACATGGATGCCCCGAAGCGGCCCTCTGAGCATTCCCTGGCCTCTCTGGC | scotin; unassigned |
| 132 | 131413 | 0 | CAACGCGGCCCCCAGCGGGTGTCACCCTGCTCCCTCGTGGGTCGCCTGCGCCCACACCGG | similar to FSHD region gene 2 protein; unassigned |
| 133 | 131551 | 0 | CAACTTCTCCGACTCTACCAGCTGATGCTCTTCACCCTGCCAGGGACCCCTGTTTTCAGC | solute carrier family 3 (activators of dibasic and neutral |
| | | | | amino acid transport), member 2; SLC3A2 |
| 134 | 131688 | 0 | CAAGACGATCCGGGTAAAGTTCCAGGGAGGCCGCGAAGCCAGTGGAATCCTGAAGGGCTT | LSM7 homolog, U6 small nuclear RNA associated (S. cerevisiae); |
| | | | | LSM7 |
| 135 | 131715 | 0 | CAAGAGACTCTTCCAAGGCACTACCAATATGTTATCTCCAGATGCCGCGCAACTGTCTGA | family with sequence similarity 122B; FAM122B |
| 136 | 131936 | 0 | CAAGCTACAGCGAAAGCTTCCTGTGGAGTCGATCCAGATTGTATTAGAGGAACTGAGGAA | vacuolar protein sorting 25 homolog (S. cerevisiae); |
| | | | | VPS25 |
| 137 | 132553 | 0 | CAATGTACATATCCTAACTTTACCACACATATTCGAACCTACAGCTCACTGCCTGGCCCA | unassigned |
| 138 | 132642 | 0 | CAATTTGCAAACTTAGTGCTACATCAGACTGTGGAGCGTATTCATGTGGGCAAAAAATAC | LSM1 homolog, U6 small nuclear RNA associated (S. cerevisiae); |
| | | | | LSM1 |
| 139 | 132648 | 0 | CACAAAAGAACGATTTTCAGTGCCCCCAGCAAGGCTGCACCCTCCTTGATCATCACAGGG | t-complex 10 (mouse); TCP10 |
| 140 | 133356 | 0 | CACCATCAACACCTTGGTGGAGAACAAAGAAAGCTCAGCTGGTGGTGACTGCACACGTGG | 60S RIBOSOMAL PROTEIN L7A |
| 141 | 133626 | 0 | CACCTATTGACCATACTACAATGAATGATGATGCCAGGACAGAACTGTACCGCTCTCTTT | apoptosis antagonizing transcription factor; AATF |
| 142 | 135425 | 0 | CAGCACTTACCGATCCAGAGCCTCCCGGCCTTCTCCGGTGTCCTGTACCAACTCTTCTAT | immunoglobulin mu binding protein 2; IGHMBP2 |
| 143 | 135704 | 0 | CAGCCGAGATGCTTTATGGATTGATCCACGCCCGCTACATCCTTACCAACCGTGGCATCG | casein kinase 2, beta polypeptide; CSNK2B |
| 144 | 135807 | 0 | CAGCGAACTATGGCTCTTCCTGTAGGACGAGGAATGTTTACCTTGTTTTCGTACCATCCT | anaphase promoting complex subunit 1; ANAPC1 |
| 145 | 135917 | 0 | CAGCTACTGCCACTTCGCCTTACATCCCTGCTGACTGCCCAGAGACTCAGAGGAAATAAA | septin 4; SEPT4 |
| 146 | 136418 | 0 | CAGGCATGCAGAAGGCTCTGTGTGCAGCCCCAGACCTGGGTACCTTCGTCACCGTCCTCA | unassigned |
| 147 | 136420 | 0 | CAGGCATTCGAGAAGTACCGCCTGCGGGTGAAGAACTTCGGCATCTGGCTGCGCTACAAA | 60S RIBOSOMAL PROTEIN L18A |
| 148 | 136996 | 0 | CAGTCCCTTGTTCCAAAAATTGGAAAATGACCAGATTGAAAGTTTAAGGCAGCGCTTTGG | methionine-tRNA synthetase; MARS |
| 149 | 137061 | 0 | CAGTGAAGGTAGAGGAACCCAGATAGAAGAAAATCCTTTGGAAGAAAATATTCTGGCGGG | ankyrin repeat and IBR domain containing 1; ANKIB1 |
| 150 | 137326 | 0 | CAGTTGAAAATTAGGTTCTAAGTTGTTCTTGCAGGAATTAGCCTCCCCGTCTCCCAAAAC | SLIT-ROBO Rho GTPase activating protein |
| | | | | 2; SRGAP2 |
| 151 | 137501 | 0 | CATACAAATCTGATGTTAATGTTTGCTCTTAGAAGTCATACTCCATGGTCTTCAAAGACC | F-box protein 21; FBXO21 |
| 152 | 137907 | 0 | CATCCCATTTGGTAGTCTAGCTGACTCCATCAGTATTAACCTCCCCGCTCCTCCTAACCT | SWI/SNF related, matrix associated, actin dependent |
| | | | | regulator of chromatin, subfamily c, member |
| | | | | 2; SMARCC2 |
| 153 | 137986 | 0 | CATCCTTCAATATAGTGCCTTTAACTTCCCGTGTGAAACCTGATCCTCCACATATTAAAA | interleukin 13 receptor, alpha 1; IL13RA1 |
| 154 | 138526 | 0 | CATGGAGGGTGTAGAAGAGAAGAAGAAGGAGGTTCCTGCTGTGCCAGAAACCCTTAAGAA | ribosomal protein L7; RPL7 |
| 155 | 138654 | 0 | CATGGTTCTTCAGGTCCCCCAGGAATCAGAAACTATCCCTCTTGTGATGAAAGCTGTCTC | major histocompatibility complex, class 1-related; MR1 |
| 156 | 138703 | 0 | CATGTCCCAGGACAGTGTTACTTCTTCTGCATGATGTGTGGTAGACTCCCTTTGCTGGCT | oxidative-stress responsive 1; OXSR1 |
| 157 | 139273 | 0 | CCAAAAAGGCAGCGTTGAAAGGTGTCCACAGCCACATAAAAAAGAAGACCCGCACGTCAC | unassigned |
| 158 | 139449 | 0 | CCAACACTACCCAGGACTCTTGCTACCTGGTTCCAACTCCAGACAACCACTATGCCAGGC | transmembrane protein 115; TMEM115 |
| 159 | 139466 | 0 | CCAACATCTCCAGCTGGATCCCAGGGAAATATCAGCCTTGGGCAACTGCAGTGACCAGGG | adenine phosphoribosyltransferase; APRT |
| 160 | 139652 | 0 | CCAAGCTGACTCCTGAGGAAGAAGAGATTTTGAACAAAAAGCGATCTAAAAAAATTCAGA | similar to ribosomal protein S8; unassigned |
| 161 | 139881 | 0 | CCACAAGGCAAAGGGCAAGTGAGGCTGACGTCCGGCCCAAGTGGGCCCAGCCCGGCCCGC | histone cluster 2, H2aa3; HIST2H2AA3 |
| 162 | 140164 | 0 | CCACCGCTAGGGTCTCCACAGGCGCCCTCCCTCCGCGCCCTCCCTCCCCCTCGAGCCGCC | DKFZP564B147 |
| 163 | 140226 | 0 | CCACCTTCACCTTTAGCTTCTTGAAAATGGGCCCCTGCAGAATAAATCTGCCAGTTTTTA | vasodilator-stimulated phosphoprotein; VASP |
| 164 | 140424 | 0 | CCACTGTGGCCTGCTGGGAACTGGGCTGTGGAAAGGTCCGGCCTCGAGTAGGCAAAACCC | gb def: Mus musculus 0 day neonate thymus cDNA, |
| | | | | RIKEN full-length enriched library, clon |
| 165 | 140544 | 0 | CCAGAATGTTACAGGATGTAGTAATTACTATAACTTTTTGCGGTGCACGGAACCTGAGGA | carboxypeptidase, vitellogenic-like; CPVL |
| 166 | 140597 | 0 | CCAGAGAAAGTCCTCGCTCGTCACCAGCAAGCTTGCGGGTGGCCAAGTTGAATGATGCTG | endosulfine alpha; ENSA |
| 167 | 140829 | 0 | CCAGCCCCCTGACGGTTTACAGATGCCATGGCAACATCAGGAAGTTACCCTCTATGCTCT | unassigned |
| 168 | 141288 | 0 | CCAGTGAACCACTGAGCTCGCACTGTAGCCAGTCCTGTGTGCCCCTGCTGGATTCTGCTT | hypothetical protein FLJ33534 |
| 169 | 141469 | 0 | CCATCACCAAAGGTGGAGCAGCCAAAATGAAGTACAATCCCTTTGTGACTTCTGACCGAA | 60S RIBOSOMAL PROTEIN L26 |
| 170 | 141482 | 0 | CCATCACTCCATCAAAGTCCCTGGCTATAAGATCTGGATTTTACCCACTCCATCTTCTCT | zinc finger protein 142; ZNF142 |
| 171 | 141676 | 0 | CCATGCCAGTCAGGCGGGCTTGCCATGTTCTGTGAATCTCGAGTGAGCGGTGCCACCCGC | vacuolar protein sorting 37 homolog B (S. cerevisiae); |
| | | | | VPS37B |
| 172 | 141703 | 0 | CCATGGAAGTTTGACCCCAACGAGATCAAAGTCATATACCTGAGGTGCACCAGGAGTGAA | similar to proline-rich proteoglycan 2; unassigned |
| 173 | 141901 | 0 | CCATTTAAAAAACTATGCTGCTGCTCTAGAAACTTTTATAGGAGGACAAAAATTAGTAAG | SUPPRESSOR OF G2 ALLELE OF SKP1 |
| 174 | 142102 | 0 | CCCAATGCTTTCACTCTTATCTACCCTTTGGCACTTATCTTGCTTATCAACATAATAATT | chromosome 3 open reading frame 60; C3orf60 |
| 175 | 142266 | 0 | CCCACTTGCACCTCTCCACCTTTGGCACTAGAACTCCTGAGACACCACTTCTCATGCTTC | pleiomorphic adenoma gene-like 2; PLAGL2 |
| 176 | 142421 | 0 | CCCAGGATGACTACTCGGTCCTGTTTGAAGACACCTCCTATGCAGATGGCTATTCCCCTC | coiled-coil domain containing 101; CCDC101 |
| 177 | 142487 | 0 | CCCAGTCTTATCTGTGCCTTTACTGCTTTGCGCATCTCAGATGCTAACTTGGTTCTTTTT | UDP-Gal:betaGlcNAc beta 1,4-galactosyltransferase, |
| | | | | polypeptide 1; B4GALT1 |
| 178 | 142757 | 0 | CCCCACGCCATGCGGCACATCCAGGAGCACTACGGCGGGACTGCCACCTTCTACCTCTCT | galactokinase 1; GALK1 |
| 179 | 143032 | 0 | CCCCGCACACCGTGAGCTACCCGGACAATCTGACCTACCGCGATCTCTACTACTTCCTCT | diacylglycerol O-acyltransferase homolog 1 |
| | | | | (mouse); DGAT1 |
| 180 | 143181 | 0 | CCCCTGGAAGAGTGATTCTAATCAGGTATTTTCCTACAAAGTTTGGACTGTGTCTTCTTC | ankyrin repeat domain 55; ANKRD55 |
| 181 | 144028 | 0 | CCCTTAGCAATCCGGCCTCGCAGGCTGTACTTTCATGGTGCTCTCTACCTTCTGGCCCCC | cell death-inducing DFFA-like effector c; CIDEC |
| 182 | 144049 | 0 | CCCTTCCAAAAACTACAATATGATGACTGTATCAGGTTAAGATATAGTCTGTGGATGGAT | B-cell translocation gene 1, anti-proliferative; BTG1 |
| 183 | 144135 | 0 | CCCTTTCATTAGAACTTCAAGCTCTCCAAAGGCTCAGATTATAACTGTTGTCATATTTAT | 2′-5&apos; -oligoadenylate synthetase 2, |
| | | | | 69/71 kDa; OAS2 |
| 184 | 144168 | 0 | CCCTTTTTGGCCTGAAGACATTTTAGAATTTCCTAACAGAGTTTACTGTTGTTTAGAAAT | BCL2/adenovirus E1B 19 kDa interacting protein 3- |
| | | | | like; BNIP3L |
| 185 | 144479 | 0 | CCGCCTCCATTGCAACATCTTCTACGACTACTCCGGCTACGGTGCCAGCGCGGGCAGGCC | UNCHARACTERIZED |
| 186 | 144646 | 0 | CCGGATCCTTCGTGTCCCCACAGCACGTTTCTTGAAGCAGGATAAGTTTGAGTGTCATTT | MHC CLASS II BETA CHAIN |
| 187 | 144765 | 0 | CCGGGCGACTGCGAAGTTTGTATTTCTTATCTGGGAAGATTTTACCAGGACCTCAAAGAC | arginine-rich, mutated in early stage tumors; ARMET |
| 188 | 145597 | 0 | CCTCCACCAGCATTTCCCTTACTCTGAAGTTCCGGCATTCACATCATTCATGTTTTCTTT | nuclear protein localization 4 homolog (S. cerevisiae); |
| | | | | NPLOC4 |
| 189 | 145675 | 0 | CCTCCCGGAAGAGCTTCAAGAGCTAAGAACCTGCTGCAAGTCACTGCCTTCCAAGTGCAG | keratin 5 (epidermolysis bullosa simplex, Dowling- |
| | | | | Meara/Kobner/Weber-Cockayne types); KRT5 |
| 190 | 145726 | 0 | CCTCCTCACTTGGATAAAAAGCAGATTTGCCTTAGTGCTGCATGTCTGTCTGGGAGAGGG | unassigned |
| 191 | 146019 | 0 | CCTGAAAACCAAGCTTTGATTTAGATTGAGTAAGATTTACCCAGAATGTCAGATTCCTTT | peptidylglycine alpha-amidating monooxygenase; PAM |
| 192 | 146289 | 0 | CCTGCCAAACAAGCTAATATGGAAACCACATGTAACTTAGCCAGACTATACCTTGTGTAG | DEAD (Asp-Glu-Ala-Asp) box polypeptide 3, X- |
| | | | | linked; DDX3X |
| 193 | 146331 | 0 | CCTGCCTAACATGCCAGCGCAGCCAACGCTTCCTCAATGATCCCGGGCATTTACTCTGGG | ribonuclease P 21 kDa subunit; RPP21 |
| 194 | 146661 | 0 | CCTGGGCATGATGGGCCGAGCCACCTCGGATCCCACTGATTGGCCAGCCGAGCGAGAACC | adducin 1 (alpha); ADD1 |
| 195 | 146768 | 0 | CCTGTACCTGCTCTATTTCAGAGCTTGTGGCTTTGTGTCTCCCCTGCTTTCCCCACGCAG | enhancer of mRNA decapping 3 homolog (S. cerevisiae); |
| | | | | EDC3 |
| 196 | 146806 | 0 | CCTGTCCAGCACTGCCTAGTGTTGGAGGGTAGACCAAGGCTGTGCATGATTCACCCCCTC | microtubule associated serine/threonine kinase |
| | | | | 3; MAST3 |
| 197 | 146814 | 0 | CCTGTCCCCTCCACCTTCCCTCACAGTGTGTCTGGTGACAACCGAGTGGCTGTCATCGGC | chemokine (C-C motif) ligand 3-like 1; CCL3L1 |
| 198 | 147139 | 0 | CCTTCCATTTGACCTAATTTAACTGGTGAAATTTAAAGTGAATTCATGGGCTCATCTTTA | myeloid cell leukemia sequence 1 (BCL2- |
| | | | | related); MCL1 |
| 199 | 147521 | 0 | CCTTTCCCTGCATATGCTTCTGATGGTGTCATCTGCTCCTTCCTGTGGCCTCATCCAAAC | triosephosphate isomerase 1; TPI1 |
| 200 | 147811 | 0 | CGAATGTCCTGGCTGATGCTCTCAAAAGGATCAACAATGCAAAAAAGAGAAGCAAACGCC | similar to ribosomal protein S15a; unassigned |
| 201 | 147922 | 0 | CGACCTCATGAACAAGTTCCTGACCTACTTCCCCGGGAGGAGGATCAGCGCTGAGGACGG | cell division cycle 2-like 1 (PITSLRE proteins); CDC2L1 |
| 202 | 148434 | 0 | CGCACTGCCACTATAAGGCTCCCACCGTGGTCTTGCACATGACTAAGACGGACCCCTCTT | frizzled homolog 9 (Drosophila); FZD9 |
| 203 | 148685 | 0 | CGCCCTGTGGGTGCACAGCAACCAGCTCTCCATGCAGTGTGTCAAGGATGATGAGCTCTA | proline-serine-threonine phosphatase interacting |
| | | | | protein 1; PSTPIP1 |
| 204 | 148950 | 0 | CGCTAGAGGTGAAATTCTTGGACCGGCGCAAGACGGACCAGAGCGAAAGCATTTGCCAAG | scavenger receptor class F, member 2; SCARF2 |
| 205 | 149133 | 0 | CGCTTACTACCTTCAGTATAAAAATGTCAGGCCTGATTATCTAAAAGCTATTTGGAATGT | superoxide dismutase 2, mitochondrial; SOD2 |
| 206 | 149320 | 0 | CGGAGCCACAGACACAGGCGTGAACGGTGACCGAGCCCCCTCTGATGCTCCATGCCCCTG | unassigned |
| 207 | 149466 | 0 | CGGCAGCCGAAGACACTGCGACTCTGGAGACAGCCCAAATATCCTCGGAAGAGCGCTCCC | 60S RIBOSOMAL PROTEIN L23A |
| 208 | 149642 | 0 | CGGCTCCGTTCGGGCAAGGATAGTTACTGACCGGGAAACTGGGTCCTCCAAAGGGTTTGG | nucleolin; NCL |
| 209 | 149923 | 0 | CGGTGACCTTCTCCACGGAATGCCGGATGCCCGACATCGCCCTGCCCTCCCAGTTTGTGG | hydrocephalus inducing homolog (mouse); HYDIN |
| 210 | 149934 | 0 | CGGTGCATCCACGAGGACCTGCTAGGGCTGACCTTCCGGATCTCTCCACACGCCTTCTTC | HpaII tiny fragments locus 9C; unassigned |
| 211 | 150024 | 0 | CGTACCTTCCCACTGGCCTCAAGTGAGCCAAGAAACACTGCCTGCCCTCTGTCTGTCTTC | histone deacetylase 1; HDAC1 |
| 212 | 150233 | 0 | CGTCTCCTAGGTATTCATTCTGTATTTTGCAAGCCTCAAAACATACGTGAAGTTGGCTTT | peroxisomal membrane protein 3, 35 kDa (Zellweger |
| | | | | syndrome); PXMP3 |
| 213 | 150510 | 0 | CGTGTGTTCTGGCTGTAGACAACATTCTTTATATTGCCAACCTCGGAGATAGTCGGGCAA | integrin-linked kinase-associated serine/threonine |
| | | | | phosphatase 2C; ILKAP |
| 214 | 150670 | 0 | CTAAACATGGTGATATTCTTCCTAATGCTGATGGGACATGGTATCTTCAGGTGATCCTGG | CD1c molecule; CD1C |
| 215 | 150983 | 0 | CTACAGACACTGGGCGCCAAGGCCCAGGCACAGACTGACCGAGTGAACCTGCGGACCCTG | HLA-G histocompatibility antigen, class I, G; HLA-G |
| 216 | 151531 | 0 | CTAGTTTTATGTTTCTTGGGAAAATATCACTTTGTATTCTCTGTCCAGGGCTTCAGATAT | drebrin 1; DBN1 |
| 217 | 151956 | 0 | CTCACCCACAGGTGCCATGTGCACACTCCTGGTTTTCAAACAATTCTCTGGATTTATTTA | AXIN1 up-regulated 1; AXUD1 |
| 218 | 151962 | 0 | CTCACCCCTGTCCTCAGAGTGATAAACTAAGTCACATACAGATAAAGCACTGAAAACACC | defensin, beta 118; DEFB118 |
| 219 | 152345 | 0 | CTCATGTATGTCTACTGGACTCAGCTCAACATGTTCCAGACCTTGAAGTACCTGGCCATC | ribophorin II; RPN2 |
| 220 | 152725 | 0 | CTCCCTGGCTCTCAGAAGGTATTCCTTTTGTGTACAGTGTGTAAAGTGTAAATCCTTTTT | plasminogen activator, tissue; PLAT |
| 221 | 152892 | 0 | CTCCTCTTGACTCTCCAGACCTAAAGTGACACCCTTCAGGCACTTCGGGCCCAATTCAGC | biogenesis of lysosome-related organelles complex-1, |
| | | | | subunit 3; BLOC1S3 |
| 222 | 153002 | 0 | CTCCTTCTTTTCCAGCCCCGGTACCGGACCCTGCAGCCGCAGAGATGTTGATGCCTAAGA | unassigned |
| 223 | 153036 | 0 | CTCGAAGCAGAGTTGACGGACACTGCTCCCAAAAGGTCATTACTCAGAATAAATGTATTT | protein phosphatase 2, regulatory subunit B, delta |
| | | | | isoform; PPP2R2D |
| 224 | 153055 | 0 | CTCGAGAACCTTGTTTAAAAGCAGAAGACTGCAAGATTCCTTCGCCTCAGAAACCAATCT | nucleoporin 205 kDa; NUP205 |
| 225 | 153297 | 0 | CTCTACTGTCGACTGAAGATCCAAGTGCGAAAGGCAGCTATAACCAGCTATGAGAAATCA | Fc fragment of IgE, high affinity I, receptor for; gamma |
| | | | | polypeptide; FCER1G |
| 226 | 153454 | 0 | CTCTCTACCCTTGCCGTATCTAAGGAGCTGAGGTAATACAGATCCAAGGAGAATTGTATA | general transcription factor IIF, polypeptide 2, |
| | | | | 30 kDa; GTF2F2 |
| 227 | 153812 | 0 | CTCTTGAGAACTTGGCTCAGGGCTCCTGAGGACCTTTCCCAGCATTACCTTCCCTTCCCT | COMM domain containing 4; COMMD4 |
| 228 | 153914 | 0 | CTGAAACTTGATGGCTCCGAACACCCTCGAAGCGCGCCACTCGCTTCCCCCATAGCCACC | oxytocin, prepro-(neurophysin I); OXT |
| 229 | 154230 | 0 | CTGACTCTGAAATCAACCTTACAAATGTGACAGATATCATCAGGGTTCCGGTGTTCAACA | triggering receptor expressed on myeloid cells |
| | | | | 1; TREM1 |
| 230 | 154419 | 0 | CTGAGGGCGAGAAGATCCGAAAGAAATACCCGGACCGGGTGCCGGTGATAGTAGAAAAGG | GABA(A) receptor-associated protein; GABARAP |
| 231 | 154456 | 0 | CTGAGTGTGTTAAGATGGTATTAATCATGTCGGTGTCATGTCACTAAGTTTAATGCTGCT | zinc finger, CCHC domain containing 2; ZCCHC2 |
| 232 | 155029 | 0 | CTGCCTCTCTGGCCCTCTGAGATATCCCGATGGGCACAAATGGAAGGTGCGCACTTGCCC | lipid phosphate phosphatase-related protein type |
| | | | | 2; unassigned |
| 233 | 155318 | 0 | CTGCTGGGATTTGCCCTCCTAGAGTGCCCCTCAGTCCTGGAATACAAGGTGCAGGCTGGA | unassigned |
| 234 | 155892 | 0 | CTGGCTTTCTCAAGAGTATGGATTGACATATTGTGTTATGAATGCACATCTCTCAGATGT | development and differentiation enhancing factor |
| | | | | 1; DDEF1 |
| 235 | 156010 | 0 | CTGGGCGAGCCTCCCGTGCTGCCCGTATCTCGCATGGCCTCCATCCCCTCCATGATCGGG | leucine rich repeat containing 62; LRRC62 |
| 236 | 156146 | 0 | CTGGTCTCACGTGCCATGCCCACTTGCCACCCCTGTTCGTGAACTTTGCCGACCTCTTTC | DKFZp761E198 protein; unassigned |
| 237 | 156640 | 0 | CTGTGCCTAAGAAGCTGCTCATGATGGCTGGTATCGATGACTGCTACACCTCAGCCCGGG | ribosomal protein S2; RPS2 |
| 238 | 156956 | 0 | CTTAAGCAATGTATATGCCATGCATTACCATGCACTAATTCAATCACAGGTGTTTCTATC | calcyclin binding protein; CACYBP |
| 239 | 157206 | 0 | CTTATTGCTGTGAAGGGCAGACAATGCATGGCTGATCTACTCTGTTACCAATGGCTTTAC | casein kinase 1, delta; CSNK1D |
| 240 | 157279 | 0 | CTTCACACAGCCTTTTGAGCACACATGAGAATGTATACTGGAGAGAAACCCTATAAATAT | zinc finger protein 14; ZNF14 |
| 241 | 157389 | 0 | CTTCAGTGGACCGAAATCTGTATTCTGTTTGCGTACTTGTAATATGTATATTAAGAAGCA | tight junction protein 2 (zona occludens 2); TJP2 |
| 242 | 157436 | 0 | CTTCATTGAGGGCCTGTACGACATGCACATTCAGCTGCAGAGTGTGCCCTTCCTGCACTG | chloride channel 7; CLCN7 |
| 243 | 157527 | 0 | CTTCCCCTGCCGATCCTAAATCAACATCAGGAGAAATGCCGGTGGTTAGCTTCATCAAAA | XIAP associated factor-1; unassigned |
| 244 | 157542 | 0 | CTTCCGCAAACTCACCTACCGCGGCACAGACTTGGACCAGCTGCGGGACGTGTCCTGCGA | 40S RIBOSOMAL PROTEIN S15 |
| 245 | 157646 | 0 | CTTCGCTTCCGAAAAAACTTTCAGGCCCTGTTGGAGGAGCAGAACTTGAGTGTGGCCGAG | zinc finger, HIT type 1; ZNHIT1 |
| 246 | 157941 | 0 | CTTGAGTCGACTGGAGGCTGCCAGGAATTCAGGATGCATACAGCTGTAATTTAACCCAGA | chromosome 3 open reading frame 18; C3orf18 |
| 247 | 158058 | 0 | CTTGCGCTCTACTCTGTAGTTATGTGGATTGCCGAGCAATGACCCTTTTCAATTTCTTAT | major facilitator superfamily domain containing |
| | | | | 1; MFSD1 |
| 248 | 158257 | 0 | CTTGTAATATCCCCTTGCTCCTAACATCTACATTCCCTTCGTGTCTTTGATAAATTGTAT | splicing factor, arginine/serine-rich 1 (splicing factor 2, |
| | | | | alternate splicing factor); SFRS1 |
| 249 | 158652 | 0 | CTTTGACCACCTCAGTGCTCAAGAACAATTTGTGTCCCTCGGGCAGCAACATCATCAGCA | CD81 molecule; CD81 |
| 250 | 158661 | 0 | CTTTGAGATTGTCACTTCTGTACATAAACCACCTTTGTGAGGCTCTTTCTATAAATACAT | jumonji domain containing 2B; JMJD2B |
| 251 | 158771 | 0 | CTTTGGGAAGACCATATCCTCCATACTCCTTGGCCGATTTCTCTTGGAACAACATCACTG | chromosome 1 open reading frame 85; C1orf85 |
| 252 | 158784 | 0 | CTTTGTAAAGTACTACCATGCTAAGAACGGCCGTGCTTATGTGGAATCCCCAGCCCGGAA | RUN domain containing 1; RUNDC1 |
| 253 | 158825 | 0 | CTTTGTTTCTGTCCCCTCCGAGGAGTCATTTTGGTCGACAGGCTCTCAAGGCAACTCCCC | kinesin family member 3C; KIF3C |
| 254 | 158876 | 0 | CTTTTCCCGAGAGGCTGACAATGTTAAAGACAAACTTTGCAGTAAGCGAACAGATCTTTG | transmembrane protein 4; TMEM4 |
| 255 | 158926 | 0 | CTTTTGGGAAGAAATCAGCGGAGAACCTTTATGCTTTATCAGAGGCCCCATCCCCAGAAT | RNA-BINDING PROTEIN LIN-28 |
| 256 | 158974 | 0 | CTTTTTTAAGTGTTTTCTATCCGTTATCCATTTCACCCTTGGCCTATCCCTCTCAGATAG | zinc finger protein 282; ZNF282 |
| 257 | 159001 | 0 | GAAAAAATGTGGGAAGCTTGGATTTTCACTCTCACCTGGCAGTCATGAGGTGCTTCTCTC | unassigned |
| 258 | 159269 | 0 | GAAACCATACCGAAGACCTAAGTTCTGTCGAAAAATGAAGTGATGCTCGCGTTTTTAATA | nucleolar protein 9; NOL9 |
| 259 | 159460 | 0 | GAAAGCGAGCCCTCAGCTCAGCCCAGGATCCCCAGAATGCCCTTAGGCCCCCAGGAAGGG | gonadotropin-releasing hormone 2; GNRH2 |
| 260 | 159559 | 0 | GAAAGTTGTTGTATACTGTTAACGATTGTCTGCCCATGTCCTGCCTGAAATACCATGATT | high-mobility group nucleosomal binding domain |
| | | | | 2; HMGN2 |
| 261 | 159749 | 0 | GAACAAAATGCAGCTCCTACCCTCCTCGGGCTTTAGTTGTACCTTAATAACAGGAATTTT | nuclear receptor subfamily 3, group C, member 1 |
| | | | | (glucocorticoid receptor); NR3C1 |
| 262 | 160054 | 0 | GAACGTGCCTCTCTCTTGCTTACAAATGTCTAAGGTCCCCACTGCCTGCTGGAGAGAAAA | killer cell immunoglobulin-like receptor, two domains, |
| | | | | long cytoplasmic tail, 3; KIR2DL3 |
| 263 | 160068 | 0 | GAACTACCAGTCCAAGAATCTGTTTAAAATTCAGACTTCAAATAGTGTCAAATAAAAAGT | similar to ribosomal protein S3a; unassigned |
| 264 | 160171 | 0 | GAACTTGATCCTGAAAAGCCATCTGATTCACTTTCTGCAAGCCTTGGACTTCAATTAGTT | chromosome 4 open reading frame 27; C4orf27 |
| 265 | 160712 | 0 | GAAGCTGGCCCACACCTATCAAAGCCCCCTGCTCTACTGTGACCTGGAGGTGGAAGGCTT | centromere protein M; CENPM |
| 266 | 160973 | 0 | GAAGTCCAAGCAACAGCCTTTGAATGTAACCAATCCTACTAATAAACCAGTTCTGAAGGT | hydroxymethylbilane synthase; HMBS |
| 267 | 161646 | 0 | GACAATAAAAGGTGGCGTTTTTGTACTTTACCTGGATTCCATTGGCTGGTTTTACCACTC | chromosome 14 open reading frame 119; C14orf119 |
| 268 | 161818 | 0 | GACAGAAAGTAAATCTATGGATATGGTATTTTGTGAATGATCTTTTAAATAAAAGAAAAC | eukaryotic translation initiation factor 4H; EIF4H |
| 269 | 161988 | 0 | GACATACGACTCTATTTCCTACAGTGCGAAACTTGTCATTCTAGATGTTCTGTTGCCAGT | eukaryotic translation initiation factor 2, subunit 2 beta, |
| | | | | 38 kDa; EIF2S2 |
| 270 | 162105 | 0 | GACATTGAGCTTGTTTCAAATTCAGCGGCTTTGATTCAGCAAGCCACAACAGTTAAAAAC | ribosomal protein L9; RPL9 |
| 271 | 162160 | 0 | GACCAAGTGCATCTACTGCGGCTTCTGCCAGGAGGCCTGTCCCGTGGATGCCATCGTCGA | NADH dehydrogenase (ubiquinone) Fe—S protein 8, |
| | | | | 23 kDa (NADH-coenzyme Q reductase); NDUFS8 |
| 272 | 162185 | 0 | GACCACCTCCCCCGACTGCCACTCTGGACCTAATAGCTGTTCCTTAGGCCCCACTCCATG | CDC42 effector protein (Rho GTPase binding) |
| | | | | 1; CDC42EP1 |
| 273 | 162244 | 0 | GACCAGTCCCATTCAGATCCGGCTTGGACAGGCACCTGAGATGGTGCCAAAGTGCAGCTG | COMM domain containing 5; COMMD5 |
| 274 | 162427 | 0 | GACCCTGTCAACACCCGCGACCCGTCTGCCTGGCCGTAAGTTTGGTATCTGGCTTTTTCT | unassigned |
| 275 | 162467 | 0 | GACCGCTACCCCCGCAAAGTGACAGCTGCCATGGGCAAGAAGAAGATCGCCAAGAGATCA | ribosomal protein L27; RPL27 |
| 276 | 162550 | 0 | GACCTCCTGCCCGAACCGCGGATCCTGCAGAAACTCGCTGTGCCCATCATCGACACACCC | protease, serine 27; PRSS27 |
| 277 | 162733 | 0 | GACGCCTCGCTGGCCATCAAACCCGTATTTGAGCGTTTCCAGTCTGTCATCATCACATCT | excision repair cross-complementing rodent repair |
| | | | | deficiency, complementation group 2 (xeroderma |
| | | | | pigmentosum D); ERCC2 |
| 278 | 163014 | 0 | GACTCTGAGCTGTGTTAAGGAGAACAAGGGCAAGGAGACCTCCCTTTGTGCTCCCTCACT | similar to CG14977-PA; unassigned |
| 279 | 163028 | 0 | GACTCTTCGAAGACACCAATCTGTGCGCTATTCACGCTAAACGCGTCACCATCATGCCCA | histone cluster 1, H3c; HIST1H3C |
| 280 | 163775 | 0 | GAGAGCGAGCCTGAGCTCTGCTCCCTTGATCTCCTCTGCGTCTCTGCTGGATGGCAGGGC | unassigned |
| 281 | 163821 | 0 | GAGAGGCATCTGTCTGCCGAGGACTTCTCAAGGGTATTTGCCATGTCCCCTGAAGAGTTT | erythrocyte membrane protein band 4.9 |
| | | | | (dematin); EPB49 |
| 282 | 163994 | 0 | GAGATTCACCGGCGAGCCCACTTGTCAGAAAACGAGCTAGAAGCACTAGAGAAGAATGAC | RNA binding motif protein 10; RBM10 |
| 283 | 164265 | 0 | GAGCCCCCTTCAGTCGCAGCCTCACTCTAGGATGAAGCCTGCTGGGAGCGTGAATGACAT | Enah/Vasp-like; EVL |
| 284 | 164335 | 0 | GAGCCTCTAGTCCACCCTCTCCAGTGGTCACTCTTGAGTCACATCTGTCACTTAATTATT | phosphodiesterase 4C, cAMP-specific |
| | | | | (phosphodiesterase E1 dunce homolog, |
| | | | | Drosophila); PDE4C |
| 285 | 164357 | 0 | GAGCCTTGGCCCACACTGAGGCTTAGGCCTCTCTGCCTGGGATGGGCTCCCACCCTCCCC | thymidine kinase 1, soluble; TK1 |
| 286 | 164401 | 0 | GAGCGCTTCCACCGCTTCCAGCCCACCTATCCGTACCTGCAGCACGAGATCGACCTGCCA | transmembrane, prostate androgen induced |
| | | | | RNA; TMEPAI |
| 287 | 164735 | 0 | GAGGACTTTTGTCTGGGATTGGTCATCACTCTTCTGTAATGCCCACCTGCCCCTGCCCAG | major histocompatibility complex, class II, DQ beta |
| | | | | 2; HLA-DQB2 |
| 288 | 164784 | 0 | GAGGAGGAGATCACCAAGTTTGAGGAGCACGTGCAGAGTGTCGATATCGCAGCTTTCAAC | eukaryotic translation elongation factor 1 delta |
| | | | | (guanine nucleotide exchange protein); EEF1D |
| 289 | 165227 | 0 | GAGGTTTCCAAATCAAATATGTTGCAATGGATCCTGTATCCAAATCCAGTCAAGGAAAAA | tumor necrosis factor, alpha-induced protein |
| | | | | 6; TNFAIP6 |
| 290 | 165286 | 0 | GAGTATGCTCGCTATGAGAATGGACACTACTCTTACCGCATCCACCGGTCCCCGCTCTGT | TEA domain family member 4; TEAD4 |
| 291 | 165344 | 0 | GAGTCCCCTACCATGACTGAAGGCGCCAGAGACTGGCGGTGTCTTAAGACTCCGGGCACC | ADAM metallopeptidase domain 15 |
| | | | | (metargidin); ADAM15 |
| 292 | 165355 | 0 | GAGTCCTATGTGGGATGAATAGCTTCAGCCTTTGCGCTTGCACCTCTTTGCTGTCCACTC | unassigned |
| 293 | 165397 | 0 | GAGTCTGCTTTCTTCTACTGCCCTGAGCCTGAACGCTTCTGCTTAATCTGAGAATCACAT | golgi autoantigen, golgin subfamily b, macrogolgin |
| | | | | (with transmembrane signal), 1; GOLGB1 |
| 294 | 165594 | 0 | GAGTTGTCTTTGTACTCTTGAGTTGTACCTTATTCTTCCACTTGGCCTGAGTTTTTATAA | coenzyme Q10 homolog A (S. cerevisiae); COQ10A |
| 295 | 165595 | 0 | GAGTTTATAACTATAATCACCTAATGCCCACAAGGTACTCTGTGGATATCCCCTTGAACA | 60S RIBOSOMAL PROTEIN L27E |
| 296 | 165796 | 0 | GATAGCTGTCCTGTTAGAATCAGAAATCGGTGTGTTATGACGTCCCGTCCGCGTGGTGTG | mitochondrial ribosomal protein S14; MRPS14 |
| 297 | 165993 | 0 | GATCCAACTGCACCCATGGGAAATCTGAACTTCCACTTTCTTTGAGCTTGTCTTTGGTTG | HSPC157 |
| 298 | 166010 | 0 | GATCCAGCAGGTCCTCAAAGACTGTATCGTCCACCTCTGCATCTCCAAGCCCGAACGCCC | protein kinase, cAMP-dependent, regulatory, type I, |
| | | | | beta; PRKAR1B |
| 299 | 166052 | 0 | GATCCCTTGTTTTCCTGTCAGTTGGACCCCTCACCTGGCCTCCAGGGAAGAATGCAGAGA | apelin, AGTRL1 ligand; APLN |
| 300 | 166256 | 0 | GATGAAGAGAGCATTTTCCACTGAGAAATAGAAGTTTGATTAAAAATCAACCTTGCTTCA | actin-related protein 10 homolog (S. cerevisiae); |
| | | | | ACTR10 |
| 301 | 166394 | 0 | GATGATGCTCTCCCGCCACTGAGGCTCCAGGAGGGAATATCTGTTGCCCCTGCGGCCCCA | calcium binding protein 4; CABP4 |
| 302 | 166429 | 0 | GATGCAGATGACTTTGGCCTACAGTTCCCGCTGGACCTGGATGTGAGGGTGAAGGCTGTG | phospholipid scramblase 3; PLSCR3 |
| 303 | 166502 | 0 | GATGCGTGGGCTGACATCTGCAGGCCGAAAGAGCCGTGGCCTTGGAAAGGGCCATAAGTT | ribosomal protein L15; RPL15 |
| 304 | 166813 | 0 | GATGTTTGAGTCCGAGTCCTAGGCCACTCGCTGCCCCTACGCCTGCCCCGGTGCCCGGCT | troponin I type 2 (skeletal, fast); TNNI2 |
| 305 | 166860 | 0 | GATTATATTGGTTCTGCCTCTGGCATGCTGGTAGACTAGGGCCATCCTAACTTATTATTT | IQ motif containing B1; IQCB1 |
| 306 | 166918 | 0 | GATTCCCATACACTGGACAGCCAAGTTACCAGCCAAGTGGTCAGTCTCAGAGTCCTCCCC | dipeptidase 2; DPEP2 |
| 307 | 167208 | 0 | GCAAAATTGCTAAAGAGAGATGAACCACATTATAAAGTAATCTTTGGCTGTAAGGCATTT | CD55 molecule, decay accelerating factor for |
| | | | | complement (Cromer blood group); CD55 |
| 308 | 167373 | 0 | GCAACCGAATTCCAGTTTAGAGGCAGATGTGGTCGTGGACGTGGTCAGCCACCTCAATAA | ribosomal protein S10; RPS10 |
| 309 | 167428 | 0 | GCAAGAACAAGTACCGCCCCGACCTGCGCATGGCAGCCATCCGCAGGGCCAGCGCCATCC | ribosomal protein L28; RPL28 |
| 310 | 167622 | 0 | GCAATCAAGTGGGCTTCATCAATTTAATTTCTTCTCTTTGAGTAAATGAAGATTCAGACT | DKFZp313A2432 |
| 311 | 167654 | 0 | GCAATGGATTCAAGTTCGAAATATGGCAACTTTGAAAGATATCACCAGGAGACTAAAGTC | ATP synthase, H+ transporting, mitochondrial F1 |
| | | | | complex, gamma polypeptide 1; ATP5C1 |
| 312 | 167861 | 0 | GCACCAGCACCTTGGAAGCACCAATAAAGAGGATGCCCACGTGGCCCCAGCAATCAGAAG | inter-alpha (globulin) inhibitor H4 (plasma Kallikrein- |
| | | | | sensitive glycoprotein); ITIH4 |
| 313 | 168184 | 0 | GCAGAAGCATCGGTGCTGATACTCTTCAATAAAATCGACCTACCCTGTTACATGTCCACG | ADP-ribosylation factor-like 16; ARL16 |
| 314 | 168631 | 0 | GCAGGAACCTGCCAGTTCTCCTTGGTGCAAAAATCTGACCCTCGGCTGCCCTGCAAAGGG | PROSTATE SECRETED SEMINAL PLASMA |
| | | | | PROTEIN PRECURSOR |
| 315 | 168915 | 0 | GCAGTGTGAACTCTTTATTCACTCCCAGCCTGTCCTGTGGCCTGTCCCACTGTGTGCACT | tubulin, beta 2C; TUBB2C |
| 316 | 169187 | 0 | GCATGACTATTCAGATGGCTACTGAGTTATCAGTGGCCATTTATTAGCATCATATTTATT | WD repeat and SOCS box-containing 2; WSB2 |
| 317 | 169221 | 0 | GCATGCCTGGAAGTTGTCATGTTTGTGCCACGTTTCAGTTCAGTTCTGAAGTGTTATTAA | voltage-dependent anion channel 3; VDAC3 |
| 318 | 169282 | 0 | GCATGTGAGTGCCCCCAGAACTGTCCTGGCTCCTTCCGTATTAAACGCATTTGCATTTTG | ubiquitin associated protein 1; UBAP1 |
| 319 | 169382 | 0 | GCATTGGAAGGCATAAGACCTACCTGTGCTACGAAGTGGAGCGCCTGGACAATGGCACCT | apolipoprotein B mRNA editing enzyme, catalytic |
| | | | | polypeptide-like 3A; APOBEC3A |
| 320 | 169512 | 0 | GCCAACCATGGTGAACTTGGGTCTGTCCCGGGTGGACGACGCCGTGGCTGCCAAGCACCC | transmembrane protein 141; TMEM141 |
| 321 | 169647 | 0 | GCCACAAGCCTGAATTTCTCAGTGTTGGTAAGTTTCTTTACCTACCCTCACTATATATTA | IKAROS family zinc finger 1 (Ikaros); IKZF1 |
| 322 | 170287 | 0 | GCCCAGTCTTCTATCCCCCACCTAAAAAGACCAAGCATTGATGCCCAAGTTTTGGAAATA | ribonuclease T2; RNASET2 |
| 323 | 170453 | 0 | GCCCGACGTGACCTCCACCCCTAGTGCCTGTGATCTGACTCTGCCCGACGTGACCTCCAC | unassigned |
| 324 | 170536 | 0 | GCCCTACATATGTGAACATTGTGGCAGAGCTTTTAACCAATCCTCGAACCTTACTAAACA | zinc finger protein 724 pseudogene; ZNF724P |
| 325 | 170551 | 0 | GCCCTAGTGTGTAAATGACTTGGATCTCCCTCCTGGCAGACTGTGACCCTCAGCACAGGG | chromosome 22 open reading frame 29; C22orf29 |
| 326 | 170781 | 0 | GCCGCCCAGAAAATGCCATCATCTATAACAACAATGAGGACTTCCAGGTCGGACAAGCCA | transketolase (Wernicke-Korsakoff syndrome); TKT |
| 327 | 170788 | 0 | GCCGCCCTGGCTGTGTGTGAAACATTTGGAGATACCTGGAGTACGGACAGTCACCTCTGA | unassigned |
| 328 | 170844 | 0 | GCCGGAGAAACTGCCCAGCAGATCTGTGAGGACCTCAGGTTGTGTATACCTTCTACAGGT | granulysin; GNLY |
| 329 | 171063 | 0 | GCCTATTGGTATCTGTGTATATTTACGTTAAACACAATTATGTTACCTAAGCCTCTGGTG | synaptotagmin-like 3; SYTL3 |
| 330 | 171985 | 0 | GCGCTAACAGAGCTGGAGATTCTAGATATTTCTTTTAATCTGCTGAGAAACATCGAAGGG | protein phosphatase 1, regulatory subunit 7; PPP1R7 |
| 331 | 172014 | 0 | GCGCTGCCATCATCCAGCCACTGCAGTCGCCGCTGCCGCGCCCCTGAGCCCGGGTCCCTG | unassigned |
| 332 | 172117 | 0 | GCGGCCAGTTTCAGGTCCAGTGAGCATGAGAATGCCTATGAGAATGTGCCCGAGGAGGAA | PDZK1 interacting protein 1; PDZK1IP1 |
| 333 | 172139 | 0 | GCGGCGGCAACGCGGTGGCCTGTCCGGTGTGCCGCGCGCCCACGCGCCTGGCCCCCCGCC | UNCHARACTERIZED |
| 334 | 172191 | 0 | GCGGGCCTCCGTGGAGCTCCTGGATGAGATGAAGTTCTCGCTGGAGAAGCTGCACCAAGG | GRAM domain containing 1A; GRAMD1A |
| 335 | 172470 | 0 | GCTAAGCTGAATAATGACAAAGTTGAAAGGACCAATACAGCCCCTTTTATAAGGATTTTG | CCR4-NOT transcription complex, subunit 1; CNOT1 |
| 336 | 172619 | 0 | GCTAGAAATGACTCCTGAACTTGGACATGTCTACACCTGCCTTGTCGATCACTCCAGCCT | major histocompatibility complex, class II, DO |
| | | | | beta; HLA-DOB |
| 337 | 173310 | 0 | GCTGAAGGTACAAGAAGAAATGCTTAAGGAAGAATTTCAAAAGAAATCTGAGCAGTTAAA | guanylate binding protein 4; GBP4 |
| 338 | 173605 | 0 | GCTGCCTCAAGTCCTGGAAGCCAAATCACAAAGACTATTACAACTGCTCTGCCATGGTAA | p53-associated parkin-like cytoplasmic |
| | | | | protein; unassigned |
| 339 | 173972 | 0 | GCTGTACAGTTCAGTAGAGTGGTCACTTTCACTGCAGTATACATTTATCTACACATTATA | nudix (nucleoside diphosphate linked moiety X)-type |
| | | | | motif 3; NUDT3 |
| 340 | 174085 | 0 | GCTGTGCTCTTTTCAAGCCATGTCCGCAAGGTGAACCGCTTCCACAAGATCCGGAACCGG | myosin IG; MYO1G |
| 341 | 174420 | 0 | GCTTCTACCCTCATACCCACAATATGGATGGGTTCTTCATTGCCAAGTTCAAGAAATTTT | nucleolar protein 1, 120 kDa; NOL1 |
| 342 | 174881 | 0 | GGAAAGCCCTGGAGGGAATCACATGTGTACTTTTTCATGAAGCTTTTTGCAAAGCACATC | coiled-coil domain containing 69; CCDC69 |
| 343 | 175030 | 0 | GGAACCAGGGCATCGAGGCTGCGATGGACTGGCTGATGGAGCACGAAGACGACCCCGATG | SAPK substrate protein 1; unassigned |
| 344 | 175376 | 0 | GGAATAACGAGGACATTTCCATCATCCCGCCTCTGTTTACAGTCAGCGTGGACCATCGGG | signal sequence receptor, delta (translocon- |
| | | | | associated protein delta); SSR4 |
| 345 | 175469 | 0 | GGAATGGGCGAGACATTGCTGCAAAGAAGTCAAGCTTTTTTCAGACAAAAGGTGTGAGGG | thymocyte nuclear protein 1; THYN1 |
| 346 | 176248 | 0 | GGAGACCTGAAGTTGCTCTTTGAGTACCTGACCCTATTTGGCATTGATGACAAAATCTCC | histidyl-tRNA synthetase; HARS |
| 347 | 176372 | 0 | GGAGATCTATCTCTTCTCTCTGCCCATTAAGGAATCAGAGATCATTGACTTTTTCCTGGG | ribosomal protein S2; RPS2 |
| 348 | 176535 | 0 | GGAGCTACTGAAGGTCTCCAAGGACAAACAGGCCCTCAAATTTATCAAGAAAAGGGTGGG | similar to ribosomal protein L36; unassigned |
| 349 | 176569 | 0 | GGAGCTGTCAAGCCCTGCATTGCCTCCCCCTGGACGTCTCATTATGGGAGAAAATGAAGC | unassigned |
| 350 | 176998 | 0 | GCCGCCCTGGCTGTGTGTGAAACATTTGGAGATACCTGGAGTACGGACAGTCACCTCTGA | unassigned |
| 351 | 177291 | 0 | GGATGGGTCCAACGTGGTCTTTAAACTTCTGGGTCCGGTGCTAGTCAAACAGGAGCTGGG | prefoldin subunit 6; PFDN6 |
| 352 | 177583 | 0 | GGCAAGTCAGAGCATTAGCAGCTATTTAAATTGGTATCAGCAGAAACCAGGGAAAGCCCC | IMMUNOGLOBULIN LAMBDA CHAIN C REGION |
| 353 | 177856 | 0 | GGCAGCGTGGATCTGCCCACACATAGGCTACTGGAATAGTTTAACCCAGCAACTTTCCTT | zinc finger, AN1-type domain 3; ZFAND3 |
| 354 | 177865 | 0 | GGCAGCTTGCAGTCCGTGGTGATGAAGAGTTGGATTCTCTTATCAAGGCTACCACAGCTG | HISTONE H2A |
| 355 | 178216 | 0 | GGCCACTGAGTATGTCCACTCCCTCCAGGCCGAGGAGCACCAGCTTTTGCTGGAAAAGGA | v-myc myelocytomatosis viral related oncogene, |
| | | | | neuroblastoma derived (avian); MYCN |
| 356 | 178379 | 0 | GGCCCATCAAAAGCCTTTATCCCTTGACATTTATCCAGGTGAAACAGCATTATGGGTTTG | galactosidase, beta 1; GLB1 |
| 357 | 178628 | 0 | GGCCTCATTCCTTTACCACTCCCACACCTGGAAAGCATATACTATATTACAAAATGACAT | MOESIN/EZRIN/RADIXIN |
| 358 | 178643 | 0 | GGCCTCGACCTGTTGCGCTGGGCCGTCTGTTCCTTCTAGGCACTGTATTTAACTAACTTT | odz, odd Oz/ten-m homolog 3 (Drosophila); ODZ3 |
| 359 | 179899 | 0 | GGGACAGTTTGGTATTAAAACACTTAAATATAGATCCGGTGGTATGGATGAGAAAACAAT | CD47 molecule; CD47 |
| 360 | 179935 | 0 | GGGACCGTCCTGCTGAGAAATTGCACTGAAGAGATGCCCCCACCTCTGGTTGGGCCTGGG | v-maf musculoaponeurotic fibrosarcoma oncogene |
| | | | | homolog F (avian); MAFF |
| 361 | 180173 | 0 | GGGAGGTACAATAAGAACATGTCAGAAGTTCCTAATTCAGTACAACAGGAGACAGCTGTT | processing of precursor 5, ribonuclease P/MRP |
| | | | | subunit (S. cerevisiae); POP5 |
| 362 | 180500 | 0 | GGGCCAAGAAGCAGGAAGCCTTGCGGAGAGTGACGGAGAATCTGGCCAGCCTCACCCCCA | DiGeorge syndrome critical region gene 14; DGCR14 |
| 363 | 180917 | 0 | GGGTACCTCTGCAACAGGAAATCCATGACCCAGCCCTTCACCAGTGCTTCAGCCACCACC | LY6/PLAUR domain containing 5; LYPD5 |
| 364 | 181160 | 0 | GGGTGGAGGGTATGAAAATGACTGCAGCATAGCACGACTGAACAAGCGCAGTTTCTTCAT | pyruvate dehydrogenase phosphatase regulatory |
| | | | | subunit; unassigned |
| 365 | 181239 | 0 | GGGTTCCCCTGCTTCCAACCTCCATTGCACTGCTTCCCCTAAGACTGTGACCTCCTGGAA | LOC338799 |
| 366 | 181391 | 0 | GGTACCAGTGTTACTATGGGTATCCGCCGCTGACCTACCTGGAGTACCCCATCCTCATCG | PQ loop repeat containing 3; PQLC3 |
| 367 | 181496 | 0 | GGTATCACTGACCAAGGAGAAGTCCCCAATGGCTACAATGTCTCCAGATCAACCACAGAG | T-CELL RECEPTOR BETA CHAIN V REGION C5 |
| 368 | 181810 | 0 | GGTCGTATTGAACACCTGGTAACCAAGCCTGCTTTTAACTCTGGTAAAGTGGATATTGTC | GLYCERALDEHYDE 3-PHOSPHATE |
| | | | | DEHYDROGENASE |
| 369 | 181937 | 0 | GGTGAAAGAATTAATGAACTCCAGTACCTGAAAGTGAAAGATTTGATTTTGTTTCCATCT | thioredoxin domain containing 13; TXNDC13 |
| 370 | 182125 | 0 | GGTGCATTTCAGAAAGGATGGAGAACATTTATTATGTGTGAAAGCATCCTCTTCCGGTTT | ubiquitin specific peptidase 48; USP48 |
| 371 | 182284 | 0 | GGTGGCCCATCTGTTCAGGGTGGCTGCACGATTTATGGAAAACAAGATGTCTGCCAACAA | GEM interacting protein; GMIP |
| 372 | 182375 | 0 | GGTGTAATTGAAGGGTGTGAAATGCTTTGTCAATCATTTGTCACATTTATCCAGTTTGGG | YME1-like 1 (S. cerevisiae); YME1L1 |
| 373 | 183023 | 0 | GTAAGGATTGAAAGGCTTGTAATCCAAAGTTACTTTGTACAGACCTTGAAGATTGAAAAA | chromosome 1 open reading frame 41; C1orf41 |
| 374 | 183441 | 0 | GTAGGCGGGTTATCTGCGAACACAGTAGTGGAAGATGTAAAGCAATATTTCGAGCAGTTT | musashi homolog 2 (Drosophila); MSI2 |
| 375 | 183747 | 0 | GTATTTATTGGCTTCAAGGCCCACCTCTCTGTACTCTGGGCTCTAAAGTTGGAGGTCAGG | dynactin 3 (p22); DCTN3 |
| 376 | 184125 | 0 | GTCATCAAGGTGTTCAGTGACATGAAAGTGTGCAAGTCTTCAACACTAGAAAAGGTGAAG | CFLP1 |
| 377 | 184429 | 0 | GTCCCTCCTGGTGTCACCCCAGAGCCACACATGGGCATCTATGGGAGAGTGTCAACCAGA | T-cell leukemia homeobox 1; TLX1 |
| 378 | 184488 | 0 | GTCCGTCTAGCTCACGGGCCCCTCCAGTGGAATGGGTCTTTTCGGTGGAGATAAAAGTTG | mannosidase, alpha, class 1B, member 1; MAN1B1 |
| 379 | 185093 | 0 | GTCTTCCTCGGGCAGCAGGTGGGAAGTGGGAGCCGGAGCGGCAGCTGGCAGCGTTCTCTC | ribonuclease T2; RNASET2 |
| 380 | 185214 | 0 | GTGAAATGTTTGTCACTCTTACTGCACAGACTTATCTGCAATCAAACTGGTTAGTTTTTT | recombining binding protein suppressor of hairless |
| | | | | (Drosophila); RBPSUH |
| 381 | 185730 | 0 | GTGCACTTCCTGGTCATTCCTAAGAAGCCCATTCCTCGGATTAGCCAGGCTGAAGAAGAA | histidine triad nucleotide binding protein 2; HINT2 |
| 382 | 186249 | 0 | GTGGAGAAAGTTTACCCACCAGTGCCTGAGCAGCTACAGCTCCGAATTGCTTTTTGGAGC | spermidine/spermine N1-acetyltransferase 1; SAT1 |
| 383 | 186765 | 0 | GTGGTGCGGAGCTCCTGTTTGACGGTATTAAGAAACATCGAGTCACTTTGCCTGGACAGG | ubiquitin related modifier 1 homolog (S. cerevisiae); |
| | | | | URM1 |
| 384 | 186980 | 0 | GTGTCTGCCGATTCCCGCATTGCAGAACTTCTCACAGAGCTCCATCAGCTGATCAAACAA | coiled-coil domain containing 101; CCDC101 |
| 385 | 187172 | 0 | GTGTTCATCTGAGCATAACTGTACTAAATCCTTTTTCCATATCAGTATAATAAAGGAGTG | phosphoglycerate mutase 1 (brain); PGAM1 |
| 386 | 187317 | 0 | GTTACAACCGCAATCTCTCCAAGACGGAGTTCCTAAGCTTCATGAATACAGAGCTGGCTG | S100 CALCIUM-BINDING PROTEIN A11 |
| 387 | 187369 | 0 | GTTACTAAAACGTGAATCCTAAAATGAGAAGCAGTTCCTGGGACCAGATTGAAATGAATT | SEC11 homolog C (S. cerevisiae); SEC11C |
| 388 | 187518 | 0 | GTTCAAAGGATCGATGGACCGTAAATAAGCTGCCATTAACACATCTGGTTACTGCTGTAA | RNA binding motif protein 22; RBM22 |
| 389 | 187600 | 0 | GTTCATAAGAAGGCAACAAATTCTTCTCCTCTACAGAAGGATTTTGCAAACAATTTGGCA | FAMILY NOT NAMED |
| 390 | 187667 | 0 | GTTCCCAACTGTTGGCCAGAATGAATTCTTCGAAAAATATAGGTGGTTTCCAGGGAATTT | CMT1A duplicated region transcript 4; CDRT4 |
| 391 | 187829 | 0 | GTTCTCGGAGCCATTTGTACATTTCATCACTCAGTGTATGCGAAAACAGCCAAAAGAAAG | mitogen-activated protein kinase kinase 5; MAP2K5 |
| 392 | 187871 | 0 | GTTCTTAAGTTTTTTGCTGCAGGAACCCATTTAGGTGGCAACAACCTTGACTTCAAAATG | similar to laminin receptor 1 (ribosomal protein |
| | | | | SA); unassigned |
| 393 | 187881 | 0 | GTTCTTCGTCACTTAATGTTGGTTCCAGTCCTTCAACTGTTCATATCTACTTTATAACAT | enhancer of rudimentary homolog (Drosophila); ERH |
| 394 | 187987 | 0 | GTTGATTCACCTAACTCATTATTTTGCTTTATTAAAAGTCTTCCTTCACCACCGAGATAT | Ras suppressor protein 1; RSU1 |
| 395 | 188616 | 0 | GTTTTGGATGTACCATTTGTTTCTTATTTGTGTAACTGTAAGTTCACATCAACCTCATGG | ubiquinol-cytochrome c reductase hinge |
| | | | | protein; UQCRH |
| 396 | 188678 | 0 | TAAAAAGGCACAACTCAAATCTCAGAGACACTAAACAACAGGATCACTAGGCCTGCCAAC | chromosome 12 open reading frame 46; C12orf46 |
| 397 | 188703 | 0 | TAAAACCTTGTTTAGTAAAGCCAAGTCATACTATAGAAGAACACATTCAGATGCCAGTGA | Rho GTPase activating protein 5; ARHGAP5 |
| 398 | 188846 | 0 | TAAAGCCAAAGCTGTTACAGAGATGAACATCTTTTGTCAAACCATTAAGAGTTAGAAAGA | chitobiase, di-N-acetyl-; CTBS |
| 399 | 188901 | 0 | TAAAGTTGGAAAGTCCCCGTCCCCCAGAACCTCAAGTCTAGAAACCAGTATGGAAGGGAG | potassium inwardly-rectifying channel, subfamily J, |
| | | | | member 9; KCNJ9 |
| 400 | 189918 | 0 | TACAGCCCCTACCTTCAGAGAGCACCTGGCCTGCAGCTCATCCAAACCTGAGTCTCCTCT | PQ loop repeat containing 2; PQLC2 |
| 401 | 190073 | 0 | TACATTACCCATCTCCTCTTTTGCCTCTGAGAAAGAGTATATAAGCTTCTGTACCCCACT | histone cluster 1, H2bk; HIST1H2BK |
| 402 | 190074 | 0 | TACATTAGATGGTGTGTCCCGGAAGAAACTTCACCTGAGAACTTTTGAACTGAGGAAAGA | solute carrier family 4 (anion exchanger), member 1, |
| | | | | adaptor protein; SLC4A1AP |
| 403 | 190302 | 0 | TACCTAGTCCCCAGCCTGCTCCCTAGCCAGAGGCTCTAATGTACAATAAAGCAATGTGGT | cytochrome P450, family 2, subfamily D, polypeptide |
| | | | | 6; CYP2D6 |
| 404 | 190571 | 0 | TACTATTGGTGTAGAGTTCGGTGCTCGAATGATAACTATTGATGGGAAACAGATAAAACT | RAB2, member RAS oncogene family; RAB2 |
| 405 | 190803 | 0 | TACTTCTTCCATGAATTGGCCAAGGAGAAGCGCAAGGGTGTTGAGCGTCTCCTGAAGATG | FERRITIN LIGHT CHAIN |
| 406 | 190949 | 0 | TAGACCTGATGTGTTAGATACTGCTTTGTTACGACCTGGAAGATTAGATAAGATCATCTA | spermatogenesis associated 5-like 1; SPATA5L1 |
| 407 | 191074 | 0 | TAGATCAACTTTTAACTCAGAGTCCTGGTGACTATATCCCCATATCCTATGAACAGATAT | chromosome 10 open reading frame 46; C10orf46 |
| 408 | 191350 | 0 | TAGGAAGTATTAAAACTGTGAAGCTTTCTCAGTGCACTTTGAACCTGGAAAACAATCCCA | LIM domain kinase 1; LIMK1 |
| 409 | 191714 | 0 | TATAAACTACTTATAAAGGCCCTTCAGTTATCTGAACCTGGCAAAGAAATTCACTGATTT | transmembrane protein 126A; TMEM126A |
| 410 | 191970 | 0 | TATCACTTTGGCTGGACCCACTAATGCCATCTTCAAAGCCTTTGCTATGATCATTGACAA | poly(rC) binding protein 2; PCBP2 |
| 411 | 192246 | 0 | TATGACCCCTGGACTAACCCCAGCCAATTCCCAGGCCTCAAAAGCCACTCCCAAGCTAGA | Treacher Collins-Franceschetti syndrome 1; TCOF1 |
| 412 | 192503 | 0 | TATGTGAAGAAAATGCAAACCTTTCAATTCCCACGTGTATACAAGCTAATGTGATGAGGG | DCN1, defective in cullin neddylation 1, domain |
| | | | | containing 5 (S. cerevisiae); DCUN1D5 |
| 413 | 193530 | 0 | TCACATAACTGTAATATTTGGTTGCTCAGCATAAGTGATGGAAGCAAACACTAATTTCTA | tumor necrosis factor, alpha-induced protein 1 |
| | | | | (endothelial); TNFAIP1 |
| 414 | 193540 | 0 | TCACATATGGATACTTTCACAGTTCAGGATTCCACTGCAATGAGCTGGTGGAGGAATAAT | DTFT5783; unassigned |
| 415 | 193857 | 0 | TCACTGTCACATTCTTTGATGTTTCTGAGCAAAATGCCCCGGCTCCCTTCCTGGGCATCG | KIAA1539; KIAA1539 |
| 416 | 194644 | 0 | TCATACGTTGTCCAGCTGTAAGTTCATTTGAGTAGCAGACCTAACAAATATTTGAGGTCA | Mof4 family associated protein 1; MRFAP1 |
| 417 | 194925 | 0 | TCATGGACAGACTGGCCTTCTTAGCTGTACTATAAATTTGTGAGTGAAGTTAGAGCCCAG | chromosome 1 open reading frame 142; C1orf142 |
| 418 | 194980 | 0 | TCATGTGCTGGTACCAATAGGACAGGAAGATTTTAATCAGCTTTACTATCTATGTTTTTT | pyridoxamine 5′-phosphate oxidase; PNPO |
| 419 | 195090 | 0 | TCATTTATATCCCCACCGCAATACTGTGGATTATCCCCCAGAAAGCTGTTCGTTGGATTC | Yip1 domain family, member 1; YIPF1 |
| 420 | 195189 | 0 | TCCAACATTGGGAATAATTATGTATCCTGGTACCAGCAGCTCCCAGGAACAGCCCCCAAA | hypothetical protein similar to KIAA0187 gene |
| | | | | product; unassigned |
| 421 | 195508 | 0 | TCCAGCCTCTACCATCACCTGCATGTGGCCGACACACGCTTCGACATGGTCCAGCTCATC | v-raf murine sarcoma 3611 viral oncogene |
| | | | | homolog; ARAF |
| 422 | 195786 | 0 | TCCATTCTTTTGAGCAGGTTAAAGCCATTCACATCCATTCTGACATGTTCTCAGTTCAAA | acyl-CoA synthetase long-chain family member |
| | | | | 6; ACSL6 |
| 423 | 196233 | 0 | TCCCTGCCCTCACCTGCAAATGAGTTAAAGAAGAGGCGTGGGAATCCAGGCAGTGGTTTT | MAP/microtubule affinity-regulating kinase 4; MARK4 |
| 424 | 196303 | 0 | TCCCTTGTTTAGAACACGAATTTCCATTTACCTGGTGGGAACACGAAACAGGAGTCTCTT | golgi autoantigen, golgin subfamily a, 1; GOLGA1 |
| 425 | 196427 | 0 | TCCGGCATTACTATGTCATGGTCATCTGCTACGTCTACTTCACCCGCATCATCGCCATCC | G protein-coupled receptor 108; GPR108 |
| 426 | 196494 | 0 | TCCGTGGGCATCATGTTGACCGAGCTGGAGAAAGCCTTGAACTCTATCATCGACGTCTAC | S100 calcium binding protein A8; S100A8 |
| 427 | 196650 | 0 | TCCTCAGCCAGCACAGGGAAATCCAGACTCAGGGTTCCAGAAATCCCCCGTTCCCAAACC | myotubularin related protein 3; MTMR3 |
| 428 | 196711 | 0 | TCCTCCCCGCCGCCCACCTCAGAATTCCTTCCTCCCCGGCCCCTAGTGGGAGCTTAGGCC | unassigned |
| 429 | 196942 | 0 | TCCTGGCATTCTCTCAGAAGCTGTACTACGACAAGGAACAGACAGTGAGCATGAAGGACA | carbonic anhydrase IV; CA4 |
| 430 | 197238 | 0 | TCGAAAGTGCGAATCTGACTTACGCCATTATTACGACAGTACCATTGAGTTGTGCGTGGG | granzyme B (granzyme 2, cytotoxic T-lymphocyte- |
| | | | | associated serine esterase 1); GZMB |
| 431 | 197310 | 0 | TCGAGATAAGAGAGCAGATGTTGGAGAATTCTTCTAGATTTTCAGAACTTGAAGACTATT | interferon-related developmental regulator 1; IFRD1 |
| 432 | 197392 | 0 | TCGCACCAGGGTGGAAAAAAAGGGAATAGTGTTCAAATCACTGATGGAACTGGATGACGC | unassigned |
| 433 | 197394 | 0 | TCGCACGCGCGCCCTCCCTGGCCGGGCCCACTCGCCACGCGCCCAGCCATGAACCTGGCG | unassigned |
| 434 | 197890 | 0 | TCTAATACCATCCTGCCCATTGTCCTTACCGTCCTGCCCATACAGACTGTGGCTCCTTCC | paired box gene 4; PAX4 |
| 435 | 198202 | 0 | TCTCAAGTGGCAGTTTCATTATTTAGAATGCAAGGTGGACATCTTTTGGATATCTTTTTC | SWI/SNF related, matrix associated, actin dependent |
| | | | | regulator of chromatin, subfamily c, member |
| | | | | 1; SMARCC1 |
| 436 | 198318 | 0 | TCTCATCCTACTTAGCCTACCTAGATTTCTCATGACGAGTTAATGCATGTCCGTGGTTGG | brain abundant, membrane attached signal protein |
| | | | | 1; BASP1 |
| 437 | 198473 | 0 | TCTCCGTCTCTGTCTCAAATTTGTGGTCCACTGAGCTATAACTTACTTCTGTATTAAAAT | HLA-G histocompatibility antigen, class I, G; HLA-G |
| 438 | 198548 | 0 | TCTCGGAGTGGCTTTCGCTGGAGAGGTGCTTTGCTGTCTCTCAGACTCAGTCACTGTGTT | blocked early in transport 1 homolog (S. cerevisiae)- |
| | | | | like; BET1L |
| 439 | 198718 | 0 | TCTCTGTTTCTTGGAAAGGTATCTATTACATCCTGCTAGCTGACTGACAAAACTAAGCAG | ring finger protein 11; RNF11 |
| 440 | 198784 | 0 | TCTGAAACACTGGGAGCCTGAGATTCCAGCCCCTATGTCAGAGCTCACAGAGACTTTGGT | major histocompatibility complex, class II, DQ alpha |
| | | | | 2; HLA-DQA2 |
| 441 | 198911 | 0 | TCTGAGTTAACGTTTCAGCTGTATCATTAGACTTGTATTTAGAGCGTGTCACTTCCTCTG | YTH domain family, member 1; YTHDF1 |
| 442 | 199145 | 0 | TCTGGAAAGCAGTCTGCCCCTGGAAGTGGTAGCAAGATTCCACAGAAAAGAAGTAAAACT | NUCLEOPHOSMIN 1 |
| 443 | 199887 | 0 | TCTTGCATTAGCAGTGCCCACTGATGGCATTACTCTGCACTATAGCCATTTGCCCCAACT | UBIQUITIN |
| 444 | 200193 | 0 | TGAAAACAGATCGACCTTTACCGGAGAATCCCTATCACTCAAGACCAAGACCGGATCCCA | NADH dehydrogenase (ubiquinone) 1 alpha |
| | | | | subcomplex, 8, 19 kDa; NDUFA8 |
| 445 | 200749 | 0 | TGAAGGACCGCCCATTCTTCCCTGGGCTGGTGAAGTACATGAACTCAGGGCCGGTCGTGG | non-metastatic cells 2, protein (NM23B) expressed |
| | | | | in; NME2 |
| 446 | 200967 | 0 | TGAATGTTGAAAACTGCAATGTCCGTTATGAGGGCCAAAAATCTGTTTTGAAGGCAGCTA | unassigned |
| 447 | 200998 | 0 | TGAATTTGATGAAGTGATGTTTCCAAAGAACGTGAGGTGCTCTACTTGTGATTTAAGGAA | zinc finger, DHHC-type containing 4; ZDHHC4 |
| 448 | 201203 | 0 | TGACCACCAGGCTATGACGTTCCTGCTGCGCATTACAGAAAGCTTTTAACTGTGATCAGG | KIAA1706 protein; unassigned |
| 449 | 201206 | 0 | TGACCACTATGCTGTCATCAAGTTTCCATTGACCACTGAGTCTGCCATGAAGAAGATAGA | 60S RIBOSOMAL PROTEIN L23A |
| 450 | 201287 | 0 | TGACCTCTCCCGCCGCATCTGCCTCTTCCTGACCACAGCCAACCCTGATCTCCTGCTGGA | essential meiotic endonuclease 1 homolog 2 (S. pombe); |
| | | | | EME2 |
| 451 | 201530 | 0 | TGAGAACAAGCAGGATGCTGTGGACTACCTCACCTGGACCTTTCTGTACCGCCGCATGAC | activating signal cointegrator 1 complex subunit 3-like |
| | | | | 1; ASCC3L1 |
| 452 | 201628 | 0 | TGAGAGCCATCCCAGTAACCCGACCACCGCTGGTCTTCACTGGACACCATGAACCACACT | INTERFERON INDUCIBLE TRANSMEMBRANE |
| | | | | PROTEIN |
| 453 | 201746 | 0 | TGAGCCGAGCCCCTGCCACCAGCCTCCTCCGCACGCCCGTGGAATCAGCACTTTCTGCTT | unassigned |
| 454 | 201805 | 0 | TGAGCTGTGACTCAACTGCTTCATTAAACATTCTGCATTGGGTATAATCTAAGAATTGTT | ubiquitin-conjugating enzyme E2, J1 (UBC6 homolog, |
| | | | | yeast); UBE2J1 |
| 455 | 202075 | 0 | TGAGTTCTTTTGAAGCTGATCTCAGGCATCGGATTATTTCTTCTGTAAATATTTCAGAAT | mitochondrial ribosomal protein L34; MRPL34 |
| 456 | 202139 | 0 | TGATACTGAACCTTGATTAATAACAGAAATTCAGGATGTAAAGCCACAGAATGGGATTTA | phosphatidylcholine transfer protein; PCTP |
| 457 | 202480 | 0 | TGATGTGACTTACAATTGGATTCAAGATAAATGTGTTCCTCTTGTCCGAGAAATAACATT | thioredoxin domain containing 4 (endoplasmic |
| | | | | reticulum); TXNDC4 |
| 458 | 202690 | 0 | TGCAACCTATGGGCTATGCAACTTCTTATGGACAGCCTCCCACTGGTTATGCTACTCCAA | RNA BINDING PROTEIN |
| 459 | 202780 | 0 | TGCAATGCGTGTTGTACATACAGAGGTAACTATCAATATTTAAGTTTGTTGCTGTCAAGA | adrenomedullin; ADM |
| 460 | 202943 | 0 | TGCAGAATTTTATTTTACTTTTTTTAAAGCTATGTTGTTAGCACACAGAACACTTCATTG | unassigned |
| 461 | 203036 | 0 | TGCAGCTTGCAATCCGTGGTGATGAAGAGTTGGATTCTCTTATCAAGGCTACCATAGCTG | H2A histone family, member V; H2AFV |
| 462 | 203177 | 0 | TGCATCCCCAGAGTACAGCGAGTTTCCCGCCTCCCGTTAGAGATCCAACACATATTTTTT | hypothetical LOC340094; unassigned |
| 463 | 203507 | 0 | TGCCATTGGTTGTATTTTTGTTCTGAGTTTTCGGTGCCGTGTTCCTAACTACTCCATCCC | tweety homolog 3 (Drosophila); TTYH3 |
| 464 | 203573 | 0 | TGCCCCAGTTTGAGAAGTGGTTGCAGGACAATTTAACCATCGTTGCTGGTATTTTCATAG | tetraspanin 5; TSPAN5 |
| 465 | 203663 | 0 | TGCCCTTCCTACTCCTCATAGCATGATATTGTTCTCCAAGGATGGGAATCAGGCATGTGT | signal transducer and activator of transcription 2, |
| | | | | 113 kDa; STAT2 |
| 466 | 203967 | 0 | TGCGCATGTTGTGCCACCACTGCAGCTCCAAGGCCTACCACCTTCAGAAGTCAACCTGTG | 60S RIBOSOMAL PROTEIN L37 |
| 467 | 204015 | 0 | TGCGGAGCCTGTTAAAGGTCACTCAGATGTGCAGGTGTTAATCTTCTCTAAAAGCCTGGT | SECIS binding protein 2; SECISBP2 |
| 468 | 204151 | 0 | TGCTACACAAAAGCCAAAAGGTTTCATGTAGATTTTAGTTCACTAAAGGGTGCCCACAAA | hexokinase 2; HK2 |
| 469 | 204296 | 0 | TGCTCCGAGAGAATGGTGACTCCTTGCAGAAAGCCATGATGCAGATACTACAGGAAAAAA | myxovirus (influenza virus) resistance 2 (mouse); MX2 |
| 470 | 204604 | 0 | TGCTGGTTCTTTGGATAATGGAGTTCTTGTGTTAACAAATTACGTGCTATATGATTTTTT | zinc finger protein 518; ZNF518 |
| 471 | 204784 | 0 | TGCTTTAAATCACTATCAAAGTTACAAGAAATGTTTGGCTTATTGTGTGATGCAACAGAT | protein phosphatase 1A (formerly 2C), magnesium- |
| | | | | dependent, alpha isoform; PPM1A |
| 472 | 205183 | 0 | TGGACAGCCACCTTTGACCCAGTGCCTACAGATGCCCCGACCAGCCCCCGAGTCTCCGGG | SAPS domain family, member 1; SAPS1 |
| 473 | 205249 | 0 | TGGACCCTGAGCAGCTTCTTGGGCCCTGGTACGTGCTTGCGGTGGCCTCCCGGGAAAAGG | lipocalin 6; LCN6 |
| 474 | 205389 | 0 | TGGAGAGAGCAAGTGGCATTTGCTGAAGTGCATTTCCGGTAGAAAACTCCAGTGGTCCCT | unassigned |
| 475 | 205731 | 0 | TGGATGTGAAGATATGGTACCTTCTCAAGTGTAGCTCTTTCAAATATAGTCAATGCTGGG | hypoxia-inducible factor 1, alpha subunit |
| | | | | inhibitor; HIF1AN |
| 476 | 205999 | 0 | TGGCCAAAGTGAGCGAGTTAGGTGATCTTGGTTTCAATTTCCGAGCCTTTGTTAATATGG | ceroid-lipofuscinosis, neuronal 5; CLN5 |
| 477 | 206122 | 0 | TGGCCGCTGTACACTTTTTGCAACTGGTTTGATGTCACATTTCAGCTCCAACTTTGCATC | chromosome 1 open reading frame 108; C1orf108 |
| 478 | 206232 | 0 | TGGCGGCGCAACTCCGAAGAAGAGCGCTAAGAAAACACCGAAGAAAGCGAAGAAGCCGGC | histone cluster 1, H1c; HIST1H1C |
| 479 | 207292 | 0 | TGGTGCTAATGATGGACAGTTAAAAAGATAGCTAGTGTATATTGTTATGGGTCAGTACTT | cyclin T2; CCNT2 |
| 480 | 207649 | 0 | TGTAATACTCCCTTTGGGCGAAGCTAACATCGGTGCCTCCCCGACCTTGCTGACTAGGCA | plasma membrane proteolipid (plasmolipin); PLLP |
| 481 | 207683 | 0 | TGTACACTTGTATAAGTACCGTTTACTTCATGGCATGAATAAATGGATCTGTGAGATGCA | chromosome 14 open reading frame 2; C14orf2 |
| 482 | 207727 | 0 | TGTACCTCTGGATTGGCGGAAGTAAATCTGGAAGGATTCTCACTCGTATTTCCCACCCCT | hypoxia up-regulated 1; HYOU1 |
| 483 | 207803 | 0 | TGTAGCAAACTCATACTGGATCATTTCAGTTACCTTGAACTAATAGCACATAATGGTTTT | v-myb myeloblastosis viral oncogene homolog (avian)- |
| | | | | like 1; MYBL1 |
| 484 | 208381 | 0 | TGTCTCACGTGGTGGATCCGGTGGAAATCCAAGCTCTGGGCTGGTAATTTTTATGAGCAT | ligatin; LGTN |
| 485 | 208509 | 0 | TGTCTTGTTTCAGTCCATGATCCCACTGACCTACTCTTGCCTGCTGGAGGGTAATGAGAA | aminomethyltransferase; AMT |
| 486 | 209686 | 0 | TGTTTACATCTCCCACATTCATACCAATATACGTCAGGTTTGCTTAACCATTGATTTTTT | protein tyrosine phosphatase type IVA, member |
| | | | | 1; PTP4A1 |
| 487 | 209738 | 0 | TGTTTCTCGTTTTCATCATATAGACAAAACAGCCCTGCTGCAAAGATGGTCAACGTACCT | ribosomal protein L36a-like; RPL36AL |
| 488 | 209946 | 0 | TTAAATGTGGAGGCTTTCTATAGCATTCTAAGCTGAGAAGTAGATTGTTACCCAGTAATG | TBC1 domain family, member 15; TBC1D15 |
| 489 | 209952 | 0 | TTAAATTTCGTTTGTCTGGAATATTTTGTATGAGTTCTTGAATAAAACTTGGGAACCAAA | similar to 60S ribosomal protein L22 (Heparin-binding |
| | | | | protein HBp15); unassigned |
| 490 | 210426 | 0 | TTACTCTAGCGCCACTGAATTTTTTCTCTTAGGCTTCCCTGGCTCCCAAGAAGTATGCCG | OLFACTORY RECEPTOR MOR120 |
| 491 | 210617 | 0 | TTAGGAGGAAGTTGTGTCCAGTTCAGGGTGCCCTCGGGAGCCCTGTCCCTGTTGCTGTGG | SRY (sex determining region Y)-box 12; SOX12 |
| 492 | 210742 | 0 | TTATAGAAAGGACACAAGTTTGTTTCCTGGCTTTACCTTGGGAAAATGCTAGCAACATTA | calpain 2, (m/II) large subunit; CAPN2 |
| 493 | 211052 | 0 | TTATTTTAGTAAAATGCCCAGGAGTCCTGGAAGCTACGCGGACTTGCAGAGGTTTTATTT | EF-hand domain family, member D2; EFHD2 |
| 494 | 211174 | 0 | TTCAAGGTCTGTTTTTCTAACTGAAAAGCTAAGGGCTTGATTCCTAGCCCCGTTCTGTGG | unc-84 homolog B (C. elegans); UNC84B |
| 495 | 211734 | 0 | TTCCAAGTCAAGTACTCTGGGACCGAGTGCACTGAAGACGATAGGAAGTTCAGCATCAGT | KIN, antigenic determinant of recA protein homolog |
| | | | | (mouse); KIN |
| 496 | 211931 | 0 | TTCCCAGGTTTAATGAAAGAACCCAACTTAGTTTTTCAGTGAATTTGACACCTATTTTTT | huntingtin interacting protein 2; HIP2 |
| 497 | 212006 | 0 | TTCCCTCGGTACCATCCGTTCTATCCCATTCCCTGGACCAAATGTTTGCAATATATAACA | unassigned |
| 498 | 212174 | 0 | TTCCTCGTCAGTGGTCAAGGTGTGTCATCCATACAGCTCCATGCCTTTGTCTTTTTTAAA | protein-O-mannosyltransferase 1; POMT1 |
| 499 | 212468 | 0 | TTCGTTGGGCACAACAGGAACGTATATGACTGCTGCTGCTCCTATGCAAGGGACCTACAT | RNA binding motif, single stranded interacting |
| | | | | protein; RBMS3 |
| 500 | 212680 | 0 | TTCTCGACATCGAGGACCCATAAGCAGGCCTCCAACGCCCCTGTGGCCAACTGCAAAAAA | TIMP metallopeptidase inhibitor 2; TIMP2 |
| 501 | 212834 | 0 | TTCTGCTTCCTTGGATGTCATTGCTTAAATATAGTCTTGAAGGGCTTGTTTTGAAATATT | phosphoinositide-3-kinase, class 3; PIK3C3 |
| 502 | 212992 | 0 | TTCTTCAGTCATGGCATTCGCAGTGCCCAGTGATGGCATTACTCTGCACTATAGCCATTT | ubiquitin B; UBB |
| 503 | 213386 | 0 | TTGAGCCCAGGCATCGTTGAGCATTAACACTCTGTGACAGAGCTGCAGACCCCTGCCTTG | cytokine induced apoptosis inhibitor 1; CIAPIN1 |
| 504 | 213392 | 0 | TTGAGCTCAACTACATGGTCTACATGTTCCAGTATGATTCCACCTATGACAAATTCCATG | GLYCERALDEHYDE 3-PHOSPHATE |
| | | | | DEHYDROGENASE |
| 505 | 213429 | 0 | TTGAGGGTAGGTCAGGAGTGTCAACGTGCTTGTACATAGAGTGTCTGCTGTAGCTGTGTG | ATF4 |
| 506 | 213480 | 0 | TTGATATTGTAGACGTCAAGGGAATGGGTACTGTTCAAAAAGGAATGCCCCACAAGTGTT | ribosomal protein L21; RPL21 |
| 507 | 213580 | 0 | TTGCAAGACATACCAGAGAAGGACTTCATTGTTTTCTGCTCTTCAACCTCATATAACGTG | CASPASE-1 |
| 508 | 213805 | 0 | TTGCCTGAGGCAGAGCAAGACGGGTTCTCACCCCTGACTTCTGGAGGCTTCCCTTGAAGC | nuclear prelamin A recognition factor-like; NARFL |
| 509 | 213915 | 0 | TTGCTGAACGTTCTGATTCCACCCAATATGCCATGTACGCGAACAGGGAAGAATAACGTT | nucleoporin 50 kDa; NUP50 |
| 510 | 213922 | 0 | TTGCTGAGAACCAACTTTCAATAGTCATGAGAGAATCAAATAATAGATGTCCGTACAAGT | Wilms tumor 1 associated protein; WTAP |
| 511 | 214614 | 0 | TTGTATTCATTGTGGATGTTAAAGCCAACAAGCACCAGATCAAACAGGCTGTGAAGAAGC | 60S RIBOSOMAL PROTEIN L23A |
| 512 | 214774 | 0 | TTGTGCGTCATAGAACCCAGAAGGAAATTGAGCAGGAAGCTGCAGTTGAATTATCACAGT | ubiquinol-cytochrome c reductase, Rieske iron-sulfur |
| | | | | polypeptide 1; UQCRFS1 |
| 513 | 215062 | 0 | TTTAATCAAGATTAAGAATGAAGTTGACTCTACTTTGACCTTCCGAAGATCATGCAGAGA | succinate dehydrogenase complex, subunit B, iron |
| | | | | sulfur (Ip); SDHB |
| 514 | 215112 | 0 | TTTACAGCACTGTTTTTTATGTAGTTACAACATGATGTGATTGTAGCTTTTTAAACTATG | PHOSPHATIDYLINOSITOL-GLYCAN |
| | | | | BIOSYNTHESIS, CLASS F |
| 515 | 215448 | 0 | TTTCACTTAACCCCAGGCCATTATCATATCCAGATGGTCTTCAGAGTTGTCTTTATATGT | aminolevulinate, delta-, synthase 1; ALAS1 |
| 516 | 215752 | 0 | TTTCTCAAAGACAGCAAAAACCTCTCAAACTGAGGAGCAACATTTATTCTTACTAAGCAG | sterile alpha motif domain containing 9; SAMD9 |
| 517 | 216334 | 0 | TTTGGCGTCAGCTTCGAGTGCTTCGCCTCACCCCTCAACTGCTACTTCCGCCAGTACTGT | chromosome 20 open reading frame 67; C20orf67 |
| 518 | 217279 | 0 | AAACCATTGAGAAGATGCAGGAATAAAGTAATCTTATATACAAGCTTTGATTAAAACTTG | ribosomal protein L26; RPL26 |
| 519 | 217674 | 0 | AAGGCATCATGGATTCCCTGTTCCAGTCCTTCAATGCCTCCATCTCAGTGGCCAGCTTCC | MAX-like protein X; MLX |
| 520 | 217758 | 0 | AATAAAGACCTATGTACTTAATCCTTTAACTCTGCGGATAGCATTTGGTAGGTAGTGATT | growth factor receptor-bound protein 2; GRB2 |
| 521 | 218201 | 0 | ACCCGGAAACAAACTTGCCAGTTGGGTATCCTCCTCAGTATCCACCGACAGCATTCCAAG | phospholipid scramblase 1; PLSCR1 |
| 522 | 219140 | 0 | AGGCTTTAATGAGCGTGTGACCTGGGCCACGTCCTGTGGCGTTTGTTCTCCTAGGCCAAC | calcium and integrin binding 1 (calmyrin); CIB1 |
| 523 | 219147 | 0 | AGGGAATCCCGTGGGTTGCTTACCTACCTATAAGGTGGTTTATAAGCTGCTGTCCTGGCC | signal transducer and activator of transcription 3 |
| | | | | (acute-phase response factor); STAT3 |
| 524 | 219372 | 0 | ATAAATTTGCCCAAAATCCTAAAGACCGGGAAAAGGGAACCATTGAGCTTGGCAAAAAAA | CD8b molecule; CD8B |
| 525 | 219934 | 0 | CAAAAAAGTGCACTGCTCTTCTGTCTATTGTACCGACTTAACCTCTTCCACCCAAGTCCG | armadillo repeat containing, X-linked 6; ARMCX6 |
| 526 | 220398 | 0 | CAGCCCCCTCATCATGCAGTTGCTGAGAGACAACCTAATAACACTGTGGACATCACACAG | 14/03/2003 |
| 527 | 222165 | 0 | CTGATAAAGGAAGCAGGAAGCGCTATGAACCATCAGACAAGGACAGGCAGAGCCCTCCTC | conserved nuclear protein NHN1; unassigned |
| 528 | 222692 | 0 | GAAGAGATAGAGATAGTAAAATGTGAAAATGCTACAGTTATGGATAAGGCCCGAGCTTTG | inhibitory caspase recruitment domain (CARD) |
| | | | | protein; unassigned |
| 529 | 223130 | 0 | GATACCCAAAGGTCAAGAACACAGTGATTTTATTAGAAGTTTCATCCGCAAATTTTCTTC | 2′-5&apos; -oligoadenylate synthetase 2, |
| | | | | 69/71 kDa; OAS2 |
| 530 | 223180 | 0 | GATGCTGGAGGGAACAGTGAAGTGCAGCAGATGATGCTTCGAGGGTGGCTTTGAGGCCAC | DKFZp586I1420 |
| 531 | 223539 | 0 | GCCCACCTCCGGGACTGACTGGTCAGAAGCCACCCTTGTCTACGTGGGATAATTCTCCCC | trinucleotide repeat containing 6A; TNRC6A |
| 532 | 223554 | 0 | GCCCCACCAGTACCCATATGCAGGACTTTATGGACAGCAGCCTGCTAACCAAGTCATCAT | pleckstrin homology domain containing, family B |
| | | | | (evectins) member 2; PLEKHB2 |
| 533 | 223717 | 0 | GCGCAAGAAGTTCAACATGGACCCCGCCAAGGGTATCCAGTATTTCATTGAGCACAAGCT | pleckstrin homology, Sec7 and coiled-coil domains |
| | | | | 4; PSCD4 |
| 534 | 223796 | 0 | GCTATATATACTCGAGCACTCTCCATATAATGCCTCCATTTACCAACTTGCTCTTAAAAA | chromosome 9 open reading frame 66; C9orf66 |
| 535 | 223896 | 0 | GCTGCCAGCTACCAGCCTGGCTGGCCCTGTCCTGTCCACCCTCATTGCCCCAACTCCCAT | WD repeat domain 33; WDR33 |
| 536 | 224201 | 0 | GGAGGGCCTCCTGCTCCTCCTGGCGCTAGGAGAGCCCCACTCGGTGTGGCACGGAGACAC | ribosomal protein L7a; RPL7A |
| 537 | 224302 | 0 | GGCAGGTTAGAGCTAGTGTATGTTACTGTGAATTGTAATGTAGTTGGATTGTACAAATTA | FAST kinase domains 5; FASTKD5 |
| 538 | 224390 | 0 | GGCGCGGACCAAAGCGATCTCTTCTGAGGATCCGGCAAGATGGCAGAAGTAGAGCAGAAG | ribosomal protein S15; RPS15 |
| 539 | 224678 | 0 | GGTCAGAACCGTGATTCGAGCCTTTGTGAAATGCACCAAAGCCCGATACCTGAAGAAAAA | mitochondrial ribosomal protein L20; MRPL20 |
| 540 | 224990 | 0 | GTCTTTATGAAGAACTCCTTCAAGGATGTGGACCATCTGTTTCAAAAGAAATTAGCGGCC | unassigned |
| 541 | 225234 | 0 | GTTCCTGGCTCGCCGTCTCCGCTGCCGCTTGACCGCACTTCTGGAGGGCTCCGCACCTTG | unassigned |
| 542 | 225433 | 0 | TACAGAACTAGACCAGAAGACATTTGTGGATAAATCTGAACTCACTTCCTGTGTGTAACT | coiled-coil domain containing 23; CCDC23 |
| 543 | 226380 | 0 | TGAACTTTCTGCTGAGCGAGCACCGCCAGGCCCTGGCCTCCGCCAAGCACCGAGGCCCCG | unassigned |
| 544 | 226634 | 0 | TGCAGAGTGGCGTCCTCAAGTCCCTCTCCCTGCACCCCTGCCCCTCACGCATAGTGCCAC | unassigned |
| 545 | 226833 | 0 | TGGAATGTGAAGCGTATGCAATTCCTTCTGCCTCCCTCAGCTGGTACAAGGATGGACAGG | hemicentin 1; HMCN1 |
| 546 | 227814 | 0 | TTTCCTGACGTTTTACATTTCCACTTTCCTATTCCATTCATTAAGCTAGCCAACAATCCA | makorin, ring finger protein, 1; MKRN1 |
| 547 | 227967 | 0 | AAAAATAAAGCTGTATGACTTAGTGCTGAAGGATATGAATTAGGCATAGCTCTTGGGTTG | unassigned |
| 548 | 228018 | 0 | AAACGCTCCCTGTATCTTGCTGTACTGTTAAAGAAAGCTGAATTCCACATTGCCAACAAA | CHST11 |
| 549 | 228350 | 0 | AATCGAAAAGAAGCAAATTGCCATGACAGATAACACTTTGATTGCTCAATCTCTTGGTAA | unassigned |
| 550 | 228418 | 0 | ACAAAATTCCTAGCACATGAGAAGATCTGGCTCGACAAATTCAAATATGAAGATACAGAA | ELONGATION FACTOR-1 BETA, DELTA |
| 551 | 228829 | 0 | AGAAGCCCCTTACTCCCAAGTCTGAGAGTTCCAAGTGTGGTAAAAATGGCAACCTTTGCT | unassigned |
| 552 | 228955 | 0 | AGATTCTGCAAAGGTGCCAACCCCTTGCAAAGGAGCCCTGGCATCAGAACCCTCCCCAGG | unassigned |
| 553 | 229149 | 0 | AGGCCCCACCTTCCAGTGAGAACTCATGCAGAGACCCTCAAACCAGGAAAGCTGGGTTGT | unassigned |
| 554 | 229178 | 0 | AGGGCAATTTACTTTTTTGTACTTCAGACTATCTTGATTGTCAAAGTGTACGAACTGTAA | GUANINE NUCLEOTIDE-BINDING PROTEIN G, |
| | | | | ALPHA SUBUNIT |
| 555 | 229386 | 0 | ATCAGCATTGACAAGGGACACAATTTCTGTCTGATCTATGACACCAAGGGTTGCTTTGGT | 30S/40S RIBOSOMAL PROTEIN S4 |
| 556 | 229610 | 0 | ATTCATGACGTGTGAAATTTCAGTTTCTCTGGAGTTTGTCAGACGGCGTGGGAACCACGC | unassigned |
| 557 | 229869 | 0 | CACTGCAGGTGTATATAGATGCTTTCTGTCATACTGTGTTTTCAGATGCAGAATTTTAAA | unassigned |
| 558 | 229998 | 0 | CAGGCGCTGACCCACGAATGCAACTCTCAGCCGAGCTGTCCCTGCCGGATTTCAAACAGC | unassigned |
| 559 | 230179 | 0 | CCAAAGTGGACGAGGTGAAGTTTATGATAAAGTTCCAAATGAAGAAGGTGTTACCTCTGG | similar to ribosomal protein L10a; unassigned |
| 560 | 230388 | 0 | CCCCCAGCTGCTGTTCTCGTCTTTGGAGGACCCGGCTTTACTGGTGCCACATGCCTGCTG | hypothetical protein LOC254099 |
| 561 | 230983 | 0 | CTGACTGGAAACCTTAGCCCCCAAATATGAAATGCCTTCTCTAGATTAAAAGGGTGCAGA | unassigned |
| 562 | 231881 | 0 | GCCGAAGGACCCTGTGCTGCCTGTGACTTTGGTATGTGTCCTCTGGGAACAGAAGCAGGG | LATE CORNIFIED ENVELOPE |
| 563 | 231927 | 0 | GCCTTGGCAGAGGCGTCTCCCCACATTCTGACTCCTGGTCCCCTTGAAACCCTGTTGGTG | hypothetical protein FLJ25404; unassigned |
| 564 | 232462 | 0 | GGTATCTCCATTGCACTCTATTTGCCACCTCACCCTGAAGGAAGGTACGAGGGCCCCTTC | unassigned |
| 565 | 232665 | 0 | GTGAAATGCATGTTTAGCAAGTGTTAGGTACTGTATTTGAACCAATAAATGTGAATCCTT | hypothetical protein LOC253842 |
| 566 | 232784 | 0 | GTTCCAGCTTTACCCCAGCCTTAATCTTTTAAAATGTATATTTTCCTTAGCGTTGATTTT | LOC285835 |
| 567 | 232947 | 0 | TACGTGTTGGAAGAAACAGACACCTTCCCATCCCCAGCGTTTGTTCAGTGCCTTGGTTGG | LOC144486 |
| 568 | 233271 | 0 | TCCCACTGCGGTCACTTCCTAGGACTCAGACGGTCCTGCTCCCACTGCGGTCACTTCCTA | unassigned |
| 569 | 234280 | 0 | TTGTGAAGTCCAAGGAGGTCAAGACCAAGATCCCAAAGGGCATTAGGTGCAAACTCAATC | hypothetical gene supported by |
| | | | | BC013438; unassigned |
| 570 | 234317 | 0 | TTTCGATGGCTCTAGTACTTTTACAGTCTGAACAGTGACATGTATCTCGTGCCTGCTGCC | GLUTAMINE SYNTHETASE |
| 571 | 234406 | 0 | AAACGCTGGGAATCTGAGCGCATCCTCTCCTTCATCCCTCCTGATGGAAACTTCCGCCTG | adaptor-related protein complex 3, mu 2 |
| | | | | subunit; AP3M2 |
| 572 | 234426 | 0 | AAATACACAGAGGTCCTCAAGACCCACGGACTCCTGGTCTGAGCCCAATAAAGACTGTTA | similar to ribosomal protein L13a; unassigned |
| 573 | 234587 | 0 | AGAAAGAGAATCATTGTCTCGCCTTCTGTGTTCCACTCTCCTCCTCACTGGTGCCTTTTG | LOC219690 |
| 574 | 234622 | 0 | AGATGGCGCTGAAAGCAAATAAGGAAGCTCCTGCCCCTCCTAAAGCCGAAGCCAAAGTGA | 60S RIBOSOMAL PROTEIN L23A |
| 575 | 234633 | 0 | AGCCCTTCCTCTGTGCTCCGCCTTGAGAGCAGTGTTTCGGACGCTGGGAAGCGTGCTGTG | family with sequence similarity 90, member A11 |
| | | | | pseudogene; FAM90A11P |
| 576 | 234677 | 0 | AGTCAGCCCTGTGGCCCCTCCACGGCCCCCAGGCCCAAGGCCATACGGGCACTGATGGCC | unassigned |
| 577 | 234862 | 0 | CACGCTGTATGTTCCCCTGCGAGCACCCTCCTCTTGGCCTCTGGCCAAGTCCCACCCATC | unassigned |
| 578 | 234963 | 0 | CCATGCTCTCTCTCCATAGGTCCTGTTTTACTATGATGTAAAAATTAGGTCATGTACATT | SMALL NUCLEAR RIBONUCLEOPROTEIN G |
| 579 | 234980 | 0 | CCCCATCTTGCATGTTGTGACACCTTCACCAATAACATAATCATGTATTTCCCTGCTGTC | OR7E156P |
| 580 | 235086 | 0 | CGTGGACCGCGCTGCGAGCCTCGGAGACGCCGTAGAAGGAGACCTGCTTCCGGGACTGGA | thyroid adenoma associated; THADA |
| 581 | 235093 | 0 | CTAATACCTGCCAACCTACTCTTAATCAGTGGTGGAAGAATGGTCTCAGAACTGCTTGTT | unassigned |
| 582 | 235377 | 0 | GGAGGCATGTCCTCAGGCCTGGGAGACCAGGCTGGCCCCAGCCTCCCTGTGCGGTCAGGG | unassigned |
| 583 | 235378 | 0 | GGAGGCGCAATAAGACACCCCTCCACAGAGCTTGGCATCATGGGAAGCTGGTTCTACCTC | FLJ43339 protein; unassigned |
| 584 | 235380 | 0 | GGATCCCGGTCCAGTCTCCTGACTGCGTAGAGATCCCTCTTCTTCCCGAAAGGCAGTGGA | unassigned |
| 585 | 235381 | 0 | CACTGCAGGTGTATATAGATGCTTTCTGTCATACTGTGTTTTCAGATGCAGAATTTTAAA | LOC283824 |
| 586 | 235600 | 0 | GTTTTTAGGATCAGTACTTTTTAATGGAAAAAACTTGACCAAAAATTTGTCACAGAATTT | unassigned |
| 587 | 235698 | 0 | TCAGGCATGTTACTGGTAGTTCCTTTTGAGTCTGACATTCTAATAAAATAATTTGTAGAA | U520 |
| 588 | 235774 | 0 | TGAAGCAGTGTGCAGATGTTGAAGGAGTATAATGCAAGATATTTTTTTCTTTTTTATAGT | unassigned |
| 589 | 235783 | 0 | TGACTGTCACAGGCAGGCTCAACAAGTGTGGAGTGATCAGCCCCAGATTTGATGTGCAAC | 30S RIBOSOMAL PROTEIN S8 |
| 590 | 235812 | 0 | TGCCGTGTTCCGGAGCCAGCAGCAGGAGACTGTGGGCCTTGAGGATGTGGTAGTGCATGG | unassigned |
| 591 | 235833 | 0 | TGGAAGTCATCATTGCAGATGCTTAAGTCAACTATTTTAATAAATTGATTACCAGTTGTT | 40S RIBOSOMAL PROTEIN S20 |
| 592 | 235877 | 0 | TGTTGGCCTTTTAAGCCCAATGGTCTATCAGGAAGTAGAAGAGCAGAAACTACATCAAGC | IQ motif containing B1; IQCB1 |
| 593 | 235960 | 0 | TTGCTTGTGGATGACTGACCAGGAGGCTATTCAAGATCTCTGGCACTGGAGGAAGTCTCT | NUCLEOPHOSMIN 1 |
| 594 | 236300 | 0 | CAACTCTCCTCTGAAGCCCTGGTGGCTGCCCAAATTTGTGCCAATAAGTACATAGTAAAA | 60S RIBOSOMAL PROTEIN L10 |
| 595 | 236307 | 0 | CAATCATGTTGCCGTATCAAGCAGAAAATGTCACCACTATCTGGAGAGTTGGACATGTTT | RIBOSOMAL PROTEIN L39E |
| 596 | 236371 | 0 | CCAGATTAACAGTCTTATCAGAAGAACGAACTAAGGTGTCTACCATGATTATTTTTCTAA | unassigned |
| 597 | 236685 | 0 | GGGACCGTGTCGGCCCAGATCGAGGGTGGCGTTCATGGCCTGCACTCTTACGAGAGGTGG | INOSINE-5-MONOPHOSPHATE DEHYDROGENASE |
| 598 | 236756 | 0 | GTGGTCAACCACCTCAGTAAAATTGGAGAGGATTATTTTGCATTGACTAAACTTACAGAA | unassigned |
| 599 | 236794 | 0 | TAGCCCTGTTCTCTCCTGGTACCTCCAGCATCCCAATCAATTCCTCCAGATCCGCCTGAG | unassigned |
| 600 | 236829 | 0 | TCCAGATACCTAATAAGATGCTGGAATGTAATCCCTGGACAATCCGTGTCCTGGCAGCAT | breakpoint cluster region; BCR |
| 601 | 236955 | 0 | TTAGATCCTCCTCTTCAAATGCTGTAATTAACATCACTTAAAAAAACTTGAAAAAATATT | unassigned |
| 602 | 237093 | 0 | GGGCCCTGGATCACCAGCCTCCCTCCACCCAGAATGCCCCGTCCACTCCACTGCCCACCA | unassigned |
| 603 | 295023 | 0 | ACTGTGGTGATTTTTCATATTCCAGTACTCCAGCCTGGGTGACAGTGCGAGACTCTGTTT | unassigned |
| 604 | 318897 | 0 | AGGAGGGATGTTACTAGAAATGCACAAAGTGGGCTGAACACAGTGGCTCACACCTGTAAT | ZINC FINGER PROTEIN 393 |
| 605 | 361497 | 0 | CAACATAGTGAGACCCTGCTTCTAAAGCATTTTCTTGGTGTTACTCCTGTAGATCCTCAC | FATTY-ACID AMIDE HYDROLASE |
| 606 | 412092 | 0 | CCGCAGGTCGTCCATCCGCAACGCGCACAGCATCCATCAGCGGTCGCGGAAGCGCCTCAG | NCF1 |
| 607 | 416900 | 0 | CCTCCTTCATTGCCATCTGTGAGTTTCCTGCCTGAAGAGGCACGTTCCTCAGCCCCCTCC | MBL1P1 |
| 608 | 424910 | 0 | CGAGCTGCCTGCGCTGGGCAAATGACCTCCCCGCGAACGGGAACGCCCGGACGAGACAAC | unassigned |
| 609 | 426464 | 0 | CGCCAGTCCCTCCGACGCCGACCTCAGAGTTCCAGCTGCTGTGGCAGTGGCAGTGGCCAG | late cornified envelope 5A; LCE5A |
| 610 | 443501 | 0 | CTCTCCCTAGGAGGCCTGCCCCCGCTAACCGGCTTTTTGCCCAAATGGGCCATTATCGAA | general transcription factor IIB; GTF2B |
| 611 | 474728 | 0 | GAATGAGAACCCTACTTGCCTAAATGAGGAATGTCTTTCCTACCATCTAAAATACGAAGG | heterogeneous nuclear ribonucleoprotein A3; HNRPA3 |
| 612 | 518907 | 0 | GCTGAGCTCAGCCCCTGTGGCCTCAGAGCTGCAGGCCCCTCCCGGGTGTCAGAGCACTGA | small optic lobes homolog (Drosophila); SOLH |
| 613 | 531903 | 0 | GGATCGCTGCCACCTTTTACCTAGGCCTCCCCACCATGGCCTCTGCCAGAGCCAGCTCCT | ASPARTATE AMINOTRANSFERASE |
| 614 | 536912 | 0 | GGCCTAAAAATAAGGCCCATGTCCACTGTCCCCTGCATTAGTGTTGCTGTTGGAACAATA | 60S RIBOSOMAL PROTEIN L21 |
| 615 | 539197 | 0 | GGCTGAAGTTGCAGTGAGCCGAGATCGCGCCATTGTACTCCAGCCTGGGCGATGAGCAAA | chromosome 3 open reading frame 34; C3orf34 |
| 616 | 541108 | 0 | GGGAACCGCGGTGGCTTCCCTCGCGGAGGCAAGGCCAAAGATAAGGAGTGGATGCCCGTC | unassigned |
| 617 | 545687 | 0 | GGGCCGAGAGAATTTTGAGCTCTAGCCGTCTTGTTCGCCGGCAATAAAAGGACTCCTGAA | unassigned |
| 618 | 565070 | 0 | GTGACCAAGCCCCTTCTGCTGCTCCATGCCCCTGCTCGCCGCAGTGTCCCAGTCACCAGG | unassigned |
| 619 | 588118 | 0 | TAGAACAATCCTGTGAAGAACCTTCTAAATCTGATGGTATTTATGGCTGTAAGTTGCTGG | UNCHARACTERIZED |
| 620 | 613619 | 0 | TCCTTTCTAGTTATTTCTATTACTTCAGCCTTACCTCCTCCAACTTCAGCACCTCATTAT | unassigned |
| 621 | 616050 | 0 | TCTACAGCGTGGTTTGCCTGCCTGTCTGCCCTCCTGGATGCTATTAAAGCTTTGTTTTGT | ADP-RIBOSYLATION FACTOR-LIKE 4, ARL4 |
| 622 | 643139 | 0 | TGGAAGGAACAAATTCCAGACACACCAGCACTTTGGGAGGCTGAGGCGGCTAGATCACTT | UNCHARACTERIZED |
| 623 | 673310 | 0 | TTCTCTCCACAGTATGGCTTCACCTGTTCCTGAGCGCCCTGCTACCCTCTTGCTAACCTG | kelch domain containing 4; KLHDC4 |
| 624 | 687856 | 0 | TTTGATGAGCTGAAGGCTTCAGAAGGTTGGTAATAACAAACTTCTCTGAGCTAAAGGAGG | L1 TRANSPOSABLE ELEMENT-RELATED |
| 625 | 694146 | 0 | AACTTGGAAAAATGTTTTTGCAAAACTTGATGATCAAGCTGAACGTAGAACGATATTCCT | unassigned |
| 626 | 695191 | 0 | ACACTCCGGTGAGGTTCTGACTGGCCCTGGGACATCACCTGCTCCAGGATCCTATGTGGC | unassigned |
| 627 | 695718 | 0 | ACCCCTGCCCACTGCGGCAAACCCCTACTTCTGGTTTCCTTTGGAACCCCTTTGTTATTC | unassigned |
| 628 | 696102 | 0 | ACTCAGGCCTCCTGCAATGGCTCCATGCTGGACCAGCAACAGCTCCACGCCGGCTGGACT | unassigned |
| 629 | 700852 | 0 | CAGCGGGCAGCAGACCCCAGAGTAGCAGGGAAGACAAGCACTTCAAAGAGGCAGCGTCAG | unassigned |
| 630 | 701053 | 0 | CAGGTGCTCGTGTGCACGTGAGCGGCTCTTCCTGCTGACTGACTACAGCTAATTGACAAA | unassigned |
| 631 | 701997 | 0 | CCAGGAGCTCCGCCCCCTCTGGGTTCCCAGGACTCTGATTGGTCGGCGAGCCAGCCCTTC | FBJ murine osteosarcoma viral oncogene homolog |
| | | | | B; FOSB |
| 632 | 707035 | 0 | GCAAGCGTGGCATCATTGGCTAGAATGTTTGAAGACCAGTCTTAACATCTGATTATATTT | ATP5L2 |
| 633 | 707472 | 0 | GCCAGAACCATCCAGCTAAGCCCCTCGCAGATTCCCCACCCACGAAAATGCTGAGATGAC | D21S2090E |
| 634 | 708012 | 0 | GCTCACTTTGTTTCTCGGTGGCTGACTCGTCTCTGTCGCTCACTCCCTCTGTCACTCGCG | chromosome 14 open reading frame 78; C14orf78 |
| 635 | 711916 | 0 | TATTTTGAATTGATTGTGGCATCTGCCTGCTTCCCCATTAAAACTGAATAAAATCTTTAA | unassigned |
| 636 | 712531 | 0 | TCCAGTCTCAGCAAGCTGCCCTTTAAAGAGGGTGATATGGTTTGGCTCTGTGTCCCCACC | unassigned |
| 637 | 713949 | 0 | TGCAGACCTGACCCACATGTCCAGGAGCCTGTATGCTGGCCCCCTCTACCCTTGAGTGCC | unassigned |
| 638 | 10480018 | 0 | GACGTGTGAGGTCACTTCCTGCGTGTTGGGTGGCTTCCTGCGGCGTTTCCACTCTCGCTC | ribosomal protein S13; RPS13 |
| 639 | 102001 | 10 | AAATACGTGGGACAGTGTCTTCTCAGAGACAACCAGCCTTGAAGGCTACAGGTGATGAGA | protein immuno-reactive with anti-PTH polyclonal |
| | | | | antibodies; unassigned |
| 640 | 102047 | 10 | AAATATCCTCCTGTGACACCTTCCCCACCCTGCCAGTCAAAGTATCCACCCAAGAGCAAG | small proline-rich protein 2A; SPRR2A |
| 641 | 102451 | 10 | AAATTTCCAGATCAACATGGCTATGGTATTTAGTAATGGCCCAGCTTAGAGACTTCAGCT | tropomodulin 1; TMOD1 |
| 642 | 104220 | 10 | AAGAAACTCACTTTCCCTGTGGCACGTTATGCTTCAGAATTAAAACAATGAAGATTAAAA | rabphilin 3A-like (without C2 domains); RPH3AL |
| 643 | 106983 | 10 | AATCACAGCCACTTGACAAGAAAGGATATTCATTATTTTCAAATGGCTTTTGGACTATCA | THUMP domain containing 1; THUMPD1 |
| 644 | 108231 | 10 | AATTTTGTGCCTACTCTAGGGCAAACAGAATTACAATTGAAGGAGTTCCTATCTATCTGT | AHA1, activator of heat shock 90 kDa protein ATPase |
| | | | | homolog 2 (yeast); AHSA2 |
| 645 | 110074 | 10 | ACATCAAACTGCCTGGATTTTTCTACCACCCTGTTACATCATAACAACTTCTGAAACACA | GM2 ganglioside activator; GM2A |
| 646 | 112934 | 10 | ACGGGTCACCCGAGGCCCATACCAAGACTCTGTTCCTGCCCTAGGCCCAGTCTCAAAGGA | sphingomyelin phosphodiesterase 3, neutral |
| | | | | membrane (neutral sphingomyelinase II); SMPD3 |
| 647 | 113660 | 10 | ACTCCTGGATTATAGATTAAAAGTCTCTGTAGACATCTCTGTGAAGAGCAAGCTATCATT | signal recognition particle 14 kDa (homologous Alu |
| | | | | RNA binding protein); SRP14 |
| 648 | 113742 | 10 | ACTCTATGCATTGTGGAACACCTTTAAATCCATCCTGATTCAAGTTGCCTTATTCAAAGT | MULTIDRUG RESISTANCE PROTEIN 2 |
| 649 | 117044 | 10 | AGAGGTGGAGACCATCTCCAAGGAACTGGAGCTTTTGGACAGAGAGCTGTGCCAGCTGCT | gasdermin domain containing 1; GSDMDC1 |
| 650 | 118174 | 10 | AGCAGCGGCTGCAACTGCGGCTCCTGGCCAGACCCCGGCCTCAGCGCAAGCTCCAGCGCA | eukaryotic translation initiation factor 3, subunit 5 |
| | | | | epsilon, 47 kDa; EIF3S5 |
| 651 | 120624 | 10 | AGGATAAGGATGCTTAAAATGGAAATCATTCTCCAACGATATACAAATTGGACTTGTTCA | forkhead box O1A (rhabdomyosarcoma); FOXO1A |
| 652 | 122946 | 10 | AGTGAATTAACTGTGTCTCCCTTGTCTTAGGATATTCTGTAGATTGATTGCAGATTTCTT | ubiquitin-conjugating enzyme E2D 1 (UBC4/5 |
| | | | | homolog, yeast); UBE2D1 |
| 653 | 123404 | 10 | AGTGTGGGAAGATGTCTCCCTGACCTCAATGTCTGTCTGCAATTTATGGAGATGACCACA | LOC199725 |
| 654 | 123750 | 10 | AGTTGTAACTCTGCGTGGACTATGGACAGTCAACAATATGTACTTAAAAGTTGCACTATT | calmodulin 2 (phosphorylase kinase, delta); CALM2 |
| 655 | 125313 | 10 | ATCAGAACAAGCCCTTCAGTGTGCCGCATACTAAGTCCCTGGAGAGCCGCATCAAGGAGG | transcriptional adaptor 3 (NGG1 homolog, yeast)- |
| | | | | like; TADA3L |
| 656 | 125540 | 10 | ATCATGGCAGTCCCTGTCATCTCTGAGTGGGCCTTTGCAAGTGGTTCCTGACATTGATGA | serine/threonine kinase 40; STK40 |
| 657 | 125665 | 10 | ATCCAGCACCAGTCAGACCAATATGTCAAAATTAAGCGTAACTGGCGGAAACCCAGAGGC | ribosomal protein L32; RPL32 |
| 658 | 128233 | 10 | ATGGGCGCCCAAGGATTCTCCCCGCAGGCTCGCAGACTCACCTGATCACCGGGCAAGCGC | unassigned |
| 659 | 129584 | 10 | ATTCTTATATTTTTCTTTACTAATTTTGGATTTTTTTTCTTTGAATTATTGGGCAGGGAA | HSC70-INTERACTING PROTEIN |
| 660 | 136737 | 10 | CAGGTGAGGAAAGTTAGGAGATATTCATCTTAAGAGATATCCTATTTGGCAGTCACATGT | family with sequence similarity 49, member A; FAM49A |
| 661 | 137199 | 10 | CAGTGGTGGCCGTAGACTTGGCTCGGAACTTAGTGGCACCAGAGTAACTCTAGTCAGTTA | nucleoporin 62 kDa; NUP62 |
| 662 | 141516 | 10 | CCATCCCACATTCGGACCCTGCCCATACCCCTGCCTGGGTTTTCTAACTGTAAATCACTT | ATP-binding cassette, sub-family C (CFTR/MRP), |
| | | | | member 8; ABCC8 |
| 663 | 143933 | 10 | CCCTGGATTCAAATTAAGTGCAATATTTTGCAAACAGCTCTTCTTAGGGAAATCTCCTGA | transmembrane and coiled-coil domain family |
| | | | | 3; TMCC3 |
| 664 | 144117 | 10 | CCCTTGTGTCTCAGGTGTGGTCCCTGCCTGCTTGATGAAGTTGCTCTGTTCAAGCCTTTG | glycosyltransferase 25 domain containing 1; GLT25D1 |
| 665 | 144454 | 10 | CCGCCGACTTCACGGCCGAGGCCCACGCCGCCTGGGACAAGTTCCTATCGGTCGTATCCT | hemoglobin, zeta; HBZ |
| 666 | 145045 | 10 | CCTAACCCTGTACTAACCTGCTTGGTGGACTTGGAAAAGACTTGGCTCTGTCGGGAAAGG | phosphatidylinositol 3,4,5-trisphosphate-dependent |
| | | | | RAC exchanger 1; unassigned |
| 667 | 148686 | 10 | CGCCCTTCCTAAGTTATCGGCCTGCGAGCCGGAGAGACAATGGAGAGAACTGCAGAGGCC | zinc finger protein 787; ZNF787 |
| 668 | 149707 | 10 | CGGGACCATCTGATGTGATGTGAATACTCTTCCCACATACATTAAACACACTTAAGTGAG | solute carrier family 19 (folate transporter), member |
| | | | | 1; SLC19A1 |
| 669 | 149721 | 10 | CGGGAGAGATTTACTTTGAACATTGTCAGTTGCAGCAAAAATTTACTACACAAGATTATT | coiled-coil domain containing 90B; CCDC90B |
| 670 | 151108 | 10 | CTACCGTCAAGTCTTTGAACGCCATTACCCAGGCCGGGCTGACTGGCTGAGCCATTACTG | asparagine synthetase; ASNS |
| 671 | 151523 | 10 | CTAGTTGGATGGCACAAGGCTCTTCACAGACGCATCTGTAGCAGAGTGGAACTTGTACTA | translocase of outer mitochondrial membrane 7 |
| | | | | homolog (yeast); TOMM7 |
| 672 | 153385 | 10 | CTCTCATTCTCCATAGTCTGTTTCCTGGAAAGTCGATGTAATTAACTGATGGCCCAAAAA | prolyl-tRNA synthetase |
| | | | | (mitochondrial)(putative); PARS2 |
| 673 | 156494 | 10 | CTGTCGGAGGCCGGGCTGCGCCTGCTGCACTTCCTGTTCATGTACGACCCTAAGAAAAGG | cyclin-dependent kinase (CDC2-like) 10; CDK10 |
| 674 | 161521 | 10 | GAATTTTTGTGCTCTTTTCCCTGTGTACATGGTGGTTCTATCTCCAATAAAACTTTTGTT | unassigned |
| 675 | 161967 | 10 | GACAGTGGCATCTACTTCTGCATGATCGTCGGGAGCCCCGAGCTGACCTTCGGGAAGGGA | CD8b molecule; CD8B |
| 676 | 162490 | 10 | GACCGTGGTGAAGAATTGCATCGTGCCCATCGACAGCACGCCCTACCGACAGTGGTACGA | 40S RIBOSOMAL PROTEIN S8 |
| 677 | 166400 | 10 | GATGATGTAGTTGATTATTTCAAGAGACAAGGTTTCTCCTATCAGGGTCGGGCTTCCAGC | NOL1/NOP2/Sun domain family, member 5; NSUN5 |
| 678 | 172174 | 10 | GCGGGAGAAGCTGACGGACTGGAAGGACTTCTTGCTGGTGAAGAGCAGGAGGAACATCAC | Hermansky-Pudlak syndrome 1; HPS1 |
| 679 | 172296 | 10 | GCGTCTCAGGCAGGCATGACTGGCTACGGGATGCCACGCCAGATCCTCTGATCCCACCCC | transgelin 2; TAGLN2 |
| 680 | 174201 | 10 | GCTTAAGGAATTATGTGAGCTTAAAACTAGTCAAGCAGTTTAGAACCAAAGGCCTATATT | dedicator of cytokinesis 9; DOCK9 |
| 681 | 174875 | 10 | GGAAAGATCTGTGAAATGCTATCTCTCCTGAAGCAATACTGTTGACCAGAAAGGACACTC | BCL2-related protein Al; BCL2A1 |
| 682 | 175820 | 10 | GGACCGCTATAAGGCCAGTCGGACTGCGACATAGCCCATCCCCTCGACCGCTCGCGTCGC | unassigned |
| 683 | 177127 | 10 | GGATCCTGGTATCCGCTAACAGGTCAAAATGCAGATCTTCGTGAAAACCCTTACCGGCAA | ubiquitin B; UBB |
| 684 | 178394 | 10 | GGCCCCAGGCCGGTACTTCGCCCACAGCATCCTGACCGTGTCCGAAGAGGAATGGAACAC | IGHM |
| 685 | 178526 | 10 | GGCCGCCATCAATGCACGCAAGATGAAATTTGCTCTGCTAAAAGGCTCCTTCAGTGAGCA | protein disulfide isomerase family A, member 6; PDIA6 |
| 686 | 178566 | 10 | GGCCGTCACACCTACCCTGTGCAGCGGAGCCGGACCAGGCTCTTGTGTCCTCACTCAGGT | SYNAPTOGYRIN 2 |
| 687 | 179521 | 10 | GGCTTCCTTCAGCGTTCTTCCTGTTGTATTCTGAGTATCGCCCAAAAATCAAAGGAGAAC | SWI/SNF-RELATED CHROMATIN BINDING |
| | | | | PROTEIN |
| 688 | 183635 | 10 | GTATGAGGATGTGGCACTGATCAAAGACCATACACTTGTCAATTCCTTGATTCGTGTGCT | RAB6 interacting protein 1; RAB6IP1 |
| 689 | 184060 | 10 | GTCAGGAGTCCCAAAGGTCAGTGACAGTTTCTCAGAAGAGGCCCAGCGTCCACCTCTCTC | protein phosphatase 2A, regulatory subunit B′ (PR |
| | | | | 53); PPP2R4 |
| 690 | 187114 | 10 | GTGTGGGCCATCTCGGCCCTGGTGTCCTTCCTGCCCATCCTCATGCACTGGTGGCGGGCG | adrenergic, beta-1-, receptor; ADRB1 |
| 691 | 187876 | 10 | GTTCTTAGTTGGTGGAGCGATTTGTCTGGTTAATTCCGATAACGAACGAGACTCTGGCAT | iroquois homeobox protein 6; IRX6 |
| 692 | 190261 | 10 | TACCGAGGCCCCTACAAAGCCTTCAGAGTAGATATCTCTGCCAACGTGAGGACAGAAGGA | 60S RIBOSOMAL PROTEIN L29 |
| 693 | 192398 | 10 | TATGGACTCTGCCTTCATGTCATCAGTTAAAGTGCCCTGCACACCTGCCTGTCCTAGGTC | unassigned |
| 694 | 193634 | 10 | TCACCCCTGTCCTGTTGGCCCCAGGCAGCCAAGACCGATGGCTTTGGCCCGTCCTTCCCA | unassigned |
| 695 | 195179 | 10 | TCCAACAAGTACGGCGTGTTTATGCGAGTGAGCGAGGTGAAGCCCACCTATCGCAACTCC | purine-rich element binding protein A; PURA |
| 696 | 196668 | 10 | TCCTCATATTCATTCCAGTCTGGATATTTGATACTATCCTTCTTGTCCTGCTGATTGTGA | transmembrane protein 60; TMEM60 |
| 697 | 197340 | 10 | TCGAGGTGGAGCCGAGTGACACCATTGAGAATGTCAAGGCAAAGATCCAAGACAAGGAAG | ubiquitin C; UBC |
| 698 | 197808 | 10 | TCGTTCTCTGCACTTTCCCCCCTGCCTCCCAACAGTGGCCTTCCTATCTGGCTTGGTGGG | acyl-malonyl condensing enzyme 1; AMAC1 |
| 699 | 200647 | 10 | TGAAGAGGCCATAGTACCTCCTGTTTGAAGTTGTTTATTCACATCTATCTTATTTGAAGA | testis expressed sequence 10; TEX10 |
| 700 | 203100 | 10 | TGCAGTATTTATGGCCTCGTCCTCCCCCACCTAGGCCACGTGTGAGCTGCTCCTGTCTCT | tubulin, beta 3; TUBB3 |
| 701 | 203566 | 10 | TGCCCATTCCCCATCATCATCCGTTTTACCTTAGTTAGCATTTTTCTTATCATTTTTCTT | ankyrin repeat domain 17; ANKRD17 |
| 702 | 205747 | 10 | TGGATTCAGTGCAGTAAATAAAACACAGGAAGTATTCTGGTGGAAAAATACCTTGTATTT | protein tyrosine phosphatase-like A domain containing |
| | | | | 2; PTPLAD2 |
| 703 | 206302 | 10 | TGGCTCAACTCGAATCATCACCAGATTGCGGAATCCAGATAGCAAACTTAGTCAGCTGAA | bromodomain PHD finger transcription factor; BPTF |
| 704 | 206528 | 10 | TGGGAAGTAAAGACATAGGATCCAAGAATGAGGGTTCCCCCAGCCGGGCCTGCAGCCCAG | mediator of RNA polymerase II transcription, subunit |
| | | | | 25 homolog (S. cerevisiae); MED25 |
| 705 | 207955 | 10 | TGTATTATCTGCTTTGCTGATGTAGACAAGAGTTAACTGAGTAGCATGCTTTATTAAGCA | transmembrane protein 50A; TMEM50A |
| 706 | 209706 | 10 | TGTTTATCCATCAGCCCAGAGCACTTACTGAGAGTAAAGAGGCTCTAGCCACCCCCTTAC | chromosome 7 open reading frame 25; C7orf25 |
| 707 | 210420 | 10 | TTACTCCTGCCCAGTGACTGTGACCACTGTCCGTGTTGCCTTCTTGAACAGCGATTCCCC | syntaxin 1A (brain); STX1A |
| 708 | 214925 | 10 | TTGTTGTAGGCATCAAAAGAATTGATGGCGTGAGTTTACTGGTGCGGAAAACCATTGCAA | 60S RIBOSOMAL PROTEIN L7 |
| 709 | 215764 | 10 | TTTCTCATAAGCATTTGCCCTCACCATGGTTTATAAAACTTTGGGAAAACGGAATATTCA | UV radiation resistance associated gene; UVRAG |
| 710 | 217100 | 10 | TTTTTCTGCCCCATTTCTCTGCCATTTCAGCCATCTCAGCCTGATCTCTGCCTCCTCAGC | unassigned |
| 711 | 217443 | 10 | AACATTGAAAAGTTGTGGTCTGATCAGTTAATTTGTATGTAGCAGTGTATGCTCTCATAT | tubulin, alpha 3; unassigned |
| 712 | 218894 | 10 | AGCCTGAGGTGATCTGTGAAAATGGTTCGCTATTCACTTGACCCGGAGAACCCCACGAAA | ribosomal protein L17; RPL17 |
| 713 | 220741 | 10 | CCAAGCTGCTGTACTTCAAAGGAAACAGATCTAGCACACTGCTGCACCCCTGCTTCCACA | G protein-coupled receptor 107; GPR107 |
| 714 | 221390 | 10 | CCTGCAGCAGACGTGCCAGCAGCTTGCGGTCCAGCAGGCACCCTCTGCTCAGCCCACCCC | SH3 AND MULTIPLE ANKYRIN REPEAT DOMAINS |
| | | | | PROTEIN 1,2 |
| 715 | 227738 | 10 | TTGTTTCCGGTGGTCTTCCCGTTGTGGGAGCAGGTGGAGGGTGGAGACCTAAACTTTGGG | ZNF524 |
| 716 | 227872 | 10 | TTTGCTTCCTTCCCTGGACGGCCCGCTCCCCGAAACGCGCGCAATAAAGTGATTCGCAGA | DnaJ (Hsp40) homolog, subfamily C, member |
| | | | | 4; DNAJC4 |
| 717 | 230395 | 10 | CCCCTGACCCTGCCGGAAAGCGAAACTGAGATGCGGGCATTGGGCCCTGGGAAGCGTGGG | obscurin, cytoskeletal calmodulin and titin-interacting |
| | | | | RhoGEF; OBSCN |
| 718 | 234988 | 10 | CCCCTAGCTCCGTCGGTTCCTTTCTGGTGAGATCCCCAGTGCCTGTGGCACCTGTCACCA | unassigned |
| 719 | 236556 | 10 | GAGCATTCGCTGTACTTTAAGATACCCATCTTTTTCTTTTTAACCCTAATCTTTCACTTG | TOP1P2 |
| 720 | 384551 | 10 | CAGTGAGTTGAGATCGCGCCACTGCACTCCAGCCTGGGCAACAGAACAAGACTCCGTCTC | hypothetical protein FLJ40448; unassigned |
| 721 | 397748 | 10 | CCACTTGTGCCGGACGCTGTGGCTGGTGGCAGCGGTGCTGCTGGCTCTGCTGTGTTGCAC | MAS-related GPR, member E; MRGPRE |
| 722 | 539274 | 10 | GGCTGAGGACACCTCCCCGGCTGAGCAGACCAGCCAGAACTTCACCAAGAGCGCAGGGCT | unassigned |
| 723 | 700282 | 10 | CACATTTGTACTTGCGGACCAGGACTGACAAGGGAGCCACTGCCTCTGCCATAATCAGAA | unassigned |
| 724 | 712642 | 10 | TCCCGCATTATCTCCCTGGACCCTCACGCAGCCCACAAGGCAGCTGTTGGTATCATCCCC | unassigned |
| 725 | 714371 | 10 | TGGAAGCTTTGGTGCTTTGCTGACCCTGTGACCTGAACAGCCACCCACCTCTCCGAGCCC | unassigned |
| 726 | 104157 | 20 | AACTTTCCTAGGTGATTACTTCGGGATCCTCAAGGAGGCGAGAGTGACCGTGTTCCCCTT | phosphatidylethanolamine N-methyltransferase; PEMT |
| 727 | 107398 | 20 | AATGAGCAGATTACGGGCAGGGACGACCTGTCAAAGCGCGGAGTGGACCAAACCTGCACT | dedicator of cytokinesis 10; DOCK10 |
| 728 | 109372 | 20 | ACAGACCCCATTCTGCCCACCAGAACCGGAAGTTGTGTCTTTGCAAAAGCAACCAGTTAG | unassigned |
| 729 | 110171 | 20 | ACATCGGTCCGTCCTGCTTCCAGCTGCTGCAGCGCGCCTTCGCCGCCAAAGCATCCAGCA | FXYD domain containing ion transport regulator |
| | | | | 7; FXYD7 |
| 730 | 112798 | 20 | ACGCTTCATCATCTATGCCTTCCCCATGCTCAACATCACGGCTGCCAGAGGCTGCTCCTA | asparagine-linked glycosylation 12 homolog (S. cerevisiae, |
| | | | | alpha-1,6-mannosyltransferase); ALG12 |
| 731 | 115349 | 20 | AGAACATGCTTTCAACATTGGATTGCCAGACAACATTGTAAACTGCAATGAATTTTTGTG | zinc finger protein 277 pseudogene; ZNF277P |
| 732 | 118257 | 20 | AGCAGTACAGCTGCCTCAAACCTTTGGGATTTTCAGAATGACTGACACTGCCGAAGCTGT | family with sequence similarity 103, member |
| | | | | A1; FAM103A1 |
| 733 | 122089 | 20 | AGGTTGTACGAGTAAGAGGACACTATAAAGGTCAGCAAATTGGTACAGTAGTCCAGGTTT | unassigned |
| 734 | 125079 | 20 | ATCAACAAGTTTGTGCAGTTCATCCATAAGTACATTACCTACAATGCCCCAGCAGCCATC | integrator complex subunit 1; INTS1 |
| 735 | 132753 | 20 | CACAATGATTAATCCAGTGCCGCCTGGAGGCAGCCGGTCCAACTTCCCGATGGGTCCCGG | single stranded DNA binding protein 3; SSBP3 |
| 736 | 133231 | 20 | CACCAAGAGCTCCTGAGCCCCCTGCCCCCAAAGCAATAAAGTCAGCTGGCTTTCTCAAAA | unassigned |
| 737 | 133672 | 20 | CACCTGACCAATCAGAGAGCTCACTAAAATGCTAATTAGGCAAAAACAGGAGGTAAAGAA | endogenous retroviral family W, env(C7), member 1 |
| | | | | (syncytin); ERVWE1 |
| 738 | 135242 | 20 | CAGATGCTTTTCTCAAACTTTCCTGATCCTGCAGGCAAGCTAAACCAGTTCCGGAAGAAC | similar to beta-1,4-mannosyltransferase; unassigned |
| 739 | 137923 | 20 | CATCCGAGCTGGGACTCTAATCATGGCTCTGCATGACTCTTCCGATTACCTGCTGGAGTC | LAG1 homolog, ceramide synthase 2 (S. cerevisiae); |
| | | | | LASS2 |
| 740 | 144309 | 20 | CCGAGGGCATTCACACGGGCCAGTTTGTGTATTGCGGCAAGAAGGCCCAGCTCAACATTG | ribosomal protein L8; RPL8 |
| 741 | 146893 | 20 | CCTGTGGTCCATTGTTCATTTTAATTCACATTTCTTATGAAGTATGGTAACAGGGAGGGA | glycerol-3-phosphate dehydrogenase 1-like; GPD1L |
| 742 | 150817 | 20 | CTAAGCTGCATTGAGAAATGACTCGTCTCTGTATTTGTATTAAGCCTTAACACTTTTCTT | microtubule associated monoxygenase, calponin and |
| | | | | LIM domain containing 3; MICAL3 |
| 743 | 156215 | 20 | CTGGTGTCCAATCTGGATTTTGGAGTCTCAGACGCCGATATTCAGGAACTCTTTGCTGAA | THO complex 4; THOC4 |
| 744 | 163137 | 20 | GACTGTATTTACCAAGTCTCCCTATCAGGAATTCACTGACCACCTCGTTAAGACCCACAC | ribosomal protein S2; RPS2 |
| 745 | 168709 | 20 | GCAGGCCTTACCGCTCTGTTTATAGTGACCCACCCTAGATCTTCCCCAAGAGGGACTGGG | paxillin; PXN |
| 746 | 170887 | 20 | GCCGGGCCCACTCCATTCAGATCATGAAGGTGGAGGAGATCGCGGCCAGCAAGTGCCGCC | similar to ribosomal protein L18a; unassigned |
| 747 | 174360 | 20 | GCTTCCCCTCTCTCCGGTCTGTCCCTCCAAGATGACAAAGAAAAGAAGGAACAATGGTCG | 40S RIBOSOMAL PROTEIN S26 |
| 748 | 179326 | 20 | GGCTGCCTGCATGCACGGTGCCCTCCTTGCACTCCGGACGTGAGCATTCGCAGTGGGTTT | chromosome 4 open reading frame 23; C4orf23 |
| 749 | 180333 | 20 | GGGATTTTGGCCTTGTTGACCCTCCTAGGTGCCCTGGGAATTGCAAACAGCTTTCTGGAT | microsomal glutathione S-transferase 2; MGST2 |
| 750 | 183858 | 20 | GTCAATCCAAGGATCCAGAAGGCTTATGAGTATTTTATTATCCTGTCCAGGACCCTGAAG | FAMILY NOT NAMED |
| 751 | 184572 | 20 | GTCCTGGATGTTGATGTCCTGCATCTAACGCGGTGTAACCCCCGAAGCCGAGCGAGCTCC | splicing factor 3B, 14 kDa subunit; unassigned |
| 752 | 187458 | 20 | GTTATCAAGGACATTTAAGGAATCCTGATCCTCAGAACTTCTCTGGGACAATTTCAGTTC | proteasome (prosome, macropain) subunit, alpha |
| | | | | type, 5; PSMA5 |
| 753 | 188831 | 20 | TAAAGATACAGTCACCAAGAATGTTTTGAGTTTTTTGAAAGACCCCAATTTAAGCCTTGC | cytidylate kinase; CMPK |
| 754 | 192651 | 20 | TATTCCAGAAGGCTCCACCCTGCCGTCCTGCGGGAGACTGCTGTCCAGTCCTGGCCGGGC | potassium voltage-gated channel, shaker-related |
| | | | | subfamily, beta member 2; KCNAB2 |
| 755 | 196599 | 20 | TCCTATGCAACAAGATCCGATACTTGGACTTATCGTACAATGACATTCGATTTATCCCCC | leucine rich repeat containing 8 family, member |
| | | | | C; LRRC8C |
| 756 | 199127 | 20 | TCTGCTGGCGAGTCCAGAAACATTATTGCCCAGAAGGATTATGTGTTTATGGATTATTTT | importin 9; IPO9 |
| 757 | 207286 | 20 | TGGTGCGATTCATGGATATACTGGTAAATTTAGGCAAAGTGAAACTTATCAGCGTAGTTT | KIAA0157; KIAA0157 |
| 758 | 208933 | 20 | TGTGGAGCGTTCACTATGGGTGTCATTGGTGGCGGAGTCTTCCAGGCCATCAAGAGTTTC | MITOCHONDRIAL IMPORT INNER MEMBRANE |
| | | | | TRANSLOCASE SUBUNIT TIM17 |
| 759 | 229520 | 20 | ATGGAGCCTGTGACAATTATAATGGCTATGGCTATGGATTTGGGTCAGATAGATTTGGAA | HETEROGENEOUS NUCLEAR |
| | | | | RIBONUCLEOPROTEIN |
| 760 | 236688 | 20 | GGGACTGCCCAGTCTGTGGGCTGTGATGTTGATGGCCGCCACCCTCATGACATCATATAT | 60S RIBOSOMAL PROTEIN L12 |
| 761 | 690434 | 20 | TTTTATAAAGCCACAATAGTTAAAGCACTTAGATGTGGACAGAATCGCTTGAACCTGGGA | unassigned |
| 762 | 696965 | 20 | AGCAATGAGTTGTTTAGTGACACATAGCTGAGAAGTAAAATGACGACAAAAAGCAAGAAG | unassigned |
| 763 | 705996 | 20 | GACCCATGGCCATGCCCGCCTGCCTGTTACATTCCTGTTATATATAGACCAAGGAAAGCT | hypothetical LOC441027; unassigned |
| 764 | 102664 | 30 | AACACACGTTTTTAAAGTTCATGTACGTTCTTGTACACAGAGGTAAAGATTTGAAAACCT | nucleolar protein 10; NOL10 |
| 765 | 108400 | 30 | ACAAATGGGAACAGTTGACTGGTTTAGTGGATGCTGAAGGCCTTCAGGAAATATGCTACT | hypothetical protein BC004921; unassigned |
| 766 | 113751 | 30 | ACTCTCAGCTCATCTCCCTCAAGCGCCAGGTACAGAGCATGAAGCAGACGAACAGCAGCC | REST corepressor 2; RCOR2 |
| 767 | 114394 | 30 | ACTGTGATCCAAAGCAGCCTAATTACTGGCCGGTCATCCCCCCGAAGTTCTGAGCTCGGG | LOC492303 |
| 768 | 142989 | 30 | CCCCCTGCCCTCTGACGCTCTCCCAGTACTTCAGGCATATGCTGTGCCCTTGACAGTGGC | sprouty-related, EVH1 domain containing 3; SPRED3 |
| 769 | 145481 | 30 | CCTCAGCAGCTCTCCTTGTTACTACTTTTACCAAGCGGAAGATGGACAGCATATGTTCCT | ring finger protein 10; RNF10 |
| 770 | 160960 | 30 | GAAGTCAAATGCACGCCAACATTCCAGTTTTTTAAGAAGGGACAAAAGGTGGGTGAATTT | thioredoxin; TXN |
| 771 | 174760 | 30 | GGAAAAGAACTAAATGAATTCCGGGAAAAGCACAACATTCGTCTCATGGGAGAAGATGAG | prefoldin subunit 2; PFDN2 |
| 772 | 175254 | 30 | GGAAGCGGTAGACTATAAAAACATTCGTTTCACAGTATGGGATGCTGGTGGTCAAGATAG | ADP-RIBOSYLATION FACTOR, ARF |
| 773 | 186148 | 30 | GTGGAAAAAGTTGGAAACACAGATCTGTGCAGTTCTACATTCACTGATTATTACAGTGTG | cleavage stimulation factor, 3′ pre-RNA, subunit 1, |
| | | | | 50 kDa; CSTF1 |
| 774 | 196745 | 30 | TCCTCGCCACCTGCTCGGCTGATCAGACGTGCAAGATCTGGAGGACGTCCAACTTCTCCC | G protein beta subunit-like; unassigned |
| 775 | 204159 | 30 | TGCTACATTTCCAAGGTGAAGATGTGTGGGCACATGTTATGGCAGATTGAAAAGGATCTC | ATP synthase, H+ transporting, mitochondrial F1 |
| | | | | complex, epsilon subunit; ATP5E |
| 776 | 213516 | 30 | TTGATGATACAGTAAGAAACCTGTAAAATTCGAGCCATATAAATAAAACCTGTACTGTTC | unassigned |
| 777 | 216889 | 30 | TTTTGATGGGCTACTCATACAGTTAGATTTTACAGCTTCTGATGTTGAATGTTCCTAAAT | high-mobility group box 2; HMGB2 |
| 778 | 234977 | 30 | CCCCACATTGCCCAGCCCTCACACATGGACTGCCCAGTGCCCACACCTGGCTTTGGCAAT | fucosyltransferase 11 (alpha (1,3) |
| | | | | fucosyltransferase); FUT11 |
| 779 | 235506 | 30 | GGTCCTCCACCGTCCAAGGCCAGCACACCATTCCTGAAGCCCAGCTTCACACCCTGGATT | LOC497256 |
| 780 | 694601 | 30 | AATAAAGACCTGATTATACAGGCAGTGAGCTGTAATCCCAGCACTTTGGGAGGCTGAAGC | unassigned |
| 781 | 101065 | 40 | AAACGAGCAAGGACAGCTCTGCAAATTACTATGCAAGTCAGAAGAAAACATTTGAAATTA | TRA1P2 |
| 782 | 107464 | 40 | AATGCACTGGTCACGAAACGTCTAATACTATGACTGTTAAAATGTCAGACTATAACAAAT | ubiquitin specific peptidase 38; USP38 |
| 783 | 112021 | 40 | ACCTCCTATGGCTCAGGATGAGGGAGGCCCCCAGGCCCTTCTGGTTGGTAGTGAGTGTGG | jumonji domain containing 2B; JMJD2B |
| 784 | 116303 | 40 | AGACGTTTGACAATGAGTCAGTAGCACAAAAGAGATGACATTTACCTAGCACTATAAACC | sulfatase 2; SULF2 |
| 785 | 120823 | 40 | AGGCACCCCCATGCCATCCCCGGGTCCATTTTGAGCCACAAGACTAGCAGAGACCGTGGC | coiled-coil domain containing 114; CCDC114 |
| 786 | 122028 | 40 | AGGTTACAGACCTGCCTATCGTTCCAATAATCCTGTTTCACTTGAATGAAGGGAGTATGT | eukaryotic translation termination factor 1; ETF1 |
| 787 | 130369 | 40 | ATTTTAATACACGTCATTGGAGGGCTGCGTATTTGTAAATAGCCTGATGCTCATTTGGAA | carbohydrate (chondroitin) synthase 1; CHSY1 |
| 788 | 135479 | 40 | CAGCAGGATAAGCTGATAAAGGAAGGGAAGTACACCCCTCCACCTCACCACATTGGCAAG | FAMILY NOT NAMED |
| 789 | 137092 | 40 | CAGTGATGATTCAAATGCTGTACAATTAGCCAAGTCTTTAGGTGTTGATTCTCAAATAAA | phospholipase A2-activating protein; PLAA |
| 790 | 143330 | 40 | CCCGCCTGGTGATGAGGCGCTCCTCGCGTTCCTTCCGTCTCCAGTGCACCGGCTTTCCCT | unassigned |
| 791 | 147381 | 40 | CCTTGGGAAGCCCCCTACCCCGCTACCTCTACCTGGCTAGCAACCAGACTAATGCGTGGG | amine oxidase, copper containing 2 (retina- |
| | | | | specific); AOC2 |
| 792 | 147942 | 40 | CGACGCTGGGTCTACTATTGCCTGGTGAACATCACGCTGAGTGACCTGCTCACGGGCGCG | endothelial differentiation, lysophosphatidic acid G- |
| | | | | protein-coupled receptor, 6; EDG6 |
| 793 | 149034 | 40 | CGCTGACTTGGAGCCTCTCTTCCTATACCTGTGCAATTCTTCTACGTTTTGTGATCATGC | PQ loop repeat containing 3; PQLC3 |
| 794 | 155915 | 40 | CTGGGAATGGCAAGGGCAAGGTAGAGTGCCTAGGAGCCCTGGACTCAGGCTGGCAGAGGG | ATP-binding cassette, sub-family A (ABC1), member |
| | | | | 7; ABCA7 |
| 795 | 157784 | 40 | CTTCTGGCTGACTGTGCGAAGTATGCTGCCCCACAAGACCAAGCGAGGCCAGGCCGCTCT | ribosomal protein L13a; RPL13A |
| 796 | 168528 | 40 | GCAGCGACTACAAGGTGTAATCAAGACTCGAAATAGAGTGACAGGACTGCCGTTATCTAT | ataxia telangiectasia and Rad3 related; ATR |
| 797 | 171369 | 40 | GCCTGCTGTTGCCACACTCCTCATGGATGTCATGTTCTACTCCAATGGAGTGAAGGACCC | similar to opposite strand transcription unit to |
| | | | | Stag3; unassigned |
| 798 | 177184 | 40 | GGATGAAATGTCAGTGGAAGAAGCAGATGAGAAACTCTTGAGATCTTGGTCCTGTGTTTT | G protein-coupled receptor 44; GPR44 |
| 799 | 178151 | 40 | GGCCAAGCCAGAACTCCACTATTGCCCTGCCTCCTGTTCTGTCCCCACCATGGCTACAGA | gb def: Hypothetical protein FLJ46051 |
| 800 | 178477 | 40 | GGCCCTCTGGACAGGAGGGACCATCCACTCCATAGCCCTCACCTCCCTTACCATCAAGCT | OLFACTORY RECEPTOR MOR239, MOR240 |
| 801 | 202425 | 40 | TGATGGCTGCATGACAGATGTTGGCTTATTGTAAAAATAAAGTTAAAGAAAATAATGTAT | proteasome (prosome, macropain) 26S subunit, |
| | | | | ATPase, 6; PSMC6 |
| 802 | 203782 | 40 | TGCCTCCCTGGTCACCTATTACACCAGTTCTGGAGAAGACATCCTCATTGGCGGCTTGAA | likely ortholog of mouse neighbor of Punc |
| | | | | E11; unassigned |
| 803 | 209426 | 40 | TGTTCACTGTCCCCCTAATATTAGGGAGTAAAACGGATACCAAGTTGATTTAGTGTTTTT | CD83 molecule; CD83 |
| 804 | 234929 | 40 | CATTATCAAAATTGGCTTCCAGGCTGTCATGGGCAAGCGAGCACAGCTCCGTGCCAAAGC | eukaryotic translation initiation factor 2, subunit 2 beta, |
| | | | | 38 kDa; EIF2S2 |
| 805 | 101692 | 50 | AAAGGAGAGCATCCTGGCCTGCCTATTAGCGATGTTGCAAAGAAACTGGTAGAGATGTGG | unassigned |
| 806 | 105293 | 50 | AAGCCATCACCTGGATGCCTACGTGGGAAGGGACCTCGAATGTGGGACCCCAGCCCCTCT | MEG3 |
| 807 | 115081 | 50 | AGAAACATTGAGCATGAACACCATCTGTGCGAGTCATTTACTTATTGCCCCTCACCTCTA | unassigned |
| 808 | 120870 | 50 | AGGCAGCTAGACCAGGGATAGGAGTGGGCAACTTGCCAAGCCCTTAACTCTACTTCCTCT | MASK-4E-BP3 alternate reading frame |
| | | | | gene; unassigned |
| 809 | 123557 | 50 | AGTTCACCAGCCCCTCCAGGGAGCACAGCCACGTCTGGTCAGGAATCTTTTAATGAGTGA | unassigned |
| 810 | 129276 | 50 | ATTCAGACAGATTTGGAGATTGGCAAGATTACCAATTTCATCAAGTTTGACAATGGTAAC | 30S/40S RIBOSOMAL PROTEIN S4 |
| 811 | 133236 | 50 | CACCAAGCTGGAAGGCAGTGATTTAGACCTTTTGAGAATAGGACACTTGGCAGGAGGGAA | RAD54-like 2 (S. cerevisiae); RAD54L2 |
| 812 | 145042 | 50 | CCTAACCCCAGCCTGAAGACCTTCAAGCCCATCGACCTGAGTGACCTGAAGCGCCGGAGC | hypothetical protein LOC348262; unassigned |
| 813 | 146556 | 50 | CCTGGAGTAAATATTGGCACAGATTTCATTTGAGAGAACTCAGCCCCCTGGTCTAAGCTG | KRAB-A domain containing 1; KRBA1 |
| 814 | 147011 | 50 | CCTTAGACTTGAAAGTACGGTGGTTGAGGAGAGCAATGGTTCTGATGAGATGGAGAATTC | tetratricopeptide repeat domain 17; TTC17 |
| 815 | 147272 | 50 | CCTTCTTCGTGGTGTCTCTGGTCCTCCCCATCTGCCGGGACTCCTGCTGGATCCACCCGG | 5-hydroxytryptamine (serotonin) receptor 1D; HTR1D |
| 816 | 173075 | 50 | GCTCGCTCGAGGACCTCAGCTCGTGCCCTCGCGCCGCCCCTGCGCGCAGGCTTACCGGGC | glutamate receptor, ionotropic, N-methyl D-aspartate |
| | | | | 2D; GRIN2D |
| 817 | 176542 | 50 | GGAGCTCAAGAAGCATAAGCCCAACTTCTGATGTGCCAGAAACCGCCCTGAGATCTGCCG | vacuolar protein sorting 52 homolog (S. cerevisiae); |
| | | | | VPS52 |
| 818 | 176992 | 50 | GGATAACATACAAACCGGTGTGGAAAATGTTGTCCTTTGAGTGGCAAGAATTAGAAAAAT | zinc finger and BTB domain containing 38; ZBTB38 |
| 819 | 180028 | 50 | GGGAGAATGTGACCTAATTTATGACAAATACGTAGAGCTCAGGTATCACTTCTAGTTTTA | NADH dehydrogenase (ubiquinone) 1 alpha |
| | | | | subcomplex, 7, 14.5 kDa; NDUFA7 |
| 820 | 180412 | 50 | GGGCACTCCCTGCCAGAGGAGACCGTGGACTTCATGGTTCAGCACACGTCGTTCAAGGAG | sulfotransferase family, cytosolic, 1A, phenol- |
| | | | | preferring, member 1; SULT1A1 |
| 821 | 183644 | 50 | GTATGCAGGTGCCCTCTGTGCCTATTCACAGTTCCCTACTAAAGACTGGAGTGCTCAGCC | RIBOSOMAL PROTEIN S2 |
| 822 | 184158 | 50 | GTCATCTTGGGCAATGAACTGCCAAAATTCTATGATGAGTGAACCTTCCCCAGACTTCTC | proteasome (prosome, macropain) subunit, beta type, |
| | | | | 9 (large multifunctional peptidase 2); PSMB9 |
| 823 | 185863 | 50 | GTGCCCCCTTCTCCCCGGTCCTCCACTACTGGCTGCTGCTTTGGGACGGCAGCGAGGCTG | similar to hypothetical protein; unassigned |
| 824 | 188209 | 50 | GTTGTGCTTTATGGCCACTGAGAGAATTCAGAATAAATTGAAAGATGGAGTCTAAAAATT | cell cycle progression 1; CCPG1 |
| 825 | 192079 | 50 | TATCCTGTAGATGTGAAGCACTTTCAGTTTTCAGCGATGTTGGAATGTAGCATCAGAAGC | Rho guanine nucleotide exchange factor (GEF) |
| | | | | 7; ARHGEF7 |
| 826 | 194873 | 50 | TCATGACCCACAATAGGATACAAACGAAGAGTTTAAGCCAGCATGATCCAGATGGGTTCA | histidine decarboxylase; HDC |
| 827 | 207722 | 50 | TGTACCTAGGGAAAAAATTTAAGGAGGTATTCACACTCAGGGTCATGCACTTGCACAATG | CD96 molecule; CD96 |
| 828 | 218083 | 50 | ACATAGTGTATGTTTGTGATATATAAGGTTTTCTTTATTTTGTATATGATCAATAAACCT | v-maf musculoaponeurotic fibrosarcoma oncogene |
| | | | | homolog G (avian); MAFG |
| 829 | 220525 | 50 | CAGTTACATCTGCCGAGGCTGCCTCCCTGGATGAGCCTTCCAGCAGCTCCATCGCCAGTA | notochord homolog (Xenopus laevis); NOTO |
| 830 | 234269 | 50 | TTGTCAGCGCCACCTCCACCTTCAGGAGCCTGCCACGTGCCTGCCCTCGGTCACTTAGCC | DKFZP434A062 |
| 831 | 236327 | 50 | CACTGTGCCTGAGACCCTCGACCCAGCCGAATACAACATATCTCTGGAAACCCAGCGGGT | hypothetical gene supported by AF044957; |
| | | | | NM_004547; unassigned |
| 832 | 264394 | 50 | AAGTGAGAGCCACGAGCCAAGGTGGGCACTTGATGTCGGATCTCTTCAACAAGCTGGTCA | family with sequence similarity 39, member D |
| | | | | pseudogene; FAM39DP |
| 833 | 343680 | 50 | ATGACAAAACAAGGTTCTTTAACACCCCAAAGGTCATACCAGCTCACCAGCAATGGATTC | unassigned |
| 834 | 421950 | 50 | CCTTCCCCACCATGGCTTCCGGCCCCACCCCGAGTGGCATTGTCGCTGCAGCCAACTTTG | unassigned |
| 835 | 101867 | 60 | AAAGTCAAGAAAACAACTGGGTCGGATCATGCTAAAAGGAGATAATATTACTCTGCTACA | SNRPEL1\|SNRPE |
| 836 | 106225 | 60 | AAGTAACAGGGAAGCTACAGGTTACAACAGATTTGTGAACTCAGCCAAGCACAGTGGTGG | heterogeneous nuclear ribonucleoprotein A1 |
| | | | | pseudogene 4; HNRPA1P4 |
| 837 | 114948 | 60 | ACTTTTGTGAGGAAGATTAATGTGGCCAATAAAACCTTTAAATGTTAAGTGTCAAAAAAA | nucleoporin 50 kDa; NUP50 |
| 838 | 126773 | 60 | ATGAACGAACACGGCTACTTTCCAGAGATATTTGATGAAAGGAAGTTGCTTATTCTTCTC | transmembrane protein 77; TMEM77 |
| 839 | 129728 | 60 | ATTGCAAGGGATGGTGCTTCTTTGAGGATGATGTCAATGAGTTCACCTGCCCTGTGTGTT | RanBP-type and C3HC4-type zinc finger containing |
| | | | | 1; RBCK1 |
| 840 | 130690 | 60 | CAAACAAAGCTAAGACAGCAGGGAACAGAATTGTCATGGCTGAATAGACCAATCGTGTTC | sulfiredoxin 1 homolog (S. cerevisiae); SRXN1 |
| 841 | 137603 | 60 | CATAGGGCCACAGTGCCGTATCTGCTGCAGACATGATTGTTTCTTGTTCTAGAGGTTTTC | MLX interacting protein; MLXIP |
| 842 | 138873 | 60 | CATTATGGCTTAATTTATCCATGGGTTCACGTCGTAATATCATCTGATTCTTTAGCTGAT | Hermansky-Pudlak syndrome 3; HPS3 |
| 843 | 141449 | 60 | CCATATCCTCACTCTGAGTCTTGGTATCCAGGTATTGCTTCAAACTGGTGTCTGAGATTT | DENN/MADD domain containing 2D; DENND2D |
| 844 | 152505 | 60 | CTCCAGGATGCCTCACATTTTCCCTGTTTGTTAGTGGTCTACCCGAGAGTCCTATCAATT | triggering receptor expressed on myeloid cells-like 3 |
| 845 | 162516 | 60 | GACCTATACCTGTGTTTCTTGCCTCATTTTTTTCCTTGCAAATGTAGTATGGCCTGTGTC | aldo-keto reductase family 1, member B1 (aldose |
| | | | | reductase); AKR1B1 |
| 846 | 164480 | 60 | GAGCTCCTAAGTCACTTCAAGGTGGACCTGGTGTGTCACGGCAAGACAGAAATTATCCCT | phosphate cytidylyltransferase 2, |
| | | | | ethanolamine; PCYT2 |
| 847 | 167566 | 60 | GCAAGTACACGCTGGGCCACTGCACCATCCGCTGGGCCTTCATGCTGGCCATCCTCAGCA | lipoma HMGIC fusion partner-like 5; LHFPL5 |
| 848 | 172324 | 60 | GCGTGATTTTCGAGACAATACTGTCAGAGTTCAAGACACAGATTGGAAAGAACTGTACAG | F-box protein 7; FBXO7 |
| 849 | 172727 | 60 | GCTATTCCCTATATTCAGCAATTAAATCGGATACTTCTGGAGACTATGAAATCACACTCT | annexin A3; ANXA3 |
| 850 | 175038 | 60 | GGAACCGATTTGTACAATGTGGGAATTTTGTTACCTTTTTAATCAAGGGCAACTTCCTTT | zinc fingers and homeoboxes 2; ZHX2 |
| 851 | 178605 | 60 | GGCCTATTTCAGAGAACTGCCGGATCCCCTGCTCACTTACCGGCTCTATGACAAGTTTGC | Rho GTPase activating protein 30; ARHGAP30 |
| 852 | 182566 | 60 | GGTTCACCGAGGCTGTGTACAAAGTGTCTTCATGTCCTGTGTTTCACCTTTTAACATACA | unassigned |
| 853 | 188077 | 60 | GTTGGAAAACATGGAAAATGCATCCTTAACACCTGAGCCTCTGGTCATCTTCAGTATTTT | senataxin; SETX |
| 854 | 194371 | 60 | TCAGGATTCTGCTGGTCTCTTGCAGAGTGAATGAGTGGCCCCTGCCTCTCCTATGGGTCC | unassigned |
| 855 | 195871 | 60 | TCCCACGGCCCTTCCAGCCTACCCTGGAGGAGATTGAAGAGTTTCTGGAGGAGAACATGG | Kruppel-like factor 15; KLF15 |
| 856 | 196827 | 60 | TCCTGACGAGCAGCGGCTGTACAAGGATGACCAACTCTTGGATGATGGCAAGACACTGGG | transcription elongation factor B (SIII), polypeptide 2 |
| | | | | (18 kDa, elongin B); TCEB2 |
| 857 | 208223 | 60 | TGTCCCCGGTGCCTGTGAAATTCGTCATGCCATGACCCACCTGCATTAAACCTATTTTTT | LOC90120 |
| 858 | 210097 | 60 | TTAAGTGTGTAGATTGAGCAGGTAGTAATTGCATGCAGTTTGTACATTAGTGCATTAAAA | pyruvate dehydrogenase (lipoamide) alpha 1; PDHA1 |
| 859 | 227679 | 60 | TTGGGAGAGGATACTGTCCAGAAAATTAATGCATACTTTTGTCACAATTTGCCTTTTTGT | Wilms tumor 1 associated protein; WTAP |
| 860 | 232393 | 60 | GGGATCCACCTCCCAAGTACTCCCCAAATGCACCCCTTAACTAGGAGCAGGGTGTTATTA | KERATIN, TYPE I CYTOSKELETAL |
| 861 | 234266 | 60 | TTGTAGCGTGCTTCATGAAAATATCTACTTATCCAGGTTTGCAAATGTACATGTTCATTT | IBR domain containing 2; IBRDC2 |
| 862 | 234461 | 60 | AAGAAAGTGGCTATGGTGCCTGCCCAGGGAAAGCGGTGTTATGACAGGAAGCAGAGTGGC | 60S RIBOSOMAL PROTEIN L44 |
| 863 | 235834 | 60 | TGGAATGATATCAAAAAGGTCTATGCCTCTCAGCGAATGAGAGCTGGCAAAGGCAAAATG | ribosomal protein L4; RPL4 |
| 864 | 410937 | 60 | CCCTTCCTAGCCTCCTGACATGAGTCTGCTGGAAAGAGCATCCAAACAAACAAGTAATAA | chromosome 10 open reading frame 99; C10orf99 |
| 865 | 638716 | 60 | TGCCTGGAGACTCCTATTCACCCTTCAGATCAATATCCCCCAAATAAACTCCCAGTCACT | FLJ42957 protein; unassigned |
| 866 | 710730 | 60 | GTTCAATGCCGCACTATTCACAATAGCAGACTTGGAATCAACCCAAATGCCCATCAATGA | hypothetical protein LOC149157; unassigned |
| 867 | 121526 | 70 | AGGGCCCGCAGAGCATTTGGTGCCCCTCCATGTTGCAATGCAAACACCTTCACCACTGGG | hypothetical protein LOC150223; unassigned |
| 868 | 124152 | 70 | ATAAGGCCCGCTGGAGTCACAAGCCCCATCCCAGACTCTCCAACGCTGGACCTGCAGCGC | unassigned |
| 869 | 126099 | 70 | ATCGCCCAGTTTCTGAGTGACATCCCGGAGACTGTGCCTTTGTCCACTGTCAATAGACAG | acetyl-Coenzyme A acyltransferase 1 (peroxisomal 3- |
| | | | | oxoacyl-Coenzyme A thiolase); ACAA1 |
| 870 | 126367 | 70 | ATCTCCTCATTGTGCCTTCATCAGAGCTGGTGCCTTCGGGCCAGAAAGACTCTCGTTCTT | oral cancer overexpressed 1; ORAOV1 |
| 871 | 128435 | 70 | ATGTACCTTCGTTCAAATATCCTCATGTAATTGCCATCTGTCACTCACTATATTCACAAA | nucleolar and spindle associated protein 1; NUSAP1 |
| 872 | 131957 | 70 | CAAGCTGGTGTCCCTCCAGGCTAAAACACTTCCACCCCCTGGGCAGTGCACTACAGGGTG | chromosome 22 open reading frame 26; C22orf26 |
| 873 | 133352 | 70 | CACCATATACAGGAGCTCAGACTCAAGCAGGTCAGATTGAAGGTCAGATGTACCAACAGT | TRK-fused gene; TFG |
| 874 | 140616 | 70 | CCAGAGATGAAGGGAAGTGGACTAAAGTATTAAACCCTCTAGCTCCCATTGGCTGAAGAC | dual specificity phosphatase 23; DUSP23 |
| 875 | 151061 | 70 | CTACCAGACAAGTTACAGCATCGATGATCAGTCACAGCAGTCCTATGATTATGGAGGAAG | Yip1 domain family, member 5; YIPF5 |
| 876 | 151174 | 70 | CTACGGAAACAAGTTGAAGTACCTGGCTTTCCTCCGCAAGCGGATGAACACCAGCCCTTC | unassigned |
| 877 | 153694 | 70 | CTCTGTGAGCTCTGGGCTTCCCAGTTTGTTTACCCGGGAAAGTACGTCTAGATTGTGTGG | hematopoietic cell-specific Lyn substrate 1; HCLS1 |
| 878 | 153835 | 70 | CTCTTGGAGAACTCCGAGGAGTATGCGGCTCGGGCCCGTCTGCTCACAGAGATCCACGGG | ubiquitin-conjugating enzyme E2S; UBE2S |
| 879 | 155063 | 70 | CTGCCTTGTTTTGCGACATTGTCCCATTCACACAGATATTTTGGGATAATAAAGGAAAAT | phosphoglucomutase 1; PGM1 |
| 880 | 155226 | 70 | CTGCTCTACTTCACCGGCTCTGCACACTTCAACCGCTCCATGCGAGCCCTGGCCAAAACC | polymerase (DNA directed), lambda; POLL |
| 881 | 155691 | 70 | CTGGCAATCGGCTCGCCCTCCTTCCAAGACAAGCTGCTGCTCGGCCCCTCTGAGATCCGT | unassigned |
| 882 | 165421 | 70 | GAGTGATGCTGAACTTAAGGGTTCAGATGTAGATTCTCTGGTCATTGAGCATATCCAAGT | ribosomal protein L17; RPL17 |
| 883 | 169563 | 70 | GCCAAGCCAGTCCCTACTCTTGGGCTGCGGCCACGTGAGGCTCCGCATCAGCAGCCAGGG | chromosome 16 open reading frame 35; C16orf35 |
| 884 | 172495 | 70 | GCTAATTAATGAAGAGGAGCAACTACTATTGGTGTATTTTTCACAGATTGGTGCTTTCTA | G protein-coupled receptor kinase interactor 2; GIT2 |
| 885 | 173982 | 70 | GCTGTAGACATTATCTGTGTCACCGTGGAAGACTATTTCAACGATTTTGCCAAAATTAAA | exocyst complex component 3; EXOC3 |
| 886 | 176856 | 70 | GGAGTCCATGTTGCATTTCTTGTGAACTATAAATGGTGCTTCTCATTTTCTGATAATTTT | hypothetical protein FLJ40432; unassigned |
| 887 | 189070 | 70 | TAACCAGCCCCAGTTCCGGGCTGTCTTGGGCGAAGTGAAACTGTGTGAGAAGATGGCCCA | eukaryotic translation elongation factor 1 |
| | | | | gamma; EEF1G |
| 888 | 197266 | 70 | TCGACAAAGGTAAAGTGGGAGTCTGTGTCTGTGCTCAACCTCTTCACCAGGATCCGGTAA | fizzy/cell division cycle 20 related 1 (Drosophila); FZR1 |
| 889 | 198543 | 70 | TCTCGGAACCCATCAAGGTGCTGTACTCCAAGTTTCTGATGCACCCGGAGGAGCTGTTTG | TFII-1 REPEAT DOMAIN-CONTAINING PROTEIN |
| 890 | 203594 | 70 | TGCCCCTCGGCCCAAGAGTGTCCAGCGGTGGCCCACCTCTTCCTCCCACTACAGCCTCAA | required for meiotic nuclear division 5 homolog B |
| | | | | (S. cerevisiae); RMND5B |
| 891 | 205836 | 70 | TGGCAAGGTACCCGCTGACAGAGAGCCAGCTAGCGCTAGTCCGGGACATCCGACGACGGG | nuclear factor (erythroid-derived 2), 45 kDa; NFE2 |
| 892 | 208543 | 70 | TGTGAACTTGTTGCACTGCAGAAACATATTCAGAGTTTATCTATGTAACTTATTCACTCT | furry homolog (Drosophila); FRY |
| 893 | 215759 | 70 | TTTCTCAGCAACATTTATTCAAGATGATTTTTACCAGGAACCTTATCAAAGGCAAAACCA | chromosome 5 open reading frame 4; C5orf4 |
| 894 | 221081 | 70 | CCCCTGTGAATCAAGATTTGGGCATGTTCTTGGTCACCATTTCCTGCTACACCAGAGGTG | Bernardinelli-Seip congenital lipodystrophy 2 |
| | | | | (seipin); BSCL2 |
| 895 | 221266 | 70 | CCGTTCTGACCTCTACCTGGACCTTATTAACCAGAAGAAGATGAGTCCCCCGCTTTAGGG | regulator of G-protein signalling 3; RGS3 |
| 896 | 222840 | 70 | GACATGAAAGTTCAGATCCCTTCCACTCAGGATTCTCGCCGCCTTTTCTAAGAAAATAAT | chromosome 10 open reading frame 47; C10orf47 |
| 897 | 226105 | 70 | TCCTTCTTCAGTGTCCTCACATGGGCTTCCTTCCCTTCTCAGCTGATGCCATCACCTGGG | unassigned |
| 898 | 230293 | 70 | CCAGTGATTCTGCTTCTAACATATTTCAGACATCATTTCTGTCCATTCCCACTACCAGAA | unassigned |
| 899 | 234727 | 70 | ATCCTGTCCCTCACCTCCTCTCCCTGCATCCTCATTGCTCCCTGTGCCTACTTTCCCTCC | HUMAN UNCHARACTERIZED PROTEIN |
| 900 | 235614 | 70 | TAATACAGCTTAACCTTGCAGCTACCAACTTTTGTGTCAAGCTAGGTACCTTTATTTGAT | TRANSCRIPTION FACTOR BTF3 |
| 901 | 236001 | 70 | TTTTATGCTAACCATTGTTTCTGTAGTTAAAATTGTTTTCTTGGTGTTATCTTTTCTCAA | unassigned |
| 902 | 236583 | 70 | GATTCCACATAAAAATTTTCTGAGGTTGTCCTCATTGATCCATTCCATAAAGCTATCAGA | ribosomal protein L15; RPL15 |
| 903 | 316129 | 70 | AGCTTCTCCCAAGTGGGCGGCAGCAGCAGCTTCCAGGGTGGCCTGGGTGGAGGCTATGGC | unassigned |
| 904 | 459905 | 70 | CTTCCCTCAGCCTCCTCAGTAGCTGGATTACAGATATGTATCTCAAGAGCACTCCACAAC | unassigned |
| 905 | 707864 | 70 | GCGGAGGCTGTAAAACCTGGCACTCTGCTTGGGTTATCAATACTCTGGCTGACCATCGTC | nuclear pore complex interacting protein; NPIP |
| 906 | 101310 | 80 | AAAGAACTAGAAAGAGACAGGGAGAAATTGTTAAGTGGAAGTGAGAGCTCATCAAAACAA | unassigned |
| 907 | 101811 | 80 | AAAGGTGTCCGCAGCCACACGCAAAAAAGAAGATCCGCATGTCACTCACCTTCAGGCGGC | similar to RPL23AP7 protein; unassigned |
| 908 | 104346 | 80 | AAGAAGACTCCCGAGGGCGATGCCAGTCCCTCCACTCCAGAGGAGAACGAAACCACGACA | PIN2-interacting protein 1; unassigned |
| 909 | 105423 | 80 | AAGCGTATTACCCCTCGTCACTTGCAACTTGCTATTCGTGGAGATGAAGAATTGGATTCT | H2A histone family, member Z; H2AFZ |
| 910 | 112167 | 80 | ACCTGCCCCAGCCAGCGCAGCAGGTTCAAGGCGTTTGTTGCCATCAGGGATTACAATGGC | 40S RIBOSOMAL PROTEIN S2 |
| 911 | 112734 | 80 | ACGCGAGGTATAGGCTCCAGACTCCTCACCAAGATGGGCTATGAGTTTGGCAAGGGTTTG | zinc finger, CCCH-type with G patch domain; ZGPAT |
| 912 | 112771 | 80 | ACGCTCTCTGAGAGACCATCCCCAAGCACAGACGTCCAGACAGACCCCCAGACCCTCAAG | FXYD domain containing ion transport regulator |
| | | | | 5; FXYD5 |
| 913 | 114791 | 80 | ACTTGTGGTCTTCAGGAAAACTACTCAGAATATAATGACTCCTCATCAGTATCATATTGT | zinc finger protein 652; ZNF652 |
| 914 | 114917 | 80 | ACTTTGTTCCACGCTCCTGCTACTGACTGTCCCGTCCTGGGTCTTATCCCAGGTCACCTT | MGC27165 |
| 915 | 117844 | 80 | AGCAAGATTGATAGATTAGAGACGACATTAGCAGGCATAAAAAACATTGACACAAAGGTA | chromosome 19 open reading frame 59; C19orf59 |
| 916 | 118417 | 80 | AGCATGTGTTCTGTGAGGTTGTTCGGCTATGTCCAAGTGTCGTTTACTAATGTACCCCTG | NHP2 non-histone chromosome protein 2-like 1 (S. cerevisiae); |
| | | | | NHP2L1 |
| 917 | 120515 | 80 | AGGAGCTGCTACGGAGCCAGCTATATCCAGAGGTGCCACCCGAGGAGTTCCGCCCCTTTC | copper metabolism (Murr1) domain containing |
| | | | | 1; COMMD1 |
| 918 | 121491 | 80 | AGGGCAGATGAGGCGCAGGAAAATAGTCTTGGAAATGTTAAATATGATGGGTAAATTAAA | mediator of RNA polymerase II transcription, subunit |
| | | | | 10 homolog (NUT2, S. cerevisiae); MED10 |
| 919 | 127770 | 80 | ATGCTTCACAGCCTACCTCACAGGACAGCCCACTACCCCCAAGCCTCAGCTCAGTCACGT | toll-interleukin 1 receptor (TIR) domain containing |
| | | | | adaptor protein; TIRAP |
| 920 | 127964 | 80 | ATGGAGTGAGCCCAAAGGTTCGAAAGGTGTTGCAGCTTCTTCGCCTTCGTCAAATCTTCA | ribosomal protein L7; RPL7 |
| 921 | 131247 | 80 | CAACATCCAGGCCAAGATGCTGCCCAAGAAGACTGAGAGTCACCTCAAGGTAAAGGAAAA | HISTONE H2A |
| 922 | 132240 | 80 | CAAGTGCTGTTACAACTGGTTGCTGGGAGAATTAAGCTCATCCTCTGTGATTCCACTGGC | abhydrolase domain containing 10; ABHD10 |
| 923 | 135922 | 80 | CAGCTATCGCAGACCAGCATCCTGTCCCTTGCTGATTCCCACACGGAGTTCTTCGATGCC | oxysterol binding protein-like 7; OSBPL7 |
| 924 | 136206 | 80 | CAGGACACCATGGGACCCTCCCAGCATGTCTATGCCTACTCTCAAGAAATGGCTCCCTCC | colony stimulating factor 3 receptor |
| | | | | (granulocyte); CSF3R |
| 925 | 138517 | 80 | CATGGAGACCTTCTTCTACCGCCCCTGTCTTAATAAAGCTGCGTGTTTCACTTCGGCATC | U2 small nuclear RNA auxiliary factor 1-like |
| | | | | 4; U2AF1L4 |
| 926 | 141824 | 80 | CCATTATGTATTGATTTTGCAACTTAGGATGTTTTTGAGTCCCATGGTTCATTTTGATTG | coiled-coil domain containing 109B; CCDC109B |
| 927 | 143400 | 80 | CCCGGCCATCTTCCACGACTTCCGCATGTTCAACTGCTCCTTCCAGTTCTCCCTGGAGAA | patatin-like phospholipase domain containing |
| | | | | 1; PNPLA1 |
| 928 | 148862 | 80 | CGCGCCCTTGACGCCCTTCGGCCAGGCCACTGTGTGCCCCTTCTCCGCAGGCGCCGCCCT | basic helix-loop-helix domain containing, class B, |
| | | | | 4; BHLHB4 |
| 929 | 153388 | 80 | CTCTCCAACAAGATGTGGAAAAACCATATTTCCTCCAGGAACACTACACCGCTGCCCCGC | trinucleotide repeat containing 6B; TNRC6B |
| 930 | 157638 | 80 | CTTCGCCCTTCATGTGGTCCAACCTGGGCATTGGCCTAGCTATCTCCCTGTCTGTGGTTG | ATPase, H+ transporting, lysosomal 21 kDa, V0 |
| | | | | subunit b; ATP6V0B |
| 931 | 159466 | 80 | GAAAGCTCGGCGAGATGAAGAATCTGTGCGAATCGCTCAGACCAGACTGCTGGAAGAGGA | differentially expressed in FDCP 6 homolog |
| | | | | (mouse); DEF6 |
| 932 | 170501 | 80 | GCCCGGCGAGGAGAACGGCAAAGATTACTACTTTGTAACCAGGGAGGTGATGCAGCGTGA | guanylate kinase 1; GUK1 |
| 933 | 171691 | 80 | GCGAAACTATGCAACAGTTTACATCAGTCATGTGAAGTATTTGTCTAAAACAGAGCAAAC | Ras association (RalGDS/AF-6) domain family |
| | | | | 4; RASSF4 |
| 934 | 173522 | 80 | GCTGCAGAGACTGCCCCAGGCTGAGCCCGTGGAGATCGTGGCCTTCTCAGTCATCATCCT | unassigned |
| 935 | 174637 | 80 | GCTTTCTGTGCCGATAACGCTCACGCAAGCATGGTTAACGTCCCTAAAACCCGCCGGACT | 60S RIBOSOMAL PROTEIN L44 |
| 936 | 178413 | 80 | GGCCCCGTCCTATAGCCAAAATCACAGAAATTCATGAGTTTCTACTTGAGTGAGGAAACT | GUANINE NUCLEOTIDE-BINDING PROTEIN G/G/G |
| | | | | GAMMA-10 |
| 937 | 180376 | 80 | GGGCAATATTCTCTGTACATATTAGCGACAACAGATTGGATTTTATGTTGACATTTGTTT | fragile × mental retardation 1; FMR1 |
| 938 | 181930 | 80 | GGTGAAAAACTAACTTCAAGTGTCCCTTGTTTGAAATAAACTTAGCAGAGTCACTTTCTA | zinc finger protein 18; ZNF18 |
| 939 | 184098 | 80 | GTCAGTGAGGTCCCGTGAGTCTTTGTGAGTCCTTGTGTCATCGTTCGGGCACTGTTTTTT | PHD finger protein 21A; PHF21A |
| 940 | 185831 | 80 | GTGCCATGGAGTTCACCATCTGCAAGTCAGATATCGTCACAAGAGATGAGTTCCTCAGAA | caspase recruitment domain family, member |
| | | | | 11; CARD11 |
| 941 | 186009 | 80 | GTGCTATGGCCTCATCATCAAGACTTTCAATCCTATCCCAAGTGAAATAAATGGAATGAA | interleukin 1 receptor, type II; IL1R2 |
| 942 | 186061 | 80 | GTGCTGACGTACCTGCTGCTACCCTGCACACTGCCCTTCGAGTACATCTACTTCCGCAGC | patatin-like phospholipase domain containing |
| | | | | 5; PNPLA5 |
| 943 | 188218 | 80 | GTTGTGTTCATCAAGCCCACCTTCCCATTCTGCAGGAGGACCCAAGAGATCCTCAGTCAA | GLUTAREDOXIN, GRX |
| 944 | 188497 | 80 | GTTTGGGTATGCCACCTCAAAATGTTGGAGAAGTGTATGGAGTTGTGAAAGCTTATACAA | adenylosuccinate synthase; ADSS |
| 945 | 191839 | 80 | TATAGCCACAGAAATAAAGGAGGGACCTATATCTGGGACAGTGTCTTCTCAGAAACAACC | LOC375251 |
| 946 | 197179 | 80 | TCCTTGTCATTGACCTTAGCTAAACCATGGCAATTCATAAATAGAGGAAACATTAATGAA | microtubule-associated protein, RP/EB family, |
| | | | | member 2; MAPRE2 |
| 947 | 198352 | 80 | TCTCCAAGGCCCATGAGGATATGACTGCCCTGGAGAAGGATTACAAGGAGGTGGGCATGG | TUBULIN ALPHA CHAIN |
| 948 | 198356 | 80 | TCTCCACACAGAAAATCTTCTTGATTCTATAGAGACTTAATCATGCCTATGGCTTTGAAT | enoyl Coenzyme A hydratase domain containing |
| | | | | 3; ECHDC3 |
| 949 | 200308 | 80 | TGAAAGACCGACCATTCTTCCCTGGGCTGGTGAAGTACATGAACTCAGGGCCGGTTGTGG | non-metastatic cells 2, protein (NM23B) expressed |
| | | | | in; NME2 |
| 950 | 202673 | 80 | TGCAAATTTTCCCCGTTTGCCCTACGCCCCTTTTGGTACACCTAGAGGTTGATTTCCTTT | serine/threonine kinase 24 (STE20 homolog, |
| | | | | yeast); STK24 |
| 951 | 204337 | 80 | TGCTCTATACAAATGTATCCATAAAATATCAGAGCTTGTTGGGCATGAACATCAAACTTT | unassigned |
| 952 | 206444 | 80 | TGGCTTCTGAACTGGAATTCTGCAGCTAACCCTTCCACGACTAGAACCTTAGGCATTGGG | H2A histone family, member X; H2AFX |
| 953 | 207506 | 80 | TGGTTGGATGAAGTCCTTAGTACAGTTGAAAAACAGAGCATTAAAGACTAATCAATTGTT | F-box protein 30; FBXO30 |
| 954 | 208250 | 80 | TGTCCCTTTTTCCCCTGATGCAAGTTGTAGATGGAATAGAAGCCCTTGTTGCCGTAGATG | unassigned |
| 955 | 208748 | 80 | TGTGCAGGGTATCCTGTAGGGTGACCTGGAATTCGAATTCTGTTTCCCTTGTAAAATATT | non-SMC condensin I complex, subunit D2; NCAPD2 |
| 956 | 210081 | 80 | TTAAGGGTTTAGATGTAGACTCTCTGGCCATTGAGCATATCCAAATGAATAAAGCATCTA | 60S RIBOSOMAL PROTEIN L17 |
| 957 | 210225 | 80 | TTACACTGCACTCTGACCCTGTAGTACAGCAATAACCGTCTAATAAAGAGCCTACCCCCA | phosphoglycerate dehydrogenase; PHGDH |
| 958 | 211303 | 80 | TTCACTGATAAGGAGAGCAAGCGTCCCAAGAACATCCCCATCATAGTCCTCCCCCTCGAG | unassigned |
| 959 | 211412 | 80 | TTCAGCCTCAGAAATCAAATTTGACAGCCAGGAAGATCTGTGGACCAAAATCATTCTGGC | Kruppel-like factor 6; KLF6 |
| 960 | 211767 | 80 | TTCCACCGTATGGAAAAGGCGCACCCTGAGCCTGGGACCTGGGACAGCTTCCTGGAAAAG | sulfotransferase family, cytosolic, 1A, phenol- |
| | | | | preferring, member 3; SULT1A3 |
| 961 | 214987 | 80 | TTTAAAGAAGGGAGACGAGTGTGAGCTCCTAGGACATAGCAAGAACATCCGCACTGTGGT | Tu translation elongation factor, mitochondrial; TUFM |
| 962 | 217726 | 80 | AAGTCGGCTTCGAGCACCCTTCAGTTCCATGGCCAAGAGCCCACTCGAGGGCGTTTCCTC | deoxyguanosine kinase; DGUOK |
| 963 | 217999 | 80 | ACACTCTACTCCCGGTCAAAAGTGGATTGTATATGTCCTCTTTGATGTGATGGTCCCTTT | UNCHARACTERIZED |
| 964 | 219479 | 80 | ATCAAAACAAGACAAATGCTGTTCAGGGAAAGAAGTTGGCAAGCTTAATGTTAAACAAAA | NADH-UBIQUINONE OXIDOREDUCTASE 13 KD-B |
| | | | | SUBUNIT |
| 965 | 224565 | 80 | GGGCCCACCTAGCCTTTCCCTGCTGCCCAACTGGATGGAAAATAAAAGGTTCTTGTATTC | serine hydrolase-like 2; SERHL2 |
| 966 | 229017 | 80 | AGCCCCATCTCCTGAGCAGCACAGACCCTCCCACGGCCACCGCATGGTGAACCTGCACAG | KIAA1257; KIAA1257 |
| 967 | 230842 | 80 | CTCACGATTTATTCCTCCAGGTCTTTGATTGGAGAGAGTAACTTTTTAATTCTGTTGTTT | RNA binding motif protein 33; RBM33 |
| 968 | 235151 | 80 | CTGCTTCTAGCATGGTCGGTGGACCTGGGTGTCTGTCTGCACACGTCCTCCAGTGGCCTG | BETA1,4 MANNOSYLTRANSFERASE |
| 969 | 235454 | 80 | GGGCCGCTCGCAGACCAGCTTTCCTGGGAGCTGGCCCCGCTCCCGCGTTCCCCACCCTGC | unassigned |
| 970 | 236383 | 80 | CCCAGCCAGTTAAGCACAAAGAAAAATATTTCAATAAAGGATCATTTGACAACTGTGGAA | 60S RIBOSOMAL PROTEIN L12 |
| 971 | 264940 | 80 | AAGTGTGATGGCATGCACGTGTGGATCACTTGAGCTTGGGAGGTCAGAGCATAATGGCAC | unassigned |
| 972 | 541843 | 80 | GGGACACTGTTGGATAGGAGGCGTGGTCCCAGCGTGGTCTCCCTGTCTGGGCCTCTGCCT | unassigned |
| 973 | 10419000 | 80 | CCTGCCCCTCCTGGGCACCCTGCCCACCAGGTCACCTGCACCTGCTCTGAATAAACTGTG | lipocalin 8; LCN8 |
| 974 | 100430 | 90 | AAAAGCAAGAGAATTTGAGAAGATGAATCAGTCACTACGATTATTTCGGGAAGTTTGCCT | mutS homolog 6 (E. coli); MSH6 |
| 975 | 101196 | 90 | AAACTGCTGACTAGGTCATCCTCTGTCTGGTAGAGACATTCACATCTTTGCTTTTATTCT | adenosine deaminase, RNA-specific; ADAR |
| 976 | 101893 | 90 | AAAGTGAAAGCTCTGAACAAGGGTGATGCCAACTCTGAAGTCACTGTGTACTACCAGTCA | nardilysin (N-arginine dibasic convertase); NRD1 |
| 977 | 103225 | 90 | AACCATTTTAACTCTCCAGTGCACTTTGCCATTAAAGTCTCTTCACATTGATTTGTTTCC | fucosidase, alpha-L-2, plasma; FUCA2 |
| 978 | 104059 | 90 | AACTTCAGCGAGAAAGTGGGAGTTGCCTTTGACCACATGAAGGTCTGCTTTGGAGACTTT | elaC homolog 2 (E. coli); ELAC2 |
| 979 | 105120 | 90 | AAGCACAGATTTGACCCAAGCTATTTATATGTTATAAAGTTATAATAAAGTGTTTCTTAC | CDC-like kinase 3; CLK3 |
| 980 | 105172 | 90 | AAGCAGCCCTGCCAGCCACCTCCTGTGTGCCCCACGCCAAAGTGCCCAGAGCCATGTCCA | small proline-rich protein 2E; SPRR2E |
| 981 | 105239 | 90 | AAGCATTTAAAATATGTAGTTCCCATATATTTCAGGGTCTCTGTGTATTAAGCTAACTCA | COP9 constitutive photomorphogenic homolog subunit |
| | | | | 4 (Arabidopsis); COPS4 |
| 982 | 105376 | 90 | AAGCCTTGCCCTGGTGTTCTACCAGAAAAACGTCTCCCAATCACCCAGGAAAGCTGTCCA | carbohydrate kinase-like; CARKL |
| 983 | 105718 | 90 | AAGGAGAATGCCTAAAGTCAAACGAAGCCGGAAAGCACCCCAGGATGGCTGGGAGTTGAT | BUD31 homolog (yeast); BUD31 |
| 984 | 105982 | 90 | AAGGGAATGAGGATGATCTTTGGCTGTTGCTGCTCTTTATGAAGAATCTTATTTGTAACT | zinc finger, SWIM-type containing 3; ZSWIM3 |
| 985 | 106345 | 90 | AAGTCCGGTCTCTGACCCTTGACTCATGGGAGCCAGAACTAGTGAAGCTCATGTGTGAGC | centaurin, beta 1; CENTB1 |
| 986 | 106552 | 90 | AAGTTACTTGGATGGACCCATTGTGCATCTTTTACTGAAAACTGGCTCCCCATCATGTAT | tripeptidyl peptidase II; TPP2 |
| 987 | 106979 | 90 | AATCACAATTACACCACTTTAGACCCTATGTGTAGCAGGTCACAACTTACCCTTGTGTGT | microtubule-associated protein 1 light chain 3 |
| | | | | beta; MAP1LC3B |
| 988 | 107385 | 90 | AATGACTTGATCATCTGCTTCCTTTTTGAATTTTTAACAGATAGTAAGTAAATTTGGTGG | solute carrier family 31 (copper transporters), member |
| | | | | 1; SLC31A1 |
| 989 | 109365 | 90 | ACAGACATGTCCTTCGATAACTCCCTGTTTACCGTCTCCGCGAAAACGATGCCAGAAGAA | hypothetical LOC255809; unassigned |
| 990 | 111545 | 90 | ACCCTCGCTACAAGCCCGTCCCTGCCCTGGAGAACGACCTCGCGCTGCTTCAGCTGGACG | granzyme M (lymphocyte met-ase 1); GZMM |
| 991 | 112240 | 90 | ACCTGGGCCTTCTGAACATTCCAAAAGTTTTGACAAGTGGACGACTAAGATTAATGAATG | ribonuclease L (2′,5&apos; -oligoisoadenylate |
| | | | | synthetase-dependent); RNASEL |
| 992 | 112953 | 90 | ACGGTGAGGCGGAGGCACTGGCTGCAAAAGTCCACCCCCTCTAGACCTCTGCAACCACAG | unassigned |
| 993 | 113098 | 90 | ACGTTACCCCACTGTTTCCCACTGCCCGCGACGTCACTTTCCTGTGCACGTTACCCCTTC | unassigned |
| 994 | 113335 | 90 | ACTAGGAATCCTCCAACCAGGCTCCTGTGATAGAGTTCTTTTAAGCCCAAGATTTTTTAT | APEX nuclease (multifunctional DNA repair enzyme) |
| | | | | 1; APEX1 |
| 995 | 113678 | 90 | ACTCGAATCCAGAAGGAACGATTTGGCTCTACCCAGGAGTACGAAGCTTGCTTTGGTCAG | carbamoyl-phosphate synthetase 2, aspartate |
| | | | | transcarbamylase, and dihydroorotase; CAD |
| 996 | 114207 | 90 | ACTGGAGCCACCCGCGAAAATTCGGCCAGGGTTCTCGCTCTTGTCGTGTCTGTTCAAACC | ribosomal protein S29; RPS29 |
| 997 | 114676 | 90 | ACTTCTGTTTATTGTGGATGTTAAAGCCAACAAGCACCAGATCAAACAGGCTGTGAAGAA | 60S RIBOSOMAL PROTEIN L23A |
| 998 | 116246 | 90 | AGACCTTGCTCTTCCTAGTCCTTTTAATGCTGTGTGTTCTGTTAAGTTCTTTCATTTGTT | TAF7 RNA polymerase II, TATA box binding protein |
| | | | | (TBP)-associated factor, 55 kDa; TAF7 |
| 999 | 116401 | 90 | AGACTGTGAAAAGATCCTTGAACGGAAAGCCAAATCTTGCCAAGTAGGAAAGGAAAAGGG | 60S RIBOSOMAL PROTEIN L26 |
| 1000 | 116549 | 90 | AGAGACCCTTTCTGAAAGAAGTATGGCCAAAAGCACTTTAATGCTGCTGACATTGTTGTT | mitofusin 2; MFN2 |
| 1001 | 116793 | 90 | AGAGCGAGGAGAAGCGAGAAAAGATGAAACGGACCCTTTTAAAAGATTGGAAGACCCGTT | regulator of G-protein signalling 2, 24 kDa; RGS2 |
| 1002 | 116850 | 90 | AGAGCTTGGTTTCATTGAGCATTTCTCTATTTTTCCAGTTATCCCGAAATTTCTATGTAT | microtubule-associated protein, RP/EB family, |
| | | | | member 1; MAPRE1 |
| 1003 | 117096 | 90 | AGAGTCATCTCTAGTTCCCCACCTCAATCCCGGCATCCAGCCTTCAGTCCCGCCCACGTG | leukemia inhibitory factor (cholinergic differentiation |
| | | | | factor); LIF |
| 1004 | 117279 | 90 | AGATATTCTACATCCCATCCACAATACTACTGATTTTAGAGGACAAGACAATAAAGGGAT | alpha-kinase 1; ALPK1 |
| 1005 | 117960 | 90 | AGCACATTTGCCTACTAATGGAAAAGGTTAATAATTCATGCCAAAAATAGAAATTAGCGT | cytidine monophosphate N-acetylneuraminic acid |
| | | | | synthetase; CMAS |
| 1006 | 117986 | 90 | AGCACCTAAGAAGGGCTGCTGGACCTACAGAGCTCATGGTTGGATTAACCCATGCATGAG | 60S RIBOSOMAL PROTEIN L17 |
| 1007 | 119357 | 90 | AGCTACTAGCTGCCTACGTGTGTGCATTTGCTATATAGCATACTTCTTTTTTCCAGTTTC | platelet factor 4 (chemokine (C—X—C motif) ligand |
| | | | | 4); PF4 |
| 1008 | 119905 | 90 | AGCTTGGAACTTTTGAGATGATCCCTAACATACTGTACTACTTGCTTTTACAATGTGTTA | Nedd4 family interacting protein 1; NDFIP1 |
| 1009 | 120173 | 90 | AGGAATATGCAGAGGAGTTCAGGACCTACCTGGAGGGCGAGTGCCTGGAGTTGCTCCGCA | major histocompatibility complex, class I, F; HLA-F |
| 1010 | 120734 | 90 | AGGATTATGGGTCCTGCAATTCTACAGTTTCTTACTGTTTTGTATCAAAATCACTATCTT | Fas (TNFRSF6)-associated via death domain; FADD |
| 1011 | 120814 | 90 | AGGCACAGTACGGCCTCACCGACGAGGTTCACCAGCTAGAGGCAACCATCGCTGCCCTGA | tektin 2 (testicular); TEKT2 |
| 1012 | 121186 | 90 | AGGCTCTGTGAGGCACGAACCCTGCCTCCCTAGGCCGGACCTTGTGGACGACAGCCCCAC | hypothetical protein MGC13114; unassigned |
| 1013 | 121320 | 90 | AGGGAACAGTGCTTAGAAAAGCAAAAACTAGGTGTGTCATTGAAATAATAGGCATAAAAA | hypothetical protein LOC54103; unassigned |
| 1014 | 121518 | 90 | AGGGCCAGGGATGCATGGGATTTTAATTGTTTCATCACACCTTCCCCGTGGCAAAGAAAC | chromosome 16 open reading frame 57; C16orf57 |
| 1015 | 121803 | 90 | AGGTCCAGGTAGTTCGAGGACACTACAAAGGTCAGCAAATTGGCAAGGTAGTCCAGGTGT | ribosomal protein L26-like 1; RPL26L1 |
| 1016 | 122713 | 90 | AGTCCCTTAGCCATTATCTGAGAGGCTAGAATTCTGGCAGTGTCCCCGTGCATCTTTCCC | hypothetical protein FLJ14107 |
| 1017 | 123515 | 90 | AGTTATAATTCCTGCCTCAGAAAAAGCTTTTCCATTACACTGTGAATGATACCTGTTTTG | protein disulfide isomerase family A, member 5; PDIA5 |
| 1018 | 124957 | 90 | ATATTAAAGGCATTGAAGGACATTCACCTGGAAACTTACCAAAATTCTGCCATGAGTGTG | chromosome 8 open reading frame 70; C8orf70 |
| 1019 | 125201 | 90 | ATCACACTGTCAGAGGCTTACATTCAGATTTGGAAGAGGCGAGATAATGATGAAACCAAC | ubiquitin specific peptidase 39; USP39 |
| 1020 | 125329 | 90 | ATCAGAGACCCTGCCTCTGTTTGACCCCGCACTGACTGAATAAAGCTCCTCTGGCCGTTT | G protein-coupled bile acid receptor 1; GPBAR1 |
| 1021 | 125982 | 90 | ATCCTGCTGGAACCTCAGCTGCAACATGAGCTCCGCAGCCAGGTCCCGCCTCACCCGCGC | platelet factor 4 variant 1; PF4V1 |
| 1022 | 127187 | 90 | ATGATAAACTCTGTAAGGAAGTTCCCAACTATAAACTTATAACCCCAGCTGTGGTCTCTG | ribosomal protein S25; RPS25 |
| 1023 | 127871 | 90 | ATGGACCCCAAGTTCCCGAGGAACATGTGCTTTGCCAAGAAGCAAAACAAGAAGGTCCTA | similar to 60S ribosomal protein L29 (Cell surface |
| | | | | heparin-binding protein HIP); unassigned |
| 1024 | 127934 | 90 | ATGGAGCTGGCCTGCAGCCTTTTTGTGCAAGTGGGAACGCCACTGTCCCCCTGCTTTGTG | SERINE PROTEASE INHIBITOR, SERPIN |
| 1025 | 128131 | 90 | ATGGCTCAAATAATACCCTGGGTATGCAGGACCCACTATACCTTGCATTTGCTGAGTACA | protein tyrosine phosphatase, non-receptor type |
| | | | | 7; PTPN7 |
| 1026 | 128174 | 90 | ATGGGAAGAACAGAATTGCTCCTGCATGCAACTAATTCAATAAAACTGTCTTGTGAGCTG | clusterin; CLU |
| 1027 | 128456 | 90 | ATGTAGCAAAGCTTTTAGCCGATCCTCAAAACTTACTGAACATAAGATAATTCATACTGG | zinc finger protein 675; ZNF675 |
| 1028 | 130150 | 90 | ATTTCCTTATCCATGGAGGAGACCTCTGAACAGATCACAAATGTTACGTGAGCTTTTTCC | chromosome 6 open reading frame 89; C6orf89 |
| 1029 | 130721 | 90 | CAAACATCTTATTGATACTTACTTCAAGAAGAAGAAGCTGTGGAAGCCCAGACACCTGAT | similar to 60S ribosomal protein L6 (TAX-responsive |
| | | | | enhancer element-binding protein 107) (TAXREB107) |
| | | | | (Neoplasm-related protein C140); unassigned |
| 1030 | 131361 | 90 | CAACCTACTACGCACAGTGCTACCGCCACATGCTGGACTTGCAGAAGCAGCTGGGCAGAT | SH3-domain GRB2-like endophilin B2; SH3GLB2 |
| 1031 | 132592 | 90 | CAATTCCACGATGCCAAATTCATGGCAGACATTGATCTGGATCCAGGCTGTACATTGAAT | threonyl-tRNA synthetase; TARS |
| 1032 | 132917 | 90 | CACAGAGCATCGTGGAGGCCACCTCTAGGCTTAAGACCTTCAACTTGATCCCGGCTGTTG | mitochondrial ribosomal protein L4; MRPL4 |
| 1033 | 133345 | 90 | CACCAGTTGGTGGAGGCTTCAGGGAAGACCAGAGTCCTGGACAGAGAGGGTAACAGGAGG | solute carrier family 39 (zinc transporter), member |
| | | | | 7; SLC39A7 |
| 1034 | 133818 | 90 | CACGCAACCCTGGATAAATACGTAATTAAGTCCCGGCGCTCCCACTCCCGGAAAGGACCT | unassigned |
| 1035 | 134295 | 90 | CACTGGAGGCCTTGTAGGATTAAGGATACCAACATCAAAGGTGTAATCAGCCTCATTGGA | adult retina protein; unassigned |
| 1036 | 134910 | 90 | CAGAGAATCAAGGATTTTTTGCGGAATCTTGTACCCAGGACAGAGTCCTAGTGTGTGCCC | cathelicidin antimicrobial peptide; CAMP |
| 1037 | 136062 | 90 | CAGCTGTAGCCTATGGTGTGGCCAGCCTCACCCCCAGCAGCAAGCGTGGCTGCCCCCACA | scratch homolog 1, zinc finger protein |
| | | | | (Drosophila); SCRT1 |
| 1038 | 136254 | 90 | CAGGACGATACACTCACGCTGCAGGCTGCAGGCCTTGTGCCCAAAGCAGCACTGCTGCTG | UBX domain containing 5; UBXD5 |
| 1039 | 136396 | 90 | CAGGCAACTCCGAGTCTGCCCCCGTCCCTGCAACGGGTGACTCTCAGGATGCCCCTGTGC | CELP |
| 1040 | 137251 | 90 | CAGTGTTGCAGTGTGAATTCCTAAATAGAGGGTAAAGTGAGCCTAGCCAGGAGGTGTTTG | glucose-fructose oxidoreductase domain containing |
| | | | | 1; GFOD1 |
| 1041 | 137826 | 90 | CATCATAGATGACATCAACAGTGGTGCCATGGAATGCCCAGCCAGTTAAGCACAAAGGAA | 60S RIBOSOMAL PROTEIN L12 |
| 1042 | 138381 | 90 | CATGCACCTTACAATTTCTGAACAGTTAACCCTATAGAAGCATGCTTTATATGAGTGTCT | TNF receptor-associated factor 5; TRAF5 |
| 1043 | 139445 | 90 | CCAACACCTTCTCGCCCGCAAACGTGGACGCCTCCGTGATGTACAGGAAGTGGAAAGAGA | cell division cycle 34 homolog (S. cerevisiae); CDC34 |
| 1044 | 139760 | 90 | CCAATATCCAGGATAAGGAAGGCATCCTCCCCGACCAGCAGAGGCTCATCTTTGCAGGCA | UBIQUITIN |
| 1045 | 139869 | 90 | CCACAACTACCAGATTGTCAATCATGACCAAAAGTTGCTTCTCATCACTTCTACAACCCC | kelch repeat and BTB (POZ) domain containing |
| | | | | 7; KBTBD7 |
| 1046 | 141545 | 90 | CCATCCTTCCAGCTATCCTGCAAAGTGCAGCCCTTCCATGTTGCCCTGAAAGTCCCAGAT | solute carrier family 2 (facilitated glucose transporter), |
| | | | | member 14; SLC2A14 |
| 1047 | 141908 | 90 | CCATTTAGTCACCTAGGCCAAAGTCCGGAAGGATGCTCCTCTTACACTTTTCCGAAGATA | peroxisomal D3,D2-enoyl-CoA isomerase; PECI |
| 1048 | 142255 | 90 | CCCACTGGCTTCAAGATGGCATTAATTACTAGCCTCCCACTGTGGTGCCTGGCAGAGACC | unassigned |
| 1049 | 142775 | 90 | CCCCAGAAACCGAATCCTCTCTTCTGCATCCCCCTCTAAGTGATCTCTCCCAGTCCTGGG | unassigned |
| 1050 | 142977 | 90 | CCCCCTCTAGTGCATAATTCAGCATACGATGAGTATGAGTCTGTTTTGGACCCCATCCAA | unassigned |
| 1051 | 143723 | 90 | CCCTCGGCCTCCCGTTGGTATCTTCCATCTCATGCGTTCAGCATTGTAACCTCGCGGCGG | hypothetical LOC401093; unassigned |
| 1052 | 143967 | 90 | CCCTGGTAAAGCCCAAGGAAGTTAAGCCCAAGATCCCAAAGGGTGTCAGCCACAAGCTCC | 60S RIBOSOMAL PROTEIN L29 |
| 1053 | 144226 | 90 | CCGACCGACAGTTCCAGGAGCTCAACGAGCTGGCGGAGTTTGCCCGCTTACAGGACCAGC | transmembrane protein 142A; TMEM142A |
| 1054 | 145606 | 90 | CCTCCACTGCTTTTCTATGGGAGACACTCTTAATTTAACAGATGAGAATATTTTGAAACT | methyl-CpG binding domain protein 6; MBD6 |
| 1055 | 146482 | 90 | CCTGGAAATGCCAGAGAAGGATAACACATTCGTCCTCAAGGTAGAGAATGGAGCCGAATA | SH2B adaptor protein 2; SH2B2 |
| 1056 | 147338 | 90 | CCTTGCCCACCTCACTCCTGAGTTAGCACACTTTCCAGGTGTCAGCAGGTGTGATCAGGG | family with sequence similarity 128, member |
| | | | | B; FAM128B |
| 1057 | 147346 | 90 | CCTTGCTATAGAAGACCTGGGACAGAGGACTGCTGTCTGCCCTCTCTGGTCACCCTGCCT | defensin, alpha 3, neutrophil-specific; DEFA3 |
| 1058 | 147541 | 90 | CCTTTGAAATATATAGAAGGTGACAAAGCTTTTAACCAGTCCTCAACCCATACTACACAT | zinc finger protein 486; ZNF486 |
| 1059 | 149070 | 90 | CGCTGCTGCAACCGGCCGTGTGGCGCGCGCTGCTCCTGGACCGCCGCCAGGCCCTGCCCA | undifferentiated embryonic cell transcription factor |
| | | | | 1; UTF1 |
| 1060 | 150159 | 90 | CGTCCCAAATCAATAAGAAGGTAGAATGAGTTATGAGTTATTCATATTCTGTTGGAAGCT | cyclin-dependent kinase inhibitor 2D (p19, inhibits |
| | | | | CDK4); CDKN2D |
| 1061 | 150872 | 90 | CTAATGAAATGTAGTTGGGTTCTTCCTGTAATGCGCTATTATGTCTTGGGCTTAATAAAA | SWI/SNF-related, matrix-associated actin-dependent |
| | | | | regulator of chromatin, subfamily a, containing |
| | | | | DEAD/H box 1; SMARCAD1 |
| 1062 | 151419 | 90 | CTAGCTCCACGGCACGGGTGTCTCCCAGCCACTGCCCTTGCTGGAGGACCGCTGTGAGTC | chromosome 19 open reading frame 25; C19orf25 |
| 1063 | 151826 | 90 | CTCAACCAGACAAATCAGGGCTGCCCAGTGATCGGTTCTCTGCAGAGAGGCCTGAGGGAT | T-CELL RECEPTOR BETA CHAIN V REGION |
| 1064 | 152585 | 90 | CTCCCACCTCACCGTTTCCATAGTTGGCTCTTTTGTGTCATCTTACCCTTTACAGAGAAA | hexamthylene bis-acetamide inducible 2; HEXIM2 |
| 1065 | 154789 | 90 | CTGCAGCTGTTCAAGCACGAGATGCAGCATTTCGTGAAGGTCATCCAGGGCTACATCGCC | tubulin, gamma complex associated protein |
| | | | | 6; TUBGCP6 |
| 1066 | 154932 | 90 | CTGCCCCCAAGACACTGTGTGTGACCTGATCCAGAGTAAGTGCCTCTCCAAGGAGAACGC | granulin; GRN |
| 1067 | 154937 | 90 | CTGCCCCCTGGACCTCTTCTACAAGTGTGTCTGCTTCCTGCCTGTGAAACTCATCTTCGT | transmembrane protein 38A; TMEM38A |
| 1068 | 155553 | 90 | CTGGAGAGACAGATCTGAATGTTCAGTTCTAGCCAAGGTAGATTTTACTTTCAACTTTTT | protein phosphatase 1, regulatory (inhibitor) subunit |
| | | | | 2; PPP1R2 |
| 1069 | 157712 | 90 | CTTCTATGACGAGAATGATGCCAAACTCTTTGAACAGATTTTGAAGGCCGAGTACGAGTT | calcium/calmodulin-dependent protein kinase |
| | | | | I; CAMK1 |
| 1070 | 158606 | 90 | CTTTCTCTGTTTAGCAGTCACAGGTGAGGGTGGTATTAGCATCTTTTTTATGTAGAAAAA | activator of basal transcription 1; ABT1 |
| 1071 | 158656 | 90 | CTTTGACTGCCAGTATCTGATGGCCACCTTTGTCAATGTATACATCGCCAGTTTTATCAG | CDP-diacylglycerol synthase (phosphatidate |
| | | | | cytidylyltransferase) 2; CDS2 |
| 1072 | 159602 | 90 | GAAATATTCCAAGGCCTGGATGCTAATCAAGATGAACAGGTCGACTTTCAAGAATTCATA | S100 calcium binding protein A12; S100A12 |
| 1073 | 159687 | 90 | GAAATGGCGATATTGATATCATGTCCCTGAAACGAATGCTGGAGAAACTTGGAGTCCCCA | allograft inflammatory factor 1; AIF1 |
| 1074 | 159695 | 90 | GAAATGTGTCCTGAGAATGGATCTTGTGTACCTGATGGTCCAGGTCTTTTGCAGTGTGTT | chromosome 2 open reading frame 28; C2orf28 |
| 1075 | 159877 | 90 | GAACATGGAACAGAATGAACAGAAAGAGCAGAAGTCAAGTGAGCTCATGAAAGAAGTTCC | leucine rich repeat containing 37B; LRRC37B |
| 1076 | 160727 | 90 | GAAGCTTGAGCCTAAATCTGGCTGGATGACTTTTCTAGAAGTTACAGGAAAGATCTGTGA | 5,10-methenyltetrahydrofolate synthetase (5- |
| | | | | formyltetrahydrofolate cyclo-ligase); MTHFS |
| 1077 | 160921 | 90 | GAAGGTTCTGGCTCCACGGGTGAATCTGACTTTTCGTAAAATTTTGCTTACTAAAAAATA | alkB, alkylation repair homolog 2 (E. coli); ALKBH2 |
| 1078 | 161035 | 90 | GAAGTGGCTCTTGCAGCTAGAGTTGACTCAGAAGCCGAAATTCCTAGAAATCAGGTTTCT | egf-like module containing, mucin-like, hormone |
| | | | | receptor-like 2; EMR2 |
| 1079 | 161406 | 90 | GAATGTTGAAGGATTGAAGAGTTCTAAGCATAAAATAAGTGGCATTTTCTGACTTCTTCC | tumor protein D52-like 2; TPD52L2 |
| 1080 | 162153 | 90 | GACCAAGATGATCAGAAACCTGGCCCCTCAGAGCGATCTCGAGCCACAAAGTCAGGAAGT | scaffold attachment factor B; SAFB |
| 1081 | 162796 | 90 | GACGGGCCAGCCCAGGAACCCCAGAGCGCACCATGGCTGTCCAAGTCCTCTGTCTCCTCT | rhomboid domain containing 3; RHBDD3 |
| 1082 | 163054 | 90 | GACTGAGCTGTTTATTTTCTTCACTTCCCTTATGCAAAAATTTACCTTCAGGCCCCCAAA | cytochrome P450, family 2, subfamily J, polypeptide |
| | | | | 2; CYP2J2 |
| 1083 | 163084 | 90 | GACTGCCAGCGTGGTACCTCCCATGCTGCAGGCCTCCATCTAAATGAGACAACAAAGCAC | EGFR-coamplified and overexpressed |
| | | | | protein; unassigned |
| 1084 | 163151 | 90 | GACTGTGGACCTCATGGTTGAGCACACGTCGTTCAAGGAGATGAAGAAGAACCCTATGAC | sulfotransferase family, cytosolic, 1A, phenol- |
| | | | | preferring, member 2; SULT1A2 |
| 1085 | 163194 | 90 | GACTTCACTGGAAACAGCAAACTGGAGCTGAATTTCAAAGCTGGAGATGTGATCTTCCTC | neutrophil cytosolic factor 4, 40 kDa; NCF4 |
| 1086 | 163252 | 90 | GACTTGTATGCTGAACTCCGCTGCATGTGTATAAAGACAACCTCTGGAATTCATCCCAAA | pro-platelet basic protein (chemokine (C—X—C motif) |
| | | | | ligand 7); PPBP |
| 1087 | 164529 | 90 | GAGCTGGACACCCCCTCTATGACTGCAGAGCAAGTAGCTGCCATTGAGCAGAGCGTCAAT | alanyl-tRNA synthetase domain containing 1; AARSD1 |
| 1088 | 165048 | 90 | GAGGGATTAAAGATAAAAATTTTGGCTGGATGCAATGGCTCACGCCTGCTATCCCGCTAT | unassigned |
| 1089 | 165825 | 90 | GATATAGATTGTCCGGCCGCTTTGTGATTCCATGGATTGATTCAGTCTTCTGGATTTTTT | O-linked N-acetylglucosamine (GlcNAc) transferase |
| | | | | (UDP-N-acetylglucosamine:polypeptide-N- |
| | | | | acetylglucosaminyl transferase); OGT |
| 1090 | 166173 | 90 | GATCTCTCTGTGACTGACTTTGTGACTGTCCTGTGGTTTCTCCTGCCATTGCTTTGTGTT | major facilitator superfamily domain containing |
| | | | | 5; MFSD5 |
| 1091 | 166964 | 90 | GATTCTTCAGAGGTTAGCCTGGTACTTTCTCATCAGACACTAGCTTGAAGTAAGAGGAGA | prenylcysteine oxidase 1 like; PCYOX1L |
| 1092 | 167507 | 90 | GCAAGCCTCCTGCTTCACTTTCAGGTTTCTCGAAGTGCCTTCTTGCTCCTGTCTGTTTCC | CKLF-like MARVEL transmembrane domain |
| | | | | containing 5; CMTM5 |
| 1093 | 168872 | 90 | GCAGTGAGATCCCAGGAAGCTGGCACATCTTGGAAGGTCCGTCCTGCTCGGCTTTTCGCT | bone marrow stromal cell antigen 2; BST2 |
| 1094 | 169477 | 90 | GCCAAAGTCATACACTGGCTATCAGAAAATTATGCTGGAAGAATTGCAGTGGAAAAACTG | signal transducer and activator of transcription 3 |
| | | | | interacting protein 1; STATIP1 |
| 1095 | 169779 | 90 | GCCACTGCCGTTCCTCTATGTGCTCCTGCCCGCCGTGTACTCCGGGATCTGTGCTGTGGG | neuropeptides B/W receptor 2; NPBWR2 |
| 1096 | 169988 | 90 | GCCAGTTGGCTGAAAGGTTTGAAATACGTACCCCAGTAAAACCATTCAATCAATAATTGG | ubiquitin-conjugating enzyme E2W (putative); UBE2W |
| 1097 | 170312 | 90 | GCCCATGCAACTCAGTCCAGGATTTTACTGGGTCAGTGACATTGGTGGAAGCCTTCATGC | G protein-coupled receptor 68; GPR68 |
| 1098 | 170400 | 90 | GCCCCGGCCCCTGCAGCCGCAGAGATGTTGATGCCTAAGAAGAACCGGATTGCCATTTAT | unassigned |
| 1099 | 170630 | 90 | GCCCTGGCAGAAGACATCGAGAAGACCATGAGCACGGCTCTGCACGAGTTGCGGGAACTC | SLIT-ROBO Rho GTPase activating protein |
| | | | | 3; SRGAP3 |
| 1100 | 171390 | 90 | GCCTGGACTCTTGCACTGAAAATTGTCTCTCCAGCTGTGTAGACCACTTCATTGACACCA | MITOCHONDRIAL IMPORT INNER MEMBRANE |
| | | | | TRANSLOCASE SUBUNIT TIM8 |
| 1101 | 172691 | 90 | GCTATCTGACCCCTGACCTCTGGAAAGAGACTGTATTTACCAAGTCTCCCTATCAGGACT | ribosomal protein S2; RPS2 |
| 1102 | 172942 | 90 | GCTCCATTGGATCAGCTTCCCAGGAAGTTCAGCTTCGGGTTAGTACATAAGGCCACCACA | chromosome 10 open reading frame 33; C10orf33 |
| 1103 | 173555 | 90 | GCTGCATCCCGCGTCCAGCACCTACGTCCCGCTGCCGTCGCCGCCGCCACCATGCCCAAG | high-mobility group nucleosomal binding domain |
| | | | | 2; HMGN2 |
| 1104 | 173918 | 90 | GCTGGTCACCTACCTGCTCCCTCTGCTGGTCATCCTCCTGTCTTACGTCCGGGTGTCAGT | prolactin releasing hormone receptor; PRLHR |
| 1105 | 175144 | 90 | GGAAGACCGCTATAAAGGCTGAATGATGGATACATTATTCCTTCACACAGTGGATTTTGA | PQ loop repeat containing 3; PQLC3 |
| 1106 | 177061 | 90 | GGATATTTCATGTCTGAATCGGGACCCAGCTCGAGTAGTAGTTGTGGACTGCAAGAAGGA | translocase of inner mitochondrial membrane 50 |
| | | | | homolog (S. cerevisiae); TIMM50 |
| 1107 | 177639 | 90 | GGCACAATGCGGTCCAGACCCTGCTGCGTCTCCCTTCCAAACTCTGGTGCTGAATAAACC | glycoprotein Ib (platelet), beta polypeptide; GP1BB |
| 1108 | 177981 | 90 | GGCATACAAGGCGCTCCTCAGAGTCAAACACTTGATGCTTTTGCATTATGAGATTTTTGT | GTPase, IMAP family member 5; GIMAP5 |
| 1109 | 178007 | 90 | GGCATCATTGGCTATGATGTTTGAAGACCAATCTTTAACATCTGATTATATTTGATTTAT | ATP synthase, H+ transporting, mitochondrial F0 |
| | | | | complex, subunit G; ATP5L |
| 1110 | 178355 | 90 | GGCCCACTTTGTAGCCCCATCACCCTTGGCCTGCTGGTGGCTGGCGTCCTGGTTCTGCTG | CD8b molecule; CD8B |
| 1111 | 178408 | 90 | GGCCCCGAGGGCACGGAGGACGTTTTCACCTTCGGCTTTCCAGTACCGCCCTTCCTGCTG | protein phosphatase 1, regulatory subunit |
| | | | | 3D; PPP1R3D |
| 1112 | 178825 | 90 | GGCGATGCCCGTCCTCTGGCTTGGGTTAATTCTTCGGTGACACTGGCATTGCTGGGTGGT | N-sulfoglucosamine sulfohydrolase |
| | | | | (sulfamidase); SGSH |
| 1113 | 180037 | 90 | GGGAGACGTTCAGCTACCCTGACTTTCTCAGGATGATGCTGGGCAAGAGATCTGCCATCC | allograft inflammatory factor 1; AIF1 |
| 1114 | 180184 | 90 | GGGAGTAAAAACAGGCTGGTGCAGACAGCAGAGCTCACAAAGGTGTTCGAAATCCGCACC | glia maturation factor, gamma; GMFG |
| 1115 | 180191 | 90 | GGGAGTGAAATGTTACCCAATTAGGCTTGTCAGGTTAGTAATAAACTGAACAGTAATAAA | tripartite motif-containing 23; TRIM23 |
| 1116 | 180247 | 90 | GGGATCTTGGTGCTGAGCCGCCACACCCTGGGCCTGGCCCTGCGGGAGCACCCTGCCCTG | protein disulfide isomerase family A, member 2; PDIA2 |
| 1117 | 180427 | 90 | GGGCAGATATGCATTAAATAGTTTGTACAAGCAGCTTTCGTTGAAGTTTAGAAGATAAGA | growth hormone inducible transmembrane |
| | | | | protein; GHITM |
| 1118 | 180941 | 90 | GGGTATAATCTCACAAATCGATGGGACTGCAAGGATTGTAAACTGAAATGAACATGATTA | unassigned |
| 1119 | 180998 | 90 | GGGTCCCATTTCTCACTGAGAAGATTGTGAATATTTCCATATGGATTTTCTATTGTTACT | solute carrier family 2 (facilitated glucose transporter), |
| | | | | member 3; SLC2A3 |
| 1120 | 181105 | 90 | GGGTGATTCTCTTGCCATTCATCGACAGTCAGCATGTCATCCACAAGTATTTCCTGCCCC | dolichyl-phosphate mannosyltransferase polypeptide |
| | | | | 2, regulatory subunit; DPM2 |
| 1121 | 181758 | 90 | GGTCCTCAAGGAATCAAAGTTTAAGGAAACAGGTGTAATTACCCCAGAAGAGTTTGTGGC | ATG3 autophagy related 3 homolog (S. cerevisiae); |
| | | | | ATG3 |
| 1122 | 182820 | 90 | GGTTTGGAGATCCAGGAACACACAGATTTGGGTATCAAATGTGACCCATGCATTGGTATC | unassigned |
| 1123 | 183013 | 90 | GTAAGCCGAAAGGATGAAGAGTTAGACCCCATGGACCCTAGCTCATACTCAGACGCCCCC | polyglutamine binding protein 1; PQBP1 |
| 1124 | 184495 | 90 | GTCCGTGTGCTGGATGAACGCCTGGTTCGACTGCGTGATGGTACCCGGTCTTACTTCGGG | tumor necrosis factor (ligand) superfamily, member |
| | | | | 14; TNFSF14 |
| 1125 | 185825 | 90 | GTGCCATCCAGAAGAAATCCCCCTGGCGGCAAGTCCAGCCTCGTCTTGGGTTAGCTCTGA | hematological and neurological expressed 1; HN1 |
| 1126 | 186996 | 90 | GTGTCTTGATGACTCTCCCAGGAATCAGAAAGATAGTATTTACTAAAGAAACGGTTGTTT | WD repeat and FYVE domain containing 2; WDFY2 |
| 1127 | 187070 | 90 | GTGTGCTCTGGCTCGGATAAGAGATGGGACATCATTCAGTCACTAGTTGGATGGCACAAG | translocase of outer mitochondrial membrane 7 |
| | | | | homolog (yeast); TOMM7 |
| 1128 | 187155 | 90 | GTGTTACTACAAGATGGCAATAAATACTATGGGATTGTTTGTATTAAAAAATTTACATTG | small nuclear ribonucleoprotein polypeptide E; SNRPE |
| 1129 | 187598 | 90 | GTTCAGTTATGAGGAGTCAAATCCTAAGGATCCAGCGGCAGTGACAGAATCCAAAGAGGG | histocompatibility (minor) 13; HM13 |
| 1130 | 187762 | 90 | GTTCCTTGTGGATGTTAAAGCCAACAAGCACCAGATTAAACAGGCTGTGAAGAAGCTCTA | 60S RIBOSOMAL PROTEIN L23A |
| 1131 | 188191 | 90 | GTTGTCCTGAAGTCGGGCTCTCCCGGCCCTGCCTCCCAGCAAGTAAGCAAGCTCTTTTGG | FLJ45445 protein; unassigned |
| 1132 | 189240 | 90 | TAAGAGGACACAAATGAGGACACGTGGCTTTTATACAAAGTATCTATATGAGATTCTTCT | ring finger protein 1; RING1 |
| 1133 | 189793 | 90 | TACAATGTCTTTTAGCTAATTCTAATTAAAAATTACAGACTGGTGTACAAGATACTTGTG | ubiquinol-cytochrome c reductase, Rieske iron-sulfur |
| | | | | polypeptide 1; UQCRFS1 |
| 1134 | 189818 | 90 | TACACAGCCCCGTGAACCCTGAGGAGTGGAGTCATACACGAAGGGCGTGTGGCCATCGTG | bromodomain containing 9; BRD9 |
| 1135 | 190155 | 90 | TACCAGTGACCATATTGAAACGCTGTATGAGCTGGACATCGAGTACTCTCAAGTTTTAGC | ferrochelatase (protoporphyria); FECH |
| 1136 | 190198 | 90 | TACCCAGTAACTGAAAGCCCCTCTGGTCCTCGCCAGCTATTTATTTCTTGGATATTTATT | interleukin 27; IL27 |
| 1137 | 190344 | 90 | TACCTGCCTGTAGACAAGTCTCTCTCATACCAACAGAACTTCCGGTACTTCCAGAACCAA | golgi apparatus protein 1; GLG1 |
| 1138 | 190833 | 90 | TACTTTTAGCCTGTGTCAAATGTAAGTCCCAAGTATTTCCAGCAGGAAGTAATGTCTTCC | HSPB (heat shock 27 kDa) associated protein |
| | | | | 1; HSPBAP1 |
| 1139 | 191960 | 90 | TATCACCCTTTACTGCAACCACAGGAACCGAAGACGTGTTTGCAAATGTCCCCGGCCTGT | CD8a molecule; CD8A |
| 1140 | 192340 | 90 | TATGCCAGAACCCCCTCCATCGTCTACGTTATCTGCATCACTTCCAGGTCCACCCTTTCT | hypothetical protein FLJ25006; unassigned |
| 1141 | 192488 | 90 | TATGTCAAAAATTGGACAAAAGTTTCTCAATGATTAAGGAGGGTGATTATAACCCCCTCT | selectin L (lymphocyte adhesion molecule 1); SELL |
| 1142 | 192673 | 90 | TATTCGAAATCTCAGGACTCTTCTGGCCGTAGGTTCCAGGAAAGCTCGTGGAAGCTTTGG | similar to HESB like domain containing 2; unassigned |
| 1143 | 192931 | 90 | TCAAACGCAGAAGGACTGCCTCACTGAGCAACCAAGAGTGTCAGTTGTACCCGAGGCGTT | small nuclear ribonucleoprotein polypeptide N; SNRPN |
| 1144 | 193802 | 90 | TCACTCCGCGTCCCTACTGCACCTGTCACAAAGTGCCTTCTGATATGCCTGGCAAACCAA | LOC150166 |
| 1145 | 194079 | 90 | TCAGATGATGACTGGTTGAAGAAGTTTTCTGGGAAGACGCTTGAAGAGAATAAAGAGGAA | peptidylprolyl isomerase E (cyclophilin E); PPIE |
| 1146 | 194352 | 90 | TCAGGAGCGCATTAACTGCCTGGAAGGGACCCACGAGTTTTTTGAGGCCATTGGGTTCCA | UBX domain containing 1; UBXD1 |
| 1147 | 194700 | 90 | TCATCAAGTCAAAAGCACTGAGTGTTTTGCTAGTCTAGTGACATGGGTTATTGTATTTCC | chromosome 20 open reading frame 177; C20orf177 |
| 1148 | 194779 | 90 | TCATCCTCACTCAGTTCCCTGGTAGCACAGACTGACAGCTGCTCTTGGGCTATAGCTTGG | KIAA0913; KIAA0913 |
| 1149 | 196141 | 90 | TCCCGTCAGGACGTTGAGGACTTTTCGACCAATTCAACCCTTTGCCCCACCTTTATTAAA | CD14 molecule; CD14 |
| 1150 | 196409 | 90 | TCCGCTTATTTCTGCCAGTATATTTTGGACACTTTATAATCATTAAAGCACTTTCTTGGC | ribonuclease/angiogenin inhibitor 1; RNH1 |
| 1151 | 196448 | 90 | TCCGGGCTGGGTAAGCTTAGACAAGCCCCCTCCCCTCTCTGTGAGCCTGTTTCTCTGGGA | unassigned |
| 1152 | 198298 | 90 | TCTCAGTTACAACCTATTACATATGGTCCTTCACATTCAGGGTCTGCTACAACAGCTTCC | nuclear factor of activated T-cells, cytoplasmic, |
| | | | | calcineurin-dependent 3; NFATC3 |
| 1153 | 198391 | 90 | TCTCCAGTTGGTTATCTGAATAGTGTCACCAATTCCACCAAGACAGTGCTGAGATTGGAA | transforming growth factor, beta receptor III |
| | | | | (betaglycan, 300 kDa); TGFBR3 |
| 1154 | 198428 | 90 | TCTCCCCAGGAATTCACTTAAAAAGGGACTGAGCATTGTGTCAACCTGTTGCAGTGTTTT | ankyrin repeat domain 13A; ANKRD13A |
| 1155 | 199360 | 90 | TCTGTAGAGATGGCCTTTCACTTGAGGAGTACTCAGTTTTCAGGTTCTTCCTAGCTCGGG | tyrosine 3-monooxygenase/tryptophan 5- |
| | | | | monooxygenase activation protein, beta |
| | | | | polypeptide; YWHAB |
| 1156 | 199779 | 90 | TCTTCGCCTTCCACTTCTACCGCTCACTGGTCAGCCATAAGACCGACCGACAGTTCCAGG | transmembrane protein 142A; TMEM142A |
| 1157 | 200004 | 90 | TCTTGTTTTTCCACTACTGCTACCACAACTATATTATCATGCAAATGCTGTATTCTTCTT | signal transducer and activator of transcription 1, |
| | | | | 91 kDa; STAT1 |
| 1158 | 200160 | 90 | TCTTTTGTCTTTCCGTGGAGCTGTCGCCATGAAGGTCGAGCTGTGCAGTTTTAGCGGGTA | ribosomal protein L24; RPL24 |
| 1159 | 200186 | 90 | TGAAAAAGCAATGACAAATCACTGCAAGAGTACACGTCATAAGCAAAATACTGAGAAATT | zinc finger protein 638; ZNF638 |
| 1160 | 200578 | 90 | TGAAGAAAGTTGAAATCAGCCAGCAGGCCAAGTACACTTGCTCTTTCTGTGGCAAAACCA | ribosomal protein L37a; RPL37A |
| 1161 | 201343 | 90 | TGACGCTCTCTGTTCTACACAGCCCTCCTGGTCTTCAGTGCCCTGGGAAACATCCTTGCC | unassigned |
| 1162 | 201440 | 90 | TGACTGCCCCATATTTTACATCCCTCATTCAAGGTACTGGCTCCTGTATCACCCAGCTCT | unassigned |
| 1163 | 201912 | 90 | TGAGGCTGCGGACAAAGCCCTTTCATCTGAGGACTTTCATCTGTGCATATCACGGCCCCC | DEAH (Asp-Glu-Ala-His) box polypeptide 38; DHX38 |
| 1164 | 202982 | 90 | TGCAGATGCTCTTAAAAGCATTGATAACCTTTGTGACGAACATAAAGAGATCCTTAAATT | NADH dehydrogenase (ubiquinone) Fe—S protein 1, |
| | | | | 75 kDa (NADH-coenzyme Q reductase); NDUFS1 |
| 1165 | 203098 | 90 | TGCAGTAGACGATACAGGTTGCATGTGGACACTCAGTCACATTAACAACTTGGGAAAAAA | BTB and CNC homology 1, basic leucine zipper |
| | | | | transcription factor 1; BACH1 |
| 1166 | 203648 | 90 | TGCCCTGGACCCTCGGCTGGGTAGCGCCACCAGAGCGACCAAACGTCCCGCGCCTTCCAG | sorbitol dehydrogenase; SORD |
| 1167 | 203700 | 90 | TGCCGGAAAATTGGTCGCGATTGTAGATGTTATTGATCAGAACAGGGCTTTGGTCGATGG | ribosomal protein L14; RPL14 |
| 1168 | 203708 | 90 | TGCCGGGCTTTATCGCTGCCTCTATTATAAGCCCCCTGGATGGTCTGAGCACAGTGACTT | leukocyte-associated immunoglobulin-like receptor |
| | | | | 2; LAIR2 |
| 1169 | 205425 | 90 | TGGAGATGGCGACTAGTGGACAACAGAACAATATTGGAATGGTGGTAATACGAGGAAATA | small nuclear ribonucleoprotein polypeptide G; SNRPG |
| 1170 | 205686 | 90 | TGGATGACATGGACATGGACTTAGACAAGGAATTTCTCCAGGACTTGAAGGAGCTCAAGG | fibroblast growth factor (acidic) intracellular binding |
| | | | | protein; FIBP |
| 1171 | 206696 | 90 | TGGGCACATTGCTGCTAATTAATCTTCCTAATCTCGTGGGATCACAATATGAATAACAAG | FLJ21272 |
| 1172 | 207077 | 90 | TGGTCAACTTAGCTTTTAAGCAGACGATGCTGTAAAAACTAACGGCTTCTCTGATATTTA | RAD21 homolog (S. pombe); RAD21 |
| 1173 | 207211 | 90 | TGGTGAAGAAGCAGGTGTTTGAGCTACTGGCTGCCCTGTGCATCTACTCTCCCGAGGGCC | chromosome 14 open reading frame 151; C14orf151 |
| 1174 | 207673 | 90 | TGTACAACACTTCTTACTGCGCTGAGATCGCTCACAGTGTTTCCTCCAGGAACCGCGAAG | 60S RIBOSOMAL PROTEIN L32 |
| 1175 | 207692 | 90 | TGTACAGTTATAGCTACAACCAGTATTATCAGCAGTACCAGAACTACTATGCTCAGTGGG | tRNA selenocysteine associated protein 1; TRSPAP1 |
| 1176 | 208079 | 90 | TGTCAGAACTAAGGAATGAATTACAGCGGAAAGATGCACTAGTCCAGAAGCACTTGACAA | mediator of RNA polymerase II transcription, subunit |
| | | | | 28 homolog (S. cerevisiae); MED28 |
| 1177 | 208310 | 90 | TGTCCTTCCCGTCAGCCTGGCATTTGACAAATGTACAGCTTGTTCTTCCAAAGTTCTTGA | ATG7 autophagy related 7 homolog (S. cerevisiae); |
| | | | | ATG7 |
| 1178 | 208491 | 90 | TGTCTTCGTTAGAAAAGTAAAAATGCTGAAGAAGCCCAAGTTTGAATTGGGAAAGCTCAT | ribosomal protein S3A; RPS3A |
| 1179 | 210085 | 90 | TTAAGTAAGTTTTTCTCAAATTTTGTTTCAGTTCTAGGTCCCTTGTCACAGCTTGGTTTT | tetratricopeptide repeat domain 14; TTC14 |
| 1180 | 211683 | 90 | TTCATTCTGTATTTTGCCCGCAAAGTTTTAAAGCTTTCATCCACAGTCAGGAATTAAACT | hypothetical LOC440248; unassigned |
| 1181 | 211856 | 90 | TTCCATCATGGATTCATTACAGCTTAATCAAAATAACGCCCCAGATACCAGCCCCTGTAT | v-rel reticuloendotheliosis viral oncogene homolog A, |
| | | | | nuclear factor of kappa light polypeptide gene |
| | | | | enhancer in B-cells 3, p65 (avian); RELA |
| 1182 | 212069 | 90 | TTCCGCTATTTTGCACCACCTGCCTGGCCCTTATGGGCAACTCAAGGAAGAAAGGAAAGA | unassigned |
| 1183 | 212354 | 90 | TTCGCACTGCTGTCTTTGGCTTTGAGACCTCGGAAGCGAAGGGCCCCGATGGCATGGCCC | major vault protein; MVP |
| 1184 | 212904 | 90 | TTCTGTAATCAAACTGCAAATATTGTCATAACCAACATCCAAAATGACGGCTGCTATATA | pleiomorphic adenoma gene-like 1; PLAGL1 |
| 1185 | 212939 | 90 | TTCTGTGCTGGCTGCTCAGAAGATACCGCATATCTAAGAAGATTGATCACCTCATGTATC | 60S RIBOSOMAL PROTEIN L19 |
| 1186 | 213466 | 90 | TTGATAGAAAACGCTTTGATTGCTCAATCTCTTGGTAAATATGGCACCATCTGCCTGGAG | 60S RIBOSOMAL PROTEIN L7 |
| 1187 | 215143 | 90 | TTTACCTCTAGGAGGATTTGCTGAGCTCATGGGAAGTAATGGGCCTCAAAAGTTTTGCAT | WW domain containing E3 ubiquitin protein ligase |
| | | | | 1; WWP1 |
| 1188 | 215650 | 90 | TTTCCTCTATATTCGTTCTTGGCTCCCTTGTATATTTTTCTCAGGAGGCGTCACGGTGGG | insulin induced gene 1; INSIG1 |
| 1189 | 216444 | 90 | TTTGTAGACACCTCAAATTATATCACTGTTCTCTAGCGCCAATATTCCCAGGTAAATTGA | multiple EGF-like-domains 9; MEGF9 |
| 1190 | 216522 | 90 | TTTGTGATGTCATTTGCCTGTGTCATGGCCTGCCTTCCCTAGATATTGTCCTAATGTGAG | unassigned |
| 1191 | 216646 | 90 | TTTTACTATTGAACTGTATTCTAGTGGCTGTTCATGCTCCAAGACTTTAGTTACCGAGAC | MAX binding protein; MNT |
| 1192 | 217271 | 90 | AAACATGAACAGCACCAAGCTCTCAGCTGACACCTACGAAGATCTGAAGGCCAAGCTTCC | c-Maf-inducing protein; unassigned |
| 1193 | 217706 | 90 | AAGGTGGTTCTTTCCTTGAAGGGCAGCCTCCTGCCCAGGCCCCGTGGCCCTGGAGCCTCA | ubiquitin A-52 residue ribosomal protein fusion product |
| | | | | 1; UBA52 |
| 1194 | 218186 | 90 | ACCCCATGCTCCCCAAGAACGCGGCTCTGCGCTGGAAGGCTGTGGCCTCTTGCTCCTCCT | keratin 3; KRT3 |
| 1195 | 219723 | 90 | ATGGAGCTGTGCAAGTTGGAAGCCGCGGAGGCTCTCGGAACATGACCTACCTGCCGGCGG | LOC494150 |
| 1196 | 220179 | 90 | CACCAAGCTGTCTGGCGCATGTGCCCTGGGCATCTCCACCCTCAGTCTGGAGTTCTCGGG | hypothetical protein LOC388931; unassigned |
| 1197 | 220354 | 90 | CAGAGTGCACCTGACACTGCCATCACATCGTCAGTATCACTGCCTGTCTCTGCCACCAAA | similar to hypothetical protein MGC49416; unassigned |
| 1198 | 220708 | 90 | CCAAATTAGGCTTAGACTGTGCAAAGGGCTTAGCTAAGTTATCGAGCTTAAAACCCGTCA | family with sequence similarity 129, member |
| | | | | A; FAM129A |
| 1199 | 222023 | 90 | CTCCTGTATTACCGCCGAGTGGACCTGCTGTAAACCCTGTGTGCGCTGTGTGTGCGCCCA | ubiquitin specific peptidase 10; USP10 |
| 1200 | 222435 | 90 | CTTCCTGCTCTCCATCATGGCGCAGGATCAAGGTGAAAAGGAGAACCCCATGCGGGAACT | ribosomal protein L11; RPL11 |
| 1201 | 223755 | 90 | GCGGTTTCTTTCTTTCCGCGCCGATAGCGCTCACGCAAGCATGGTTAACGTCCCTAAAAC | ribosomal protein L36a; RPL36A |
| 1202 | 225147 | 90 | GTGGTGAAGACAATGCAAGCCCTGGAGAAGGCCTACATCAAGGACTGTGTCTCCCCCAGC | vacuolar protein sorting 28 homolog (S. cerevisiae); |
| | | | | VPS28 |
| 1203 | 226296 | 90 | TCTGTGCCTTGGCAACAAAGCGCCACTACTCCATAACCCCATGAAACCTGCCCTGCCCCC | unassigned |
| 1204 | 230672 | 90 | CGCTCCATCTCAGCTTCCCCATGTGGTGCTGTGCTCTGTGGTGGCCAAGACTGCCATGTT | unassigned |
| 1205 | 232022 | 90 | GCTGAGAAATTCAGCTTTGTTTTAGTTGAATCATCATATTGGAAAGCAGACATTGAAAGT | membrane bound O-acyltransferase domain |
| | | | | containing 1; MBOAT1 |
| 1206 | 232526 | 90 | GGTTGGGAGGCCATGGAACCAGGATTAGACCCACATCCGGCCACCAAGACCTCTGGCTCC | RIBOSOMAL PROTEIN L5-RELATED |
| 1207 | 232819 | 90 | GTTTCAATACAGTGTCCCAGGCAGTCACTACCTATAGATTAGAGCTGATGTGCTGGCCTG | unassigned |
| 1208 | 233835 | 90 | TGGGCTGGATCCTCTGGTACACCGGCAACATCGAGATCTCGCGCCAGGAGCTGGAGCGCG | hypothetical gene supported by |
| | | | | BC052596; unassigned |
| 1209 | 234327 | 90 | TTTCTTGTATTTCTCTCACGTTAACAAAATTGGTTCAGCATCTACCATGGGCTACATGCT | UNCHARACTERIZED |
| 1210 | 234978 | 90 | CCCCACCTGACCTGGCCTCGGCCATCAGCAACTGGGTTCAGTTTGAAGATGACACACCCT | stonin 2; STON2 |
| 1211 | 234984 | 90 | CCCCCGGAGCCATGGCCAGCCCTTCCCGCAGCTCCGAAGCCACTGGCAAGCCCCGAGGCA | unassigned |
| 1212 | 234990 | 90 | CCCGAGTCCCCTACCACTTCCGGGCCCCCAGCCGCATCTTCTGGCGGACCGTGCGAGGTA | similar to ribosomal protein L13a; unassigned |
| 1213 | 235306 | 90 | GCAGTAAGAAAACTGTAAAATTCGAGCCATATAAATAAAACCTGTACTGTTCTAGTTGTT | SUB1 homolog (S. cerevisiae); SUB1 |
| 1214 | 236048 | 90 | AAATACACAGAGGTCCTCAAGACCCAGGGACTCCTGAGCCCAATAAAGACTATTAATTCC | unassigned |
| 1215 | 236152 | 90 | ACTCCTAAGACATACTTGTGATATTTCAATGATGCAATAAAAGACCTATTGATTTGGACC | 60S RIBOSOMAL PROTEIN L9 |
| 1216 | 236473 | 90 | CTCGCTCTCTGGGCAACAACAGATATCAGAAAACACTTGCCATTTATTTATAACCTAAGC | GLYCOGENIN-RELATED |
| 1217 | 236503 | 90 | CTTCAATATTGGTGATGCCCTGGACAGCAGCAGCTCCATGTAAACCATCCAAAAGACCAC | KERATIN, TYPE I CYTOSKELETAL |
| 1218 | 236579 | 90 | GATGGGTAGTTAGATTTCCCAAAATTTCTTAATCTGATTGGTGGCCTAGCTGCGGCTTGC | S100 CALCIUM-BINDING PROTEIN A11 |
| 1219 | 236585 | 90 | GATTTTGGACCCAAGAAGGGAGAAAACTTTGGAGGCAGAAGCTCTGGCCCCTATGGTGGT | HETEROGENEOUS NUCLEAR |
| | | | | RIBONUCLEOPROTEIN |
| 1220 | 236724 | 90 | GGTGAGGAAGGCAAGAAAAGCTGGCAACTTCTATGTACCTGCAGAACACAGATCGGTATT | 60S RIBOSOMAL PROTEIN L7 |
| 1221 | 236885 | 90 | TGATGGTACCTTAGATCACCCCTACAGCCATGCTCTGGTGGCTGGAATTGACCGCTGTCC | 60S RIBOSOMAL PROTEIN L27E |
| 1222 | 243149 | 90 | AAAGAAAATTCATGTGAAAGTTCTCAGAGTCGTCCTTGTCTACTCCACTACCAAATGTTG | P40 |
| 1223 | 312026 | 90 | AGCCCCTGCCACTGCCTTCACCAGGCCCAGCTCACACACGGCTTGGCACCGTGCACAGAG | unassigned |
| 1224 | 351916 | 90 | ATTAATCTTTCTTAATTGGTTTGCCTGTTCTGCTTCTGTAAAAATTGCTTCAGCTAAACT | unassigned |
| 1225 | 697257 | 90 | AGCCTGGACCCCGACACGCTGCCTGCTGTTGCCACACTCCTCATGGATGTCATGTCCTAC | opposite strand transcription unit to |
| | | | | STAG3; unassigned |
| 1226 | 697295 | 90 | AGCGTACAACAGTGATACATGTAACCCCAAATGTGATGTGAGAGGACGATTACTTTGTAA | gb def: Hypothetical protein FLJ20958 |
| 1227 | 704151 | 90 | CTCCTATGTTGGAAATTTGTTCATTAAAATTCTCCCAATAAAGCTTTACAGCCTTCTGCA | G antigen 6; GAGE6 |
| 1228 | 712587 | 90 | TCCCAGAAGTGGTTGTTTCCCTTGCATGGGACGAAAGCTTGGCTCCAAAGCATCCAGGCT | defensin, alpha 1; DEFA1 |
| 1229 | 714879 | 90 | TGGTGTCTAGCACATTCCTCTACCTTATTTTCTGTCATTGTACCTACTTCTACCTGAACA | unassigned |
| 1230 | 100771 | 100 | AAACAACTTGACCAAAAATTTGTCACAGAATTTTGAGACCCATTAAAAAAGTTAAATGAG | apolipoprotein L domain containing 1; APOLD1 |
| 1231 | 101113 | 100 | AAACTACAAAGAATACTGTGCTAAGGCTTGAGTGCGTTGAGCCCAACTGCAGATCCAAGA | LOC284230 |
| 1232 | 101958 | 100 | AAAGTTTATCTATAACCTGGAAGACCATGAGTGGTGTGAAAACATGGAGTCCGTTTTATA | solute carrier organic anion transporter family, |
| | | | | member 3A1; SLCO3A1 |
| 1233 | 102040 | 100 | AAATATATACGTCTATTCTTTATGCCTTGCCCTAGCCAGATGGAAGAAGATGAAGAAGGA | Kruppel-like factor 7 (ubiquitous); KLF7 |
| 1234 | 102437 | 100 | AAATTGGAAGCTGTGCAGTATAAAACTCAAGTTGTTGCTGGAACAAATTACTACATTAAG | cystatin A (stefin A); CSTA |
| 1235 | 102558 | 100 | AACAACTGGAGGGAGATCCCAGAAAACCTGATGGACCAGTACAGCGAGGTTAATGCCATC | alanyl (membrane) aminopeptidase (aminopeptidase |
| | | | | N, aminopeptidase M, microsomal aminopeptidase, |
| | | | | CD13, p150); ANPEP |
| 1236 | 102604 | 100 | AACAAGGACACCAAGGTACCCAATGCCTGTTTATTCACCATGAACAAAGAAGACCACACA | DNA directed RNA polymerase II polypeptide J-related |
| | | | | gene; unassigned |
| 1237 | 103589 | 100 | AACGCCACCCACTGCCAATACAACTTCCCACAGGTGGGCCGCACGGCTCTGCGGGTGCTG | chemokine (C—X—C motif) receptor 3; CXCR3 |
| 1238 | 104196 | 100 | AAGAAAAGCCATCTATGTACTGAACCCGGGACTAGAAGGAAAATAAATGATCTATATGTT | proteasome (prosome, macropain) activator subunit 2 |
| | | | | (PA28 beta); PSME2 |
| 1239 | 104280 | 100 | AAGAACAGGGTTGGGACCTTTTCTGCCCCTGCCCCTTAGCTACTGAGGCATAGGGAGAGG | glucocorticoid modulatory element binding protein |
| | | | | 2; GMEB2 |
| 1240 | 104697 | 100 | AAGAGAGTGACCAAGAAGGCTCAGTGAAGGTCCCGCAGGGATGAGGCTGCCAGCCCCTTC | dolichyl-phosphate mannosyltransferase polypeptide |
| | | | | 2, regulatory subunit; DPM2 |
| 1241 | 104772 | 100 | AAGAGGAATGTGTTGAATGTCGCGTTTGCTGTCCACTCGTCCTAGAAGTTTAGTGTTTTT | target of myb1-like 2 (chicken); TOM1L2 |
| 1242 | 105079 | 100 | AAGCAAATCCGGCCATGAAGACTGTCTACAAGTTCGCAAAAGATCATGCAAAAATGGGAA | DENN/MADD domain containing 1A; DENND1A |
| 1243 | 105463 | 100 | AAGCTCATTCTTAGAACTTACACATCTAGAACAGCTTCCACTTTGGCAGTGAGGTCGTAG | calcium binding protein 39; CAB39 |
| 1244 | 105497 | 100 | AAGCTGACCTTTCTGAGAAGTTGGTATGGTGTAACACTAAAGTAGGTGGTTCGTGTGTGT | Ras-related GTP binding A; RRAGA |
| 1245 | 105744 | 100 | AAGGAGCCCAGGAACTGAGGCGACTCGCCCCACTGCCATGTCCAAAAGCTTGAAAAAGAA | membrane associated guanylate kinase, WW and |
| | | | | PDZ domain containing 2; MAGI2 |
| 1246 | 106478 | 100 | AAGTGGAGGAGTAGCTCAAGAAGAAATGTTTCACTCTGCTCTGGTACTATGATCCCAATT | unassigned |
| 1247 | 107457 | 100 | AATGCAATTCTCAGAGAAGACAAAGACCCGCAAAAGATGTATGCCACCATCTATGAGCTG | lipocalin 2 (oncogene 24p3); LCN2 |
| 1248 | 107655 | 100 | AATGGCTTTGGCCACAGCCGTCTTGTGAAGGAAAACCTGATTGACTACTTCATCCCCTTC | torsin family 3, member A; TOR3A |
| 1249 | 108775 | 100 | ACAATGCCAGCCCGCTGCTTTTTCTATCCTCCCAGTCACCTTTGCAGACAAAGACCAGGG | phospholysine phosphohistidine inorganic |
| | | | | pyrophosphate phosphatase; unassigned |
| 1250 | 108944 | 100 | ACACAGTGCGAGAGGGCATCTTGGATACAGCTCAGACCATCTGTGACGTGGCATCGCGGG | hypothetical protein LOC23130; unassigned |
| 1251 | 108974 | 100 | ACACATTCCAGCAAATGTATTTGCAATTATGTGGTTGATGCTTTGTGATATAAATGTACT | far upstream element (FUSE) binding protein |
| | | | | 1; FUBP1 |
| 1252 | 109712 | 100 | ACAGGATGGGTGCCCGACCAGCCCACCGCCCGTGAGAGCTCCAGGACTGAAGCCGCAGAG | unassigned |
| 1253 | 110009 | 100 | ACATACAGCAGCTCTATTGAATAACATGCATCTGAATTTTAAGTTGCAAAGGTATCTGAA | zinc finger, AN1-type domain 5; ZFAND5 |
| 1254 | 110634 | 100 | ACCAAGAGACAGAAACAGAAAAACATTAAACACAGTGGGAATATCACTTTTGATGAGATC | 60S RIBOSOMAL PROTEIN L12 |
| 1255 | 112366 | 100 | ACCTTCCTCCCTCACTGGACTTCAGTGTGGGACCTGCAGGTCTCAGGCCTTCTGGGAAGT | unassigned |
| 1256 | 113059 | 100 | ACGTGCTTACTACTGCAGTGCATTTGTCATTAGTCTTCATGTTAATACAGTACATTTATT | EH-domain containing 3; EHD3 |
| 1257 | 113121 | 100 | ACGTTGTCGCCAAGTCCCGGGACTTCTGGTACTTCGTATCTCAGTTAAAAAAGATGAAGA | 60S RIBOSOMAL PROTEIN L18A |
| 1258 | 113409 | 100 | ACTATTGGATGTTAGTTTGGAGTCCTGTGTGCTTCTCTCTCTTATGGCTGTGTCCCTGGT | UBIQUITIN 1, 2 |
| 1259 | 113729 | 100 | ACTCTAATTGAGATTTTGGCATCAAGAACTAACAAAGAAATCAGAGACATTAACAGGGTC | annexin A1; ANXA1 |
| 1260 | 115418 | 100 | AGAACTCAGGGTGGCCCTATGACTTGGAGGAGCAAGATCAGACCGCTCAAAGGTCCCCGT | leucine zipper, putative tumor suppressor 2; LZTS2 |
| 1261 | 115935 | 100 | AGAATTTTGCAGAGCTGAAGGTCAAGTGCCTGAGAAAGAAGTTTGCCCAAAAGATGCTTT | 60S RIBOSOMAL PROTEIN L7 |
| 1262 | 116147 | 100 | AGACCATCACTGACGAGTTTGAGCAGGGCACCTACATCTACTTTGACTACGAGAAGTGGG | CCR4-NOT transcription complex, subunit 3; CNOT3 |
| 1263 | 116214 | 100 | AGACCTCAAGTCTGCCTCTACTGTGTCTCACATCACCATGTAGAAGAATGGGCGTACAGT | NEL-like 2 (chicken); NELL2 |
| 1264 | 116682 | 100 | AGAGATTCCTCTGCGAATCTGTTTTTAGCTATCAAGTGGCATCCACGCTTAAACAGGTGA | chromosome 10 open reading frame 104; C10orf104 |
| 1265 | 116953 | 100 | AGAGGCCACAGAGAAAGAAAGGTACCTGGGTTCAACTAAGCTCCAGGCTGCTCCACCCAA | 60S RIBOSOMAL PROTEIN L21 |
| 1266 | 117219 | 100 | AGATACAAAACTTATTTCCATGTTTCTGAATCTTCTTTGTTTCAAATGGTGCTGCATGTT | N-myc (and STAT) interactor; NMI |
| 1267 | 117300 | 100 | AGATCACCGCCGCGAGTAAAAAGGCTCCAGCCCAGAAGGTTCCTGCCCAGAAAGCCACAG | ribosomal protein L14; RPL14 |
| 1268 | 117625 | 100 | AGATTCAATCCTGTAATGTGTGAAAACATACCTCTAGATGAAAGTCGAAATGAAAAGCTG | patatin-like phospholipase domain containing |
| | | | | 8; PNPLA8 |
| 1269 | 117790 | 100 | AGCAACACTTTGTGATCTCATGGCTTTGATTGATTTGGGCTGTTCAAAATGTTTATTTGA | chromosome 9 open reading frame 156; C9orf156 |
| 1270 | 119015 | 100 | AGCCTGGTGCCGGCTGACAGCTCACTGGAACTTTTCATCTGCTTGGCCAGGTGATGCCAA | unassigned |
| 1271 | 119132 | 100 | AGCGATTCCTTGCAATAATGTGGAAGTCCTCATGAGTGGCAATGTCAGGTGTTATAATAT | leucine-rich repeat kinase 2; LRRK2 |
| 1272 | 120117 | 100 | AGGAAGCAGAATGGCTATGATGGGCAAACTAAGCCGATTTTCCAGAAAAAGGCTAAAACT | 60S RIBOSOMAL PROTEIN L44 |
| 1273 | 120662 | 100 | AGGATCTCACATTTCACCCCAGGCTCAACTGAGGATGTGGCTTATTAAACACGGAAGTGC | T-cell leukemia translocation altered gene; TCTA |
| 1274 | 122309 | 100 | AGTACGTGCCCTATGGCCCCGTGATGGAGGTGCTGCCCTACTTGTCCCGCCGTGCCCTGG | proline dehydrogenase (oxidase) 1; PRODH |
| 1275 | 122327 | 100 | AGTACTTCTGCAGATCTAAGAGATTGCTGGCTATTAAAAGATGCAAGCATTTTGAACTGG | 60S RIBOSOMAL PROTEIN L44 |
| 1276 | 122554 | 100 | AGTCACCATCGCACAGGGTGGCGTCCTGCCCAACATCCAGGCCGTGCTGCTGCCAAAGAA | histone cluster 1, H2aj; HIST1H2AJ |
| 1277 | 124424 | 100 | ATACGAGTGGAATGAGGTGAAGAACGTCAAATCCATCGTGCCCATGATTCACGTGTCATG | jumonji domain containing 3; JMJD3 |
| 1278 | 124706 | 100 | ATAGTGGAGAGTAGGAAACTGTACTTTATCTCGGCATCCTCTTGAATGATAGTGCAAGTT | titin; TTN |
| 1279 | 124803 | 100 | ATATCAAGGGACAGCTCACAGACATACTGCAGAAGTCCTGTTGGCTGAGATAGGACGGCC | anaphase promoting complex subunit 1; ANAPC1 |
| 1280 | 125410 | 100 | ATCAGTAAGCAGGAATATGATGAGGCTGGTCCTCCTATCGTTCACAGAAAATGTTTCTGA | similar to RIKEN cDNA 4732495G21 gene; unassigned |
| 1281 | 125981 | 100 | ATCCTGCTGCTATTCCGCCTTCATTAACAGACTACTCAGTACCATTCCACCATACGCCAA | protein inhibitor of activated STAT, 2; PIAS2 |
| 1282 | 126008 | 100 | ATCCTTACAGACCATTTGAGGGCTTCCTCATCGACTTAAAGACCCGCTATCCCATATTGG | cyclin H; CCNH |
| 1283 | 126331 | 100 | ATCTCCAACAATCAAAGCTAGACGTAGCAGGAGTAGAAGCTATTCTCGCAGAATTAAAAT | chromosome 6 open reading frame 111; C6orf111 |
| 1284 | 127723 | 100 | ATGCTGCGGGCCATTAGAGATTTCTTCTGGAAAACTGGAAACAAGATAGGGTTTAAACCA | 2-deoxyribose-5-phosphate aldolase homolog (C. elegans); |
| | | | | DERA |
| 1285 | 130995 | 100 | CAAATAGTTCATCAAAATGAATCTTTGCTCTTTGGACTGAATTCTTACCATACTGCCATT | phosphorylase kinase, beta; PHKB |
| 1286 | 132033 | 100 | CAAGGATCTCTCTCACTAAAGGCATACAGACTGACTCCTAAACTGATGGAAGTTTGTAAA | eukaryotic translation initiation factor 3, subunit 3 |
| | | | | gamma, 40 kDa; EIF3S3 |
| 1287 | 132276 | 100 | CAAGTTCGTGTACAGCCAAAGAGAGCTATTTGAGCCTTGGAATAATCTGCCTAAATATTA | apolipoprotein B mRNA editing enzyme, catalytic |
| | | | | polypeptide-like 3G; APOBEC3G |
| 1288 | 132679 | 100 | CACAAATTTTATCAAAAATCAAAGCTATTCCTCAGCTCCAGGGCTAGCTGCGATCTGTGT | 60S RIBOSOMAL PROTEIN L6 |
| 1289 | 133906 | 100 | CACGGCAGCTCTCCGCCAATTTCTCTCAGATTTCCACAGAGACTGTTTGAATGTTTTCAA | transforming growth factor, beta-induced, |
| | | | | 68 kDa; TGFBI |
| 1290 | 134602 | 100 | CAGAACCTGAGCGACCTCTATCGTTGGCTTCAGGCCCAAAAAGACAAGATGTTTTCCCAG | leucine-rich alpha-2-glycoprotein 1; LRG1 |
| 1291 | 135140 | 100 | CAGATAACCCTTTGATTGCTTGATCTCTCGGTAAATATGGCATCATCTGCACGGAGGATC | 60S RIBOSOMAL PROTEIN L7 |
| 1292 | 135209 | 100 | CAGATGAACCTGTAGCAGAGTGGAACTTGTACTAACTTATGATAGAATGTATCAGAATAA | TRANSLOCASE OF OUTER MEMBRANE SUBUNIT |
| | | | | TOM7 |
| 1293 | 135492 | 100 | CAGCAGGTCCTGAGTGAAGCCGTGGGCCCTCCAAATGCTCGTTTTATAGCAACCTCTCTC | MAX-like protein X; MLX |
| 1294 | 135636 | 100 | CAGCCATAGTCAATCCCACGGTGTTCTTCAACATTGCCATCAATGGTGAGCCCTTGGGCT | similar to peptidylprolyl isomerase A isoform |
| | | | | 1; unassigned |
| 1295 | 135833 | 100 | CAGCGCAAGATTGATCAGAAAGCTGTGGACTCACAAATTTTACCAAAAATCAAAGCTATT | ribosomal protein L6; RPL6 |
| 1296 | 135977 | 100 | CAGCTCTCCTGAAAGCTTCTACCAGAAAAGCACCTGCTGCTAAAGTCCCAGCAAAAAAGA | 60S RIBOSOMAL PROTEIN L14 |
| 1297 | 136743 | 100 | CAGGTGCAACAGGTTCAGGTGTTTGCTGACGTCCAGTGTACAGTGAATCTGGTAGGCGGG | nuclear receptor coactivator 1; NCOA1 |
| 1298 | 136898 | 100 | CAGTATCAGGGATCTACTGTCTTTGTTCAAAGGTCAAATAAAAACCTAGTCTCCTTTTAT | hippocampus abundant transcript-like 1; HIATL1 |
| 1299 | 137330 | 100 | CAGTTGAGTGATAGAGTTAACCCCTTATCTGTAAGTTTTGAATTTACATTGTTTAATCCC | unassigned |
| 1300 | 137563 | 100 | CATAGAAGCCATGTCCAAGCTAAAGCCTTACTTTCTTACTGATGGAACGGGAACAGTCAC | acetyl-Coenzyme A acetyltransferase 2 (acetoacetyl |
| | | | | Coenzyme A thiolase); ACAT2 |
| 1301 | 138471 | 100 | CATGCTGGCCTACTTCATCACCTGGGTCTCCTTTGTGCCCCTCCTGGCCAATGTGCAGGT | taste receptor, type 1, member 3; TAS1R3 |
| 1302 | 138834 | 100 | CATTACTCGACAGATGTGGCACCGATCTTTAGCCAGAGAACTCTCTGGAACCATCAAAGA | 60S RIBOSOMAL PROTEIN L12 |
| 1303 | 138851 | 100 | CATTAGGAAGTGACTTAACAACATTAGGCCTCAATCTGAACTCTCCTGAAAATCTCTACC | CCR4-NOT transcription complex, subunit 2; CNOT2 |
| 1304 | 138962 | 100 | CATTCGTGTTCTGTGTATACCAAATGATTCTGTTATCTAAAGAAGCTTTTTGCTGGGAAA | bone marrow stromal cell antigen 1; BST1 |
| 1305 | 139305 | 100 | CCAAACCCTTGTCATTTCCCCCAGTGAGCTCTGATTTCTAGACTGCTTTGAAAATGCTGT | telomeric repeat binding factor 2, interacting |
| | | | | protein; TERF2IP |
| 1306 | 140620 | 100 | CCAGAGCACAGAAGACAAATGTATATTCAAGATAGACTGGACTCTGTCACCAGGAGAGCA | adhesion molecule, interacts with CXADR antigen |
| | | | | 1; AMICA1 |
| 1307 | 141286 | 100 | CCAGTCTGTGGGCTGCAATGTTGATGGCCGCCACCCTCATGACATCATAGATGACATCAA | 60S RIBOSOMAL PROTEIN L12 |
| 1308 | 141595 | 100 | CCATCTCTGTCTAGCAAGCAGCCTCCTAAGATAGCTGTTCTCCCTATCATGACGGTGTAG | triggering receptor expressed on myeloid cells-like |
| | | | | 2; TREML2 |
| 1309 | 141639 | 100 | CCATGACCACCTGCAGCCGCCAGTTCACCTCCTCCAGCTCCATGAAGGGCTCCTGCGGCA | keratin 14 (epidermolysis bullosa simplex, Dowling- |
| | | | | Meara, Koebner); KRT14 |
| 1310 | 142046 | 100 | CCCAAGCCCTCCCCTCACTGGAATTCTTCTTGCTCTGTGAGCTAGCCTCATCTTCAGTTG | unassigned |
| 1311 | 142242 | 100 | CCCACTCCGTCTACAGCCTCCTGTCTGTGTTTAGCCAGCGCTTTTACTGCGGTTCCTCCT | G protein-coupled receptor 45; GPR45 |
| 1312 | 142562 | 100 | CCCATCCCACTCCCTGTTTCGGGCCTCGTCTGCTGGGAAAGTCACTTTTCCAGTATGTCT | tripartite motif-containing 31; TRIM31 |
| 1313 | 143113 | 100 | CCCCTCAATAAGTATTTGCAGCAGAACAGACATGTCAAGGATAAGAACATCATAGAACTG | spleen tyrosine kinase; SYK |
| 1314 | 143169 | 100 | CCCCTGCATTTGTCCTGGGAAACACGGTATTTAAGAGAGAACTATATTGGTATTAAAGCT | mitogen-activated protein kinase kinase kinase kinase |
| | | | | 2; MAP4K2 |
| 1315 | 143546 | 100 | CCCTACGCGCCTTGTCTCCTACTCCTGACTCCTACCTGCCCTGGAACATCCTTTGCAGGG | chromogranin A (parathyroid secretory protein |
| | | | | 1); CHGA |
| 1316 | 143873 | 100 | CCCTGCCGCCGCCGAGTCGCGCGGAGGCGGAGGCTTGGGTGCGTTCAAGATTCAGCTTCA | mitochondrial ribosomal protein L50; MRPL50 |
| 1317 | 144379 | 100 | CCGCACTTCAGAGTTGAGTCATTTTCTGAGGATGAATGGAATTTACTGTATGTTGCAGTA | F-box protein, helicase, 18; FBXO18 |
| 1318 | 145493 | 100 | CCTCAGCTTTTGCACACCTCCAATATATTGTCCACTGAAGTCAGAATAATCTAAAAATAA | unassigned |
| 1319 | 146599 | 100 | CCTGGCCAACATCCGCTCACCTGTCTTCAACCATTCCCTGTACCGCACATTCGTTCCAGC | PC2 (positive cofactor 2, multiprotein complex) |
| | | | | glutamine/Q-rich-associated protein; PCQAP |
| 1320 | 146990 | 100 | CCTTACACGTACCTCTCATCAGTGTCCTCTTGCTCAAAAATCTGTTTGATCCCTGTTACC | solute carrier family 2 (facilitated glucose transporter), |
| | | | | member 1; SLC2A1 |
| 1321 | 147295 | 100 | CCTTGAATGAGCTATATTCAGGGTATCCGGTATTTTGTAATAGGGAATAGGAAACCTTGT | sulfatase modifying factor 1; SUMF1 |
| 1322 | 147612 | 100 | CCTTTTCAGGATTTAGGCCTGTAAGAAACTATGCCTGATTCTGTAAAATAAGTGTAAAGA | exocyst complex component 6; EXOC6 |
| 1323 | 148241 | 100 | CGATATGACCTGCCAGCATCATACAAGTTTCACAAAAAGAAATCAGTCTGATCATCTAAA | methyltransferase like 5; METTL5 |
| 1324 | 148692 | 100 | CGCCGAAGGCGACCGGTCGTCCACACCGAGCGACATCAACTCCCCTCGACACCGGACACA | kazrin; unassigned |
| 1325 | 149705 | 100 | CGGGACATTGGCGTTCCCATGACCAGTGTGCGGCTGCCCTGCTATTTTGAGAACCTCCTC | NmrA-like family domain containing 1; NMRAL1 |
| 1326 | 150701 | 100 | CTAAAGCCCAGATGCCCACCATAGAACGAGCAACCTTGACAAGAGATTTCTACCTCTTTC | caspase 5, apoptosis-related cysteine |
| | | | | peptidase; CASP5 |
| 1327 | 150896 | 100 | CTAATGTCTGTTAGCTACCCATAAGAATGCTGTTTGCTGCAGTTCTGTGTCCTGTGCTTG | TAR DNA binding protein; TARDBP |
| 1328 | 151002 | 100 | CTACAGCGGCTTCGAGGTGCTCTTTGCCTGCACTGGTATCGCCTTGGGCTATGGCGTGTG | unc-93 homolog B1 (C. elegans); UNC93B1 |
| 1329 | 151695 | 100 | CTATGGGCGTGAACGGAATGGGAGGGTTGTCTAGCATGTCCAGTATGAGTGGTGGATGGG | heterogeneous nuclear ribonucleoprotein H1 |
| | | | | (H); HNRPH1 |
| 1330 | 151778 | 100 | CTATTTTCAACATAACTGAAGGCATATGCTGGCCCATAAACACCCTGTAGGTTCTTGATA | transporter 1, ATP-binding cassette, sub-family B |
| | | | | (MDR/TAP); TAP1 |
| 1331 | 151867 | 100 | CTCAAGGCAGCTAAGCGAGAGCTTCAAGAGCAAAGAGTTTGTGTCTAGTGATGAGAGCTC | structure specific recognition protein 1; SSRP1 |
| 1332 | 152539 | 100 | CTCCATCACCTTTGGGCTTGTTTTCTACTTTGCCACAGATTATCTTGTACAGCCTTTTAT | presenilin 1 (Alzheimer disease 3); PSEN1 |
| 1333 | 153516 | 100 | CTCTGAGATGAGACTGTACAAGAATATTCCACAGATGTCCTTTGATGATACAGAAAGGGA | chromosome 1 open reading frame 128; C1orf128 |
| 1334 | 155096 | 100 | CTGCGCTCCGCCGTCGGCTCGGGCTGAAAAAGTTTCTCCATGGTTCCTTTGTGTCGCCCG | unassigned |
| 1335 | 155386 | 100 | CTGCTTTACTAAAATGCAGTAGAGGTACTCTTCTGTCCCTTCCGTTTATAGTTCTCTGAG | unassigned |
| 1336 | 156493 | 100 | CTGTCGGAAGACCGTCAACGGCCACCTGGACTCCTATGAGAAAGTCACCCAGCTGCCGGG | suppressor of cytokine signaling 3; SOCS3 |
| 1337 | 156497 | 100 | CTGTCGGTCTCAGTACGTTCACTTTATAGCTGCTGGCAATATCGAAGGTTCCTTTTTTGT | ralA binding protein 1; RALBP1 |
| 1338 | 157702 | 100 | CTTCTACGGTTTCTTTGTCTGCGGAATCAGGGAAGAGTGAAAAGGGTCAGCCACAGAATT | NADH dehydrogenase (ubiquinone) flavoprotein 3, |
| | | | | 10 kDa; NDUFV3 |
| 1339 | 158453 | 100 | CTTTAGTGAGTACCCCTTTAGTGCTATATTTGTGCCATTCATTATCTGGTTCATATTTCT | solute carrier family 35 (CMP-sialic acid transporter), |
| | | | | member A1; SLC35A1 |
| 1340 | 158787 | 100 | CTTTGTAACCATGTATTTACTCTGCCAGGTGCCTATATTCCAATAAAATGTTCATCCTTG | family with sequence similarity 129, member |
| | | | | A; FAM129A |
| 1341 | 158846 | 100 | CTTTTAGTGACCACGGGCTACATCATATGCTTTGTTCCTTACCACATTGTCCGAATCCCG | G protein-coupled receptor 171; GPR171 |
| 1342 | 160035 | 100 | GAACGGATTACAATTCTGCTCCCCAAGAGGCCCCCTAAGACCACAGAAGATAAGGAGGAA | polymerase (RNA) III (DNA directed) polypeptide G |
| | | | | (32 kD)-like; POLR3GL |
| 1343 | 160844 | 100 | GAAGGCTCTCCATCGAAGGCAACATTGCTGTGGGAAAGTCCACGTTTGTGAAGTTACTCA | deoxyguanosine kinase; DGUOK |
| 1344 | 161046 | 100 | GAAGTGTGTGGCTGGGCGGATTCAGCGAAGTCTCATGGGAAGCAGGACCTAGAGCCGGGC | wingless-type MMTV integration site family, member |
| | | | | 3; WNT3 |
| 1345 | 161271 | 100 | GAATGAAACCTATAGCCTTTGTGCTGTTCTGCCTTGCCTGTGAGCTATGTCACTCCCCTC | hexosaminidase A (alpha polypeptide); HEXA |
| 1346 | 162222 | 100 | GACCAGCGGCCCACCAAGAGCTGGCTCAAGAAGTTTCTGGGCTTCGTTGTGGACCCCAAC | peroxisomal proliferator-activated receptor A |
| | | | | interacting complex 285; unassigned |
| 1347 | 162617 | 100 | GACCTTAATTCTCTTTCCCATCTTGCAAGATGGCGGGTGAAAAAGTTGAGAAGCCAGATA | ribosomal protein L6; RPL6 |
| 1348 | 163152 | 100 | GACTGTGGACTTCATGATTGTTGTACTTCTGGGTCAAAACTCAAATGAGGTGAATTTTGC | unassigned |
| 1349 | 164007 | 100 | GAGATTGCTGGCTATTAAAAGATGCAAGCATTTTGAACTGGGAGGAGATAAGAAGAGAAA | 60S RIBOSOMAL PROTEIN L44 |
| 1350 | 164041 | 100 | GAGCAACCTGCGAGACTCACAAGATGGGAAGCTGACAGAGATACCTACAGACAGAGTGCT | ribosomal protein S10; RPS10 |
| 1351 | 164302 | 100 | GAGCCGCTCATAGACCCCGCCTGCCGTCCGGTCAATAAAATCCGCCTGACTCCTGCGCCC | neuropeptide W; NPW |
| 1352 | 164721 | 100 | GAGGACGTGAGCCAGTTTGATACCCGCTTCACACGGCAGACGCCGGTGGACAGTCCTGAT | ribosomal protein S6 kinase, 70 kDa, polypeptide |
| | | | | 2; RPS6KB2 |
| 1353 | 165071 | 100 | GAGGGCCTGATCTGCATCTGCAGCATGAGGTTCTGCCCGTTTGCTGAGAGGACGCATCTG | GLUTATHIONE-S-TRANSFERASE OMEGA |
| 1354 | 165502 | 100 | GAGTGTGCTCCCCCGTCATGCAACATCTGGACACAACTAACAGAGCATGGTGAATACATG | transmembrane and coiled-coil domains 4; TMCO4 |
| 1355 | 166068 | 100 | GATCCTAGGTTCTTCCTGACTGCTTTCTCCAACTGTTCACAGCAAATGCTTGGATTTTAT | transmembrane 9 superfamily member 3; TM9SF3 |
| 1356 | 166975 | 100 | GATTGACCTGGCCAAGCTGAAGAAGTTTATTGCCTACTGCCGAGTGAAGTGTGGCCCCCG | MCM5 minichromosome maintenance deficient 5, cell |
| | | | | division cycle 46 (S. cerevisiae); MCM5 |
| 1357 | 167003 | 100 | GATTGCTCCTGTGTAAAGATGCCTTGTCGTGCAGAAACAAATGGCTGTCCAGTTTATTAA | splicing factor, arginine/serine-rich 2; SFRS2 |
| 1358 | 167575 | 100 | GCAAGTCCCAACTTTGAATAAAACAGATGATGTCCTGTGACTGCCCCACAGAGATAAGGG | ABI gene family, member 3; ABI3 |
| 1359 | 167868 | 100 | GCACCAGTGACATTTAAAGGCTTCCGCGAGTGAATGAGTGCTTCTTAATCCTAAAAACAC | MAD2L1 binding protein; MAD2L1BP |
| 1360 | 168086 | 100 | GCACTGGAATAGGAAATGTCCCCCATCTCCCTTCCTGCACCCTGCTGTGCTCCCTCCAAA | TBC1 domain family, member 10B; TBC1D10B |
| 1361 | 168498 | 100 | GCAGCCCTGGTTCAGGCCCGGAGGAGGGTTTGCGGGTAGTTGCACGGACAATTCGGCGGG | death-associated protein kinase 3; DAPK3 |
| 1362 | 169781 | 100 | GCCACTGCCTCCCCCGAATGCATTTGGAACCAAAGTCTAAACTGAGCTCGCAGCCCCCGC | nuclear receptor co-repressor 2; NCOR2 |
| 1363 | 170047 | 100 | GCCATCCTACGCCGTAGCCGTCCAGAGACTGGCAGGCCTCGGCCTAAAGGTCTGGAGGGT | 40S RIBOSOMAL PROTEIN S10 |
| 1364 | 170102 | 100 | GCCATGCTCTTCAGGAGGAGACTCCAAGGGCAAAGGAGGGTGTCTTGGCTGTGCTTGAAG | phosphomevalonate kinase; PMVK |
| 1365 | 170472 | 100 | GCCCGCCCGAGCTGCTCGACGTGATGAAGCCCCAGGAGTCGGGAAGCAGTGCCAATGAAC | ELONGIN B |
| 1366 | 171075 | 100 | GCCTCAAGAGGTGGTGGAAGAGTTGAAGAAGTACCTGTCGTAGGGAGATTTGGGTAGAAG | chromosome 11 open reading frame 31; C11orf31 |
| 1367 | 171160 | 100 | GCCTCCCTGTTTGAAGCCTGCCCTTGTCTGAGATGCTGGTAATGGCCATGGTACCCCCTT | guanine nucleotide binding protein (G protein), alpha |
| | | | | inhibiting activity polypeptide 2; GNAI2 |
| 1368 | 171339 | 100 | GCCTGCCCACTGCAACGGAGCCGCCAGCACCTCCTCCCCTCCAGATCCGGGCCCCAGGCT | ataxin 7-like 2; ATXN7L2 |
| 1369 | 171710 | 100 | GCGAACTGGGTTGCTTCCCTGAGGGCCCCCGCTGGCCAAGGCCTGTGGACGACGCTTGCG | ADP-ribosylation-like factor 6 interacting protein |
| | | | | 4; ARL6IP4 |
| 1370 | 174250 | 100 | GCTTATAAGTTAAAGGGCATCACAGTGAGGGTGTAGTAGATAAATTCAAGGAAATAAGAG | ORM1-like 1 (S. cerevisiae); ORMDL1 |
| 1371 | 175122 | 100 | GGAAGAAGGAGAGGAATACTAATTATCCATTCCTTTTGGCCCTGCAGCATGTCATGCTCC | alpha tubulin; unassigned |
| 1372 | 175282 | 100 | GGAAGCTTTGTGAAGCTCAACAAGGCTTCCACTAACATGCTGAGGATTGTAGAACCATAT | 60S RIBOSOMAL PROTEIN L7 |
| 1373 | 175938 | 100 | GGACGTGATAGCTCTGCCTATTGCAGGACAATGATGGCTATTCTAAACGCTAAGGAAAAA | ubiquitin-conjugating enzyme E2Q (putative) |
| | | | | 1; UBE2Q1 |
| 1374 | 175969 | 100 | GGACTATGCGGAGGCCCTGATCAACCCCATTAAGCACGTCAGCCTGATGGACCAGAGGGC | phospholipase C, beta 3 (phosphatidylinositol- |
| | | | | specific); PLCB3 |
| 1375 | 178191 | 100 | GGCCACCAGCTGTTTCCCACGCCCCATGACTCCCCGAGACCGACATGAAGGGCGCAAACA | nuclear mitotic apparatus protein 1; NUMA1 |
| 1376 | 178227 | 100 | GGCCAGAAGGCAGCGCCTGCTCCAAAAGTTCAGAGGACTCAAAAACTCCAGCTCCTAAAA | 60S RIBOSOMAL PROTEIN L14 |
| 1377 | 179141 | 100 | GGCTCATTTGCTCTCTCCACTACTCATCTCTGGAATTAGCCGCTTAAATACAGGTTTTTG | skeletal muscle and kidney enriched inositol |
| | | | | phosphatase; unassigned |
| 1378 | 179146 | 100 | GGCTCCAAGGAGACAGCAACTCAGCCCTTGCCTCTGTATGACACACCCTATGAGCCAGAG | Src homology 2 domain containing F; SHF |
| 1379 | 179752 | 100 | GGGAAGAAGGGACAACAGCGGACTGTCTAAAGGATGCCTGGATTCCTTGTTTCTCAGGAC | HISTONE H2A |
| 1380 | 179857 | 100 | GGGACAAAATGAGAAGTCATCACTCTTTTTGGATCATTTAGATCTCTTGCATCCTTTGTT | similar to HESB like domain containing 2; unassigned |
| 1381 | 180577 | 100 | GGGCCCTCTCCATTGTGGCCGATGACTGAATCCCCGTCACTCTTGGAGGACTCCTGTGAC | bridging integrator 3; BIN3 |
| 1382 | 181086 | 100 | GGGTGAGAAGAATAACCACAATTGTATGTGCCTGTTTTTTACTCTTAGCATTAGATGAAT | histidine ammonia-lyase; HAL |
| 1383 | 181922 | 100 | GGTCTTGTAATTACAGGAGCCATTTCTGTAGGTAACTGGACCAAGAATGAGAAAAATAAT | sorting nexin 15; SNX15 |
| 1384 | 181993 | 100 | GGTGACAGAAGACACAGATGAAGATGCTCCCCTTGTGCCAGATGATACCTCAGACTCTGG | pleckstrin homology domain containing, family G (with |
| | | | | RhoGef domain) member 6; PLEKHG6 |
| 1385 | 182070 | 100 | GGTGATCTGCTTTTATCTAAATGCAAATAAGGATGTGTTCTCTGAGACCCATGATCAGGG | signal transducer and activator of transcription 3 |
| | | | | (acute-phase response factor); STAT3 |
| 1386 | 182204 | 100 | GGTGCTGGTGGCCTTTCCCCGGTGGATTGGTCTCTGGCCCAGCCCAGTCTCTTCTCAGGG | ADP-ribosylation-like factor 6 interacting protein |
| | | | | 4; ARL6IP4 |
| 1387 | 182573 | 100 | GGTTCAGATCGATGGCCTTGTCCATGTTGTCCTTTCTGGCTTCCCTGATGGTGTCATGTT | cyclin M3; CNNM3 |
| 1388 | 182667 | 100 | GGTTGAAGTCTGTGGATGCAACTGTTAATGAAGATGGTTAAACTTGAAATAAACAATTTT | unassigned |
| 1389 | 183167 | 100 | GTACCACAAGAAGATCTTCCGGACTGCCATGCTGTTCCAGTTTGTGAACGTGCTGCTCCA | exportin 6; XPO6 |
| 1390 | 184157 | 100 | GTCATCTTGCTTACCTACGTGCTGGCCGCCACAGAACTTACCTGCCTCTTCATGCAGTTC | solute carrier family 22 (organic cation transporter), |
| | | | | member 18; SLC22A18 |
| 1391 | 184933 | 100 | GTCTGAAACCCCTGGTAGCCCCGACTTCTTTTTAATTAAAATAAGGTAAGCCCTTCAATT | CD99 molecule; CD99 |
| 1392 | 185593 | 100 | GTGATCCCTCGGGATGACCCCCTCGTGCTCTATGTCTATGCTGCCCCTCAGGACATGAGG | FYVE, RhoGEF and PH domain containing 2; FGD2 |
| 1393 | 186362 | 100 | GTGGCAAGGCCTTTAAGCGCTCCTCTATCCTTACTACACATAAGAGAATTCATACTGGAG | zinc finger protein 66; ZNF66 |
| 1394 | 186433 | 100 | GTGGCCCTGGGATACCGGAAAGTGCAACAGGTGATCGAGAACCACATCCTCAAGCTCTTC | regulatory factor X-associated ankyrin-containing |
| | | | | protein; RFXANK |
| 1395 | 187278 | 100 | GTTAAATACCACATTATTTGAAAGCTGGGAGATCGTTGGACCTTACCCTTCCTGGTGGGT | LAG1 homolog, ceramide synthase 6 (S. cerevisiae); |
| | | | | LASS6 |
| 1396 | 187446 | 100 | GTTATAGAAATCAGCATACTATTTTTTTAAATCTGGAGAGAAGATATTCTGGTGACTGAA | ralA binding protein 1; RALBP1 |
| 1397 | 187590 | 100 | GTTCAGGGCCAGGGCCTCCTTGGAATAAATGGTTATTGTTACTAGGTCCCCACCTTCCCT | SH3KBP1 binding protein 1; SHKBP1 |
| 1398 | 187824 | 100 | GTTCTCCTTGGGTGACCCCCATGATGCCTGACCGCTCCTCGTGCCTCCTGGAACAGCCAG | unassigned |
| 1399 | 188270 | 100 | GTTTACTTTGAAAAAGTGAAAAAGGCTTCCGGGCTGTCCTCTGCCCAGTGAGATGGAGGA | inositol 1,3,4-triphosphate 5/6 kinase; ITPK1 |
| 1400 | 189707 | 100 | TACAAAGAAGACAGTGCTAAGGCTTGAGCGCGTTGAGCCCAACTGCATATCTAAGAGAAT | unassigned |
| 1401 | 190174 | 100 | TACCATGGGACCAGCTCTGGCCAGAGGGAACTAAGCAAATCCAATAGAGATGTTTCTGGG | MFNG O-fucosylpeptide 3-beta-N- |
| | | | | acetylglucosaminyltransferase; MFNG |
| 1402 | 190338 | 100 | TACCTGATGTATGCCAAGTTCCTTTGTTCAGTATTCCGTGGGTGAACGGGTGGAGGAAGG | TUBULIN ALPHA-1 CHAIN |
| 1403 | 190885 | 100 | TAGAAGATGAGGAAGATATAACACTTACAAGATGGACAGGGATGATAATTGGGCCTACAA | UBIQUITIN-CONJUGATING ENZYME |
| 1404 | 190921 | 100 | TAGAATTGAGAATCTGGAACTAATGTCACAGCATGGATGTAATGCCTGGAAAGTATACAA | DENN/MADD domain containing 2C; DENND2C |
| 1405 | 191530 | 100 | TAGTAGTAGTACTGAGAAAAATCCCTTCAGCTCTAAGAACACTGAAAAATCCACCGATTT | v-ral simian leukemia viral oncogene homolog B (ras |
| | | | | related; GTP binding protein); RALB |
| 1406 | 192006 | 100 | TATCATCTCAGTGAACCTACTGGTGGACTCCCAATTGACAAGATTGAGCAATAGAAAAAA | ralA binding protein 1; RALBP1 |
| 1407 | 192464 | 100 | TATGGTGGGCAAACCAAGCTGATTTTCCAGAAAAAGGCTAAAGCTACAAAGAAGATTGTC | 60S RIBOSOMAL PROTEIN L44 |
| 1408 | 192905 | 100 | TCAAAAGGCTATGTCTGCTCTTCAGTAATGACATGAAATCTTTGTTCATCTCCACTTTGT | component of oligomeric golgi complex 5; COG5 |
| 1409 | 193007 | 100 | TCAAATCACTATCTGAAGGGTCACGGAGCGCAAAATAAAGTTTAAAACCCTGCTACCACA | mitochondrial ribosomal protein L53; MRPL53 |
| 1410 | 193821 | 100 | TCACTGAATACAGCACAGACAAGGACGAGCCTCCAAAGGACGTCTTTGATGAATTATTTA | parvin, gamma; PARVG |
| 1411 | 194223 | 100 | TCAGCCTGTCCAATAATGGAGCCCTGTCCTTCTACACAAGGCAGCCTAAACTACCCACCA | unassigned |
| 1412 | 194416 | 100 | TCAGGGACGTCAATGTGTCTGCCTAGCCCTGTTGGCGGGCTGACCCTCGACCTCCCAGAC | arginyl aminopeptidase (aminopeptidase B)-like |
| | | | | 1; RNPEPL1 |
| 1413 | 195881 | 100 | TCCCACTGTCTCCCCCAGATATGTCCTTCCCAGCATCTTTGGCTGCACAGCATTTCCTTC | coiled-coil domain containing 67; CCDC67 |
| 1414 | 196014 | 100 | TCCCCATCCTGCATCTGGACGGTATTGTGGAGGACTCCTCCAACATCCTGGGCTTCTCCA | glutamate receptor, ionotropic, kainate 5; GRIK5 |
| 1415 | 196577 | 100 | TCCTAGCAGATGATACAGCAGTGGGCTACATACAATGAGAGCCCTGAGCCCTCAAGAACT | complement component 8, beta polypeptide; C8B |
| 1416 | 197007 | 100 | TCCTGTAGTGCTGTCTCTGCTTTTTGCATCTTGCCCAGTATATTATGACACAAATAAAAA | unassigned |
| 1417 | 197251 | 100 | TCGAAGCAGTCAACCTCCCGGTCGACCATATCTCCTTGATCCTGGCTGTGGACTGGCTAG | solute carrier family 1 (neutral amino acid transporter), |
| | | | | member 5; SLC1A5 |
| 1418 | 197267 | 100 | TCGACAAATACCACCCAGGCTACTTTGGGAAAGTTGGTATGAAGCATTACCACTTAAAGA | ribosomal protein L27a; RPL27A |
| 1419 | 197857 | 100 | TCTAACAGACAAAATTGATGTACTTCTGCAACAGATTGAAGAATTAGGGTCTGAAGGAAA | cisplatin resistance-associated overexpressed |
| | | | | protein; unassigned |
| 1420 | 199121 | 100 | TCTGCTGCTGCGGAAGGGACCCCTCGGAGGAGCATTCGCTGCTGGTGAATTGATTCGACC | mucolipin 1; MCOLN1 |
| 1421 | 199912 | 100 | TCTTGCTTGACCGTTTGGGACATCAATCTTCCACATGAAGTGCAAAATTTAGAAAAACAC | leucine-rich repeat kinase 2; LRRK2 |
| 1422 | 200120 | 100 | TCTTTGGTGCTGCAGCGGCACACAACTGGCAAGGCTTAATCAAAAGACTGGAAAACTGCA | acyl-Coenzyme A binding domain containing 6; ACBD6 |
| 1423 | 200176 | 100 | TGAAAAAACTACTAGGATCACGCGGCATGTATTGAGCATATAGGTTGCTGTAGATGAATG | HBII-276HG |
| 1424 | 200572 | 100 | TGAACTTTCAGCCAAGAAGGTAGTGTGAAAATATTACTGTGAGGTTTTAAAAGTACACAA | unassigned |
| 1425 | 201125 | 100 | TGACAGGAACTTCCGCACCTCCTGAGGCCCTGGATGATTCTAATTGTTAGAAATTCTAAT | replication initiator 1; REPIN1 |
| 1426 | 201335 | 100 | TGACGCAGTATAAGAAGGGCAAGGATTCCTTGTATGCCCAGGGAAAGAGGCGCTATGATC | LOC554234 |
| 1427 | 201923 | 100 | TGAGGGACATGGCAAGTTCCTGGCCACTGCCCAGAACCCTGCTGATGAGCCCACTCTAGG | GOLGI AUTOANTIGEN, GOLGIN SUBFAMILY A |
| | | | | MEMBER 2 |
| 1428 | 202166 | 100 | TGATATCAGCCATCGTCAACCCCGCCGTGTTCTTCGACATCGCCGTGGATGGCGGGCCCT | unassigned |
| 1429 | 202737 | 100 | TGCAAGCCGCCGGCACCCGCCTGCTGCGACCCGTGCGCCTCCTGCCAGTGCCGCTTCTTC | agouti signaling protein, nonagouti homolog |
| | | | | (mouse); ASIP |
| 1430 | 203664 | 100 | TGCCCTTGAGTCCCCTGTGCCCTAGCAACCGGAGGAATGGAAAGGACCTCATCAGGGTGG | hypothetical protein LOC146909; unassigned |
| 1431 | 203712 | 100 | TGCCGTCAACATGCCTTTCATGGACTTCCTGACTGAGGATGGCTTCGAGAAGGGCCCAGA | thiosulfate sulfurtransferase (rhodanese); TST |
| 1432 | 205151 | 100 | TGGACAAGAAGGAGCCTGAAGTCTTGCGGGACTCACTGGATAGATGTTATTCAACTCCTT | UNCHARACTERIZED |
| 1433 | 205981 | 100 | TGGCATGGCTGCCTTGATGTAACATAATTCTCTGTCCCCAAGATTTAGAAAATTCCTCTT | phosphorylase kinase, alpha 2 (liver); PHKA2 |
| 1434 | 206400 | 100 | TGGCTGGGCAACCTACGTCGCCTTTGGACCTCATGCTGGAAAATTCATTGTGATCATAGA | 60S RIBOSOMAL PROTEIN L14 |
| 1435 | 206536 | 100 | TGGGAATCACGAATTTTCCTATTCCTGGAGAGCCTCATTTTCCACTTAACGCAATTATGC | ARP2/3 COMPLEX 21 KD SUBUNIT |
| 1436 | 206815 | 100 | TGGGCTCTAGGAGACCCCAAATTTGACACCACAGAAAGCAAATAAAACACTTGAAATACG | MGC10812 |
| 1437 | 206925 | 100 | TGGGTGCCACTGCCTGCTTGAAAGCACTTTCTGAACCTACAGAAGTTGGGTATTGTCTGA | WD repeat domain 59; WDR59 |
| 1438 | 207178 | 100 | TGGTCTGATGCTCCTTCAAAAACATTCACTTTTTACAACGTCAAGGAATTAAGCATAAAA | chromosome X and Y open reading frame 3; CXYorf3 |
| 1439 | 207943 | 100 | TGTATGTCTACTGGTGGGAGACTGTGAGGATCCCAGGATTCAGTATTCCTGGCCCAGAGG | neural precursor cell expressed, developmentally |
| | | | | down-regulated 8; NEDD8 |
| 1440 | 208243 | 100 | TGTCCCTGTTTTATAAACATAATCACAACAGTAATAAACCTCAAGTAGTGGCTAGTGTTT | Ion peptidase 2, peroxisomal; LONP2 |
| 1441 | 208270 | 100 | TGTCCTACGAGCAGCTGGAGCAGCCGATGCAGCTGTACAGTGCGCGCCAGCGGCGGCGGC | similar to 40S ribosomal protein S15 (RIG |
| | | | | protein); unassigned |
| 1442 | 208343 | 100 | TGTCGGACTATGTAATTGTAACTATACCTCTGGTTCCCATTAAAAGTGACCATTTTAGTT | fusion (involved in t(12; 16) in malignant |
| | | | | liposarcoma); FUS |
| 1443 | 208774 | 100 | TGTGCCAGAAACCCTTAAGAAAAAGCAAAGGAATTTCACAGAGCTGAAGATCAAGCTCCT | unassigned |
| 1444 | 210798 | 100 | TTATCAGAATTCCGAGAAGGAGTGCGGAAGATTGCCCGAGAGCAAAAAGTCCCTGAGATT | cysteinyl-tRNA synthetase; CARS |
| 1445 | 211100 | 100 | TTCAACACTGCCAATGATGATAACGTTACTCAGGTGCGGGCATTCTATGTGAACGTGCTG | catalase; CAT |
| 1446 | 211120 | 100 | TTCAACTCTGGCCCTCACAATCCAGTGGAGGAGACGAAACTCATCTGCCTCTGTCCCTCT | hypothetical gene supported by AK024248; |
| | | | | AL137733; unassigned |
| 1447 | 211169 | 100 | TTCAAGGGATAGAAAGTCACAGTAAGGATGGCAATGCCAGTGGAACCAAGCTGCTTGAGG | ELONGATION FACTOR 1-ALPHA |
| 1448 | 211400 | 100 | TTCAGCCAAGTTCAGGGAGGTCTGAATACTGAGGCCTTCATAGCCACTGCACCCCAGGTA | unassigned |
| 1449 | 211521 | 100 | TTCAGTGTTGATCCTTTATTCTTTCTATCTGTCAGGTGCACAAGATTACCCTCCTTTTTT | 14/03/2003 |
| 1450 | 212389 | 100 | TTCGCTTTATTTTTGTAAGTATCACCTGCCACCATGTTTTGTAATTTGAGGTCTTGATTT | membrane-bound transcription factor peptidase, site |
| | | | | 1; MBTPS1 |
| 1451 | 213145 | 100 | TTGAAAGTTATGTTTTAGGGTCCTCTGAAAAGCAAATTGTGTCAGAAGATAAAGAGCTTT | chromosome 21 open reading frame 45; C21orf45 |
| 1452 | 214080 | 100 | TTGGACCTAGTTGGTGATTATACTCTGTCTCCCATGGAGACCACGTCTTGCATCCTTCCT | hypothetical gene supported by |
| | | | | AY007155; unassigned |
| 1453 | 214739 | 100 | TTGTGACCATTAGCATTTGTCAACAAAGTCACCCACTTCCCACTATTGCTTGCACAAACC | chemokine (C-C motif) receptor 1; CCR1 |
| 1454 | 215225 | 100 | TTTAGCGTCTTTGAAGGAGACCAGACATGAGTGAATACCTAGGAGAGTGTCAGCATGTTT | KIAA0317; KIAA0317 |
| 1455 | 215483 | 100 | TTTCAGGACCCTAGAGGAGAGCTTTATACAATTACCGATGTGAATTTCTCTAAAGTGTAT | hippocampus abundant transcript 1; HIAT1 |
| 1456 | 215616 | 100 | TTTCCGGAGCACTTGCAGAGGACTTGCTATTTGCCAGGTGCTTTATGTATCATTAAATTT | isopentenyl-diphosphate delta isomerase 1; IDI1 |
| 1457 | 215770 | 100 | TTTCTCCATCCAATTCTTTGAATTTCCCAGTCTCCCCTATGTAAAACTTAGCAACTTGGG | major histocompatibility complex, class II, DM |
| | | | | beta; HLA-DMB |
| 1458 | 215830 | 100 | TTTCTGCTGTTTGATCTCTAAGGAACTCCTGTTGCTAAATATGAAGAGTATGGAACATTC | transmembrane protein 30A; TMEM30A |
| 1459 | 216357 | 100 | TTTGGGAGAAATGGATCTGACTGCCCGGACAAGTTTTGCTTATTCCAGTCTGAAACCAAA | lactotransferrin; LTF |
| 1460 | 216775 | 100 | TTTTCCCAGGTACTGCCTTACAAAGCTGTGGCCAGGAAGTGGCCGGTATAAAGGATGCCC | tumor necrosis factor, alpha-induced protein |
| | | | | 2; TNFAIP2 |
| 1461 | 217447 | 100 | AACCAAGTAGCTGCAGCTCTCTACCAAGCCCTCCACCGGACCCTGTGGGCGGCGGCTGTG | unassigned |
| 1462 | 217900 | 100 | AATTTGAGCCTCTGCTGAATTGGATGAAAGATAAAGCCCTTAAGGACAAGATTGAAAAGG | heat shock protein 90 kDa beta (Grp94), member |
| | | | | 1; HSP90B1 |
| 1463 | 218546 | 100 | AGAAAGTGGCCCGGGTGAAGGCGCTATATGAGGAGCTGGATCTGCCAGCAGTGTTCTTGC | farnesyl diphosphate synthase (farnesyl |
| | | | | pyrophosphate synthetase, |
| | | | | dimethylallyltranstransferase, |
| | | | | geranyltranstransferase); FDPS |
| 1464 | 218581 | 100 | AGAAGCTTCCTGAAATGGACATTGATTGATTCCAACACTTGTTTCTATTAAAACAGACTA | heat shock 70 kDa protein 4; HSPA4 |
| 1465 | 218636 | 100 | AGACGCCAGGAAGGTGAGATCTTCGACACAGAAAAAGAGAAATATGAGATTACGGAGCAG | ribosomal protein L6; RPL6 |
| 1466 | 218954 | 100 | AGCTGCCCGAGCGCCTGCTGCAGCCGCTCCACTTTCTCCACATAGGCCTGTTCTTGCTTT | angiomotin like 2; AMOTL2 |
| 1467 | 220348 | 100 | CAGAGGGAGTGTGCGAATCTACCCTGACCAATGGGCTCAAGAATAAAGTATGATTTTTGA | sulfotransferase family, cytosolic, 1A, phenol- |
| | | | | preferring, member 3; SULT1A3 |
| 1468 | 221030 | 100 | CCCCACCATTCTACAGAGTTGTACTCAAGACAGATACTGAAAAAATCTAATACCTTCCCT | kelch domain containing 1; KLHDC1 |
| 1469 | 221158 | 100 | CCCTGTTCCTGCCCTGAAACAATTTCAATCACTGACAAATCATTATCATTCATTAATAAT | F-box and leucine-rich repeat protein 14; FBXL14 |
| 1470 | 221657 | 100 | CGCTAAGCGCCTATGCCACTCGCCTGATGAATTTGGGAGGTCATAAAAGCCTCACATGGG | unassigned |
| 1471 | 222747 | 100 | GAATAACAGGCTGGTTGGAAATCTGGAACAGAGTATCCTGAGAATCTGCCCACCTTGAAG | unassigned |
| 1472 | 223546 | 100 | GCCCAGCCAGTTAAGCACAAAGGAAAACATTTCAATAAAGGATCATTTGACAACTGGTGA | ribosomal protein L12; RPL12 |
| 1473 | 225189 | 100 | GTGTTCCTCCTCCCTCTATTACTGTTTCACCAGAGCTGTCTTAGCTCAAATCTGTTGTGT | scotin; unassigned |
| 1474 | 226803 | 100 | TGCTTCTGATTCCTACATCGTTTTCACCACTGAAATAGTTTTCTACTGAAATACAAAACA | NIPSNAP3A |
| 1475 | 228198 | 100 | AAGAGCTCTGTGTCTTCTTAGTGGCTGTATCTTGGATTCTGTCTTGTGCCAGCTCCCTCT | olfactory receptor, family 1, subfamily J, member |
| | | | | 2; OR1J2 |
| 1476 | 228421 | 100 | ACAAACTACAATCATCTTCCTGAGGCAGATTCCCACTAGGACTGCATTCAACTTAGAGCC | PROLINE-RICH PROTEIN |
| 1477 | 229592 | 100 | ATTAATACGCCAGTCATCATAAAAGATGGTCATTATAGTACCCCCATTGCTCCTGCTTGT | AUTOPHAGY PROTEIN 12 |
| 1478 | 229944 | 100 | CAGCCACCTGTCAAGAGGAGGCGGAGCGTCATGCCTCTGGAAGACTGGATGAATATTCTC | LOC253039\|EHD2 |
| 1479 | 230429 | 100 | CCCTGTTCCCACTCTACCACTGGAGGAAATGAGGACACAATCTGGTATCAACAGTTTGAT | unassigned |
| 1480 | 230540 | 100 | CCTGCGGGTGACCCGGCCTCTGGTGCCAGAGCCTGCCATCCTTCCTGTTTGTGCTGCCAG | chromosome 9 open reading frame 139; C9orf139 |
| 1481 | 230838 | 100 | CTCACCCTCCTCAGACTCTGCGGCGGAGAGCCGAGTGATGAATAAATGAGTAACCACATC | unassigned |
| 1482 | 232377 | 100 | GGGACCACCCTCATTTCCCAGCTTCCTCGAAGGGCAGACACTCCCCACAGCTCTGCTGCC | unassigned |
| 1483 | 232820 | 100 | GTTTCTTGGCTACACAGATGGGTCTGTCAGGGTTGAAGCCACATGGGTGCCTGCTCATGT | unassigned |
| 1484 | 232981 | 100 | TAGCACACTCATGAACCTAATTCCCACATTTGATAGTTGTTACATTTTGCCATGTTTGTT | Lyrm7 homolog (mouse); LYRM7 |
| 1485 | 233218 | 100 | TCATTGGGTTTAGGAAGGATTTCTCTAACACTGAGTAACATGAGGATTTAGCAGTAGTGT | unassigned |
| 1486 | 234288 | 100 | TTGTTCGTTCTGCTCTGGAGACCCCTGGGTTGCGGCCCCTGGACCCCTCCACCCCTGCTG | PLECKSTRIN HOMOLOGY DOMAIN CONTAINING |
| | | | | PROTEIN |
| 1487 | 234297 | 100 | TTTAGATTTATCAGGCTTCTTCACCTCGCACTGTCCCCATCCTGGCCGCAGGCCCCCTCG | unassigned |
| 1488 | 234359 | 100 | TTTGTTCACACAGTCTCTCCAGCTCCCGCACCCTCTGCGCCTCCTGCTCTCGGATCATCT | unassigned |
| 1489 | 234458 | 100 | AACTGGGAGGAGATAAGAAGAGAAAGGGCCAAGTGATCCAGTTCTAAGTGTCATCTTTTG | 60S RIBOSOMAL PROTEIN L44 |
| 1490 | 234621 | 100 | AGATGCAGGAATAAAGTAATCTTATATACAAGCTTTGATTAAAACTTGAAACAAAGAAAA | zinc finger, MYND-type containing 17; ZMYND17 |
| 1491 | 234758 | 100 | ATGGAGAGGAGAGATCGTGCTGTGTGTCATGTCTGTTGTTCAAGTAAATAAAAGTTGCCC | LOC284454 |
| 1492 | 235017 | 100 | CCTCCTCTCCCTCCCACTGCACACTCCCACTTCCTCAGCGACCGGGCCCTTCTCCACCTC | unassigned |
| 1493 | 235219 | 100 | GAAGAACCGAGTGTGTCCACCGATGTGGCAGCTGCAGCGGGCTTGGCTTTGTGAGGAACC | unassigned |
| 1494 | 235396 | 100 | GGCCACAGCTGCTCTCCAGGCCCACTATGCACACATCTTCCCCTCCAAGGTTTGTTCTGC | CAPICUA PROTEIN |
| 1495 | 235909 | 100 | TTCACCCCAGCAAGATTCTTGAATGGAAAGCCAAATCTCACCAAGTAGGAAAGGAAACGG | unassigned |
| 1496 | 236102 | 100 | AATAAAAGCTCGCCTTTTGTCTGTACATACTGGCCTCCGTGAATACATAGATCAGCCATT | 60S RIBOSOMAL PROTEIN L19 |
| 1497 | 236177 | 100 | AGATAAGAAGAGAAAGGGCCAAATGATCCAGTTCCAAGTGCCATCTTTTATTATGAAGAC | 60S RIBOSOMAL PROTEIN L44 |
| 1498 | 236952 | 100 | TTAAGAGATGCAAGCATTTTGAACTGGAAGGAGATAAGAGAAAGGGCCAAGTGATCCAGT | 60S RIBOSOMAL PROTEIN L44 |
| 1499 | 237069 | 100 | CCACCACCTCCACCCTGGAAGAGTTCCCCTTCCCTTTGAAATCTCATGGGACTTTGCCCC | CLAUDIN-4 |
| 1500 | 240102 | 100 | AAAATAGTTCAAATGAGTCCTGTATCATTGTATCTCCTATTCTGGATTAGTGCCTTTTGG | homeobox containing 1; HMBOX1 |
| 1501 | 264288 | 100 | AAGTGAAACAAACAAAAAGTGATGTCTGCCAACAGCCACCACCAAGACAAGCGTCTGGGT | c-mer proto-oncogene tyrosine kinase; MERTK |
| 1502 | 343450 | 100 | ATGAAGTGAGAAATTGTTGAGAAGGATACAGTTTGTTTTTAGATGTCCTTTGTCCAATGT | small nuclear ribonucleoprotein polypeptide E; SNRPE |
| 1503 | 423075 | 100 | CCTTTATTTCCTTTATTACCCGCATCCTTGTGTCACCAGGTCCTCTCATTACGACAGCCT | unassigned |
| 1504 | 466085 | 100 | GAAAACATGGTAGGACTCACACTGGATAGAAACCAAAGCAGGTGAATCACCTGAGGTCAG | zinc finger protein 763; ZNF763 |
| 1505 | 510396 | 100 | GCCGGGCAGAGGTGCTCCTCACTTGCCACACAGGGCGGCAGCTTGGCAGAGTCGCTCCTC | HEPATOCELLULAR CARCINOMA-ASSOCIATED |
| | | | | ANTIGEN-RELATED |
| 1506 | 552912 | 100 | GGTGGAGACACAGCGGCTCCCCGCTAACCACCACTCTCCTGCCTGGTGTAGACAAAGCGG | SODIUM/HYDROGEN EXCHANGER 7, 9 |
| 1507 | 660069 | 100 | TGTTCTCAGCACTGTACAACGGTCCCTATATAATACGGAGAAGCAATATCACTGTATGAG | unassigned |
| 1508 | 693356 | 100 | AAAAGATCGAAATGGACGAGCAGGATATGAGAAGGGCATTATATCGTTTCAGACTTACAG | unassigned |
| 1509 | 700108 | 100 | CAATGCTCTCCATCTCCCTTATGTGGACTCTTGTTCTTGTCTGATCTCTTGTCAAATTGT | unassigned |
| 1510 | 710021 | 100 | GTCAGGCCAGGGTCCTGTCTGCTCTGTGAGTCCCTCCAATTGTTCTTATTCCGAGATTTC | poly (ADP-ribose) polymerase family, member |
| | | | | 9; PARP9 |
| 1511 | 710141 | 100 | GTCTACCCCCTGCACGTGCAGAGCAAAAAGAGCTTCCTATGGGAGCTGTTCTCCAGAAAA | disrupted in schizophrenia 1; DISC1 |

Table 6: Verification Results Using Same Platform but Performed at a Different Laboratory and with a Different Sample Cohort

TABLE 6A
Sample information

| | Number of samples |
|---|---|
| Breast cancer samples | 20 |
| Non-breast cancer samples | 20 |
| | 40 |

TABLE 6B
Prediction performance

| | | | Study 2 | |
|---|---|---|---|---|
| | | | Number of | |
| | Study 1 | | probes present | |
| Frequency of | Number of | | corresponding to | |
| occurrence | informative | Accuracy | study 1 informa- | Accuracy |
| criterion | probes | estimated | tive probes | estimated |
| 0% | 1511 | 76.38 | 1466 | 82.5 |
| 10% | 873 | 77.17 | 842 | 80.0 |
| 20% | 786 | 78.74 | 757 | 80.0 |
| 30% | 748 | 80.31 | 722 | 82.5 |
| 40% | 731 | 80.31 | 705 | 85.0 |
| 50% | 707 | 78.74 | 682 | 85.0 |
| 60% | 677 | 77.95 | 653 | 85.0 |
| 70% | 645 | 78.74 | 625 | 85.0 |
| 80% | 606 | 78.74 | 589 | 77.5 |
| 90% | 538 | 80.31 | 524 | 80.0 |
| 100% | 282 | 72.44 | 278 | 77.5 |

Table 7: Verification Results Using Different Platform (Codelink, GE) and Performed at a Different Laboratory and with a Different Sample Cohort

TABLE 7A
Sample information

| | Number of samples |
|---|---|
| Breast cancer samples | 56 |
| Non-breast cancer samples | 58 |
| | 114 |

TABLE 7B
Prediction performance

| | | | Study 2 | | Study 3 | |
|---|---|---|---|---|---|---|
| | | | Number of | | Number of | |
| | Study 1 | | probes present | | probes present | |
| Frequency of | Number of | | corresponding to | | corresponding to | |
| occurrence | informative | Accuracy | study 1 informa- | Accuracy | study 1 informa- | Accuracy |
| criterion | probes | estimated | tive probes | estimated | tive probes | estimated |
| 0% | 1511 | 76.38 | 1466 | 82.5 | 611 | 80.70 |
| 10% | 873 | 77.17 | 842 | 80.0 | 507 | 80.70 |
| 20% | 786 | 78.74 | 757 | 80.0 | 476 | 80.70 |
| 30% | 748 | 80.31 | 722 | 82.5 | 467 | 80.70 |
| 40% | 731 | 80.31 | 705 | 85.0 | 460 | 80.70 |
| 50% | 707 | 78.74 | 682 | 85.0 | 446 | 80.70 |
| 60% | 677 | 77.95 | 653 | 85.0 | 435 | 79.82 |
| 70% | 645 | 78.74 | 625 | 85.0 | 425 | 78.95 |
| 80% | 606 | 78.74 | 589 | 77.5 | 413 | 78.95 |
| 90% | 538 | 80.31 | 524 | 80.0 | 380 | 78.95 |
| 100% | 282 | 72.44 | 278 | 77.5 | 213 | 71.93 |

TABLE 7C
Probe sequences

| | | % | | | |
|---|---|---|---|---|---|
| | Table 5 | Freq. | | | |
| Probe | Probe ID | of | CodeLink ID | | |
| No. | No. | Occ. | No. | CodeLink Probe Sequence | Gene name |
| 1 | 103617 | 0 | GE88525 | CTTTGTCATACCACATCTTCCCCTTTACCA | 5-azacytidine induced 2; AZI2 |
| 2 | 105816 | 0 | GE78958 | CTGCTTTACAAGAGGTTCTGAAGACTGCCC | ribosomal protein S12; RPS12 |
| 3 | 106334 | 0 | GE55737 | CTCTCCTCTCCTCCTTGTCTGGCTCTGTTG | NECAP endocytosis associated 2; NECAP2 |
| 4 | 106796 | 0 | GE54069 | AAACAAACCACCTGACCAAGAGGGAAGTGA | actin related protein 2/3 complex, subunit 5, 16 kDa; ARPC5 |
| 5 | 107117 | 0 | GE62124 | ACCTCGCTCTTATACCATCGCAGTTGCTTC | galactosidase, alpha; GLA |
| 6 | 108442 | 0 | GE1680138 | GCATGAAGGGAGCACCGTGGAGAAGACAGT | immunoglobulin lambda light chain variable region |
| 7 | 108594 | 0 | GE55150 | TGTAATGTCTAGTGGGGCTTCATCATCCTG | progesterone receptor membrane component 2; PGRMC2 |
| 8 | 111542 | 0 | GE82463 | AACATTCCAGAAGATGACTCAGGTGTCCCC | chromosome X open reading frame 9; CXorf9 |
| 9 | 111542 | 0 | GE88309 | GTCCACCACTCCAACTTTGCTTTCTGAAGG | chromosome X open reading frame 9; CXorf9 |
| 10 | 112290 | 0 | GE55189 | ACTGTAGGTGGAAGAGCAAGAGTCCCTCCC | MCM3 minichromosome maintenance deficient 3 (S. cerevisiae) |
| | | | | | associated protein; MCM3AP |
| 11 | 112443 | 0 | GE533113 | GGCACACTCCACCTTCCCTAGTCACCAGCT | glycoprotein IX (platelet); GP9 |
| 12 | 117405 | 0 | GE1679927 | TGAAGAGCCGAATACCTGTGGTGCTCCTGG | nicotinamide nucleotide adenylyltransferase 3; NMNAT3 |
| 13 | 119207 | 0 | GE1679715 | TTCCTTGACGTGTCTCAGACTGGGTCCCTG | unassigned; unassigned |
| 14 | 120075 | 0 | GE1679931 | GGTCACTGAACAACTAATCTTGGTCCCTGA | adaptor-related protein complex 3, mu 2 subunit; AP3M2 |
| 15 | 120440 | 0 | GE54208 | CCATTCTCTTGCCCTTAGGATTCACTGCTC | inosine triphosphatase (nucleoside triphosphate |
| | | | | | pyrophosphatase); ITPA |
| 16 | 121045 | 0 | GE85833 | GTTGTCAGCAGGAGAGAGCATTAGTTTGGA | EF-hand domain family, member A1; EFHA1 |
| 17 | 121045 | 0 | GE85834 | GCTCATCGTCCTGTCAGACTAGCGGAGTTT | EF-hand domain family, member A1; EFHA1 |
| 18 | 124046 | 0 | GE61239 | CTACATCGAGGACCTTAAGTGCCGTGTGCT | serpin peptidase inhibitor, clade B (ovalbumin), member 1; SERPINB1 |
| 19 | 124823 | 0 | GE545386 | TATCCTCCCTGGCAGACACAACCCAATAGG | polymerase (DNA directed), beta; POLB |
| 20 | 125012 | 0 | GE88839 | CTCTCCCGAAACTAAACTTGAGCCTCCATT | GRIP and coiled-coil domain containing 2; GCC2 |
| 21 | 125096 | 0 | GE1679721 | GAGCCCAGTGACATTGTCTATCTCATCCGC | potassium channel, subfamily T, member 1; KCNT1 |
| 22 | 126905 | 0 | GE59496 | GAGCCCCCTCTTCCAGACACTATACTTCCA | solute carrier family 31 (copper transporters), member 2; SLC31A2 |
| 23 | 127609 | 0 | GE568338 | GGGTCACCATCATGCCTAAGGACATCCAGC | histone cluster 3, H3; HIST3H3 |
| 24 | 128211 | 0 | GE79060 | CATTGAAGACGTCATTGCCCAGGGTATTGG | zinc finger protein 675; ZNF675 |
| 25 | 129530 | 0 | GE86936 | TGAATGGGTTGTTAAAGGCAATGGTTTGTG | RanBP-type and C3HC4-type zinc finger containing 1; RBCK1 |
| 26 | 131715 | 0 | GE87385 | TTGTGTTGCTGCCAGAATCAGAATCCAGTT | apolipoprotein B mRNA editing enzyme, catalytic polypeptide-like |
| | | | | | 3G; APOBEC3G |
| 27 | 133356 | 0 | GE1679947 | AGAAAGCTCAGCTGGTGGTGACTGCACACG | unassigned; unassigned |
| 28 | 135807 | 0 | GE55720 | CCCCTCCTCGGAACACAACAGTAGACCTTA | hypothetical protein LOC285074; unassigned |
| 29 | 136420 | 0 | GE1679954 | AAGAACTTCGGCATCTGGCTGCGCTACAAA | 60S RIBOSOMAL PROTEIN L18A |
| 30 | 137061 | 0 | GE56690 | TGAATTGCAAAGACCTCCATAAAACCACCC | ankyrin repeat and IBR domain containing 1; ANKIB1 |
| 31 | 138703 | 0 | GE53430 | ATGTGTGGTAGACTCCCTTTGCTGGCTTGT | oxidative-stress responsive 1; OXSR1 |
| 32 | 139466 | 0 | GE79833 | AGGACAGAGGGTGGTCGTCGTGGATGATCT | adenine phosphoribosyltransferase; APRT |
| 33 | 140829 | 0 | GE1679744 | TGGCAACATCAGGAAGTTACCCTCTATGCT | unassigned; unassigned |
| 34 | 141469 | 0 | GE1679335 | GGTGGAGCAGCCAAAATGAAGTACAATCCC | 60S RIBOSOMAL PROTEIN L26 |
| 35 | 144168 | 0 | GE56569 | TGCCATTTGTTTCCTTCTGATCTCTCACTG | BCL2/adenovirus E1B 19 kDa interacting protein 3-like; BNIP3L |
| 36 | 145597 | 0 | GE55586 | TTTTGTCCTCTGCTGTCTCCTCTGGTCCTG | nuclear protein localization 4 homolog (S. cerevisiae); NPLOC4 |
| 37 | 146661 | 0 | GE80556 | GTGCTGCCTCTCTTCTGTGTCGTTTTGTTG | adducin 1 (alpha); ADD1 |
| 38 | 147139 | 0 | GE82631 | TGGGGCAGGATTGTGACTCTCATTTCTTTT | myeloid cell leukemia sequence 1 (BCL2-related); MCL1 |
| 39 | 147922 | 0 | GE81068 | GAGGACTACAGCGACAAAGTGAAAGCCAGC | cell division cycle 2-like 2 (PITSLRE proteins); CDC2L2 |
| 40 | 151531 | 0 | GE79428 | TTGACTGGCTTTCCTCTCGTTGGTAGTTGA | drebrin 1; DBN1 |
| 41 | 152345 | 0 | GE81214 | CGACTGTCTTGTCCCAGAACCTTTTCACTC | ribophorin II; RPN2 |
| 42 | 153036 | 0 | GE55477 | GGCATCATTGTCCGCTCCATTAAGAACAGT | protein phosphatase 2, regulatory subunit B, delta isoform; PPP2R2D |
| 43 | 153454 | 0 | GE59743 | GTGGAAAACCAGCTTCAGTCAGTGCTCCTA | general transcription factor IIF, polypeptide 2, 30 kDa; GTF2F2 |
| 44 | 155892 | 0 | GE53850 | CCAAGTGTTTCTTTTCCCATGCTCTTTGTT | development and differentiation enhancing factor 1; DDEF1 |
| 45 | 155892 | 0 | GE82388 | TTCCCTCTCAGTTTTCTTTTCATCCCAGCC | development and differentiation enhancing factor 1; DDEF1 |
| 46 | 157646 | 0 | GE79496 | GTTTCTTCCGACAGTTGTGTTGTGCCAATG | zinc finger, HIT type 1; ZNHIT1 |
| 47 | 157646 | 0 | GE86501 | CTGCCTCAGTTTGATGACGATGCGGACACT | zinc finger, HIT type 1; ZNHIT1 |
| 48 | 158771 | 0 | GE88802 | CTTCATACTTTGTTGGGGGACTTTGGAGGC | chromosome 1 open reading frame 85; C1orf85 |
| 49 | 158784 | 0 | GE79943 | CTTTTGATGAGAGTGCCCTAACCCCAGACA | RUN domain containing 1; RUNDC1 |
| 50 | 160068 | 0 | GE1679984 | CCAGTCCAAGAATCTGTTTAAAATTCAGAC | similar to ribosomal protein S3a; unassigned |
| 51 | 160973 | 0 | GE58161 | ATGCCCTGGAGAAGAATGAAGTGGACCTGG | hydroxymethylbilane synthase; HMBS |
| 52 | 161646 | 0 | GE1679767 | TTTGTACTTTACCTGGATTCCATTGGCTGG | chromosome 14 open reading frame 119; C14orf119 |
| 53 | 162105 | 0 | GE1679986 | GACATTGAGCTTGTTTCAAATTCAGCGGCT | ribosomal protein L9; RPL9 |
| 54 | 162160 | 0 | GE54322 | GCTATGACATCGACATGACCAAGTGCATCT | NADH dehydrogenase (ubiquinone) Fe—S protein 8, 23 kDa (NADH- |
| | | | | | coenzyme Q reductase); NDUFS8 |
| 55 | 162550 | 0 | GE80732 | CTTCACCAATTACATCCTCCCCGTGTGCCT | protease, serine 27; PRSS27 |
| 56 | 164265 | 0 | GE82108 | GAGAAAAGCAGCCTCCCAGTCAGACAAGCC | Enah/Vasp-like; EVL |
| 57 | 167428 | 0 | GE88508 | CCTCCTGCCCGTGTTTGTGAATATCATTCT | ribosomal protein L28; RPL28 |
| 58 | 167622 | 0 | GE811968 | TGCTTAAAATGTTGCTCAAACCCCTGACCT | hypothetical protein DKFZp313A2432; DKFZp313A2432 |
| 59 | 170844 | 0 | GE58500 | ATAAGCCCACCCAGAGAAGTGTTTCCAATG | granulysin; GNLY |
| 60 | 173972 | 0 | GE54576 | CCTGCCTTGGATTCTGAAGTGTTCCTGTTT | nudix (nucleoside diphosphate linked moiety X)-type motif 3; NUDT3 |
| 61 | 175030 | 0 | GE61990 | GACTCGTGCCTTCTGCTGTTCTCATTGTGG | SAPK substrate protein 1; unassigned |
| 62 | 176372 | 0 | GE1679999 | GGAATCAGAGATCATTGACTTTTTCCTGGG | ribosomal protein S2; RPS2 |
| 63 | 178216 | 0 | GE81500 | ACCAAGGCTGTCACCACATTCACCATCACT | v-myc myelocytomatosis viral related oncogene, neuroblastoma derived |
| | | | | | (avian); MYCN |
| 64 | 178628 | 0 | GE1679789 | GCCTCATTCCTTTACCACTCCCACACCTGG | MOESIN/EZRIN/RADIXIN |
| 65 | 181160 | 0 | GE56469 | CCTTCATTTCTGGCTCTGTGTCTCCTCTGG | pyruvate dehydrogenase phosphatase regulatory subunit; unassigned |
| 66 | 181937 | 0 | GE82596 | TTCCCAGTCCTAATCAGCACCTTCCAGAGA | thioredoxin domain containing 13; TXNDC13 |
| 67 | 187871 | 0 | GE1680014 | GCTGCAGGAACCCATTTAGGTGGCAACAAC | similar to laminin receptor 1 (ribosomal protein SA); unassigned |
| 68 | 188901 | 0 | GE59225 | GCCCCTGGAAATGTGCTAAAGTTGGAAAGT | potassium inwardly-rectifying channel, subfamily J, member 9; KCNJ9 |
| 69 | 194925 | 0 | GE505537 | CACCCAACTGTTCTTTTATCGTCTCGGTTT | chromosome 1 open reading frame 142; C1orf142 |
| 70 | 196303 | 0 | GE62544 | GTTCCTTTGTCTTCTCACTCGCACTCTGGC | golgi autoantigen, golgin subfamily a, 1; GOLGA1 |
| 71 | 196942 | 0 | GE58106 | CACTACTTCCGCTACCTGGGCTCACTCACC | carbonic anhydrase IV; CA4 |
| 72 | 197310 | 0 | GE81039 | AAAGCAGCGGTCAGTTTTCAGAGATGTCCT | interferon-related developmental regulator 1; IFRD1 |
| 73 | 198202 | 0 | GE59340 | TTCATTGGATTGGGGGTGAGTGTTTTGTTT | SWI/SNF related, matrix associated, actin dependent regulator of |
| | | | | | chromatin, subfamily c, member 1; SMARCC1 |
| 74 | 199887 | 0 | GE1679813 | CATTACTCTGCACTATAGCCATTTGCCCCA | UBIQUITIN |
| 75 | 202480 | 0 | GE53284 | GTTCTTTTAGTAAGGCATTTGGGGTTGGGG | thioredoxin domain containing 4 (endoplasmic reticulum); TXNDC4 |
| 76 | 202780 | 0 | GE57093 | CTTGGCAGATCACTCTCTTAGCAGGTAGGT | adrenomedullin; ADM |
| 77 | 202780 | 0 | GE85302 | CGTGAATGTCTCAGCGAGGTGTAAAGTTGT | adrenomedullin; ADM |
| 78 | 203036 | 0 | GE54719 | CCCTCTTCCTCCCCGTCATTGTACTGTAAC | H2A histone family, member V; H2AFV |
| 79 | 204151 | 0 | GE87081 | GCTGGTCCTTCTCGTTTGCTCTAGTCTTGC | hexokinase 2; HK2 |
| 80 | 209738 | 0 | GE79737 | GCAAAGATGGTCAACGTACCTAAAACCCGA | ribosomal protein L36a-like; RPL36AL |
| 81 | 211734 | 0 | GE81785 | TACAACGAATACATCAGCCACCGAGAGCAC | KIN, antigenic determinant of recA protein homolog (mouse); KIN |
| 82 | 217279 | 0 | GE537881 | TCACTAGGCTAAAACTGGACAAAGACCGCA | ribosomal protein L26; RPL26 |
| 83 | 217279 | 0 | GE539167 | AAGATCAGCAAATTGGCAAAGTAGTCCAGG | ribosomal protein L26; RPL26 |
| 84 | 223796 | 0 | GE486224 | AACTTCCGCATTTCCACCTTCTAAGCCGAA | chromosome 9 open reading frame 66; C9orf66 |
| 85 | 228018 | 0 | GE54850 | AAATCCCTTCCTTGCCCACCTCTATGTCAG | carbohydrate (chondroitin 4) sulfotransferase 11; CHST11 |
| 86 | 231927 | 0 | GE1680074 | ACTCCTGGTCCCCTTGAAACCCTGTTGGTG | hypothetical protein FLJ25404; unassigned |
| 87 | 234426 | 0 | GE81797 | GGAAACAGGCCGAGAAGAACGTGGATAAGA | similar to ribosomal protein L13a; unassigned |
| 88 | 234587 | 0 | GE729014 | TTGGCTTGTTAACTCGGTCAGTCCCTGGGA | unassigned; unassigned |
| 89 | 234862 | 0 | GE477402 | GACCCAACAACAACCCCTCCCAAGTTCCTA | unassigned; unassigned |
| 90 | 234862 | 0 | GE84107 | ATCACGCTTTCTGTCCCACTTTCCCACACT | unassigned; unassigned |
| 91 | 234963 | 0 | GE1679864 | CCATGCTCTCTCTCCATAGGTCCTGTTTTA | small nuclear ribonucleoprotein g |
| 92 | 235086 | 0 | GE61631 | AGCACCTCTTCTGTCTCCTCTCAAAGTCCG | thyroid adenoma associated; THADA |
| 93 | 235377 | 0 | GE1679658 | GGAGGCATGTCCTCAGGCCTGGGAGACCAG | unassigned; unassigned |
| 94 | 235378 | 0 | GE88076 | GCCTTCCTTTTGGGTGTCTTTCTCTTCTCC | FLJ43339 protein; unassigned |
| 95 | 235698 | 0 | GE1680092 | TCAGGCATGTTACTGGTAGTTCCTTTTGAG | U520 |
| 96 | 236307 | 0 | GE1679875 | TGTTGCCGTATCAAGCAGAAAATGTCACCA | RIBOSOMAL PROTEIN L39E |
| 97 | 236371 | 0 | GE1680098 | TCAGAAGAACGAACTAAGGTGTCTACCATG | unassigned; unassigned |
| 98 | 236685 | 0 | GE1680101 | GCGTTCATGGCCTGCACTCTTACGAGAGGT | INOSINE-5-MONOPHOSPHATE DEHYDROGENASE |
| 99 | 295023 | 0 | GE615605 | AGGAAGGCCAAATGAGCAAGTGAATCAGCA | unassigned; unassigned |
| 100 | 536912 | 0 | GE1679891 | AAAATAAGGCCCATGTCCACTGTCCCCTGC | 60S RIBOSOMAL PROTEIN L21 |
| 101 | 539197 | 0 | GE83577 | TTTCCTCTGACTTACCCGGACATGTACGTG | chromosome 3 open reading frame 34; C3orf34 |
| 102 | 694146 | 0 | GE1680117 | TTTTGCAAAACTTGATGATCAAGCTGAACG | unassigned; unassigned |
| 103 | 711916 | 0 | GE495809 | ATTTGGCTCTCACACTCTTTACCGTGCAGA | unassigned; unassigned |
| 104 | 10480018 | 0 | GE1679593 | ACGTGTGAGGTCACTTCCTGCGTGTTGGGT | ribosomal protein S13; RPS13 |
| 105 | 104220 | 10 | GE88292 | CTTATTTATTACCCTCCCCTCCCACACCCC | rabphilin 3A-like (without C2 domains); RPH3AL |
| 106 | 113742 | 10 | GE528029 | TCCTTCTGCACTGCGTGTCCCATCTTTGAA | MULTIDRUG RESISTANCE PROTEIN 2 |
| 107 | 125665 | 10 | GE1679723 | TCCAGCACCAGTCAGACCAATATGTCAAAA | ribosomal protein L32; RPL32 |
| 108 | 136737 | 10 | GE55963 | CTGCTGTCCTGCCTCAATTTAGCCAAGACT | family with sequence similarity 49, member A; FAM49A |
| 109 | 137199 | 10 | GE56869 | CTTTTCACCTACTGCGACCACCCACCTCAT | nucleoporin 62 kDa; NUP62 |
| 110 | 137199 | 10 | GE81788 | CTGTTGTCTGTAGTTTGGGGTTGTGGCAAG | nucleoporin 62 kDa; NUP62 |
| 111 | 143933 | 10 | GE53794 | CTCTCCTTTCATTGTCAGACTCCCCCTGGT | transmembrane and coiled-coil domain family 3; TMCC3 |
| 112 | 145045 | 10 | GE53958 | CGTGTCTCCTCCTCCTCATCTTAGCTTCCA | phosphatidylinositol 3,4,5-trisphosphate-dependent RAC exchanger |
| | | | | | 1; unassigned |
| 113 | 151108 | 10 | GE81052 | GCACGCCCTCTATGACAATGTGGAGAAACT | asparagine synthetase; ASNS |
| 114 | 161521 | 10 | GE1679766 | TTTGTGCTCTTTTCCCTGTGTACATGGTGG | unassigned; unassigned |
| 115 | 162490 | 10 | GE1679987 | ATCGACAGCACGCCCTACCGACAGTGGTAC | 40S RIBOSOMAL PROTEIN S8 |
| 116 | 166400 | 10 | GE82286 | GCACCGGCACATCTAACATCTACACTTCTC | NOL1/NOP2/Sun domain family, member 5; NSUN5 |
| 117 | 172174 | 10 | GE59321 | CCTCGCCTTCTGTGTCTTTAGTCTTGAGCC | Hermansky-Pudlak syndrome 1; HPS1 |
| 118 | 174875 | 10 | GE62993 | GTTTGAAGACGGCATCATTAACTGGGGAAG | BCL2-related protein A1; BCL2A1 |
| 119 | 178526 | 10 | GE61375 | TTTCCCTACCATCGTTGAGAGAGAGCCTTG | protein disulfide isomerase family A, member 6; PDIA6 |
| 120 | 187114 | 10 | GE631286 | CAGGTGAACTCGAAGCCCACAATCCTCGTC | adrenergic, beta-1-, receptor; ADRB1 |
| 121 | 190261 | 10 | GE1680017 | CCGAGGCCCCTACAAAGCCTTCAGAGTAGA | 60S RIBOSOMAL PROTEIN L29 |
| 122 | 206302 | 10 | GE80838 | CAGAGCCGAGATCCTGAAGAAGAGAGCACT | bromodomain PHD finger transcription factor; BPTF |
| 123 | 206528 | 10 | GE1680045 | TAGGATCCAAGAATGAGGGTTCCCCCAGCC | mediator of RNA polymerase II transcription, subunit 25 homolog (S. cerevisiae); |
| | | | | | MED25 |
| 124 | 207955 | 10 | GE54722 | AACACATCTGATTTCCCACAGCACAACAGC | transmembrane protein 50A; TMEM50A |
| 125 | 210420 | 10 | GE57747 | ATGTTTGGGATGGTGGCTCCTGTTGTCTTG | syntaxin 1A (brain); STX1A |
| 126 | 214925 | 10 | GE1679833 | TTGATGGCGTGAGTTTACTGGTGCGGAAAA | 60S RIBOSOMAL PROTEIN L7 |
| 127 | 217443 | 10 | GE541560 | TGGACCACAAGTTCGACCTGATGTATGCCA | tubulin, alpha 3; unassigned |
| 128 | 220741 | 10 | GE55634 | ACTCCACACTTCACCCCGCTGCTTTTCTCT | G protein-coupled receptor 107; GPR107 |
| 129 | 227738 | 10 | GE556587 | GGTGTGCCCTATACGGTCTCTGAAGGTTCA | zinc finger protein 524; ZNF524 |
| 130 | 234988 | 10 | GE1679865 | CCTAGCTCCGTCGGTTCCTTTCTGGTGAGA | unassigned; unassigned |
| 131 | 384551 | 10 | GE517698 | AGACCGGCATCCTCTCTCTCTCTGTGCACC | hypothetical protein FLJ40448; unassigned |
| 132 | 539274 | 10 | GE1679464 | AGACCAGCCAGAACTTCACCAAGAGCGCAG | unassigned; unassigned |
| 133 | 712642 | 10 | GE611455 | CTGTTGTGCCCTCTGAGCCCTCCAGTGAGT | unassigned; unassigned |
| 134 | 104157 | 20 | GE53759 | AACCCACACATTCCCATTCACCAATAAAGG | phosphatidylethanolamine N-methyltransferase; PEMT |
| 135 | 109372 | 20 | GE1679914 | TCTGCCCACCAGAACCGGAAGTTGTGTCTT | unassigned; unassigned |
| 136 | 150817 | 20 | GE1679974 | AAGCTGCATTGAGAAATGACTCGTCTCTGT | microtubule associated monoxygenase, calponin and LIM domain |
| | | | | | containing 3; MICAL3 |
| 137 | 163137 | 20 | GE1679769 | GGAATTCACTGACCACCTCGTTAAGACCCA | ribosomal protein S2; RPS2 |
| 138 | 179326 | 20 | GE1680002 | ACTCCGGACGTGAGCATTCGCAGTGGGTTT | chromosome 4 open reading frame 23; C4orf23 |
| 139 | 184572 | 20 | GE62051 | CTAAATCCCACGAATGACAACTACCACCTT | splicing factor 3B, 14 kDa subunit; unassigned |
| 140 | 196599 | 20 | GE62773 | GCATAACAGCATCACCTACATCCCAGAGCA | leucine rich repeat containing 8 family, member C; LRRC8C |
| 141 | 236688 | 20 | GE1680102 | GATGGCCGCCACCCTCATGACATCATATAT | 60S RIBOSOMAL PROTEIN L12 |
| 142 | 705996 | 20 | GE1679902 | ATGCCCGCCTGCCTGTTACATTCCTGTTAT | hypothetical LOC441027; unassigned |
| 143 | 108400 | 30 | GE63107 | AACTCCCAAACTGCCGTTCTTTTCGATAGC | hypothetical protein BC004921; unassigned |
| 144 | 160960 | 30 | GE1679985 | GAAGTCAAATGCACGCCAACATTCCAGTTT | thioredoxin; TXN |
| 145 | 174760 | 30 | GE61143 | TTGGAGATGGAGTTGAATGAGCACAGCCTA | prefoldin subunit 2; PFDN2 |
| 146 | 186148 | 30 | GE57546 | CGGAACTCAGCATCCTACTCTTCGCCTTTA | zinc finger protein 66; ZNF66 |
| 147 | 196745 | 30 | GE54956 | CCCCCAGTTGCTTATCCAGATGTGACAGAG | G protein beta subunit-like; unassigned |
| 148 | 204159 | 30 | GE558798 | TGGACTCAGCTACATCCGATACTCCCAGAT | ATP synthase, H+ transporting, mitochondrial F1 complex, epsilon |
| | | | | | subunit; ATP5E |
| 149 | 234977 | 30 | GE560311 | TCCATTTGATTCAAGGTGCTGGTCCAACAG | fucosyltransferase 11 (alpha (1,3) fucosyltransferase); FUT11 |
| 150 | 107464 | 40 | GE83438 | ATGTATCACTGCCACTGGTTTTGGAGTTGC | ubiquitin specific peptidase 38; USP38 |
| 151 | 112021 | 40 | GE1679918 | CCCCAGGCCCTTCTGGTTGGTAGTGAGTGT | jumonji domain containing 2B; JMJD2B |
| 152 | 135479 | 40 | GE1679736 | AAGTACACCCCTCCACCTCACCACATTGGC | similar to peptidylprolyl isomerase A isoform 1; unassigned |
| 153 | 137092 | 40 | GE55263 | CGGGCTCTTCGGGATCTTCTAACACACTAC | phospholipase A2-activating protein; PLAA |
| 154 | 137092 | 40 | GE81368 | TGACAATGACATCTTCCCCTTACCTTAGCC | phospholipase A2-activating protein; PLAA |
| 155 | 143330 | 40 | GE1679966 | GTTCCTTCCGTCTCCAGTGCACCGGCTTTC | unassigned; unassigned |
| 156 | 147381 | 40 | GE60463 | GACTTACCCCCTTTCTCTTACCACGGCTTC | amine oxidase, copper containing 2 (retina-specific); AOC2 |
| 157 | 147942 | 40 | GE55127 | GTCAACCCCATCATCTACTCCTTCCGCAGC | endothelial differentiation, lysophosphatidic acid G-protein-coupled |
| | | | | | receptor, 6; EDG6 |
| 158 | 149034 | 40 | GE1679755 | CGCTGACTTGGAGCCTCTCTTCCTATACCT | PQ loop repeat containing 3; PQLC3 |
| 159 | 155915 | 40 | GE56727 | AAGGACGAGGACACCGAAGAGCAGAAGGAG | ATP-binding cassette, sub-family A (ABC1), member 7; ABCA7 |
| 160 | 168528 | 40 | GE59204 | TCAATGGTTGGTTATATTCTGGGGCTTGGA | ataxia telangiectasia and Rad3 related; ATR |
| 161 | 178477 | 40 | GE1679788 | GACCATCCACTCCATAGCCCTCACCTCCCT | OLFACTORY RECEPTOR MOR239, MOR240 |
| 162 | 202425 | 40 | GE57296 | CTATTGGTGGTCGTCGGTTTTCTGAGGGTA | proteasome (prosome, macropain) 26S subunit, ATPase, 6; PSMC6 |
| 163 | 209426 | 40 | GE58327 | CCCTATTCCCTGAAGATCCGAAACACTACC | CD83 molecule; CD83 |
| 164 | 115081 | 50 | GE1679711 | TGCGAGTCATTTACTTATTGCCCCTCACCT | unassigned; unassigned |
| 165 | 120870 | 50 | GE80820 | CTGCTCCATTGACTTTGACATCACCCAGAA | MASK-4E-BP3 alternate reading frame gene; unassigned |
| 166 | 120870 | 50 | GE82564 | CTATGTCAACGTCCACTAGCTGCCCGATTC | eukaryotic translation initiation factor 4E binding protein 3; EIF4EBP3 |
| 167 | 129276 | 50 | GE1679731 | AGACAGATTTGGAGATTGGCAAGATTACCA | heat shock 70 kDa protein 5 (glucose-regulated protein, 78 kDa); HSPA5 |
| 168 | 147272 | 50 | GE56187 | CTGCCCTTCTTCGTGGTGTCTCTGGTCCTC | 5-hydroxytryptamine (serotonin) receptor 1D; HTR1D |
| 169 | 180028 | 50 | GE54497 | ACCCGACTACTTTGCCTCCTTGGATTTCCT | NADH dehydrogenase (ubiquinone) 1 alpha subcomplex, 7, |
| | | | | | 14.5 kDa; NDUFA7 |
| 170 | 180412 | 50 | GE1679791 | TGGACTTCATGGTTCAGCACACGTCGTTCA | sulfotransferase family, cytosolic, 1A, phenol-preferring, member |
| | | | | | 1; SULT1A1 |
| 171 | 185863 | 50 | GE1680010 | GTCCTCCACTACTGGCTGCTGCTTTGGGAC | patatin-like phospholipase domain containing 5; PNPLA5 |
| 172 | 188209 | 50 | GE81436 | CCCACCTATGTCCATTCCATGTACCAGCTT | cell cycle progression 1; CCPG1 |
| 173 | 207722 | 50 | GE81564 | GATGAGCCCCAGTGTTCTTGCCTCCTACTA | CD96 molecule; CD96 |
| 174 | 264394 | 50 | GE882321 | CGGAGGTCTAGGAAGAGGGTCTGCACAGCA | family with sequence similarity 39, member D pseudogene; FAM39DP |
| 175 | 106225 | 60 | GE1679910 | ATTTGTGAACTCAGCCAAGCACAGTGGTGG | heterogeneous nuclear ribonucleoprotein A1 pseudogene |
| | | | | | 4; HNRPA1P4 |
| 176 | 126773 | 60 | GE1679725 | CGAACACGGCTACTTTCCAGAGATATTTGA | transmembrane protein 77; TMEM77 |
| 177 | 129728 | 60 | GE62827 | TCTCCTGCCCCTTCATTGACAACACCTACT | sulfiredoxin 1 homolog (S. cerevisiae); SRXN1 |
| 178 | 130690 | 60 | GE86527 | TTCCCTCTTCCCCCTTTCTCTCTGTCTCAT | phosphorylase kinase, beta; PHKB |
| 179 | 138873 | 60 | GE83411 | CAAATGCTTTCAGGCTGCTTACCTTACCGT | Hermansky-Pudlak syndrome 3; HPS3 |
| 180 | 141449 | 60 | GE82992 | TCTGTAAGGCTCTGACCTCCAAGACCAACC | DENN/MADD domain containing 2D; DENND2D |
| 181 | 172727 | 60 | GE57860 | GCTTTCCCAACAGCTCCACCTTACTTCTTC | annexin A3; ANXA3 |
| 182 | 232393 | 60 | GE1679444 | TCCCAAGTACTCCCCAAATGCACCCCTTAA | KERATIN, TYPE I CYTOSKELETAL |
| 183 | 234461 | 60 | GE1679860 | CAGGGAAAGCGGTGTTATGACAGGAAGCAG | 60S RIBOSOMAL PROTEIN L44 |
| 184 | 710730 | 60 | GE1680123 | GCAGACTTGGAATCAACCCAAATGCCCATC | hypothetical protein LOC149157; unassigned |
| 185 | 124152 | 70 | GE1679935 | AGTCACAAGCCCCATCCCAGACTCTCCAAC | unassigned; unassigned |
| 186 | 133352 | 70 | GE61614 | TGGAAAACAGTCTACTCAGGTTATGGCAGC | 60S RIBOSOMAL PROTEIN L7A |
| 187 | 140616 | 70 | GE55498 | CCATCGAGACCTATGAGCAGGAGAAAGCAG | dual specificity phosphatase 23; DUSP23 |
| 188 | 153835 | 70 | GE1679978 | CTTGGAGAACTCCGAGGAGTATGCGGCTCG | ubiquitin-conjugating enzyme E2S; UBE2S |
| 189 | 155063 | 70 | GE58103 | TTCCTTTCTCTTTTGTGAATCTTTCCCCCC | phosphoglucomutase 1; PGM1 |
| 190 | 169563 | 70 | GE60133 | TGTCTCCCAATGCCAGCGTATGTCTGTACT | chromosome 16 open reading frame 35; C16orf35 |
| 191 | 197266 | 70 | GE1679809 | CTGTGCTCAACCTCTTCACCAGGATCCGGT | fizzy/cell division cycle 20 related 1 (Drosophila); FZR1 |
| 192 | 198543 | 70 | GE1679406 | TGCTGTACTCCAAGTTTCTGATGCACCCGG | TFII-I REPEAT DOMAIN-CONTAINING PROTEIN |
| 193 | 221081 | 70 | GE54466 | ATTCCTATATGCCGACAGTCAGCCACCTCA | Bernardinelli-Seip congenital lipodystrophy 2 (seipin); BSCL2 |
| 194 | 234727 | 70 | GE1679863 | GTCCCTCACCTCCTCTCCCTGCATCCTCAT | HUMAN UNCHARACTERIZED PROTEIN |
| 195 | 236001 | 70 | GE1680095 | AATTGTTTTCTTGGTGTTATCTTTTCTCAA | unassigned; unassigned |
| 196 | 236583 | 70 | GE1679880 | GGTTGTCCTCATTGATCCATTCCATAAAGC | ribosomal protein L15; RPL15 |
| 197 | 105423 | 80 | GE62273 | GTGGGCCGTATTCATCGACACCTAAAATCT | H2A histone family, member Z; H2AFZ |
| 198 | 112167 | 80 | GE1679919 | GGCGTTTGTTGCCATCAGGGATTACAATGG | 40S RIBOSOMAL PROTEIN S2 |
| 199 | 112734 | 80 | GE55483 | CTGGAAAACGTGTATGAGAGCATCCGGGAG | zinc finger, CCCH-type with G patch domain; ZGPAT |
| 200 | 112734 | 80 | GE83434 | CAAGATGGGCTATGAGTTTGGCAAGGGTTT | zinc finger, CCCH-type with G patch domain; ZGPAT |
| 201 | 112771 | 80 | GE61584 | TTCAGCAGACGCAACTATCATGGACATTCA | FXYD domain containing ion transport regulator 5; FXYD5 |
| 202 | 117844 | 80 | GE1679929 | CGACATTAGCAGGCATAAAAAACATTGACA | chromosome 19 open reading frame 59; C19orf59 |
| 203 | 118417 | 80 | GE78982 | AAACAGCAGATCCAATCCATTCAGCAGTCC | NHP2 non-histone chromosome protein 2-like 1 (S. cerevisiae); NHP2L1 |
| 204 | 120515 | 80 | GE87243 | TTCTTGTGCCCGCATTGGTATTAAATCCTC | copper metabolism (Murr1) domain containing 1; COMMD1 |
| 205 | 127964 | 80 | GE79925 | TGGCGTTTGTCATCAGAATCAGAGGTATCA | ribosomal protein L7; RPL7 |
| 206 | 131247 | 80 | GE1679733 | GCCAAGATGCTGCCCAAGAAGACTGAGAGT | family with sequence similarity 122B; FAM122B |
| 207 | 136206 | 80 | GE57995 | CTCTCACCATCTCCAGTCACCAGCATCTCC | colony stimulating factor 3 receptor (granulocyte); CSF3R |
| 208 | 138517 | 80 | GE1679739 | CGCCCCTGTCTTAATAAAGCTGCGTGTTTC | U2 small nuclear RNA auxiliary factor 1-like 4; U2AF1L4 |
| 209 | 141824 | 80 | GE82249 | TGGCAACATGATTTCAGCTTCTACCTTGAT | coiled-coil domain containing 109B; CCDC109B |
| 210 | 153388 | 80 | GE554996 | CGATCTGGGTTCCGTCCACCTAATTCCAAA | trinucleotide repeat containing 6B; TNRC6B |
| 211 | 153388 | 80 | GE87860 | TTGGTGGCTTTCTTTTCTCTCTTTGATGGG | trinucleotide repeat containing 6B; TNRC6B |
| 212 | 159466 | 80 | GE80146 | TTAGCCTCTCTTAGCCCCTTGTTCTTCCCA | differentially expressed in FDCP 6 homolog (mouse); DEF6 |
| 213 | 159466 | 80 | GE86304 | ACTAGAGGTGAAAGCTCGGCGAGATGAAGA | differentially expressed in FDCP 6 homolog (mouse); DEF6 |
| 214 | 170501 | 80 | GE57786 | GCTGTCCCCTGTCCCTATCTCTCACTCTGG | guanylate kinase 1; GUK1 |
| 215 | 173522 | 80 | GE614054 | CTTGGTCTCACTGTCCTCACCGGCTTCCTC | unassigned; unassigned |
| 216 | 186061 | 80 | GE812881 | GAAAGTGCCCCATGTGCAAGTCAAGGATGT | cleavage stimulation factor, 3′ pre-RNA, subunit 1, 50 kDa; CSTF1 |
| 217 | 188218 | 80 | GE1679799 | GTTCATCAAGCCCACCTTCCCATTCTGCAG | GLUTAREDOXIN, GRX |
| 218 | 198352 | 80 | GE83044 | TGGACCACAAGTTCGACCTGATGTATGCCA | TUBULIN ALPHA CHAIN |
| 219 | 200308 | 80 | GE61684 | GCCTATGGTTTAAGCCTGAAGAACTGGTTG | non-metastatic cells 2, protein (NM23B) expressed in; NME2 |
| 220 | 202673 | 80 | GE54189 | ATTGACAATCGGACTCAGAAAGTGGTTGCC | serine/threonine kinase 24 (STE20 homolog, yeast); STK24 |
| 221 | 208250 | 80 | GE1679823 | TTGTAGATGGAATAGAAGCCCTTGTTGCCG | unassigned; unassigned |
| 222 | 208748 | 80 | GE57283 | CAGCAGAGATGACAGAAGACGAGACACCCA | non-SMC condensin I complex, subunit D2; NCAPD2 |
| 223 | 210081 | 80 | GE1680049 | CTCTCTGGCCATTGAGCATATCCAAATGAA | 60S RIBOSOMAL PROTEIN L17 |
| 224 | 211412 | 80 | GE81006 | GCACACTGAGAATGCTAATGGTTGGGTTGA | Kruppel-like factor 6; KLF6 |
| 225 | 217999 | 80 | GE1679837 | CCCGGTCAAAAGTGGATTGTATATGTCCTC | UNCHARACTERIZED |
| 226 | 229017 | 80 | GE752719 | TCATTAAAGTGCAGCAGGACAGATGGCAGC | KIAA1257; KIAA1257 |
| 227 | 230842 | 80 | GE1679848 | CACGATTTATTCCTCCAGGTCTTTGATTGG | RNA binding motif protein 33; RBM33 |
| 228 | 235151 | 80 | GE1680088 | CTAGCATGGTCGGTGGACCTGGGTGTCTGT | BETA1,4 MANNOSYLTRANSFERASE |
| 229 | 236383 | 80 | GE1680099 | CCCAGCCAGTTAAGCACAAAGAAAAATATT | 60S RIBOSOMAL PROTEIN L12 |
| 230 | 101893 | 90 | GE81166 | CTCTGAACAAGGGTGATGCCAACTCTGAAG | nardilysin (N-arginine dibasic convertase); NRD1 |
| 231 | 103225 | 90 | GE56083 | ACAGCCACTTAACTGGATTTCTTTGGAGCA | fucosidase, alpha-L-2, plasma; FUCA2 |
| 232 | 104059 | 90 | GE55775 | ATCCTGGTGCTGCTTTTGTGGTGGTAGAAT | elaC homolog 2 (E. coli); ELAC2 |
| 233 | 105120 | 90 | GE57712 | GAATAACTTCCAGCCTTACCCCCTACCACA | CDC-like kinase 3; CLK3 |
| 234 | 105172 | 90 | GE504435 | TAGGGATAATTGGCTCACCTCGTTCCACAG | small proline-rich protein 2E; SPRR2E |
| 235 | 105172 | 90 | GE81648 | GCCAGCCAAAGTATCCACCGAAGAGCAAGT | small proline-rich protein 2A; SPRR2A |
| 236 | 106979 | 90 | GE61704 | CCCTGACTGTAAACTGCTGAAGGTCCCTGA | microtubule-associated protein 1 light chain 3 beta; MAP1LC3B |
| 237 | 106979 | 90 | GE79540 | ATGCGTCTGTCCACTTGGCTAACTTTTAAT | microtubule-associated protein 1 light chain 3 beta; MAP1LC3B |
| 238 | 112240 | 90 | GE87744 | GGGCGATGGCTGTCTTTTCTTGACTTTGTA | ribonuclease L (2′,5&apos; -oligoisoadenylate synthetase- |
| | | | | | dependent); RNASEL |
| 239 | 114676 | 90 | GE1679709 | GCCAACAAGCACCAGATCAAACAGGCTGTG | 60S RIBOSOMAL PROTEIN L23A |
| 240 | 116246 | 90 | GE58974 | TTAGTAGACCTGCCCTGTGTTATGGAAAGC | TAF7 RNA polymerase II, TATA box binding protein (TBP)-associated |
| | | | | | factor, 55 kDa; TAF7 |
| 241 | 116549 | 90 | GE57383 | TGCCTCTCTTCTCATTATTGTGTCCTTTGC | mitofusin 2; MFN2 |
| 242 | 116793 | 90 | GE79018 | GGACTGTGACCTGCCATAAAGACTGACCTT | regulator of G-protein signalling 2, 24 kDa; RGS2 |
| 243 | 117096 | 90 | GE58282 | ACCCCCATCCCCTACTGTGACTTGCTTTAG | leukemia inhibitory factor (cholinergic differentiation factor); LIF |
| 244 | 117960 | 90 | GE62915 | TGATACAGCCTTCTTCAGCCAGTTTGCTTT | cytidine monophosphate N-acetylneuraminic acid synthetase; CMAS |
| 245 | 117960 | 90 | GE78951 | GCCTTCCAGAGTGTATGGGTTTCGACAGAC | cytidine monophosphate N-acetylneuraminic acid synthetase; CMAS |
| 246 | 119357 | 90 | GE57889 | ACTGATAGCCACGCTGAAGAATGGAAGGAA | platelet factor 4 (chemokine (C—X—C motif) ligand 4); PF4 |
| 247 | 119357 | 90 | GE57891 | CAGAGCTGAAGCTGAAGAAGATGGGGACCT | platelet factor 4 (chemokine (C—X—C motif) ligand 4); PF4 |
| 248 | 120173 | 90 | GE79992 | TTGTTGTCCTTGGAGCTGTGGTCACTGGAG | major histocompatibility complex, class I, F; HLA-F |
| 249 | 120814 | 90 | GE54503 | GCTGTCTCTCTCTCAACCTCAGATCCCCAA | tektin 2 (testicular); TEKT2 |
| 250 | 121320 | 90 | GE1679934 | GAAAAGCAAAAACTAGGTGTGTCATTGAAA | hypothetical protein LOC54103; unassigned |
| 251 | 121518 | 90 | GE82875 | TTTTCTCCACTTCTTTCTCCCACTCACCCC | chromosome 16 open reading frame 57; C16orf57 |
| 252 | 121803 | 90 | GE58678 | CGGAGATTTTGAGGCTAGGGTGTGTTTCTT | ribosomal protein L26-like 1; RPL26L1 |
| 253 | 123515 | 90 | GE57229 | AAGAAGATGAAAGTTGACCTGAGCCCGAAG | protein disulfide isomerase family A, member 5; PDIA5 |
| 254 | 124957 | 90 | GE58648 | GAGCTAATGTCAAACCCCGAAATTCCACAC | chromosome 8 open reading frame 70; C8orf70 |
| 255 | 125201 | 90 | GE61836 | TCTTCAACATCCTGGCTAAGTTCAATGGCA | ubiquitin specific peptidase 39; USP39 |
| 256 | 127187 | 90 | GE80975 | GTCTGCTGCTATTCTCCGAGCTTCGCAATG | ribosomal protein S25; RPS25 |
| 257 | 127871 | 90 | GE1679940 | GACCCCAAGTTCCCGAGGAACATGTGCTTT | similar to 60S ribosomal protein L29 (Cell surface heparin-binding |
| | | | | | protein HIP); unassigned |
| 258 | 127934 | 90 | GE1679941 | GAGCTGGCCTGCAGCCTTTTTGTGCAAGTG | SERINE PROTEASE INHIBITOR, SERPIN |
| 259 | 128131 | 90 | GE81200 | GTGGACATTCTGGGTATTGTGTGCCAACTG | protein tyrosine phosphatase, non-receptor type 7; PTPN7 |
| 260 | 128174 | 90 | GE61669 | AAGAAGCCAAGAAGAAGAAAGAGGATGCCC | clusterin; CLU |
| 261 | 128174 | 90 | GE79935 | CGATGTATTCTGACCAAGGTGCGACAATCT | ribosomal protein, large, P2; RPLP2 |
| 262 | 128456 | 90 | GE1679942 | TGTAGCAAAGCTTTTAGCCGATCCTCAAAA | 30S/40S RIBOSOMAL PROTEIN S4 |
| 263 | 133818 | 90 | GE1679735 | ATACGTAATTAAGTCCCGGCGCTCCCACTC | transforming growth factor, beta-induced, 68 kDa; TGFBI |
| 264 | 134295 | 90 | GE1679948 | CAACATCAAAGGTGTAATCAGCCTCATTGG | leucine-rich alpha-2-glycoprotein 1; LRG1 |
| 265 | 134910 | 90 | GE81385 | TTTTGCGGAATCTTGTACCCAGGACAGAGT | TRANSLOCASE OF OUTER MEMBRANE SUBUNIT TOM7 |
| 266 | 139445 | 90 | GE57676 | TGGCTCCTTAGACGACAGACTACCTCACGG | cell division cycle 34 homolog (S. cerevisiae); CDC34 |
| 267 | 139760 | 90 | GE1679959 | ATCCTCCCCGACCAGCAGAGGCTCATCTTT | UBIQUITIN |
| 268 | 139869 | 90 | GE1679961 | CCAGATTGTCAATCATGACCAAAAGTTGCT | kelch repeat and BTB (POZ) domain containing 7; KBTBD7 |
| 269 | 142255 | 90 | GE1679747 | CCCACTGGCTTCAAGATGGCATTAATTACT | unassigned; unassigned |
| 270 | 142977 | 90 | GE1679748 | CCCCTCTAGTGCATAATTCAGCATACGATG | unassigned; unassigned |
| 271 | 143723 | 90 | GE1679750 | CCTCCCGTTGGTATCTTCCATCTCATGCGT | hypothetical LOC401093; unassigned |
| 272 | 143967 | 90 | GE1679752 | GCCCAAGGAAGTTAAGCCCAAGATCCCAAA | 60S RIBOSOMAL PROTEIN L29 |
| 273 | 144226 | 90 | GE1679969 | GACCGACAGTTCCAGGAGCTCAACGAGCTG | transmembrane protein 142A; TMEM142A |
| 274 | 146482 | 90 | GE53018 | CTGATCCACGTCCCGCTAGAGACCTTTCTG | SH2B adaptor protein 2; SH2B2 |
| 275 | 147338 | 90 | GE1679754 | CTTTCCAGGTGTCAGCAGGTGTGATCAGGG | family with sequence similarity 128, member B; FAM128B |
| 276 | 147346 | 90 | GE1679971 | GACTGCTGTCTGCCCTCTCTGGTCACCCTG | defensin, alpha 3, neutrophil-specific; DEFA3 |
| 277 | 150159 | 90 | GE59136 | CTTTCTCTTCTTGTTTCTCCTGCCCACTGC | cyclin-dependent kinase inhibitor 2D (p19, inhibits CDK4); CDKN2D |
| 278 | 151419 | 90 | GE56561 | GTTCATCCGTCGTCTCATTCATGCCGAGTT | chromosome 19 open reading frame 25; C19orf25 |
| 279 | 151826 | 90 | GE1679975 | AAATCAGGGCTGCCCAGTGATCGGTTCTCT | T-CELL RECEPTOR BETA CHAIN V REGION |
| 280 | 152585 | 90 | GE470494 | GCTGGTGCGAGACTACCTGGAGCTGGAGAA | hexamthylene bis-acetamide inducible 2; HEXIM2 |
| 281 | 154932 | 90 | GE59880 | CTTCCTTATCCCACCCCAGAGACATCGGCT | granulin; GRN |
| 282 | 154937 | 90 | GE82787 | TGTGTCTGCTTCCTGCCTGTGAAACTCATC | transmembrane protein 38A; TMEM38A |
| 283 | 155553 | 90 | GE61755 | GCCCTGTGTGTCTTGGTTTAGTTATGGTTT | protein phosphatase 1, regulatory (inhibitor) subunit 2; PPP1R2 |
| 284 | 155553 | 90 | GE80089 | CTTGGAGCCAAAGTATCGGATTCAGGAACA | protein phosphatase 1, regulatory (inhibitor) subunit 2; PPP1R2 |
| 285 | 159877 | 90 | GE83678 | AAGGGCAGTTATCTCAACAGACCGATGCTC | leucine rich repeat containing 37B; LRRC37B |
| 286 | 159877 | 90 | GE85266 | CGACACCTACAATGGCATCTTCACCACCTT | leucine rich repeat containing 37B; LRRC37B |
| 287 | 160921 | 90 | GE1679765 | CTGGCTCCACGGGTGAATCTGACTTTTCGT | alkB, alkylation repair homolog 2 (E. coli); ALKBH2 |
| 288 | 161035 | 90 | GE58539 | GGCTTTGGAGAACTTTGAATGCTACCCCCC | egf-like module containing, mucin-like, hormone receptor-like 2; EMR2 |
| 289 | 161406 | 90 | GE81260 | TACAAAACCTGCTTCTCTTCTCAACCGTGG | tumor protein D52-like 2; TPD52L2 |
| 290 | 162153 | 90 | GE61262 | GTTACGGTTTTGTCACGATGTCCACAGCAG | scaffold attachment factor B; SAFB |
| 291 | 162796 | 90 | GE56292 | ATCTCCGTCCTTGTCTTTCCATTCTGCCCT | rhomboid domain containing 3; RHBDD3 |
| 292 | 163084 | 90 | GE55539 | TCCGCCGCATAGTTATAGTGTTGATGTGTG | EGFR-coamplified and overexpressed protein; unassigned |
| 293 | 163194 | 90 | GE62052 | GCACATCACGCAGAAGGACAACTACAGGGT | neutrophil cytosolic factor 4, 40 kDa; NCF4 |
| 294 | 163252 | 90 | GE57965 | CCGCTGCATGTGTATAAAGACAACCTCTGG | pro-platelet basic protein (chemokine (C—X—C motif) ligand 7); PPBP |
| 295 | 164529 | 90 | GE61559 | CTGCCTGTGAATGTCCGAGAACTGAGCCTG | alanyl-tRNA synthetase domain containing 1; AARSD1 |
| 296 | 165825 | 90 | GE56295 | TCCATTTCCCATTTCCTTTTCTTCCCTGAC | O-linked N-acetylglucosamine (GlcNAc) transferase (UDP-N- |
| | | | | | acetylglucosamine:polypeptide-N-acetylglucosaminyl transferase); OGT |
| 297 | 165825 | 90 | GE58305 | CCCCATACCCTCACCCTTAAAATTCTCCTG | O-linked N-acetylglucosamine (GlcNAc) transferase (UDP-N- |
| | | | | | acetylglucosamine:polypeptide-N-acetylglucosaminyl transferase); OGT |
| 298 | 166173 | 90 | GE79938 | TGCCAAAAGTTCCCTCTGTGTTACTCCCAT | major facilitator superfamily domain containing 5; MFSD5 |
| 299 | 167507 | 90 | GE87117 | CTTCTTGCTCCTGTCTGTTTCCCCATCCTG | CKLF-like MARVEL transmembrane domain containing 5; CMTM5 |
| 300 | 167507 | 90 | GE87118 | CAGTCCTGCCCCTGTTCCTCTACTCACATC | CKLF-like MARVEL transmembrane domain containing 5; CMTM5 |
| 301 | 168872 | 90 | GE78965 | TTCGCTTGAACATTCCCTTGATCTCATCAG | bone marrow stromal cell antigen 2; BST2 |
| 302 | 169477 | 90 | GE55895 | TGCTTTCTCTCTGTGGACATGAGGATTGGA | signal transducer and activator of transcription 3 interacting protein |
| | | | | | 1; STATIP1 |
| 303 | 169779 | 90 | GE80676 | ACGGTCCTGGTTCTGCCCTTCTTCTCTTTC | neuropeptides B/W receptor 2; NPBWR2 |
| 304 | 169988 | 90 | GE1679779 | TTGGCTGAAAGGTTTGAAATACGTACCCCA | ubiquitin-conjugating enzyme E2W (putative); UBE2W |
| 305 | 170312 | 90 | GE62288 | TTTCAACGCCTACCACTTCTCCCTCCTGCT | G protein-coupled receptor 68; GPR68 |
| 306 | 170400 | 90 | GE1679780 | TGTTGATGCCTAAGAAGAACCGGATTGCCA | unassigned; unassigned |
| 307 | 170630 | 90 | GE53167 | CCTTTATGTGGGGCTTTCTTCTCTGTTGGA | SLIT-ROBO Rho GTPase activating protein 3; SRGAP3 |
| 308 | 171390 | 90 | GE1679782 | CTTGCACTGAAAATTGTCTCTCCAGCTGTG | MITOCHONDRIAL IMPORT INNER MEMBRANE TRANSLOCASE |
| | | | | | SUBUNIT TIM8 |
| 309 | 172942 | 90 | GE88483 | ATTTGGAGAGAATCTTCGGGCTTCCTGGAG | chromosome 10 open reading frame 33; C10orf33 |
| 310 | 173555 | 90 | GE61331 | CCTTTCCCTTCTGGTTTTGAGAGACTTCCT | high-mobility group nucleosomal binding domain 2; HMGN2 |
| 311 | 173918 | 90 | GE81367 | CTCCCTCTGCTGGTCATCCTCCTGTCTTAC | prolactin releasing hormone receptor; PRLHR |
| 312 | 175144 | 90 | GE79436 | GTGTTACTATGGGTATCCGCCGCTGACCTA | PQ loop repeat containing 3; PQLC3 |
| 313 | 177061 | 90 | GE86520 | CCAATAAAGTACATCCCAGACGCCACACCT | translocase of inner mitochondrial membrane 50 homolog (S. cerevisiae); |
| | | | | | TIMM50 |
| 314 | 177639 | 90 | GE79445 | TCTGGTGCTGAATAAACCCTTCTGATCTGG | glycoprotein Ib (platelet), beta polypeptide; GP1BB |
| 315 | 177981 | 90 | GE56033 | GCTCCCATTTCCCCTTCTTCCTGATAGACT | GTPase, IMAP family member 5; GIMAP5 |
| 316 | 178007 | 90 | GE56285 | TTTCCAGAACAGTGAGGGTTAGGTCTTGGG | ATP synthase, H+ transporting, mitochondrial F0 complex, subunit |
| | | | | | G; ATP5L |
| 317 | 178007 | 90 | GE85997 | ATTTGTCCGTAACCTTGTGGAGAAGACCCC | ATP synthase, H+ transporting, mitochondrial F0 complex, subunit |
| | | | | | G; ATP5L |
| 318 | 178355 | 90 | GE81458 | TGCGGGTTTGAGGATAGGAGTTCACTTCAT | CD8b molecule; CD8B |
| 319 | 178825 | 90 | GE59070 | TCTGGCTTGGGTTAATTCTTCGGTGACACT | N-sulfoglucosamine sulfohydrolase (sulfamidase); SGSH |
| 320 | 180037 | 90 | GE61613 | CCCTGAAACGAATGCTGGAGAAACTTGGAG | allograft inflammatory factor 1; AIF1 |
| 321 | 180184 | 90 | GE53033 | TTGTCTTTCTTTCGTTGATCTCTGGGCTGG | glia maturation factor, gamma; GMFG |
| 322 | 180191 | 90 | GE57555 | GCTGCTGGAGTATTGGATGTTGCTTGATTT | tripartite motif-containing 23; TRIM23 |
| 323 | 180427 | 90 | GE61214 | CTTTTGGTTTCTCGCATTGCCTCTCAGACT | growth hormone inducible transmembrane protein; GHITM |
| 324 | 180941 | 90 | GE86061 | GAAAATACCCAGTGTTGACTCACCAAGGCA | unassigned; unassigned |
| 325 | 180998 | 90 | GE57861 | CCAGCTTTTCCTCCCTTGGGTTCTGATATT | solute carrier family 2 (facilitated glucose transporter), member |
| | | | | | 3; SLC2A3 |
| 326 | 181105 | 90 | GE81329 | TCGCCGTTAGCCTGATCATCTTCACCTACT | dolichyl-phosphate mannosyltransferase polypeptide 2, regulatory |
| | | | | | subunit; DPM2 |
| 327 | 184495 | 90 | GE54584 | GGAGTGTTGAGCAATTTCGGTTTCCTCTGA | tumor necrosis factor (ligand) superfamily, member 14; TNFSF14 |
| 328 | 185825 | 90 | GE58696 | TACCAAGCCTCAACGGGACAGACCATAAAC | hematological and neurological expressed 1; HN1 |
| 329 | 185825 | 90 | GE61558 | CCTCGTCTTGGGTTAGCTCTGACTGTCCTG | similar to hypothetical protein; unassigned |
| 330 | 187070 | 90 | GE79674 | TAGTTGGATGGCACAAGGCTCTTCACAGAC | hypothetical protein LOC201725; unassigned |
| 331 | 187762 | 90 | GE1679798 | GCCAACAAGCACCAGATTAAACAGGCTGTG | 60S RIBOSOMAL PROTEIN L23A |
| 332 | 189240 | 90 | GE80158 | AGGGCGTCAGTGAAAAGCAGTACACCATCT | ring finger protein 1; RING1 |
| 333 | 189793 | 90 | GE60494 | CTGTTTGTGCGTCATAGAACCCAGAAGGAA | ubiquinol-cytochrome c reductase, Rieske iron-sulfur polypeptide |
| | | | | | 1; UQCRFS1 |
| 334 | 189818 | 90 | GE61766 | GTGTGTTCCTGTCATAGTTTGTGTCTCCCA | bromodomain containing 9; BRD9 |
| 335 | 190155 | 90 | GE57038 | AGCCTCTCCATCCAGCATCTTCTCTATCTT | ferrochelatase (protoporphyria); FECH |
| 336 | 190198 | 90 | GE814663 | CGTCTCTGCTTCATCTCCACCACGCTTCAG | interleukin 27; IL27 |
| 337 | 190344 | 90 | GE59055 | AGCCCTCTTGTATAGCATCCCCACTCACCT | golgi apparatus protein 1; GLG1 |
| 338 | 190833 | 90 | GE87151 | TTCTACGGATGACTTGCTGGACTGCTTGGT | HSPB (heat shock 27 kDa) associated protein 1; HSPBAP1 |
| 339 | 191960 | 90 | GE57813 | TGGGGTCCTTCTCCTGTCACTGGTTATCAC | CD8a molecule; CD8A |
| 340 | 191960 | 90 | GE80399 | ATCTCAACCTCTTCCCCGCCCGTTTTACAA | CD8a molecule; CD8A |
| 341 | 192488 | 90 | GE57883 | TTGGGGGTTTTGCTGTTTCCTTTTATGAGA | selectin L (lymphocyte adhesion molecule 1); SELL |
| 342 | 192673 | 90 | GE1680023 | CTTCTGGCCGTAGGTTCCAGGAAAGCTCGT | similar to HESB like domain containing 2; unassigned |
| 343 | 192931 | 90 | GE57513 | GCGTCCACCAAGACCTTAGCATACTGTTGA | small nuclear ribonucleoprotein polypeptide N; SNRPN |
| 344 | 194779 | 90 | GE56650 | CCCTGTAGCCCTCAGTATCTCACTCACCCA | KIAA0913; KIAA0913 |
| 345 | 196141 | 90 | GE80198 | CAGAACCTTGTGAGCTGGACGATGAAGATT | CD14 molecule; CD14 |
| 346 | 196409 | 90 | GE56852 | AAGATCCAGAAGCTGAGCCTCCAGAACTGC | ribonuclease/angiogenin inhibitor 1; RNH1 |
| 347 | 196448 | 90 | GE1679808 | CCCCTCCCCTCTCTGTGAGCCTGTTTCTCT | unassigned; unassigned |
| 348 | 198298 | 90 | GE57765 | GTTCCATCTTTGCCTGTGCCTCATCCTGCT | nuclear factor of activated T-cells, cytoplasmic, calcineurin-dependent |
| | | | | | 3; NFATC3 |
| 349 | 198391 | 90 | GE57580 | TCTTCAAGCCTGTCTTCAACACCTCACTGC | transforming growth factor, beta receptor III (betaglycan, |
| | | | | | 300 kDa); TGFBR3 |
| 350 | 198428 | 90 | GE88068 | CACCCTCCTCCATTTTGCGTCTATTTCTTC | ankyrin repeat domain 13A; ANKRD13A |
| 351 | 199360 | 90 | GE81853 | CGGGACTTAAAGACACTTGACCTGTTTGGG | tyrosine 3-monooxygenase/tryptophan 5-monooxygenase activation |
| | | | | | protein, beta polypeptide; YWHAB |
| 352 | 200004 | 90 | GE58182 | TGTGATTCCCTCCTGCTACTCTGTTCCTTC | signal transducer and activator of transcription 1, 91 kDa; STAT1 |
| 353 | 200160 | 90 | GE79243 | GAAAGGCTCAACGAGAACAAGCTATCAGGG | ribosomal protein L24; RPL24 |
| 354 | 200578 | 90 | GE1679549 | TGAAGAAAGTTGAAATCAGCCAGCAGGCCA | ribosomal protein L37a; RPL37A |
| 355 | 201440 | 90 | GE1679814 | TGCCCCATATTTTACATCCCTCATTCAAGG | unassigned; unassigned |
| 356 | 201912 | 90 | GE81844 | GTATGCGTGACTTGGCTGTGGCTGTCTTTT | DEAH (Asp-Glu-Ala-His) box polypeptide 38; DHX38 |
| 357 | 203098 | 90 | GE53107 | GCTGCCGAAGACAAATGACAGGATTATGAG | BTB and CNC homology 1, basic leucine zipper transcription factor |
| | | | | | 1; BACH1 |
| 358 | 203648 | 90 | GE79094 | GCGTCCAAGTCTGTGAATGTAAAACCCCTC | sorbitol dehydrogenase; SORD |
| 359 | 205686 | 90 | GE54101 | CGGCAGGCACTACTCATCGAGAGGTACTAT | fibroblast growth factor (acidic) intracellular binding protein; FIBP |
| 360 | 206696 | 90 | GE83051 | ATTCCAGGGTCAGACAAGATTCCAGTAGCG | unassigned; unassigned |
| 361 | 207077 | 90 | GE57195 | CTGCCGCAAAGTTCTACAGCTTCTTGGTTC | RAD21 homolog (S. pombe); RAD21 |
| 362 | 207692 | 90 | GE79802 | GTCTTCAGAGATCCCTGCCATGATGTAGCC | tRNA selenocysteine associated protein 1; TRSPAP1 |
| 363 | 208079 | 90 | GE502754 | TCTTGGAAGAGACTCCTGCTGTGATTGTCC | mediator of RNA polymerase II transcription, subunit 28 homolog (S. cerevisiae); |
| | | | | | MED28 |
| 364 | 208310 | 90 | GE62471 | GGTTGTGTCTGTCAAATGTCTGCTGCTTGG | ATG7 autophagy related 7 homolog (S. cerevisiae); ATG7 |
| 365 | 208491 | 90 | GE79078 | AAAATTGCATCTGATGGTCTCAAGGGTCGT | similar to ribosomal protein S3a; unassigned |
| 366 | 211683 | 90 | GE1680051 | TTGCCCGCAAAGTTTTAAAGCTTTCATCCA | hypothetical LOC440248; unassigned |
| 367 | 212354 | 90 | GE60057 | GGAGCAGTTCACAGTGTTGTCCCTCTCAGC | major vault protein; MVP |
| 368 | 212939 | 90 | GE1680053 | TCTGTGCTGGCTGCTCAGAAGATACCGCAT | 60S RIBOSOMAL PROTEIN L19 |
| 369 | 213466 | 90 | GE1679831 | ATTGCTCAATCTCTTGGTAAATATGGCACC | 60S RIBOSOMAL PROTEIN L7 |
| 370 | 217706 | 90 | GE79164 | TGCGTCCCAAGAAGAAGGTCAAATAAGGTG | ubiquitin A-52 residue ribosomal protein fusion product 1; UBA52 |
| 371 | 220179 | 90 | GE1680062 | ATGTGCCCTGGGCATCTCCACCCTCAGTCT | hypothetical protein LOC388931; unassigned |
| 372 | 222023 | 90 | GE56867 | CTGTCTGCTCTTCTCTAATGCTGCGTCCCT | ubiquitin specific peptidase 10; USP10 |
| 373 | 222023 | 90 | GE793817 | GCTGTCTGCTCTTCTCTAATGCTGCATCCC | ubiquitin specific peptidase 10; USP10 |
| 374 | 222435 | 90 | GE508275 | GGTAGGCCAGGTTTCAGCATCGCAGACAAG | ribosomal protein L11; RPL11 |
| 375 | 223755 | 90 | GE499320 | AGATTGTGCTAAGGCTTGAGTGTGTTGAGC | ribosomal protein L36a; RPL36A |
| 376 | 225147 | 90 | GE58701 | GAAATCAGCTCTATTGACGAATTCTGCCGC | vacuolar protein sorting 28 homolog (S. cerevisiae); VPS28 |
| 377 | 230672 | 90 | GE1680068 | CTCCATCTCAGCTTCCCCATGTGGTGCTGT | unassigned; unassigned |
| 378 | 232022 | 90 | GE570749 | CTCCAAGAGAAGCGGAACAAGCAAAACTGC | membrane bound O-acyltransferase domain containing 1; MBOAT1 |
| 379 | 232526 | 90 | GE1679852 | ATTAGACCCACATCCGGCCACCAAGACCTC | RIBOSOMAL PROTEIN L5-RELATED |
| 380 | 233835 | 90 | GE769224 | CCTCTGGTACACCGGCAACATCGAGATCTC | hypothetical gene supported by BC052596; unassigned |
| 381 | 234984 | 90 | GE1680126 | ACATGCCTGTGGTCTCAGCTACTCGGGAGG | unassigned; unassigned |
| 382 | 235306 | 90 | GE547175 | ATTGGGAAAATGAGGTACGTTAGTGTTCGC | SUB1 homolog (S. cerevisiae); SUB1 |
| 383 | 235306 | 90 | GE78961 | TTCAGATTGGGAAAATGAGGTACGTTAGCG | SUB1 homolog (S. cerevisiae); SUB1 |
| 384 | 236152 | 90 | GE1680097 | TGTGATATTTCAATGATGCAATAAAAGACC | 60S RIBOSOMAL PROTEIN L9 |
| 385 | 236473 | 90 | GE1679456 | TGGGCAACAACAGATATCAGAAAACACTTG | GLYCOGENIN-RELATED |
| 386 | 236503 | 90 | GE1679879 | GCAGCTCCATGTAAACCATCCAAAAGACCA | KERATIN, TYPE I CYTOSKELETAL |
| 387 | 236585 | 90 | GE1679881 | GAAGGGAGAAAACTTTGGAGGCAGAAGCTC | HETEROGENEOUS NUCLEAR RIBONUCLEOPROTEIN |
| 388 | 236724 | 90 | GE1680103 | GGTGAGGAAGGCAAGAAAAGCTGGCAACTT | 60S RIBOSOMAL PROTEIN L7 |
| 389 | 236885 | 90 | GE1679883 | TGGTACCTTAGATCACCCCTACAGCCATGC | 60S RIBOSOMAL PROTEIN L27E |
| 390 | 243149 | 90 | GE55702 | AAGACCTCTGGGACTCTATCAAGCATACCA | P40 |
| 391 | 312026 | 90 | GE509887 | TTCTCAAAGGTGAAATTCCTCAGCACAGGG | unassigned; unassigned |
| 392 | 351916 | 90 | GE1679887 | TTCTTAATTGGTTTGCCTGTTCTGCTTCTG | unassigned; unassigned |
| 393 | 697257 | 90 | GE1679996 | CCTGCTGTTGCCACACTCCTCATGGATGTC | opposite strand transcription unit to STAG3; unassigned |
| 394 | 697257 | 90 | GE552858 | GCAGATGCATACATTAACCACAGCCCAGGG | opposite strand transcription unit to STAG3; unassigned |
| 395 | 697295 | 90 | GE1679897 | TGTAACCCCAAATGTGATGTGAGAGGACGA | gb def: Hypothetical protein FLJ20958 |
| 396 | 704151 | 90 | GE1680121 | TCTCCCAATAAAGCTTTACAGCCTTCTGCA | G antigen 6; GAGE6 |
| 397 | 714879 | 90 | GE1680125 | TGGTGTCTAGCACATTCCTCTACCTTATTT | unassigned; unassigned |
| 398 | 101113 | 100 | GE1680131 | AAGGGCCAAGTGATCCCGTTCTAAGTGTCA | similar to large subunit ribosomal protein L36a; unassigned |
| 399 | 101958 | 100 | GE58512 | TTTTCTCCTCCTTCGTTTGTTGGGCTTCAT | solute carrier organic anion transporter family, member 3A1; SLCO3A1 |
| 400 | 102040 | 100 | GE55665 | CGTCTATTCTTTATGCCTTGCCCTAGCCAG | Kruppel-like factor 7 (ubiquitous); KLF7 |
| 401 | 102040 | 100 | GE79042 | CCCCTCCTGTCCTCCTTTGACTGTTTGACT | alanyl (membrane) aminopeptidase (aminopeptidase N, |
| | | | | | aminopeptidase M, microsomal aminopeptidase, CD13, p150); ANPEP |
| 402 | 102558 | 100 | GE57867 | ACAGAAAACAGCAAATAGTCCCCAGCCCTT | DNA directed RNA polymerase II polypeptide J-related |
| | | | | | gene; unassigned |
| 403 | 102604 | 100 | GE1679907 | CAAGGACACCAAGGTACCCAATGCCTGTTT | RPB11b2alpha protein; unassigned |
| 404 | 103589 | 100 | GE87847 | TTTTCGCCCTCCCAGACTTCATCTTCCTGT | chemokine (C—X—C motif) receptor 3; CXCR3 |
| 405 | 104196 | 100 | GE550928 | TCCAACACCTGATCCCCAAGATTGAAGATG | proteasome (prosome, macropain) activator subunit 2 (PA28 |
| | | | | | beta); PSME2 |
| 406 | 104196 | 100 | GE81197 | GCAACCTGGAGAAAATTGTTAACCCAAAGG | proteasome (prosome, macropain) activator subunit 2 (PA28 |
| | | | | | beta); PSME2 |
| 407 | 104280 | 100 | GE87838 | CCACCCACCAGCTCAGAACCTGTCACTAAT | glucocorticoid modulatory element binding protein 2; GMEB2 |
| 408 | 104697 | 100 | GE81329 | TCGCCGTTAGCCTGATCATCTTCACCTACT | dolichyl-phosphate mannosyltransferase polypeptide 2, regulatory |
| | | | | | subunit; DPM2 |
| 409 | 104772 | 100 | GE54314 | CCTTTGGGTTGTGACTTGGGTTGTCTCTGA | target of myb1-like 2 (chicken); TOM1L2 |
| 410 | 104772 | 100 | GE56643 | AACTGCTTCTGTCTGTCCATACCTCCAGGC | target of myb1-like 2 (chicken); TOM1L2 |
| 411 | 105463 | 100 | GE58719 | GTCCTGGCTTTGTGGTGTAGTGCTGTGTGT | calcium binding protein 39; CAB39 |
| 412 | 105497 | 100 | GE62216 | AACTCTCCTGACGCCAAAATCTTCTGCCTG | Ras-related GTP binding A; RRAGA |
| 413 | 105744 | 100 | GE53402 | TTTATGAAGAGGCTTTTCTGTCGTCCCAGG | membrane associated guanylate kinase, WW and PDZ domain |
| | | | | | containing 2; MAGI2 |
| 414 | 106478 | 100 | GE1679911 | TTTCACTCTGCTCTGGTACTATGATCCCAA | unassigned; unassigned |
| 415 | 107457 | 100 | GE81528 | GAAGACAAAGACCCGCAAAAGATGTATGCC | lipocalin 2 (oncogene 24p3); LCN2 |
| 416 | 107457 | 100 | GE88852 | GAACTTCATCCGCTTCTCCAAATCTCTGGG | lipocalin 2 (oncogene 24p3); LCN2 |
| 417 | 107655 | 100 | GE56966 | GCTACTTAGAGACGCCCCAGCCAGAAAAGG | torsin family 3, member A; TOR3A |
| 418 | 108974 | 100 | GE56212 | GCAGGATTAGTCATTGGAAAAGGGGGAGAA | far upstream element (FUSE) binding protein 1; FUBP1 |
| 419 | 108974 | 100 | GE58877 | AATCCTTTGAGTGTATGCCATTGGTGAGCC | far upstream element (FUSE) binding protein 1; FUBP1 |
| 420 | 109712 | 100 | GE1679915 | CGTGAGAGCTCCAGGACTGAAGCCGCAGAG | unassigned; unassigned |
| 421 | 110009 | 100 | GE61231 | AGTTGGTCTTACAGGGTTTGACTGCCGATG | zinc finger, AN1-type domain 5; ZFAND5 |
| 422 | 113059 | 100 | GE58604 | CATTCTCTTCTGTGGTCTCTCCCCTGGCTT | EH-domain containing 3; EHD3 |
| 423 | 113121 | 100 | GE1679922 | TCCCGGGACTTCTGGTACTTCGTATCTCAG | 60S RIBOSOMAL PROTEIN L18A |
| 424 | 113409 | 100 | GE1679708 | TGCTTCTCTCTCTTATGGCTGTGTCCCTGG | UBIQUITIN 1, 2 |
| 425 | 113729 | 100 | GE59671 | GGACTTTGGTGTGAATGAAGACTTGGCTGA | annexin A1; ANXA1 |
| 426 | 115418 | 100 | GE516750 | CTCAAAGGTCCCCGTGTTCACTGTTACCCA | leucine zipper, putative tumor suppressor 2; LZTS2 |
| 427 | 115418 | 100 | GE85662 | TGACCCATTCCTCCTGGCAGAGAGTGATGA | leucine zipper, putative tumor suppressor 2; LZTS2 |
| 428 | 116147 | 100 | GE53393 | CAGCCAACTGTACCACGGAAAACTCTGAAG | CCR4-NOT transcription complex, subunit 3; CNOT3 |
| 429 | 116682 | 100 | GE88496 | TGGTGGCATTATCCTTTCAAAATCTCAGGG | chromosome 10 open reading frame 104; C10orf104 |
| 430 | 116953 | 100 | GE1679926 | TTCAACTAAGCTCCAGGCTGCTCCACCCAA | 60S RIBOSOMAL PROTEIN L21 |
| 431 | 117219 | 100 | GE81429 | TGTGGAGATTGGAGTGGCTGACAAGATTTT | N-myc (and STAT) interactor; NMI |
| 432 | 117300 | 100 | GE81339 | ATGTCTCCTTTGGACCTCATGCCGGAAAAT | ribosomal protein L14; RPL14 |
| 433 | 117625 | 100 | GE56023 | GCCCTTGGATGAATGTGAGGAACTTTATCG | patatin-like phospholipase domain containing 8; PNPLA8 |
| 434 | 117790 | 100 | GE55401 | CCACAACCCCACCATAGCACTAAGAGGAAA | chromosome 9 open reading frame 156; C9orf156 |
| 435 | 119015 | 100 | GE1679714 | CAGCTCACTGGAACTTTTCATCTGCTTGGC | unassigned; unassigned |
| 436 | 120117 | 100 | GE1679932 | CAGAATGGCTATGATGGGCAAACTAAGCCG | 60S RIBOSOMAL PROTEIN L44 |
| 437 | 120662 | 100 | GE63281 | CTGCTGCTGTGGTTGGTGTTAAGTCTCCTG | T-cell leukemia translocation altered gene; TCTA |
| 438 | 122309 | 100 | GE59482 | CAACCCCATCCTCACACAGATTCACCTTTT | proline dehydrogenase (oxidase) 1; PRODH |
| 439 | 124424 | 100 | GE53070 | TTCTCTGGGGCTTTATTTTCGTTTTGTTGG | jumonji domain containing 3; JMJD3 |
| 440 | 124706 | 100 | GE57871 | ATCTTGATCCGTCCCATGTATTCCAACCCT | glutamic-oxaloacetic transaminase 2, mitochondrial (aspartate |
| | | | | | aminotransferase 2); GOT2 |
| 441 | 125410 | 100 | GE1679722 | GGCTGGTCCTCCTATCGTTCACAGAAAATG | similar to RIKEN cDNA 4732495G21 gene; unassigned |
| 442 | 126331 | 100 | GE1679662 | TCCAACAATCAAAGCTAGACGTAGCAGGAG | chromosome 6 open reading frame 111; C6orf111 |
| 443 | 130995 | 100 | GE60096 | GGTGATGAATCTGCTGCTGGAAGGAGAAGT | HISTONE H2A |
| 444 | 132276 | 100 | GE82621 | TGACGAATTTCAGCACTGTTGGAGCAAGTT | 60S RIBOSOMAL PROTEIN L6 |
| 445 | 132679 | 100 | GE1679661 | TCAAAGCTATTCCTCAGCTCCAGGGCTAGC | TRK-fused gene; TFG |
| 446 | 133906 | 100 | GE61621 | GCCCTGAGAGACCTGCTGAACAACCACATC | adult retina protein; unassigned |
| 447 | 134602 | 100 | GE62231 | GCTGCCTTTCTCTGACTCTGTCTTCCCCAA | cathelicidin antimicrobial peptide; CAMP |
| 448 | 135209 | 100 | GE1679949 | CAGATGAACCTGTAGCAGAGTGGAACTTGT | FAMILY NOT NAMED |
| 449 | 135636 | 100 | GE1679327 | CAGCCATAGTCAATCCCACGGTGTTCTTCA | anaphase promoting complex subunit 1; ANAPC1 |
| 450 | 135833 | 100 | GE80972 | CCTACTGAAGATGTGCCTCGAAAGCTGTTG | ribosomal protein L6; RPL6 |
| 451 | 135977 | 100 | GE1679952 | CCAGAAAAGCACCTGCTGCTAAAGTCCCAG | 60S RIBOSOMAL PROTEIN L14 |
| 452 | 136743 | 100 | GE55134 | CCCAACCTTTATTCCCAGCCTTACTCTTCT | nuclear receptor coactivator 1; NCOA1 |
| 453 | 136743 | 100 | GE85573 | TATCTGGATGAAGGCTTTTGGAGGAGAACC | nuclear receptor coactivator 1; NCOA1 |
| 454 | 136898 | 100 | GE62119 | AAAACAACTCAAGCATTCTGGTGGCAACAT | hippocampus abundant transcript-like 1; HIATL1 |
| 455 | 137330 | 100 | GE1679955 | AGAGTTAACCCCTTATCTGTAAGTTTTGAA | unassigned; unassigned |
| 456 | 138471 | 100 | GE1679738 | TGCTGGCCTACTTCATCACCTGGGTCTCCT | taste receptor, type 1, member 3; TAS1R3 |
| 457 | 138834 | 100 | GE1679958 | CGACAGATGTGGCACCGATCTTTAGCCAGA | 60S RIBOSOMAL PROTEIN L12 |
| 458 | 138851 | 100 | GE81936 | CTCACCTGCCATCCACCTTCAACTACAACC | CCR4-NOT transcription complex, subunit 2; CNOT2 |
| 459 | 139305 | 100 | GE61445 | TTTGGTCCCGACAAGATGACATAGATTTGC | telomeric repeat binding factor 2, interacting protein; TERF2IP |
| 460 | 141286 | 100 | GE1679964 | GATGGCCGCCACCCTCATGACATCATAGAT | 60S RIBOSOMAL PROTEIN L12 |
| 461 | 141595 | 100 | GE82952 | CCCATCTCTGTCTAGCAAGCAGCCTCCTAA | triggering receptor expressed on myeloid cells-like 2; TREML2 |
| 462 | 141639 | 100 | GE795066 | AGTTCCCAGCTATCTCCCCTGCTCCTCTGC | keratin 16 (focal non-epidermolytic palmoplantar keratoderma); KRT16 |
| 463 | 142046 | 100 | GE1679746 | GCCCTCCCCTCACTGGAATTCTTCTTGCTC | unassigned; unassigned |
| 464 | 142242 | 100 | GE484425 | AGTGCAGAAGTTGGGCAGAAAGGGAGGAGG | G protein-coupled receptor 45; GPR45 |
| 465 | 142562 | 100 | GE60068 | AAATCACCACTCTTCAGCCCCATCCCACTC | tripartite motif-containing 31; TRIM31 |
| 466 | 143113 | 100 | GE57710 | GCTGGATTTGTTTGTTTTCTTGTCTGTGTG | spleen tyrosine kinase; SYK |
| 467 | 143169 | 100 | GE79571 | ATCATCCTGGAGAGCATTCCCACTGACAAC | mitogen-activated protein kinase kinase kinase kinase 2; MAP4K2 |
| 468 | 143546 | 100 | GE79075 | TTGTCTCCTACTCCTGACTCCTACCTGCCC | chromogranin A (parathyroid secretory protein 1); CHGA |
| 469 | 143873 | 100 | GE1679968 | AGGCTTGGGTGCGTTCAAGATTCAGCTTCA | mitochondrial ribosomal protein L50; MRPL50 |
| 470 | 144379 | 100 | GE56595 | GACCTGCCATTTCTCCACTCCCTACAGACA | F-box protein, helicase, 18; FBXO18 |
| 471 | 145493 | 100 | GE1679970 | CCTCAGCTTTTGCACACCTCCAATATATTG | unassigned; unassigned |
| 472 | 146599 | 100 | GE55329 | CACAGTTTTGGGTTCAGGCTATGCTGCTTT | PC2 (positive cofactor 2, multiprotein complex) glutamine/Q-rich- |
| | | | | | associated protein; PCQAP |
| 473 | 147612 | 100 | GE56714 | TTCTGGATTTGTTTGGTTTGGTTTGGTTCC | exocyst complex component 6; EXOC6 |
| 474 | 148241 | 100 | GE62236 | TGTTAGGAGCAGGGTTGTGTGTTGGATTTG | methyltransferase like 5; METTL5 |
| 475 | 148692 | 100 | GE1679973 | ACACCGAGCGACATCAACTCCCCTCGACAC | kazrin; unassigned |
| 476 | 149705 | 100 | GE62976 | ACGATGCCAAGATGACTCCTGAGGACTACG | NmrA-like family domain containing 1; NMRAL1 |
| 477 | 150896 | 100 | GE61210 | TCGCTTACAAAACTCACACTCTCACAATGC | hematological and neurological expressed 1-like; HN1L |
| 478 | 150896 | 100 | GE79753 | CTACCCCTTTGTCAACTGCTGTGAATGCTG | TAR DNA binding protein; TARDBP |
| 479 | 151778 | 100 | GE79181 | CAGGGCTATGACACAGAGGTAGACGAGGCT | transporter 1, ATP-binding cassette, sub-family B (MDR/TAP); TAP1 |
| 480 | 151867 | 100 | GE58118 | CGCTACCACTTCCTGATCCTCCTCTTCTCC | structure specific recognition protein 1; SSRP1 |
| 481 | 152539 | 100 | GE57790 | CATTACCGTCTGTGATTGCCATTTCTTCCC | presenilin 1 (Alzheimer disease 3); PSEN1 |
| 482 | 153516 | 100 | GE62769 | GGTCCATCAGGTTACCCCACAGACACACTT | chromosome 1 open reading frame 128; C1orf128 |
| 483 | 155096 | 100 | GE1679979 | GTCGGCTCGGGCTGAAAAAGTTTCTCCATG | unassigned; unassigned |
| 484 | 155386 | 100 | GE1679980 | TGCAGTAGAGGTACTCTTCTGTCCCTTCCG | unassigned; unassigned |
| 485 | 156493 | 100 | GE53118 | CATTCGGGAGTTCCTGGACCAGTACGATGC | suppressor of cytokine signaling 3; SOCS3 |
| 486 | 156497 | 100 | GE57776 | CTCGGAAGACAAACCCCACACACACTCAAG | ralA binding protein 1; RALBP1 |
| 487 | 157702 | 100 | GE60222 | ACTCTCAAAATTCAGGATGCCTCAGCCCTC | NADH dehydrogenase (ubiquinone) flavoprotein 3, 10 kDa; NDUFV3 |
| 488 | 158787 | 100 | GE56752 | TACCATAAAGAGACGGGTTTGAGGGTTTGC | family with sequence similarity 129, member A; FAM129A |
| 489 | 158846 | 100 | GE54051 | TGCTCAACCAGGATTTCACTCTTCAAAGCC | G protein-coupled receptor 171; GPR171 |
| 490 | 160035 | 100 | GE55059 | GACTCTGGACCCTCGTGTCTTTCTTTAGGA | polymerase (RNA) III (DNA directed) polypeptide G (32 kD)- |
| | | | | | like; POLR3GL |
| 491 | 160844 | 100 | GE59146 | GCTCCACTTTGAGGCTCTGATGAACATTCC | deoxyguanosine kinase; DGUOK |
| 492 | 161046 | 100 | GE86328 | ATGGTAGTAGAGAAGCACCGTGAGTCCCGA | wingless-type MMTV integration site family, member 3; WNT3 |
| 493 | 161271 | 100 | GE79844 | GGATACATCTCGCCATTACCTGCCACTCTC | hexosaminidase A (alpha polypeptide); HEXA |
| 494 | 164041 | 100 | GE1679771 | CCTGCGAGACTCACAAGATGGGAAGCTGAC | ribosomal protein S10; RPS10 |
| 495 | 164302 | 100 | GE1679990 | CGTCCGGTCAATAAAATCCGCCTGACTCCT | neuropeptide W; NPW |
| 496 | 164721 | 100 | GE53423 | AGTGAAGCACCCCTTTATTGTGGAACTGGC | ribosomal protein S6 kinase, 70 kDa, polypeptide 2; RPS6KB2 |
| 497 | 165071 | 100 | GE1679991 | CATGAGGTTCTGCCCGTTTGCTGAGAGGAC | GLUTATHIONE-S-TRANSFERASE OMEGA |
| 498 | 165502 | 100 | GE85497 | AGGGTGGAGAACGTGGACCTGACCTCTGTG | transmembrane and coiled-coil domains 4; TMCO4 |
| 499 | 165502 | 100 | GE85498 | TCTTCCCCAGTCTCCATATGCAGCTCTCTC | transmembrane and coiled-coil domains 4; TMCO4 |
| 500 | 166975 | 100 | GE62378 | ACAGCATCATCAAGGACTTCACCAAGCAGA | MCM5 minichromosome maintenance deficient 5, cell division cycle 46 |
| | | | | | (S. cerevisiae); MCM5 |
| 501 | 167003 | 100 | GE58129 | CAAGTCCAGATCCGCACGAAGGTCCAAGTC | splicing factor, arginine/serine-rich 2; SFRS2 |
| 502 | 167575 | 100 | GE53976 | AGCATCTTCCCATTTCCTCAGTACCCACAA | ABI gene family, member 3; ABI3 |
| 503 | 167868 | 100 | GE57090 | CAATGCCCTAAGCCCCAAGGAGTTCTATGA | MAD2L1 binding protein; MAD2L1BP |
| 504 | 168086 | 100 | GE56456 | CCCTTCCACCCCTCCAGTTAGTCCCTATCT | TBC1 domain family, member 10B; TBC1D10B |
| 505 | 169781 | 100 | GE62815 | GCAAGAGATCAACAAGAAGCTGAACACCCA | nuclear receptor co-repressor 2; NCOR2 |
| 506 | 170047 | 100 | GE85992 | CCCCACACACCGATTTCTGAGTAGCGATAG | 40S RIBOSOMAL PROTEIN S10 |
| 507 | 170102 | 100 | GE57796 | TGACTGGATGTTCTCAGCCCCTTGTTCTGG | phosphomevalonate kinase; PMVK |
| 508 | 170472 | 100 | GE1679993 | GTGATGAAGCCCCAGGAGTCGGGAAGCAGT | ELONGIN B |
| 509 | 171075 | 100 | GE1679781 | GTGGTGGAAGAGTTGAAGAAGTACCTGTCG | chromosome 11 open reading frame 31; C11orf31 |
| 510 | 171160 | 100 | GE81109 | ACCATTGTCTTGTTCTGTGATGAGGGGAGG | guanine nucleotide binding protein (G protein), alpha inhibiting activity |
| | | | | | polypeptide 2; GNAI2 |
| 511 | 171339 | 100 | GE1680129 | AAAAGCCCATTAACGAGAAAGTGCCTGCCC | ataxin 7-like 2; ATXN7L2 |
| 512 | 171710 | 100 | GE1680134 | CAGAGAGATCAACAAGCAACCCACCCGAGG | ADP-ribosylation-like factor 6 interacting protein 4; ARL6IP4 |
| 513 | 174250 | 100 | GE80737 | CCACAACTACATGGTGTTCGGATCTTTGGA | ORM1-like 1 (S. cerevisiae); ORMDL1 |
| 514 | 175122 | 100 | GE505003 | TGGACCACAAGTTCGACCTGATGTATGCCA | alpha tubulin; unassigned |
| 515 | 175282 | 100 | GE1679784 | TCAACAAGGCTTCCACTAACATGCTGAGGA | 60S RIBOSOMAL PROTEIN L7 |
| 516 | 175938 | 100 | GE55276 | CCATTTGTCAGGGTTGTGTCTCCAGTCCTC | ubiquitin-conjugating enzyme E2Q (putative) 1; UBE2Q1 |
| 517 | 175969 | 100 | GE60404 | GAAGCCTCGGACTACATTCCTGACGACCAC | phospholipase C, beta 3 (phosphatidylinositol-specific); PLCB3 |
| 518 | 178191 | 100 | GE81605 | CACATCTGAAGACCTGCTATCCCCTGGAGT | nuclear mitotic apparatus protein 1; NUMA1 |
| 519 | 178227 | 100 | GE1679787 | CGCCTGCTCCAAAAGTTCAGAGGACTCAAA | 60S RIBOSOMAL PROTEIN L14 |
| 520 | 179141 | 100 | GE53885 | GCTCTAACCAGGCTCATTTGCTCTCTCCAC | skeletal muscle and kidney enriched inositol phosphatase; unassigned |
| 521 | 179857 | 100 | GE1680003 | TTGGATCATTTAGATCTCTTGCATCCTTTG | similar to HESB like domain containing 2; unassigned |
| 522 | 180577 | 100 | GE55739 | AGAAGTATGAGGAAAAGGAGAAGACGGGGC | bridging integrator 3; BIN3 |
| 523 | 181086 | 100 | GE62366 | ATTCAGCACTGTGTTCCTGTTGTCGTGGTT | histidine ammonia-lyase; HAL |
| 524 | 181993 | 100 | GE55819 | AGATGCTCCCCTTGTGCCAGATGATACCTC | pleckstrin homology domain containing, family G (with RhoGef domain) |
| | | | | | member 6; PLEKHG6 |
| 525 | 182070 | 100 | GE61402 | TATCCAGTGGCACTTGTAATGGCGTCTTCA | signal transducer and activator of transcription 3 (acute-phase response |
| | | | | | factor); STAT3 |
| 526 | 182204 | 100 | GE1680005 | GATTGGTCTCTGGCCCAGCCCAGTCTCTTC | ADP-ribosylation-like factor 6 interacting protein 4; ARL6IP4 |
| 527 | 182573 | 100 | GE55336 | GTTGTCCTTTCTGGCTTCCCTGATGGTGTC | cyclin M3; CNNM3 |
| 528 | 182667 | 100 | GE1679793 | GTCTGTGGATGCAACTGTTAATGAAGATGG | unassigned; unassigned |
| 529 | 184157 | 100 | GE54233 | TTGCTATCAATACCCTTGTCCTCCTGGTCC | solute carrier family 22 (organic cation transporter), member |
| | | | | | 18; SLC22A18 |
| 530 | 184933 | 100 | GE61166 | TGCTGGGGATGACTTTGACTTAGGAGATGC | CD99 molecule; CD99 |
| 531 | 186362 | 100 | GE1680011 | TGGCAAGGCCTTTAAGCGCTCCTCTATCCT | translocase of outer mitochondrial membrane 7 homolog |
| | | | | | (yeast); TOMM7 |
| 532 | 187824 | 100 | GE1680013 | GTTCTCCTTGGGTGACCCCCATGATGCCTG | unassigned; unassigned |
| 533 | 190174 | 100 | GE60445 | ATTTCGCTCCCTCCATTGTCTGCTCTATCC | MFNG O-fucosylpeptide 3-beta-N- |
| | | | | | acetylglucosaminyltransferase; MFNG |
| 534 | 190338 | 100 | GE1679802 | GCCAAGTTCCTTTGTTCAGTATTCCGTGGG | TUBULIN ALPHA-1 CHAIN |
| 535 | 190885 | 100 | GE1680019 | ACAAGATGGACAGGGATGATAATTGGGCCT | UBIQUITIN-CONJUGATING ENZYME |
| 536 | 191530 | 100 | GE62888 | GCTATGGTTGACTTCTTGCTTGTGCTTCCC | v-ral simian leukemia viral oncogene homolog B (ras related; GTP |
| | | | | | binding protein); RALB |
| 537 | 192464 | 100 | GE1680021 | TGGTGGGCAAACCAAGCTGATTTTCCAGAA | 60S RIBOSOMAL PROTEIN L44 |
| 538 | 193007 | 100 | GE526095 | TCACTATCTGAAGGGTCACGGAGCGCAAAA | SNRPN upstream reading frame; SNURF |
| 539 | 193821 | 100 | GE63385 | TGGGGTCATCTTACTCTTGCTGATTGGACA | mitochondrial ribosomal protein L53; MRPL53 |
| 540 | 193821 | 100 | GE79679 | CTTCCCTCCCACCCTGTCTCCTGTCTCCAT | parvin, gamma; PARVG |
| 541 | 194416 | 100 | GE55866 | TCCGCAACGACTACTATCCTGACCTCCACA | arginyl aminopeptidase (aminopeptidase B)-like 1; RNPEPL1 |
| 542 | 195881 | 100 | GE1680027 | CTTCCCAGCATCTTTGGCTGCACAGCATTT | coiled-coil domain containing 67; CCDC67 |
| 543 | 196577 | 100 | GE57849 | TATGCCTACTTGCTCCAGCCCTCTCAGTTC | complement component 8, beta polypeptide; C8B |
| 544 | 197007 | 100 | GE1680028 | TGCTGTCTCTGCTTTTTGCATCTTGCCCAG | unassigned; unassigned |
| 545 | 197267 | 100 | GE79837 | ATCGGGCTACTACAAAGTTCTGGGAAAGGG | ribosomal protein L27a; RPL27A |
| 546 | 197857 | 100 | GE53875 | AGACTCGTGCCCCCATTAGTGTGCCTCTTT | cisplatin resistance-associated overexpressed protein; unassigned |
| 547 | 197857 | 100 | GE82124 | ACAGGAGCAAAAGTCGGGACAGAGAACAAG | cisplatin resistance-associated overexpressed protein; unassigned |
| 548 | 199121 | 100 | GE80875 | TCCGCTACCTGACCTTCTTCCACAACTACA | mucolipin 1; MCOLN1 |
| 549 | 199912 | 100 | GE1680031 | TGCTTGACCGTTTGGGACATCAATCTTCCA | leucine-rich repeat kinase 2; LRRK2 |
| 550 | 200120 | 100 | GE62136 | TTTTCCACCCGTCTTTGGTATGTATTGGCT | acyl-Coenzyme A binding domain containing 6; ACBD6 |
| 551 | 200572 | 100 | GE502202 | AGGTTTGGGCTTCTGTTCCTTTCACTTGCA | NM23-LV; unassigned |
| 552 | 201125 | 100 | GE55283 | GTCTCACAGCAAGATTCACAAGCGATCCGA | replication initiator 1; REPIN1 |
| 553 | 201923 | 100 | GE1679513 | CCAGAACCCTGCTGATGAGCCCACTCTAGG | GOLGI AUTOANTIGEN, GOLGIN SUBFAMILY A MEMBER 2 |
| 554 | 202737 | 100 | GE502632 | GGCGCTGAACAAGAAATCCAAACAGATCGG | agouti signaling protein, nonagouti homolog (mouse); ASIP |
| 555 | 203664 | 100 | GE624182 | CCTGGTGAAGATGTGGATGATAATGGTGCC | hypothetical protein LOC146909; unassigned |
| 556 | 205151 | 100 | GE1679817 | TGCGGGACTCACTGGATAGATGTTATTCAA | UNCHARACTERIZED |
| 557 | 205981 | 100 | GE60062 | CAGGAATCTGCCACTTCTTTTATGACAGCG | phosphorylase kinase, alpha 2 (liver); PHKA2 |
| 558 | 206400 | 100 | GE1679818 | CGCCTTTGGACCTCATGCTGGAAAATTCAT | 60S RIBOSOMAL PROTEIN L14 |
| 559 | 206536 | 100 | GE1679819 | GGAGAGCCTCATTTTCCACTTAACGCAATT | ARP2/3 COMPLEX 21 KD SUBUNIT |
| 560 | 206815 | 100 | GE1680144 | CCGCCCTAGAACTTTTGCCAGTGCCTTTTC | hypothetical protein MGC10812; MGC10812 |
| 561 | 206925 | 100 | GE61819 | TATTGCTTGCCTCCTGCCTGTTCACAAATC | WD repeat domain 59; WDR59 |
| 562 | 207178 | 100 | GE57551 | ACTGAAAAGAAAGCGTTGCCCTGGTGATTC | chromosome X and Y open reading frame 3; CXYorf3 |
| 563 | 207943 | 100 | GE79030 | CTACAGACAAGGTGGAGCGAATCAAGGAGC | neural precursor cell expressed, developmentally down-regulated |
| | | | | | 8; NEDD8 |
| 564 | 208270 | 100 | GE1680046 | GCTGGAGCAGCCGATGCAGCTGTACAGTGC | similar to 40S ribosomal protein S15 (RIG protein); unassigned |
| 565 | 208343 | 100 | GE58786 | GGACAGCAGCAAAGCTATAATCCCCCTCAG | fusion (involved in t(12; 16) in malignant liposarcoma); FUS |
| 566 | 208343 | 100 | GE85981 | AGAGTTTTCCTGTTCAGATTACCCTGCCCA | ribosomal protein S3A; RPS3A |
| 567 | 208774 | 100 | GE1680047 | TGCCAGAAACCCTTAAGAAAAAGCAAAGGA | unassigned; unassigned |
| 568 | 210798 | 100 | GE57570 | CTCTGACTGGCTGGATTCTACACTTGGCTG | cysteinyl-tRNA synthetase; CARS |
| 569 | 211100 | 100 | GE61602 | TATTGGAAAGAAGACTCCCATCGCAGTTCG | catalase; CAT |
| 570 | 211120 | 100 | GE1679827 | GAGACGAAACTCATCTGCCTCTGTCCCTCT | hypothetical protein LOC284701; unassigned |
| 571 | 211400 | 100 | GE1679628 | TACTGAGGCCTTCATAGCCACTGCACCCCA | hypothetical gene supported by AK024248; AL137733; unassigned |
| 572 | 211521 | 100 | GE1679828 | TCTGTCAGGTGCACAAGATTACCCTCCTTT | unassigned; unassigned |
| 573 | 215225 | 100 | GE79973 | TGCTCCAAAACTCCCTCTGCTGATACTCCT | KIAA0317; KIAA0317 |
| 574 | 215483 | 100 | GE56754 | AGTCACAGCCATCCTCATAATACACAAGCG | hippocampus abundant transcript 1; HIAT1 |
| 575 | 215770 | 100 | GE58957 | TCTCCCATTTAGCCTTAACCCCCTCTTACG | major histocompatibility complex, class II, DM beta; HLA-DMB |
| 576 | 215830 | 100 | GE82328 | GCCTAAGTTCCTCCTGTTTTCTGCTGTTTG | transmembrane protein 30A; TMEM30A |
| 577 | 216357 | 100 | GE61208 | GTGGCGGTGGTTAGGAGATCAGACACTAGC | lactotransferrin; LTF |
| 578 | 216775 | 100 | GE58145 | TGACCGTAATTCTTGACTTCAGGCTCCTCC | tumor necrosis factor, alpha-induced protein 2; TNFAIP2 |
| 579 | 217900 | 100 | GE79080 | GGCTGAATCTTCTCCATTTGTTGAGCGACT | heat shock protein 90 kDa beta (Grp94), member 1; HSP90B1 |
| 580 | 218581 | 100 | GE53658 | GCCCTATAATTTCAAAGCCCAAACCCAAAG | heat shock 70 kDa protein 4; HSPA4 |
| 581 | 218636 | 100 | GE1679652 | CGCCAGGAAGGTGAGATCTTCGACACAGAA | ribosomal protein L6; RPL6 |
| 582 | 218954 | 100 | GE1680061 | AGCCGCTCCACTTTCTCCACATAGGCCTGT | angiomotin like 2; AMOTL2 |
| 583 | 220348 | 100 | GE59234 | CGCACCCACCCTGTTCTCTACCTCTTCTAT | sulfotransferase family, cytosolic, 1A, phenol-preferring, member |
| | | | | | 3; SULT1A3 |
| 584 | 221030 | 100 | GE1680063 | CCCCACCATTCTACAGAGTTGTACTCAAGA | kelch domain containing 1; KLHDC1 |
| 585 | 221158 | 100 | GE550672 | CCTCAAGTCTCTCTCCCTCTGCTCCTGCCA | F-box and leucine-rich repeat protein 14; FBXL14 |
| 586 | 225189 | 100 | GE86830 | CCTGTGATGACCAATACTGCTGCTCTGACG | scotin; unassigned |
| 587 | 229944 | 100 | GE1680146 | GGATTCCAATGGAGATTTTGAGGGACTGAC | EH-domain containing 2; EHD2 |
| 588 | 230838 | 100 | GE1680069 | CGGCGGAGAGCCGAGTGATGAATAAATGAG | unassigned; unassigned |
| 589 | 232377 | 100 | GE1679850 | GACCACCCTCATTTCCCAGCTTCCTCGAAG | unassigned; unassigned |
| 590 | 233218 | 100 | GE1680080 | TGGGTTTAGGAAGGATTTCTCTAACACTGA | unassigned; unassigned |
| 591 | 234288 | 100 | GE1679627 | GTTCGTTCTGCTCTGGAGACCCCTGGGTTG | PLECKSTRIN HOMOLOGY DOMAIN CONTAINING PROTEIN |
| 592 | 234297 | 100 | GE1679854 | TATCAGGCTTCTTCACCTCGCACTGTCCCC | unassigned; unassigned |
| 593 | 234359 | 100 | GE1679856 | TTTGTTCACACAGTCTCTCCAGCTCCCGCA | unassigned; unassigned |
| 594 | 234458 | 100 | GE1679859 | TGGGAGGAGATAAGAAGAGAAAGGGCCAAG | 60S RIBOSOMAL PROTEIN L44 |
| 595 | 234758 | 100 | GE1680137 | CACCCTGGGTAGTCGTGGACAGAAGCTTGG | hypothetical protein LOC284454; LOC284454 |
| 596 | 235017 | 100 | GE1680087 | CTCCTCTCCCTCCCACTGCACACTCCCACT | unassigned; unassigned |
| 597 | 235396 | 100 | GE1679869 | GCCCACTATGCACACATCTTCCCCTCCAAG | CAPICUA PROTEIN |
| 598 | 236102 | 100 | GE1679873 | GCCTTTTGTCTGTACATACTGGCCTCCGTG | 60S RIBOSOMAL PROTEIN L19 |
| 599 | 236952 | 100 | GE1679884 | TGGAAGGAGATAAGAGAAAGGGCCAAGTGA | 60S RIBOSOMAL PROTEIN L44 |
| 600 | 237069 | 100 | GE1680107 | ACCACCTCCACCCTGGAAGAGTTCCCCTTC | CLAUDIN-4 |
| 601 | 240102 | 100 | GE1680108 | TATCTCCTATTCTGGATTAGTGCCTTTTGG | homeobox containing 1; HMBOX1 |
| 602 | 264288 | 100 | GE588951 | CCCATACTCTCCCTTATCCCCATACCCAGA | c-mer proto-oncogene tyrosine kinase; MERTK |
| 603 | 343450 | 100 | GE87544 | CTTCCCCCAGTATCGCACATGGTTCTAGTT | small nuclear ribonucleoprotein polypeptide E; SNRPE |
| 604 | 423075 | 100 | GE1679889 | TTACCCGCATCCTTGTGTCACCAGGTCCTC | unassigned; unassigned |
| 605 | 466085 | 100 | GE1679890 | GGACTCACACTGGATAGAAACCAAAGCAGG | zinc finger protein 763; ZNF763 |
| 606 | 510396 | 100 | GE1680114 | GCAGAGGTGCTCCTCACTTGCCACACAGGG | HEPATOCELLULAR CARCINOMA-ASSOCIATED ANTIGEN- |
| | | | | | RELATED |
| 607 | 552912 | 100 | GE537394 | AGCAGGACTGAACTTCAACTCACGCCTTTG | SODIUM/HYDROGEN EXCHANGER 7, 9 |
| 608 | 660069 | 100 | GE56987 | GCCTCCTAGAGCCTCTGGTAAGACTTCTGG | unassigned; unassigned |
| 609 | 700108 | 100 | GE54641 | CTCACCTGTTGTCACTCCCTCCTGCTCCCT | unassigned; unassigned |
| 610 | 710021 | 100 | GE1679905 | GGGTCCTGTCTGCTCTGTGAGTCCCTCCAA | poly (ADP-ribose) polymerase family, member 9; PARP9 |
| 611 | 710141 | 100 | GE1680122 | CGTGCAGAGCAAAAAGAGCTTCCTATGGGA | disrupted in schizophrenia 1; DISC1 |

### Table 8: Probe Validation by Real Time Quantitative PCR (Taqman) (Study 4)

TABLE 8A
Sample information

| | Number of samples |
|---|---|
| Breast cancer samples | 31 |
| Non-breast cancer samples | 29 |
| | 60 |

TABLE 8B
Preferred Table 5 sequences and sequence/gene information for probe/primer generation

| Probe | Table 5 | |
|---|---|---|
| Number | Probe ID No. | Gene name |
| 1 | 101893 | nardilysin (N-arginine dibasic convertase); NRD1 |
| 2 | 101958 | solute carrier organic anion transporter family, member 3A1; SLCO3A1 |
| 3 | 102040 | Kruppel-like factor 7 (ubiquitous); KLF7 |
| 4 | 102604 | DNA directed RNA polymerase II polypeptide J-related gene; unassigned |
| 5 | 104196 | proteasome (prosome, macropain) activator subunit 2 (PA28 beta); PSME2 |
| 6 | 104220 | rabphilin 3A-like (without C2 domains); RPH3AL |
| 7 | 104697 | dolichyl-phosphate mannosyltransferase polypeptide 2, regulatory subunit; DPM2 |
| 8 | 104772 | target of myb1-like 2 (chicken); TOM1L2 |
| 9 | 105423 | H2A histone family, member Z; H2AFZ |
| 10 | 106796 | actin related protein 2/3 complex, subunit 5, 16 kDa; ARPC5 |
| 11 | 106979 | microtubule-associated protein 1 light chain 3 beta; MAP1LC3B |
| 12 | 107117 | galactosidase, alpha; GLA |
| 13 | 107385 | solute carrier family 31 (copper transporters), member 1; SLC31A1 |
| 14 | 107464 | ubiquitin specific peptidase 38; USP38 |
| 15 | 107655 | torsin family 3, member A; TOR3A |
| 16 | 108400 | hypothetical protein BC004921; unassigned |
| 17 | 108775 | phospholysine phosphohistidine inorganic pyrophosphate phosphatase; unassigned |
| 18 | 108974 | far upstream element (FUSE) binding protein 1; FUBP1 |
| 19 | 110009 | zinc finger, AN1-type domain 5; ZFAND5 |
| 20 | 110634 | unassigned; unassigned |
| 21 | 111542 | chromosome X open reading frame 9; CXorf9 |
| 22 | 112443 | glycoprotein IX (platelet); GP9 |
| 23 | 112734 | zinc finger, CCCH-type with G patch domain; ZGPAT |
| 24 | 112771 | FXYD domain containing ion transport regulator 5; FXYD5 |
| 25 | 112934 | sphingomyelin phosphodiesterase 3, neutral membrane (neutral sphingomyelinase |
| | | II); SMPD3 |
| 26 | 113059 | EH-domain containing 3; EHD3 |
| 27 | 113742 | unassigned; unassigned |
| 28 | 115081 | unassigned; unassigned |
| 29 | 116246 | TAF7 RNA polymerase II, TATA box binding protein (TBP)-associated factor, 55 kDa; TAF7 |
| 30 | 116549 | mitofusin 2; MFN2 |
| 31 | 117279 | alpha-kinase 1; ALPK1 |
| 32 | 117790 | chromosome 9 open reading frame 156; C9orf156 |
| 33 | 117844 | chromosome 19 open reading frame 59; C19orf59 |
| 34 | 118417 | NHP2 non-histone chromosome protein 2-like 1 (S. cerevisiae); NHP2L1 |
| 35 | 119015 | unassigned; unassigned |
| 36 | 119132 | leucine-rich repeat kinase 2; LRRK2 |
| 37 | 119357 | platelet factor 4 (chemokine (C-X-C motif) ligand 4); PF4 |
| 38 | 120440 | inosine triphosphatase (nucleoside triphosphate pyrophosphatase); ITPA |
| 39 | 120515 | copper metabolism (Murr1) domain containing 1; COMMD1 |
| 40 | 120662 | T-cell leukemia translocation altered gene; TCTA |
| 41 | 121045 | EF-hand domain family, member A1; EFHA1 |
| 42 | 121320 | hypothetical protein LOC54103; unassigned |
| 43 | 122713 | hypothetical protein FLJ14107; FLJ14107 |
| 44 | 124424 | jumonji domain containing 3; JMJD3 |
| 45 | 125012 | GRIP and coiled-coil domain containing 2; GCC2 |
| 46 | 125201 | ubiquitin specific peptidase 39; USP39 |
| 47 | 126367 | oral cancer overexpressed 1; ORAOV1 |
| 48 | 126773 | transmembrane protein 77; TMEM77 |
| 49 | 127187 | ribosomal protein S25; RPS25 |
| 50 | 127723 | 2-deoxyribose-5-phosphate aldolase homolog (C. elegans); DERA |
| 51 | 129728 | RanBP-type and C3HC4-type zinc finger containing 1; RBCK1 |
| 52 | 130995 | phosphorylase kinase, beta; PHKB |
| 53 | 131715 | family with sequence similarity 122B; FAM122B |
| 54 | 132033 | eukaryotic translation initiation factor 3, subunit 3 gamma, 40 kDa; EIF3S3 |
| 55 | 132276 | apolipoprotein B mRNA editing enzyme, catalytic polypeptide-like 3G; APOBEC3G |
| 56 | 133345 | solute carrier family 39 (zinc transporter), member 7; SLC39A7 |
| 57 | 133352 | TRK-fused gene; TFG |
| 58 | 134602 | leucine-rich alpha-2-glycoprotein 1; LRG1 |
| 59 | 136206 | colony stimulating factor 3 receptor (granulocyte); CSF3R |
| 60 | 136737 | family with sequence similarity 49, member A; FAM49A |
| 61 | 136743 | nuclear receptor coactivator 1; NCOA1 |
| 62 | 137092 | phospholipase A2-activating protein; PLAA |
| 63 | 138851 | CCR4-NOT transcription complex, subunit 2; CNOT2 |
| 64 | 139445 | cell division cycle 34 homolog (S. cerevisiae); CDC34 |
| 65 | 139869 | kelch repeat and BTB (POZ) domain containing 7; KBTBD7 |
| 66 | 139881 | histone cluster 2, H2aa3; HIST2H2AA3 |
| 67 | 140544 | carboxypeptidase, vitellogenic-like; CPVL |
| 68 | 141449 | DENN/MADD domain containing 2D; DENND2D |
| 69 | 143169 | mitogen-activated protein kinase kinase kinase kinase 2; MAP4K2 |
| 70 | 144379 | F-box protein, helicase, 18; FBXO18 |
| 71 | 145597 | nuclear protein localization 4 homolog (S. cerevisiae); NPLOC4 |
| 72 | 146599 | PC2 (positive cofactor 2, multiprotein complex) glutamine/Q-rich-associated |
| | | protein; PCQAP |
| 73 | 146768 | enhancer of mRNA decapping 3 homolog (S. cerevisiae); EDC3 |
| 74 | 147295 | sulfatase modifying factor 1; SUMF1 |
| 75 | 147338 | family with sequence similarity 128, member B; FAM128B |
| 76 | 149705 | NmrA-like family domain containing 1; NMRAL1 |
| 77 | 150701 | caspase 5, apoptosis-related cysteine peptidase; CASP5 |
| 78 | 151108 | asparagine synthetase; ASNS |
| 79 | 151867 | structure specific recognition protein 1; SSRP1 |
| 80 | 152539 | presenilin 1 (Alzheimer disease 3); PSEN1 |
| 81 | 152585 | hexamthylene bis-acetamide inducible 2; HEXIM2 |
| 82 | 154932 | granulin; GRN |
| 83 | 155063 | phosphoglucomutase 1; PGM1 |
| 84 | 155553 | protein phosphatase 1, regulatory (inhibitor) subunit 2; PPP1R2 |
| 85 | 155892 | development and differentiation enhancing factor 1; DDEF1 |
| 86 | 156215 | THO complex 4; THOC4 |
| 87 | 156493 | suppressor of cytokine signaling 3; SOCS3 |
| 88 | 157542 | unassigned; unassigned |
| 89 | 157784 | ribosomal protein L13a; RPL13A |
| 90 | 158771 | chromosome 1 open reading frame 85; C1orf85 |
| 91 | 158846 | G protein-coupled receptor 171; GPR171 |
| 92 | 159466 | differentially expressed in FDCP 6 homolog (mouse); DEF6 |
| 93 | 159559 | high-mobility group nucleosomal binding domain 2; HMGN2 |
| 94 | 160844 | deoxyguanosine kinase; DGUOK |
| 95 | 161271 | hexosaminidase A (alpha polypeptide); HEXA |
| 96 | 163084 | EGFR-coamplified and overexpressed protein; unassigned |
| 97 | 163151 | sulfotransferase family, cytosolic, 1A, phenol-preferring, member 2; SULT1A2 |
| 98 | 163194 | neutrophil cytosolic factor 4, 40 kDa; NCF4 |
| 99 | 163252 | pro-platelet basic protein (chemokine (C-X-C motif) ligand 7); PPBP |
| 100 | 164265 | Enah/Vasp-like; EVL |
| 101 | 165502 | transmembrane and coiled-coil domains 4; TMCO4 |
| 102 | 165825 | O-linked N-acetylglucosamine (GlcNAc) transferase (UDP-N- |
| | | acetylglucosamine: polypeptide-N-acetylglucosaminyl transferase); OGT |
| 103 | 166975 | MCM5 minichromosome maintenance deficient 5, cell division cycle 46 |
| | | (S. cerevisiae); MCM5 |
| 104 | 168528 | ataxia telangiectasia and Rad3 related; ATR |
| 105 | 168872 | bone marrow stromal cell antigen 2; BST2 |
| 106 | 169477 | signal transducer and activator of transcription 3 interacting protein 1; STATIP1 |
| 107 | 169563 | chromosome 16 open reading frame 35; C16orf35 |
| 108 | 169781 | nuclear receptor co-repressor 2; NCOR2 |
| 109 | 169988 | ubiquitin-conjugating enzyme E2W (putative); UBE2W |
| 110 | 170102 | phosphomevalonate kinase; PMVK |
| 111 | 170312 | G protein-coupled receptor 68; GPR68 |
| 112 | 171160 | guanine nucleotide binding protein (G protein), alpha inhibiting activity polypeptide |
| | | 2; GNAI2 |
| 113 | 172296 | transgelin 2; TAGLN2 |
| 114 | 172691 | ribosomal protein S2; RPS2 |
| 115 | 173555 | high-mobility group nucleosomal binding domain 2; HMGN2 |
| 116 | 173972 | nudix (nucleoside diphosphate linked moiety X)-type motif 3; NUDT3 |
| 117 | 174250 | ORM1-like 1 (S. cerevisiae); ORMDL1 |
| 118 | 175122 | alpha tubulin; unassigned |
| 119 | 176372 | ribosomal protein S2; RPS2 |
| 120 | 177061 | translocase of inner mitochondrial membrane 50 homolog (S. cerevisiae); TIMM50 |
| 121 | 177127 | ubiquitin B; UBB |
| 122 | 178408 | protein phosphatase 1, regulatory subunit 3D; PPP1R3D |
| 123 | 178825 | N-sulfoglucosamine sulfohydrolase (sulfamidase); SGSH |
| 124 | 180184 | glia maturation factor, gamma; GMFG |
| 125 | 180191 | tripartite motif-containing 23; TRIM23 |
| 126 | 180412 | sulfotransferase family, cytosolic, 1A, phenol-preferring, member 1; SULT1A1 |
| 127 | 180427 | growth hormone inducible transmembrane protein; GHITM |
| 128 | 180998 | solute carrier family 2 (facilitated glucose transporter), member 3; SLC2A3 |
| 129 | 181105 | dolichyl-phosphate mannosyltransferase polypeptide 2, regulatory subunit; DPM2 |
| 130 | 181160 | pyruvate dehydrogenase phosphatase regulatory subunit; unassigned |
| 131 | 182070 | signal transducer and activator of transcription 3 (acute-phase response factor); STAT3 |
| 132 | 183167 | exportin 6; XPO6 |
| 133 | 184157 | solute carrier family 22 (organic cation transporter), member 18; SLC22A18 |
| 134 | 184495 | tumor necrosis factor (ligand) superfamily, member 14; TNFSF14 |
| 135 | 184572 | splicing factor 3B, 14 kDa subunit; unassigned |
| 136 | 185825 | hematological and neurological expressed 1; HN1 |
| 137 | 186996 | WD repeat and FYVE domain containing 2; WDFY2 |
| 138 | 187278 | LAG1 homolog, ceramide synthase 6 (S. cerevisiae); LASS6 |
| 139 | 187458 | proteasome (prosome, macropain) subunit, alpha type, 5; PSMA5 |
| 140 | 188270 | inositol 1,3,4-triphosphate 5/6 kinase; ITPK1 |
| 141 | 189240 | ring finger protein 1; RING1 |
| 142 | 189818 | bromodomain containing 9; BRD9 |
| 143 | 190261 | unassigned; unassigned |
| 144 | 191839 | unassigned; unassigned |
| 145 | 192651 | potassium voltage-gated channel, shaker-related subfamily, beta member 2; KCNAB2 |
| 146 | 192905 | component of oligomeric golgi complex 5; COG5 |
| 147 | 193007 | mitochondrial ribosomal protein L53; MRPL53 |
| 148 | 193821 | parvin, gamma; PARVG |
| 149 | 196303 | golgi autoantigen, golgin subfamily a, 1; GOLGA1 |
| 150 | 196409 | ribonuclease/angiogenin inhibitor 1; RNH1 |
| 151 | 196599 | leucine rich repeat containing 8 family, member C; LRRC8C |
| 152 | 197266 | fizzy/cell division cycle 20 related 1 (Drosophila); FZR1 |
| 153 | 198428 | ankyrin repeat domain 13A; ANKRD13A |
| 154 | 199360 | tyrosine 3-monooxygenase/tryptophan 5-monooxygenase activation protein, beta |
| | | polypeptide; YWHAB |
| 155 | 199912 | leucine-rich repeat kinase 2; LRRK2 |
| 156 | 200186 | zinc finger protein 638; ZNF638 |
| 157 | 200308 | non-metastatic cells 2, protein (NM23B) expressed in; NME2 |
| 158 | 202480 | thioredoxin domain containing 4 (endoplasmic reticulum); TXNDC4 |
| 159 | 202673 | serine/threonine kinase 24 (STE20 homolog, yeast); STK24 |
| 160 | 203098 | BTB and CNC homology 1, basic leucine zipper transcription factor 1; BACH1 |
| 161 | 203648 | sorbitol dehydrogenase; SORD |
| 162 | 203712 | thiosulfate sulfurtransferase (rhodanese); TST |
| 163 | 206232 | histone cluster 1, H1c; HIST1H1C |
| 164 | 206444 | H2A histone family, member X; H2AFX |
| 165 | 206528 | mediator of RNA polymerase II transcription, subunit 25 homolog (S. cerevisiae); MED25 |
| 166 | 206696 | hypothetical protein FLJ21272 |
| 167 | 206925 | WD repeat domain 59; WDR59 |
| 168 | 207211 | chromosome 14 open reading frame 151; C14orf151 |
| 169 | 207943 | neural precursor cell expressed, developmentally down-regulated 8; NEDD8 |
| 170 | 207955 | transmembrane protein 50A; TMEM50A |
| 171 | 208310 | ATG7 autophagy related 7 homolog (S. cerevisiae); ATG7 |
| 172 | 208343 | fusion (involved in t(12; 16) in malignant liposarcoma); FUS |
| 173 | 208748 | non-SMC condensin I complex, subunit D2; NCAPD2 |
| 174 | 209426 | CD83 molecule; CD83 |
| 175 | 209738 | ribosomal protein L36a-like; RPL36AL |
| 176 | 210085 | tetratricopeptide repeat domain 14; TTC14 |
| 177 | 211683 | hypothetical LOC440248; unassigned |
| 178 | 211767 | sulfotransferase family, cytosolic, 1A, phenol-preferring, member 3; SULT1A3 |
| 179 | 212992 | ubiquitin B; UBB |
| 180 | 214987 | Tu translation elongation factor, mitochondrial; TUFM |
| 181 | 215225 | KIAA0317; KIAA0317 |
| 182 | 215616 | isopentenyl-diphosphate delta isomerase 1; IDI1 |
| 183 | 215770 | major histocompatibility complex, class II, DM beta; HLA-DMB |
| 184 | 217726 | deoxyguanosine kinase; DGUOK |
| 185 | 217900 | heat shock protein 90 kDa beta (Grp94), member 1; HSP90B1 |
| 186 | 218083 | v-maf musculoaponeurotic fibrosarcoma oncogene homolog G (avian); MAFG |
| 187 | 218581 | heat shock 70 kDa protein 4; HSPA4 |
| 188 | 219147 | signal transducer and activator of transcription 3 (acute-phase response factor); STAT3 |
| 189 | 220348 | sulfotransferase family, cytosolic, 1A, phenol-preferring, member 3; SULT1A3 |
| 190 | 221081 | Bernardinelli-Seip congenital lipodystrophy 2 (seipin); BSCL2 |
| 191 | 222023 | ubiquitin specific peptidase 10; USP10 |
| 192 | 223796 | chromosome 9 open reading frame 66; C9orf66 |
| 193 | 225147 | vacuolar protein sorting 28 homolog (S. cerevisiae); VPS28 |
| 194 | 226803 | nipsnap homolog 3A (C. elegans); NIPSNAP3A |
| 195 | 227872 | DnaJ (Hsp40) homolog, subfamily C, member 4; DNAJC4 |
| 196 | 230540 | chromosome 9 open reading frame 139; C9orf139 |
| 197 | 232022 | membrane bound O-acyltransferase domain containing 1; MBOAT1 |
| 198 | 234426 | ribosomal protein L13a; RPL13A |
| 199 | 234758 | hypothetical protein LOC284454; LOC284454 |
| 200 | 234977 | fucosyltransferase 11 (alpha (1,3) fucosyltransferase); FUT11 |
| 201 | 235086 | thyroid adenoma associated; THADA |
| 202 | 235306 | SUB1 homolog (S. cerevisiae); SUB1 |
| 203 | 264394 | family with sequence similarity 39, member D pseudogene; FAM39DP |
| 204 | 312026 | unassigned; unassigned |
| 205 | 423075 | unassigned; unassigned |
| 206 | 539197 | chromosome 3 open reading frame 34; C3orf34 |
| 207 | 693356 | unassigned; unassigned |
| 208 | 710021 | poly (ADP-ribose) polymerase family, member 9; PARP9 |

1. A set of oligonucleotide probes, wherein said set comprises at least 10 oligonucleotides wherein each of said oligonucleotides is selected from an oligonucleotide as set forth in Table 5, 7C or 8B or derived from a sequence as set forth in Table 5, 7C or 8B, or an oligonucleotide with a complementary sequence, or a functionally equivalent oligonucleotide.

2. A set as claimed in claim 1 wherein said at least 10 oligonucleotides are selected from oligonucleotides as set forth in Table 5, 7C or 8B or derived from a sequence as set forth in Table 5, 7C or 8B which have at least 60%, preferably at least 100% frequency of occurrence, or an oligonucleotide with a complementary sequence, or a functionally equivalent oligonucleotide.

3. A set as claimed in claim 1 or 2 wherein each of said oligonucleotides in said set is selected from an oligonucleotide as set forth in Table 5, 7C or 8B or derived from a sequence as set forth in Table 5, 7C or 8B, and preferably has at least 60%, preferably at least 100% frequency of occurrence, or an oligonucleotide with a complementary sequence, or a functionally equivalent oligonucleotide.

4. A set as claimed in any one of claims 1 to 3 wherein said set comprises all of the oligonucleotides set forth in Table 5, 7C or 8B which have at least 60%, preferably at least 100% frequency of occurrence, or derived from a sequence as set forth in Table 5, 7C or 8B, or an oligonucleotide with a complementary sequence, or a functionally equivalent oligonucleotide.

5. A set as claimed in any one of claims 1 to 4 wherein said set comprises all of the oligonucleotides set forth in Table 5, 7C or 8B, or derived from a sequence as set forth in Table 5, 7C or 8B, or an oligonucleotide with a complementary sequence, or a functionally equivalent oligonucleotide.

6. A set of oligonucleotide probes as claimed in any one of claims 1 to 5, wherein each probe in said set binds to a different transcript.

7. A set as claimed in any one of claims 1 to 5, wherein said set comprises at least 20 oligonucleotides and said set comprises pairs of primers in which each oligonucleotide in said pair of primers binds to the same transcript or its complementary sequence and preferably each of the pairs of primers bind to a different transcript.

8. A set of oligonucleotide probes as claimed in any one of claims 1 to 5, wherein said set comprises at least 30 oligonucleotides and said set comprises pairs of primers and a labelled probe for each pair of primers in which each oligonucleotide in said pair of primers and said labelled probe bind to the same transcript or its complementary sequence and preferably each of the pairs of primers and the labelled probe bind to different transcripts.

9. A set as claimed in any one of claims 1 to 8 consisting of from 10 to 500 oligonucleotide probes.

10. A set of oligonucleotide probes as claimed in any one of claims 1 to 9, wherein each of said oligonucleotide probes is from 15 to 200 bases in length.

11. A set of oligonucleotide probes as claimed in any one of claims 1 to 10, wherein said probes are immobilized on one or more solid supports.

12. A set of oligonucleotide probes as claimed in claim 11, wherein said solid support is a sheet, filter, membrane, plate or biochip.

13. A kit comprising a set of oligonucleotide probes as defined in claim 11 or 12 preferably immobilized on one or more solid supports.

14. A kit as claimed in claim 13 wherein said probes are immobilized on a single solid support and each unique probe is attached to different region of said solid support.

15. A kit as claimed in claim 13 or 14 further comprising standardizing materials.

16. The use of a set of probes as described in any one of claims 1 to 12 or a kit as described in any one of claims 13 to 15 to determine the gene expression pattern of a cell which pattern reflects the level of gene expression of genes to which said oligonucleotide probes bind, comprising at least the steps of:
a) isolating mRNA from said cell, which may optionally be reverse transcribed to cDNA;
b) hybridizing the mRNA or cDNA of step (a) to a set of oligonucleotides or a kit as defined in any one of claims 1 to 15; and
c) assessing the amount of mRNA or cDNA hybridizing to each of said probes to produce said pattern.

17. A method of preparing a standard gene transcript pattern characteristic of a cancer or a stage thereof in an organism comprising at least the steps of:
a) isolating mRNA from the cells of a sample of one or more organisms having the cancer or a stage thereof, which may optionally be reverse transcribed to cDNA;
b) hybridizing the mRNA or cDNA of step (a) to a set of oligonucleotides or a kit as defined in any one of claims 1 to 15 specific for said cancer or a stage thereof in an organism and sample thereof corresponding to the organism and sample thereof under investigation; and
c) assessing the amount of mRNA or cDNA hybridizing to each of said probes to produce a characteristic pattern reflecting the level of gene expression of genes to which said oligonucleotides bind, in the sample with the cancer or a stage thereof.

18. A method of preparing a test gene transcript pattern comprising at least the steps of:
a) isolating mRNA from the cells of a sample of said test organism, which may optionally be reverse transcribed to cDNA;
b) hybridizing the mRNA or cDNA of step (a) to a set of oligonucleotides or a kit as defined in any one of claims 1 to 15 specific for a cancer or a stage thereof in an organism and sample thereof corresponding to the organism and sample thereof under investigation; and
c) assessing the amount of mRNA or cDNA hybridizing to each of said probes to produce said pattern reflecting the level of gene expression of genes to which said oligonucleotides bind, in said test sample.

19. A method of diagnosing or identifying or monitoring a cancer or a stage thereof in an organism, comprising the steps of:
a) isolating mRNA from the cells of a sample of said organism, which may optionally be reverse transcribed to cDNA;
b) hybridizing the mRNA or cDNA of step (a) to a set of oligonucleotides or a kit as defined in any one of claims 1 to 15 specific for said cancer or a stage thereof in an organism and sample thereof corresponding to the organism and sample thereof under investigation;
c) assessing the amount of mRNA or cDNA hybridizing to each of said probes to produce a characteristic pattern reflecting the level of gene expression of genes to which said oligonucleotides bind in said sample; and
d) comparing said pattern to a standard diagnostic pattern prepared as described in claim 17 using a sample from an organism corresponding to the organism and sample under investigation to determine the degree of correlation indicative of the presence of said cancer or a stage thereof in the organism under investigation.

20. A method as claimed in any one of claims 16 to 19 wherein said probes are primers and in step b) said mRNA or cDNA or a part thereof is amplified using said primers and in step c) the amount of amplified product is assessed to produce said pattern.

21. A method as claimed in any one of claims 16 to 19 wherein said probes are labelling probes and pairs of primers and in step b) said labelling probes and primers are hybridized to said mRNA or cDNA and said mRNA or cDNA or a part thereof is amplified using said primers, wherein when said labelling probe binds to the target sequence it is displaced during amplification thereby generating a signal and in step c) the amount of signal generated is assessed to produce said pattern.

22. A method as claimed in any one of claims 17 to 21 wherein said mRNA or cDNA is amplified prior to step b).

23. A method as claimed in any one of claims 17 to 22 wherein the oligonucleotides and/or the mRNA or cDNA are labelled.

24. A method as claimed in any one of claims 17 to 23 wherein said pattern is expressed as an array of numbers relating to the expression level associated with each probe.

25. A method as claimed in any one of claims 17 to 24 wherein said organism is a eukaryotic organism, preferably a mammal.

26. A method as claimed in claim 25 wherein said organism is a human.

28. A method as claimed in any one of claims 17 to 27 wherein the data making up said pattern is mathematically projected onto a classification model.

29. A method as claimed in any one of claims 17 to 28 wherein said sample is tissue, body fluid or body waste.

30. A method as claimed in any one of claims 17 to 29 wherein said sample is peripheral blood.

31. A method as claimed in any one of claims 17 to 30 wherein the cells in the sample are not disease cells, have not been in contact with such cells and do not originate from the site of the disease or condition.

32. A method of monitoring a cancer or a stage thereof in an organism as claimed in any of claims 19 to 31 wherein said monitoring is performed after treatment of said cancer in said organism to determine the efficacy of said treatment.

33. A method as claimed in any one of claims 17 to 32 wherein said cancer is stomach, lung, breast, prostate gland, bowel, skin, colon or ovary cancer.

34. A method as claimed in claim 34 wherein said cancer is breast cancer.


SEQUENCE LISTING (2122 sequences)

SEQ ID NO: 1 - DNA, 60 bp, Artificial Sequence
  Oligonucleotide
aaaaagagtttacgccttacgactacagccagtcagacttcaaggcttttgctggaaaca

SEQ ID NO: 2 - DNA, 60 bp, Artificial Sequence
  Oligonucleotide
aaaactgctgtgaacctcacaggcaggttaaacaagtatggagtgatcaggcccagattt

SEQ ID NO: 3 - DNA, 60 bp, Artificial Sequence
  Oligonucleotide
aaaagagcaacaaagactccagaacccactctacctcctcaatcccttggccatctgtgg

SEQ ID NO: 4 - DNA, 60 bp, Artificial Sequence
  Oligonucleotide
aaactaaaaactaggaaagtgttaactatcgttgcccaccgaatttgaggtagcaaaaaa

SEQ ID NO: 5 - DNA, 60 bp, Artificial Sequence
  Oligonucleotide
aaagtaatcatcgttcaggcccaacccttaggtttaaaaagtcaggttgtccatcccatt

SEQ ID NO: 6 - DNA, 60 bp, Artificial Sequence
  Oligonucleotide
aaatgattccatggctccctgtagtacttctacaaagcatctatcacaattgtaattaat

SEQ ID NO: 7 - DNA, 60 bp, Artificial Sequence
  Oligonucleotide
aacagtcatgatgctatggactcctactacgactacatatgggatgttaccattttggaa

SEQ ID NO: 8 - DNA, 60 bp, Artificial Sequence
  Oligonucleotide
aaccgcgtggctgtttttgaactgcctggaacctaagaccctgaattcttttccccccca

SEQ ID NO: 9 - DNA, 60 bp, Artificial Sequence
  Oligonucleotide
aacctcactgaaacctgctccgtgcccggatgttgatcatgctggtggcttggttactgt

SEQ ID NO: 10 - DNA, 60 bp, Artificial Sequence
  Oligonucleotide
aacgcattcatgaatttccagtgttcagtaaatagcagctatgtgtgtgcaaaataaaag

SEQ ID NO: 11 - DNA, 60 bp, Artificial Sequence
  Oligonucleotide
aacgctacagcgtggacaaatctctcagccacccctggttacaggagtaccagacgtggc

SEQ ID NO: 12 - DNA, 60 bp, Artificial Sequence
  Oligonucleotide
aacggatccatatcaggaagacaatctgaagagcagagatctccaaaaactaagcatttc

SEQ ID NO: 13 - DNA, 60 bp, Artificial Sequence
  Oligonucleotide
aactggaccgcgcacgacaggacctgccctctagcctcgtgggtctgttccccagggccc

SEQ ID NO: 14 - DNA, 60 bp, Artificial Sequence
  Oligonucleotide
aagcgggatcttgtactctctaaactggtccacaatgtgcataaccacatcaccaatgac

SEQ ID NO: 15 - DNA, 60 bp, Artificial Sequence
  Oligonucleotide
aagcgttcataataacttgcgaattggccctgatgttctagcatgtgattacttcactcc

SEQ ID NO: 16 - DNA, 60 bp, Artificial Sequence
  Oligonucleotide
aaggaaacaggtgactagaagggcctgaggattacagtgaacctgaccattcagaacaga

SEQ ID NO: 17 - DNA, 60 bp, Artificial Sequence
  Oligonucleotide
aaggatgtcattgaagagtatttcaaatgcaagaaatgaagaaataaatctttggctcac

SEQ ID NO: 18 - DNA, 60 bp, Artificial Sequence
  Oligonucleotide
aaggctggactccatgactatatatacatacatctatctacatctgcctgtgtacacaca

SEQ ID NO: 19 - DNA, 60 bp, Artificial Sequence
  Oligonucleotide
aaggcttcagagtagatatctctgccaatgtgaggacagaaggactggtgcgacccccca

SEQ ID NO: 20 - DNA, 60 bp, Artificial Sequence
  Oligonucleotide
aagggaaagctcccaaagcatcctatcattgtgaaggccaaattcttcagaagaagagca

SEQ ID NO: 21 - DNA, 60 bp, Artificial Sequence
  Oligonucleotide
aaggttttactgtcttaaagctgtctttctgagatctaattccaaggacttctccacagc

SEQ ID NO: 22 - DNA, 60 bp, Artificial Sequence
  Oligonucleotide
aagtccagggttgcttggtttactggtttataagaaatctgaaagcacctctgacattcc

SEQ ID NO: 23 - DNA, 60 bp, Artificial Sequence
  Oligonucleotide
aagtgtctgggccctgccttcacaccagccacacgggctgcctggagccaactctacggg

SEQ ID NO: 24 - DNA, 60 bp, Artificial Sequence
  Oligonucleotide
aatactgagagatttggtcagaatttgaggccagtttcctagctcattgctagtcaggaa

SEQ ID NO: 25 - DNA, 60 bp, Artificial Sequence
  Oligonucleotide
aatccgacagtactgcaatcactggcgaaattttgctgacattgatgattcctggaaaag

SEQ ID NO: 26 - DNA, 60 bp, Artificial Sequence
  Oligonucleotide
aatgaatgatgaaggagatcatgacccagttcctctaccaaatgttaatgcagcaatatt

SEQ ID NO: 27 - DNA, 60 bp, Artificial Sequence
  Oligonucleotide
aatgccagtcctcatgtaacctcaggtatcttcagcttgtggagaataaatctggtttaa

SEQ ID NO: 28 - DNA, 60 bp, Artificial Sequence
  Oligonucleotide
acaacagtcacgttgaccatcagtggagtccaggcagaagacgaggctgactattactgt

SEQ ID NO: 29 - DNA, 60 bp, Artificial Sequence
  Oligonucleotide
acaagcagcattaagactgaagttggaatattctgttgaccataaaaccttgatatcatt

SEQ ID NO: 30 - DNA, 60 bp, Artificial Sequence
  Oligonucleotide
acagaggccgtggcagggaaacaggctttgcctttgtaacctttgatgaacatgactcca

SEQ ID NO: 31 - DNA, 60 bp, Artificial Sequence
  Oligonucleotide
acagccaggcattcacccagcaggtgcaccagtgcatcgagtgctgccctgtgcctctgg

SEQ ID NO: 32 - DNA, 60 bp, Artificial Sequence
  Oligonucleotide
acaggccatgaccttgaagtgaaagtcttctgttgctattgtgggctcaaatatttggtc

SEQ ID NO: 33 - DNA, 60 bp, Artificial Sequence
  Oligonucleotide
acagtccactgaatgggtataatgaattgcagtatatacgtatgattgctttttaagtga

SEQ ID NO: 34 - DNA, 60 bp, Artificial Sequence
  Oligonucleotide
acagttcccttcagtctggtcagtccgttatctccctgctgagctcagaagaattaaaaa

SEQ ID NO: 35 - DNA, 60 bp, Artificial Sequence
  Oligonucleotide
acagttgaagaccgttttgtactaagtctcattttgtatactggtaaaaactacatgctt

SEQ ID NO: 36 - DNA, 60 bp, Artificial Sequence
  Oligonucleotide
acagttttgcctgcgagcttcctccggtgctcttattgacctgttctgacccctgcgcta

SEQ ID NO: 37 - DNA, 60 bp, Artificial Sequence
  Oligonucleotide
acatcaactacttcgcctccgacgagctgacggtcaagaccaaggatggcatggtggaga

SEQ ID NO: 38 - DNA, 60 bp, Artificial Sequence
  Oligonucleotide
acatctccactgcccccaaagacctccgttgaacattctgtatggaaaagagccctggag

SEQ ID NO: 39 - DNA, 60 bp, Artificial Sequence
  Oligonucleotide
acattcacgatctggactcgaactcctttgaactggacttacagttttccgaagatgaga

SEQ ID NO: 40 - DNA, 60 bp, Artificial Sequence
  Oligonucleotide
acccatcttcagtgtcttacttgtactgtatcacattccataccctcatttaattcttaa

SEQ ID NO: 41 - DNA, 60 bp, Artificial Sequence
  Oligonucleotide
accctcctgctcaatggctaccagacactggaagacttcaaagagctgcgagaaacacac

SEQ ID NO: 42 - DNA, 60 bp, Artificial Sequence
  Oligonucleotide
accgatgaagaggtttgagtagatgtacaaatcaagtaatggtttgaacacctttaataa

SEQ ID NO: 43 - DNA, 60 bp, Artificial Sequence
  Oligonucleotide
accgcctaaaagtgtatcagggtctttattgtgtggctattcgtgatttcaaacaggcag

SEQ ID NO: 44 - DNA, 60 bp, Artificial Sequence
  Oligonucleotide
acctcatgatatttttcgtcagagaaaacagaacacaagtagaccaccatctatgcatgt

SEQ ID NO: 45 - DNA, 60 bp, Artificial Sequence
  Oligonucleotide
acctgtgatgaaaacatctgtaactactagcccacagagtgacatgatgagggagcaact

SEQ ID NO: 46 - DNA, 60 bp, Artificial Sequence
  Oligonucleotide
acctttcaggccagacaggagcacctgaccaaaggcttcacagccgccctcaccgcccgg

SEQ ID NO: 47 - DNA, 60 bp, Artificial Sequence
  Oligonucleotide
acgcttgtacatgaagtgtggaaggactctgccacaatgtccctggaccctgaggaagag

SEQ ID NO: 48 - DNA, 60 bp, Artificial Sequence
  Oligonucleotide
acggcgagggcggctgcatcactgcggaggactgcccctgcgtgcacaatgaggccagct

SEQ ID NO: 49 - DNA, 60 bp, Artificial Sequence
  Oligonucleotide
acggctggaatccctctgtgtgcatgaacttctgtgccgccttccttagctttgcccaga

SEQ ID NO: 50 - DNA, 60 bp, Artificial Sequence
  Oligonucleotide
actgagcgactgggaaaactcggctctacatctcacccagaacggcttttagaaacacca

SEQ ID NO: 51 - DNA, 60 bp, Artificial Sequence
  Oligonucleotide
actgaggaaatgagacagcacgtgacaaatccttaaaggatacacacatgacaggaagga

SEQ ID NO: 52 - DNA, 60 bp, Artificial Sequence
  Oligonucleotide
acttgtcaggagttgagacttccctgccggattctattttgaaagtaaatggtcttccct

SEQ ID NO: 53 - DNA, 60 bp, Artificial Sequence
  Oligonucleotide
agaaaagtcctatcaattacagaagctatacgaacaaagaaaaatggtcatgtacctcaa

SEQ ID NO: 54 - DNA, 60 bp, Artificial Sequence
  Oligonucleotide
agaaagggtagttcaaagagtctgtcttgagatctgattttttccccctttacctagctg

SEQ ID NO: 55 - DNA, 60 bp, Artificial Sequence
  Oligonucleotide
agaaggacaaacctgagaaagaattaaaagccttttgtgctgatcaacttgatgtctttt

SEQ ID NO: 56 - DNA, 60 bp, Artificial Sequence
  Oligonucleotide
agaaggcttccacactcaaatctctaagtatttctctgagcgtggtgatgcagtgactaa

SEQ ID NO: 57 - DNA, 60 bp, Artificial Sequence
  Oligonucleotide
agaccggcgaaagaaggaacgagttgaagcagttaatatggctgaaggaatcattcacga

SEQ ID NO: 58 - DNA, 60 bp, Artificial Sequence
  Oligonucleotide
agacggaagcctgaaaactcctcagactccagcacctcccttttacaaactgacgtttgt

SEQ ID NO: 59 - DNA, 60 bp, Artificial Sequence
  Oligonucleotide
agaggcctctgtgcccagcctgattctctgctcccaggagccagtgacatgaggtgcaga

SEQ ID NO: 60 - DNA, 60 bp, Artificial Sequence
  Oligonucleotide
agagttgttgctgcccgtattaggccacacagtggaaccccatttatatcatagcagaag

SEQ ID NO: 61 - DNA, 60 bp, Artificial Sequence
  Oligonucleotide
agatgaagagccgaatacctgtggtgctcctggcctgtggctcctttaaccccatcacca

SEQ ID NO: 62 - DNA, 60 bp, Artificial Sequence
  Oligonucleotide
agcacctcagcagccagaacagatatttcagtgaagctgacaaaatcaaagtggcccagg

SEQ ID NO: 63 - DNA, 60 bp, Artificial Sequence
  Oligonucleotide
agcagagagaagcctgagcctggccccagtttttcatttgtagaacctgggattcaaact

SEQ ID NO: 64 - DNA, 60 bp, Artificial Sequence
  Oligonucleotide
agcattacgggttttcgttgagtctgttttaaggtatggcttgccagtgaacttccaagc

SEQ ID NO: 65 - DNA, 60 bp, Artificial Sequence
  Oligonucleotide
agccaacatcacgttttgttagctgtgatttacctttgtccgtttaaaagacttcacgga

SEQ ID NO: 66 - DNA, 60 bp, Artificial Sequence
  Oligonucleotide
agccataatgttgaacagaattggagtattttctttataatttcttgaacaggcaaatga

SEQ ID NO: 67 - DNA, 60 bp, Artificial Sequence
  Oligonucleotide
agccatcacttcaacattgtgataatccttcacagcaagaaaccgaataaaatactaaca

SEQ ID NO: 68 - DNA, 60 bp, Artificial Sequence
  Oligonucleotide
agccatgaacatgttgagtgagcatgctggagaatgagagaccacatgaagcagaaacat

SEQ ID NO: 69 - DNA, 60 bp, Artificial Sequence
  Oligonucleotide
agcccccaccgtggagacctctgacccttatgctgatgatcctgtacgtcacccagccct

SEQ ID NO: 70 - DNA, 60 bp, Artificial Sequence
  Oligonucleotide
agcctcgtgaacgtccacggtgctgtgctgtacgacaagttcatccggcctgagggagag

SEQ ID NO: 71 - DNA, 60 bp, Artificial Sequence
  Oligonucleotide
agccttcaccatctctgcctatacagatggacacactccctgcctgtgctgctgctagac

SEQ ID NO: 72 - DNA, 60 bp, Artificial Sequence
  Oligonucleotide
agcggatggtgccctgactccatctggattccttgacgtgtctcagactgggtccctgag

SEQ ID NO: 73 - DNA, 60 bp, Artificial Sequence
  Oligonucleotide
agctgacctcactggcattaactgatgtgccctacctgttcagcccccatctgggcctcg

SEQ ID NO: 74 - DNA, 60 bp, Artificial Sequence
  Oligonucleotide
agctggaaggccgtgatgccatcttcaagcagtttcatttcaaagacttcaacagggcct

SEQ ID NO: 75 - DNA, 60 bp, Artificial Sequence
  Oligonucleotide
agcttcaaatgagtttcaagggaattttcccatgtgaaaaaaggagagaacactggcatc

SEQ ID NO: 76 - DNA, 60 bp, Artificial Sequence
  Oligonucleotide
aggaaaacatgcacttcgagatctgcccctggtccagctacctcactggtgcctggaagc

SEQ ID NO: 77 - DNA, 60 bp, Artificial Sequence
  Oligonucleotide
aggaacctacaggattctaaggtttcctaggtcactgaacaactaatcttggtccctgaa

SEQ ID NO: 78 - DNA, 60 bp, Artificial Sequence
  Oligonucleotide
aggagaccgtcaggccgcatgtagacaatgctgctaagaaacagaacaaaatgccacccc

SEQ ID NO: 79 - DNA, 60 bp, Artificial Sequence
  Oligonucleotide
aggagataagtttccatgcactttggtggcacagaaaattgacctgccggagtaccaggg

SEQ ID NO: 80 - DNA, 60 bp, Artificial Sequence
  Oligonucleotide
aggaggcccgcacaccggtacactcgtggacacctacacactccataggagatcctggct

SEQ ID NO: 81 - DNA, 60 bp, Artificial Sequence
  Oligonucleotide
aggatggcaaggattaaaagaatatgatcaagcattggctgatcttaagaaagctcaggg

SEQ ID NO: 82 - DNA, 60 bp, Artificial Sequence
  Oligonucleotide
aggattttgtatccccggcctacttgaagaagtggtcagctaaaggaatccaggttgttg

SEQ ID NO: 83 - DNA, 60 bp, Artificial Sequence
  Oligonucleotide
aggcagcagcccagtccccatgttctgtcccctcacaggttcctacccccggcttcttct

SEQ ID NO: 84 - DNA, 60 bp, Artificial Sequence
  Oligonucleotide
aggcattaggtttcccaactgctttgtgctgatatcagaacagcagaaattaaatgtgaa

SEQ ID NO: 85 - DNA, 60 bp, Artificial Sequence
  Oligonucleotide
aggcccgtcacaagatccaggccaagtatctggaccagatggaggacctgtatgaagact

SEQ ID NO: 86 - DNA, 60 bp, Artificial Sequence
  Oligonucleotide
aggcctagatttgaaataatgttttgtacttcggtaagatggaaaacttagtgattcact

SEQ ID NO: 87 - DNA, 60 bp, Artificial Sequence
  Oligonucleotide
aggctgaggtctcctgggaattctcacccgctctcctgctgctaaggaaatgacgtcaat

SEQ ID NO: 88 - DNA, 60 bp, Artificial Sequence
  Oligonucleotide
aggcttattagaagaatgaactaaggtgtctaccatgattatttttctaagctggttggt

SEQ ID NO: 89 - DNA, 60 bp, Artificial Sequence
  Oligonucleotide
agggaccctggtttggactagacctttggaggccgagtgttatccctggcttctggaggg

SEQ ID NO: 90 - DNA, 60 bp, Artificial Sequence
  Oligonucleotide
aggtgtcgcaggcagcagcggaactcctggctttctgcgagacgcatgccaaagatgacc

SEQ ID NO: 91 - DNA, 60 bp, Artificial Sequence
  Oligonucleotide
aggttggtctcggcccagtttcccattgatcacttcacacacatcttcatcgatgaggct

SEQ ID NO: 92 - DNA, 60 bp, Artificial Sequence
  Oligonucleotide
agtaagactgaagcagacatggaagagtatatatgggaaaatagctcatcagaaagaaat

SEQ ID NO: 93 - DNA, 60 bp, Artificial Sequence
  Oligonucleotide
agtagctggtgctgctccagctgaggaagaaagtggaagcaaagaaagaagaatccgagg

SEQ ID NO: 94 - DNA, 60 bp, Artificial Sequence
  Oligonucleotide
agtataacagacactataccaaaataccaagcaactgttttgagaacccagacttaaaat

SEQ ID NO: 95 - DNA, 60 bp, Artificial Sequence
  Oligonucleotide
agtgtatcgacggataacagagttcacatattcaaacctgtatctgtgcaggcaatgtgg

SEQ ID NO: 96 - DNA, 60 bp, Artificial Sequence
  Oligonucleotide
ataaattcatgaaagaagccacgacgaatgcaccattcagattgaataagaaagacagaa

SEQ ID NO: 97 - DNA, 60 bp, Artificial Sequence
  Oligonucleotide
ataaggaatttggtaatgatgaaagcaattttggaggtggtggaagctacaatgattttg

SEQ ID NO: 98 - DNA, 60 bp, Artificial Sequence
  Oligonucleotide
atacagatgttttcccttgtggcagtcttcagcctcctctaccctacatgatctggagca

SEQ ID NO: 99 - DNA, 60 bp, Artificial Sequence
  Oligonucleotide
atataacaacattcagatgactctcccgaaaacttacaccatagctaatcaatttcctct

SEQ ID NO: 100 - DNA, 60 bp, Artificial Sequence
  Oligonucleotide
atatccacacagaagaattgatatcaggttgatacccaaagatcagtattactgtggtgt

SEQ ID NO: 101 - DNA, 60 bp, Artificial Sequence
  Oligonucleotide
atatttacacacagcacatatatgcacaaaatagcctgcccttcccacatgtctccctaa

SEQ ID NO: 102 - DNA, 60 bp, Artificial Sequence
  Oligonucleotide
atatttcactttctctttgactttagaccttttgaagtctgtataaacttgttttgaaat

SEQ ID NO: 103 - DNA, 60 bp, Artificial Sequence
  Oligonucleotide
atcaaccctccgcccgacacgaggctggagcccagtgacattgtctatctcatccgctcc

SEQ ID NO: 104 - DNA, 60 bp, Artificial Sequence
  Oligonucleotide
atcacgcgcccctgatggaacttttctgctgttgtgaagtacttttatccatttgcttct

SEQ ID NO: 105 - DNA, 60 bp, Artificial Sequence
  Oligonucleotide
atctgatgactgctttgtgctggacaacgggctctgtggcaagatctatatctggaaggg

SEQ ID NO: 106 - DNA, 60 bp, Artificial Sequence
  Oligonucleotide
atgacaatgcttctctgtgactcaaaccaggaatttccaaagatttcaagccagggagaa

SEQ ID NO: 107 - DNA, 60 bp, Artificial Sequence
  Oligonucleotide
atgacgatgaggatgacaccccagtgaagacggttctgtcctccccatgtgactcccggg

SEQ ID NO: 108 - DNA, 60 bp, Artificial Sequence
  Oligonucleotide
atgactctgcccatccccatcctttcagcacaactccgttattgtggaagaaatgtcatt

SEQ ID NO: 109 - DNA, 60 bp, Artificial Sequence
  Oligonucleotide
atgagatagtcttataagaatcacgattttctacacctgtcattgagccaagaaagtcca

SEQ ID NO: 110 - DNA, 60 bp, Artificial Sequence
  Oligonucleotide
atgcagagggacaaagggctgtgctacacttcccagttacattctgaagctcataaatgt

SEQ ID NO: 111 - DNA, 60 bp, Artificial Sequence
  Oligonucleotide
atgcgcgagatcgctcaggactttaagaccgacctgcgcttccagagctcggccgtgatg

SEQ ID NO: 112 - DNA, 60 bp, Artificial Sequence
  Oligonucleotide
atgctcagcgtgaggctggagcagcagctgacagtggcagtcctggcccagggtgacggt

SEQ ID NO: 113 - DNA, 60 bp, Artificial Sequence
  Oligonucleotide
atggaacctactgcaaaaagattgtccaaaatgcctaagaaaatactcctctgatgcatt

SEQ ID NO: 114 - DNA, 60 bp, Artificial Sequence
  Oligonucleotide
atggaatttgtaagtttatgtctaaagagctttagtcctagaggacctgagtctgctata

SEQ ID NO: 115 - DNA, 60 bp, Artificial Sequence
  Oligonucleotide
atggccgccgccaagcagtgcaagggcatcgtggactgcatcgtccgcatccccaaagat

SEQ ID NO: 116 - DNA, 60 bp, Artificial Sequence
  Oligonucleotide
atggcttcatcgacaaggaagatttgcatgatatgcttgcttctctagggaagaatccca

SEQ ID NO: 117 - DNA, 60 bp, Artificial Sequence
  Oligonucleotide
atgggatttggcctttttgattaaattcctgctcccctgcaaataaagcctttttacaca

SEQ ID NO: 118 - DNA, 60 bp, Artificial Sequence
  Oligonucleotide
atgggcgcagaggcttttccagtgtgtataaatccatgaaaataaacgccacctgcaccc

SEQ ID NO: 119 - DNA, 60 bp, Artificial Sequence
  Oligonucleotide
atgtcaaaggaaatcagcagtgatagatgaagggttcgcagcgagagtcccggacttgtc

SEQ ID NO: 120 - DNA, 60 bp, Artificial Sequence
  Oligonucleotide
atgtctgtgcagccttacactctgtctttacagaagcaaatagtacacaaaagatctatt

SEQ ID NO: 121 - DNA, 60 bp, Artificial Sequence
  Oligonucleotide
attctctaaagaatcagattggagataaagaaaagctgggaggtaaactttcctctgaag

SEQ ID NO: 122 - DNA, 60 bp, Artificial Sequence
  Oligonucleotide
attgagacacattacctgaataagcaggtgaaagccatcaaagaattgggtgagcacgtg

SEQ ID NO: 123 - DNA, 60 bp, Artificial Sequence
  Oligonucleotide
atttaaagagatctgtgtactgtttacttcccacttcccagaatcccttgtatctccttt

SEQ ID NO: 124 - DNA, 60 bp, Artificial Sequence
  Oligonucleotide
atttgcctgatttaagtgtctgagaaacaaatctttgttctcttaggctgcaatggaaca

SEQ ID NO: 125 - DNA, 60 bp, Artificial Sequence
  Oligonucleotide
atttgtaaacctgtctctaatttgtaattttgtaaaccctgtctctcatattttgtaaaa

SEQ ID NO: 126 - DNA, 60 bp, Artificial Sequence
  Oligonucleotide
atttgtatcatgtaatgaactaaaccacctgtaattttgtaccgtatgtgtctttccatc

SEQ ID NO: 127 - DNA, 60 bp, Artificial Sequence
  Oligonucleotide
atttgtttaaatgtctacattctttctaataaactgttggaagacttcttggctgtcctt

SEQ ID NO: 128 - DNA, 60 bp, Artificial Sequence
  Oligonucleotide
caaaaagtgcgttagaaacacttcaagaagaaaagcctgagctgaccgtcgtctttgagc

SEQ ID NO: 129 - DNA, 60 bp, Artificial Sequence
  Oligonucleotide
caaatgtcatgagaagtttgattcagtaacttgtgatggaggattctttggtatcttact

SEQ ID NO: 130 - DNA, 60 bp, Artificial Sequence
  Oligonucleotide
caacatctttcctcctgtggtcaacatcacatggctgagcaatgggcagtcagtcacaga

SEQ ID NO: 131 - DNA, 60 bp, Artificial Sequence
  Oligonucleotide
caacccggcctacatggatgccccgaagcggccctctgagcattccctggcctctctggc

SEQ ID NO: 132 - DNA, 60 bp, Artificial Sequence
  Oligonucleotide
caacgcggcccccagcgggtgtcaccctgctccctcgtgggtcgcctgcgcccacaccgg

SEQ ID NO: 133 - DNA, 60 bp, Artificial Sequence
  Oligonucleotide
caacttctccgactctaccagctgatgctcttcaccctgccagggacccctgttttcagc

SEQ ID NO: 134 - DNA, 60 bp, Artificial Sequence
  Oligonucleotide
caagacgatccgggtaaagttccagggaggccgcgaagccagtggaatcctgaagggctt

SEQ ID NO: 135 - DNA, 60 bp, Artificial Sequence
  Oligonucleotide
caagagactcttccaaggcactaccaatatgttatctccagatgccgcgcaactgtctga

SEQ ID NO: 136 - DNA, 60 bp, Artificial Sequence
  Oligonucleotide
caagctacagcgaaagcttcctgtggagtcgatccagattgtattagaggaactgaggaa

SEQ ID NO: 137 - DNA, 60 bp, Artificial Sequence
  Oligonucleotide
caatgtacatatcctaactttaccacacatattcgaacctacagctcactgcctggccca

SEQ ID NO: 138 - DNA, 60 bp, Artificial Sequence
  Oligonucleotide
caatttgcaaacttagtgctacatcagactgtggagcgtattcatgtgggcaaaaaatac

SEQ ID NO: 139 - DNA, 60 bp, Artificial Sequence
  Oligonucleotide
cacaaaagaacgattttcagtgcccccagcaaggctgcaccctccttgatcatcacaggg

SEQ ID NO: 140 - DNA, 60 bp, Artificial Sequence
  Oligonucleotide
caccatcaacaccttggtggagaacaaagaaagctcagctggtggtgactgcacacgtgg

SEQ ID NO: 141 - DNA, 60 bp, Artificial Sequence
  Oligonucleotide
cacctattgaccatactacaatgaatgatgatgccaggacagaactgtaccgctctcttt

SEQ ID NO: 142 - DNA, 60 bp, Artificial Sequence
  Oligonucleotide
cagcacttaccgatccagagcctcccggccttctccggtgtcctgtaccaactcttctat

SEQ ID NO: 143 - DNA, 60 bp, Artificial Sequence
  Oligonucleotide
cagccgagatgctttatggattgatccacgcccgctacatccttaccaaccgtggcatcg

SEQ ID NO: 144 - DNA, 60 bp, Artificial Sequence
  Oligonucleotide
cagcgaactatggctcttcctgtaggacgaggaatgtttaccttgttttcgtaccatcct

SEQ ID NO: 145 - DNA, 60 bp, Artificial Sequence
  Oligonucleotide
cagctactgccacttcgccttacatccctgctgactgcccagagactcagaggaaataaa

SEQ ID NO: 146 - DNA, 60 bp, Artificial Sequence
  Oligonucleotide
caggcatgcagaaggctctgtgtgcagccccagacctgggtaccttcgtcaccgtcctca

SEQ ID NO: 147 - DNA, 60 bp, Artificial Sequence
  Oligonucleotide
caggcattcgagaagtaccgcctgcgggtgaagaacttcggcatctggctgcgctacaaa

SEQ ID NO: 148 - DNA, 60 bp, Artificial Sequence
  Oligonucleotide
cagtcccttgttccaaaaattggaaaatgaccagattgaaagtttaaggcagcgctttgg

SEQ ID NO: 149 - DNA, 60 bp, Artificial Sequence
  Oligonucleotide
cagtgaaggtagaggaacccagatagaagaaaatcctttggaagaaaatattctggcggg

SEQ ID NO: 150 - DNA, 60 bp, Artificial Sequence
  Oligonucleotide
cagttgaaaattaggttctaagttgttcttgcaggaattagcctccccgtctcccaaaac

SEQ ID NO: 151 - DNA, 60 bp, Artificial Sequence
  Oligonucleotide
catacaaatctgatgttaatgtttgctcttagaagtcatactccatggtcttcaaagacc

SEQ ID NO: 152 - DNA, 60 bp, Artificial Sequence
  Oligonucleotide
catcccatttggtagtctagctgactccatcagtattaacctccccgctcctcctaacct

SEQ ID NO: 153 - DNA, 60 bp, Artificial Sequence
  Oligonucleotide
catccttcaatatagtgcctttaacttcccgtgtgaaacctgatcctccacatattaaaa

SEQ ID NO: 154 - DNA, 60 bp, Artificial Sequence
  Oligonucleotide
catggagggtgtagaagagaagaagaaggaggttcctgctgtgccagaaacccttaagaa

SEQ ID NO: 155 - DNA, 60 bp, Artificial Sequence
  Oligonucleotide
catggttcttcaggtcccccaggaatcagaaactatccctcttgtgatgaaagctgtctc

SEQ ID NO: 156 - DNA, 60 bp, Artificial Sequence
  Oligonucleotide
catgtcccaggacagtgttacttcttctgcatgatgtgtggtagactccctttgctggct

SEQ ID NO: 157 - DNA, 60 bp, Artificial Sequence
  Oligonucleotide
ccaaaaaggcagcgttgaaaggtgtccacagccacataaaaaagaagacccgcacgtcac

SEQ ID NO: 158 - DNA, 60 bp, Artificial Sequence
  Oligonucleotide
ccaacactacccaggactcttgctacctggttccaactccagacaaccactatgccaggc

SEQ ID NO: 159 - DNA, 60 bp, Artificial Sequence
  Oligonucleotide
ccaacatctccagctggatcccagggaaatatcagccttgggcaactgcagtgaccaggg

SEQ ID NO: 160 - DNA, 60 bp, Artificial Sequence
  Oligonucleotide
ccaagctgactcctgaggaagaagagattttgaacaaaaagcgatctaaaaaaattcaga

SEQ ID NO: 161 - DNA, 60 bp, Artificial Sequence
  Oligonucleotide
ccacaaggcaaagggcaagtgaggctgacgtccggcccaagtgggcccagcccggcccgc

SEQ ID NO: 162 - DNA, 60 bp, Artificial Sequence
  Oligonucleotide
ccaccgctagggtctccacaggcgccctccctccgcgccctccctccccctcgagccgcc

SEQ ID NO: 163 - DNA, 60 bp, Artificial Sequence
  Oligonucleotide
ccaccttcacctttagcttcttgaaaatgggcccctgcagaataaatctgccagttttta

SEQ ID NO: 164 - DNA, 60 bp, Artificial Sequence
  Oligonucleotide
ccactgtggcctgctgggaactgggctgtggaaaggtccggcctcgagtaggcaaaaccc

SEQ ID NO: 165 - DNA, 60 bp, Artificial Sequence
  Oligonucleotide
ccagaatgttacaggatgtagtaattactataactttttgcggtgcacggaacctgagga

SEQ ID NO: 166 - DNA, 60 bp, Artificial Sequence
  Oligonucleotide
ccagagaaagtcctcgctcgtcaccagcaagcttgcgggtggccaagttgaatgatgctg

SEQ ID NO: 167 - DNA, 60 bp, Artificial Sequence
  Oligonucleotide
ccagccccctgacggtttacagatgccatggcaacatcaggaagttaccctctatgctct

SEQ ID NO: 168 - DNA, 60 bp, Artificial Sequence
  Oligonucleotide
ccagtgaaccactgagctcgcactgtagccagtcctgtgtgcccctgctggattctgctt

SEQ ID NO: 169 - DNA, 60 bp, Artificial Sequence
  Oligonucleotide
ccatcaccaaaggtggagcagccaaaatgaagtacaatccctttgtgacttctgaccgaa

SEQ ID NO: 170 - DNA, 60 bp, Artificial Sequence
  Oligonucleotide
ccatcactccatcaaagtccctggctataagatctggattttacccactccatcttctct

SEQ ID NO: 171 - DNA, 60 bp, Artificial Sequence
  Oligonucleotide
ccatgccagtcaggcgggcttgccatgttctgtgaatctcgagtgagcggtgccacccgc

SEQ ID NO: 172 - DNA, 60 bp, Artificial Sequence
  Oligonucleotide
ccatggaagtttgaccccaacgagatcaaagtcatatacctgaggtgcaccaggagtgaa

SEQ ID NO: 173 - DNA, 60 bp, Artificial Sequence
  Oligonucleotide
ccatttaaaaaactatgctgctgctctagaaacttttataggaggacaaaaattagtaag

SEQ ID NO: 174 - DNA, 60 bp, Artificial Sequence
  Oligonucleotide
cccaatgctttcactcttatctaccctttggcacttatcttgcttatcaacataataatt

SEQ ID NO: 175 - DNA, 60 bp, Artificial Sequence
  Oligonucleotide
cccacttgcacctctccacctttggcactagaactcctgagacaccacttctcatgcttc

SEQ ID NO: 176 - DNA, 60 bp, Artificial Sequence
  Oligonucleotide
cccaggatgactactcggtcctgtttgaagacacctcctatgcagatggctattcccctc

SEQ ID NO: 177 - DNA, 60 bp, Artificial Sequence
  Oligonucleotide
cccagtcttatctgtgcctttactgctttgcgcatctcagatgctaacttggttcttttt

SEQ ID NO: 178 - DNA, 60 bp, Artificial Sequence
  Oligonucleotide
ccccacgccatgcggcacatccaggagcactacggcgggactgccaccttctacctctct

SEQ ID NO: 179 - DNA, 60 bp, Artificial Sequence
  Oligonucleotide
ccccgcacaccgtgagctacccggacaatctgacctaccgcgatctctactacttcctct

SEQ ID NO: 180 - DNA, 60 bp, Artificial Sequence
  Oligonucleotide
cccctggaagagtgattctaatcaggtattttcctacaaagtttggactgtgtcttcttc

SEQ ID NO: 181 - DNA, 60 bp, Artificial Sequence
  Oligonucleotide
cccttagcaatccggcctcgcaggctgtactttcatggtgctctctaccttctggccccc

SEQ ID NO: 182 - DNA, 60 bp, Artificial Sequence
  Oligonucleotide
cccttccaaaaactacaatatgatgactgtatcaggttaagatatagtctgtggatggat

SEQ ID NO: 183 - DNA, 60 bp, Artificial Sequence
  Oligonucleotide
ccctttcattagaacttcaagctctccaaaggctcagattataactgttgtcatatttat

SEQ ID NO: 184 - DNA, 60 bp, Artificial Sequence
  Oligonucleotide
ccctttttggcctgaagacattttagaatttcctaacagagtttactgttgtttagaaat

SEQ ID NO: 185 - DNA, 60 bp, Artificial Sequence
  Oligonucleotide
ccgcctccattgcaacatcttctacgactactccggctacggtgccagcgcgggcaggcc

SEQ ID NO: 186 - DNA, 60 bp, Artificial Sequence
  Oligonucleotide
ccggatccttcgtgtccccacagcacgtttcttgaagcaggataagtttgagtgtcattt

SEQ ID NO: 187 - DNA, 60 bp, Artificial Sequence
  Oligonucleotide
ccgggcgactgcgaagtttgtatttcttatctgggaagattttaccaggacctcaaagac

SEQ ID NO: 188 - DNA, 60 bp, Artificial Sequence
  Oligonucleotide
cctccaccagcatttcccttactctgaagttccggcattcacatcattcatgttttcttt

SEQ ID NO: 189 - DNA, 60 bp, Artificial Sequence
  Oligonucleotide
cctcccggaagagcttcaagagctaagaacctgctgcaagtcactgccttccaagtgcag

SEQ ID NO: 190 - DNA, 60 bp, Artificial Sequence
  Oligonucleotide
cctcctcacttggataaaaagcagatttgccttagtgctgcatgtctgtctgggagaggg

SEQ ID NO: 191 - DNA, 60 bp, Artificial Sequence
  Oligonucleotide
cctgaaaaccaagctttgatttagattgagtaagatttacccagaatgtcagattccttt

SEQ ID NO: 192 - DNA, 60 bp, Artificial Sequence
  Oligonucleotide
cctgccaaacaagctaatatggaaaccacatgtaacttagccagactataccttgtgtag

SEQ ID NO: 193 - DNA, 60 bp, Artificial Sequence
  Oligonucleotide
cctgcctaacatgccagcgcagccaacgcttcctcaatgatcccgggcatttactctggg

SEQ ID NO: 194 - DNA, 60 bp, Artificial Sequence
  Oligonucleotide
cctgggcatgatgggccgagccacctcggatcccactgattggccagccgagcgagaacc

SEQ ID NO: 195 - DNA, 60 bp, Artificial Sequence
  Oligonucleotide
cctgtacctgctctatttcagagcttgtggctttgtgtctcccctgctttccccacgcag

SEQ ID NO: 196 - DNA, 60 bp, Artificial Sequence
  Oligonucleotide
cctgtccagcactgcctagtgttggagggtagaccaaggctgtgcatgattcaccccctc

SEQ ID NO: 197 - DNA, 60 bp, Artificial Sequence
  Oligonucleotide
cctgtcccctccaccttccctcacagtgtgtctggtgacaaccgagtggctgtcatcggc

SEQ ID NO: 198 - DNA, 60 bp, Artificial Sequence
  Oligonucleotide
ccttccatttgacctaatttaactggtgaaatttaaagtgaattcatgggctcatcttta

SEQ ID NO: 199 - DNA, 60 bp, Artificial Sequence
  Oligonucleotide
cctttccctgcatatgcttctgatggtgtcatctgctccttcctgtggcctcatccaaac

SEQ ID NO: 200 - DNA, 60 bp, Artificial Sequence
  Oligonucleotide
cgaatgtcctggctgatgctctcaaaaggatcaacaatgcaaaaaagagaagcaaacgcc

SEQ ID NO: 201 - DNA, 60 bp, Artificial Sequence
  Oligonucleotide
cgacctcatgaacaagttcctgacctacttccccgggaggaggatcagcgctgaggacgg

SEQ ID NO: 202 - DNA, 60 bp, Artificial Sequence
  Oligonucleotide
cgcactgccactataaggctcccaccgtggtcttgcacatgactaagacggacccctctt

SEQ ID NO: 203 - DNA, 60 bp, Artificial Sequence
  Oligonucleotide
cgccctgtgggtgcacagcaaccagctctccatgcagtgtgtcaaggatgatgagctcta

SEQ ID NO: 204 - DNA, 60 bp, Artificial Sequence
  Oligonucleotide
cgctagaggtgaaattcttggaccggcgcaagacggaccagagcgaaagcatttgccaag

SEQ ID NO: 205 - DNA, 60 bp, Artificial Sequence
  Oligonucleotide
cgcttactaccttcagtataaaaatgtcaggcctgattatctaaaagctatttggaatgt

SEQ ID NO: 206 - DNA, 60 bp, Artificial Sequence
  Oligonucleotide
cggagccacagacacaggcgtgaacggtgaccgagccccctctgatgctccatgcccctg

SEQ ID NO: 207 - DNA, 60 bp, Artificial Sequence
  Oligonucleotide
cggcagccgaagacactgcgactctggagacagcccaaatatcctcggaagagcgctccc

SEQ ID NO: 208 - DNA, 60 bp, Artificial Sequence
  Oligonucleotide
cggctccgttcgggcaaggatagttactgaccgggaaactgggtcctccaaagggtttgg

SEQ ID NO: 209 - DNA, 60 bp, Artificial Sequence
  Oligonucleotide
cggtgaccttctccacggaatgccggatgcccgacatcgccctgccctcccagtttgtgg

SEQ ID NO: 210 - DNA, 60 bp, Artificial Sequence
  Oligonucleotide
cggtgcatccacgaggacctgctagggctgaccttccggatctctccacacgccttcttc

SEQ ID NO: 211 - DNA, 60 bp, Artificial Sequence
  Oligonucleotide
cgtaccttcccactggcctcaagtgagccaagaaacactgcctgccctctgtctgtcttc

SEQ ID NO: 212 - DNA, 60 bp, Artificial Sequence
  Oligonucleotide
cgtctcctaggtattcattctgtattttgcaagcctcaaaacatacgtgaagttggcttt

SEQ ID NO: 213 - DNA, 60 bp, Artificial Sequence
  Oligonucleotide
cgtgtgttctggctgtagacaacattctttatattgccaacctcggagatagtcgggcaa

SEQ ID NO: 214 - DNA, 60 bp, Artificial Sequence
  Oligonucleotide
ctaaacatggtgatattcttcctaatgctgatgggacatggtatcttcaggtgatcctgg

SEQ ID NO: 215 - DNA, 60 bp, Artificial Sequence
  Oligonucleotide
ctacagacactgggcgccaaggcccaggcacagactgaccgagtgaacctgcggaccctg

SEQ ID NO: 216 - DNA, 60 bp, Artificial Sequence
  Oligonucleotide
ctagttttatgtttcttgggaaaatatcactttgtattctctgtccagggcttcagatat

SEQ ID NO: 217 - DNA, 60 bp, Artificial Sequence
  Oligonucleotide
ctcacccacaggtgccatgtgcacactcctggttttcaaacaattctctggatttattta

SEQ ID NO: 218 - DNA, 60 bp, Artificial Sequence
  Oligonucleotide
ctcacccctgtcctcagagtgataaactaagtcacatacagataaagcactgaaaacacc

SEQ ID NO: 219 - DNA, 60 bp, Artificial Sequence
  Oligonucleotide
ctcatgtatgtctactggactcagctcaacatgttccagaccttgaagtacctggccatc

SEQ ID NO: 220 - DNA, 60 bp, Artificial Sequence
  Oligonucleotide
ctccctggctctcagaaggtattccttttgtgtacagtgtgtaaagtgtaaatccttttt

SEQ ID NO: 221 - DNA, 60 bp, Artificial Sequence
  Oligonucleotide
ctcctcttgactctccagacctaaagtgacacccttcaggcacttcgggcccaattcagc

SEQ ID NO: 222 - DNA, 60 bp, Artificial Sequence
  Oligonucleotide
ctccttcttttccagccccggtaccggaccctgcagccgcagagatgttgatgcctaaga

SEQ ID NO: 223 - DNA, 60 bp, Artificial Sequence
  Oligonucleotide
ctcgaagcagagttgacggacactgctcccaaaaggtcattactcagaataaatgtattt

SEQ ID NO: 224 - DNA, 60 bp, Artificial Sequence
  Oligonucleotide
ctcgagaaccttgtttaaaagcagaagactgcaagattccttcgcctcagaaaccaatct

SEQ ID NO: 225 - DNA, 60 bp, Artificial Sequence
  Oligonucleotide
ctctactgtcgactgaagatccaagtgcgaaaggcagctataaccagctatgagaaatca

SEQ ID NO: 226 - DNA, 60 bp, Artificial Sequence
  Oligonucleotide
ctctctacccttgccgtatctaaggagctgaggtaatacagatccaaggagaattgtata

SEQ ID NO: 227 - DNA, 60 bp, Artificial Sequence
  Oligonucleotide
ctcttgagaacttggctcagggctcctgaggacctttcccagcattaccttcccttccct

SEQ ID NO: 228 - DNA, 60 bp, Artificial Sequence
  Oligonucleotide
ctgaaacttgatggctccgaacaccctcgaagcgcgccactcgcttcccccatagccacc

SEQ ID NO: 229 - DNA, 60 bp, Artificial Sequence
  Oligonucleotide
ctgactctgaaatcaaccttacaaatgtgacagatatcatcagggttccggtgttcaaca

SEQ ID NO: 230 - DNA, 60 bp, Artificial Sequence
  Oligonucleotide
ctgagggcgagaagatccgaaagaaatacccggaccgggtgccggtgatagtagaaaagg

SEQ ID NO: 231 - DNA, 60 bp, Artificial Sequence
  Oligonucleotide
ctgagtgtgttaagatggtattaatcatgtcggtgtcatgtcactaagtttaatgctgct

SEQ ID NO: 232 - DNA, 60 bp, Artificial Sequence
  Oligonucleotide
ctgcctctctggccctctgagatatcccgatgggcacaaatggaaggtgcgcacttgccc

SEQ ID NO: 233 - DNA, 60 bp, Artificial Sequence
  Oligonucleotide
ctgctgggatttgccctcctagagtgcccctcagtcctggaatacaaggtgcaggctgga

SEQ ID NO: 234 - DNA, 60 bp, Artificial Sequence
  Oligonucleotide
ctggctttctcaagagtatggattgacatattgtgttatgaatgcacatctctcagatgt

SEQ ID NO: 235 - DNA, 60 bp, Artificial Sequence
  Oligonucleotide
ctgggcgagcctcccgtgctgcccgtatctcgcatggcctccatcccctccatgatcggg

SEQ ID NO: 236 - DNA, 60 bp, Artificial Sequence
  Oligonucleotide
ctggtctcacgtgccatgcccacttgccacccctgttcgtgaactttgccgacctctttc

SEQ ID NO: 237 - DNA, 60 bp, Artificial Sequence
  Oligonucleotide
ctgtgcctaagaagctgctcatgatggctggtatcgatgactgctacacctcagcccggg

SEQ ID NO: 238 - DNA, 60 bp, Artificial Sequence
  Oligonucleotide
cttaagcaatgtatatgccatgcattaccatgcactaattcaatcacaggtgtttctatc

SEQ ID NO: 239 - DNA, 60 bp, Artificial Sequence
  Oligonucleotide
cttattgctgtgaagggcagacaatgcatggctgatctactctgttaccaatggctttac

SEQ ID NO: 240 - DNA, 60 bp, Artificial Sequence
  Oligonucleotide
cttcacacagccttttgagcacacatgagaatgtatactggagagaaaccctataaatat

SEQ ID NO: 241 - DNA, 60 bp, Artificial Sequence
  Oligonucleotide
cttcagtggaccgaaatctgtattctgtttgcgtacttgtaatatgtatattaagaagca

SEQ ID NO: 242 - DNA, 60 bp, Artificial Sequence
  Oligonucleotide
cttcattgagggcctgtacgacatgcacattcagctgcagagtgtgcccttcctgcactg

SEQ ID NO: 243 - DNA, 60 bp, Artificial Sequence
  Oligonucleotide
cttcccctgccgatcctaaatcaacatcaggagaaatgccggtggttagcttcatcaaaa

SEQ ID NO: 244 - DNA, 60 bp, Artificial Sequence
  Oligonucleotide
cttccgcaaactcacctaccgcggcacagacttggaccagctgcgggacgtgtcctgcga

SEQ ID NO: 245 - DNA, 60 bp, Artificial Sequence
  Oligonucleotide
cttcgcttccgaaaaaactttcaggccctgttggaggagcagaacttgagtgtggccgag

SEQ ID NO: 246 - DNA, 60 bp, Artificial Sequence
  Oligonucleotide
cttgagtcgactggaggctgccaggaattcaggatgcatacagctgtaatttaacccaga

SEQ ID NO: 247 - DNA, 60 bp, Artificial Sequence
  Oligonucleotide
cttgcgctctactctgtagttatgtggattgccgagcaatgacccttttcaatttcttat

SEQ ID NO: 248 - DNA, 60 bp, Artificial Sequence
  Oligonucleotide
cttgtaatatccccttgctcctaacatctacattcccttcgtgtctttgataaattgtat

SEQ ID NO: 249 - DNA, 60 bp, Artificial Sequence
  Oligonucleotide
ctttgaccacctcagtgctcaagaacaatttgtgtccctcgggcagcaacatcatcagca

SEQ ID NO: 250 - DNA, 60 bp, Artificial Sequence
  Oligonucleotide
ctttgagattgtcacttctgtacataaaccacctttgtgaggctctttctataaatacat

SEQ ID NO: 251 - DNA, 60 bp, Artificial Sequence
  Oligonucleotide
ctttgggaagaccatatcctccatactccttggccgatttctcttggaacaacatcactg

SEQ ID NO: 252 - DNA, 60 bp, Artificial Sequence
  Oligonucleotide
ctttgtaaagtactaccatgctaagaacggccgtgcttatgtggaatccccagcccggaa

SEQ ID NO: 253 - DNA, 60 bp, Artificial Sequence
  Oligonucleotide
ctttgtttctgtcccctccgaggagtcattttggtcgacaggctctcaaggcaactcccc

SEQ ID NO: 254 - DNA, 60 bp, Artificial Sequence
  Oligonucleotide
cttttcccgagaggctgacaatgttaaagacaaactttgcagtaagcgaacagatctttg

SEQ ID NO: 255 - DNA, 60 bp, Artificial Sequence
  Oligonucleotide
cttttgggaagaaatcagcggagaacctttatgctttatcagaggccccatccccagaat

SEQ ID NO: 256 - DNA, 60 bp, Artificial Sequence
  Oligonucleotide
cttttttaagtgttttctatccgttatccatttcacccttggcctatccctctcagatag

SEQ ID NO: 257 - DNA, 60 bp, Artificial Sequence
  Oligonucleotide
gaaaaaatgtgggaagcttggattttcactctcacctggcagtcatgaggtgcttctctc

SEQ ID NO: 258 - DNA, 60 bp, Artificial Sequence
  Oligonucleotide
gaaaccataccgaagacctaagttctgtcgaaaaatgaagtgatgctcgcgtttttaata

SEQ ID NO: 259 - DNA, 60 bp, Artificial Sequence
  Oligonucleotide
gaaagcgagccctcagctcagcccaggatccccagaatgcccttaggcccccaggaaggg

SEQ ID NO: 260 - DNA, 60 bp, Artificial Sequence
  Oligonucleotide
gaaagttgttgtatactgttaacgattgtctgcccatgtcctgcctgaaataccatgatt

SEQ ID NO: 261 - DNA, 60 bp, Artificial Sequence
  Oligonucleotide
gaacaaaatgcagctcctaccctcctcgggctttagttgtaccttaataacaggaatttt

SEQ ID NO: 262 - DNA, 60 bp, Artificial Sequence
  Oligonucleotide
gaacgtgcctctctcttgcttacaaatgtctaaggtccccactgcctgctggagagaaaa

SEQ ID NO: 263 - DNA, 60 bp, Artificial Sequence
  Oligonucleotide
gaactaccagtccaagaatctgtttaaaattcagacttcaaatagtgtcaaataaaaagt

SEQ ID NO: 264 - DNA, 60 bp, Artificial Sequence
  Oligonucleotide
gaacttgatcctgaaaagccatctgattcactttctgcaagccttggacttcaattagtt

SEQ ID NO: 265 - DNA, 60 bp, Artificial Sequence
  Oligonucleotide
gaagctggcccacacctatcaaagccccctgctctactgtgacctggaggtggaaggctt

SEQ ID NO: 266 - DNA, 60 bp, Artificial Sequence
  Oligonucleotide
gaagtccaagcaacagcctttgaatgtaaccaatcctactaataaaccagttctgaaggt

SEQ ID NO: 267 - DNA, 60 bp, Artificial Sequence
  Oligonucleotide
gacaataaaaggtggcgtttttgtactttacctggattccattggctggttttaccactc

SEQ ID NO: 268 - DNA, 60 bp, Artificial Sequence
  Oligonucleotide
gacagaaagtaaatctatggatatggtattttgtgaatgatcttttaaataaaagaaaac

SEQ ID NO: 269 - DNA, 60 bp, Artificial Sequence
  Oligonucleotide
gacatacgactctatttcctacagtgcgaaacttgtcattctagatgttctgttgccagt

SEQ ID NO: 270 - DNA, 60 bp, Artificial Sequence
  Oligonucleotide
gacattgagcttgtttcaaattcagcggctttgattcagcaagccacaacagttaaaaac

SEQ ID NO: 271 - DNA, 60 bp, Artificial Sequence
  Oligonucleotide
gaccaagtgcatctactgcggcttctgccaggaggcctgtcccgtggatgccatcgtcga

SEQ ID NO: 272 - DNA, 60 bp, Artificial Sequence
  Oligonucleotide
gaccacctcccccgactgccactctggacctaatagctgttccttaggccccactccatg

SEQ ID NO: 273 - DNA, 60 bp, Artificial Sequence
  Oligonucleotide
gaccagtcccattcagatccggcttggacaggcacctgagatggtgccaaagtgcagctg

SEQ ID NO: 274 - DNA, 60 bp, Artificial Sequence
  Oligonucleotide
gaccctgtcaacacccgcgacccgtctgcctggccgtaagtttggtatctggctttttct

SEQ ID NO: 275 - DNA, 60 bp, Artificial Sequence
  Oligonucleotide
gaccgctacccccgcaaagtgacagctgccatgggcaagaagaagatcgccaagagatca

SEQ ID NO: 276 - DNA, 60 bp, Artificial Sequence
  Oligonucleotide
gacctcctgcccgaaccgcggatcctgcagaaactcgctgtgcccatcatcgacacaccc

SEQ ID NO: 277 - DNA, 60 bp, Artificial Sequence
  Oligonucleotide
gacgcctcgctggccatcaaacccgtatttgagcgtttccagtctgtcatcatcacatct

SEQ ID NO: 278 - DNA, 60 bp, Artificial Sequence
  Oligonucleotide
gactctgagctgtgttaaggagaacaagggcaaggagacctccctttgtgctccctcact

SEQ ID NO: 279 - DNA, 60 bp, Artificial Sequence
  Oligonucleotide
gactcttcgaagacaccaatctgtgcgctattcacgctaaacgcgtcaccatcatgccca

SEQ ID NO: 280 - DNA, 60 bp, Artificial Sequence
  Oligonucleotide
gagagcgagcctgagctctgctcccttgatctcctctgcgtctctgctggatggcagggc

SEQ ID NO: 281 - DNA, 60 bp, Artificial Sequence
  Oligonucleotide
gagaggcatctgtctgccgaggacttctcaagggtatttgccatgtcccctgaagagttt

SEQ ID NO: 282 - DNA, 60 bp, Artificial Sequence
  Oligonucleotide
gagattcaccggcgagcccacttgtcagaaaacgagctagaagcactagagaagaatgac

SEQ ID NO: 283 - DNA, 60 bp, Artificial Sequence
  Oligonucleotide
gagcccccttcagtcgcagcctcactctaggatgaagcctgctgggagcgtgaatgacat

SEQ ID NO: 284 - DNA, 60 bp, Artificial Sequence
  Oligonucleotide
gagcctctagtccaccctctccagtggtcactcttgagtcacatctgtcacttaattatt

SEQ ID NO: 285 - DNA, 60 bp, Artificial Sequence
  Oligonucleotide
gagccttggcccacactgaggcttaggcctctctgcctgggatgggctcccaccctcccc

SEQ ID NO: 286 - DNA, 60 bp, Artificial Sequence
  Oligonucleotide
gagcgcttccaccgcttccagcccacctatccgtacctgcagcacgagatcgacctgcca

SEQ ID NO: 287 - DNA, 60 bp, Artificial Sequence
  Oligonucleotide
gaggacttttgtctgggattggtcatcactcttctgtaatgcccacctgcccctgcccag

SEQ ID NO: 288 - DNA, 60 bp, Artificial Sequence
  Oligonucleotide
gaggaggagatcaccaagtttgaggagcacgtgcagagtgtcgatatcgcagctttcaac

SEQ ID NO: 289 - DNA, 60 bp, Artificial Sequence
  Oligonucleotide
gaggtttccaaatcaaatatgttgcaatggatcctgtatccaaatccagtcaaggaaaaa

SEQ ID NO: 290 - DNA, 60 bp, Artificial Sequence
  Oligonucleotide
gagtatgctcgctatgagaatggacactactcttaccgcatccaccggtccccgctctgt

SEQ ID NO: 291 - DNA, 60 bp, Artificial Sequence
  Oligonucleotide
gagtcccctaccatgactgaaggcgccagagactggcggtgtcttaagactccgggcacc

SEQ ID NO: 292 - DNA, 60 bp, Artificial Sequence
  Oligonucleotide
gagtcctatgtgggatgaatagcttcagcctttgcgcttgcacctctttgctgtccactc

SEQ ID NO: 293 - DNA, 60 bp, Artificial Sequence
  Oligonucleotide
gagtctgctttcttctactgccctgagcctgaacgcttctgcttaatctgagaatcacat

SEQ ID NO: 294 - DNA, 60 bp, Artificial Sequence
  Oligonucleotide
gagttgtctttgtactcttgagttgtaccttattcttccacttggcctgagtttttataa

SEQ ID NO: 295 - DNA, 60 bp, Artificial Sequence
  Oligonucleotide
gagtttataactataatcacctaatgcccacaaggtactctgtggatatccccttgaaca

SEQ ID NO: 296 - DNA, 60 bp, Artificial Sequence
  Oligonucleotide
gatagctgtcctgttagaatcagaaatcggtgtgttatgacgtcccgtccgcgtggtgtg

SEQ ID NO: 297 - DNA, 60 bp, Artificial Sequence
  Oligonucleotide
gatccaactgcacccatgggaaatctgaacttccactttctttgagcttgtctttggttg

SEQ ID NO: 298 - DNA, 60 bp, Artificial Sequence
  Oligonucleotide
gatccagcaggtcctcaaagactgtatcgtccacctctgcatctccaagcccgaacgccc

SEQ ID NO: 299 - DNA, 60 bp, Artificial Sequence
  Oligonucleotide
gatcccttgttttcctgtcagttggacccctcacctggcctccagggaagaatgcagaga

SEQ ID NO: 300 - DNA, 60 bp, Artificial Sequence
  Oligonucleotide
gatgaagagagcattttccactgagaaatagaagtttgattaaaaatcaaccttgcttca

SEQ ID NO: 301 - DNA, 60 bp, Artificial Sequence
  Oligonucleotide
gatgatgctctcccgccactgaggctccaggagggaatatctgttgcccctgcggcccca

SEQ ID NO: 302 - DNA, 60 bp, Artificial Sequence
  Oligonucleotide
gatgcagatgactttggcctacagttcccgctggacctggatgtgagggtgaaggctgtg

SEQ ID NO: 303 - DNA, 60 bp, Artificial Sequence
  Oligonucleotide
gatgcgtgggctgacatctgcaggccgaaagagccgtggccttggaaagggccataagtt

SEQ ID NO: 304 - DNA, 60 bp, Artificial Sequence
  Oligonucleotide
gatgtttgagtccgagtcctaggccactcgctgcccctacgcctgccccggtgcccggct

SEQ ID NO: 305 - DNA, 60 bp, Artificial Sequence
  Oligonucleotide
gattatattggttctgcctctggcatgctggtagactagggccatcctaacttattattt

SEQ ID NO: 306 - DNA, 60 bp, Artificial Sequence
  Oligonucleotide
gattcccatacactggacagccaagttaccagccaagtggtcagtctcagagtcctcccc

SEQ ID NO: 307 - DNA, 60 bp, Artificial Sequence
  Oligonucleotide
gcaaaattgctaaagagagatgaaccacattataaagtaatctttggctgtaaggcattt

SEQ ID NO: 308 - DNA, 60 bp, Artificial Sequence
  Oligonucleotide
gcaaccgaattccagtttagaggcagatgtggtcgtggacgtggtcagccacctcaataa

SEQ ID NO: 309 - DNA, 60 bp, Artificial Sequence
  Oligonucleotide
gcaagaacaagtaccgccccgacctgcgcatggcagccatccgcagggccagcgccatcc

SEQ ID NO: 310 - DNA, 60 bp, Artificial Sequence
  Oligonucleotide
gcaatcaagtgggcttcatcaatttaatttcttctctttgagtaaatgaagattcagact

SEQ ID NO: 311 - DNA, 60 bp, Artificial Sequence
  Oligonucleotide
gcaatggattcaagttcgaaatatggcaactttgaaagatatcaccaggagactaaagtc

SEQ ID NO: 312 - DNA, 60 bp, Artificial Sequence
  Oligonucleotide
gcaccagcaccttggaagcaccaataaagaggatgcccacgtggccccagcaatcagaag

SEQ ID NO: 313 - DNA, 60 bp, Artificial Sequence
  Oligonucleotide
gcagaagcatcggtgctgatactcttcaataaaatcgacctaccctgttacatgtccacg

SEQ ID NO: 314 - DNA, 60 bp, Artificial Sequence
  Oligonucleotide
gcaggaacctgccagttctccttggtgcaaaaatctgaccctcggctgccctgcaaaggg

SEQ ID NO: 315 - DNA, 60 bp, Artificial Sequence
  Oligonucleotide
gcagtgtgaactctttattcactcccagcctgtcctgtggcctgtcccactgtgtgcact

SEQ ID NO: 316 - DNA, 60 bp, Artificial Sequence
  Oligonucleotide
gcatgactattcagatggctactgagttatcagtggccatttattagcatcatatttatt

SEQ ID NO: 317 - DNA, 60 bp, Artificial Sequence
  Oligonucleotide
gcatgcctggaagttgtcatgtttgtgccacgtttcagttcagttctgaagtgttattaa

SEQ ID NO: 318 - DNA, 60 bp, Artificial Sequence
  Oligonucleotide
gcatgtgagtgcccccagaactgtcctggctccttccgtattaaacgcatttgcattttg

SEQ ID NO: 319 - DNA, 60 bp, Artificial Sequence
  Oligonucleotide
gcattggaaggcataagacctacctgtgctacgaagtggagcgcctggacaatggcacct

SEQ ID NO: 320 - DNA, 60 bp, Artificial Sequence
  Oligonucleotide
gccaaccatggtgaacttgggtctgtcccgggtggacgacgccgtggctgccaagcaccc

SEQ ID NO: 321 - DNA, 60 bp, Artificial Sequence
  Oligonucleotide
gccacaagcctgaatttctcagtgttggtaagtttctttacctaccctcactatatatta

SEQ ID NO: 322 - DNA, 60 bp, Artificial Sequence
  Oligonucleotide
gcccagtcttctatcccccacctaaaaagaccaagcattgatgcccaagttttggaaata

SEQ ID NO: 323 - DNA, 60 bp, Artificial Sequence
  Oligonucleotide
gcccgacgtgacctccacccctagtgcctgtgatctgactctgcccgacgtgacctccac

SEQ ID NO: 324 - DNA, 60 bp, Artificial Sequence
  Oligonucleotide
gccctacatatgtgaacattgtggcagagcttttaaccaatcctcgaaccttactaaaca

SEQ ID NO: 325 - DNA, 60 bp, Artificial Sequence
  Oligonucleotide
gccctagtgtgtaaatgacttggatctccctcctggcagactgtgaccctcagcacaggg

SEQ ID NO: 326 - DNA, 60 bp, Artificial Sequence
  Oligonucleotide
gccgcccagaaaatgccatcatctataacaacaatgaggacttccaggtcggacaagcca

SEQ ID NO: 327 - DNA, 60 bp, Artificial Sequence
  Oligonucleotide
gccgccctggctgtgtgtgaaacatttggagatacctggagtacggacagtcacctctga

SEQ ID NO: 328 - DNA, 60 bp, Artificial Sequence
  Oligonucleotide
gccggagaaactgcccagcagatctgtgaggacctcaggttgtgtataccttctacaggt

SEQ ID NO: 329 - DNA, 60 bp, Artificial Sequence
  Oligonucleotide
gcctattggtatctgtgtatatttacgttaaacacaattatgttacctaagcctctggtg

SEQ ID NO: 330 - DNA, 60 bp, Artificial Sequence
  Oligonucleotide
gcgctaacagagctggagattctagatatttcttttaatctgctgagaaacatcgaaggg

SEQ ID NO: 331 - DNA, 60 bp, Artificial Sequence
  Oligonucleotide
gcgctgccatcatccagccactgcagtcgccgctgccgcgcccctgagcccgggtccctg

SEQ ID NO: 332 - DNA, 60 bp, Artificial Sequence
  Oligonucleotide
gcggccagtttcaggtccagtgagcatgagaatgcctatgagaatgtgcccgaggaggaa

SEQ ID NO: 333 - DNA, 60 bp, Artificial Sequence
  Oligonucleotide
gcggcggcaacgcggtggcctgtccggtgtgccgcgcgcccacgcgcctggccccccgcc

SEQ ID NO: 334 - DNA, 60 bp, Artificial Sequence
  Oligonucleotide
gcgggcctccgtggagctcctggatgagatgaagttctcgctggagaagctgcaccaagg

SEQ ID NO: 335 - DNA, 60 bp, Artificial Sequence
  Oligonucleotide
gctaagctgaataatgacaaagttgaaaggaccaatacagccccttttataaggattttg

SEQ ID NO: 336 - DNA, 60 bp, Artificial Sequence
  Oligonucleotide
gctagaaatgactcctgaacttggacatgtctacacctgccttgtcgatcactccagcct

SEQ ID NO: 337 - DNA, 60 bp, Artificial Sequence
  Oligonucleotide
gctgaaggtacaagaagaaatgcttaaggaagaatttcaaaagaaatctgagcagttaaa

SEQ ID NO: 338 - DNA, 60 bp, Artificial Sequence
  Oligonucleotide
gctgcctcaagtcctggaagccaaatcacaaagactattacaactgctctgccatggtaa

SEQ ID NO: 339 - DNA, 60 bp, Artificial Sequence
  Oligonucleotide
gctgtacagttcagtagagtggtcactttcactgcagtatacatttatctacacattata

SEQ ID NO: 340 - DNA, 60 bp, Artificial Sequence
  Oligonucleotide
gctgtgctcttttcaagccatgtccgcaaggtgaaccgcttccacaagatccggaaccgg

SEQ ID NO: 341 - DNA, 60 bp, Artificial Sequence
  Oligonucleotide
gcttctaccctcatacccacaatatggatgggttcttcattgccaagttcaagaaatttt

SEQ ID NO: 342 - DNA, 60 bp, Artificial Sequence
  Oligonucleotide
ggaaagccctggagggaatcacatgtgtactttttcatgaagctttttgcaaagcacatc

SEQ ID NO: 343 - DNA, 60 bp, Artificial Sequence
  Oligonucleotide
ggaaccagggcatcgaggctgcgatggactggctgatggagcacgaagacgaccccgatg

SEQ ID NO: 344 - DNA, 60 bp, Artificial Sequence
  Oligonucleotide
ggaataacgaggacatttccatcatcccgcctctgtttacagtcagcgtggaccatcggg

SEQ ID NO: 345 - DNA, 60 bp, Artificial Sequence
  Oligonucleotide
ggaatgggcgagacattgctgcaaagaagtcaagcttttttcagacaaaaggtgtgaggg

SEQ ID NO: 346 - DNA, 60 bp, Artificial Sequence
  Oligonucleotide
ggagacctgaagttgctctttgagtacctgaccctatttggcattgatgacaaaatctcc

SEQ ID NO: 347 - DNA, 60 bp, Artificial Sequence
  Oligonucleotide
ggagatctatctcttctctctgcccattaaggaatcagagatcattgactttttcctggg

SEQ ID NO: 348 - DNA, 60 bp, Artificial Sequence
  Oligonucleotide
ggagctactgaaggtctccaaggacaaacaggccctcaaatttatcaagaaaagggtggg

SEQ ID NO: 349 - DNA, 60 bp, Artificial Sequence
  Oligonucleotide
ggagctgtcaagccctgcattgcctccccctggacgtctcattatgggagaaaatgaagc

SEQ ID NO: 350 - DNA, 60 bp, Artificial Sequence; identical to SEQ ID NO: 327
  Oligonucleotide

SEQ ID NO: 351 - DNA, 60 bp, Artificial Sequence
  Oligonucleotide
ggatgggtccaacgtggtctttaaacttctgggtccggtgctagtcaaacaggagctggg

SEQ ID NO: 352 - DNA, 60 bp, Artificial Sequence
  Oligonucleotide
ggcaagtcagagcattagcagctatttaaattggtatcagcagaaaccagggaaagcccc

SEQ ID NO: 353 - DNA, 60 bp, Artificial Sequence
  Oligonucleotide
ggcagcgtggatctgcccacacataggctactggaatagtttaacccagcaactttcctt

SEQ ID NO: 354 - DNA, 60 bp, Artificial Sequence
  Oligonucleotide
ggcagcttgcagtccgtggtgatgaagagttggattctcttatcaaggctaccacagctg

SEQ ID NO: 355 - DNA, 60 bp, Artificial Sequence
  Oligonucleotide
ggccactgagtatgtccactccctccaggccgaggagcaccagcttttgctggaaaagga

SEQ ID NO: 356 - DNA, 60 bp, Artificial Sequence
  Oligonucleotide
ggcccatcaaaagcctttatcccttgacatttatccaggtgaaacagcattatgggtttg

SEQ ID NO: 357 - DNA, 60 bp, Artificial Sequence
  Oligonucleotide
ggcctcattcctttaccactcccacacctggaaagcatatactatattacaaaatgacat

SEQ ID NO: 358 - DNA, 60 bp, Artificial Sequence
  Oligonucleotide
ggcctcgacctgttgcgctgggccgtctgttccttctaggcactgtatttaactaacttt

SEQ ID NO: 359 - DNA, 60 bp, Artificial Sequence
  Oligonucleotide
gggacagtttggtattaaaacacttaaatatagatccggtggtatggatgagaaaacaat

SEQ ID NO: 360 - DNA, 60 bp, Artificial Sequence
  Oligonucleotide
gggaccgtcctgctgagaaattgcactgaagagatgcccccacctctggttgggcctggg

SEQ ID NO: 361 - DNA, 60 bp, Artificial Sequence
  Oligonucleotide
gggaggtacaataagaacatgtcagaagttcctaattcagtacaacaggagacagctgtt

SEQ ID NO: 362 - DNA, 60 bp, Artificial Sequence
  Oligonucleotide
gggccaagaagcaggaagccttgcggagagtgacggagaatctggccagcctcaccccca

SEQ ID NO: 363 - DNA, 60 bp, Artificial Sequence
  Oligonucleotide
gggtacctctgcaacaggaaatccatgacccagcccttcaccagtgcttcagccaccacc

SEQ ID NO: 364 - DNA, 60 bp, Artificial Sequence
  Oligonucleotide
gggtggagggtatgaaaatgactgcagcatagcacgactgaacaagcgcagtttcttcat

SEQ ID NO: 365 - DNA, 60 bp, Artificial Sequence
  Oligonucleotide
gggttcccctgcttccaacctccattgcactgcttcccctaagactgtgacctcctggaa

SEQ ID NO: 366 - DNA, 60 bp, Artificial Sequence
  Oligonucleotide
ggtaccagtgttactatgggtatccgccgctgacctacctggagtaccccatcctcatcg

SEQ ID NO: 367 - DNA, 60 bp, Artificial Sequence
  Oligonucleotide
ggtatcactgaccaaggagaagtccccaatggctacaatgtctccagatcaaccacagag

SEQ ID NO: 368 - DNA, 60 bp, Artificial Sequence
  Oligonucleotide
ggtcgtattgaacacctggtaaccaagcctgcttttaactctggtaaagtggatattgtc

SEQ ID NO: 369 - DNA, 60 bp, Artificial Sequence
  Oligonucleotide
ggtgaaagaattaatgaactccagtacctgaaagtgaaagatttgattttgtttccatct

SEQ ID NO: 370 - DNA, 60 bp, Artificial Sequence
  Oligonucleotide
ggtgcatttcagaaaggatggagaacatttattatgtgtgaaagcatcctcttccggttt

SEQ ID NO: 371 - DNA, 60 bp, Artificial Sequence
  Oligonucleotide
ggtggcccatctgttcagggtggctgcacgatttatggaaaacaagatgtctgccaacaa

SEQ ID NO: 372 - DNA, 60 bp, Artificial Sequence
  Oligonucleotide
ggtgtaattgaagggtgtgaaatgctttgtcaatcatttgtcacatttatccagtttggg

SEQ ID NO: 373 - DNA, 60 bp, Artificial Sequence
  Oligonucleotide
gtaaggattgaaaggcttgtaatccaaagttactttgtacagaccttgaagattgaaaaa

SEQ ID NO: 374 - DNA, 60 bp, Artificial Sequence
  Oligonucleotide
gtaggcgggttatctgcgaacacagtagtggaagatgtaaagcaatatttcgagcagttt

SEQ ID NO: 375 - DNA, 60 bp, Artificial Sequence
  Oligonucleotide
gtatttattggcttcaaggcccacctctctgtactctgggctctaaagttggaggtcagg

SEQ ID NO: 376 - DNA, 60 bp, Artificial Sequence
  Oligonucleotide
gtcatcaaggtgttcagtgacatgaaagtgtgcaagtcttcaacactagaaaaggtgaag

SEQ ID NO: 377 - DNA, 60 bp, Artificial Sequence
  Oligonucleotide
gtccctcctggtgtcaccccagagccacacatgggcatctatgggagagtgtcaaccaga

SEQ ID NO: 378 - DNA, 60 bp, Artificial Sequence
  Oligonucleotide
gtccgtctagctcacgggcccctccagtggaatgggtcttttcggtggagataaaagttg

SEQ ID NO: 379 - DNA, 60 bp, Artificial Sequence
  Oligonucleotide
gtcttcctcgggcagcaggtgggaagtgggagccggagcggcagctggcagcgttctctc

SEQ ID NO: 380 - DNA, 60 bp, Artificial Sequence
  Oligonucleotide
gtgaaatgtttgtcactcttactgcacagacttatctgcaatcaaactggttagtttttt

SEQ ID NO: 381 - DNA, 60 bp, Artificial Sequence
  Oligonucleotide
gtgcacttcctggtcattcctaagaagcccattcctcggattagccaggctgaagaagaa

SEQ ID NO: 382 - DNA, 60 bp, Artificial Sequence
  Oligonucleotide
gtggagaaagtttacccaccagtgcctgagcagctacagctccgaattgctttttggagc

SEQ ID NO: 383 - DNA, 60 bp, Artificial Sequence
  Oligonucleotide
gtggtgcggagctcctgtttgacggtattaagaaacatcgagtcactttgcctggacagg

SEQ ID NO: 384 - DNA, 60 bp, Artificial Sequence
  Oligonucleotide
gtgtctgccgattcccgcattgcagaacttctcacagagctccatcagctgatcaaacaa

SEQ ID NO: 385 - DNA, 60 bp, Artificial Sequence
  Oligonucleotide
gtgttcatctgagcataactgtactaaatcctttttccatatcagtataataaaggagtg

SEQ ID NO: 386 - DNA, 60 bp, Artificial Sequence
  Oligonucleotide
gttacaaccgcaatctctccaagacggagttcctaagcttcatgaatacagagctggctg

SEQ ID NO: 387 - DNA, 60 bp, Artificial Sequence
  Oligonucleotide
gttactaaaacgtgaatcctaaaatgagaagcagttcctgggaccagattgaaatgaatt

SEQ ID NO: 388 - DNA, 60 bp, Artificial Sequence
  Oligonucleotide
gttcaaaggatcgatggaccgtaaataagctgccattaacacatctggttactgctgtaa

SEQ ID NO: 389 - DNA, 60 bp, Artificial Sequence
  Oligonucleotide
gttcataagaaggcaacaaattcttctcctctacagaaggattttgcaaacaatttggca

SEQ ID NO: 390 - DNA, 60 bp, Artificial Sequence
  Oligonucleotide
gttcccaactgttggccagaatgaattcttcgaaaaatataggtggtttccagggaattt

SEQ ID NO: 391 - DNA, 60 bp, Artificial Sequence
  Oligonucleotide
gttctcggagccatttgtacatttcatcactcagtgtatgcgaaaacagccaaaagaaag

SEQ ID NO: 392 - DNA, 60 bp, Artificial Sequence
  Oligonucleotide
gttcttaagttttttgctgcaggaacccatttaggtggcaacaaccttgacttcaaaatg

SEQ ID NO: 393 - DNA, 60 bp, Artificial Sequence
  Oligonucleotide
gttcttcgtcacttaatgttggttccagtccttcaactgttcatatctactttataacat

SEQ ID NO: 394 - DNA, 60 bp, Artificial Sequence
  Oligonucleotide
gttgattcacctaactcattattttgctttattaaaagtcttccttcaccaccgagatat

SEQ ID NO: 395 - DNA, 60 bp, Artificial Sequence
  Oligonucleotide
gttttggatgtaccatttgtttcttatttgtgtaactgtaagttcacatcaacctcatgg

SEQ ID NO: 396 - DNA, 60 bp, Artificial Sequence
  Oligonucleotide
taaaaaggcacaactcaaatctcagagacactaaacaacaggatcactaggcctgccaac

SEQ ID NO: 397 - DNA, 60 bp, Artificial Sequence
  Oligonucleotide
taaaaccttgtttagtaaagccaagtcatactatagaagaacacattcagatgccagtga

SEQ ID NO: 398 - DNA, 60 bp, Artificial Sequence
  Oligonucleotide
taaagccaaagctgttacagagatgaacatcttttgtcaaaccattaagagttagaaaga

SEQ ID NO: 399 - DNA, 60 bp, Artificial Sequence
  Oligonucleotide
taaagttggaaagtccccgtcccccagaacctcaagtctagaaaccagtatggaagggag

SEQ ID NO: 400 - DNA, 60 bp, Artificial Sequence
  Oligonucleotide
tacagcccctaccttcagagagcacctggcctgcagctcatccaaacctgagtctcctct

SEQ ID NO: 401 - DNA, 60 bp, Artificial Sequence
  Oligonucleotide
tacattacccatctcctcttttgcctctgagaaagagtatataagcttctgtaccccact

SEQ ID NO: 402 - DNA, 60 bp, Artificial Sequence
  Oligonucleotide
tacattagatggtgtgtcccggaagaaacttcacctgagaacttttgaactgaggaaaga

SEQ ID NO: 403 - DNA, 60 bp, Artificial Sequence
  Oligonucleotide
tacctagtccccagcctgctccctagccagaggctctaatgtacaataaagcaatgtggt

SEQ ID NO: 404 - DNA, 60 bp, Artificial Sequence
  Oligonucleotide
tactattggtgtagagttcggtgctcgaatgataactattgatgggaaacagataaaact

SEQ ID NO: 405 - DNA, 60 bp, Artificial Sequence
  Oligonucleotide
tacttcttccatgaattggccaaggagaagcgcaagggtgttgagcgtctcctgaagatg

SEQ ID NO: 406 - DNA, 60 bp, Artificial Sequence
  Oligonucleotide
tagacctgatgtgttagatactgctttgttacgacctggaagattagataagatcatcta

SEQ ID NO: 407 - DNA, 60 bp, Artificial Sequence
  Oligonucleotide
tagatcaacttttaactcagagtcctggtgactatatccccatatcctatgaacagatat

SEQ ID NO: 408 - DNA, 60 bp, Artificial Sequence
  Oligonucleotide
taggaagtattaaaactgtgaagctttctcagtgcactttgaacctggaaaacaatccca

SEQ ID NO: 409 - DNA, 60 bp, Artificial Sequence
  Oligonucleotide
tataaactacttataaaggcccttcagttatctgaacctggcaaagaaattcactgattt

SEQ ID NO: 410 - DNA, 60 bp, Artificial Sequence
  Oligonucleotide
tatcactttggctggacccactaatgccatcttcaaagcctttgctatgatcattgacaa

SEQ ID NO: 411 - DNA, 60 bp, Artificial Sequence
  Oligonucleotide
tatgacccctggactaaccccagccaattcccaggcctcaaaagccactcccaagctaga

SEQ ID NO: 412 - DNA, 60 bp, Artificial Sequence
  Oligonucleotide
tatgtgaagaaaatgcaaacctttcaattcccacgtgtatacaagctaatgtgatgaggg

SEQ ID NO: 413 - DNA, 60 bp, Artificial Sequence
  Oligonucleotide
tcacataactgtaatatttggttgctcagcataagtgatggaagcaaacactaatttcta

SEQ ID NO: 414 - DNA, 60 bp, Artificial Sequence
  Oligonucleotide
tcacatatggatactttcacagttcaggattccactgcaatgagctggtggaggaataat

SEQ ID NO: 415 - DNA, 60 bp, Artificial Sequence
  Oligonucleotide
tcactgtcacattctttgatgtttctgagcaaaatgccccggctcccttcctgggcatcg

SEQ ID NO: 416 - DNA, 60 bp, Artificial Sequence
  Oligonucleotide
tcatacgttgtccagctgtaagttcatttgagtagcagacctaacaaatatttgaggtca

SEQ ID NO: 417 - DNA, 60 bp, Artificial Sequence
  Oligonucleotide
tcatggacagactggccttcttagctgtactataaatttgtgagtgaagttagagcccag

SEQ ID NO: 418 - DNA, 60 bp, Artificial Sequence
  Oligonucleotide
tcatgtgctggtaccaataggacaggaagattttaatcagctttactatctatgtttttt

SEQ ID NO: 419 - DNA, 60 bp, Artificial Sequence
  Oligonucleotide
tcatttatatccccaccgcaatactgtggattatcccccagaaagctgttcgttggattc

SEQ ID NO: 420 - DNA, 60 bp, Artificial Sequence
  Oligonucleotide
tccaacattgggaataattatgtatcctggtaccagcagctcccaggaacagcccccaaa

SEQ ID NO: 421 - DNA, 60 bp, Artificial Sequence
  Oligonucleotide
tccagcctctaccatcacctgcatgtggccgacacacgcttcgacatggtccagctcatc

SEQ ID NO: 422 - DNA, 60 bp, Artificial Sequence
  Oligonucleotide
tccattcttttgagcaggttaaagccattcacatccattctgacatgttctcagttcaaa

SEQ ID NO: 423 - DNA, 60 bp, Artificial Sequence
  Oligonucleotide
tccctgccctcacctgcaaatgagttaaagaagaggcgtgggaatccaggcagtggtttt

SEQ ID NO: 424 - DNA, 60 bp, Artificial Sequence
  Oligonucleotide
tcccttgtttagaacacgaatttccatttacctggtgggaacacgaaacaggagtctctt

SEQ ID NO: 425 - DNA, 60 bp, Artificial Sequence
  Oligonucleotide
tccggcattactatgtcatggtcatctgctacgtctacttcacccgcatcatcgccatcc

SEQ ID NO: 426 - DNA, 60 bp, Artificial Sequence
  Oligonucleotide
tccgtgggcatcatgttgaccgagctggagaaagccttgaactctatcatcgacgtctac

SEQ ID NO: 427 - DNA, 60 bp, Artificial Sequence
  Oligonucleotide
tcctcagccagcacagggaaatccagactcagggttccagaaatcccccgttcccaaacc

SEQ ID NO: 428 - DNA, 60 bp, Artificial Sequence
  Oligonucleotide
tcctccccgccgcccacctcagaattccttcctccccggcccctagtgggagcttaggcc

SEQ ID NO: 429 - DNA, 60 bp, Artificial Sequence
  Oligonucleotide
tcctggcattctctcagaagctgtactacgacaaggaacagacagtgagcatgaaggaca

SEQ ID NO: 430 - DNA, 60 bp, Artificial Sequence
  Oligonucleotide
tcgaaagtgcgaatctgacttacgccattattacgacagtaccattgagttgtgcgtggg

SEQ ID NO: 431 - DNA, 60 bp, Artificial Sequence
  Oligonucleotide
tcgagataagagagcagatgttggagaattcttctagattttcagaacttgaagactatt

SEQ ID NO: 432 - DNA, 60 bp, Artificial Sequence
  Oligonucleotide
tcgcaccagggtggaaaaaaagggaatagtgttcaaatcactgatggaactggatgacgc

SEQ ID NO: 433 - DNA, 60 bp, Artificial Sequence
  Oligonucleotide
tcgcacgcgcgccctccctggccgggcccactcgccacgcgcccagccatgaacctggcg

SEQ ID NO: 434 - DNA, 60 bp, Artificial Sequence
  Oligonucleotide
tctaataccatcctgcccattgtccttaccgtcctgcccatacagactgtggctccttcc

SEQ ID NO: 435 - DNA, 60 bp, Artificial Sequence
  Oligonucleotide
tctcaagtggcagtttcattatttagaatgcaaggtggacatcttttggatatctttttc

SEQ ID NO: 436 - DNA, 60 bp, Artificial Sequence
  Oligonucleotide
tctcatcctacttagcctacctagatttctcatgacgagttaatgcatgtccgtggttgg

SEQ ID NO: 437 - DNA, 60 bp, Artificial Sequence
  Oligonucleotide
tctccgtctctgtctcaaatttgtggtccactgagctataacttacttctgtattaaaat

SEQ ID NO: 438 - DNA, 60 bp, Artificial Sequence
  Oligonucleotide
tctcggagtggctttcgctggagaggtgctttgctgtctctcagactcagtcactgtgtt

SEQ ID NO: 439 - DNA, 60 bp, Artificial Sequence
  Oligonucleotide
tctctgtttcttggaaaggtatctattacatcctgctagctgactgacaaaactaagcag

SEQ ID NO: 440 - DNA, 60 bp, Artificial Sequence
  Oligonucleotide
tctgaaacactgggagcctgagattccagcccctatgtcagagctcacagagactttggt

SEQ ID NO: 441 - DNA, 60 bp, Artificial Sequence
  Oligonucleotide
tctgagttaacgtttcagctgtatcattagacttgtatttagagcgtgtcacttcctctg

SEQ ID NO: 442 - DNA, 60 bp, Artificial Sequence
  Oligonucleotide
tctggaaagcagtctgcccctggaagtggtagcaagattccacagaaaagaagtaaaact

SEQ ID NO: 443 - DNA, 60 bp, Artificial Sequence
  Oligonucleotide
tcttgcattagcagtgcccactgatggcattactctgcactatagccatttgccccaact

SEQ ID NO: 444 - DNA, 60 bp, Artificial Sequence
  Oligonucleotide
tgaaaacagatcgacctttaccggagaatccctatcactcaagaccaagaccggatccca

SEQ ID NO: 445 - DNA, 60 bp, Artificial Sequence
  Oligonucleotide
tgaaggaccgcccattcttccctgggctggtgaagtacatgaactcagggccggtcgtgg

SEQ ID NO: 446 - DNA, 60 bp, Artificial Sequence
  Oligonucleotide
tgaatgttgaaaactgcaatgtccgttatgagggccaaaaatctgttttgaaggcagcta

SEQ ID NO: 447 - DNA, 60 bp, Artificial Sequence
  Oligonucleotide
tgaatttgatgaagtgatgtttccaaagaacgtgaggtgctctacttgtgatttaaggaa

SEQ ID NO: 448 - DNA, 60 bp, Artificial Sequence
  Oligonucleotide
tgaccaccaggctatgacgttcctgctgcgcattacagaaagcttttaactgtgatcagg

SEQ ID NO: 449 - DNA, 60 bp, Artificial Sequence
  Oligonucleotide
tgaccactatgctgtcatcaagtttccattgaccactgagtctgccatgaagaagataga

SEQ ID NO: 450 - DNA, 60 bp, Artificial Sequence
  Oligonucleotide
tgacctctcccgccgcatctgcctcttcctgaccacagccaaccctgatctcctgctgga

SEQ ID NO: 451 - DNA, 60 bp, Artificial Sequence
  Oligonucleotide
tgagaacaagcaggatgctgtggactacctcacctggacctttctgtaccgccgcatgac

SEQ ID NO: 452 - DNA, 60 bp, Artificial Sequence
  Oligonucleotide
tgagagccatcccagtaacccgaccaccgctggtcttcactggacaccatgaaccacact

SEQ ID NO: 453 - DNA, 60 bp, Artificial Sequence
  Oligonucleotide
tgagccgagcccctgccaccagcctcctccgcacgcccgtggaatcagcactttctgctt

SEQ ID NO: 454 - DNA, 60 bp, Artificial Sequence
  Oligonucleotide
tgagctgtgactcaactgcttcattaaacattctgcattgggtataatctaagaattgtt

SEQ ID NO: 455 - DNA, 60 bp, Artificial Sequence
  Oligonucleotide
tgagttcttttgaagctgatctcaggcatcggattatttcttctgtaaatatttcagaat

SEQ ID NO: 456 - DNA, 60 bp, Artificial Sequence
  Oligonucleotide
tgatactgaaccttgattaataacagaaattcaggatgtaaagccacagaatgggattta

SEQ ID NO: 457 - DNA, 60 bp, Artificial Sequence
  Oligonucleotide
tgatgtgacttacaattggattcaagataaatgtgttcctcttgtccgagaaataacatt

SEQ ID NO: 458 - DNA, 60 bp, Artificial Sequence
  Oligonucleotide
tgcaacctatgggctatgcaacttcttatggacagcctcccactggttatgctactccaa

SEQ ID NO: 459 - DNA, 60 bp, Artificial Sequence
  Oligonucleotide
tgcaatgcgtgttgtacatacagaggtaactatcaatatttaagtttgttgctgtcaaga

SEQ ID NO: 460 - DNA, 60 bp, Artificial Sequence
  Oligonucleotide
tgcagaattttattttactttttttaaagctatgttgttagcacacagaacacttcattg

SEQ ID NO: 461 - DNA, 60 bp, Artificial Sequence
  Oligonucleotide
tgcagcttgcaatccgtggtgatgaagagttggattctcttatcaaggctaccatagctg

SEQ ID NO: 462 - DNA, 60 bp, Artificial Sequence
  Oligonucleotide
tgcatccccagagtacagcgagtttcccgcctcccgttagagatccaacacatatttttt

SEQ ID NO: 463 - DNA, 60 bp, Artificial Sequence
  Oligonucleotide
tgccattggttgtatttttgttctgagttttcggtgccgtgttcctaactactccatccc

SEQ ID NO: 464 - DNA, 60 bp, Artificial Sequence
  Oligonucleotide
tgccccagtttgagaagtggttgcaggacaatttaaccatcgttgctggtattttcatag

SEQ ID NO: 465 - DNA, 60 bp, Artificial Sequence
  Oligonucleotide
tgcccttcctactcctcatagcatgatattgttctccaaggatgggaatcaggcatgtgt

SEQ ID NO: 466 - DNA, 60 bp, Artificial Sequence
  Oligonucleotide
tgcgcatgttgtgccaccactgcagctccaaggcctaccaccttcagaagtcaacctgtg

SEQ ID NO: 467 - DNA, 60 bp, Artificial Sequence
  Oligonucleotide
tgcggagcctgttaaaggtcactcagatgtgcaggtgttaatcttctctaaaagcctggt

SEQ ID NO: 468 - DNA, 60 bp, Artificial Sequence
  Oligonucleotide
tgctacacaaaagccaaaaggtttcatgtagattttagttcactaaagggtgcccacaaa

SEQ ID NO: 469 - DNA, 60 bp, Artificial Sequence
  Oligonucleotide
tgctccgagagaatggtgactccttgcagaaagccatgatgcagatactacaggaaaaaa

SEQ ID NO: 470 - DNA, 60 bp, Artificial Sequence
  Oligonucleotide
tgctggttctttggataatggagttcttgtgttaacaaattacgtgctatatgatttttt

SEQ ID NO: 471 - DNA, 60 bp, Artificial Sequence
  Oligonucleotide
tgctttaaatcactatcaaagttacaagaaatgtttggcttattgtgtgatgcaacagat

SEQ ID NO: 472 - DNA, 60 bp, Artificial Sequence
  Oligonucleotide
tggacagccacctttgacccagtgcctacagatgccccgaccagcccccgagtctccggg

SEQ ID NO: 473 - DNA, 60 bp, Artificial Sequence
  Oligonucleotide
tggaccctgagcagcttcttgggccctggtacgtgcttgcggtggcctcccgggaaaagg

SEQ ID NO: 474 - DNA, 60 bp, Artificial Sequence
  Oligonucleotide
tggagagagcaagtggcatttgctgaagtgcatttccggtagaaaactccagtggtccct

SEQ ID NO: 475 - DNA, 60 bp, Artificial Sequence
  Oligonucleotide
tggatgtgaagatatggtaccttctcaagtgtagctctttcaaatatagtcaatgctggg

SEQ ID NO: 476 - DNA, 60 bp, Artificial Sequence
  Oligonucleotide
tggccaaagtgagcgagttaggtgatcttggtttcaatttccgagcctttgttaatatgg

SEQ ID NO: 477 - DNA, 60 bp, Artificial Sequence
  Oligonucleotide
tggccgctgtacactttttgcaactggtttgatgtcacatttcagctccaactttgcatc

SEQ ID NO: 478 - DNA, 60 bp, Artificial Sequence
  Oligonucleotide
tggcggcgcaactccgaagaagagcgctaagaaaacaccgaagaaagcgaagaagccggc

SEQ ID NO: 479 - DNA, 60 bp, Artificial Sequence
  Oligonucleotide
tggtgctaatgatggacagttaaaaagatagctagtgtatattgttatgggtcagtactt

SEQ ID NO: 480 - DNA, 60 bp, Artificial Sequence
  Oligonucleotide
tgtaatactccctttgggcgaagctaacatcggtgcctccccgaccttgctgactaggca

SEQ ID NO: 481 - DNA, 60 bp, Artificial Sequence
  Oligonucleotide
tgtacacttgtataagtaccgtttacttcatggcatgaataaatggatctgtgagatgca

SEQ ID NO: 482 - DNA, 60 bp, Artificial Sequence
  Oligonucleotide
tgtacctctggattggcggaagtaaatctggaaggattctcactcgtatttcccacccct

SEQ ID NO: 483 - DNA, 60 bp, Artificial Sequence
  Oligonucleotide
tgtagcaaactcatactggatcatttcagttaccttgaactaatagcacataatggtttt

SEQ ID NO: 484 - DNA, 60 bp, Artificial Sequence
  Oligonucleotide
tgtctcacgtggtggatccggtggaaatccaagctctgggctggtaatttttatgagcat

SEQ ID NO: 485 - DNA, 60 bp, Artificial Sequence
  Oligonucleotide
tgtcttgtttcagtccatgatcccactgacctactcttgcctgctggagggtaatgagaa

SEQ ID NO: 486 - DNA, 60 bp, Artificial Sequence
  Oligonucleotide
tgtttacatctcccacattcataccaatatacgtcaggtttgcttaaccattgatttttt

SEQ ID NO: 487 - DNA, 60 bp, Artificial Sequence
  Oligonucleotide
tgtttctcgttttcatcatatagacaaaacagccctgctgcaaagatggtcaacgtacct

SEQ ID NO: 488 - DNA, 60 bp, Artificial Sequence
  Oligonucleotide
ttaaatgtggaggctttctatagcattctaagctgagaagtagattgttacccagtaatg

SEQ ID NO: 489 - DNA, 60 bp, Artificial Sequence
  Oligonucleotide
ttaaatttcgtttgtctggaatattttgtatgagttcttgaataaaacttgggaaccaaa

SEQ ID NO: 490 - DNA, 60 bp, Artificial Sequence
  Oligonucleotide
ttactctagcgccactgaattttttctcttaggcttccctggctcccaagaagtatgccg

SEQ ID NO: 491 - DNA, 60 bp, Artificial Sequence
  Oligonucleotide
ttaggaggaagttgtgtccagttcagggtgccctcgggagccctgtccctgttgctgtgg

SEQ ID NO: 492 - DNA, 60 bp, Artificial Sequence
  Oligonucleotide
ttatagaaaggacacaagtttgtttcctggctttaccttgggaaaatgctagcaacatta

SEQ ID NO: 493 - DNA, 60 bp, Artificial Sequence
  Oligonucleotide
ttattttagtaaaatgcccaggagtcctggaagctacgcggacttgcagaggttttattt

SEQ ID NO: 494 - DNA, 60 bp, Artificial Sequence
  Oligonucleotide
ttcaaggtctgtttttctaactgaaaagctaagggcttgattcctagccccgttctgtgg

SEQ ID NO: 495 - DNA, 60 bp, Artificial Sequence
  Oligonucleotide
ttccaagtcaagtactctgggaccgagtgcactgaagacgataggaagttcagcatcagt

SEQ ID NO: 496 - DNA, 60 bp, Artificial Sequence
  Oligonucleotide
ttcccaggtttaatgaaagaacccaacttagtttttcagtgaatttgacacctatttttt

SEQ ID NO: 497 - DNA, 60 bp, Artificial Sequence
  Oligonucleotide
ttccctcggtaccatccgttctatcccattccctggaccaaatgtttgcaatatataaca

SEQ ID NO: 498 - DNA, 60 bp, Artificial Sequence
  Oligonucleotide
ttcctcgtcagtggtcaaggtgtgtcatccatacagctccatgcctttgtcttttttaaa

SEQ ID NO: 499 - DNA, 60 bp, Artificial Sequence
  Oligonucleotide
ttcgttgggcacaacaggaacgtatatgactgctgctgctcctatgcaagggacctacat

SEQ ID NO: 500 - DNA, 60 bp, Artificial Sequence
  Oligonucleotide
ttctcgacatcgaggacccataagcaggcctccaacgcccctgtggccaactgcaaaaaa

SEQ ID NO: 501 - DNA, 60 bp, Artificial Sequence
  Oligonucleotide
ttctgcttccttggatgtcattgcttaaatatagtcttgaagggcttgttttgaaatatt

SEQ ID NO: 502 - DNA, 60 bp, Artificial Sequence
  Oligonucleotide
ttcttcagtcatggcattcgcagtgcccagtgatggcattactctgcactatagccattt

SEQ ID NO: 503 - DNA, 60 bp, Artificial Sequence
  Oligonucleotide
ttgagcccaggcatcgttgagcattaacactctgtgacagagctgcagacccctgccttg

SEQ ID NO: 504 - DNA, 60 bp, Artificial Sequence
  Oligonucleotide
ttgagctcaactacatggtctacatgttccagtatgattccacctatgacaaattccatg

SEQ ID NO: 505 - DNA, 60 bp, Artificial Sequence
  Oligonucleotide
ttgagggtaggtcaggagtgtcaacgtgcttgtacatagagtgtctgctgtagctgtgtg

SEQ ID NO: 506 - DNA, 60 bp, Artificial Sequence
  Oligonucleotide
ttgatattgtagacgtcaagggaatgggtactgttcaaaaaggaatgccccacaagtgtt

SEQ ID NO: 507 - DNA, 60 bp, Artificial Sequence
  Oligonucleotide
ttgcaagacataccagagaaggacttcattgttttctgctcttcaacctcatataacgtg

SEQ ID NO: 508 - DNA, 60 bp, Artificial Sequence
  Oligonucleotide
ttgcctgaggcagagcaagacgggttctcacccctgacttctggaggcttcccttgaagc

SEQ ID NO: 509 - DNA, 60 bp, Artificial Sequence
  Oligonucleotide
ttgctgaacgttctgattccacccaatatgccatgtacgcgaacagggaagaataacgtt

SEQ ID NO: 510 - DNA, 60 bp, Artificial Sequence
  Oligonucleotide
ttgctgagaaccaactttcaatagtcatgagagaatcaaataatagatgtccgtacaagt

SEQ ID NO: 511 - DNA, 60 bp, Artificial Sequence
  Oligonucleotide
ttgtattcattgtggatgttaaagccaacaagcaccagatcaaacaggctgtgaagaagc

SEQ ID NO: 512 - DNA, 60 bp, Artificial Sequence
  Oligonucleotide
ttgtgcgtcatagaacccagaaggaaattgagcaggaagctgcagttgaattatcacagt

SEQ ID NO: 513 - DNA, 60 bp, Artificial Sequence
  Oligonucleotide
tttaatcaagattaagaatgaagttgactctactttgaccttccgaagatcatgcagaga

SEQ ID NO: 514 - DNA, 60 bp, Artificial Sequence
  Oligonucleotide
tttacagcactgttttttatgtagttacaacatgatgtgattgtagctttttaaactatg

SEQ ID NO: 515 - DNA, 60 bp, Artificial Sequence
  Oligonucleotide
tttcacttaaccccaggccattatcatatccagatggtcttcagagttgtctttatatgt

SEQ ID NO: 516 - DNA, 60 bp, Artificial Sequence
  Oligonucleotide
tttctcaaagacagcaaaaacctctcaaactgaggagcaacatttattcttactaagcag

SEQ ID NO: 517 - DNA, 60 bp, Artificial Sequence
  Oligonucleotide
tttggcgtcagcttcgagtgcttcgcctcacccctcaactgctacttccgccagtactgt

SEQ ID NO: 518 - DNA, 60 bp, Artificial Sequence
  Oligonucleotide
aaaccattgagaagatgcaggaataaagtaatcttatatacaagctttgattaaaacttg

SEQ ID NO: 519 - DNA, 60 bp, Artificial Sequence
  Oligonucleotide
aaggcatcatggattccctgttccagtccttcaatgcctccatctcagtggccagcttcc

SEQ ID NO: 520 - DNA, 60 bp, Artificial Sequence
  Oligonucleotide
aataaagacctatgtacttaatcctttaactctgcggatagcatttggtaggtagtgatt

SEQ ID NO: 521 - DNA, 60 bp, Artificial Sequence
  Oligonucleotide
acccggaaacaaacttgccagttgggtatcctcctcagtatccaccgacagcattccaag

SEQ ID NO: 522 - DNA, 60 bp, Artificial Sequence
  Oligonucleotide
aggctttaatgagcgtgtgacctgggccacgtcctgtggcgtttgttctcctaggccaac

SEQ ID NO: 523 - DNA, 60 bp, Artificial Sequence
  Oligonucleotide
agggaatcccgtgggttgcttacctacctataaggtggtttataagctgctgtcctggcc

SEQ ID NO: 524 - DNA, 60 bp, Artificial Sequence
  Oligonucleotide
ataaatttgcccaaaatcctaaagaccgggaaaagggaaccattgagcttggcaaaaaaa

SEQ ID NO: 525 - DNA, 60 bp, Artificial Sequence
  Oligonucleotide
caaaaaagtgcactgctcttctgtctattgtaccgacttaacctcttccacccaagtccg

SEQ ID NO: 526 - DNA, 60 bp, Artificial Sequence
  Oligonucleotide
cagccccctcatcatgcagttgctgagagacaacctaataacactgtggacatcacacag

SEQ ID NO: 527 - DNA, 60 bp, Artificial Sequence
  Oligonucleotide
ctgataaaggaagcaggaagcgctatgaaccatcagacaaggacaggcagagccctcctc

SEQ ID NO: 528 - DNA, 60 bp, Artificial Sequence
  Oligonucleotide
gaagagatagagatagtaaaatgtgaaaatgctacagttatggataaggcccgagctttg

SEQ ID NO: 529 - DNA, 60 bp, Artificial Sequence
  Oligonucleotide
gatacccaaaggtcaagaacacagtgattttattagaagtttcatccgcaaattttcttc

SEQ ID NO: 530 - DNA, 60 bp, Artificial Sequence
  Oligonucleotide
gatgctggagggaacagtgaagtgcagcagatgatgcttcgagggtggctttgaggccac

SEQ ID NO: 531 - DNA, 60 bp, Artificial Sequence
  Oligonucleotide
gcccacctccgggactgactggtcagaagccacccttgtctacgtgggataattctcccc

SEQ ID NO: 532 - DNA, 60 bp, Artificial Sequence
  Oligonucleotide
gccccaccagtacccatatgcaggactttatggacagcagcctgctaaccaagtcatcat

SEQ ID NO: 533 - DNA, 60 bp, Artificial Sequence
  Oligonucleotide
gcgcaagaagttcaacatggaccccgccaagggtatccagtatttcattgagcacaagct

SEQ ID NO: 534 - DNA, 60 bp, Artificial Sequence
  Oligonucleotide
gctatatatactcgagcactctccatataatgcctccatttaccaacttgctcttaaaaa

SEQ ID NO: 535 - DNA, 60 bp, Artificial Sequence
  Oligonucleotide
gctgccagctaccagcctggctggccctgtcctgtccaccctcattgccccaactcccat

SEQ ID NO: 536 - DNA, 60 bp, Artificial Sequence
  Oligonucleotide
ggagggcctcctgctcctcctggcgctaggagagccccactcggtgtggcacggagacac

SEQ ID NO: 537 - DNA, 60 bp, Artificial Sequence
  Oligonucleotide
ggcaggttagagctagtgtatgttactgtgaattgtaatgtagttggattgtacaaatta

SEQ ID NO: 538 - DNA, 60 bp, Artificial Sequence
  Oligonucleotide
ggcgcggaccaaagcgatctcttctgaggatccggcaagatggcagaagtagagcagaag

SEQ ID NO: 539 - DNA, 60 bp, Artificial Sequence
  Oligonucleotide
ggtcagaaccgtgattcgagcctttgtgaaatgcaccaaagcccgatacctgaagaaaaa

SEQ ID NO: 540 - DNA, 60 bp, Artificial Sequence
  Oligonucleotide
gtctttatgaagaactccttcaaggatgtggaccatctgtttcaaaagaaattagcggcc

SEQ ID NO: 541 - DNA, 60 bp, Artificial Sequence
  Oligonucleotide
gttcctggctcgccgtctccgctgccgcttgaccgcacttctggagggctccgcaccttg

SEQ ID NO: 542 - DNA, 60 bp, Artificial Sequence
  Oligonucleotide
tacagaactagaccagaagacatttgtggataaatctgaactcacttcctgtgtgtaact

SEQ ID NO: 543 - DNA, 60 bp, Artificial Sequence
  Oligonucleotide
tgaactttctgctgagcgagcaccgccaggccctggcctccgccaagcaccgaggccccg

SEQ ID NO: 544 - DNA, 60 bp, Artificial Sequence
  Oligonucleotide
tgcagagtggcgtcctcaagtccctctccctgcacccctgcccctcacgcatagtgccac

SEQ ID NO: 545 - DNA, 60 bp, Artificial Sequence
  Oligonucleotide
tggaatgtgaagcgtatgcaattccttctgcctccctcagctggtacaaggatggacagg

SEQ ID NO: 546 - DNA, 60 bp, Artificial Sequence
  Oligonucleotide
tttcctgacgttttacatttccactttcctattccattcattaagctagccaacaatcca

SEQ ID NO: 547 - DNA, 60 bp, Artificial Sequence
  Oligonucleotide
aaaaataaagctgtatgacttagtgctgaaggatatgaattaggcatagctcttgggttg

SEQ ID NO: 548 - DNA, 60 bp, Artificial Sequence
  Oligonucleotide
aaacgctccctgtatcttgctgtactgttaaagaaagctgaattccacattgccaacaaa

SEQ ID NO: 549 - DNA, 60 bp, Artificial Sequence
  Oligonucleotide
aatcgaaaagaagcaaattgccatgacagataacactttgattgctcaatctcttggtaa

SEQ ID NO: 550 - DNA, 60 bp, Artificial Sequence
  Oligonucleotide
acaaaattcctagcacatgagaagatctggctcgacaaattcaaatatgaagatacagaa

SEQ ID NO: 551 - DNA, 60 bp, Artificial Sequence
  Oligonucleotide
agaagccccttactcccaagtctgagagttccaagtgtggtaaaaatggcaacctttgct

SEQ ID NO: 552 - DNA, 60 bp, Artificial Sequence
  Oligonucleotide
agattctgcaaaggtgccaaccccttgcaaaggagccctggcatcagaaccctccccagg

SEQ ID NO: 553 - DNA, 60 bp, Artificial Sequence
  Oligonucleotide
aggccccaccttccagtgagaactcatgcagagaccctcaaaccaggaaagctgggttgt

SEQ ID NO: 554 - DNA, 60 bp, Artificial Sequence
  Oligonucleotide
agggcaatttacttttttgtacttcagactatcttgattgtcaaagtgtacgaactgtaa

SEQ ID NO: 555 - DNA, 60 bp, Artificial Sequence
  Oligonucleotide
atcagcattgacaagggacacaatttctgtctgatctatgacaccaagggttgctttggt

SEQ ID NO: 556 - DNA, 60 bp, Artificial Sequence
  Oligonucleotide
attcatgacgtgtgaaatttcagtttctctggagtttgtcagacggcgtgggaaccacgc

SEQ ID NO: 557 - DNA, 60 bp, Artificial Sequence
  Oligonucleotide
cactgcaggtgtatatagatgctttctgtcatactgtgttttcagatgcagaattttaaa

SEQ ID NO: 558 - DNA, 60 bp, Artificial Sequence
  Oligonucleotide
caggcgctgacccacgaatgcaactctcagccgagctgtccctgccggatttcaaacagc

SEQ ID NO: 559 - DNA, 60 bp, Artificial Sequence
  Oligonucleotide
ccaaagtggacgaggtgaagtttatgataaagttccaaatgaagaaggtgttacctctgg

SEQ ID NO: 560 - DNA, 60 bp, Artificial Sequence
  Oligonucleotide
cccccagctgctgttctcgtctttggaggacccggctttactggtgccacatgcctgctg

SEQ ID NO: 561 - DNA, 60 bp, Artificial Sequence
  Oligonucleotide
ctgactggaaaccttagcccccaaatatgaaatgccttctctagattaaaagggtgcaga

SEQ ID NO: 562 - DNA, 60 bp, Artificial Sequence
  Oligonucleotide
gccgaaggaccctgtgctgcctgtgactttggtatgtgtcctctgggaacagaagcaggg

SEQ ID NO: 563 - DNA, 60 bp, Artificial Sequence
  Oligonucleotide
gccttggcagaggcgtctccccacattctgactcctggtccccttgaaaccctgttggtg

SEQ ID NO: 564 - DNA, 60 bp, Artificial Sequence
  Oligonucleotide
ggtatctccattgcactctatttgccacctcaccctgaaggaaggtacgagggccccttc

SEQ ID NO: 565 - DNA, 60 bp, Artificial Sequence
  Oligonucleotide
gtgaaatgcatgtttagcaagtgttaggtactgtatttgaaccaataaatgtgaatcctt

SEQ ID NO: 566 - DNA, 60 bp, Artificial Sequence
  Oligonucleotide
gttccagctttaccccagccttaatcttttaaaatgtatattttccttagcgttgatttt

SEQ ID NO: 567 - DNA, 60 bp, Artificial Sequence
  Oligonucleotide
tacgtgttggaagaaacagacaccttcccatccccagcgtttgttcagtgccttggttgg

SEQ ID NO: 568 - DNA, 60 bp, Artificial Sequence
  Oligonucleotide
tcccactgcggtcacttcctaggactcagacggtcctgctcccactgcggtcacttccta

SEQ ID NO: 569 - DNA, 60 bp, Artificial Sequence
  Oligonucleotide
ttgtgaagtccaaggaggtcaagaccaagatcccaaagggcattaggtgcaaactcaatc

SEQ ID NO: 570 - DNA, 60 bp, Artificial Sequence
  Oligonucleotide
tttcgatggctctagtacttttacagtctgaacagtgacatgtatctcgtgcctgctgcc

SEQ ID NO: 571 - DNA, 60 bp, Artificial Sequence
  Oligonucleotide
aaacgctgggaatctgagcgcatcctctccttcatccctcctgatggaaacttccgcctg

SEQ ID NO: 572 - DNA, 60 bp, Artificial Sequence
  Oligonucleotide
aaatacacagaggtcctcaagacccacggactcctggtctgagcccaataaagactgtta

SEQ ID NO: 573 - DNA, 60 bp, Artificial Sequence
  Oligonucleotide
agaaagagaatcattgtctcgccttctgtgttccactctcctcctcactggtgccttttg

SEQ ID NO: 574 - DNA, 60 bp, Artificial Sequence
  Oligonucleotide
agatggcgctgaaagcaaataaggaagctcctgcccctcctaaagccgaagccaaagtga

SEQ ID NO: 575 - DNA, 60 bp, Artificial Sequence
  Oligonucleotide
agcccttcctctgtgctccgccttgagagcagtgtttcggacgctgggaagcgtgctgtg

SEQ ID NO: 576 - DNA, 60 bp, Artificial Sequence
  Oligonucleotide
agtcagccctgtggcccctccacggcccccaggcccaaggccatacgggcactgatggcc

SEQ ID NO: 577 - DNA, 60 bp, Artificial Sequence
  Oligonucleotide
cacgctgtatgttcccctgcgagcaccctcctcttggcctctggccaagtcccacccatc

SEQ ID NO: 578 - DNA, 60 bp, Artificial Sequence
  Oligonucleotide
ccatgctctctctccataggtcctgttttactatgatgtaaaaattaggtcatgtacatt

SEQ ID NO: 579 - DNA, 60 bp, Artificial Sequence
  Oligonucleotide
ccccatcttgcatgttgtgacaccttcaccaataacataatcatgtatttccctgctgtc

SEQ ID NO: 580 - DNA, 60 bp, Artificial Sequence
  Oligonucleotide
cgtggaccgcgctgcgagcctcggagacgccgtagaaggagacctgcttccgggactgga

SEQ ID NO: 581 - DNA, 60 bp, Artificial Sequence
  Oligonucleotide
ctaatacctgccaacctactcttaatcagtggtggaagaatggtctcagaactgcttgtt

SEQ ID NO: 582 - DNA, 60 bp, Artificial Sequence
  Oligonucleotide
ggaggcatgtcctcaggcctgggagaccaggctggccccagcctccctgtgcggtcaggg

SEQ ID NO: 583 - DNA, 60 bp, Artificial Sequence
  Oligonucleotide
ggaggcgcaataagacacccctccacagagcttggcatcatgggaagctggttctacctc

SEQ ID NO: 584 - DNA, 60 bp, Artificial Sequence
  Oligonucleotide
ggatcccggtccagtctcctgactgcgtagagatccctcttcttcccgaaaggcagtgga

SEQ ID NO: 585 - DNA, 60 bp, Artificial Sequence; identical to SEQ ID NO: 557
  Oligonucleotide

SEQ ID NO: 586 - DNA, 60 bp, Artificial Sequence
  Oligonucleotide
gtttttaggatcagtactttttaatggaaaaaacttgaccaaaaatttgtcacagaattt

SEQ ID NO: 587 - DNA, 60 bp, Artificial Sequence
  Oligonucleotide
tcaggcatgttactggtagttccttttgagtctgacattctaataaaataatttgtagaa

SEQ ID NO: 588 - DNA, 60 bp, Artificial Sequence
  Oligonucleotide
tgaagcagtgtgcagatgttgaaggagtataatgcaagatatttttttcttttttatagt

SEQ ID NO: 589 - DNA, 60 bp, Artificial Sequence
  Oligonucleotide
tgactgtcacaggcaggctcaacaagtgtggagtgatcagccccagatttgatgtgcaac

SEQ ID NO: 590 - DNA, 60 bp, Artificial Sequence
  Oligonucleotide
tgccgtgttccggagccagcagcaggagactgtgggccttgaggatgtggtagtgcatgg

SEQ ID NO: 591 - DNA, 60 bp, Artificial Sequence
  Oligonucleotide
tggaagtcatcattgcagatgcttaagtcaactattttaataaattgattaccagttgtt

SEQ ID NO: 592 - DNA, 60 bp, Artificial Sequence
  Oligonucleotide
tgttggccttttaagcccaatggtctatcaggaagtagaagagcagaaactacatcaagc

SEQ ID NO: 593 - DNA, 60 bp, Artificial Sequence
  Oligonucleotide
ttgcttgtggatgactgaccaggaggctattcaagatctctggcactggaggaagtctct

SEQ ID NO: 594 - DNA, 60 bp, Artificial Sequence
  Oligonucleotide
caactctcctctgaagccctggtggctgcccaaatttgtgccaataagtacatagtaaaa

SEQ ID NO: 595 - DNA, 60 bp, Artificial Sequence
  Oligonucleotide
caatcatgttgccgtatcaagcagaaaatgtcaccactatctggagagttggacatgttt

SEQ ID NO: 596 - DNA, 60 bp, Artificial Sequence
  Oligonucleotide
ccagattaacagtcttatcagaagaacgaactaaggtgtctaccatgattatttttctaa

SEQ ID NO: 597 - DNA, 60 bp, Artificial Sequence
  Oligonucleotide
gggaccgtgtcggcccagatcgagggtggcgttcatggcctgcactcttacgagaggtgg

SEQ ID NO: 598 - DNA, 60 bp, Artificial Sequence
  Oligonucleotide
gtggtcaaccacctcagtaaaattggagaggattattttgcattgactaaacttacagaa

SEQ ID NO: 599 - DNA, 60 bp, Artificial Sequence
  Oligonucleotide
tagccctgttctctcctggtacctccagcatcccaatcaattcctccagatccgcctgag

SEQ ID NO: 600 - DNA, 60 bp, Artificial Sequence
  Oligonucleotide
tccagatacctaataagatgctggaatgtaatccctggacaatccgtgtcctggcagcat

SEQ ID NO: 601 - DNA, 60 bp, Artificial Sequence
  Oligonucleotide
ttagatcctcctcttcaaatgctgtaattaacatcacttaaaaaaacttgaaaaaatatt

SEQ ID NO: 602 - DNA, 60 bp, Artificial Sequence
  Oligonucleotide
gggccctggatcaccagcctccctccacccagaatgccccgtccactccactgcccacca

SEQ ID NO: 603 - DNA, 60 bp, Artificial Sequence
  Oligonucleotide
actgtggtgatttttcatattccagtactccagcctgggtgacagtgcgagactctgttt

SEQ ID NO: 604 - DNA, 60 bp, Artificial Sequence
  Oligonucleotide
aggagggatgttactagaaatgcacaaagtgggctgaacacagtggctcacacctgtaat

SEQ ID NO: 605 - DNA, 60 bp, Artificial Sequence
  Oligonucleotide
caacatagtgagaccctgcttctaaagcattttcttggtgttactcctgtagatcctcac

SEQ ID NO: 606 - DNA, 60 bp, Artificial Sequence
  Oligonucleotide
ccgcaggtcgtccatccgcaacgcgcacagcatccatcagcggtcgcggaagcgcctcag

SEQ ID NO: 607 - DNA, 60 bp, Artificial Sequence
  Oligonucleotide
cctccttcattgccatctgtgagtttcctgcctgaagaggcacgttcctcagccccctcc

SEQ ID NO: 608 - DNA, 60 bp, Artificial Sequence
  Oligonucleotide
cgagctgcctgcgctgggcaaatgacctccccgcgaacgggaacgcccggacgagacaac

SEQ ID NO: 609 - DNA, 60 bp, Artificial Sequence
  Oligonucleotide
cgccagtccctccgacgccgacctcagagttccagctgctgtggcagtggcagtggccag

SEQ ID NO: 610 - DNA, 60 bp, Artificial Sequence
  Oligonucleotide
ctctccctaggaggcctgcccccgctaaccggctttttgcccaaatgggccattatcgaa

SEQ ID NO: 611 - DNA, 60 bp, Artificial Sequence
  Oligonucleotide
gaatgagaaccctacttgcctaaatgaggaatgtctttcctaccatctaaaatacgaagg

SEQ ID NO: 612 - DNA, 60 bp, Artificial Sequence
  Oligonucleotide
gctgagctcagcccctgtggcctcagagctgcaggcccctcccgggtgtcagagcactga

SEQ ID NO: 613 - DNA, 60 bp, Artificial Sequence
  Oligonucleotide
ggatcgctgccaccttttacctaggcctccccaccatggcctctgccagagccagctcct

SEQ ID NO: 614 - DNA, 60 bp, Artificial Sequence
  Oligonucleotide
ggcctaaaaataaggcccatgtccactgtcccctgcattagtgttgctgttggaacaata

SEQ ID NO: 615 - DNA, 60 bp, Artificial Sequence
  Oligonucleotide
ggctgaagttgcagtgagccgagatcgcgccattgtactccagcctgggcgatgagcaaa

SEQ ID NO: 616 - DNA, 60 bp, Artificial Sequence
  Oligonucleotide
gggaaccgcggtggcttccctcgcggaggcaaggccaaagataaggagtggatgcccgtc

SEQ ID NO: 617 - DNA, 60 bp, Artificial Sequence
  Oligonucleotide
gggccgagagaattttgagctctagccgtcttgttcgccggcaataaaaggactcctgaa

SEQ ID NO: 618 - DNA, 60 bp, Artificial Sequence
  Oligonucleotide
gtgaccaagccccttctgctgctccatgcccctgctcgccgcagtgtcccagtcaccagg

SEQ ID NO: 619 - DNA, 60 bp, Artificial Sequence
  Oligonucleotide
tagaacaatcctgtgaagaaccttctaaatctgatggtatttatggctgtaagttgctgg

SEQ ID NO: 620 - DNA, 60 bp, Artificial Sequence
  Oligonucleotide
tcctttctagttatttctattacttcagccttacctcctccaacttcagcacctcattat

SEQ ID NO: 621 - DNA, 60 bp, Artificial Sequence
  Oligonucleotide
tctacagcgtggtttgcctgcctgtctgccctcctggatgctattaaagctttgttttgt

SEQ ID NO: 622 - DNA, 60 bp, Artificial Sequence
  Oligonucleotide
tggaaggaacaaattccagacacaccagcactttgggaggctgaggcggctagatcactt

SEQ ID NO: 623 - DNA, 60 bp, Artificial Sequence
  Oligonucleotide
ttctctccacagtatggcttcacctgttcctgagcgccctgctaccctcttgctaacctg

SEQ ID NO: 624 - DNA, 60 bp, Artificial Sequence
  Oligonucleotide
tttgatgagctgaaggcttcagaaggttggtaataacaaacttctctgagctaaaggagg

SEQ ID NO: 625 - DNA, 60 bp, Artificial Sequence
  Oligonucleotide
aacttggaaaaatgtttttgcaaaacttgatgatcaagctgaacgtagaacgatattcct

SEQ ID NO: 626 - DNA, 60 bp, Artificial Sequence
  Oligonucleotide
acactccggtgaggttctgactggccctgggacatcacctgctccaggatcctatgtggc

SEQ ID NO: 627 - DNA, 60 bp, Artificial Sequence
  Oligonucleotide
acccctgcccactgcggcaaacccctacttctggtttcctttggaacccctttgttattc

SEQ ID NO: 628 - DNA, 60 bp, Artificial Sequence
  Oligonucleotide
actcaggcctcctgcaatggctccatgctggaccagcaacagctccacgccggctggact

SEQ ID NO: 629 - DNA, 60 bp, Artificial Sequence
  Oligonucleotide
cagcgggcagcagaccccagagtagcagggaagacaagcacttcaaagaggcagcgtcag

SEQ ID NO: 630 - DNA, 60 bp, Artificial Sequence
  Oligonucleotide
caggtgctcgtgtgcacgtgagcggctcttcctgctgactgactacagctaattgacaaa

SEQ ID NO: 631 - DNA, 60 bp, Artificial Sequence
  Oligonucleotide
ccaggagctccgccccctctgggttcccaggactctgattggtcggcgagccagcccttc

SEQ ID NO: 632 - DNA, 60 bp, Artificial Sequence
  Oligonucleotide
gcaagcgtggcatcattggctagaatgtttgaagaccagtcttaacatctgattatattt

SEQ ID NO: 633 - DNA, 60 bp, Artificial Sequence
  Oligonucleotide
gccagaaccatccagctaagcccctcgcagattccccacccacgaaaatgctgagatgac

SEQ ID NO: 634 - DNA, 60 bp, Artificial Sequence
  Oligonucleotide
gctcactttgtttctcggtggctgactcgtctctgtcgctcactccctctgtcactcgcg

SEQ ID NO: 635 - DNA, 60 bp, Artificial Sequence
  Oligonucleotide
tattttgaattgattgtggcatctgcctgcttccccattaaaactgaataaaatctttaa

SEQ ID NO: 636 - DNA, 60 bp, Artificial Sequence
  Oligonucleotide
tccagtctcagcaagctgccctttaaagagggtgatatggtttggctctgtgtccccacc

SEQ ID NO: 637 - DNA, 60 bp, Artificial Sequence
  Oligonucleotide
tgcagacctgacccacatgtccaggagcctgtatgctggccccctctacccttgagtgcc

SEQ ID NO: 638 - DNA, 60 bp, Artificial Sequence
  Oligonucleotide
gacgtgtgaggtcacttcctgcgtgttgggtggcttcctgcggcgtttccactctcgctc

SEQ ID NO: 639 - DNA, 60 bp, Artificial Sequence
  Oligonucleotide
aaatacgtgggacagtgtcttctcagagacaaccagccttgaaggctacaggtgatgaga

SEQ ID NO: 640 - DNA, 60 bp, Artificial Sequence
  Oligonucleotide
aaatatcctcctgtgacaccttccccaccctgccagtcaaagtatccacccaagagcaag

SEQ ID NO: 641 - DNA, 60 bp, Artificial Sequence
  Oligonucleotide
aaatttccagatcaacatggctatggtatttagtaatggcccagcttagagacttcagct

SEQ ID NO: 642 - DNA, 60 bp, Artificial Sequence
  Oligonucleotide
aagaaactcactttccctgtggcacgttatgcttcagaattaaaacaatgaagattaaaa

SEQ ID NO: 643 - DNA, 60 bp, Artificial Sequence
  Oligonucleotide
aatcacagccacttgacaagaaaggatattcattattttcaaatggcttttggactatca

SEQ ID NO: 644 - DNA, 60 bp, Artificial Sequence
  Oligonucleotide
aattttgtgcctactctagggcaaacagaattacaattgaaggagttcctatctatctgt

SEQ ID NO: 645 - DNA, 60 bp, Artificial Sequence
  Oligonucleotide
acatcaaactgcctggatttttctaccaccctgttacatcataacaacttctgaaacaca

SEQ ID NO: 646 - DNA, 60 bp, Artificial Sequence
  Oligonucleotide
acgggtcacccgaggcccataccaagactctgttcctgccctaggcccagtctcaaagga

SEQ ID NO: 647 - DNA, 60 bp, Artificial Sequence
  Oligonucleotide
actcctggattatagattaaaagtctctgtagacatctctgtgaagagcaagctatcatt

SEQ ID NO: 648 - DNA, 60 bp, Artificial Sequence
  Oligonucleotide
actctatgcattgtggaacacctttaaatccatcctgattcaagttgccttattcaaagt

SEQ ID NO: 649 - DNA, 60 bp, Artificial Sequence
  Oligonucleotide
agaggtggagaccatctccaaggaactggagcttttggacagagagctgtgccagctgct

SEQ ID NO: 650 - DNA, 60 bp, Artificial Sequence
  Oligonucleotide
agcagcggctgcaactgcggctcctggccagaccccggcctcagcgcaagctccagcgca

SEQ ID NO: 651 - DNA, 60 bp, Artificial Sequence
  Oligonucleotide
aggataaggatgcttaaaatggaaatcattctccaacgatatacaaattggacttgttca

SEQ ID NO: 652 - DNA, 60 bp, Artificial Sequence
  Oligonucleotide
agtgaattaactgtgtctcccttgtcttaggatattctgtagattgattgcagatttctt

SEQ ID NO: 653 - DNA, 60 bp, Artificial Sequence
  Oligonucleotide
agtgtgggaagatgtctccctgacctcaatgtctgtctgcaatttatggagatgaccaca

SEQ ID NO: 654 - DNA, 60 bp, Artificial Sequence
  Oligonucleotide
agttgtaactctgcgtggactatggacagtcaacaatatgtacttaaaagttgcactatt

SEQ ID NO: 655 - DNA, 60 bp, Artificial Sequence
  Oligonucleotide
atcagaacaagcccttcagtgtgccgcatactaagtccctggagagccgcatcaaggagg

SEQ ID NO: 656 - DNA, 60 bp, Artificial Sequence
  Oligonucleotide
atcatggcagtccctgtcatctctgagtgggcctttgcaagtggttcctgacattgatga

SEQ ID NO: 657 - DNA, 60 bp, Artificial Sequence
  Oligonucleotide
atccagcaccagtcagaccaatatgtcaaaattaagcgtaactggcggaaacccagaggc

SEQ ID NO: 658 - DNA, 60 bp, Artificial Sequence
  Oligonucleotide
atgggcgcccaaggattctccccgcaggctcgcagactcacctgatcaccgggcaagcgc

SEQ ID NO: 659 - DNA, 60 bp, Artificial Sequence
  Oligonucleotide
attcttatatttttctttactaattttggattttttttctttgaattattgggcagggaa

SEQ ID NO: 660 - DNA, 60 bp, Artificial Sequence
  Oligonucleotide
caggtgaggaaagttaggagatattcatcttaagagatatcctatttggcagtcacatgt

SEQ ID NO: 661 - DNA, 60 bp, Artificial Sequence
  Oligonucleotide
cagtggtggccgtagacttggctcggaacttagtggcaccagagtaactctagtcagtta

SEQ ID NO: 662 - DNA, 60 bp, Artificial Sequence
  Oligonucleotide
ccatcccacattcggaccctgcccatacccctgcctgggttttctaactgtaaatcactt

SEQ ID NO: 663 - DNA, 60 bp, Artificial Sequence
  Oligonucleotide
ccctggattcaaattaagtgcaatattttgcaaacagctcttcttagggaaatctcctga

SEQ ID NO: 664 - DNA, 60 bp, Artificial Sequence
  Oligonucleotide
cccttgtgtctcaggtgtggtccctgcctgcttgatgaagttgctctgttcaagcctttg

SEQ ID NO: 665 - DNA, 60 bp, Artificial Sequence
  Oligonucleotide
ccgccgacttcacggccgaggcccacgccgcctgggacaagttcctatcggtcgtatcct

SEQ ID NO: 666 - DNA, 60 bp, Artificial Sequence
  Oligonucleotide
cctaaccctgtactaacctgcttggtggacttggaaaagacttggctctgtcgggaaagg

SEQ ID NO: 667 - DNA, 60 bp, Artificial Sequence
  Oligonucleotide
cgcccttcctaagttatcggcctgcgagccggagagacaatggagagaactgcagaggcc

SEQ ID NO: 668 - DNA, 60 bp, Artificial Sequence
  Oligonucleotide
cgggaccatctgatgtgatgtgaatactcttcccacatacattaaacacacttaagtgag

SEQ ID NO: 669 - DNA, 60 bp, Artificial Sequence
  Oligonucleotide
cgggagagatttactttgaacattgtcagttgcagcaaaaatttactacacaagattatt

SEQ ID NO: 670 - DNA, 60 bp, Artificial Sequence
  Oligonucleotide
ctaccgtcaagtctttgaacgccattacccaggccgggctgactggctgagccattactg

SEQ ID NO: 671 - DNA, 60 bp, Artificial Sequence
  Oligonucleotide
ctagttggatggcacaaggctcttcacagacgcatctgtagcagagtggaacttgtacta

SEQ ID NO: 672 - DNA, 60 bp, Artificial Sequence
  Oligonucleotide
ctctcattctccatagtctgtttcctggaaagtcgatgtaattaactgatggcccaaaaa

SEQ ID NO: 673 - DNA, 60 bp, Artificial Sequence
  Oligonucleotide
ctgtcggaggccgggctgcgcctgctgcacttcctgttcatgtacgaccctaagaaaagg

SEQ ID NO: 674 - DNA, 61 bp, Artificial Sequence
  Oligonucleotide
gaatttttgtgctcttttccctgtgtacatggtggttctatctccaataaaacttttgttc

SEQ ID NO: 675 - DNA, 60 bp, Artificial Sequence
  Oligonucleotide
gacagtggcatctacttctgcatgatcgtcgggagccccgagctgaccttcgggaaggga

SEQ ID NO: 676 - DNA, 60 bp, Artificial Sequence
  Oligonucleotide
gaccgtggtgaagaattgcatcgtgcccatcgacagcacgccctaccgacagtggtacga

SEQ ID NO: 677 - DNA, 60 bp, Artificial Sequence
  Oligonucleotide
gatgatgtagttgattatttcaagagacaaggtttctcctatcagggtcgggcttccagc

SEQ ID NO: 678 - DNA, 60 bp, Artificial Sequence
  Oligonucleotide
gcgggagaagctgacggactggaaggacttcttgctggtgaagagcaggaggaacatcac

SEQ ID NO: 679 - DNA, 60 bp, Artificial Sequence
  Oligonucleotide
gcgtctcaggcaggcatgactggctacgggatgccacgccagatcctctgatcccacccc

SEQ ID NO: 680 - DNA, 60 bp, Artificial Sequence
  Oligonucleotide
gcttaaggaattatgtgagcttaaaactagtcaagcagtttagaaccaaaggcctatatt

SEQ ID NO: 681 - DNA, 60 bp, Artificial Sequence
  Oligonucleotide
ggaaagatctgtgaaatgctatctctcctgaagcaatactgttgaccagaaaggacactc

SEQ ID NO: 682 - DNA, 60 bp, Artificial Sequence
  Oligonucleotide
ggaccgctataaggccagtcggactgcgacatagcccatcccctcgaccgctcgcgtcgc

SEQ ID NO: 683 - DNA, 60 bp, Artificial Sequence
  Oligonucleotide
ggatcctggtatccgctaacaggtcaaaatgcagatcttcgtgaaaacccttaccggcaa

SEQ ID NO: 684 - DNA, 60 bp, Artificial Sequence
  Oligonucleotide
ggccccaggccggtacttcgcccacagcatcctgaccgtgtccgaagaggaatggaacac

SEQ ID NO: 685 - DNA, 60 bp, Artificial Sequence
  Oligonucleotide
ggccgccatcaatgcacgcaagatgaaatttgctctgctaaaaggctccttcagtgagca

SEQ ID NO: 686 - DNA, 60 bp, Artificial Sequence
  Oligonucleotide
ggccgtcacacctaccctgtgcagcggagccggaccaggctcttgtgtcctcactcaggt

SEQ ID NO: 687 - DNA, 60 bp, Artificial Sequence
  Oligonucleotide
ggcttccttcagcgttcttcctgttgtattctgagtatcgcccaaaaatcaaaggagaac

SEQ ID NO: 688 - DNA, 60 bp, Artificial Sequence
  Oligonucleotide
gtatgaggatgtggcactgatcaaagaccatacacttgtcaattccttgattcgtgtgct

SEQ ID NO: 689 - DNA, 60 bp, Artificial Sequence
  Oligonucleotide
gtcaggagtcccaaaggtcagtgacagtttctcagaagaggcccagcgtccacctctctc

SEQ ID NO: 690 - DNA, 60 bp, Artificial Sequence
  Oligonucleotide
gtgtgggccatctcggccctggtgtccttcctgcccatcctcatgcactggtggcgggcg

SEQ ID NO: 691 - DNA, 60 bp, Artificial Sequence
  Oligonucleotide
gttcttagttggtggagcgatttgtctggttaattccgataacgaacgagactctggcat

SEQ ID NO: 692 - DNA, 60 bp, Artificial Sequence
  Oligonucleotide
taccgaggcccctacaaagccttcagagtagatatctctgccaacgtgaggacagaagga

SEQ ID NO: 693 - DNA, 60 bp, Artificial Sequence
  Oligonucleotide
tatggactctgccttcatgtcatcagttaaagtgccctgcacacctgcctgtcctaggtc

SEQ ID NO: 694 - DNA, 60 bp, Artificial Sequence
  Oligonucleotide
tcacccctgtcctgttggccccaggcagccaagaccgatggctttggcccgtccttccca

SEQ ID NO: 695 - DNA, 60 bp, Artificial Sequence
  Oligonucleotide
tccaacaagtacggcgtgtttatgcgagtgagcgaggtgaagcccacctatcgcaactcc

SEQ ID NO: 696 - DNA, 60 bp, Artificial Sequence
  Oligonucleotide
tcctcatattcattccagtctggatatttgatactatccttcttgtcctgctgattgtga

SEQ ID NO: 697 - DNA, 60 bp, Artificial Sequence
  Oligonucleotide
tcgaggtggagccgagtgacaccattgagaatgtcaaggcaaagatccaagacaaggaag

SEQ ID NO: 698 - DNA, 60 bp, Artificial Sequence
  Oligonucleotide
tcgttctctgcactttcccccctgcctcccaacagtggccttcctatctggcttggtggg

SEQ ID NO: 699 - DNA, 60 bp, Artificial Sequence
  Oligonucleotide
tgaagaggccatagtacctcctgtttgaagttgtttattcacatctatcttatttgaaga

SEQ ID NO: 700 - DNA, 60 bp, Artificial Sequence
  Oligonucleotide
tgcagtatttatggcctcgtcctcccccacctaggccacgtgtgagctgctcctgtctct

SEQ ID NO: 701 - DNA, 60 bp, Artificial Sequence
  Oligonucleotide
tgcccattccccatcatcatccgttttaccttagttagcatttttcttatcatttttctt

SEQ ID NO: 702 - DNA, 60 bp, Artificial Sequence
  Oligonucleotide
tggattcagtgcagtaaataaaacacaggaagtattctggtggaaaaataccttgtattt

SEQ ID NO: 703 - DNA, 60 bp, Artificial Sequence
  Oligonucleotide
tggctcaactcgaatcatcaccagattgcggaatccagatagcaaacttagtcagctgaa

SEQ ID NO: 704 - DNA, 60 bp, Artificial Sequence
  Oligonucleotide
tgggaagtaaagacataggatccaagaatgagggttcccccagccgggcctgcagcccag

SEQ ID NO: 705 - DNA, 60 bp, Artificial Sequence
  Oligonucleotide
tgtattatctgctttgctgatgtagacaagagttaactgagtagcatgctttattaagca

SEQ ID NO: 706 - DNA, 60 bp, Artificial Sequence
  Oligonucleotide
tgtttatccatcagcccagagcacttactgagagtaaagaggctctagccacccccttac

SEQ ID NO: 707 - DNA, 60 bp, Artificial Sequence
  Oligonucleotide
ttactcctgcccagtgactgtgaccactgtccgtgttgccttcttgaacagcgattcccc

SEQ ID NO: 708 - DNA, 60 bp, Artificial Sequence
  Oligonucleotide
ttgttgtaggcatcaaaagaattgatggcgtgagtttactggtgcggaaaaccattgcaa

SEQ ID NO: 709 - DNA, 60 bp, Artificial Sequence
  Oligonucleotide
tttctcataagcatttgccctcaccatggtttataaaactttgggaaaacggaatattca

SEQ ID NO: 710 - DNA, 60 bp, Artificial Sequence
  Oligonucleotide
tttttctgccccatttctctgccatttcagccatctcagcctgatctctgcctcctcagc

SEQ ID NO: 711 - DNA, 60 bp, Artificial Sequence
  Oligonucleotide
aacattgaaaagttgtggtctgatcagttaatttgtatgtagcagtgtatgctctcatat

SEQ ID NO: 712 - DNA, 60 bp, Artificial Sequence
  Oligonucleotide
agcctgaggtgatctgtgaaaatggttcgctattcacttgacccggagaaccccacgaaa

SEQ ID NO: 713 - DNA, 60 bp, Artificial Sequence
  Oligonucleotide
ccaagctgctgtacttcaaaggaaacagatctagcacactgctgcacccctgcttccaca

SEQ ID NO: 714 - DNA, 60 bp, Artificial Sequence
  Oligonucleotide
cctgcagcagacgtgccagcagcttgcggtccagcaggcaccctctgctcagcccacccc

SEQ ID NO: 715 - DNA, 60 bp, Artificial Sequence
  Oligonucleotide
ttgtttccggtggtcttcccgttgtgggagcaggtggagggtggagacctaaactttggg

SEQ ID NO: 716 - DNA, 60 bp, Artificial Sequence
  Oligonucleotide
tttgcttccttccctggacggcccgctccccgaaacgcgcgcaataaagtgattcgcaga

SEQ ID NO: 717 - DNA, 60 bp, Artificial Sequence
  Oligonucleotide
cccctgaccctgccggaaagcgaaactgagatgcgggcattgggccctgggaagcgtggg

SEQ ID NO: 718 - DNA, 60 bp, Artificial Sequence
  Oligonucleotide
cccctagctccgtcggttcctttctggtgagatccccagtgcctgtggcacctgtcacca

SEQ ID NO: 719 - DNA, 60 bp, Artificial Sequence
  Oligonucleotide
gagcattcgctgtactttaagatacccatctttttctttttaaccctaatctttcacttg

SEQ ID NO: 720 - DNA, 60 bp, Artificial Sequence
  Oligonucleotide
cagtgagttgagatcgcgccactgcactccagcctgggcaacagaacaagactccgtctc

SEQ ID NO: 721 - DNA, 60 bp, Artificial Sequence
  Oligonucleotide
ccacttgtgccggacgctgtggctggtggcagcggtgctgctggctctgctgtgttgcac

SEQ ID NO: 722 - DNA, 60 bp, Artificial Sequence
  Oligonucleotide
ggctgaggacacctccccggctgagcagaccagccagaacttcaccaagagcgcagggct

SEQ ID NO: 723 - DNA, 60 bp, Artificial Sequence
  Oligonucleotide
cacatttgtacttgcggaccaggactgacaagggagccactgcctctgccataatcagaa

SEQ ID NO: 724 - DNA, 60 bp, Artificial Sequence
  Oligonucleotide
tcccgcattatctccctggaccctcacgcagcccacaaggcagctgttggtatcatcccc

SEQ ID NO: 725 - DNA, 60 bp, Artificial Sequence
  Oligonucleotide
tggaagctttggtgctttgctgaccctgtgacctgaacagccacccacctctccgagccc

SEQ ID NO: 726 - DNA, 60 bp, Artificial Sequence
  Oligonucleotide
aactttcctaggtgattacttcgggatcctcaaggaggcgagagtgaccgtgttcccctt

SEQ ID NO: 727 - DNA, 60 bp, Artificial Sequence
  Oligonucleotide
aatgagcagattacgggcagggacgacctgtcaaagcgcggagtggaccaaacctgcact

SEQ ID NO: 728 - DNA, 60 bp, Artificial Sequence
  Oligonucleotide
acagaccccattctgcccaccagaaccggaagttgtgtctttgcaaaagcaaccagttag

SEQ ID NO: 729 - DNA, 60 bp, Artificial Sequence
  Oligonucleotide
acatcggtccgtcctgcttccagctgctgcagcgcgccttcgccgccaaagcatccagca

SEQ ID NO: 730 - DNA, 60 bp, Artificial Sequence
  Oligonucleotide
acgcttcatcatctatgccttccccatgctcaacatcacggctgccagaggctgctccta

SEQ ID NO: 731 - DNA, 60 bp, Artificial Sequence
  Oligonucleotide
agaacatgctttcaacattggattgccagacaacattgtaaactgcaatgaatttttgtg

SEQ ID NO: 732 - DNA, 60 bp, Artificial Sequence
  Oligonucleotide
agcagtacagctgcctcaaacctttgggattttcagaatgactgacactgccgaagctgt

SEQ ID NO: 733 - DNA, 60 bp, Artificial Sequence
  Oligonucleotide
aggttgtacgagtaagaggacactataaaggtcagcaaattggtacagtagtccaggttt

SEQ ID NO: 734 - DNA, 60 bp, Artificial Sequence
  Oligonucleotide
atcaacaagtttgtgcagttcatccataagtacattacctacaatgccccagcagccatc

SEQ ID NO: 735 - DNA, 60 bp, Artificial Sequence
  Oligonucleotide
cacaatgattaatccagtgccgcctggaggcagccggtccaacttcccgatgggtcccgg

SEQ ID NO: 736 - DNA, 60 bp, Artificial Sequence
  Oligonucleotide
caccaagagctcctgagccccctgcccccaaagcaataaagtcagctggctttctcaaaa

SEQ ID NO: 737 - DNA, 60 bp, Artificial Sequence
  Oligonucleotide
cacctgaccaatcagagagctcactaaaatgctaattaggcaaaaacaggaggtaaagaa

SEQ ID NO: 738 - DNA, 60 bp, Artificial Sequence
  Oligonucleotide
cagatgcttttctcaaactttcctgatcctgcaggcaagctaaaccagttccggaagaac

SEQ ID NO: 739 - DNA, 60 bp, Artificial Sequence
  Oligonucleotide
catccgagctgggactctaatcatggctctgcatgactcttccgattacctgctggagtc

SEQ ID NO: 740 - DNA, 60 bp, Artificial Sequence
  Oligonucleotide
ccgagggcattcacacgggccagtttgtgtattgcggcaagaaggcccagctcaacattg

SEQ ID NO: 741 - DNA, 60 bp, Artificial Sequence
  Oligonucleotide
cctgtggtccattgttcattttaattcacatttcttatgaagtatggtaacagggaggga

SEQ ID NO: 742 - DNA, 60 bp, Artificial Sequence
  Oligonucleotide
ctaagctgcattgagaaatgactcgtctctgtatttgtattaagccttaacacttttctt

SEQ ID NO: 743 - DNA, 60 bp, Artificial Sequence
  Oligonucleotide
ctggtgtccaatctggattttggagtctcagacgccgatattcaggaactctttgctgaa

SEQ ID NO: 744 - DNA, 60 bp, Artificial Sequence
  Oligonucleotide
gactgtatttaccaagtctccctatcaggaattcactgaccacctcgttaagacccacac

SEQ ID NO: 745 - DNA, 60 bp, Artificial Sequence
  Oligonucleotide
gcaggccttaccgctctgtttatagtgacccaccctagatcttccccaagagggactggg

SEQ ID NO: 746 - DNA, 60 bp, Artificial Sequence
  Oligonucleotide
gccgggcccactccattcagatcatgaaggtggaggagatcgcggccagcaagtgccgcc

SEQ ID NO: 747 - DNA, 60 bp, Artificial Sequence
  Oligonucleotide
gcttcccctctctccggtctgtccctccaagatgacaaagaaaagaaggaacaatggtcg

SEQ ID NO: 748 - DNA, 60 bp, Artificial Sequence
  Oligonucleotide
ggctgcctgcatgcacggtgccctccttgcactccggacgtgagcattcgcagtgggttt

SEQ ID NO: 749 - DNA, 60 bp, Artificial Sequence
  Oligonucleotide
gggattttggccttgttgaccctcctaggtgccctgggaattgcaaacagctttctggat

SEQ ID NO: 750 - DNA, 60 bp, Artificial Sequence
  Oligonucleotide
gtcaatccaaggatccagaaggcttatgagtattttattatcctgtccaggaccctgaag

SEQ ID NO: 751 - DNA, 60 bp, Artificial Sequence
  Oligonucleotide
gtcctggatgttgatgtcctgcatctaacgcggtgtaacccccgaagccgagcgagctcc

SEQ ID NO: 752 - DNA, 60 bp, Artificial Sequence
  Oligonucleotide
gttatcaaggacatttaaggaatcctgatcctcagaacttctctgggacaatttcagttc

SEQ ID NO: 753 - DNA, 60 bp, Artificial Sequence
  Oligonucleotide
taaagatacagtcaccaagaatgttttgagttttttgaaagaccccaatttaagccttgc

SEQ ID NO: 754 - DNA, 60 bp, Artificial Sequence
  Oligonucleotide
tattccagaaggctccaccctgccgtcctgcgggagactgctgtccagtcctggccgggc

SEQ ID NO: 755 - DNA, 60 bp, Artificial Sequence
  Oligonucleotide
tcctatgcaacaagatccgatacttggacttatcgtacaatgacattcgatttatccccc

SEQ ID NO: 756 - DNA, 60 bp, Artificial Sequence
  Oligonucleotide
tctgctggcgagtccagaaacattattgcccagaaggattatgtgtttatggattatttt

SEQ ID NO: 757 - DNA, 60 bp, Artificial Sequence
  Oligonucleotide
tggtgcgattcatggatatactggtaaatttaggcaaagtgaaacttatcagcgtagttt

SEQ ID NO: 758 - DNA, 60 bp, Artificial Sequence
  Oligonucleotide
tgtggagcgttcactatgggtgtcattggtggcggagtcttccaggccatcaagagtttc

SEQ ID NO: 759 - DNA, 60 bp, Artificial Sequence
  Oligonucleotide
atggagcctgtgacaattataatggctatggctatggatttgggtcagatagatttggaa

SEQ ID NO: 760 - DNA, 60 bp, Artificial Sequence
  Oligonucleotide
gggactgcccagtctgtgggctgtgatgttgatggccgccaccctcatgacatcatatat

SEQ ID NO: 761 - DNA, 60 bp, Artificial Sequence
  Oligonucleotide
ttttataaagccacaatagttaaagcacttagatgtggacagaatcgcttgaacctggga

SEQ ID NO: 762 - DNA, 60 bp, Artificial Sequence
  Oligonucleotide
agcaatgagttgtttagtgacacatagctgagaagtaaaatgacgacaaaaagcaagaag

SEQ ID NO: 763 - DNA, 60 bp, Artificial Sequence
  Oligonucleotide
gacccatggccatgcccgcctgcctgttacattcctgttatatatagaccaaggaaagct

SEQ ID NO: 764 - DNA, 60 bp, Artificial Sequence
  Oligonucleotide
aacacacgtttttaaagttcatgtacgttcttgtacacagaggtaaagatttgaaaacct

SEQ ID NO: 765 - DNA, 60 bp, Artificial Sequence
  Oligonucleotide
acaaatgggaacagttgactggtttagtggatgctgaaggccttcaggaaatatgctact

SEQ ID NO: 766 - DNA, 60 bp, Artificial Sequence
  Oligonucleotide
actctcagctcatctccctcaagcgccaggtacagagcatgaagcagacgaacagcagcc

SEQ ID NO: 767 - DNA, 60 bp, Artificial Sequence
  Oligonucleotide
actgtgatccaaagcagcctaattactggccggtcatccccccgaagttctgagctcggg

SEQ ID NO: 768 - DNA, 60 bp, Artificial Sequence
  Oligonucleotide
ccccctgccctctgacgctctcccagtacttcaggcatatgctgtgcccttgacagtggc

SEQ ID NO: 769 - DNA, 60 bp, Artificial Sequence
  Oligonucleotide
cctcagcagctctccttgttactacttttaccaagcggaagatggacagcatatgttcct

SEQ ID NO: 770 - DNA, 60 bp, Artificial Sequence
  Oligonucleotide
gaagtcaaatgcacgccaacattccagttttttaagaagggacaaaaggtgggtgaattt

SEQ ID NO: 771 - DNA, 60 bp, Artificial Sequence
  Oligonucleotide
ggaaaagaactaaatgaattccgggaaaagcacaacattcgtctcatgggagaagatgag

SEQ ID NO: 772 - DNA, 60 bp, Artificial Sequence
  Oligonucleotide
ggaagcggtagactataaaaacattcgtttcacagtatgggatgctggtggtcaagatag

SEQ ID NO: 773 - DNA, 60 bp, Artificial Sequence
  Oligonucleotide
gtggaaaaagttggaaacacagatctgtgcagttctacattcactgattattacagtgtg

SEQ ID NO: 774 - DNA, 60 bp, Artificial Sequence
  Oligonucleotide
tcctcgccacctgctcggctgatcagacgtgcaagatctggaggacgtccaacttctccc

SEQ ID NO: 775 - DNA, 60 bp, Artificial Sequence
  Oligonucleotide
tgctacatttccaaggtgaagatgtgtgggcacatgttatggcagattgaaaaggatctc

SEQ ID NO: 776 - DNA, 60 bp, Artificial Sequence
  Oligonucleotide
ttgatgatacagtaagaaacctgtaaaattcgagccatataaataaaacctgtactgttc

SEQ ID NO: 777 - DNA, 60 bp, Artificial Sequence
  Oligonucleotide
ttttgatgggctactcatacagttagattttacagcttctgatgttgaatgttcctaaat

SEQ ID NO: 778 - DNA, 60 bp, Artificial Sequence
  Oligonucleotide
ccccacattgcccagccctcacacatggactgcccagtgcccacacctggctttggcaat

SEQ ID NO: 779 - DNA, 60 bp, Artificial Sequence
  Oligonucleotide
ggtcctccaccgtccaaggccagcacaccattcctgaagcccagcttcacaccctggatt

SEQ ID NO: 780 - DNA, 60 bp, Artificial Sequence
  Oligonucleotide
aataaagacctgattatacaggcagtgagctgtaatcccagcactttgggaggctgaagc

SEQ ID NO: 781 - DNA, 60 bp, Artificial Sequence
  Oligonucleotide
aaacgagcaaggacagctctgcaaattactatgcaagtcagaagaaaacatttgaaatta

SEQ ID NO: 782 - DNA, 60 bp, Artificial Sequence
  Oligonucleotide
aatgcactggtcacgaaacgtctaatactatgactgttaaaatgtcagactataacaaat

SEQ ID NO: 783 - DNA, 60 bp, Artificial Sequence
  Oligonucleotide
acctcctatggctcaggatgagggaggcccccaggcccttctggttggtagtgagtgtgg

SEQ ID NO: 784 - DNA, 60 bp, Artificial Sequence
  Oligonucleotide
agacgtttgacaatgagtcagtagcacaaaagagatgacatttacctagcactataaacc

SEQ ID NO: 785 - DNA, 60 bp, Artificial Sequence
  Oligonucleotide
aggcacccccatgccatccccgggtccattttgagccacaagactagcagagaccgtggc

SEQ ID NO: 786 - DNA, 60 bp, Artificial Sequence
  Oligonucleotide
aggttacagacctgcctatcgttccaataatcctgtttcacttgaatgaagggagtatgt

SEQ ID NO: 787 - DNA, 60 bp, Artificial Sequence
  Oligonucleotide
attttaatacacgtcattggagggctgcgtatttgtaaatagcctgatgctcatttggaa

SEQ ID NO: 788 - DNA, 60 bp, Artificial Sequence
  Oligonucleotide
cagcaggataagctgataaaggaagggaagtacacccctccacctcaccacattggcaag

SEQ ID NO: 789 - DNA, 60 bp, Artificial Sequence
  Oligonucleotide
cagtgatgattcaaatgctgtacaattagccaagtctttaggtgttgattctcaaataaa

SEQ ID NO: 790 - DNA, 60 bp, Artificial Sequence
  Oligonucleotide
cccgcctggtgatgaggcgctcctcgcgttccttccgtctccagtgcaccggctttccct

SEQ ID NO: 791 - DNA, 60 bp, Artificial Sequence
  Oligonucleotide
ccttgggaagccccctaccccgctacctctacctggctagcaaccagactaatgcgtggg

SEQ ID NO: 792 - DNA, 60 bp, Artificial Sequence
  Oligonucleotide
cgacgctgggtctactattgcctggtgaacatcacgctgagtgacctgctcacgggcgcg

SEQ ID NO: 793 - DNA, 60 bp, Artificial Sequence
  Oligonucleotide
cgctgacttggagcctctcttcctatacctgtgcaattcttctacgttttgtgatcatgc

SEQ ID NO: 794 - DNA, 60 bp, Artificial Sequence
  Oligonucleotide
ctgggaatggcaagggcaaggtagagtgcctaggagccctggactcaggctggcagaggg

SEQ ID NO: 795 - DNA, 60 bp, Artificial Sequence
  Oligonucleotide
cttctggctgactgtgcgaagtatgctgccccacaagaccaagcgaggccaggccgctct

SEQ ID NO: 796 - DNA, 60 bp, Artificial Sequence
  Oligonucleotide
gcagcgactacaaggtgtaatcaagactcgaaatagagtgacaggactgccgttatctat

SEQ ID NO: 797 - DNA, 60 bp, Artificial Sequence
  Oligonucleotide
gcctgctgttgccacactcctcatggatgtcatgttctactccaatggagtgaaggaccc

SEQ ID NO: 798 - DNA, 60 bp, Artificial Sequence
  Oligonucleotide
ggatgaaatgtcagtggaagaagcagatgagaaactcttgagatcttggtcctgtgtttt

SEQ ID NO: 799 - DNA, 60 bp, Artificial Sequence
  Oligonucleotide
ggccaagccagaactccactattgccctgcctcctgttctgtccccaccatggctacaga

SEQ ID NO: 800 - DNA, 60 bp, Artificial Sequence
  Oligonucleotide
ggccctctggacaggagggaccatccactccatagccctcacctcccttaccatcaagct

SEQ ID NO: 801 - DNA, 60 bp, Artificial Sequence
  Oligonucleotide
tgatggctgcatgacagatgttggcttattgtaaaaataaagttaaagaaaataatgtat

SEQ ID NO: 802 - DNA, 60 bp, Artificial Sequence
  Oligonucleotide
tgcctccctggtcacctattacaccagttctggagaagacatcctcattggcggcttgaa

SEQ ID NO: 803 - DNA, 60 bp, Artificial Sequence
  Oligonucleotide
tgttcactgtccccctaatattagggagtaaaacggataccaagttgatttagtgttttt

SEQ ID NO: 804 - DNA, 60 bp, Artificial Sequence
  Oligonucleotide
cattatcaaaattggcttccaggctgtcatgggcaagcgagcacagctccgtgccaaagc

SEQ ID NO: 805 - DNA, 60 bp, Artificial Sequence
  Oligonucleotide
aaaggagagcatcctggcctgcctattagcgatgttgcaaagaaactggtagagatgtgg

SEQ ID NO: 806 - DNA, 60 bp, Artificial Sequence
  Oligonucleotide
aagccatcacctggatgcctacgtgggaagggacctcgaatgtgggaccccagcccctct

SEQ ID NO: 807 - DNA, 60 bp, Artificial Sequence
  Oligonucleotide
agaaacattgagcatgaacaccatctgtgcgagtcatttacttattgcccctcacctcta

SEQ ID NO: 808 - DNA, 60 bp, Artificial Sequence
  Oligonucleotide
aggcagctagaccagggataggagtgggcaacttgccaagcccttaactctacttcctct

SEQ ID NO: 809 - DNA, 60 bp, Artificial Sequence
  Oligonucleotide
agttcaccagcccctccagggagcacagccacgtctggtcaggaatcttttaatgagtga

SEQ ID NO: 810 - DNA, 60 bp, Artificial Sequence
  Oligonucleotide
attcagacagatttggagattggcaagattaccaatttcatcaagtttgacaatggtaac

SEQ ID NO: 811 - DNA, 60 bp, Artificial Sequence
  Oligonucleotide
caccaagctggaaggcagtgatttagaccttttgagaataggacacttggcaggagggaa

SEQ ID NO: 812 - DNA, 60 bp, Artificial Sequence
  Oligonucleotide
cctaaccccagcctgaagaccttcaagcccatcgacctgagtgacctgaagcgccggagc

SEQ ID NO: 813 - DNA, 60 bp, Artificial Sequence
  Oligonucleotide
cctggagtaaatattggcacagatttcatttgagagaactcagccccctggtctaagctg

SEQ ID NO: 814 - DNA, 60 bp, Artificial Sequence
  Oligonucleotide
ccttagacttgaaagtacggtggttgaggagagcaatggttctgatgagatggagaattc

SEQ ID NO: 815 - DNA, 60 bp, Artificial Sequence
  Oligonucleotide
ccttcttcgtggtgtctctggtcctccccatctgccgggactcctgctggatccacccgg

SEQ ID NO: 816 - DNA, 60 bp, Artificial Sequence
  Oligonucleotide
gctcgctcgaggacctcagctcgtgccctcgcgccgcccctgcgcgcaggcttaccgggc

SEQ ID NO: 817 - DNA, 60 bp, Artificial Sequence
  Oligonucleotide
ggagctcaagaagcataagcccaacttctgatgtgccagaaaccgccctgagatctgccg

SEQ ID NO: 818 - DNA, 60 bp, Artificial Sequence
  Oligonucleotide
ggataacatacaaaccggtgtggaaaatgttgtcctttgagtggcaagaattagaaaaat

SEQ ID NO: 819 - DNA, 60 bp, Artificial Sequence
  Oligonucleotide
gggagaatgtgacctaatttatgacaaatacgtagagctcaggtatcacttctagtttta

SEQ ID NO: 820 - DNA, 60 bp, Artificial Sequence
  Oligonucleotide
gggcactccctgccagaggagaccgtggacttcatggttcagcacacgtcgttcaaggag

SEQ ID NO: 821 - DNA, 60 bp, Artificial Sequence
  Oligonucleotide
gtatgcaggtgccctctgtgcctattcacagttccctactaaagactggagtgctcagcc

SEQ ID NO: 822 - DNA, 60 bp, Artificial Sequence
  Oligonucleotide
gtcatcttgggcaatgaactgccaaaattctatgatgagtgaaccttccccagacttctc

SEQ ID NO: 823 - DNA, 60 bp, Artificial Sequence
  Oligonucleotide
gtgcccccttctccccggtcctccactactggctgctgctttgggacggcagcgaggctg

SEQ ID NO: 824 - DNA, 60 bp, Artificial Sequence
  Oligonucleotide
gttgtgctttatggccactgagagaattcagaataaattgaaagatggagtctaaaaatt

SEQ ID NO: 825 - DNA, 60 bp, Artificial Sequence
  Oligonucleotide
tatcctgtagatgtgaagcactttcagttttcagcgatgttggaatgtagcatcagaagc

SEQ ID NO: 826 - DNA, 60 bp, Artificial Sequence
  Oligonucleotide
tcatgacccacaataggatacaaacgaagagtttaagccagcatgatccagatgggttca

SEQ ID NO: 827 - DNA, 60 bp, Artificial Sequence
  Oligonucleotide
tgtacctagggaaaaaatttaaggaggtattcacactcagggtcatgcacttgcacaatg

SEQ ID NO: 828 - DNA, 60 bp, Artificial Sequence
  Oligonucleotide
acatagtgtatgtttgtgatatataaggttttctttattttgtatatgatcaataaacct

SEQ ID NO: 829 - DNA, 60 bp, Artificial Sequence
  Oligonucleotide
cagttacatctgccgaggctgcctccctggatgagccttccagcagctccatcgccagta

SEQ ID NO: 830 - DNA, 60 bp, Artificial Sequence
  Oligonucleotide
ttgtcagcgccacctccaccttcaggagcctgccacgtgcctgccctcggtcacttagcc

SEQ ID NO: 831 - DNA, 60 bp, Artificial Sequence
  Oligonucleotide
cactgtgcctgagaccctcgacccagccgaatacaacatatctctggaaacccagcgggt

SEQ ID NO: 832 - DNA, 60 bp, Artificial Sequence
  Oligonucleotide
aagtgagagccacgagccaaggtgggcacttgatgtcggatctcttcaacaagctggtca

SEQ ID NO: 833 - DNA, 60 bp, Artificial Sequence
  Oligonucleotide
atgacaaaacaaggttctttaacaccccaaaggtcataccagctcaccagcaatggattc

SEQ ID NO: 834 - DNA, 60 bp, Artificial Sequence
  Oligonucleotide
ccttccccaccatggcttccggccccaccccgagtggcattgtcgctgcagccaactttg

SEQ ID NO: 835 - DNA, 60 bp, Artificial Sequence
  Oligonucleotide
aaagtcaagaaaacaactgggtcggatcatgctaaaaggagataatattactctgctaca

SEQ ID NO: 836 - DNA, 60 bp, Artificial Sequence
  Oligonucleotide
aagtaacagggaagctacaggttacaacagatttgtgaactcagccaagcacagtggtgg

SEQ ID NO: 837 - DNA, 60 bp, Artificial Sequence
  Oligonucleotide
acttttgtgaggaagattaatgtggccaataaaacctttaaatgttaagtgtcaaaaaaa

SEQ ID NO: 838 - DNA, 60 bp, Artificial Sequence
  Oligonucleotide
atgaacgaacacggctactttccagagatatttgatgaaaggaagttgcttattcttctc

SEQ ID NO: 839 - DNA, 60 bp, Artificial Sequence
  Oligonucleotide
attgcaagggatggtgcttctttgaggatgatgtcaatgagttcacctgccctgtgtgtt

SEQ ID NO: 840 - DNA, 60 bp, Artificial Sequence
  Oligonucleotide
caaacaaagctaagacagcagggaacagaattgtcatggctgaatagaccaatcgtgttc

SEQ ID NO: 841 - DNA, 60 bp, Artificial Sequence
  Oligonucleotide
catagggccacagtgccgtatctgctgcagacatgattgtttcttgttctagaggttttc

SEQ ID NO: 842 - DNA, 60 bp, Artificial Sequence
  Oligonucleotide
cattatggcttaatttatccatgggttcacgtcgtaatatcatctgattctttagctgat

SEQ ID NO: 843 - DNA, 60 bp, Artificial Sequence
  Oligonucleotide
ccatatcctcactctgagtcttggtatccaggtattgcttcaaactggtgtctgagattt

SEQ ID NO: 844 - DNA, 60 bp, Artificial Sequence
  Oligonucleotide
ctccaggatgcctcacattttccctgtttgttagtggtctacccgagagtcctatcaatt

SEQ ID NO: 845 - DNA, 60 bp, Artificial Sequence
  Oligonucleotide
gacctatacctgtgtttcttgcctcatttttttccttgcaaatgtagtatggcctgtgtc

SEQ ID NO: 846 - DNA, 60 bp, Artificial Sequence
  Oligonucleotide
gagctcctaagtcacttcaaggtggacctggtgtgtcacggcaagacagaaattatccct

SEQ ID NO: 847 - DNA, 60 bp, Artificial Sequence
  Oligonucleotide
gcaagtacacgctgggccactgcaccatccgctgggccttcatgctggccatcctcagca

SEQ ID NO: 848 - DNA, 60 bp, Artificial Sequence
  Oligonucleotide
gcgtgattttcgagacaatactgtcagagttcaagacacagattggaaagaactgtacag

SEQ ID NO: 849 - DNA, 60 bp, Artificial Sequence
  Oligonucleotide
gctattccctatattcagcaattaaatcggatacttctggagactatgaaatcacactct

SEQ ID NO: 850 - DNA, 60 bp, Artificial Sequence
  Oligonucleotide
ggaaccgatttgtacaatgtgggaattttgttacctttttaatcaagggcaacttccttt

SEQ ID NO: 851 - DNA, 60 bp, Artificial Sequence
  Oligonucleotide
ggcctatttcagagaactgccggatcccctgctcacttaccggctctatgacaagtttgc

SEQ ID NO: 852 - DNA, 60 bp, Artificial Sequence
  Oligonucleotide
ggttcaccgaggctgtgtacaaagtgtcttcatgtcctgtgtttcaccttttaacataca

SEQ ID NO: 853 - DNA, 60 bp, Artificial Sequence
  Oligonucleotide
gttggaaaacatggaaaatgcatccttaacacctgagcctctggtcatcttcagtatttt

SEQ ID NO: 854 - DNA, 60 bp, Artificial Sequence
  Oligonucleotide
tcaggattctgctggtctcttgcagagtgaatgagtggcccctgcctctcctatgggtcc

SEQ ID NO: 855 - DNA, 60 bp, Artificial Sequence
  Oligonucleotide
tcccacggcccttccagcctaccctggaggagattgaagagtttctggaggagaacatgg

SEQ ID NO: 856 - DNA, 60 bp, Artificial Sequence
  Oligonucleotide
tcctgacgagcagcggctgtacaaggatgaccaactcttggatgatggcaagacactggg

SEQ ID NO: 857 - DNA, 60 bp, Artificial Sequence
  Oligonucleotide
tgtccccggtgcctgtgaaattcgtcatgccatgacccacctgcattaaacctatttttt

SEQ ID NO: 858 - DNA, 60 bp, Artificial Sequence
  Oligonucleotide
ttaagtgtgtagattgagcaggtagtaattgcatgcagtttgtacattagtgcattaaaa

SEQ ID NO: 859 - DNA, 60 bp, Artificial Sequence
  Oligonucleotide
ttgggagaggatactgtccagaaaattaatgcatacttttgtcacaatttgcctttttgt

SEQ ID NO: 860 - DNA, 60 bp, Artificial Sequence
  Oligonucleotide
gggatccacctcccaagtactccccaaatgcaccccttaactaggagcagggtgttatta

SEQ ID NO: 861 - DNA, 60 bp, Artificial Sequence
  Oligonucleotide
ttgtagcgtgcttcatgaaaatatctacttatccaggtttgcaaatgtacatgttcattt

SEQ ID NO: 862 - DNA, 60 bp, Artificial Sequence
  Oligonucleotide
aagaaagtggctatggtgcctgcccagggaaagcggtgttatgacaggaagcagagtggc

SEQ ID NO: 863 - DNA, 60 bp, Artificial Sequence
  Oligonucleotide
tggaatgatatcaaaaaggtctatgcctctcagcgaatgagagctggcaaaggcaaaatg

SEQ ID NO: 864 - DNA, 60 bp, Artificial Sequence
  Oligonucleotide
cccttcctagcctcctgacatgagtctgctggaaagagcatccaaacaaacaagtaataa

SEQ ID NO: 865 - DNA, 60 bp, Artificial Sequence
  Oligonucleotide
tgcctggagactcctattcacccttcagatcaatatcccccaaataaactcccagtcact

SEQ ID NO: 866 - DNA, 60 bp, Artificial Sequence
  Oligonucleotide
gttcaatgccgcactattcacaatagcagacttggaatcaacccaaatgcccatcaatga

SEQ ID NO: 867 - DNA, 60 bp, Artificial Sequence
  Oligonucleotide
agggcccgcagagcatttggtgcccctccatgttgcaatgcaaacaccttcaccactggg

SEQ ID NO: 868 - DNA, 60 bp, Artificial Sequence
  Oligonucleotide
ataaggcccgctggagtcacaagccccatcccagactctccaacgctggacctgcagcgc

SEQ ID NO: 869 - DNA, 60 bp, Artificial Sequence
  Oligonucleotide
atcgcccagtttctgagtgacatcccggagactgtgcctttgtccactgtcaatagacag

SEQ ID NO: 870 - DNA, 60 bp, Artificial Sequence
  Oligonucleotide
atctcctcattgtgccttcatcagagctggtgccttcgggccagaaagactctcgttctt

SEQ ID NO: 871 - DNA, 60 bp, Artificial Sequence
  Oligonucleotide
atgtaccttcgttcaaatatcctcatgtaattgccatctgtcactcactatattcacaaa

SEQ ID NO: 872 - DNA, 60 bp, Artificial Sequence
  Oligonucleotide
caagctggtgtccctccaggctaaaacacttccaccccctgggcagtgcactacagggtg

SEQ ID NO: 873 - DNA, 60 bp, Artificial Sequence
  Oligonucleotide
caccatatacaggagctcagactcaagcaggtcagattgaaggtcagatgtaccaacagt

SEQ ID NO: 874 - DNA, 60 bp, Artificial Sequence
  Oligonucleotide
ccagagatgaagggaagtggactaaagtattaaaccctctagctcccattggctgaagac

SEQ ID NO: 875 - DNA, 60 bp, Artificial Sequence
  Oligonucleotide
ctaccagacaagttacagcatcgatgatcagtcacagcagtcctatgattatggaggaag

SEQ ID NO: 876 - DNA, 60 bp, Artificial Sequence
  Oligonucleotide
ctacggaaacaagttgaagtacctggctttcctccgcaagcggatgaacaccagcccttc

SEQ ID NO: 877 - DNA, 60 bp, Artificial Sequence
  Oligonucleotide
ctctgtgagctctgggcttcccagtttgtttacccgggaaagtacgtctagattgtgtgg

SEQ ID NO: 878 - DNA, 60 bp, Artificial Sequence
  Oligonucleotide
ctcttggagaactccgaggagtatgcggctcgggcccgtctgctcacagagatccacggg

SEQ ID NO: 879 - DNA, 60 bp, Artificial Sequence
  Oligonucleotide
ctgccttgttttgcgacattgtcccattcacacagatattttgggataataaaggaaaat

SEQ ID NO: 880 - DNA, 60 bp, Artificial Sequence
  Oligonucleotide
ctgctctacttcaccggctctgcacacttcaaccgctccatgcgagccctggccaaaacc

SEQ ID NO: 881 - DNA, 60 bp, Artificial Sequence
  Oligonucleotide
ctggcaatcggctcgccctccttccaagacaagctgctgctcggcccctctgagatccgt

SEQ ID NO: 882 - DNA, 60 bp, Artificial Sequence
  Oligonucleotide
gagtgatgctgaacttaagggttcagatgtagattctctggtcattgagcatatccaagt

SEQ ID NO: 883 - DNA, 60 bp, Artificial Sequence
  Oligonucleotide
gccaagccagtccctactcttgggctgcggccacgtgaggctccgcatcagcagccaggg

SEQ ID NO: 884 - DNA, 60 bp, Artificial Sequence
  Oligonucleotide
gctaattaatgaagaggagcaactactattggtgtatttttcacagattggtgctttcta

SEQ ID NO: 885 - DNA, 60 bp, Artificial Sequence
  Oligonucleotide
gctgtagacattatctgtgtcaccgtggaagactatttcaacgattttgccaaaattaaa

SEQ ID NO: 886 - DNA, 60 bp, Artificial Sequence
  Oligonucleotide
ggagtccatgttgcatttcttgtgaactataaatggtgcttctcattttctgataatttt

SEQ ID NO: 887 - DNA, 60 bp, Artificial Sequence
  Oligonucleotide
taaccagccccagttccgggctgtcttgggcgaagtgaaactgtgtgagaagatggccca

SEQ ID NO: 888 - DNA, 60 bp, Artificial Sequence
  Oligonucleotide
tcgacaaaggtaaagtgggagtctgtgtctgtgctcaacctcttcaccaggatccggtaa

SEQ ID NO: 889 - DNA, 60 bp, Artificial Sequence
  Oligonucleotide
tctcggaacccatcaaggtgctgtactccaagtttctgatgcacccggaggagctgtttg

SEQ ID NO: 890 - DNA, 60 bp, Artificial Sequence
  Oligonucleotide
tgcccctcggcccaagagtgtccagcggtggcccacctcttcctcccactacagcctcaa

SEQ ID NO: 891 - DNA, 60 bp, Artificial Sequence
  Oligonucleotide
tggcaaggtacccgctgacagagagccagctagcgctagtccgggacatccgacgacggg

SEQ ID NO: 892 - DNA, 60 bp, Artificial Sequence
  Oligonucleotide
tgtgaacttgttgcactgcagaaacatattcagagtttatctatgtaacttattcactct

SEQ ID NO: 893 - DNA, 60 bp, Artificial Sequence
  Oligonucleotide
tttctcagcaacatttattcaagatgatttttaccaggaaccttatcaaaggcaaaacca

SEQ ID NO: 894 - DNA, 60 bp, Artificial Sequence
  Oligonucleotide
cccctgtgaatcaagatttgggcatgttcttggtcaccatttcctgctacaccagaggtg

SEQ ID NO: 895 - DNA, 60 bp, Artificial Sequence
  Oligonucleotide
ccgttctgacctctacctggaccttattaaccagaagaagatgagtcccccgctttaggg

SEQ ID NO: 896 - DNA, 60 bp, Artificial Sequence
  Oligonucleotide
gacatgaaagttcagatcccttccactcaggattctcgccgccttttctaagaaaataat

SEQ ID NO: 897 - DNA, 60 bp, Artificial Sequence
  Oligonucleotide
tccttcttcagtgtcctcacatgggcttccttcccttctcagctgatgccatcacctggg

SEQ ID NO: 898 - DNA, 60 bp, Artificial Sequence
  Oligonucleotide
ccagtgattctgcttctaacatatttcagacatcatttctgtccattcccactaccagaa

SEQ ID NO: 899 - DNA, 60 bp, Artificial Sequence
  Oligonucleotide
atcctgtccctcacctcctctccctgcatcctcattgctccctgtgcctactttccctcc

SEQ ID NO: 900 - DNA, 60 bp, Artificial Sequence
  Oligonucleotide
taatacagcttaaccttgcagctaccaacttttgtgtcaagctaggtacctttatttgat

SEQ ID NO: 901 - DNA, 60 bp, Artificial Sequence
  Oligonucleotide
ttttatgctaaccattgtttctgtagttaaaattgttttcttggtgttatcttttctcaa

SEQ ID NO: 902 - DNA, 60 bp, Artificial Sequence
  Oligonucleotide
gattccacataaaaattttctgaggttgtcctcattgatccattccataaagctatcaga

SEQ ID NO: 903 - DNA, 60 bp, Artificial Sequence
  Oligonucleotide
agcttctcccaagtgggcggcagcagcagcttccagggtggcctgggtggaggctatggc

SEQ ID NO: 904 - DNA, 60 bp, Artificial Sequence
  Oligonucleotide
cttccctcagcctcctcagtagctggattacagatatgtatctcaagagcactccacaac

SEQ ID NO: 905 - DNA, 60 bp, Artificial Sequence
  Oligonucleotide
gcggaggctgtaaaacctggcactctgcttgggttatcaatactctggctgaccatcgtc

SEQ ID NO: 906 - DNA, 60 bp, Artificial Sequence
  Oligonucleotide
aaagaactagaaagagacagggagaaattgttaagtggaagtgagagctcatcaaaacaa

SEQ ID NO: 907 - DNA, 60 bp, Artificial Sequence
  Oligonucleotide
aaaggtgtccgcagccacacgcaaaaaagaagatccgcatgtcactcaccttcaggcggc

SEQ ID NO: 908 - DNA, 60 bp, Artificial Sequence
  Oligonucleotide
aagaagactcccgagggcgatgccagtccctccactccagaggagaacgaaaccacgaca

SEQ ID NO: 909 - DNA, 60 bp, Artificial Sequence
  Oligonucleotide
aagcgtattacccctcgtcacttgcaacttgctattcgtggagatgaagaattggattct

SEQ ID NO: 910 - DNA, 60 bp, Artificial Sequence
  Oligonucleotide
acctgccccagccagcgcagcaggttcaaggcgtttgttgccatcagggattacaatggc

SEQ ID NO: 911 - DNA, 60 bp, Artificial Sequence
  Oligonucleotide
acgcgaggtataggctccagactcctcaccaagatgggctatgagtttggcaagggtttg

SEQ ID NO: 912 - DNA, 60 bp, Artificial Sequence
  Oligonucleotide
acgctctctgagagaccatccccaagcacagacgtccagacagacccccagaccctcaag

SEQ ID NO: 913 - DNA, 60 bp, Artificial Sequence
  Oligonucleotide
acttgtggtcttcaggaaaactactcagaatataatgactcctcatcagtatcatattgt

SEQ ID NO: 914 - DNA, 60 bp, Artificial Sequence
  Oligonucleotide
actttgttccacgctcctgctactgactgtcccgtcctgggtcttatcccaggtcacctt

SEQ ID NO: 915 - DNA, 60 bp, Artificial Sequence
  Oligonucleotide
agcaagattgatagattagagacgacattagcaggcataaaaaacattgacacaaaggta

SEQ ID NO: 916 - DNA, 60 bp, Artificial Sequence
  Oligonucleotide
agcatgtgttctgtgaggttgttcggctatgtccaagtgtcgtttactaatgtacccctg

SEQ ID NO: 917 - DNA, 60 bp, Artificial Sequence
  Oligonucleotide
aggagctgctacggagccagctatatccagaggtgccacccgaggagttccgcccctttc

SEQ ID NO: 918 - DNA, 60 bp, Artificial Sequence
  Oligonucleotide
agggcagatgaggcgcaggaaaatagtcttggaaatgttaaatatgatgggtaaattaaa

SEQ ID NO: 919 - DNA, 60 bp, Artificial Sequence
  Oligonucleotide
atgcttcacagcctacctcacaggacagcccactacccccaagcctcagctcagtcacgt

SEQ ID NO: 920 - DNA, 60 bp, Artificial Sequence
  Oligonucleotide
atggagtgagcccaaaggttcgaaaggtgttgcagcttcttcgccttcgtcaaatcttca

SEQ ID NO: 921 - DNA, 60 bp, Artificial Sequence
  Oligonucleotide
caacatccaggccaagatgctgcccaagaagactgagagtcacctcaaggtaaaggaaaa

SEQ ID NO: 922 - DNA, 60 bp, Artificial Sequence
  Oligonucleotide
caagtgctgttacaactggttgctgggagaattaagctcatcctctgtgattccactggc

SEQ ID NO: 923 - DNA, 60 bp, Artificial Sequence
  Oligonucleotide
cagctatcgcagaccagcatcctgtcccttgctgattcccacacggagttcttcgatgcc

SEQ ID NO: 924 - DNA, 60 bp, Artificial Sequence
  Oligonucleotide
caggacaccatgggaccctcccagcatgtctatgcctactctcaagaaatggctccctcc

SEQ ID NO: 925 - DNA, 60 bp, Artificial Sequence
  Oligonucleotide
catggagaccttcttctaccgcccctgtcttaataaagctgcgtgtttcacttcggcatc

SEQ ID NO: 926 - DNA, 60 bp, Artificial Sequence
  Oligonucleotide
ccattatgtattgattttgcaacttaggatgtttttgagtcccatggttcattttgattg

SEQ ID NO: 927 - DNA, 60 bp, Artificial Sequence
  Oligonucleotide
cccggccatcttccacgacttccgcatgttcaactgctccttccagttctccctggagaa

SEQ ID NO: 928 - DNA, 60 bp, Artificial Sequence
  Oligonucleotide
cgcgcccttgacgcccttcggccaggccactgtgtgccccttctccgcaggcgccgccct

SEQ ID NO: 929 - DNA, 60 bp, Artificial Sequence
  Oligonucleotide
ctctccaacaagatgtggaaaaaccatatttcctccaggaacactacaccgctgccccgc

SEQ ID NO: 930 - DNA, 60 bp, Artificial Sequence
  Oligonucleotide
cttcgcccttcatgtggtccaacctgggcattggcctagctatctccctgtctgtggttg

SEQ ID NO: 931 - DNA, 60 bp, Artificial Sequence
  Oligonucleotide
gaaagctcggcgagatgaagaatctgtgcgaatcgctcagaccagactgctggaagagga

SEQ ID NO: 932 - DNA, 60 bp, Artificial Sequence
  Oligonucleotide
gcccggcgaggagaacggcaaagattactactttgtaaccagggaggtgatgcagcgtga

SEQ ID NO: 933 - DNA, 60 bp, Artificial Sequence
  Oligonucleotide
gcgaaactatgcaacagtttacatcagtcatgtgaagtatttgtctaaaacagagcaaac

SEQ ID NO: 934 - DNA, 60 bp, Artificial Sequence
  Oligonucleotide
gctgcagagactgccccaggctgagcccgtggagatcgtggccttctcagtcatcatcct

SEQ ID NO: 935 - DNA, 60 bp, Artificial Sequence
  Oligonucleotide
gctttctgtgccgataacgctcacgcaagcatggttaacgtccctaaaacccgccggact

SEQ ID NO: 936 - DNA, 60 bp, Artificial Sequence
  Oligonucleotide
ggccccgtcctatagccaaaatcacagaaattcatgagtttctacttgagtgaggaaact

SEQ ID NO: 937 - DNA, 60 bp, Artificial Sequence
  Oligonucleotide
gggcaatattctctgtacatattagcgacaacagattggattttatgttgacatttgttt

SEQ ID NO: 938 - DNA, 60 bp, Artificial Sequence
  Oligonucleotide
ggtgaaaaactaacttcaagtgtcccttgtttgaaataaacttagcagagtcactttcta

SEQ ID NO: 939 - DNA, 60 bp, Artificial Sequence
  Oligonucleotide
gtcagtgaggtcccgtgagtctttgtgagtccttgtgtcatcgttcgggcactgtttttt

SEQ ID NO: 940 - DNA, 60 bp, Artificial Sequence
  Oligonucleotide
gtgccatggagttcaccatctgcaagtcagatatcgtcacaagagatgagttcctcagaa

SEQ ID NO: 941 - DNA, 60 bp, Artificial Sequence
  Oligonucleotide
gtgctatggcctcatcatcaagactttcaatcctatcccaagtgaaataaatggaatgaa

SEQ ID NO: 942 - DNA, 60 bp, Artificial Sequence
  Oligonucleotide
gtgctgacgtacctgctgctaccctgcacactgcccttcgagtacatctacttccgcagc

SEQ ID NO: 943 - DNA, 60 bp, Artificial Sequence
  Oligonucleotide
gttgtgttcatcaagcccaccttcccattctgcaggaggacccaagagatcctcagtcaa

SEQ ID NO: 944 - DNA, 60 bp, Artificial Sequence
  Oligonucleotide
gtttgggtatgccacctcaaaatgttggagaagtgtatggagttgtgaaagcttatacaa

SEQ ID NO: 945 - DNA, 60 bp, Artificial Sequence
  Oligonucleotide
tatagccacagaaataaaggagggacctatatctgggacagtgtcttctcagaaacaacc

SEQ ID NO: 946 - DNA, 60 bp, Artificial Sequence
  Oligonucleotide
tccttgtcattgaccttagctaaaccatggcaattcataaatagaggaaacattaatgaa

SEQ ID NO: 947 - DNA, 60 bp, Artificial Sequence
  Oligonucleotide
tctccaaggcccatgaggatatgactgccctggagaaggattacaaggaggtgggcatgg

SEQ ID NO: 948 - DNA, 60 bp, Artificial Sequence
  Oligonucleotide
tctccacacagaaaatcttcttgattctatagagacttaatcatgcctatggctttgaat

SEQ ID NO: 949 - DNA, 60 bp, Artificial Sequence
  Oligonucleotide
tgaaagaccgaccattcttccctgggctggtgaagtacatgaactcagggccggttgtgg

SEQ ID NO: 950 - DNA, 60 bp, Artificial Sequence
  Oligonucleotide
tgcaaattttccccgtttgccctacgccccttttggtacacctagaggttgatttccttt

SEQ ID NO: 951 - DNA, 60 bp, Artificial Sequence
  Oligonucleotide
tgctctatacaaatgtatccataaaatatcagagcttgttgggcatgaacatcaaacttt

SEQ ID NO: 952 - DNA, 60 bp, Artificial Sequence
  Oligonucleotide
tggcttctgaactggaattctgcagctaacccttccacgactagaaccttaggcattggg

SEQ ID NO: 953 - DNA, 60 bp, Artificial Sequence
  Oligonucleotide
tggttggatgaagtccttagtacagttgaaaaacagagcattaaagactaatcaattgtt

SEQ ID NO: 954 - DNA, 60 bp, Artificial Sequence
  Oligonucleotide
tgtccctttttcccctgatgcaagttgtagatggaatagaagcccttgttgccgtagatg

SEQ ID NO: 955 - DNA, 60 bp, Artificial Sequence
  Oligonucleotide
tgtgcagggtatcctgtagggtgacctggaattcgaattctgtttcccttgtaaaatatt

SEQ ID NO: 956 - DNA, 60 bp, Artificial Sequence
  Oligonucleotide
ttaagggtttagatgtagactctctggccattgagcatatccaaatgaataaagcatcta

SEQ ID NO: 957 - DNA, 60 bp, Artificial Sequence
  Oligonucleotide
ttacactgcactctgaccctgtagtacagcaataaccgtctaataaagagcctaccccca

SEQ ID NO: 958 - DNA, 60 bp, Artificial Sequence
  Oligonucleotide
ttcactgataaggagagcaagcgtcccaagaacatccccatcatagtcctccccctcgag

SEQ ID NO: 959 - DNA, 60 bp, Artificial Sequence
  Oligonucleotide
ttcagcctcagaaatcaaatttgacagccaggaagatctgtggaccaaaatcattctggc

SEQ ID NO: 960 - DNA, 60 bp, Artificial Sequence
  Oligonucleotide
ttccaccgtatggaaaaggcgcaccctgagcctgggacctgggacagcttcctggaaaag

SEQ ID NO: 961 - DNA, 60 bp, Artificial Sequence
  Oligonucleotide
tttaaagaagggagacgagtgtgagctcctaggacatagcaagaacatccgcactgtggt

SEQ ID NO: 962 - DNA, 60 bp, Artificial Sequence
  Oligonucleotide
aagtcggcttcgagcacccttcagttccatggccaagagcccactcgagggcgtttcctc

SEQ ID NO: 963 - DNA, 60 bp, Artificial Sequence
  Oligonucleotide
acactctactcccggtcaaaagtggattgtatatgtcctctttgatgtgatggtcccttt

SEQ ID NO: 964 - DNA, 60 bp, Artificial Sequence
  Oligonucleotide
atcaaaacaagacaaatgctgttcagggaaagaagttggcaagcttaatgttaaacaaaa

SEQ ID NO: 965 - DNA, 60 bp, Artificial Sequence
  Oligonucleotide
gggcccacctagcctttccctgctgcccaactggatggaaaataaaaggttcttgtattc

SEQ ID NO: 966 - DNA, 60 bp, Artificial Sequence
  Oligonucleotide
agccccatctcctgagcagcacagaccctcccacggccaccgcatggtgaacctgcacag

SEQ ID NO: 967 - DNA, 60 bp, Artificial Sequence
  Oligonucleotide
ctcacgatttattcctccaggtctttgattggagagagtaactttttaattctgttgttt

SEQ ID NO: 968 - DNA, 60 bp, Artificial Sequence
  Oligonucleotide
ctgcttctagcatggtcggtggacctgggtgtctgtctgcacacgtcctccagtggcctg

SEQ ID NO: 969 - DNA, 60 bp, Artificial Sequence
  Oligonucleotide
gggccgctcgcagaccagctttcctgggagctggccccgctcccgcgttccccaccctgc

SEQ ID NO: 970 - DNA, 60 bp, Artificial Sequence
  Oligonucleotide
cccagccagttaagcacaaagaaaaatatttcaataaaggatcatttgacaactgtggaa

SEQ ID NO: 971 - DNA, 60 bp, Artificial Sequence
  Oligonucleotide
aagtgtgatggcatgcacgtgtggatcacttgagcttgggaggtcagagcataatggcac

SEQ ID NO: 972 - DNA, 60 bp, Artificial Sequence
  Oligonucleotide
gggacactgttggataggaggcgtggtcccagcgtggtctccctgtctgggcctctgcct

SEQ ID NO: 973 - DNA, 60 bp, Artificial Sequence
  Oligonucleotide
cctgcccctcctgggcaccctgcccaccaggtcacctgcacctgctctgaataaactgtg

SEQ ID NO: 974 - DNA, 60 bp, Artificial Sequence
  Oligonucleotide
aaaagcaagagaatttgagaagatgaatcagtcactacgattatttcgggaagtttgcct

SEQ ID NO: 975 - DNA, 60 bp, Artificial Sequence
  Oligonucleotide
aaactgctgactaggtcatcctctgtctggtagagacattcacatctttgcttttattct

SEQ ID NO: 976 - DNA, 60 bp, Artificial Sequence
  Oligonucleotide
aaagtgaaagctctgaacaagggtgatgccaactctgaagtcactgtgtactaccagtca

SEQ ID NO: 977 - DNA, 60 bp, Artificial Sequence
  Oligonucleotide
aaccattttaactctccagtgcactttgccattaaagtctcttcacattgatttgtttcc

SEQ ID NO: 978 - DNA, 60 bp, Artificial Sequence
  Oligonucleotide
aacttcagcgagaaagtgggagttgcctttgaccacatgaaggtctgctttggagacttt

SEQ ID NO: 979 - DNA, 60 bp, Artificial Sequence
  Oligonucleotide
aagcacagatttgacccaagctatttatatgttataaagttataataaagtgtttcttac

SEQ ID NO: 980 - DNA, 60 bp, Artificial Sequence
  Oligonucleotide
aagcagccctgccagccacctcctgtgtgccccacgccaaagtgcccagagccatgtcca

SEQ ID NO: 981 - DNA, 60 bp, Artificial Sequence
  Oligonucleotide
aagcatttaaaatatgtagttcccatatatttcagggtctctgtgtattaagctaactca

SEQ ID NO: 982 - DNA, 60 bp, Artificial Sequence
  Oligonucleotide
aagccttgccctggtgttctaccagaaaaacgtctcccaatcacccaggaaagctgtcca

SEQ ID NO: 983 - DNA, 60 bp, Artificial Sequence
  Oligonucleotide
aaggagaatgcctaaagtcaaacgaagccggaaagcaccccaggatggctgggagttgat

SEQ ID NO: 984 - DNA, 60 bp, Artificial Sequence
  Oligonucleotide
aagggaatgaggatgatctttggctgttgctgctctttatgaagaatcttatttgtaact

SEQ ID NO: 985 - DNA, 60 bp, Artificial Sequence
  Oligonucleotide
aagtccggtctctgacccttgactcatgggagccagaactagtgaagctcatgtgtgagc

SEQ ID NO: 986 - DNA, 60 bp, Artificial Sequence
  Oligonucleotide
aagttacttggatggacccattgtgcatcttttactgaaaactggctccccatcatgtat

SEQ ID NO: 987 - DNA, 60 bp, Artificial Sequence
  Oligonucleotide
aatcacaattacaccactttagaccctatgtgtagcaggtcacaacttacccttgtgtgt

SEQ ID NO: 988 - DNA, 60 bp, Artificial Sequence
  Oligonucleotide
aatgacttgatcatctgcttcctttttgaatttttaacagatagtaagtaaatttggtgg

SEQ ID NO: 989 - DNA, 60 bp, Artificial Sequence
  Oligonucleotide
acagacatgtccttcgataactccctgtttaccgtctccgcgaaaacgatgccagaagaa

SEQ ID NO: 990 - DNA, 60 bp, Artificial Sequence
  Oligonucleotide
accctcgctacaagcccgtccctgccctggagaacgacctcgcgctgcttcagctggacg

SEQ ID NO: 991 - DNA, 60 bp, Artificial Sequence
  Oligonucleotide
acctgggccttctgaacattccaaaagttttgacaagtggacgactaagattaatgaatg

SEQ ID NO: 992 - DNA, 60 bp, Artificial Sequence
  Oligonucleotide
acggtgaggcggaggcactggctgcaaaagtccaccccctctagacctctgcaaccacag

SEQ ID NO: 993 - DNA, 60 bp, Artificial Sequence
  Oligonucleotide
acgttaccccactgtttcccactgcccgcgacgtcactttcctgtgcacgttaccccttc

SEQ ID NO: 994 - DNA, 60 bp, Artificial Sequence
  Oligonucleotide
actaggaatcctccaaccaggctcctgtgatagagttcttttaagcccaagattttttat

SEQ ID NO: 995 - DNA, 60 bp, Artificial Sequence
  Oligonucleotide
actcgaatccagaaggaacgatttggctctacccaggagtacgaagcttgctttggtcag

SEQ ID NO: 996 - DNA, 60 bp, Artificial Sequence
  Oligonucleotide
actggagccacccgcgaaaattcggccagggttctcgctcttgtcgtgtctgttcaaacc

SEQ ID NO: 997 - DNA, 60 bp, Artificial Sequence
  Oligonucleotide
acttctgtttattgtggatgttaaagccaacaagcaccagatcaaacaggctgtgaagaa

SEQ ID NO: 998 - DNA, 60 bp, Artificial Sequence
  Oligonucleotide
agaccttgctcttcctagtccttttaatgctgtgtgttctgttaagttctttcatttgtt

SEQ ID NO: 999 - DNA, 60 bp, Artificial Sequence
  Oligonucleotide
agactgtgaaaagatccttgaacggaaagccaaatcttgccaagtaggaaaggaaaaggg

SEQ ID NO: 1000 - DNA, 60 bp, Artificial Sequence
  Oligonucleotide
agagaccctttctgaaagaagtatggccaaaagcactttaatgctgctgacattgttgtt

SEQ ID NO: 1001 - DNA, 60 bp, Artificial Sequence
  Oligonucleotide
agagcgaggagaagcgagaaaagatgaaacggacccttttaaaagattggaagacccgtt

SEQ ID NO: 1002 - DNA, 60 bp, Artificial Sequence
  Oligonucleotide
agagcttggtttcattgagcatttctctatttttccagttatcccgaaatttctatgtat

SEQ ID NO: 1003 - DNA, 60 bp, Artificial Sequence
  Oligonucleotide
agagtcatctctagttccccacctcaatcccggcatccagccttcagtcccgcccacgtg

SEQ ID NO: 1004 - DNA, 60 bp, Artificial Sequence
  Oligonucleotide
agatattctacatcccatccacaatactactgattttagaggacaagacaataaagggat

SEQ ID NO: 1005 - DNA, 60 bp, Artificial Sequence
  Oligonucleotide
agcacatttgcctactaatggaaaaggttaataattcatgccaaaaatagaaattagcgt

SEQ ID NO: 1006 - DNA, 60 bp, Artificial Sequence
  Oligonucleotide
agcacctaagaagggctgctggacctacagagctcatggttggattaacccatgcatgag

SEQ ID NO: 1007 - DNA, 61 bp, Artificial Sequence
  Oligonucleotide
agctactagctgcctacgtgtgtgcatttgctatatagcatacttcttttttccagtttcc

SEQ ID NO: 1008 - DNA, 60 bp, Artificial Sequence
  Oligonucleotide
agcttggaacttttgagatgatccctaacatactgtactacttgcttttacaatgtgtta

SEQ ID NO: 1009 - DNA, 60 bp, Artificial Sequence
  Oligonucleotide
aggaatatgcagaggagttcaggacctacctggagggcgagtgcctggagttgctccgca

SEQ ID NO: 1010 - DNA, 60 bp, Artificial Sequence
  Oligonucleotide
aggattatgggtcctgcaattctacagtttcttactgttttgtatcaaaatcactatctt

SEQ ID NO: 1011 - DNA, 60 bp, Artificial Sequence
  Oligonucleotide
aggcacagtacggcctcaccgacgaggttcaccagctagaggcaaccatcgctgccctga

SEQ ID NO: 1012 - DNA, 60 bp, Artificial Sequence
  Oligonucleotide
aggctctgtgaggcacgaaccctgcctccctaggccggaccttgtggacgacagccccac

SEQ ID NO: 1013 - DNA, 60 bp, Artificial Sequence
  Oligonucleotide
agggaacagtgcttagaaaagcaaaaactaggtgtgtcattgaaataataggcataaaaa

SEQ ID NO: 1014 - DNA, 60 bp, Artificial Sequence
  Oligonucleotide
agggccagggatgcatgggattttaattgtttcatcacaccttccccgtggcaaagaaac

SEQ ID NO: 1015 - DNA, 60 bp, Artificial Sequence
  Oligonucleotide
aggtccaggtagttcgaggacactacaaaggtcagcaaattggcaaggtagtccaggtgt

SEQ ID NO: 1016 - DNA, 60 bp, Artificial Sequence
  Oligonucleotide
agtcccttagccattatctgagaggctagaattctggcagtgtccccgtgcatctttccc

SEQ ID NO: 1017 - DNA, 60 bp, Artificial Sequence
  Oligonucleotide
agttataattcctgcctcagaaaaagcttttccattacactgtgaatgatacctgttttg

SEQ ID NO: 1018 - DNA, 60 bp, Artificial Sequence
  Oligonucleotide
atattaaaggcattgaaggacattcacctggaaacttaccaaaattctgccatgagtgtg

SEQ ID NO: 1019 - DNA, 60 bp, Artificial Sequence
  Oligonucleotide
atcacactgtcagaggcttacattcagatttggaagaggcgagataatgatgaaaccaac

SEQ ID NO: 1020 - DNA, 60 bp, Artificial Sequence
  Oligonucleotide
atcagagaccctgcctctgtttgaccccgcactgactgaataaagctcctctggccgttt

SEQ ID NO: 1021 - DNA, 60 bp, Artificial Sequence
  Oligonucleotide
atcctgctggaacctcagctgcaacatgagctccgcagccaggtcccgcctcacccgcgc

SEQ ID NO: 1022 - DNA, 60 bp, Artificial Sequence
  Oligonucleotide
atgataaactctgtaaggaagttcccaactataaacttataaccccagctgtggtctctg

SEQ ID NO: 1023 - DNA, 60 bp, Artificial Sequence
  Oligonucleotide
atggaccccaagttcccgaggaacatgtgctttgccaagaagcaaaacaagaaggtccta

SEQ ID NO: 1024 - DNA, 60 bp, Artificial Sequence
  Oligonucleotide
atggagctggcctgcagcctttttgtgcaagtgggaacgccactgtccccctgctttgtg

SEQ ID NO: 1025 - DNA, 60 bp, Artificial Sequence
  Oligonucleotide
atggctcaaataataccctgggtatgcaggacccactataccttgcatttgctgagtaca

SEQ ID NO: 1026 - DNA, 60 bp, Artificial Sequence
  Oligonucleotide
atgggaagaacagaattgctcctgcatgcaactaattcaataaaactgtcttgtgagctg

SEQ ID NO: 1027 - DNA, 60 bp, Artificial Sequence
  Oligonucleotide
atgtagcaaagcttttagccgatcctcaaaacttactgaacataagataattcatactgg

SEQ ID NO: 1028 - DNA, 60 bp, Artificial Sequence
  Oligonucleotide
atttccttatccatggaggagacctctgaacagatcacaaatgttacgtgagctttttcc

SEQ ID NO: 1029 - DNA, 60 bp, Artificial Sequence
  Oligonucleotide
caaacatcttattgatacttacttcaagaagaagaagctgtggaagcccagacacctgat

SEQ ID NO: 1030 - DNA, 60 bp, Artificial Sequence
  Oligonucleotide
caacctactacgcacagtgctaccgccacatgctggacttgcagaagcagctgggcagat

SEQ ID NO: 1031 - DNA, 60 bp, Artificial Sequence
  Oligonucleotide
caattccacgatgccaaattcatggcagacattgatctggatccaggctgtacattgaat

SEQ ID NO: 1032 - DNA, 60 bp, Artificial Sequence
  Oligonucleotide
cacagagcatcgtggaggccacctctaggcttaagaccttcaacttgatcccggctgttg

SEQ ID NO: 1033 - DNA, 60 bp, Artificial Sequence
  Oligonucleotide
caccagttggtggaggcttcagggaagaccagagtcctggacagagagggtaacaggagg

SEQ ID NO: 1034 - DNA, 60 bp, Artificial Sequence
  Oligonucleotide
cacgcaaccctggataaatacgtaattaagtcccggcgctcccactcccggaaaggacct

SEQ ID NO: 1035 - DNA, 60 bp, Artificial Sequence
  Oligonucleotide
cactggaggccttgtaggattaaggataccaacatcaaaggtgtaatcagcctcattgga

SEQ ID NO: 1036 - DNA, 60 bp, Artificial Sequence
  Oligonucleotide
cagagaatcaaggattttttgcggaatcttgtacccaggacagagtcctagtgtgtgccc

SEQ ID NO: 1037 - DNA, 60 bp, Artificial Sequence
  Oligonucleotide
cagctgtagcctatggtgtggccagcctcacccccagcagcaagcgtggctgcccccaca

SEQ ID NO: 1038 - DNA, 60 bp, Artificial Sequence
  Oligonucleotide
caggacgatacactcacgctgcaggctgcaggccttgtgcccaaagcagcactgctgctg

SEQ ID NO: 1039 - DNA, 60 bp, Artificial Sequence
  Oligonucleotide
caggcaactccgagtctgcccccgtccctgcaacgggtgactctcaggatgcccctgtgc

SEQ ID NO: 1040 - DNA, 60 bp, Artificial Sequence
  Oligonucleotide
cagtgttgcagtgtgaattcctaaatagagggtaaagtgagcctagccaggaggtgtttg

SEQ ID NO: 1041 - DNA, 60 bp, Artificial Sequence
  Oligonucleotide
catcatagatgacatcaacagtggtgccatggaatgcccagccagttaagcacaaaggaa

SEQ ID NO: 1042 - DNA, 60 bp, Artificial Sequence
  Oligonucleotide
catgcaccttacaatttctgaacagttaaccctatagaagcatgctttatatgagtgtct

SEQ ID NO: 1043 - DNA, 60 bp, Artificial Sequence
  Oligonucleotide
ccaacaccttctcgcccgcaaacgtggacgcctccgtgatgtacaggaagtggaaagaga

SEQ ID NO: 1044 - DNA, 60 bp, Artificial Sequence
  Oligonucleotide
ccaatatccaggataaggaaggcatcctccccgaccagcagaggctcatctttgcaggca

SEQ ID NO: 1045 - DNA, 60 bp, Artificial Sequence
  Oligonucleotide
ccacaactaccagattgtcaatcatgaccaaaagttgcttctcatcacttctacaacccc

SEQ ID NO: 1046 - DNA, 60 bp, Artificial Sequence
  Oligonucleotide
ccatccttccagctatcctgcaaagtgcagcccttccatgttgccctgaaagtcccagat

SEQ ID NO: 1047 - DNA, 60 bp, Artificial Sequence
  Oligonucleotide
ccatttagtcacctaggccaaagtccggaaggatgctcctcttacacttttccgaagata

SEQ ID NO: 1048 - DNA, 60 bp, Artificial Sequence
  Oligonucleotide
cccactggcttcaagatggcattaattactagcctcccactgtggtgcctggcagagacc

SEQ ID NO: 1049 - DNA, 60 bp, Artificial Sequence
  Oligonucleotide
ccccagaaaccgaatcctctcttctgcatccccctctaagtgatctctcccagtcctggg

SEQ ID NO: 1050 - DNA, 60 bp, Artificial Sequence
  Oligonucleotide
ccccctctagtgcataattcagcatacgatgagtatgagtctgttttggaccccatccaa

SEQ ID NO: 1051 - DNA, 60 bp, Artificial Sequence
  Oligonucleotide
ccctcggcctcccgttggtatcttccatctcatgcgttcagcattgtaacctcgcggcgg

SEQ ID NO: 1052 - DNA, 60 bp, Artificial Sequence
  Oligonucleotide
ccctggtaaagcccaaggaagttaagcccaagatcccaaagggtgtcagccacaagctcc

SEQ ID NO: 1053 - DNA, 60 bp, Artificial Sequence
  Oligonucleotide
ccgaccgacagttccaggagctcaacgagctggcggagtttgcccgcttacaggaccagc

SEQ ID NO: 1054 - DNA, 60 bp, Artificial Sequence
  Oligonucleotide
cctccactgcttttctatgggagacactcttaatttaacagatgagaatattttgaaact

SEQ ID NO: 1055 - DNA, 60 bp, Artificial Sequence
  Oligonucleotide
cctggaaatgccagagaaggataacacattcgtcctcaaggtagagaatggagccgaata

SEQ ID NO: 1056 - DNA, 60 bp, Artificial Sequence
  Oligonucleotide
ccttgcccacctcactcctgagttagcacactttccaggtgtcagcaggtgtgatcaggg

SEQ ID NO: 1057 - DNA, 60 bp, Artificial Sequence
  Oligonucleotide
ccttgctatagaagacctgggacagaggactgctgtctgccctctctggtcaccctgcct

SEQ ID NO: 1058 - DNA, 60 bp, Artificial Sequence
  Oligonucleotide
cctttgaaatatatagaaggtgacaaagcttttaaccagtcctcaacccatactacacat

SEQ ID NO: 1059 - DNA, 60 bp, Artificial Sequence
  Oligonucleotide
cgctgctgcaaccggccgtgtggcgcgcgctgctcctggaccgccgccaggccctgccca

SEQ ID NO: 1060 - DNA, 60 bp, Artificial Sequence
  Oligonucleotide
cgtcccaaatcaataagaaggtagaatgagttatgagttattcatattctgttggaagct

SEQ ID NO: 1061 - DNA, 60 bp, Artificial Sequence
  Oligonucleotide
ctaatgaaatgtagttgggttcttcctgtaatgcgctattatgtcttgggcttaataaaa

SEQ ID NO: 1062 - DNA, 60 bp, Artificial Sequence
  Oligonucleotide
ctagctccacggcacgggtgtctcccagccactgcccttgctggaggaccgctgtgagtc

SEQ ID NO: 1063 - DNA, 60 bp, Artificial Sequence
  Oligonucleotide
ctcaaccagacaaatcagggctgcccagtgatcggttctctgcagagaggcctgagggat

SEQ ID NO: 1064 - DNA, 60 bp, Artificial Sequence
  Oligonucleotide
ctcccacctcaccgtttccatagttggctcttttgtgtcatcttaccctttacagagaaa

SEQ ID NO: 1065 - DNA, 60 bp, Artificial Sequence
  Oligonucleotide
ctgcagctgttcaagcacgagatgcagcatttcgtgaaggtcatccagggctacatcgcc

SEQ ID NO: 1066 - DNA, 60 bp, Artificial Sequence
  Oligonucleotide
ctgcccccaagacactgtgtgtgacctgatccagagtaagtgcctctccaaggagaacgc

SEQ ID NO: 1067 - DNA, 60 bp, Artificial Sequence
  Oligonucleotide
ctgccccctggacctcttctacaagtgtgtctgcttcctgcctgtgaaactcatcttcgt

SEQ ID NO: 1068 - DNA, 60 bp, Artificial Sequence
  Oligonucleotide
ctggagagacagatctgaatgttcagttctagccaaggtagattttactttcaacttttt

SEQ ID NO: 1069 - DNA, 60 bp, Artificial Sequence
  Oligonucleotide
cttctatgacgagaatgatgccaaactctttgaacagattttgaaggccgagtacgagtt

SEQ ID NO: 1070 - DNA, 60 bp, Artificial Sequence
  Oligonucleotide
ctttctctgtttagcagtcacaggtgagggtggtattagcatcttttttatgtagaaaaa

SEQ ID NO: 1071 - DNA, 60 bp, Artificial Sequence
  Oligonucleotide
ctttgactgccagtatctgatggccacctttgtcaatgtatacatcgccagttttatcag

SEQ ID NO: 1072 - DNA, 60 bp, Artificial Sequence
  Oligonucleotide
gaaatattccaaggcctggatgctaatcaagatgaacaggtcgactttcaagaattcata

SEQ ID NO: 1073 - DNA, 60 bp, Artificial Sequence
  Oligonucleotide
gaaatggcgatattgatatcatgtccctgaaacgaatgctggagaaacttggagtcccca

SEQ ID NO: 1074 - DNA, 60 bp, Artificial Sequence
  Oligonucleotide
gaaatgtgtcctgagaatggatcttgtgtacctgatggtccaggtcttttgcagtgtgtt

SEQ ID NO: 1075 - DNA, 60 bp, Artificial Sequence
  Oligonucleotide
gaacatggaacagaatgaacagaaagagcagaagtcaagtgagctcatgaaagaagttcc

SEQ ID NO: 1076 - DNA, 60 bp, Artificial Sequence
  Oligonucleotide
gaagcttgagcctaaatctggctggatgacttttctagaagttacaggaaagatctgtga

SEQ ID NO: 1077 - DNA, 60 bp, Artificial Sequence
  Oligonucleotide
gaaggttctggctccacgggtgaatctgacttttcgtaaaattttgcttactaaaaaata

SEQ ID NO: 1078 - DNA, 60 bp, Artificial Sequence
  Oligonucleotide
gaagtggctcttgcagctagagttgactcagaagccgaaattcctagaaatcaggtttct

SEQ ID NO: 1079 - DNA, 60 bp, Artificial Sequence
  Oligonucleotide
gaatgttgaaggattgaagagttctaagcataaaataagtggcattttctgacttcttcc

SEQ ID NO: 1080 - DNA, 60 bp, Artificial Sequence
  Oligonucleotide
gaccaagatgatcagaaacctggcccctcagagcgatctcgagccacaaagtcaggaagt

SEQ ID NO: 1081 - DNA, 60 bp, Artificial Sequence
  Oligonucleotide
gacgggccagcccaggaaccccagagcgcaccatggctgtccaagtcctctgtctcctct

SEQ ID NO: 1082 - DNA, 60 bp, Artificial Sequence
  Oligonucleotide
gactgagctgtttattttcttcacttcccttatgcaaaaatttaccttcaggcccccaaa

SEQ ID NO: 1083 - DNA, 60 bp, Artificial Sequence
  Oligonucleotide
gactgccagcgtggtacctcccatgctgcaggcctccatctaaatgagacaacaaagcac

SEQ ID NO: 1084 - DNA, 60 bp, Artificial Sequence
  Oligonucleotide
gactgtggacctcatggttgagcacacgtcgttcaaggagatgaagaagaaccctatgac

SEQ ID NO: 1085 - DNA, 60 bp, Artificial Sequence
  Oligonucleotide
gacttcactggaaacagcaaactggagctgaatttcaaagctggagatgtgatcttcctc

SEQ ID NO: 1086 - DNA, 60 bp, Artificial Sequence
  Oligonucleotide
gacttgtatgctgaactccgctgcatgtgtataaagacaacctctggaattcatcccaaa

SEQ ID NO: 1087 - DNA, 60 bp, Artificial Sequence
  Oligonucleotide
gagctggacaccccctctatgactgcagagcaagtagctgccattgagcagagcgtcaat

SEQ ID NO: 1088 - DNA, 60 bp, Artificial Sequence
  Oligonucleotide
gagggattaaagataaaaattttggctggatgcaatggctcacgcctgctatcccgctat

SEQ ID NO: 1089 - DNA, 60 bp, Artificial Sequence
  Oligonucleotide
gatatagattgtccggccgctttgtgattccatggattgattcagtcttctggatttttt

SEQ ID NO: 1090 - DNA, 60 bp, Artificial Sequence
  Oligonucleotide
gatctctctgtgactgactttgtgactgtcctgtggtttctcctgccattgctttgtgtt

SEQ ID NO: 1091 - DNA, 60 bp, Artificial Sequence
  Oligonucleotide
gattcttcagaggttagcctggtactttctcatcagacactagcttgaagtaagaggaga

SEQ ID NO: 1092 - DNA, 60 bp, Artificial Sequence
  Oligonucleotide
gcaagcctcctgcttcactttcaggtttctcgaagtgccttcttgctcctgtctgtttcc

SEQ ID NO: 1093 - DNA, 60 bp, Artificial Sequence
  Oligonucleotide
gcagtgagatcccaggaagctggcacatcttggaaggtccgtcctgctcggcttttcgct

SEQ ID NO: 1094 - DNA, 60 bp, Artificial Sequence
  Oligonucleotide
gccaaagtcatacactggctatcagaaaattatgctggaagaattgcagtggaaaaactg

SEQ ID NO: 1095 - DNA, 60 bp, Artificial Sequence
  Oligonucleotide
gccactgccgttcctctatgtgctcctgcccgccgtgtactccgggatctgtgctgtggg

SEQ ID NO: 1096 - DNA, 60 bp, Artificial Sequence
  Oligonucleotide
gccagttggctgaaaggtttgaaatacgtaccccagtaaaaccattcaatcaataattgg

SEQ ID NO: 1097 - DNA, 60 bp, Artificial Sequence
  Oligonucleotide
gcccatgcaactcagtccaggattttactgggtcagtgacattggtggaagccttcatgc

SEQ ID NO: 1098 - DNA, 60 bp, Artificial Sequence
  Oligonucleotide
gccccggcccctgcagccgcagagatgttgatgcctaagaagaaccggattgccatttat

SEQ ID NO: 1099 - DNA, 60 bp, Artificial Sequence
  Oligonucleotide
gccctggcagaagacatcgagaagaccatgagcacggctctgcacgagttgcgggaactc

SEQ ID NO: 1100 - DNA, 60 bp, Artificial Sequence
  Oligonucleotide
gcctggactcttgcactgaaaattgtctctccagctgtgtagaccacttcattgacacca

SEQ ID NO: 1101 - DNA, 60 bp, Artificial Sequence
  Oligonucleotide
gctatctgacccctgacctctggaaagagactgtatttaccaagtctccctatcaggact

SEQ ID NO: 1102 - DNA, 60 bp, Artificial Sequence
  Oligonucleotide
gctccattggatcagcttcccaggaagttcagcttcgggttagtacataaggccaccaca

SEQ ID NO: 1103 - DNA, 60 bp, Artificial Sequence
  Oligonucleotide
gctgcatcccgcgtccagcacctacgtcccgctgccgtcgccgccgccaccatgcccaag

SEQ ID NO: 1104 - DNA, 60 bp, Artificial Sequence
  Oligonucleotide
gctggtcacctacctgctccctctgctggtcatcctcctgtcttacgtccgggtgtcagt

SEQ ID NO: 1105 - DNA, 60 bp, Artificial Sequence
  Oligonucleotide
ggaagaccgctataaaggctgaatgatggatacattattccttcacacagtggattttga

SEQ ID NO: 1106 - DNA, 60 bp, Artificial Sequence
  Oligonucleotide
ggatatttcatgtctgaatcgggacccagctcgagtagtagttgtggactgcaagaagga

SEQ ID NO: 1107 - DNA, 60 bp, Artificial Sequence
  Oligonucleotide
ggcacaatgcggtccagaccctgctgcgtctcccttccaaactctggtgctgaataaacc

SEQ ID NO: 1108 - DNA, 60 bp, Artificial Sequence
  Oligonucleotide
ggcatacaaggcgctcctcagagtcaaacacttgatgcttttgcattatgagatttttgt

SEQ ID NO: 1109 - DNA, 60 bp, Artificial Sequence
  Oligonucleotide
ggcatcattggctatgatgtttgaagaccaatctttaacatctgattatatttgatttat

SEQ ID NO: 1110 - DNA, 60 bp, Artificial Sequence
  Oligonucleotide
ggcccactttgtagccccatcacccttggcctgctggtggctggcgtcctggttctgctg

SEQ ID NO: 1111 - DNA, 60 bp, Artificial Sequence
  Oligonucleotide
ggccccgagggcacggaggacgttttcaccttcggctttccagtaccgcccttcctgctg

SEQ ID NO: 1112 - DNA, 60 bp, Artificial Sequence
  Oligonucleotide
ggcgatgcccgtcctctggcttgggttaattcttcggtgacactggcattgctgggtggt

SEQ ID NO: 1113 - DNA, 60 bp, Artificial Sequence
  Oligonucleotide
gggagacgttcagctaccctgactttctcaggatgatgctgggcaagagatctgccatcc

SEQ ID NO: 1114 - DNA, 60 bp, Artificial Sequence
  Oligonucleotide
gggagtaaaaacaggctggtgcagacagcagagctcacaaaggtgttcgaaatccgcacc

SEQ ID NO: 1115 - DNA, 60 bp, Artificial Sequence
  Oligonucleotide
gggagtgaaatgttacccaattaggcttgtcaggttagtaataaactgaacagtaataaa

SEQ ID NO: 1116 - DNA, 60 bp, Artificial Sequence
  Oligonucleotide
gggatcttggtgctgagccgccacaccctgggcctggccctgcgggagcaccctgccctg

SEQ ID NO: 1117 - DNA, 60 bp, Artificial Sequence
  Oligonucleotide
gggcagatatgcattaaatagtttgtacaagcagctttcgttgaagtttagaagataaga

SEQ ID NO: 1118 - DNA, 60 bp, Artificial Sequence
  Oligonucleotide
gggtataatctcacaaatcgatgggactgcaaggattgtaaactgaaatgaacatgatta

SEQ ID NO: 1119 - DNA, 60 bp, Artificial Sequence
  Oligonucleotide
gggtcccatttctcactgagaagattgtgaatatttccatatggattttctattgttact

SEQ ID NO: 1120 - DNA, 60 bp, Artificial Sequence
  Oligonucleotide
gggtgattctcttgccattcatcgacagtcagcatgtcatccacaagtatttcctgcccc

SEQ ID NO: 1121 - DNA, 60 bp, Artificial Sequence
  Oligonucleotide
ggtcctcaaggaatcaaagtttaaggaaacaggtgtaattaccccagaagagtttgtggc

SEQ ID NO: 1122 - DNA, 60 bp, Artificial Sequence
  Oligonucleotide
ggtttggagatccaggaacacacagatttgggtatcaaatgtgacccatgcattggtatc

SEQ ID NO: 1123 - DNA, 60 bp, Artificial Sequence
  Oligonucleotide
gtaagccgaaaggatgaagagttagaccccatggaccctagctcatactcagacgccccc

SEQ ID NO: 1124 - DNA, 60 bp, Artificial Sequence
  Oligonucleotide
gtccgtgtgctggatgaacgcctggttcgactgcgtgatggtacccggtcttacttcggg

SEQ ID NO: 1125 - DNA, 60 bp, Artificial Sequence
  Oligonucleotide
gtgccatccagaagaaatccccctggcggcaagtccagcctcgtcttgggttagctctga

SEQ ID NO: 1126 - DNA, 60 bp, Artificial Sequence
  Oligonucleotide
gtgtcttgatgactctcccaggaatcagaaagatagtatttactaaagaaacggttgttt

SEQ ID NO: 1127 - DNA, 60 bp, Artificial Sequence
  Oligonucleotide
gtgtgctctggctcggataagagatgggacatcattcagtcactagttggatggcacaag

SEQ ID NO: 1128 - DNA, 60 bp, Artificial Sequence
  Oligonucleotide
gtgttactacaagatggcaataaatactatgggattgtttgtattaaaaaatttacattg

SEQ ID NO: 1129 - DNA, 60 bp, Artificial Sequence
  Oligonucleotide
gttcagttatgaggagtcaaatcctaaggatccagcggcagtgacagaatccaaagaggg

SEQ ID NO: 1130 - DNA, 60 bp, Artificial Sequence
  Oligonucleotide
gttccttgtggatgttaaagccaacaagcaccagattaaacaggctgtgaagaagctcta

SEQ ID NO: 1131 - DNA, 60 bp, Artificial Sequence
  Oligonucleotide
gttgtcctgaagtcgggctctcccggccctgcctcccagcaagtaagcaagctcttttgg

SEQ ID NO: 1132 - DNA, 60 bp, Artificial Sequence
  Oligonucleotide
taagaggacacaaatgaggacacgtggcttttatacaaagtatctatatgagattcttct

SEQ ID NO: 1133 - DNA, 60 bp, Artificial Sequence
  Oligonucleotide
tacaatgtcttttagctaattctaattaaaaattacagactggtgtacaagatacttgtg

SEQ ID NO: 1134 - DNA, 60 bp, Artificial Sequence
  Oligonucleotide
tacacagccccgtgaaccctgaggagtggagtcatacacgaagggcgtgtggccatcgtg

SEQ ID NO: 1135 - DNA, 60 bp, Artificial Sequence
  Oligonucleotide
taccagtgaccatattgaaacgctgtatgagctggacatcgagtactctcaagttttagc

SEQ ID NO: 1136 - DNA, 60 bp, Artificial Sequence
  Oligonucleotide
tacccagtaactgaaagcccctctggtcctcgccagctatttatttcttggatatttatt

SEQ ID NO: 1137 - DNA, 60 bp, Artificial Sequence
  Oligonucleotide
tacctgcctgtagacaagtctctctcataccaacagaacttccggtacttccagaaccaa

SEQ ID NO: 1138 - DNA, 60 bp, Artificial Sequence
  Oligonucleotide
tacttttagcctgtgtcaaatgtaagtcccaagtatttccagcaggaagtaatgtcttcc

SEQ ID NO: 1139 - DNA, 60 bp, Artificial Sequence
  Oligonucleotide
tatcaccctttactgcaaccacaggaaccgaagacgtgtttgcaaatgtccccggcctgt

SEQ ID NO: 1140 - DNA, 60 bp, Artificial Sequence
  Oligonucleotide
tatgccagaaccccctccatcgtctacgttatctgcatcacttccaggtccaccctttct

SEQ ID NO: 1141 - DNA, 60 bp, Artificial Sequence
  Oligonucleotide
tatgtcaaaaattggacaaaagtttctcaatgattaaggagggtgattataaccccctct

SEQ ID NO: 1142 - DNA, 60 bp, Artificial Sequence
  Oligonucleotide
tattcgaaatctcaggactcttctggccgtaggttccaggaaagctcgtggaagctttgg

SEQ ID NO: 1143 - DNA, 60 bp, Artificial Sequence
  Oligonucleotide
tcaaacgcagaaggactgcctcactgagcaaccaagagtgtcagttgtacccgaggcgtt

SEQ ID NO: 1144 - DNA, 60 bp, Artificial Sequence
  Oligonucleotide
tcactccgcgtccctactgcacctgtcacaaagtgccttctgatatgcctggcaaaccaa

SEQ ID NO: 1145 - DNA, 60 bp, Artificial Sequence
  Oligonucleotide
tcagatgatgactggttgaagaagttttctgggaagacgcttgaagagaataaagaggaa

SEQ ID NO: 1146 - DNA, 60 bp, Artificial Sequence
  Oligonucleotide
tcaggagcgcattaactgcctggaagggacccacgagttttttgaggccattgggttcca

SEQ ID NO: 1147 - DNA, 60 bp, Artificial Sequence
  Oligonucleotide
tcatcaagtcaaaagcactgagtgttttgctagtctagtgacatgggttattgtatttcc

SEQ ID NO: 1148 - DNA, 60 bp, Artificial Sequence
  Oligonucleotide
tcatcctcactcagttccctggtagcacagactgacagctgctcttgggctatagcttgg

SEQ ID NO: 1149 - DNA, 60 bp, Artificial Sequence
  Oligonucleotide
tcccgtcaggacgttgaggacttttcgaccaattcaaccctttgccccacctttattaaa

SEQ ID NO: 1150 - DNA, 60 bp, Artificial Sequence
  Oligonucleotide
tccgcttatttctgccagtatattttggacactttataatcattaaagcactttcttggc

SEQ ID NO: 1151 - DNA, 60 bp, Artificial Sequence
  Oligonucleotide
tccgggctgggtaagcttagacaagccccctcccctctctgtgagcctgtttctctggga

SEQ ID NO: 1152 - DNA, 60 bp, Artificial Sequence
  Oligonucleotide
tctcagttacaacctattacatatggtccttcacattcagggtctgctacaacagcttcc

SEQ ID NO: 1153 - DNA, 60 bp, Artificial Sequence
  Oligonucleotide
tctccagttggttatctgaatagtgtcaccaattccaccaagacagtgctgagattggaa

SEQ ID NO: 1154 - DNA, 60 bp, Artificial Sequence
  Oligonucleotide
tctccccaggaattcacttaaaaagggactgagcattgtgtcaacctgttgcagtgtttt

SEQ ID NO: 1155 - DNA, 60 bp, Artificial Sequence
  Oligonucleotide
tctgtagagatggcctttcacttgaggagtactcagttttcaggttcttcctagctcggg

SEQ ID NO: 1156 - DNA, 60 bp, Artificial Sequence
  Oligonucleotide
tcttcgccttccacttctaccgctcactggtcagccataagaccgaccgacagttccagg

SEQ ID NO: 1157 - DNA, 60 bp, Artificial Sequence
  Oligonucleotide
tcttgtttttccactactgctaccacaactatattatcatgcaaatgctgtattcttctt

SEQ ID NO: 1158 - DNA, 60 bp, Artificial Sequence
  Oligonucleotide
tcttttgtctttccgtggagctgtcgccatgaaggtcgagctgtgcagttttagcgggta

SEQ ID NO: 1159 - DNA, 60 bp, Artificial Sequence
  Oligonucleotide
tgaaaaagcaatgacaaatcactgcaagagtacacgtcataagcaaaatactgagaaatt

SEQ ID NO: 1160 - DNA, 60 bp, Artificial Sequence
  Oligonucleotide
tgaagaaagttgaaatcagccagcaggccaagtacacttgctctttctgtggcaaaacca

SEQ ID NO: 1161 - DNA, 60 bp, Artificial Sequence
  Oligonucleotide
tgacgctctctgttctacacagccctcctggtcttcagtgccctgggaaacatccttgcc

SEQ ID NO: 1162 - DNA, 60 bp, Artificial Sequence
  Oligonucleotide
tgactgccccatattttacatccctcattcaaggtactggctcctgtatcacccagctct

SEQ ID NO: 1163 - DNA, 60 bp, Artificial Sequence
  Oligonucleotide
tgaggctgcggacaaagccctttcatctgaggactttcatctgtgcatatcacggccccc

SEQ ID NO: 1164 - DNA, 60 bp, Artificial Sequence
  Oligonucleotide
tgcagatgctcttaaaagcattgataacctttgtgacgaacataaagagatccttaaatt

SEQ ID NO: 1165 - DNA, 60 bp, Artificial Sequence
  Oligonucleotide
tgcagtagacgatacaggttgcatgtggacactcagtcacattaacaacttgggaaaaaa

SEQ ID NO: 1166 - DNA, 60 bp, Artificial Sequence
  Oligonucleotide
tgccctggaccctcggctgggtagcgccaccagagcgaccaaacgtcccgcgccttccag

SEQ ID NO: 1167 - DNA, 60 bp, Artificial Sequence
  Oligonucleotide
tgccggaaaattggtcgcgattgtagatgttattgatcagaacagggctttggtcgatgg

SEQ ID NO: 1168 - DNA, 60 bp, Artificial Sequence
  Oligonucleotide
tgccgggctttatcgctgcctctattataagccccctggatggtctgagcacagtgactt

SEQ ID NO: 1169 - DNA, 60 bp, Artificial Sequence
  Oligonucleotide
tggagatggcgactagtggacaacagaacaatattggaatggtggtaatacgaggaaata

SEQ ID NO: 1170 - DNA, 60 bp, Artificial Sequence
  Oligonucleotide
tggatgacatggacatggacttagacaaggaatttctccaggacttgaaggagctcaagg

SEQ ID NO: 1171 - DNA, 60 bp, Artificial Sequence
  Oligonucleotide
tgggcacattgctgctaattaatcttcctaatctcgtgggatcacaatatgaataacaag

SEQ ID NO: 1172 - DNA, 60 bp, Artificial Sequence
  Oligonucleotide
tggtcaacttagcttttaagcagacgatgctgtaaaaactaacggcttctctgatattta

SEQ ID NO: 1173 - DNA, 60 bp, Artificial Sequence
  Oligonucleotide
tggtgaagaagcaggtgtttgagctactggctgccctgtgcatctactctcccgagggcc

SEQ ID NO: 1174 - DNA, 60 bp, Artificial Sequence
  Oligonucleotide
tgtacaacacttcttactgcgctgagatcgctcacagtgtttcctccaggaaccgcgaag

SEQ ID NO: 1175 - DNA, 60 bp, Artificial Sequence
  Oligonucleotide
tgtacagttatagctacaaccagtattatcagcagtaccagaactactatgctcagtggg

SEQ ID NO: 1176 - DNA, 60 bp, Artificial Sequence
  Oligonucleotide
tgtcagaactaaggaatgaattacagcggaaagatgcactagtccagaagcacttgacaa

SEQ ID NO: 1177 - DNA, 60 bp, Artificial Sequence
  Oligonucleotide
tgtccttcccgtcagcctggcatttgacaaatgtacagcttgttcttccaaagttcttga

SEQ ID NO: 1178 - DNA, 60 bp, Artificial Sequence
  Oligonucleotide
tgtcttcgttagaaaagtaaaaatgctgaagaagcccaagtttgaattgggaaagctcat

SEQ ID NO: 1179 - DNA, 60 bp, Artificial Sequence
  Oligonucleotide
ttaagtaagtttttctcaaattttgtttcagttctaggtcccttgtcacagcttggtttt

SEQ ID NO: 1180 - DNA, 60 bp, Artificial Sequence
  Oligonucleotide
ttcattctgtattttgcccgcaaagttttaaagctttcatccacagtcaggaattaaact

SEQ ID NO: 1181 - DNA, 60 bp, Artificial Sequence
  Oligonucleotide
ttccatcatggattcattacagcttaatcaaaataacgccccagataccagcccctgtat

SEQ ID NO: 1182 - DNA, 60 bp, Artificial Sequence
  Oligonucleotide
ttccgctattttgcaccacctgcctggcccttatgggcaactcaaggaagaaaggaaaga

SEQ ID NO: 1183 - DNA, 60 bp, Artificial Sequence
  Oligonucleotide
ttcgcactgctgtctttggctttgagacctcggaagcgaagggccccgatggcatggccc

SEQ ID NO: 1184 - DNA, 60 bp, Artificial Sequence
  Oligonucleotide
ttctgtaatcaaactgcaaatattgtcataaccaacatccaaaatgacggctgctatata

SEQ ID NO: 1185 - DNA, 60 bp, Artificial Sequence
  Oligonucleotide
ttctgtgctggctgctcagaagataccgcatatctaagaagattgatcacctcatgtatc

SEQ ID NO: 1186 - DNA, 60 bp, Artificial Sequence
  Oligonucleotide
ttgatagaaaacgctttgattgctcaatctcttggtaaatatggcaccatctgcctggag

SEQ ID NO: 1187 - DNA, 60 bp, Artificial Sequence
  Oligonucleotide
tttacctctaggaggatttgctgagctcatgggaagtaatgggcctcaaaagttttgcat

SEQ ID NO: 1188 - DNA, 60 bp, Artificial Sequence
  Oligonucleotide
tttcctctatattcgttcttggctcccttgtatatttttctcaggaggcgtcacggtggg

SEQ ID NO: 1189 - DNA, 60 bp, Artificial Sequence
  Oligonucleotide
tttgtagacacctcaaattatatcactgttctctagcgccaatattcccaggtaaattga

SEQ ID NO: 1190 - DNA, 60 bp, Artificial Sequence
  Oligonucleotide
tttgtgatgtcatttgcctgtgtcatggcctgccttccctagatattgtcctaatgtgag

SEQ ID NO: 1191 - DNA, 60 bp, Artificial Sequence
  Oligonucleotide
ttttactattgaactgtattctagtggctgttcatgctccaagactttagttaccgagac

SEQ ID NO: 1192 - DNA, 60 bp, Artificial Sequence
  Oligonucleotide
aaacatgaacagcaccaagctctcagctgacacctacgaagatctgaaggccaagcttcc

SEQ ID NO: 1193 - DNA, 60 bp, Artificial Sequence
  Oligonucleotide
aaggtggttctttccttgaagggcagcctcctgcccaggccccgtggccctggagcctca

SEQ ID NO: 1194 - DNA, 60 bp, Artificial Sequence
  Oligonucleotide
accccatgctccccaagaacgcggctctgcgctggaaggctgtggcctcttgctcctcct

SEQ ID NO: 1195 - DNA, 60 bp, Artificial Sequence
  Oligonucleotide
atggagctgtgcaagttggaagccgcggaggctctcggaacatgacctacctgccggcgg

SEQ ID NO: 1196 - DNA, 60 bp, Artificial Sequence
  Oligonucleotide
caccaagctgtctggcgcatgtgccctgggcatctccaccctcagtctggagttctcggg

SEQ ID NO: 1197 - DNA, 60 bp, Artificial Sequence
  Oligonucleotide
cagagtgcacctgacactgccatcacatcgtcagtatcactgcctgtctctgccaccaaa

SEQ ID NO: 1198 - DNA, 60 bp, Artificial Sequence
  Oligonucleotide
ccaaattaggcttagactgtgcaaagggcttagctaagttatcgagcttaaaacccgtca

SEQ ID NO: 1199 - DNA, 60 bp, Artificial Sequence
  Oligonucleotide
ctcctgtattaccgccgagtggacctgctgtaaaccctgtgtgcgctgtgtgtgcgccca

SEQ ID NO: 1200 - DNA, 60 bp, Artificial Sequence
  Oligonucleotide
cttcctgctctccatcatggcgcaggatcaaggtgaaaaggagaaccccatgcgggaact

SEQ ID NO: 1201 - DNA, 60 bp, Artificial Sequence
  Oligonucleotide
gcggtttctttctttccgcgccgatagcgctcacgcaagcatggttaacgtccctaaaac

SEQ ID NO: 1202 - DNA, 60 bp, Artificial Sequence
  Oligonucleotide
gtggtgaagacaatgcaagccctggagaaggcctacatcaaggactgtgtctcccccagc

SEQ ID NO: 1203 - DNA, 60 bp, Artificial Sequence
  Oligonucleotide
tctgtgccttggcaacaaagcgccactactccataaccccatgaaacctgccctgccccc

SEQ ID NO: 1204 - DNA, 60 bp, Artificial Sequence
  Oligonucleotide
cgctccatctcagcttccccatgtggtgctgtgctctgtggtggccaagactgccatgtt

SEQ ID NO: 1205 - DNA, 60 bp, Artificial Sequence
  Oligonucleotide
gctgagaaattcagctttgttttagttgaatcatcatattggaaagcagacattgaaagt

SEQ ID NO: 1206 - DNA, 60 bp, Artificial Sequence
  Oligonucleotide
ggttgggaggccatggaaccaggattagacccacatccggccaccaagacctctggctcc

SEQ ID NO: 1207 - DNA, 60 bp, Artificial Sequence
  Oligonucleotide
gtttcaatacagtgtcccaggcagtcactacctatagattagagctgatgtgctggcctg

SEQ ID NO: 1208 - DNA, 60 bp, Artificial Sequence
  Oligonucleotide
tgggctggatcctctggtacaccggcaacatcgagatctcgcgccaggagctggagcgcg

SEQ ID NO: 1209 - DNA, 60 bp, Artificial Sequence
  Oligonucleotide
tttcttgtatttctctcacgttaacaaaattggttcagcatctaccatgggctacatgct

SEQ ID NO: 1210 - DNA, 60 bp, Artificial Sequence
  Oligonucleotide
ccccacctgacctggcctcggccatcagcaactgggttcagtttgaagatgacacaccct

SEQ ID NO: 1211 - DNA, 60 bp, Artificial Sequence
  Oligonucleotide
cccccggagccatggccagcccttcccgcagctccgaagccactggcaagccccgaggca

SEQ ID NO: 1212 - DNA, 60 bp, Artificial Sequence
  Oligonucleotide
cccgagtcccctaccacttccgggcccccagccgcatcttctggcggaccgtgcgaggta

SEQ ID NO: 1213 - DNA, 60 bp, Artificial Sequence
  Oligonucleotide
gcagtaagaaaactgtaaaattcgagccatataaataaaacctgtactgttctagttgtt

SEQ ID NO: 1214 - DNA, 60 bp, Artificial Sequence
  Oligonucleotide
aaatacacagaggtcctcaagacccagggactcctgagcccaataaagactattaattcc

SEQ ID NO: 1215 - DNA, 60 bp, Artificial Sequence
  Oligonucleotide
actcctaagacatacttgtgatatttcaatgatgcaataaaagacctattgatttggacc

SEQ ID NO: 1216 - DNA, 60 bp, Artificial Sequence
  Oligonucleotide
ctcgctctctgggcaacaacagatatcagaaaacacttgccatttatttataacctaagc

SEQ ID NO: 1217 - DNA, 60 bp, Artificial Sequence
  Oligonucleotide
cttcaatattggtgatgccctggacagcagcagctccatgtaaaccatccaaaagaccac

SEQ ID NO: 1218 - DNA, 60 bp, Artificial Sequence
  Oligonucleotide
gatgggtagttagatttcccaaaatttcttaatctgattggtggcctagctgcggcttgc

SEQ ID NO: 1219 - DNA, 60 bp, Artificial Sequence
  Oligonucleotide
gattttggacccaagaagggagaaaactttggaggcagaagctctggcccctatggtggt

SEQ ID NO: 1220 - DNA, 60 bp, Artificial Sequence
  Oligonucleotide
ggtgaggaaggcaagaaaagctggcaacttctatgtacctgcagaacacagatcggtatt

SEQ ID NO: 1221 - DNA, 60 bp, Artificial Sequence
  Oligonucleotide
tgatggtaccttagatcacccctacagccatgctctggtggctggaattgaccgctgtcc

SEQ ID NO: 1222 - DNA, 60 bp, Artificial Sequence
  Oligonucleotide
aaagaaaattcatgtgaaagttctcagagtcgtccttgtctactccactaccaaatgttg

SEQ ID NO: 1223 - DNA, 60 bp, Artificial Sequence
  Oligonucleotide
agcccctgccactgccttcaccaggcccagctcacacacggcttggcaccgtgcacagag

SEQ ID NO: 1224 - DNA, 60 bp, Artificial Sequence
  Oligonucleotide
attaatctttcttaattggtttgcctgttctgcttctgtaaaaattgcttcagctaaact

SEQ ID NO: 1225 - DNA, 60 bp, Artificial Sequence
  Oligonucleotide
agcctggaccccgacacgctgcctgctgttgccacactcctcatggatgtcatgtcctac

SEQ ID NO: 1226 - DNA, 60 bp, Artificial Sequence
  Oligonucleotide
agcgtacaacagtgatacatgtaaccccaaatgtgatgtgagaggacgattactttgtaa

SEQ ID NO: 1227 - DNA, 60 bp, Artificial Sequence
  Oligonucleotide
ctcctatgttggaaatttgttcattaaaattctcccaataaagctttacagccttctgca

SEQ ID NO: 1228 - DNA, 60 bp, Artificial Sequence
  Oligonucleotide
tcccagaagtggttgtttcccttgcatgggacgaaagcttggctccaaagcatccaggct

SEQ ID NO: 1229 - DNA, 60 bp, Artificial Sequence
  Oligonucleotide
tggtgtctagcacattcctctaccttattttctgtcattgtacctacttctacctgaaca

SEQ ID NO: 1230 - DNA, 60 bp, Artificial Sequence
  Oligonucleotide
aaacaacttgaccaaaaatttgtcacagaattttgagacccattaaaaaagttaaatgag

SEQ ID NO: 1231 - DNA, 60 bp, Artificial Sequence
  Oligonucleotide
aaactacaaagaatactgtgctaaggcttgagtgcgttgagcccaactgcagatccaaga

SEQ ID NO: 1232 - DNA, 60 bp, Artificial Sequence
  Oligonucleotide
aaagtttatctataacctggaagaccatgagtggtgtgaaaacatggagtccgttttata

SEQ ID NO: 1233 - DNA, 60 bp, Artificial Sequence
  Oligonucleotide
aaatatatacgtctattctttatgccttgccctagccagatggaagaagatgaagaagga

SEQ ID NO: 1234 - DNA, 60 bp, Artificial Sequence
  Oligonucleotide
aaattggaagctgtgcagtataaaactcaagttgttgctggaacaaattactacattaag

SEQ ID NO: 1235 - DNA, 60 bp, Artificial Sequence
  Oligonucleotide
aacaactggagggagatcccagaaaacctgatggaccagtacagcgaggttaatgccatc

SEQ ID NO: 1236 - DNA, 60 bp, Artificial Sequence
  Oligonucleotide
aacaaggacaccaaggtacccaatgcctgtttattcaccatgaacaaagaagaccacaca

SEQ ID NO: 1237 - DNA, 60 bp, Artificial Sequence
  Oligonucleotide
aacgccacccactgccaatacaacttcccacaggtgggccgcacggctctgcgggtgctg

SEQ ID NO: 1238 - DNA, 60 bp, Artificial Sequence
  Oligonucleotide
aagaaaagccatctatgtactgaacccgggactagaaggaaaataaatgatctatatgtt

SEQ ID NO: 1239 - DNA, 60 bp, Artificial Sequence
  Oligonucleotide
aagaacagggttgggaccttttctgcccctgccccttagctactgaggcatagggagagg

SEQ ID NO: 1240 - DNA, 60 bp, Artificial Sequence
  Oligonucleotide
aagagagtgaccaagaaggctcagtgaaggtcccgcagggatgaggctgccagccccttc

SEQ ID NO: 1241 - DNA, 60 bp, Artificial Sequence
  Oligonucleotide
aagaggaatgtgttgaatgtcgcgtttgctgtccactcgtcctagaagtttagtgttttt

SEQ ID NO: 1242 - DNA, 60 bp, Artificial Sequence
  Oligonucleotide
aagcaaatccggccatgaagactgtctacaagttcgcaaaagatcatgcaaaaatgggaa

SEQ ID NO: 1243 - DNA, 60 bp, Artificial Sequence
  Oligonucleotide
aagctcattcttagaacttacacatctagaacagcttccactttggcagtgaggtcgtag

SEQ ID NO: 1244 - DNA, 60 bp, Artificial Sequence
  Oligonucleotide
aagctgacctttctgagaagttggtatggtgtaacactaaagtaggtggttcgtgtgtgt

SEQ ID NO: 1245 - DNA, 60 bp, Artificial Sequence
  Oligonucleotide
aaggagcccaggaactgaggcgactcgccccactgccatgtccaaaagcttgaaaaagaa

SEQ ID NO: 1246 - DNA, 60 bp, Artificial Sequence
  Oligonucleotide
aagtggaggagtagctcaagaagaaatgtttcactctgctctggtactatgatcccaatt

SEQ ID NO: 1247 - DNA, 60 bp, Artificial Sequence
  Oligonucleotide
aatgcaattctcagagaagacaaagacccgcaaaagatgtatgccaccatctatgagctg

SEQ ID NO: 1248 - DNA, 60 bp, Artificial Sequence
  Oligonucleotide
aatggctttggccacagccgtcttgtgaaggaaaacctgattgactacttcatccccttc

SEQ ID NO: 1249 - DNA, 60 bp, Artificial Sequence
  Oligonucleotide
acaatgccagcccgctgctttttctatcctcccagtcacctttgcagacaaagaccaggg

SEQ ID NO: 1250 - DNA, 60 bp, Artificial Sequence
  Oligonucleotide
acacagtgcgagagggcatcttggatacagctcagaccatctgtgacgtggcatcgcggg

SEQ ID NO: 1251 - DNA, 60 bp, Artificial Sequence
  Oligonucleotide
acacattccagcaaatgtatttgcaattatgtggttgatgctttgtgatataaatgtact

SEQ ID NO: 1252 - DNA, 60 bp, Artificial Sequence
  Oligonucleotide
acaggatgggtgcccgaccagcccaccgcccgtgagagctccaggactgaagccgcagag

SEQ ID NO: 1253 - DNA, 60 bp, Artificial Sequence
  Oligonucleotide
acatacagcagctctattgaataacatgcatctgaattttaagttgcaaaggtatctgaa

SEQ ID NO: 1254 - DNA, 60 bp, Artificial Sequence
  Oligonucleotide
accaagagacagaaacagaaaaacattaaacacagtgggaatatcacttttgatgagatc

SEQ ID NO: 1255 - DNA, 60 bp, Artificial Sequence
  Oligonucleotide
accttcctccctcactggacttcagtgtgggacctgcaggtctcaggccttctgggaagt

SEQ ID NO: 1256 - DNA, 60 bp, Artificial Sequence
  Oligonucleotide
acgtgcttactactgcagtgcatttgtcattagtcttcatgttaatacagtacatttatt

SEQ ID NO: 1257 - DNA, 60 bp, Artificial Sequence
  Oligonucleotide
acgttgtcgccaagtcccgggacttctggtacttcgtatctcagttaaaaaagatgaaga

SEQ ID NO: 1258 - DNA, 60 bp, Artificial Sequence
  Oligonucleotide
actattggatgttagtttggagtcctgtgtgcttctctctcttatggctgtgtccctggt

SEQ ID NO: 1259 - DNA, 60 bp, Artificial Sequence
  Oligonucleotide
actctaattgagattttggcatcaagaactaacaaagaaatcagagacattaacagggtc

SEQ ID NO: 1260 - DNA, 60 bp, Artificial Sequence
  Oligonucleotide
agaactcagggtggccctatgacttggaggagcaagatcagaccgctcaaaggtccccgt

SEQ ID NO: 1261 - DNA, 60 bp, Artificial Sequence
  Oligonucleotide
agaattttgcagagctgaaggtcaagtgcctgagaaagaagtttgcccaaaagatgcttt

SEQ ID NO: 1262 - DNA, 60 bp, Artificial Sequence
  Oligonucleotide
agaccatcactgacgagtttgagcagggcacctacatctactttgactacgagaagtggg

SEQ ID NO: 1263 - DNA, 60 bp, Artificial Sequence
  Oligonucleotide
agacctcaagtctgcctctactgtgtctcacatcaccatgtagaagaatgggcgtacagt

SEQ ID NO: 1264 - DNA, 60 bp, Artificial Sequence
  Oligonucleotide
agagattcctctgcgaatctgtttttagctatcaagtggcatccacgcttaaacaggtga

SEQ ID NO: 1265 - DNA, 60 bp, Artificial Sequence
  Oligonucleotide
agaggccacagagaaagaaaggtacctgggttcaactaagctccaggctgctccacccaa

SEQ ID NO: 1266 - DNA, 60 bp, Artificial Sequence
  Oligonucleotide
agatacaaaacttatttccatgtttctgaatcttctttgtttcaaatggtgctgcatgtt

SEQ ID NO: 1267 - DNA, 60 bp, Artificial Sequence
  Oligonucleotide
agatcaccgccgcgagtaaaaaggctccagcccagaaggttcctgcccagaaagccacag

SEQ ID NO: 1268 - DNA, 60 bp, Artificial Sequence
  Oligonucleotide
agattcaatcctgtaatgtgtgaaaacatacctctagatgaaagtcgaaatgaaaagctg

SEQ ID NO: 1269 - DNA, 60 bp, Artificial Sequence
  Oligonucleotide
agcaacactttgtgatctcatggctttgattgatttgggctgttcaaaatgtttatttga

SEQ ID NO: 1270 - DNA, 60 bp, Artificial Sequence
  Oligonucleotide
agcctggtgccggctgacagctcactggaacttttcatctgcttggccaggtgatgccaa

SEQ ID NO: 1271 - DNA, 60 bp, Artificial Sequence
  Oligonucleotide
agcgattccttgcaataatgtggaagtcctcatgagtggcaatgtcaggtgttataatat

SEQ ID NO: 1272 - DNA, 60 bp, Artificial Sequence
  Oligonucleotide
aggaagcagaatggctatgatgggcaaactaagccgattttccagaaaaaggctaaaact

SEQ ID NO: 1273 - DNA, 60 bp, Artificial Sequence
  Oligonucleotide
aggatctcacatttcaccccaggctcaactgaggatgtggcttattaaacacggaagtgc

SEQ ID NO: 1274 - DNA, 60 bp, Artificial Sequence
  Oligonucleotide
agtacgtgccctatggccccgtgatggaggtgctgccctacttgtcccgccgtgccctgg

SEQ ID NO: 1275 - DNA, 60 bp, Artificial Sequence
  Oligonucleotide
agtacttctgcagatctaagagattgctggctattaaaagatgcaagcattttgaactgg

SEQ ID NO: 1276 - DNA, 60 bp, Artificial Sequence
  Oligonucleotide
agtcaccatcgcacagggtggcgtcctgcccaacatccaggccgtgctgctgccaaagaa

SEQ ID NO: 1277 - DNA, 60 bp, Artificial Sequence
  Oligonucleotide
atacgagtggaatgaggtgaagaacgtcaaatccatcgtgcccatgattcacgtgtcatg

SEQ ID NO: 1278 - DNA, 60 bp, Artificial Sequence
  Oligonucleotide
atagtggagagtaggaaactgtactttatctcggcatcctcttgaatgatagtgcaagtt

SEQ ID NO: 1279 - DNA, 60 bp, Artificial Sequence
  Oligonucleotide
atatcaagggacagctcacagacatactgcagaagtcctgttggctgagataggacggcc

SEQ ID NO: 1280 - DNA, 60 bp, Artificial Sequence
  Oligonucleotide
atcagtaagcaggaatatgatgaggctggtcctcctatcgttcacagaaaatgtttctga

SEQ ID NO: 1281 - DNA, 60 bp, Artificial Sequence
  Oligonucleotide
atcctgctgctattccgccttcattaacagactactcagtaccattccaccatacgccaa

SEQ ID NO: 1282 - DNA, 60 bp, Artificial Sequence
  Oligonucleotide
atccttacagaccatttgagggcttcctcatcgacttaaagacccgctatcccatattgg

SEQ ID NO: 1283 - DNA, 60 bp, Artificial Sequence
  Oligonucleotide
atctccaacaatcaaagctagacgtagcaggagtagaagctattctcgcagaattaaaat

SEQ ID NO: 1284 - DNA, 60 bp, Artificial Sequence
  Oligonucleotide
atgctgcgggccattagagatttcttctggaaaactggaaacaagatagggtttaaacca

SEQ ID NO: 1285 - DNA, 60 bp, Artificial Sequence
  Oligonucleotide
caaatagttcatcaaaatgaatctttgctctttggactgaattcttaccatactgccatt

SEQ ID NO: 1286 - DNA, 60 bp, Artificial Sequence
  Oligonucleotide
caaggatctctctcactaaaggcatacagactgactcctaaactgatggaagtttgtaaa

SEQ ID NO: 1287 - DNA, 60 bp, Artificial Sequence
  Oligonucleotide
caagttcgtgtacagccaaagagagctatttgagccttggaataatctgcctaaatatta

SEQ ID NO: 1288 - DNA, 60 bp, Artificial Sequence
  Oligonucleotide
cacaaattttatcaaaaatcaaagctattcctcagctccagggctagctgcgatctgtgt

SEQ ID NO: 1289 - DNA, 60 bp, Artificial Sequence
  Oligonucleotide
cacggcagctctccgccaatttctctcagatttccacagagactgtttgaatgttttcaa

SEQ ID NO: 1290 - DNA, 60 bp, Artificial Sequence
  Oligonucleotide
cagaacctgagcgacctctatcgttggcttcaggcccaaaaagacaagatgttttcccag

SEQ ID NO: 1291 - DNA, 60 bp, Artificial Sequence
  Oligonucleotide
cagataaccctttgattgcttgatctctcggtaaatatggcatcatctgcacggaggatc

SEQ ID NO: 1292 - DNA, 60 bp, Artificial Sequence
  Oligonucleotide
cagatgaacctgtagcagagtggaacttgtactaacttatgatagaatgtatcagaataa

SEQ ID NO: 1293 - DNA, 60 bp, Artificial Sequence
  Oligonucleotide
cagcaggtcctgagtgaagccgtgggccctccaaatgctcgttttatagcaacctctctc

SEQ ID NO: 1294 - DNA, 60 bp, Artificial Sequence
  Oligonucleotide
cagccatagtcaatcccacggtgttcttcaacattgccatcaatggtgagcccttgggct

SEQ ID NO: 1295 - DNA, 60 bp, Artificial Sequence
  Oligonucleotide
cagcgcaagattgatcagaaagctgtggactcacaaattttaccaaaaatcaaagctatt

SEQ ID NO: 1296 - DNA, 60 bp, Artificial Sequence
  Oligonucleotide
cagctctcctgaaagcttctaccagaaaagcacctgctgctaaagtcccagcaaaaaaga

SEQ ID NO: 1297 - DNA, 60 bp, Artificial Sequence
  Oligonucleotide
caggtgcaacaggttcaggtgtttgctgacgtccagtgtacagtgaatctggtaggcggg

SEQ ID NO: 1298 - DNA, 60 bp, Artificial Sequence
  Oligonucleotide
cagtatcagggatctactgtctttgttcaaaggtcaaataaaaacctagtctccttttat

SEQ ID NO: 1299 - DNA, 60 bp, Artificial Sequence
  Oligonucleotide
cagttgagtgatagagttaaccccttatctgtaagttttgaatttacattgtttaatccc

SEQ ID NO: 1300 - DNA, 60 bp, Artificial Sequence
  Oligonucleotide
catagaagccatgtccaagctaaagccttactttcttactgatggaacgggaacagtcac

SEQ ID NO: 1301 - DNA, 60 bp, Artificial Sequence
  Oligonucleotide
catgctggcctacttcatcacctgggtctcctttgtgcccctcctggccaatgtgcaggt

SEQ ID NO: 1302 - DNA, 60 bp, Artificial Sequence
  Oligonucleotide
cattactcgacagatgtggcaccgatctttagccagagaactctctggaaccatcaaaga

SEQ ID NO: 1303 - DNA, 60 bp, Artificial Sequence
  Oligonucleotide
cattaggaagtgacttaacaacattaggcctcaatctgaactctcctgaaaatctctacc

SEQ ID NO: 1304 - DNA, 60 bp, Artificial Sequence
  Oligonucleotide
cattcgtgttctgtgtataccaaatgattctgttatctaaagaagctttttgctgggaaa

SEQ ID NO: 1305 - DNA, 60 bp, Artificial Sequence
  Oligonucleotide
ccaaacccttgtcatttcccccagtgagctctgatttctagactgctttgaaaatgctgt

SEQ ID NO: 1306 - DNA, 60 bp, Artificial Sequence
  Oligonucleotide
ccagagcacagaagacaaatgtatattcaagatagactggactctgtcaccaggagagca

SEQ ID NO: 1307 - DNA, 60 bp, Artificial Sequence
  Oligonucleotide
ccagtctgtgggctgcaatgttgatggccgccaccctcatgacatcatagatgacatcaa

SEQ ID NO: 1308 - DNA, 60 bp, Artificial Sequence
  Oligonucleotide
ccatctctgtctagcaagcagcctcctaagatagctgttctccctatcatgacggtgtag

SEQ ID NO: 1309 - DNA, 60 bp, Artificial Sequence
  Oligonucleotide
ccatgaccacctgcagccgccagttcacctcctccagctccatgaagggctcctgcggca

SEQ ID NO: 1310 - DNA, 60 bp, Artificial Sequence
  Oligonucleotide
cccaagccctcccctcactggaattcttcttgctctgtgagctagcctcatcttcagttg

SEQ ID NO: 1311 - DNA, 60 bp, Artificial Sequence
  Oligonucleotide
cccactccgtctacagcctcctgtctgtgtttagccagcgcttttactgcggttcctcct

SEQ ID NO: 1312 - DNA, 60 bp, Artificial Sequence
  Oligonucleotide
cccatcccactccctgtttcgggcctcgtctgctgggaaagtcacttttccagtatgtct

SEQ ID NO: 1313 - DNA, 60 bp, Artificial Sequence
  Oligonucleotide
cccctcaataagtatttgcagcagaacagacatgtcaaggataagaacatcatagaactg

SEQ ID NO: 1314 - DNA, 60 bp, Artificial Sequence
  Oligonucleotide
cccctgcatttgtcctgggaaacacggtatttaagagagaactatattggtattaaagct

SEQ ID NO: 1315 - DNA, 60 bp, Artificial Sequence
  Oligonucleotide
ccctacgcgccttgtctcctactcctgactcctacctgccctggaacatcctttgcaggg

SEQ ID NO: 1316 - DNA, 60 bp, Artificial Sequence
  Oligonucleotide
ccctgccgccgccgagtcgcgcggaggcggaggcttgggtgcgttcaagattcagcttca

SEQ ID NO: 1317 - DNA, 60 bp, Artificial Sequence
  Oligonucleotide
ccgcacttcagagttgagtcattttctgaggatgaatggaatttactgtatgttgcagta

SEQ ID NO: 1318 - DNA, 60 bp, Artificial Sequence
  Oligonucleotide
cctcagcttttgcacacctccaatatattgtccactgaagtcagaataatctaaaaataa

SEQ ID NO: 1319 - DNA, 60 bp, Artificial Sequence
  Oligonucleotide
cctggccaacatccgctcacctgtcttcaaccattccctgtaccgcacattcgttccagc

SEQ ID NO: 1320 - DNA, 60 bp, Artificial Sequence
  Oligonucleotide
ccttacacgtacctctcatcagtgtcctcttgctcaaaaatctgtttgatccctgttacc

SEQ ID NO: 1321 - DNA, 60 bp, Artificial Sequence
  Oligonucleotide
ccttgaatgagctatattcagggtatccggtattttgtaatagggaataggaaaccttgt

SEQ ID NO: 1322 - DNA, 60 bp, Artificial Sequence
  Oligonucleotide
ccttttcaggatttaggcctgtaagaaactatgcctgattctgtaaaataagtgtaaaga

SEQ ID NO: 1323 - DNA, 60 bp, Artificial Sequence
  Oligonucleotide
cgatatgacctgccagcatcatacaagtttcacaaaaagaaatcagtctgatcatctaaa

SEQ ID NO: 1324 - DNA, 60 bp, Artificial Sequence
  Oligonucleotide
cgccgaaggcgaccggtcgtccacaccgagcgacatcaactcccctcgacaccggacaca

SEQ ID NO: 1325 - DNA, 60 bp, Artificial Sequence
  Oligonucleotide
cgggacattggcgttcccatgaccagtgtgcggctgccctgctattttgagaacctcctc

SEQ ID NO: 1326 - DNA, 60 bp, Artificial Sequence
  Oligonucleotide
ctaaagcccagatgcccaccatagaacgagcaaccttgacaagagatttctacctctttc

SEQ ID NO: 1327 - DNA, 60 bp, Artificial Sequence
  Oligonucleotide
ctaatgtctgttagctacccataagaatgctgtttgctgcagttctgtgtcctgtgcttg

SEQ ID NO: 1328 - DNA, 60 bp, Artificial Sequence
  Oligonucleotide
ctacagcggcttcgaggtgctctttgcctgcactggtatcgccttgggctatggcgtgtg

SEQ ID NO: 1329 - DNA, 60 bp, Artificial Sequence
  Oligonucleotide
ctatgggcgtgaacggaatgggagggttgtctagcatgtccagtatgagtggtggatggg

SEQ ID NO: 1330 - DNA, 60 bp, Artificial Sequence
  Oligonucleotide
ctattttcaacataactgaaggcatatgctggcccataaacaccctgtaggttcttgata

SEQ ID NO: 1331 - DNA, 60 bp, Artificial Sequence
  Oligonucleotide
ctcaaggcagctaagcgagagcttcaagagcaaagagtttgtgtctagtgatgagagctc

SEQ ID NO: 1332 - DNA, 60 bp, Artificial Sequence
  Oligonucleotide
ctccatcacctttgggcttgttttctactttgccacagattatcttgtacagccttttat

SEQ ID NO: 1333 - DNA, 60 bp, Artificial Sequence
  Oligonucleotide
ctctgagatgagactgtacaagaatattccacagatgtcctttgatgatacagaaaggga

SEQ ID NO: 1334 - DNA, 60 bp, Artificial Sequence
  Oligonucleotide
ctgcgctccgccgtcggctcgggctgaaaaagtttctccatggttcctttgtgtcgcccg

SEQ ID NO: 1335 - DNA, 60 bp, Artificial Sequence
  Oligonucleotide
ctgctttactaaaatgcagtagaggtactcttctgtcccttccgtttatagttctctgag

SEQ ID NO: 1336 - DNA, 60 bp, Artificial Sequence
  Oligonucleotide
ctgtcggaagaccgtcaacggccacctggactcctatgagaaagtcacccagctgccggg

SEQ ID NO: 1337 - DNA, 60 bp, Artificial Sequence
  Oligonucleotide
ctgtcggtctcagtacgttcactttatagctgctggcaatatcgaaggttccttttttgt

SEQ ID NO: 1338 - DNA, 60 bp, Artificial Sequence
  Oligonucleotide
cttctacggtttctttgtctgcggaatcagggaagagtgaaaagggtcagccacagaatt

SEQ ID NO: 1339 - DNA, 60 bp, Artificial Sequence
  Oligonucleotide
ctttagtgagtacccctttagtgctatatttgtgccattcattatctggttcatatttct

SEQ ID NO: 1340 - DNA, 60 bp, Artificial Sequence
  Oligonucleotide
ctttgtaaccatgtatttactctgccaggtgcctatattccaataaaatgttcatccttg

SEQ ID NO: 1341 - DNA, 60 bp, Artificial Sequence
  Oligonucleotide
cttttagtgaccacgggctacatcatatgctttgttccttaccacattgtccgaatcccg

SEQ ID NO: 1342 - DNA, 60 bp, Artificial Sequence
  Oligonucleotide
gaacggattacaattctgctccccaagaggccccctaagaccacagaagataaggaggaa

SEQ ID NO: 1343 - DNA, 60 bp, Artificial Sequence
  Oligonucleotide
gaaggctctccatcgaaggcaacattgctgtgggaaagtccacgtttgtgaagttactca

SEQ ID NO: 1344 - DNA, 60 bp, Artificial Sequence
  Oligonucleotide
gaagtgtgtggctgggcggattcagcgaagtctcatgggaagcaggacctagagccgggc

SEQ ID NO: 1345 - DNA, 60 bp, Artificial Sequence
  Oligonucleotide
gaatgaaacctatagcctttgtgctgttctgccttgcctgtgagctatgtcactcccctc

SEQ ID NO: 1346 - DNA, 60 bp, Artificial Sequence
  Oligonucleotide
gaccagcggcccaccaagagctggctcaagaagtttctgggcttcgttgtggaccccaac

SEQ ID NO: 1347 - DNA, 60 bp, Artificial Sequence
  Oligonucleotide
gaccttaattctctttcccatcttgcaagatggcgggtgaaaaagttgagaagccagata

SEQ ID NO: 1348 - DNA, 60 bp, Artificial Sequence
  Oligonucleotide
gactgtggacttcatgattgttgtacttctgggtcaaaactcaaatgaggtgaattttgc

SEQ ID NO: 1349 - DNA, 60 bp, Artificial Sequence
  Oligonucleotide
gagattgctggctattaaaagatgcaagcattttgaactgggaggagataagaagagaaa

SEQ ID NO: 1350 - DNA, 60 bp, Artificial Sequence
  Oligonucleotide
gagcaacctgcgagactcacaagatgggaagctgacagagatacctacagacagagtgct

SEQ ID NO: 1351 - DNA, 60 bp, Artificial Sequence
  Oligonucleotide
gagccgctcatagaccccgcctgccgtccggtcaataaaatccgcctgactcctgcgccc

SEQ ID NO: 1352 - DNA, 60 bp, Artificial Sequence
  Oligonucleotide
gaggacgtgagccagtttgatacccgcttcacacggcagacgccggtggacagtcctgat

SEQ ID NO: 1353 - DNA, 60 bp, Artificial Sequence
  Oligonucleotide
gagggcctgatctgcatctgcagcatgaggttctgcccgtttgctgagaggacgcatctg

SEQ ID NO: 1354 - DNA, 60 bp, Artificial Sequence
  Oligonucleotide
gagtgtgctcccccgtcatgcaacatctggacacaactaacagagcatggtgaatacatg

SEQ ID NO: 1355 - DNA, 60 bp, Artificial Sequence
  Oligonucleotide
gatcctaggttcttcctgactgctttctccaactgttcacagcaaatgcttggattttat

SEQ ID NO: 1356 - DNA, 60 bp, Artificial Sequence
  Oligonucleotide
gattgacctggccaagctgaagaagtttattgcctactgccgagtgaagtgtggcccccg

SEQ ID NO: 1357 - DNA, 60 bp, Artificial Sequence
  Oligonucleotide
gattgctcctgtgtaaagatgccttgtcgtgcagaaacaaatggctgtccagtttattaa

SEQ ID NO: 1358 - DNA, 60 bp, Artificial Sequence
  Oligonucleotide
gcaagtcccaactttgaataaaacagatgatgtcctgtgactgccccacagagataaggg

SEQ ID NO: 1359 - DNA, 60 bp, Artificial Sequence
  Oligonucleotide
gcaccagtgacatttaaaggcttccgcgagtgaatgagtgcttcttaatcctaaaaacac

SEQ ID NO: 1360 - DNA, 60 bp, Artificial Sequence
  Oligonucleotide
gcactggaataggaaatgtcccccatctcccttcctgcaccctgctgtgctccctccaaa

SEQ ID NO: 1361 - DNA, 60 bp, Artificial Sequence
  Oligonucleotide
gcagccctggttcaggcccggaggagggtttgcgggtagttgcacggacaattcggcggg

SEQ ID NO: 1362 - DNA, 60 bp, Artificial Sequence
  Oligonucleotide
gccactgcctcccccgaatgcatttggaaccaaagtctaaactgagctcgcagcccccgc

SEQ ID NO: 1363 - DNA, 60 bp, Artificial Sequence
  Oligonucleotide
gccatcctacgccgtagccgtccagagactggcaggcctcggcctaaaggtctggagggt

SEQ ID NO: 1364 - DNA, 60 bp, Artificial Sequence
  Oligonucleotide
gccatgctcttcaggaggagactccaagggcaaaggagggtgtcttggctgtgcttgaag

SEQ ID NO: 1365 - DNA, 60 bp, Artificial Sequence
  Oligonucleotide
gcccgcccgagctgctcgacgtgatgaagccccaggagtcgggaagcagtgccaatgaac

SEQ ID NO: 1366 - DNA, 60 bp, Artificial Sequence
  Oligonucleotide
gcctcaagaggtggtggaagagttgaagaagtacctgtcgtagggagatttgggtagaag

SEQ ID NO: 1367 - DNA, 60 bp, Artificial Sequence
  Oligonucleotide
gcctccctgtttgaagcctgcccttgtctgagatgctggtaatggccatggtaccccctt

SEQ ID NO: 1368 - DNA, 60 bp, Artificial Sequence
  Oligonucleotide
gcctgcccactgcaacggagccgccagcacctcctcccctccagatccgggccccaggct

SEQ ID NO: 1369 - DNA, 60 bp, Artificial Sequence
  Oligonucleotide
gcgaactgggttgcttccctgagggcccccgctggccaaggcctgtggacgacgcttgcg

SEQ ID NO: 1370 - DNA, 60 bp, Artificial Sequence
  Oligonucleotide
gcttataagttaaagggcatcacagtgagggtgtagtagataaattcaaggaaataagag

SEQ ID NO: 1371 - DNA, 60 bp, Artificial Sequence
  Oligonucleotide
ggaagaaggagaggaatactaattatccattccttttggccctgcagcatgtcatgctcc

SEQ ID NO: 1372 - DNA, 60 bp, Artificial Sequence
  Oligonucleotide
ggaagctttgtgaagctcaacaaggcttccactaacatgctgaggattgtagaaccatat

SEQ ID NO: 1373 - DNA, 60 bp, Artificial Sequence
  Oligonucleotide
ggacgtgatagctctgcctattgcaggacaatgatggctattctaaacgctaaggaaaaa

SEQ ID NO: 1374 - DNA, 60 bp, Artificial Sequence
  Oligonucleotide
ggactatgcggaggccctgatcaaccccattaagcacgtcagcctgatggaccagagggc

SEQ ID NO: 1375 - DNA, 60 bp, Artificial Sequence
  Oligonucleotide
ggccaccagctgtttcccacgccccatgactccccgagaccgacatgaagggcgcaaaca

SEQ ID NO: 1376 - DNA, 60 bp, Artificial Sequence
  Oligonucleotide
ggccagaaggcagcgcctgctccaaaagttcagaggactcaaaaactccagctcctaaaa

SEQ ID NO: 1377 - DNA, 60 bp, Artificial Sequence
  Oligonucleotide
ggctcatttgctctctccactactcatctctggaattagccgcttaaatacaggtttttg

SEQ ID NO: 1378 - DNA, 60 bp, Artificial Sequence
  Oligonucleotide
ggctccaaggagacagcaactcagcccttgcctctgtatgacacaccctatgagccagag

SEQ ID NO: 1379 - DNA, 60 bp, Artificial Sequence
  Oligonucleotide
gggaagaagggacaacagcggactgtctaaaggatgcctggattccttgtttctcaggac

SEQ ID NO: 1380 - DNA, 60 bp, Artificial Sequence
  Oligonucleotide
gggacaaaatgagaagtcatcactctttttggatcatttagatctcttgcatcctttgtt

SEQ ID NO: 1381 - DNA, 60 bp, Artificial Sequence
  Oligonucleotide
gggccctctccattgtggccgatgactgaatccccgtcactcttggaggactcctgtgac

SEQ ID NO: 1382 - DNA, 60 bp, Artificial Sequence
  Oligonucleotide
gggtgagaagaataaccacaattgtatgtgcctgttttttactcttagcattagatgaat

SEQ ID NO: 1383 - DNA, 60 bp, Artificial Sequence
  Oligonucleotide
ggtcttgtaattacaggagccatttctgtaggtaactggaccaagaatgagaaaaataat

SEQ ID NO: 1384 - DNA, 60 bp, Artificial Sequence
  Oligonucleotide
ggtgacagaagacacagatgaagatgctccccttgtgccagatgatacctcagactctgg

SEQ ID NO: 1385 - DNA, 60 bp, Artificial Sequence
  Oligonucleotide
ggtgatctgcttttatctaaatgcaaataaggatgtgttctctgagacccatgatcaggg

SEQ ID NO: 1386 - DNA, 60 bp, Artificial Sequence
  Oligonucleotide
ggtgctggtggcctttccccggtggattggtctctggcccagcccagtctcttctcaggg

SEQ ID NO: 1387 - DNA, 60 bp, Artificial Sequence
  Oligonucleotide
ggttcagatcgatggccttgtccatgttgtcctttctggcttccctgatggtgtcatgtt

SEQ ID NO: 1388 - DNA, 60 bp, Artificial Sequence
  Oligonucleotide
ggttgaagtctgtggatgcaactgttaatgaagatggttaaacttgaaataaacaatttt

SEQ ID NO: 1389 - DNA, 60 bp, Artificial Sequence
  Oligonucleotide
gtaccacaagaagatcttccggactgccatgctgttccagtttgtgaacgtgctgctcca

SEQ ID NO: 1390 - DNA, 60 bp, Artificial Sequence
  Oligonucleotide
gtcatcttgcttacctacgtgctggccgccacagaacttacctgcctcttcatgcagttc

SEQ ID NO: 1391 - DNA, 60 bp, Artificial Sequence
  Oligonucleotide
gtctgaaacccctggtagccccgacttctttttaattaaaataaggtaagcccttcaatt

SEQ ID NO: 1392 - DNA, 60 bp, Artificial Sequence
  Oligonucleotide
gtgatccctcgggatgaccccctcgtgctctatgtctatgctgcccctcaggacatgagg

SEQ ID NO: 1393 - DNA, 60 bp, Artificial Sequence
  Oligonucleotide
gtggcaaggcctttaagcgctcctctatccttactacacataagagaattcatactggag

SEQ ID NO: 1394 - DNA, 60 bp, Artificial Sequence
  Oligonucleotide
gtggccctgggataccggaaagtgcaacaggtgatcgagaaccacatcctcaagctcttc

SEQ ID NO: 1395 - DNA, 60 bp, Artificial Sequence
  Oligonucleotide
gttaaataccacattatttgaaagctgggagatcgttggaccttacccttcctggtgggt

SEQ ID NO: 1396 - DNA, 60 bp, Artificial Sequence
  Oligonucleotide
gttatagaaatcagcatactatttttttaaatctggagagaagatattctggtgactgaa

SEQ ID NO: 1397 - DNA, 60 bp, Artificial Sequence
  Oligonucleotide
gttcagggccagggcctccttggaataaatggttattgttactaggtccccaccttccct

SEQ ID NO: 1398 - DNA, 60 bp, Artificial Sequence
  Oligonucleotide
gttctccttgggtgacccccatgatgcctgaccgctcctcgtgcctcctggaacagccag

SEQ ID NO: 1399 - DNA, 60 bp, Artificial Sequence
  Oligonucleotide
gtttactttgaaaaagtgaaaaaggcttccgggctgtcctctgcccagtgagatggagga

SEQ ID NO: 1400 - DNA, 60 bp, Artificial Sequence
  Oligonucleotide
tacaaagaagacagtgctaaggcttgagcgcgttgagcccaactgcatatctaagagaat

SEQ ID NO: 1401 - DNA, 60 bp, Artificial Sequence
  Oligonucleotide
taccatgggaccagctctggccagagggaactaagcaaatccaatagagatgtttctggg

SEQ ID NO: 1402 - DNA, 60 bp, Artificial Sequence
  Oligonucleotide
tacctgatgtatgccaagttcctttgttcagtattccgtgggtgaacgggtggaggaagg

SEQ ID NO: 1403 - DNA, 60 bp, Artificial Sequence
  Oligonucleotide
tagaagatgaggaagatataacacttacaagatggacagggatgataattgggcctacaa

SEQ ID NO: 1404 - DNA, 60 bp, Artificial Sequence
  Oligonucleotide
tagaattgagaatctggaactaatgtcacagcatggatgtaatgcctggaaagtatacaa

SEQ ID NO: 1405 - DNA, 60 bp, Artificial Sequence
  Oligonucleotide
tagtagtagtactgagaaaaatcccttcagctctaagaacactgaaaaatccaccgattt

SEQ ID NO: 1406 - DNA, 60 bp, Artificial Sequence
  Oligonucleotide
tatcatctcagtgaacctactggtggactcccaattgacaagattgagcaatagaaaaaa

SEQ ID NO: 1407 - DNA, 60 bp, Artificial Sequence
  Oligonucleotide
tatggtgggcaaaccaagctgattttccagaaaaaggctaaagctacaaagaagattgtc

SEQ ID NO: 1408 - DNA, 60 bp, Artificial Sequence
  Oligonucleotide
tcaaaaggctatgtctgctcttcagtaatgacatgaaatctttgttcatctccactttgt

SEQ ID NO: 1409 - DNA, 60 bp, Artificial Sequence
  Oligonucleotide
tcaaatcactatctgaagggtcacggagcgcaaaataaagtttaaaaccctgctaccaca

SEQ ID NO: 1410 - DNA, 60 bp, Artificial Sequence
  Oligonucleotide
tcactgaatacagcacagacaaggacgagcctccaaaggacgtctttgatgaattattta

SEQ ID NO: 1411 - DNA, 60 bp, Artificial Sequence
  Oligonucleotide
tcagcctgtccaataatggagccctgtccttctacacaaggcagcctaaactacccacca

SEQ ID NO: 1412 - DNA, 60 bp, Artificial Sequence
  Oligonucleotide
tcagggacgtcaatgtgtctgcctagccctgttggcgggctgaccctcgacctcccagac

SEQ ID NO: 1413 - DNA, 60 bp, Artificial Sequence
  Oligonucleotide
tcccactgtctcccccagatatgtccttcccagcatctttggctgcacagcatttccttc

SEQ ID NO: 1414 - DNA, 60 bp, Artificial Sequence
  Oligonucleotide
tccccatcctgcatctggacggtattgtggaggactcctccaacatcctgggcttctcca

SEQ ID NO: 1415 - DNA, 60 bp, Artificial Sequence
  Oligonucleotide
tcctagcagatgatacagcagtgggctacatacaatgagagccctgagccctcaagaact

SEQ ID NO: 1416 - DNA, 60 bp, Artificial Sequence
  Oligonucleotide
tcctgtagtgctgtctctgctttttgcatcttgcccagtatattatgacacaaataaaaa

SEQ ID NO: 1417 - DNA, 60 bp, Artificial Sequence
  Oligonucleotide
tcgaagcagtcaacctcccggtcgaccatatctccttgatcctggctgtggactggctag

SEQ ID NO: 1418 - DNA, 60 bp, Artificial Sequence
  Oligonucleotide
tcgacaaataccacccaggctactttgggaaagttggtatgaagcattaccacttaaaga

SEQ ID NO: 1419 - DNA, 60 bp, Artificial Sequence
  Oligonucleotide
tctaacagacaaaattgatgtacttctgcaacagattgaagaattagggtctgaaggaaa

SEQ ID NO: 1420 - DNA, 60 bp, Artificial Sequence
  Oligonucleotide
tctgctgctgcggaagggacccctcggaggagcattcgctgctggtgaattgattcgacc

SEQ ID NO: 1421 - DNA, 60 bp, Artificial Sequence
  Oligonucleotide
tcttgcttgaccgtttgggacatcaatcttccacatgaagtgcaaaatttagaaaaacac

SEQ ID NO: 1422 - DNA, 60 bp, Artificial Sequence
  Oligonucleotide
tctttggtgctgcagcggcacacaactggcaaggcttaatcaaaagactggaaaactgca

SEQ ID NO: 1423 - DNA, 60 bp, Artificial Sequence
  Oligonucleotide
tgaaaaaactactaggatcacgcggcatgtattgagcatataggttgctgtagatgaatg

SEQ ID NO: 1424 - DNA, 60 bp, Artificial Sequence
  Oligonucleotide
tgaactttcagccaagaaggtagtgtgaaaatattactgtgaggttttaaaagtacacaa

SEQ ID NO: 1425 - DNA, 60 bp, Artificial Sequence
  Oligonucleotide
tgacaggaacttccgcacctcctgaggccctggatgattctaattgttagaaattctaat

SEQ ID NO: 1426 - DNA, 60 bp, Artificial Sequence
  Oligonucleotide
tgacgcagtataagaagggcaaggattccttgtatgcccagggaaagaggcgctatgatc

SEQ ID NO: 1427 - DNA, 60 bp, Artificial Sequence
  Oligonucleotide
tgagggacatggcaagttcctggccactgcccagaaccctgctgatgagcccactctagg

SEQ ID NO: 1428 - DNA, 60 bp, Artificial Sequence
  Oligonucleotide
tgatatcagccatcgtcaaccccgccgtgttcttcgacatcgccgtggatggcgggccct

SEQ ID NO: 1429 - DNA, 60 bp, Artificial Sequence
  Oligonucleotide
tgcaagccgccggcacccgcctgctgcgacccgtgcgcctcctgccagtgccgcttcttc

SEQ ID NO: 1430 - DNA, 60 bp, Artificial Sequence
  Oligonucleotide
tgcccttgagtcccctgtgccctagcaaccggaggaatggaaaggacctcatcagggtgg

SEQ ID NO: 1431 - DNA, 60 bp, Artificial Sequence
  Oligonucleotide
tgccgtcaacatgcctttcatggacttcctgactgaggatggcttcgagaagggcccaga

SEQ ID NO: 1432 - DNA, 60 bp, Artificial Sequence
  Oligonucleotide
tggacaagaaggagcctgaagtcttgcgggactcactggatagatgttattcaactcctt

SEQ ID NO: 1433 - DNA, 60 bp, Artificial Sequence
  Oligonucleotide
tggcatggctgccttgatgtaacataattctctgtccccaagatttagaaaattcctctt

SEQ ID NO: 1434 - DNA, 60 bp, Artificial Sequence
  Oligonucleotide
tggctgggcaacctacgtcgcctttggacctcatgctggaaaattcattgtgatcataga

SEQ ID NO: 1435 - DNA, 60 bp, Artificial Sequence
  Oligonucleotide
tgggaatcacgaattttcctattcctggagagcctcattttccacttaacgcaattatgc

SEQ ID NO: 1436 - DNA, 60 bp, Artificial Sequence
  Oligonucleotide
tgggctctaggagaccccaaatttgacaccacagaaagcaaataaaacacttgaaatacg

SEQ ID NO: 1437 - DNA, 60 bp, Artificial Sequence
  Oligonucleotide
tgggtgccactgcctgcttgaaagcactttctgaacctacagaagttgggtattgtctga

SEQ ID NO: 1438 - DNA, 60 bp, Artificial Sequence
  Oligonucleotide
tggtctgatgctccttcaaaaacattcactttttacaacgtcaaggaattaagcataaaa

SEQ ID NO: 1439 - DNA, 60 bp, Artificial Sequence
  Oligonucleotide
tgtatgtctactggtgggagactgtgaggatcccaggattcagtattcctggcccagagg

SEQ ID NO: 1440 - DNA, 60 bp, Artificial Sequence
  Oligonucleotide
tgtccctgttttataaacataatcacaacagtaataaacctcaagtagtggctagtgttt

SEQ ID NO: 1441 - DNA, 60 bp, Artificial Sequence
  Oligonucleotide
tgtcctacgagcagctggagcagccgatgcagctgtacagtgcgcgccagcggcggcggc

SEQ ID NO: 1442 - DNA, 60 bp, Artificial Sequence
  Oligonucleotide
tgtcggactatgtaattgtaactatacctctggttcccattaaaagtgaccattttagtt

SEQ ID NO: 1443 - DNA, 60 bp, Artificial Sequence
  Oligonucleotide
tgtgccagaaacccttaagaaaaagcaaaggaatttcacagagctgaagatcaagctcct

SEQ ID NO: 1444 - DNA, 60 bp, Artificial Sequence
  Oligonucleotide
ttatcagaattccgagaaggagtgcggaagattgcccgagagcaaaaagtccctgagatt

SEQ ID NO: 1445 - DNA, 60 bp, Artificial Sequence
  Oligonucleotide
ttcaacactgccaatgatgataacgttactcaggtgcgggcattctatgtgaacgtgctg

SEQ ID NO: 1446 - DNA, 60 bp, Artificial Sequence
  Oligonucleotide
ttcaactctggccctcacaatccagtggaggagacgaaactcatctgcctctgtccctct

SEQ ID NO: 1447 - DNA, 60 bp, Artificial Sequence
  Oligonucleotide
ttcaagggatagaaagtcacagtaaggatggcaatgccagtggaaccaagctgcttgagg

SEQ ID NO: 1448 - DNA, 60 bp, Artificial Sequence
  Oligonucleotide
ttcagccaagttcagggaggtctgaatactgaggccttcatagccactgcaccccaggta

SEQ ID NO: 1449 - DNA, 60 bp, Artificial Sequence
  Oligonucleotide
ttcagtgttgatcctttattctttctatctgtcaggtgcacaagattaccctcctttttt

SEQ ID NO: 1450 - DNA, 60 bp, Artificial Sequence
  Oligonucleotide
ttcgctttatttttgtaagtatcacctgccaccatgttttgtaatttgaggtcttgattt

SEQ ID NO: 1451 - DNA, 60 bp, Artificial Sequence
  Oligonucleotide
ttgaaagttatgttttagggtcctctgaaaagcaaattgtgtcagaagataaagagcttt

SEQ ID NO: 1452 - DNA, 60 bp, Artificial Sequence
  Oligonucleotide
ttggacctagttggtgattatactctgtctcccatggagaccacgtcttgcatccttcct

SEQ ID NO: 1453 - DNA, 60 bp, Artificial Sequence
  Oligonucleotide
ttgtgaccattagcatttgtcaacaaagtcacccacttcccactattgcttgcacaaacc

SEQ ID NO: 1454 - DNA, 60 bp, Artificial Sequence
  Oligonucleotide
tttagcgtctttgaaggagaccagacatgagtgaatacctaggagagtgtcagcatgttt

SEQ ID NO: 1455 - DNA, 60 bp, Artificial Sequence
  Oligonucleotide
tttcaggaccctagaggagagctttatacaattaccgatgtgaatttctctaaagtgtat

SEQ ID NO: 1456 - DNA, 60 bp, Artificial Sequence
  Oligonucleotide
tttccggagcacttgcagaggacttgctatttgccaggtgctttatgtatcattaaattt

SEQ ID NO: 1457 - DNA, 60 bp, Artificial Sequence
  Oligonucleotide
tttctccatccaattctttgaatttcccagtctcccctatgtaaaacttagcaacttggg

SEQ ID NO: 1458 - DNA, 60 bp, Artificial Sequence
  Oligonucleotide
tttctgctgtttgatctctaaggaactcctgttgctaaatatgaagagtatggaacattc

SEQ ID NO: 1459 - DNA, 60 bp, Artificial Sequence
  Oligonucleotide
tttgggagaaatggatctgactgcccggacaagttttgcttattccagtctgaaaccaaa

SEQ ID NO: 1460 - DNA, 60 bp, Artificial Sequence
  Oligonucleotide
ttttcccaggtactgccttacaaagctgtggccaggaagtggccggtataaaggatgccc

SEQ ID NO: 1461 - DNA, 60 bp, Artificial Sequence
  Oligonucleotide
aaccaagtagctgcagctctctaccaagccctccaccggaccctgtgggcggcggctgtg

SEQ ID NO: 1462 - DNA, 60 bp, Artificial Sequence
  Oligonucleotide
aatttgagcctctgctgaattggatgaaagataaagcccttaaggacaagattgaaaagg

SEQ ID NO: 1463 - DNA, 60 bp, Artificial Sequence
  Oligonucleotide
agaaagtggcccgggtgaaggcgctatatgaggagctggatctgccagcagtgttcttgc

SEQ ID NO: 1464 - DNA, 60 bp, Artificial Sequence
  Oligonucleotide
agaagcttcctgaaatggacattgattgattccaacacttgtttctattaaaacagacta

SEQ ID NO: 1465 - DNA, 60 bp, Artificial Sequence
  Oligonucleotide
agacgccaggaaggtgagatcttcgacacagaaaaagagaaatatgagattacggagcag

SEQ ID NO: 1466 - DNA, 60 bp, Artificial Sequence
  Oligonucleotide
agctgcccgagcgcctgctgcagccgctccactttctccacataggcctgttcttgcttt

SEQ ID NO: 1467 - DNA, 60 bp, Artificial Sequence
  Oligonucleotide
cagagggagtgtgcgaatctaccctgaccaatgggctcaagaataaagtatgatttttga

SEQ ID NO: 1468 - DNA, 60 bp, Artificial Sequence
  Oligonucleotide
ccccaccattctacagagttgtactcaagacagatactgaaaaaatctaataccttccct

SEQ ID NO: 1469 - DNA, 60 bp, Artificial Sequence
  Oligonucleotide
ccctgttcctgccctgaaacaatttcaatcactgacaaatcattatcattcattaataat

SEQ ID NO: 1470 - DNA, 60 bp, Artificial Sequence
  Oligonucleotide
cgctaagcgcctatgccactcgcctgatgaatttgggaggtcataaaagcctcacatggg

SEQ ID NO: 1471 - DNA, 60 bp, Artificial Sequence
  Oligonucleotide
gaataacaggctggttggaaatctggaacagagtatcctgagaatctgcccaccttgaag

SEQ ID NO: 1472 - DNA, 60 bp, Artificial Sequence
  Oligonucleotide
gcccagccagttaagcacaaaggaaaacatttcaataaaggatcatttgacaactggtga

SEQ ID NO: 1473 - DNA, 60 bp, Artificial Sequence
  Oligonucleotide
gtgttcctcctccctctattactgtttcaccagagctgtcttagctcaaatctgttgtgt

SEQ ID NO: 1474 - DNA, 60 bp, Artificial Sequence
  Oligonucleotide
tgcttctgattcctacatcgttttcaccactgaaatagttttctactgaaatacaaaaca

SEQ ID NO: 1475 - DNA, 60 bp, Artificial Sequence
  Oligonucleotide
aagagctctgtgtcttcttagtggctgtatcttggattctgtcttgtgccagctccctct

SEQ ID NO: 1476 - DNA, 60 bp, Artificial Sequence
  Oligonucleotide
acaaactacaatcatcttcctgaggcagattcccactaggactgcattcaacttagagcc

SEQ ID NO: 1477 - DNA, 60 bp, Artificial Sequence
  Oligonucleotide
attaatacgccagtcatcataaaagatggtcattatagtacccccattgctcctgcttgt

SEQ ID NO: 1478 - DNA, 60 bp, Artificial Sequence
  Oligonucleotide
cagccacctgtcaagaggaggcggagcgtcatgcctctggaagactggatgaatattctc

SEQ ID NO: 1479 - DNA, 60 bp, Artificial Sequence
  Oligonucleotide
ccctgttcccactctaccactggaggaaatgaggacacaatctggtatcaacagtttgat

SEQ ID NO: 1480 - DNA, 60 bp, Artificial Sequence
  Oligonucleotide
cctgcgggtgacccggcctctggtgccagagcctgccatccttcctgtttgtgctgccag

SEQ ID NO: 1481 - DNA, 60 bp, Artificial Sequence
  Oligonucleotide
ctcaccctcctcagactctgcggcggagagccgagtgatgaataaatgagtaaccacatc

SEQ ID NO: 1482 - DNA, 60 bp, Artificial Sequence
  Oligonucleotide
gggaccaccctcatttcccagcttcctcgaagggcagacactccccacagctctgctgcc

SEQ ID NO: 1483 - DNA, 60 bp, Artificial Sequence
  Oligonucleotide
gtttcttggctacacagatgggtctgtcagggttgaagccacatgggtgcctgctcatgt

SEQ ID NO: 1484 - DNA, 60 bp, Artificial Sequence
  Oligonucleotide
tagcacactcatgaacctaattcccacatttgatagttgttacattttgccatgtttgtt

SEQ ID NO: 1485 - DNA, 60 bp, Artificial Sequence
  Oligonucleotide
tcattgggtttaggaaggatttctctaacactgagtaacatgaggatttagcagtagtgt

SEQ ID NO: 1486 - DNA, 60 bp, Artificial Sequence
  Oligonucleotide
ttgttcgttctgctctggagacccctgggttgcggcccctggacccctccacccctgctg

SEQ ID NO: 1487 - DNA, 60 bp, Artificial Sequence
  Oligonucleotide
tttagatttatcaggcttcttcacctcgcactgtccccatcctggccgcaggccccctcg

SEQ ID NO: 1488 - DNA, 60 bp, Artificial Sequence
  Oligonucleotide
tttgttcacacagtctctccagctcccgcaccctctgcgcctcctgctctcggatcatct

SEQ ID NO: 1489 - DNA, 60 bp, Artificial Sequence
  Oligonucleotide
aactgggaggagataagaagagaaagggccaagtgatccagttctaagtgtcatcttttg

SEQ ID NO: 1490 - DNA, 60 bp, Artificial Sequence
  Oligonucleotide
agatgcaggaataaagtaatcttatatacaagctttgattaaaacttgaaacaaagaaaa

SEQ ID NO: 1491 - DNA, 60 bp, Artificial Sequence
  Oligonucleotide
atggagaggagagatcgtgctgtgtgtcatgtctgttgttcaagtaaataaaagttgccc

SEQ ID NO: 1492 - DNA, 60 bp, Artificial Sequence
  Oligonucleotide
cctcctctccctcccactgcacactcccacttcctcagcgaccgggcccttctccacctc

SEQ ID NO: 1493 - DNA, 60 bp, Artificial Sequence
  Oligonucleotide
gaagaaccgagtgtgtccaccgatgtggcagctgcagcgggcttggctttgtgaggaacc

SEQ ID NO: 1494 - DNA, 60 bp, Artificial Sequence
  Oligonucleotide
ggccacagctgctctccaggcccactatgcacacatcttcccctccaaggtttgttctgc

SEQ ID NO: 1495 - DNA, 60 bp, Artificial Sequence
  Oligonucleotide
ttcaccccagcaagattcttgaatggaaagccaaatctcaccaagtaggaaaggaaacgg

SEQ ID NO: 1496 - DNA, 60 bp, Artificial Sequence
  Oligonucleotide
aataaaagctcgccttttgtctgtacatactggcctccgtgaatacatagatcagccatt

SEQ ID NO: 1497 - DNA, 60 bp, Artificial Sequence
  Oligonucleotide
agataagaagagaaagggccaaatgatccagttccaagtgccatcttttattatgaagac

SEQ ID NO: 1498 - DNA, 60 bp, Artificial Sequence
  Oligonucleotide
ttaagagatgcaagcattttgaactggaaggagataagagaaagggccaagtgatccagt

SEQ ID NO: 1499 - DNA, 60 bp, Artificial Sequence
  Oligonucleotide
ccaccacctccaccctggaagagttccccttccctttgaaatctcatgggactttgcccc

SEQ ID NO: 1500 - DNA, 60 bp, Artificial Sequence
  Oligonucleotide
aaaatagttcaaatgagtcctgtatcattgtatctcctattctggattagtgccttttgg

SEQ ID NO: 1501 - DNA, 60 bp, Artificial Sequence
  Oligonucleotide
aagtgaaacaaacaaaaagtgatgtctgccaacagccaccaccaagacaagcgtctgggt

SEQ ID NO: 1502 - DNA, 60 bp, Artificial Sequence
  Oligonucleotide
atgaagtgagaaattgttgagaaggatacagtttgtttttagatgtcctttgtccaatgt

SEQ ID NO: 1503 - DNA, 60 bp, Artificial Sequence
  Oligonucleotide
cctttatttcctttattacccgcatccttgtgtcaccaggtcctctcattacgacagcct

SEQ ID NO: 1504 - DNA, 60 bp, Artificial Sequence
  Oligonucleotide
gaaaacatggtaggactcacactggatagaaaccaaagcaggtgaatcacctgaggtcag

SEQ ID NO: 1505 - DNA, 60 bp, Artificial Sequence
  Oligonucleotide
gccgggcagaggtgctcctcacttgccacacagggcggcagcttggcagagtcgctcctc

SEQ ID NO: 1506 - DNA, 60 bp, Artificial Sequence
  Oligonucleotide
ggtggagacacagcggctccccgctaaccaccactctcctgcctggtgtagacaaagcgg

SEQ ID NO: 1507 - DNA, 60 bp, Artificial Sequence
  Oligonucleotide
tgttctcagcactgtacaacggtccctatataatacggagaagcaatatcactgtatgag

SEQ ID NO: 1508 - DNA, 60 bp, Artificial Sequence
  Oligonucleotide
aaaagatcgaaatggacgagcaggatatgagaagggcattatatcgtttcagacttacag

SEQ ID NO: 1509 - DNA, 60 bp, Artificial Sequence
  Oligonucleotide
caatgctctccatctcccttatgtggactcttgttcttgtctgatctcttgtcaaattgt

SEQ ID NO: 1510 - DNA, 60 bp, Artificial Sequence
  Oligonucleotide
gtcaggccagggtcctgtctgctctgtgagtccctccaattgttcttattccgagatttc

SEQ ID NO: 1511 - DNA, 60 bp, Artificial Sequence
  Oligonucleotide
gtctaccccctgcacgtgcagagcaaaaagagcttcctatgggagctgttctccagaaaa

SEQ ID NO: 1512 - DNA, 30 bp, Artificial Sequence
  Oligonucleotide
ctttgtcataccacatcttcccctttacca

SEQ ID NO: 1513 - DNA, 30 bp, Artificial Sequence
  Oligonucleotide
ctgctttacaagaggttctgaagactgccc

SEQ ID NO: 1514 - DNA, 30 bp, Artificial Sequence
  Oligonucleotide
ctctcctctcctccttgtctggctctgttg

SEQ ID NO: 1515 - DNA, 30 bp, Artificial Sequence
  Oligonucleotide
aaacaaaccacctgaccaagagggaagtga

SEQ ID NO: 1516 - DNA, 30 bp, Artificial Sequence
  Oligonucleotide
acctcgctcttataccatcgcagttgcttc

SEQ ID NO: 1517 - DNA, 30 bp, Artificial Sequence
  Oligonucleotide
gcatgaagggagcaccgtggagaagacagt

SEQ ID NO: 1518 - DNA, 30 bp, Artificial Sequence
  Oligonucleotide
tgtaatgtctagtggggcttcatcatcctg

SEQ ID NO: 1519 - DNA, 30 bp, Artificial Sequence
  Oligonucleotide
aacattccagaagatgactcaggtgtcccc

SEQ ID NO: 1520 - DNA, 30 bp, Artificial Sequence
  Oligonucleotide
gtccaccactccaactttgctttctgaagg

SEQ ID NO: 1521 - DNA, 30 bp, Artificial Sequence
  Oligonucleotide
actgtaggtggaagagcaagagtccctccc

SEQ ID NO: 1522 - DNA, 30 bp, Artificial Sequence
  Oligonucleotide
ggcacactccaccttccctagtcaccagct

SEQ ID NO: 1523 - DNA, 30 bp, Artificial Sequence
  Oligonucleotide
tgaagagccgaatacctgtggtgctcctgg

SEQ ID NO: 1524 - DNA, 30 bp, Artificial Sequence
  Oligonucleotide
ttccttgacgtgtctcagactgggtccctg

SEQ ID NO: 1525 - DNA, 30 bp, Artificial Sequence
  Oligonucleotide
ggtcactgaacaactaatcttggtccctga

SEQ ID NO: 1526 - DNA, 30 bp, Artificial Sequence
  Oligonucleotide
ccattctcttgcccttaggattcactgctc

SEQ ID NO: 1527 - DNA, 30 bp, Artificial Sequence
  Oligonucleotide
gttgtcagcaggagagagcattagtttgga

SEQ ID NO: 1528 - DNA, 30 bp, Artificial Sequence
  Oligonucleotide
gctcatcgtcctgtcagactagcggagttt

SEQ ID NO: 1529 - DNA, 30 bp, Artificial Sequence
  Oligonucleotide
ctacatcgaggaccttaagtgccgtgtgct

SEQ ID NO: 1530 - DNA, 30 bp, Artificial Sequence
  Oligonucleotide
tatcctccctggcagacacaacccaatagg

SEQ ID NO: 1531 - DNA, 30 bp, Artificial Sequence
  Oligonucleotide
ctctcccgaaactaaacttgagcctccatt

SEQ ID NO: 1532 - DNA, 30 bp, Artificial Sequence
  Oligonucleotide
gagcccagtgacattgtctatctcatccgc

SEQ ID NO: 1533 - DNA, 30 bp, Artificial Sequence
  Oligonucleotide
gagccccctcttccagacactatacttcca

SEQ ID NO: 1534 - DNA, 30 bp, Artificial Sequence
  Oligonucleotide
gggtcaccatcatgcctaaggacatccagc

SEQ ID NO: 1535 - DNA, 30 bp, Artificial Sequence
  Oligonucleotide
cattgaagacgtcattgcccagggtattgg

SEQ ID NO: 1536 - DNA, 30 bp, Artificial Sequence
  Oligonucleotide
tgaatgggttgttaaaggcaatggtttgtg

SEQ ID NO: 1537 - DNA, 30 bp, Artificial Sequence
  Oligonucleotide
ttgtgttgctgccagaatcagaatccagtt

SEQ ID NO: 1538 - DNA, 30 bp, Artificial Sequence
  Oligonucleotide
agaaagctcagctggtggtgactgcacacg

SEQ ID NO: 1539 - DNA, 30 bp, Artificial Sequence
  Oligonucleotide
cccctcctcggaacacaacagtagacctta

SEQ ID NO: 1540 - DNA, 30 bp, Artificial Sequence
  Oligonucleotide
aagaacttcggcatctggctgcgctacaaa

SEQ ID NO: 1541 - DNA, 30 bp, Artificial Sequence
  Oligonucleotide
tgaattgcaaagacctccataaaaccaccc

SEQ ID NO: 1542 - DNA, 30 bp, Artificial Sequence
  Oligonucleotide
atgtgtggtagactccctttgctggcttgt

SEQ ID NO: 1543 - DNA, 30 bp, Artificial Sequence
  Oligonucleotide
aggacagagggtggtcgtcgtggatgatct

SEQ ID NO: 1544 - DNA, 30 bp, Artificial Sequence
  Oligonucleotide
tggcaacatcaggaagttaccctctatgct

SEQ ID NO: 1545 - DNA, 30 bp, Artificial Sequence
  Oligonucleotide
ggtggagcagccaaaatgaagtacaatccc

SEQ ID NO: 1546 - DNA, 30 bp, Artificial Sequence
  Oligonucleotide
tgccatttgtttccttctgatctctcactg

SEQ ID NO: 1547 - DNA, 30 bp, Artificial Sequence
  Oligonucleotide
ttttgtcctctgctgtctcctctggtcctg

SEQ ID NO: 1548 - DNA, 30 bp, Artificial Sequence
  Oligonucleotide
gtgctgcctctcttctgtgtcgttttgttg

SEQ ID NO: 1549 - DNA, 30 bp, Artificial Sequence
  Oligonucleotide
tggggcaggattgtgactctcatttctttt

SEQ ID NO: 1550 - DNA, 30 bp, Artificial Sequence
  Oligonucleotide
gaggactacagcgacaaagtgaaagccagc

SEQ ID NO: 1551 - DNA, 30 bp, Artificial Sequence
  Oligonucleotide
ttgactggctttcctctcgttggtagttga

SEQ ID NO: 1552 - DNA, 30 bp, Artificial Sequence
  Oligonucleotide
cgactgtcttgtcccagaaccttttcactc

SEQ ID NO: 1553 - DNA, 30 bp, Artificial Sequence
  Oligonucleotide
ggcatcattgtccgctccattaagaacagt

SEQ ID NO: 1554 - DNA, 30 bp, Artificial Sequence
  Oligonucleotide
gtggaaaaccagcttcagtcagtgctccta

SEQ ID NO: 1555 - DNA, 30 bp, Artificial Sequence
  Oligonucleotide
ccaagtgtttcttttcccatgctctttgtt

SEQ ID NO: 1556 - DNA, 30 bp, Artificial Sequence
  Oligonucleotide
ttccctctcagttttcttttcatcccagcc

SEQ ID NO: 1557 - DNA, 30 bp, Artificial Sequence
  Oligonucleotide
gtttcttccgacagttgtgttgtgccaatg

SEQ ID NO: 1558 - DNA, 30 bp, Artificial Sequence
  Oligonucleotide
ctgcctcagtttgatgacgatgcggacact

SEQ ID NO: 1559 - DNA, 30 bp, Artificial Sequence
  Oligonucleotide
cttcatactttgttgggggactttggaggc

SEQ ID NO: 1560 - DNA, 30 bp, Artificial Sequence
  Oligonucleotide
cttttgatgagagtgccctaaccccagaca

SEQ ID NO: 1561 - DNA, 30 bp, Artificial Sequence
  Oligonucleotide
ccagtccaagaatctgtttaaaattcagac

SEQ ID NO: 1562 - DNA, 30 bp, Artificial Sequence
  Oligonucleotide
atgccctggagaagaatgaagtggacctgg

SEQ ID NO: 1563 - DNA, 30 bp, Artificial Sequence
  Oligonucleotide
tttgtactttacctggattccattggctgg

SEQ ID NO: 1564 - DNA, 30 bp, Artificial Sequence
  Oligonucleotide
gacattgagcttgtttcaaattcagcggct

SEQ ID NO: 1565 - DNA, 30 bp, Artificial Sequence
  Oligonucleotide
gctatgacatcgacatgaccaagtgcatct

SEQ ID NO: 1566 - DNA, 30 bp, Artificial Sequence
  Oligonucleotide
cttcaccaattacatcctccccgtgtgcct

SEQ ID NO: 1567 - DNA, 30 bp, Artificial Sequence
  Oligonucleotide
gagaaaagcagcctcccagtcagacaagcc

SEQ ID NO: 1568 - DNA, 30 bp, Artificial Sequence
  Oligonucleotide
cctcctgcccgtgtttgtgaatatcattct

SEQ ID NO: 1569 - DNA, 30 bp, Artificial Sequence
  Oligonucleotide
tgcttaaaatgttgctcaaacccctgacct

SEQ ID NO: 1570 - DNA, 30 bp, Artificial Sequence
  Oligonucleotide
ataagcccacccagagaagtgtttccaatg

SEQ ID NO: 1571 - DNA, 30 bp, Artificial Sequence
  Oligonucleotide
cctgccttggattctgaagtgttcctgttt

SEQ ID NO: 1572 - DNA, 30 bp, Artificial Sequence
  Oligonucleotide
gactcgtgccttctgctgttctcattgtgg

SEQ ID NO: 1573 - DNA, 30 bp, Artificial Sequence
  Oligonucleotide
ggaatcagagatcattgactttttcctggg

SEQ ID NO: 1574 - DNA, 30 bp, Artificial Sequence
  Oligonucleotide
accaaggctgtcaccacattcaccatcact

SEQ ID NO: 1575 - DNA, 30 bp, Artificial Sequence
  Oligonucleotide
gcctcattcctttaccactcccacacctgg

SEQ ID NO: 1576 - DNA, 30 bp, Artificial Sequence
  Oligonucleotide
ccttcatttctggctctgtgtctcctctgg

SEQ ID NO: 1577 - DNA, 30 bp, Artificial Sequence
  Oligonucleotide
ttcccagtcctaatcagcaccttccagaga

SEQ ID NO: 1578 - DNA, 30 bp, Artificial Sequence
  Oligonucleotide
gctgcaggaacccatttaggtggcaacaac

SEQ ID NO: 1579 - DNA, 30 bp, Artificial Sequence
  Oligonucleotide
gcccctggaaatgtgctaaagttggaaagt

SEQ ID NO: 1580 - DNA, 30 bp, Artificial Sequence
  Oligonucleotide
cacccaactgttcttttatcgtctcggttt

SEQ ID NO: 1581 - DNA, 30 bp, Artificial Sequence
  Oligonucleotide
gttcctttgtcttctcactcgcactctggc

SEQ ID NO: 1582 - DNA, 30 bp, Artificial Sequence
  Oligonucleotide
cactacttccgctacctgggctcactcacc

SEQ ID NO: 1583 - DNA, 30 bp, Artificial Sequence
  Oligonucleotide
aaagcagcggtcagttttcagagatgtcct

SEQ ID NO: 1584 - DNA, 30 bp, Artificial Sequence
  Oligonucleotide
ttcattggattgggggtgagtgttttgttt

SEQ ID NO: 1585 - DNA, 30 bp, Artificial Sequence
  Oligonucleotide
cattactctgcactatagccatttgcccca

SEQ ID NO: 1586 - DNA, 30 bp, Artificial Sequence
  Oligonucleotide
gttcttttagtaaggcatttggggttgggg

SEQ ID NO: 1587 - DNA, 30 bp, Artificial Sequence
  Oligonucleotide
cttggcagatcactctcttagcaggtaggt

SEQ ID NO: 1588 - DNA, 30 bp, Artificial Sequence
  Oligonucleotide
cgtgaatgtctcagcgaggtgtaaagttgt

SEQ ID NO: 1589 - DNA, 30 bp, Artificial Sequence
  Oligonucleotide
ccctcttcctccccgtcattgtactgtaac

SEQ ID NO: 1590 - DNA, 30 bp, Artificial Sequence
  Oligonucleotide
gctggtccttctcgtttgctctagtcttgc

SEQ ID NO: 1591 - DNA, 30 bp, Artificial Sequence
  Oligonucleotide
gcaaagatggtcaacgtacctaaaacccga

SEQ ID NO: 1592 - DNA, 30 bp, Artificial Sequence
  Oligonucleotide
tacaacgaatacatcagccaccgagagcac

SEQ ID NO: 1593 - DNA, 30 bp, Artificial Sequence
  Oligonucleotide
tcactaggctaaaactggacaaagaccgca

SEQ ID NO: 1594 - DNA, 30 bp, Artificial Sequence
  Oligonucleotide
aagatcagcaaattggcaaagtagtccagg

SEQ ID NO: 1595 - DNA, 30 bp, Artificial Sequence
  Oligonucleotide
aacttccgcatttccaccttctaagccgaa

SEQ ID NO: 1596 - DNA, 30 bp, Artificial Sequence
  Oligonucleotide
aaatcccttccttgcccacctctatgtcag

SEQ ID NO: 1597 - DNA, 30 bp, Artificial Sequence
  Oligonucleotide
actcctggtccccttgaaaccctgttggtg

SEQ ID NO: 1598 - DNA, 30 bp, Artificial Sequence
  Oligonucleotide
ggaaacaggccgagaagaacgtggataaga

SEQ ID NO: 1599 - DNA, 30 bp, Artificial Sequence
  Oligonucleotide
ttggcttgttaactcggtcagtccctggga

SEQ ID NO: 1600 - DNA, 30 bp, Artificial Sequence
  Oligonucleotide
gacccaacaacaacccctcccaagttccta

SEQ ID NO: 1601 - DNA, 30 bp, Artificial Sequence
  Oligonucleotide
atcacgctttctgtcccactttcccacact

SEQ ID NO: 1602 - DNA, 30 bp, Artificial Sequence
  Oligonucleotide
ccatgctctctctccataggtcctgtttta

SEQ ID NO: 1603 - DNA, 30 bp, Artificial Sequence
  Oligonucleotide
agcacctcttctgtctcctctcaaagtccg

SEQ ID NO: 1604 - DNA, 30 bp, Artificial Sequence
  Oligonucleotide
ggaggcatgtcctcaggcctgggagaccag

SEQ ID NO: 1605 - DNA, 30 bp, Artificial Sequence
  Oligonucleotide
gccttccttttgggtgtctttctcttctcc

SEQ ID NO: 1606 - DNA, 30 bp, Artificial Sequence
  Oligonucleotide
tcaggcatgttactggtagttccttttgag

SEQ ID NO: 1607 - DNA, 30 bp, Artificial Sequence
  Oligonucleotide
tgttgccgtatcaagcagaaaatgtcacca

SEQ ID NO: 1608 - DNA, 30 bp, Artificial Sequence
  Oligonucleotide
tcagaagaacgaactaaggtgtctaccatg

SEQ ID NO: 1609 - DNA, 30 bp, Artificial Sequence
  Oligonucleotide
gcgttcatggcctgcactcttacgagaggt

SEQ ID NO: 1610 - DNA, 30 bp, Artificial Sequence
  Oligonucleotide
aggaaggccaaatgagcaagtgaatcagca

SEQ ID NO: 1611 - DNA, 30 bp, Artificial Sequence
  Oligonucleotide
aaaataaggcccatgtccactgtcccctgc

SEQ ID NO: 1612 - DNA, 30 bp, Artificial Sequence
  Oligonucleotide
tttcctctgacttacccggacatgtacgtg

SEQ ID NO: 1613 - DNA, 30 bp, Artificial Sequence
  Oligonucleotide
ttttgcaaaacttgatgatcaagctgaacg

SEQ ID NO: 1614 - DNA, 30 bp, Artificial Sequence
  Oligonucleotide
atttggctctcacactctttaccgtgcaga

SEQ ID NO: 1615 - DNA, 30 bp, Artificial Sequence
  Oligonucleotide
acgtgtgaggtcacttcctgcgtgttgggt

SEQ ID NO: 1616 - DNA, 30 bp, Artificial Sequence
  Oligonucleotide
cttatttattaccctcccctcccacacccc

SEQ ID NO: 1617 - DNA, 30 bp, Artificial Sequence
  Oligonucleotide
tccttctgcactgcgtgtcccatctttgaa

SEQ ID NO: 1618 - DNA, 30 bp, Artificial Sequence
  Oligonucleotide
tccagcaccagtcagaccaatatgtcaaaa

SEQ ID NO: 1619 - DNA, 30 bp, Artificial Sequence
  Oligonucleotide
ctgctgtcctgcctcaatttagccaagact

SEQ ID NO: 1620 - DNA, 30 bp, Artificial Sequence
  Oligonucleotide
cttttcacctactgcgaccacccacctcat

SEQ ID NO: 1621 - DNA, 30 bp, Artificial Sequence
  Oligonucleotide
ctgttgtctgtagtttggggttgtggcaag

SEQ ID NO: 1622 - DNA, 30 bp, Artificial Sequence
  Oligonucleotide
ctctcctttcattgtcagactccccctggt

SEQ ID NO: 1623 - DNA, 30 bp, Artificial Sequence
  Oligonucleotide
cgtgtctcctcctcctcatcttagcttcca

SEQ ID NO: 1624 - DNA, 30 bp, Artificial Sequence
  Oligonucleotide
gcacgccctctatgacaatgtggagaaact

SEQ ID NO: 1625 - DNA, 30 bp, Artificial Sequence
  Oligonucleotide
tttgtgctcttttccctgtgtacatggtgg

SEQ ID NO: 1626 - DNA, 30 bp, Artificial Sequence
  Oligonucleotide
atcgacagcacgccctaccgacagtggtac

SEQ ID NO: 1627 - DNA, 30 bp, Artificial Sequence
  Oligonucleotide
gcaccggcacatctaacatctacacttctc

SEQ ID NO: 1628 - DNA, 30 bp, Artificial Sequence
  Oligonucleotide
cctcgccttctgtgtctttagtcttgagcc

SEQ ID NO: 1629 - DNA, 30 bp, Artificial Sequence
  Oligonucleotide
gtttgaagacggcatcattaactggggaag

SEQ ID NO: 1630 - DNA, 30 bp, Artificial Sequence
  Oligonucleotide
tttccctaccatcgttgagagagagccttg

SEQ ID NO: 1631 - DNA, 30 bp, Artificial Sequence
  Oligonucleotide
caggtgaactcgaagcccacaatcctcgtc

SEQ ID NO: 1632 - DNA, 30 bp, Artificial Sequence
  Oligonucleotide
ccgaggcccctacaaagccttcagagtaga

SEQ ID NO: 1633 - DNA, 30 bp, Artificial Sequence
  Oligonucleotide
cagagccgagatcctgaagaagagagcact

SEQ ID NO: 1634 - DNA, 30 bp, Artificial Sequence
  Oligonucleotide
taggatccaagaatgagggttcccccagcc

SEQ ID NO: 1635 - DNA, 30 bp, Artificial Sequence
  Oligonucleotide
aacacatctgatttcccacagcacaacagc

SEQ ID NO: 1636 - DNA, 30 bp, Artificial Sequence
  Oligonucleotide
atgtttgggatggtggctcctgttgtcttg

SEQ ID NO: 1637 - DNA, 30 bp, Artificial Sequence
  Oligonucleotide
ttgatggcgtgagtttactggtgcggaaaa

SEQ ID NO: 1638 - DNA, 30 bp, Artificial Sequence
  Oligonucleotide
tggaccacaagttcgacctgatgtatgcca

SEQ ID NO: 1639 - DNA, 30 bp, Artificial Sequence
  Oligonucleotide
actccacacttcaccccgctgcttttctct

SEQ ID NO: 1640 - DNA, 30 bp, Artificial Sequence
  Oligonucleotide
ggtgtgccctatacggtctctgaaggttca

SEQ ID NO: 1641 - DNA, 30 bp, Artificial Sequence
  Oligonucleotide
cctagctccgtcggttcctttctggtgaga

SEQ ID NO: 1642 - DNA, 30 bp, Artificial Sequence
  Oligonucleotide
agaccggcatcctctctctctctgtgcacc

SEQ ID NO: 1643 - DNA, 30 bp, Artificial Sequence
  Oligonucleotide
agaccagccagaacttcaccaagagcgcag

SEQ ID NO: 1644 - DNA, 30 bp, Artificial Sequence
  Oligonucleotide
ctgttgtgccctctgagccctccagtgagt

SEQ ID NO: 1645 - DNA, 30 bp, Artificial Sequence
  Oligonucleotide
aacccacacattcccattcaccaataaagg

SEQ ID NO: 1646 - DNA, 30 bp, Artificial Sequence
  Oligonucleotide
tctgcccaccagaaccggaagttgtgtctt

SEQ ID NO: 1647 - DNA, 30 bp, Artificial Sequence
  Oligonucleotide
aagctgcattgagaaatgactcgtctctgt

SEQ ID NO: 1648 - DNA, 30 bp, Artificial Sequence
  Oligonucleotide
ggaattcactgaccacctcgttaagaccca

SEQ ID NO: 1649 - DNA, 30 bp, Artificial Sequence
  Oligonucleotide
actccggacgtgagcattcgcagtgggttt

SEQ ID NO: 1650 - DNA, 30 bp, Artificial Sequence
  Oligonucleotide
ctaaatcccacgaatgacaactaccacctt

SEQ ID NO: 1651 - DNA, 30 bp, Artificial Sequence
  Oligonucleotide
gcataacagcatcacctacatcccagagca

SEQ ID NO: 1652 - DNA, 30 bp, Artificial Sequence
  Oligonucleotide
gatggccgccaccctcatgacatcatatat

SEQ ID NO: 1653 - DNA, 30 bp, Artificial Sequence
  Oligonucleotide
atgcccgcctgcctgttacattcctgttat

SEQ ID NO: 1654 - DNA, 30 bp, Artificial Sequence
  Oligonucleotide
aactcccaaactgccgttcttttcgatagc

SEQ ID NO: 1655 - DNA, 30 bp, Artificial Sequence
  Oligonucleotide
gaagtcaaatgcacgccaacattccagttt

SEQ ID NO: 1656 - DNA, 30 bp, Artificial Sequence
  Oligonucleotide
ttggagatggagttgaatgagcacagccta

SEQ ID NO: 1657 - DNA, 30 bp, Artificial Sequence
  Oligonucleotide
cggaactcagcatcctactcttcgccttta

SEQ ID NO: 1658 - DNA, 30 bp, Artificial Sequence
  Oligonucleotide
cccccagttgcttatccagatgtgacagag

SEQ ID NO: 1659 - DNA, 30 bp, Artificial Sequence
  Oligonucleotide
tggactcagctacatccgatactcccagat

SEQ ID NO: 1660 - DNA, 30 bp, Artificial Sequence
  Oligonucleotide
tccatttgattcaaggtgctggtccaacag

SEQ ID NO: 1661 - DNA, 30 bp, Artificial Sequence
  Oligonucleotide
atgtatcactgccactggttttggagttgc

SEQ ID NO: 1662 - DNA, 30 bp, Artificial Sequence
  Oligonucleotide
ccccaggcccttctggttggtagtgagtgt

SEQ ID NO: 1663 - DNA, 30 bp, Artificial Sequence
  Oligonucleotide
aagtacacccctccacctcaccacattggc

SEQ ID NO: 1664 - DNA, 30 bp, Artificial Sequence
  Oligonucleotide
cgggctcttcgggatcttctaacacactac

SEQ ID NO: 1665 - DNA, 30 bp, Artificial Sequence
  Oligonucleotide
tgacaatgacatcttccccttaccttagcc

SEQ ID NO: 1666 - DNA, 30 bp, Artificial Sequence
  Oligonucleotide
gttccttccgtctccagtgcaccggctttc

SEQ ID NO: 1667 - DNA, 30 bp, Artificial Sequence
  Oligonucleotide
gacttaccccctttctcttaccacggcttc

SEQ ID NO: 1668 - DNA, 30 bp, Artificial Sequence
  Oligonucleotide
gtcaaccccatcatctactccttccgcagc

SEQ ID NO: 1669 - DNA, 30 bp, Artificial Sequence
  Oligonucleotide
cgctgacttggagcctctcttcctatacct

SEQ ID NO: 1670 - DNA, 30 bp, Artificial Sequence
  Oligonucleotide
aaggacgaggacaccgaagagcagaaggag

SEQ ID NO: 1671 - DNA, 30 bp, Artificial Sequence
  Oligonucleotide
tcaatggttggttatattctggggcttgga

SEQ ID NO: 1672 - DNA, 30 bp, Artificial Sequence
  Oligonucleotide
gaccatccactccatagccctcacctccct

SEQ ID NO: 1673 - DNA, 30 bp, Artificial Sequence
  Oligonucleotide
ctattggtggtcgtcggttttctgagggta

SEQ ID NO: 1674 - DNA, 30 bp, Artificial Sequence
  Oligonucleotide
ccctattccctgaagatccgaaacactacc

SEQ ID NO: 1675 - DNA, 30 bp, Artificial Sequence
  Oligonucleotide
tgcgagtcatttacttattgcccctcacct

SEQ ID NO: 1676 - DNA, 30 bp, Artificial Sequence
  Oligonucleotide
ctgctccattgactttgacatcacccagaa

SEQ ID NO: 1677 - DNA, 30 bp, Artificial Sequence
  Oligonucleotide
ctatgtcaacgtccactagctgcccgattc

SEQ ID NO: 1678 - DNA, 30 bp, Artificial Sequence
  Oligonucleotide
agacagatttggagattggcaagattacca

SEQ ID NO: 1679 - DNA, 30 bp, Artificial Sequence
  Oligonucleotide
ctgcccttcttcgtggtgtctctggtcctc

SEQ ID NO: 1680 - DNA, 30 bp, Artificial Sequence
  Oligonucleotide
acccgactactttgcctccttggatttcct

SEQ ID NO: 1681 - DNA, 30 bp, Artificial Sequence
  Oligonucleotide
tggacttcatggttcagcacacgtcgttca

SEQ ID NO: 1682 - DNA, 30 bp, Artificial Sequence
  Oligonucleotide
gtcctccactactggctgctgctttgggac

SEQ ID NO: 1683 - DNA, 30 bp, Artificial Sequence
  Oligonucleotide
cccacctatgtccattccatgtaccagctt

SEQ ID NO: 1684 - DNA, 30 bp, Artificial Sequence
  Oligonucleotide
gatgagccccagtgttcttgcctcctacta

SEQ ID NO: 1685 - DNA, 30 bp, Artificial Sequence
  Oligonucleotide
cggaggtctaggaagagggtctgcacagca

SEQ ID NO: 1686 - DNA, 30 bp, Artificial Sequence
  Oligonucleotide
atttgtgaactcagccaagcacagtggtgg

SEQ ID NO: 1687 - DNA, 30 bp, Artificial Sequence
  Oligonucleotide
cgaacacggctactttccagagatatttga

SEQ ID NO: 1688 - DNA, 30 bp, Artificial Sequence
  Oligonucleotide
tctcctgccccttcattgacaacacctact

SEQ ID NO: 1689 - DNA, 30 bp, Artificial Sequence
  Oligonucleotide
ttccctcttccccctttctctctgtctcat

SEQ ID NO: 1690 - DNA, 30 bp, Artificial Sequence
  Oligonucleotide
caaatgctttcaggctgcttaccttaccgt

SEQ ID NO: 1691 - DNA, 30 bp, Artificial Sequence
  Oligonucleotide
tctgtaaggctctgacctccaagaccaacc

SEQ ID NO: 1692 - DNA, 30 bp, Artificial Sequence
  Oligonucleotide
gctttcccaacagctccaccttacttcttc

SEQ ID NO: 1693 - DNA, 30 bp, Artificial Sequence
  Oligonucleotide
tcccaagtactccccaaatgcaccccttaa

SEQ ID NO: 1694 - DNA, 30 bp, Artificial Sequence
  Oligonucleotide
cagggaaagcggtgttatgacaggaagcag

SEQ ID NO: 1695 - DNA, 30 bp, Artificial Sequence
  Oligonucleotide
gcagacttggaatcaacccaaatgcccatc

SEQ ID NO: 1696 - DNA, 30 bp, Artificial Sequence
  Oligonucleotide
agtcacaagccccatcccagactctccaac

SEQ ID NO: 1697 - DNA, 30 bp, Artificial Sequence
  Oligonucleotide
tggaaaacagtctactcaggttatggcagc

SEQ ID NO: 1698 - DNA, 30 bp, Artificial Sequence
  Oligonucleotide
ccatcgagacctatgagcaggagaaagcag

SEQ ID NO: 1699 - DNA, 30 bp, Artificial Sequence
  Oligonucleotide
cttggagaactccgaggagtatgcggctcg

SEQ ID NO: 1700 - DNA, 30 bp, Artificial Sequence
  Oligonucleotide
ttcctttctcttttgtgaatctttcccccc

SEQ ID NO: 1701 - DNA, 30 bp, Artificial Sequence
  Oligonucleotide
tgtctcccaatgccagcgtatgtctgtact

SEQ ID NO: 1702 - DNA, 30 bp, Artificial Sequence
  Oligonucleotide
ctgtgctcaacctcttcaccaggatccggt

SEQ ID NO: 1703 - DNA, 30 bp, Artificial Sequence
  Oligonucleotide
tgctgtactccaagtttctgatgcacccgg

SEQ ID NO: 1704 - DNA, 30 bp, Artificial Sequence
  Oligonucleotide
attcctatatgccgacagtcagccacctca

SEQ ID NO: 1705 - DNA, 30 bp, Artificial Sequence
  Oligonucleotide
gtccctcacctcctctccctgcatcctcat

SEQ ID NO: 1706 - DNA, 30 bp, Artificial Sequence
  Oligonucleotide
aattgttttcttggtgttatcttttctcaa

SEQ ID NO: 1707 - DNA, 30 bp, Artificial Sequence
  Oligonucleotide
ggttgtcctcattgatccattccataaagc

SEQ ID NO: 1708 - DNA, 30 bp, Artificial Sequence
  Oligonucleotide
gtgggccgtattcatcgacacctaaaatct

SEQ ID NO: 1709 - DNA, 30 bp, Artificial Sequence
  Oligonucleotide
ggcgtttgttgccatcagggattacaatgg

SEQ ID NO: 1710 - DNA, 30 bp, Artificial Sequence
  Oligonucleotide
ctggaaaacgtgtatgagagcatccgggag

SEQ ID NO: 1711 - DNA, 30 bp, Artificial Sequence
  Oligonucleotide
caagatgggctatgagtttggcaagggttt

SEQ ID NO: 1712 - DNA, 30 bp, Artificial Sequence
  Oligonucleotide
ttcagcagacgcaactatcatggacattca

SEQ ID NO: 1713 - DNA, 30 bp, Artificial Sequence
  Oligonucleotide
cgacattagcaggcataaaaaacattgaca

SEQ ID NO: 1714 - DNA, 30 bp, Artificial Sequence
  Oligonucleotide
aaacagcagatccaatccattcagcagtcc

SEQ ID NO: 1715 - DNA, 30 bp, Artificial Sequence
  Oligonucleotide
ttcttgtgcccgcattggtattaaatcctc

SEQ ID NO: 1716 - DNA, 30 bp, Artificial Sequence
  Oligonucleotide
tggcgtttgtcatcagaatcagaggtatca

SEQ ID NO: 1717 - DNA, 30 bp, Artificial Sequence
  Oligonucleotide
gccaagatgctgcccaagaagactgagagt

SEQ ID NO: 1718 - DNA, 30 bp, Artificial Sequence
  Oligonucleotide
ctctcaccatctccagtcaccagcatctcc

SEQ ID NO: 1719 - DNA, 30 bp, Artificial Sequence
  Oligonucleotide
cgcccctgtcttaataaagctgcgtgtttc

SEQ ID NO: 1720 - DNA, 30 bp, Artificial Sequence
  Oligonucleotide
tggcaacatgatttcagcttctaccttgat

SEQ ID NO: 1721 - DNA, 30 bp, Artificial Sequence
  Oligonucleotide
cgatctgggttccgtccacctaattccaaa

SEQ ID NO: 1722 - DNA, 30 bp, Artificial Sequence
  Oligonucleotide
ttggtggctttcttttctctctttgatggg

SEQ ID NO: 1723 - DNA, 30 bp, Artificial Sequence
  Oligonucleotide
ttagcctctcttagccccttgttcttccca

SEQ ID NO: 1724 - DNA, 30 bp, Artificial Sequence
  Oligonucleotide
actagaggtgaaagctcggcgagatgaaga

SEQ ID NO: 1725 - DNA, 30 bp, Artificial Sequence
  Oligonucleotide
gctgtcccctgtccctatctctcactctgg

SEQ ID NO: 1726 - DNA, 30 bp, Artificial Sequence
  Oligonucleotide
cttggtctcactgtcctcaccggcttcctc

SEQ ID NO: 1727 - DNA, 30 bp, Artificial Sequence
  Oligonucleotide
gaaagtgccccatgtgcaagtcaaggatgt

SEQ ID NO: 1728 - DNA, 30 bp, Artificial Sequence
  Oligonucleotide
gttcatcaagcccaccttcccattctgcag

SEQ ID NO: 1729 - DNA, 30 bp, Artificial Sequence; identical to SEQ ID NO: 1638
  Oligonucleotide

SEQ ID NO: 1730 - DNA, 30 bp, Artificial Sequence
  Oligonucleotide
gcctatggtttaagcctgaagaactggttg

SEQ ID NO: 1731 - DNA, 30 bp, Artificial Sequence
  Oligonucleotide
attgacaatcggactcagaaagtggttgcc

SEQ ID NO: 1732 - DNA, 30 bp, Artificial Sequence
  Oligonucleotide
ttgtagatggaatagaagcccttgttgccg

SEQ ID NO: 1733 - DNA, 30 bp, Artificial Sequence
  Oligonucleotide
cagcagagatgacagaagacgagacaccca

SEQ ID NO: 1734 - DNA, 30 bp, Artificial Sequence
  Oligonucleotide
ctctctggccattgagcatatccaaatgaa

SEQ ID NO: 1735 - DNA, 30 bp, Artificial Sequence
  Oligonucleotide
gcacactgagaatgctaatggttgggttga

SEQ ID NO: 1736 - DNA, 30 bp, Artificial Sequence
  Oligonucleotide
cccggtcaaaagtggattgtatatgtcctc

SEQ ID NO: 1737 - DNA, 30 bp, Artificial Sequence
  Oligonucleotide
tcattaaagtgcagcaggacagatggcagc

SEQ ID NO: 1738 - DNA, 30 bp, Artificial Sequence
  Oligonucleotide
cacgatttattcctccaggtctttgattgg

SEQ ID NO: 1739 - DNA, 30 bp, Artificial Sequence
  Oligonucleotide
ctagcatggtcggtggacctgggtgtctgt

SEQ ID NO: 1740 - DNA, 30 bp, Artificial Sequence
  Oligonucleotide
cccagccagttaagcacaaagaaaaatatt

SEQ ID NO: 1741 - DNA, 30 bp, Artificial Sequence
  Oligonucleotide
ctctgaacaagggtgatgccaactctgaag

SEQ ID NO: 1742 - DNA, 30 bp, Artificial Sequence
  Oligonucleotide
acagccacttaactggatttctttggagca

SEQ ID NO: 1743 - DNA, 30 bp, Artificial Sequence
  Oligonucleotide
atcctggtgctgcttttgtggtggtagaat

SEQ ID NO: 1744 - DNA, 30 bp, Artificial Sequence
  Oligonucleotide
gaataacttccagccttaccccctaccaca

SEQ ID NO: 1745 - DNA, 30 bp, Artificial Sequence
  Oligonucleotide
tagggataattggctcacctcgttccacag

SEQ ID NO: 1746 - DNA, 30 bp, Artificial Sequence
  Oligonucleotide
gccagccaaagtatccaccgaagagcaagt

SEQ ID NO: 1747 - DNA, 30 bp, Artificial Sequence
  Oligonucleotide
ccctgactgtaaactgctgaaggtccctga

SEQ ID NO: 1748 - DNA, 30 bp, Artificial Sequence
  Oligonucleotide
atgcgtctgtccacttggctaacttttaat

SEQ ID NO: 1749 - DNA, 30 bp, Artificial Sequence
  Oligonucleotide
gggcgatggctgtcttttcttgactttgta

SEQ ID NO: 1750 - DNA, 30 bp, Artificial Sequence
  Oligonucleotide
gccaacaagcaccagatcaaacaggctgtg

SEQ ID NO: 1751 - DNA, 30 bp, Artificial Sequence
  Oligonucleotide
ttagtagacctgccctgtgttatggaaagc

SEQ ID NO: 1752 - DNA, 30 bp, Artificial Sequence
  Oligonucleotide
tgcctctcttctcattattgtgtcctttgc

SEQ ID NO: 1753 - DNA, 30 bp, Artificial Sequence
  Oligonucleotide
ggactgtgacctgccataaagactgacctt

SEQ ID NO: 1754 - DNA, 30 bp, Artificial Sequence
  Oligonucleotide
acccccatcccctactgtgacttgctttag

SEQ ID NO: 1755 - DNA, 30 bp, Artificial Sequence
  Oligonucleotide
tgatacagccttcttcagccagtttgcttt

SEQ ID NO: 1756 - DNA, 30 bp, Artificial Sequence
  Oligonucleotide
gccttccagagtgtatgggtttcgacagac

SEQ ID NO: 1757 - DNA, 30 bp, Artificial Sequence
  Oligonucleotide
actgatagccacgctgaagaatggaaggaa

SEQ ID NO: 1758 - DNA, 30 bp, Artificial Sequence
  Oligonucleotide
cagagctgaagctgaagaagatggggacct

SEQ ID NO: 1759 - DNA, 30 bp, Artificial Sequence
  Oligonucleotide
ttgttgtccttggagctgtggtcactggag

SEQ ID NO: 1760 - DNA, 30 bp, Artificial Sequence
  Oligonucleotide
gctgtctctctctcaacctcagatccccaa

SEQ ID NO: 1761 - DNA, 30 bp, Artificial Sequence
  Oligonucleotide
gaaaagcaaaaactaggtgtgtcattgaaa

SEQ ID NO: 1762 - DNA, 30 bp, Artificial Sequence
  Oligonucleotide
ttttctccacttctttctcccactcacccc

SEQ ID NO: 1763 - DNA, 30 bp, Artificial Sequence
  Oligonucleotide
cggagattttgaggctagggtgtgtttctt

SEQ ID NO: 1764 - DNA, 30 bp, Artificial Sequence
  Oligonucleotide
aagaagatgaaagttgacctgagcccgaag

SEQ ID NO: 1765 - DNA, 30 bp, Artificial Sequence
  Oligonucleotide
gagctaatgtcaaaccccgaaattccacac

SEQ ID NO: 1766 - DNA, 30 bp, Artificial Sequence
  Oligonucleotide
tcttcaacatcctggctaagttcaatggca

SEQ ID NO: 1767 - DNA, 30 bp, Artificial Sequence
  Oligonucleotide
gtctgctgctattctccgagcttcgcaatg

SEQ ID NO: 1768 - DNA, 30 bp, Artificial Sequence
  Oligonucleotide
gaccccaagttcccgaggaacatgtgcttt

SEQ ID NO: 1769 - DNA, 30 bp, Artificial Sequence
  Oligonucleotide
gagctggcctgcagcctttttgtgcaagtg

SEQ ID NO: 1770 - DNA, 30 bp, Artificial Sequence
  Oligonucleotide
gtggacattctgggtattgtgtgccaactg

SEQ ID NO: 1771 - DNA, 30 bp, Artificial Sequence
  Oligonucleotide
aagaagccaagaagaagaaagaggatgccc

SEQ ID NO: 1772 - DNA, 30 bp, Artificial Sequence
  Oligonucleotide
cgatgtattctgaccaaggtgcgacaatct

SEQ ID NO: 1773 - DNA, 30 bp, Artificial Sequence
  Oligonucleotide
tgtagcaaagcttttagccgatcctcaaaa

SEQ ID NO: 1774 - DNA, 30 bp, Artificial Sequence
  Oligonucleotide
atacgtaattaagtcccggcgctcccactc

SEQ ID NO: 1775 - DNA, 30 bp, Artificial Sequence
  Oligonucleotide
caacatcaaaggtgtaatcagcctcattgg

SEQ ID NO: 1776 - DNA, 30 bp, Artificial Sequence
  Oligonucleotide
ttttgcggaatcttgtacccaggacagagt

SEQ ID NO: 1777 - DNA, 30 bp, Artificial Sequence
  Oligonucleotide
tggctccttagacgacagactacctcacgg

SEQ ID NO: 1778 - DNA, 30 bp, Artificial Sequence
  Oligonucleotide
atcctccccgaccagcagaggctcatcttt

SEQ ID NO: 1779 - DNA, 30 bp, Artificial Sequence
  Oligonucleotide
ccagattgtcaatcatgaccaaaagttgct

SEQ ID NO: 1780 - DNA, 30 bp, Artificial Sequence
  Oligonucleotide
cccactggcttcaagatggcattaattact

SEQ ID NO: 1781 - DNA, 30 bp, Artificial Sequence
  Oligonucleotide
cccctctagtgcataattcagcatacgatg

SEQ ID NO: 1782 - DNA, 30 bp, Artificial Sequence
  Oligonucleotide
cctcccgttggtatcttccatctcatgcgt

SEQ ID NO: 1783 - DNA, 30 bp, Artificial Sequence
  Oligonucleotide
gcccaaggaagttaagcccaagatcccaaa

SEQ ID NO: 1784 - DNA, 30 bp, Artificial Sequence
  Oligonucleotide
gaccgacagttccaggagctcaacgagctg

SEQ ID NO: 1785 - DNA, 30 bp, Artificial Sequence
  Oligonucleotide
ctgatccacgtcccgctagagacctttctg

SEQ ID NO: 1786 - DNA, 30 bp, Artificial Sequence
  Oligonucleotide
ctttccaggtgtcagcaggtgtgatcaggg

SEQ ID NO: 1787 - DNA, 30 bp, Artificial Sequence
  Oligonucleotide
gactgctgtctgccctctctggtcaccctg

SEQ ID NO: 1788 - DNA, 30 bp, Artificial Sequence
  Oligonucleotide
ctttctcttcttgtttctcctgcccactgc

SEQ ID NO: 1789 - DNA, 30 bp, Artificial Sequence
  Oligonucleotide
gttcatccgtcgtctcattcatgccgagtt

SEQ ID NO: 1790 - DNA, 30 bp, Artificial Sequence
  Oligonucleotide
aaatcagggctgcccagtgatcggttctct

SEQ ID NO: 1791 - DNA, 30 bp, Artificial Sequence
  Oligonucleotide
gctggtgcgagactacctggagctggagaa

SEQ ID NO: 1792 - DNA, 30 bp, Artificial Sequence
  Oligonucleotide
cttccttatcccaccccagagacatcggct

SEQ ID NO: 1793 - DNA, 30 bp, Artificial Sequence
  Oligonucleotide
tgtgtctgcttcctgcctgtgaaactcatc

SEQ ID NO: 1794 - DNA, 30 bp, Artificial Sequence
  Oligonucleotide
gccctgtgtgtcttggtttagttatggttt

SEQ ID NO: 1795 - DNA, 30 bp, Artificial Sequence
  Oligonucleotide
cttggagccaaagtatcggattcaggaaca

SEQ ID NO: 1796 - DNA, 30 bp, Artificial Sequence
  Oligonucleotide
aagggcagttatctcaacagaccgatgctc

SEQ ID NO: 1797 - DNA, 30 bp, Artificial Sequence
  Oligonucleotide
cgacacctacaatggcatcttcaccacctt

SEQ ID NO: 1798 - DNA, 30 bp, Artificial Sequence
  Oligonucleotide
ctggctccacgggtgaatctgacttttcgt

SEQ ID NO: 1799 - DNA, 30 bp, Artificial Sequence
  Oligonucleotide
ggctttggagaactttgaatgctacccccc

SEQ ID NO: 1800 - DNA, 30 bp, Artificial Sequence
  Oligonucleotide
tacaaaacctgcttctcttctcaaccgtgg

SEQ ID NO: 1801 - DNA, 30 bp, Artificial Sequence
  Oligonucleotide
gttacggttttgtcacgatgtccacagcag

SEQ ID NO: 1802 - DNA, 30 bp, Artificial Sequence
  Oligonucleotide
atctccgtccttgtctttccattctgccct

SEQ ID NO: 1803 - DNA, 30 bp, Artificial Sequence
  Oligonucleotide
tccgccgcatagttatagtgttgatgtgtg

SEQ ID NO: 1804 - DNA, 30 bp, Artificial Sequence
  Oligonucleotide
gcacatcacgcagaaggacaactacagggt

SEQ ID NO: 1805 - DNA, 30 bp, Artificial Sequence
  Oligonucleotide
ccgctgcatgtgtataaagacaacctctgg

SEQ ID NO: 1806 - DNA, 30 bp, Artificial Sequence
  Oligonucleotide
ctgcctgtgaatgtccgagaactgagcctg

SEQ ID NO: 1807 - DNA, 30 bp, Artificial Sequence
  Oligonucleotide
tccatttcccatttccttttcttccctgac

SEQ ID NO: 1808 - DNA, 30 bp, Artificial Sequence
  Oligonucleotide
ccccataccctcacccttaaaattctcctg

SEQ ID NO: 1809 - DNA, 30 bp, Artificial Sequence
  Oligonucleotide
tgccaaaagttccctctgtgttactcccat

SEQ ID NO: 1810 - DNA, 30 bp, Artificial Sequence
  Oligonucleotide
cttcttgctcctgtctgtttccccatcctg

SEQ ID NO: 1811 - DNA, 30 bp, Artificial Sequence
  Oligonucleotide
cagtcctgcccctgttcctctactcacatc

SEQ ID NO: 1812 - DNA, 30 bp, Artificial Sequence
  Oligonucleotide
ttcgcttgaacattcccttgatctcatcag

SEQ ID NO: 1813 - DNA, 30 bp, Artificial Sequence
  Oligonucleotide
tgctttctctctgtggacatgaggattgga

SEQ ID NO: 1814 - DNA, 30 bp, Artificial Sequence
  Oligonucleotide
acggtcctggttctgcccttcttctctttc

SEQ ID NO: 1815 - DNA, 30 bp, Artificial Sequence
  Oligonucleotide
ttggctgaaaggtttgaaatacgtacccca

SEQ ID NO: 1816 - DNA, 30 bp, Artificial Sequence
  Oligonucleotide
tttcaacgcctaccacttctccctcctgct

SEQ ID NO: 1817 - DNA, 30 bp, Artificial Sequence
  Oligonucleotide
tgttgatgcctaagaagaaccggattgcca

SEQ ID NO: 1818 - DNA, 30 bp, Artificial Sequence
  Oligonucleotide
cctttatgtggggctttcttctctgttgga

SEQ ID NO: 1819 - DNA, 30 bp, Artificial Sequence
  Oligonucleotide
cttgcactgaaaattgtctctccagctgtg

SEQ ID NO: 1820 - DNA, 30 bp, Artificial Sequence
  Oligonucleotide
atttggagagaatcttcgggcttcctggag

SEQ ID NO: 1821 - DNA, 30 bp, Artificial Sequence
  Oligonucleotide
cctttcccttctggttttgagagacttcct

SEQ ID NO: 1822 - DNA, 30 bp, Artificial Sequence
  Oligonucleotide
ctccctctgctggtcatcctcctgtcttac

SEQ ID NO: 1823 - DNA, 30 bp, Artificial Sequence
  Oligonucleotide
gtgttactatgggtatccgccgctgaccta

SEQ ID NO: 1824 - DNA, 30 bp, Artificial Sequence
  Oligonucleotide
ccaataaagtacatcccagacgccacacct

SEQ ID NO: 1825 - DNA, 30 bp, Artificial Sequence
  Oligonucleotide
tctggtgctgaataaacccttctgatctgg

SEQ ID NO: 1826 - DNA, 30 bp, Artificial Sequence
  Oligonucleotide
gctcccatttccccttcttcctgatagact

SEQ ID NO: 1827 - DNA, 30 bp, Artificial Sequence
  Oligonucleotide
tttccagaacagtgagggttaggtcttggg

SEQ ID NO: 1828 - DNA, 30 bp, Artificial Sequence
  Oligonucleotide
atttgtccgtaaccttgtggagaagacccc

SEQ ID NO: 1829 - DNA, 30 bp, Artificial Sequence
  Oligonucleotide
tgcgggtttgaggataggagttcacttcat

SEQ ID NO: 1830 - DNA, 30 bp, Artificial Sequence
  Oligonucleotide
tctggcttgggttaattcttcggtgacact

SEQ ID NO: 1831 - DNA, 30 bp, Artificial Sequence
  Oligonucleotide
ccctgaaacgaatgctggagaaacttggag

SEQ ID NO: 1832 - DNA, 30 bp, Artificial Sequence
  Oligonucleotide
ttgtctttctttcgttgatctctgggctgg

SEQ ID NO: 1833 - DNA, 30 bp, Artificial Sequence
  Oligonucleotide
gctgctggagtattggatgttgcttgattt

SEQ ID NO: 1834 - DNA, 30 bp, Artificial Sequence
  Oligonucleotide
cttttggtttctcgcattgcctctcagact

SEQ ID NO: 1835 - DNA, 30 bp, Artificial Sequence
  Oligonucleotide
gaaaatacccagtgttgactcaccaaggca

SEQ ID NO: 1836 - DNA, 30 bp, Artificial Sequence
  Oligonucleotide
ccagcttttcctcccttgggttctgatatt

SEQ ID NO: 1837 - DNA, 30 bp, Artificial Sequence
  Oligonucleotide
tcgccgttagcctgatcatcttcacctact

SEQ ID NO: 1838 - DNA, 30 bp, Artificial Sequence
  Oligonucleotide
ggagtgttgagcaatttcggtttcctctga

SEQ ID NO: 1839 - DNA, 30 bp, Artificial Sequence
  Oligonucleotide
taccaagcctcaacgggacagaccataaac

SEQ ID NO: 1840 - DNA, 30 bp, Artificial Sequence
  Oligonucleotide
cctcgtcttgggttagctctgactgtcctg

SEQ ID NO: 1841 - DNA, 30 bp, Artificial Sequence
  Oligonucleotide
tagttggatggcacaaggctcttcacagac

SEQ ID NO: 1842 - DNA, 30 bp, Artificial Sequence
  Oligonucleotide
gccaacaagcaccagattaaacaggctgtg

SEQ ID NO: 1843 - DNA, 30 bp, Artificial Sequence
  Oligonucleotide
agggcgtcagtgaaaagcagtacaccatct

SEQ ID NO: 1844 - DNA, 30 bp, Artificial Sequence
  Oligonucleotide
ctgtttgtgcgtcatagaacccagaaggaa

SEQ ID NO: 1845 - DNA, 30 bp, Artificial Sequence
  Oligonucleotide
gtgtgttcctgtcatagtttgtgtctccca

SEQ ID NO: 1846 - DNA, 30 bp, Artificial Sequence
  Oligonucleotide
agcctctccatccagcatcttctctatctt

SEQ ID NO: 1847 - DNA, 30 bp, Artificial Sequence
  Oligonucleotide
cgtctctgcttcatctccaccacgcttcag

SEQ ID NO: 1848 - DNA, 30 bp, Artificial Sequence
  Oligonucleotide
agccctcttgtatagcatccccactcacct

SEQ ID NO: 1849 - DNA, 30 bp, Artificial Sequence
  Oligonucleotide
ttctacggatgacttgctggactgcttggt

SEQ ID NO: 1850 - DNA, 30 bp, Artificial Sequence
  Oligonucleotide
tggggtccttctcctgtcactggttatcac

SEQ ID NO: 1851 - DNA, 30 bp, Artificial Sequence
  Oligonucleotide
atctcaacctcttccccgcccgttttacaa

SEQ ID NO: 1852 - DNA, 30 bp, Artificial Sequence
  Oligonucleotide
ttgggggttttgctgtttccttttatgaga

SEQ ID NO: 1853 - DNA, 30 bp, Artificial Sequence
  Oligonucleotide
cttctggccgtaggttccaggaaagctcgt

SEQ ID NO: 1854 - DNA, 30 bp, Artificial Sequence
  Oligonucleotide
gcgtccaccaagaccttagcatactgttga

SEQ ID NO: 1855 - DNA, 30 bp, Artificial Sequence
  Oligonucleotide
ccctgtagccctcagtatctcactcaccca

SEQ ID NO: 1856 - DNA, 30 bp, Artificial Sequence
  Oligonucleotide
cagaaccttgtgagctggacgatgaagatt

SEQ ID NO: 1857 - DNA, 30 bp, Artificial Sequence
  Oligonucleotide
aagatccagaagctgagcctccagaactgc

SEQ ID NO: 1858 - DNA, 30 bp, Artificial Sequence
  Oligonucleotide
cccctcccctctctgtgagcctgtttctct

SEQ ID NO: 1859 - DNA, 30 bp, Artificial Sequence
  Oligonucleotide
gttccatctttgcctgtgcctcatcctgct

SEQ ID NO: 1860 - DNA, 30 bp, Artificial Sequence
  Oligonucleotide
tcttcaagcctgtcttcaacacctcactgc

SEQ ID NO: 1861 - DNA, 30 bp, Artificial Sequence
  Oligonucleotide
caccctcctccattttgcgtctatttcttc

SEQ ID NO: 1862 - DNA, 30 bp, Artificial Sequence
  Oligonucleotide
cgggacttaaagacacttgacctgtttggg

SEQ ID NO: 1863 - DNA, 30 bp, Artificial Sequence
  Oligonucleotide
tgtgattccctcctgctactctgttccttc

SEQ ID NO: 1864 - DNA, 30 bp, Artificial Sequence
  Oligonucleotide
gaaaggctcaacgagaacaagctatcaggg

SEQ ID NO: 1865 - DNA, 30 bp, Artificial Sequence
  Oligonucleotide
tgaagaaagttgaaatcagccagcaggcca

SEQ ID NO: 1866 - DNA, 30 bp, Artificial Sequence
  Oligonucleotide
tgccccatattttacatccctcattcaagg

SEQ ID NO: 1867 - DNA, 30 bp, Artificial Sequence
  Oligonucleotide
gtatgcgtgacttggctgtggctgtctttt

SEQ ID NO: 1868 - DNA, 30 bp, Artificial Sequence
  Oligonucleotide
gctgccgaagacaaatgacaggattatgag

SEQ ID NO: 1869 - DNA, 30 bp, Artificial Sequence
  Oligonucleotide
gcgtccaagtctgtgaatgtaaaacccctc

SEQ ID NO: 1870 - DNA, 30 bp, Artificial Sequence
  Oligonucleotide
cggcaggcactactcatcgagaggtactat

SEQ ID NO: 1871 - DNA, 30 bp, Artificial Sequence
  Oligonucleotide
attccagggtcagacaagattccagtagcg

SEQ ID NO: 1872 - DNA, 30 bp, Artificial Sequence
  Oligonucleotide
ctgccgcaaagttctacagcttcttggttc

SEQ ID NO: 1873 - DNA, 30 bp, Artificial Sequence
  Oligonucleotide
gtcttcagagatccctgccatgatgtagcc

SEQ ID NO: 1874 - DNA, 30 bp, Artificial Sequence
  Oligonucleotide
tcttggaagagactcctgctgtgattgtcc

SEQ ID NO: 1875 - DNA, 30 bp, Artificial Sequence
  Oligonucleotide
ggttgtgtctgtcaaatgtctgctgcttgg

SEQ ID NO: 1876 - DNA, 30 bp, Artificial Sequence
  Oligonucleotide
aaaattgcatctgatggtctcaagggtcgt

SEQ ID NO: 1877 - DNA, 30 bp, Artificial Sequence
  Oligonucleotide
ttgcccgcaaagttttaaagctttcatcca

SEQ ID NO: 1878 - DNA, 30 bp, Artificial Sequence
  Oligonucleotide
ggagcagttcacagtgttgtccctctcagc

SEQ ID NO: 1879 - DNA, 30 bp, Artificial Sequence
  Oligonucleotide
tctgtgctggctgctcagaagataccgcat

SEQ ID NO: 1880 - DNA, 30 bp, Artificial Sequence
  Oligonucleotide
attgctcaatctcttggtaaatatggcacc

SEQ ID NO: 1881 - DNA, 30 bp, Artificial Sequence
  Oligonucleotide
tgcgtcccaagaagaaggtcaaataaggtg

SEQ ID NO: 1882 - DNA, 30 bp, Artificial Sequence
  Oligonucleotide
atgtgccctgggcatctccaccctcagtct

SEQ ID NO: 1883 - DNA, 30 bp, Artificial Sequence
  Oligonucleotide
ctgtctgctcttctctaatgctgcgtccct

SEQ ID NO: 1884 - DNA, 30 bp, Artificial Sequence
  Oligonucleotide
gctgtctgctcttctctaatgctgcatccc

SEQ ID NO: 1885 - DNA, 30 bp, Artificial Sequence
  Oligonucleotide
ggtaggccaggtttcagcatcgcagacaag

SEQ ID NO: 1886 - DNA, 30 bp, Artificial Sequence
  Oligonucleotide
agattgtgctaaggcttgagtgtgttgagc

SEQ ID NO: 1887 - DNA, 30 bp, Artificial Sequence
  Oligonucleotide
gaaatcagctctattgacgaattctgccgc

SEQ ID NO: 1888 - DNA, 30 bp, Artificial Sequence
  Oligonucleotide
ctccatctcagcttccccatgtggtgctgt

SEQ ID NO: 1889 - DNA, 30 bp, Artificial Sequence
  Oligonucleotide
ctccaagagaagcggaacaagcaaaactgc

SEQ ID NO: 1890 - DNA, 30 bp, Artificial Sequence
  Oligonucleotide
attagacccacatccggccaccaagacctc

SEQ ID NO: 1891 - DNA, 30 bp, Artificial Sequence
  Oligonucleotide
cctctggtacaccggcaacatcgagatctc

SEQ ID NO: 1892 - DNA, 30 bp, Artificial Sequence
  Oligonucleotide
acatgcctgtggtctcagctactcgggagg

SEQ ID NO: 1893 - DNA, 30 bp, Artificial Sequence
  Oligonucleotide
attgggaaaatgaggtacgttagtgttcgc

SEQ ID NO: 1894 - DNA, 30 bp, Artificial Sequence
  Oligonucleotide
ttcagattgggaaaatgaggtacgttagcg

SEQ ID NO: 1895 - DNA, 30 bp, Artificial Sequence
  Oligonucleotide
tgtgatatttcaatgatgcaataaaagacc

SEQ ID NO: 1896 - DNA, 30 bp, Artificial Sequence
  Oligonucleotide
tgggcaacaacagatatcagaaaacacttg

SEQ ID NO: 1897 - DNA, 30 bp, Artificial Sequence
  Oligonucleotide
gcagctccatgtaaaccatccaaaagacca

SEQ ID NO: 1898 - DNA, 30 bp, Artificial Sequence
  Oligonucleotide
gaagggagaaaactttggaggcagaagctc

SEQ ID NO: 1899 - DNA, 30 bp, Artificial Sequence
  Oligonucleotide
ggtgaggaaggcaagaaaagctggcaactt

SEQ ID NO: 1900 - DNA, 30 bp, Artificial Sequence
  Oligonucleotide
tggtaccttagatcacccctacagccatgc

SEQ ID NO: 1901 - DNA, 30 bp, Artificial Sequence
  Oligonucleotide
aagacctctgggactctatcaagcatacca

SEQ ID NO: 1902 - DNA, 30 bp, Artificial Sequence
  Oligonucleotide
ttctcaaaggtgaaattcctcagcacaggg

SEQ ID NO: 1903 - DNA, 30 bp, Artificial Sequence
  Oligonucleotide
ttcttaattggtttgcctgttctgcttctg

SEQ ID NO: 1904 - DNA, 30 bp, Artificial Sequence
  Oligonucleotide
cctgctgttgccacactcctcatggatgtc

SEQ ID NO: 1905 - DNA, 30 bp, Artificial Sequence
  Oligonucleotide
gcagatgcatacattaaccacagcccaggg

SEQ ID NO: 1906 - DNA, 30 bp, Artificial Sequence
  Oligonucleotide
tgtaaccccaaatgtgatgtgagaggacga

SEQ ID NO: 1907 - DNA, 30 bp, Artificial Sequence
  Oligonucleotide
tctcccaataaagctttacagccttctgca

SEQ ID NO: 1908 - DNA, 30 bp, Artificial Sequence
  Oligonucleotide
tggtgtctagcacattcctctaccttattt

SEQ ID NO: 1909 - DNA, 30 bp, Artificial Sequence
  Oligonucleotide
aagggccaagtgatcccgttctaagtgtca

SEQ ID NO: 1910 - DNA, 30 bp, Artificial Sequence
  Oligonucleotide
ttttctcctccttcgtttgttgggcttcat

SEQ ID NO: 1911 - DNA, 30 bp, Artificial Sequence
  Oligonucleotide
cgtctattctttatgccttgccctagccag

SEQ ID NO: 1912 - DNA, 30 bp, Artificial Sequence
  Oligonucleotide
cccctcctgtcctcctttgactgtttgact

SEQ ID NO: 1913 - DNA, 30 bp, Artificial Sequence
  Oligonucleotide
acagaaaacagcaaatagtccccagccctt

SEQ ID NO: 1914 - DNA, 30 bp, Artificial Sequence
  Oligonucleotide
caaggacaccaaggtacccaatgcctgttt

SEQ ID NO: 1915 - DNA, 30 bp, Artificial Sequence
  Oligonucleotide
ttttcgccctcccagacttcatcttcctgt

SEQ ID NO: 1916 - DNA, 30 bp, Artificial Sequence
  Oligonucleotide
tccaacacctgatccccaagattgaagatg

SEQ ID NO: 1917 - DNA, 30 bp, Artificial Sequence
  Oligonucleotide
gcaacctggagaaaattgttaacccaaagg

SEQ ID NO: 1918 - DNA, 30 bp, Artificial Sequence
  Oligonucleotide
ccacccaccagctcagaacctgtcactaat

SEQ ID NO: 1919 - DNA, 30 bp, Artificial Sequence; identical to SEQ ID NO: 1837
  Oligonucleotide

SEQ ID NO: 1920 - DNA, 30 bp, Artificial Sequence
  Oligonucleotide
cctttgggttgtgacttgggttgtctctga

SEQ ID NO: 1921 - DNA, 30 bp, Artificial Sequence
  Oligonucleotide
aactgcttctgtctgtccatacctccaggc

SEQ ID NO: 1922 - DNA, 30 bp, Artificial Sequence
  Oligonucleotide
gtcctggctttgtggtgtagtgctgtgtgt

SEQ ID NO: 1923 - DNA, 30 bp, Artificial Sequence
  Oligonucleotide
aactctcctgacgccaaaatcttctgcctg

SEQ ID NO: 1924 - DNA, 30 bp, Artificial Sequence
  Oligonucleotide
tttatgaagaggcttttctgtcgtcccagg

SEQ ID NO: 1925 - DNA, 30 bp, Artificial Sequence
  Oligonucleotide
tttcactctgctctggtactatgatcccaa

SEQ ID NO: 1926 - DNA, 30 bp, Artificial Sequence
  Oligonucleotide
gaagacaaagacccgcaaaagatgtatgcc

SEQ ID NO: 1927 - DNA, 30 bp, Artificial Sequence
  Oligonucleotide
gaacttcatccgcttctccaaatctctggg

SEQ ID NO: 1928 - DNA, 30 bp, Artificial Sequence
  Oligonucleotide
gctacttagagacgccccagccagaaaagg

SEQ ID NO: 1929 - DNA, 30 bp, Artificial Sequence
  Oligonucleotide
gcaggattagtcattggaaaagggggagaa

SEQ ID NO: 1930 - DNA, 30 bp, Artificial Sequence
  Oligonucleotide
aatcctttgagtgtatgccattggtgagcc

SEQ ID NO: 1931 - DNA, 30 bp, Artificial Sequence
  Oligonucleotide
cgtgagagctccaggactgaagccgcagag

SEQ ID NO: 1932 - DNA, 30 bp, Artificial Sequence
  Oligonucleotide
agttggtcttacagggtttgactgccgatg

SEQ ID NO: 1933 - DNA, 30 bp, Artificial Sequence
  Oligonucleotide
cattctcttctgtggtctctcccctggctt

SEQ ID NO: 1934 - DNA, 30 bp, Artificial Sequence
  Oligonucleotide
tcccgggacttctggtacttcgtatctcag

SEQ ID NO: 1935 - DNA, 30 bp, Artificial Sequence
  Oligonucleotide
tgcttctctctcttatggctgtgtccctgg

SEQ ID NO: 1936 - DNA, 30 bp, Artificial Sequence
  Oligonucleotide
ggactttggtgtgaatgaagacttggctga

SEQ ID NO: 1937 - DNA, 30 bp, Artificial Sequence
  Oligonucleotide
ctcaaaggtccccgtgttcactgttaccca

SEQ ID NO: 1938 - DNA, 30 bp, Artificial Sequence
  Oligonucleotide
tgacccattcctcctggcagagagtgatga

SEQ ID NO: 1939 - DNA, 30 bp, Artificial Sequence
  Oligonucleotide
cagccaactgtaccacggaaaactctgaag

SEQ ID NO: 1940 - DNA, 30 bp, Artificial Sequence
  Oligonucleotide
tggtggcattatcctttcaaaatctcaggg

SEQ ID NO: 1941 - DNA, 30 bp, Artificial Sequence
  Oligonucleotide
ttcaactaagctccaggctgctccacccaa

SEQ ID NO: 1942 - DNA, 30 bp, Artificial Sequence
  Oligonucleotide
tgtggagattggagtggctgacaagatttt

SEQ ID NO: 1943 - DNA, 30 bp, Artificial Sequence
  Oligonucleotide
atgtctcctttggacctcatgccggaaaat

SEQ ID NO: 1944 - DNA, 30 bp, Artificial Sequence
  Oligonucleotide
gcccttggatgaatgtgaggaactttatcg

SEQ ID NO: 1945 - DNA, 30 bp, Artificial Sequence
  Oligonucleotide
ccacaaccccaccatagcactaagaggaaa

SEQ ID NO: 1946 - DNA, 30 bp, Artificial Sequence
  Oligonucleotide
cagctcactggaacttttcatctgcttggc

SEQ ID NO: 1947 - DNA, 30 bp, Artificial Sequence
  Oligonucleotide
cagaatggctatgatgggcaaactaagccg

SEQ ID NO: 1948 - DNA, 30 bp, Artificial Sequence
  Oligonucleotide
ctgctgctgtggttggtgttaagtctcctg

SEQ ID NO: 1949 - DNA, 30 bp, Artificial Sequence
  Oligonucleotide
caaccccatcctcacacagattcacctttt

SEQ ID NO: 1950 - DNA, 30 bp, Artificial Sequence
  Oligonucleotide
ttctctggggctttattttcgttttgttgg

SEQ ID NO: 1951 - DNA, 30 bp, Artificial Sequence
  Oligonucleotide
atcttgatccgtcccatgtattccaaccct

SEQ ID NO: 1952 - DNA, 30 bp, Artificial Sequence
  Oligonucleotide
ggctggtcctcctatcgttcacagaaaatg

SEQ ID NO: 1953 - DNA, 30 bp, Artificial Sequence
  Oligonucleotide
tccaacaatcaaagctagacgtagcaggag

SEQ ID NO: 1954 - DNA, 30 bp, Artificial Sequence
  Oligonucleotide
ggtgatgaatctgctgctggaaggagaagt

SEQ ID NO: 1955 - DNA, 30 bp, Artificial Sequence
  Oligonucleotide
tgacgaatttcagcactgttggagcaagtt

SEQ ID NO: 1956 - DNA, 30 bp, Artificial Sequence
  Oligonucleotide
tcaaagctattcctcagctccagggctagc

SEQ ID NO: 1957 - DNA, 30 bp, Artificial Sequence
  Oligonucleotide
gccctgagagacctgctgaacaaccacatc

SEQ ID NO: 1958 - DNA, 30 bp, Artificial Sequence
  Oligonucleotide
gctgcctttctctgactctgtcttccccaa

SEQ ID NO: 1959 - DNA, 30 bp, Artificial Sequence
  Oligonucleotide
cagatgaacctgtagcagagtggaacttgt

SEQ ID NO: 1960 - DNA, 30 bp, Artificial Sequence
  Oligonucleotide
cagccatagtcaatcccacggtgttcttca

SEQ ID NO: 1961 - DNA, 30 bp, Artificial Sequence
  Oligonucleotide
cctactgaagatgtgcctcgaaagctgttg

SEQ ID NO: 1962 - DNA, 30 bp, Artificial Sequence
  Oligonucleotide
ccagaaaagcacctgctgctaaagtcccag

SEQ ID NO: 1963 - DNA, 30 bp, Artificial Sequence
  Oligonucleotide
cccaacctttattcccagccttactcttct

SEQ ID NO: 1964 - DNA, 30 bp, Artificial Sequence
  Oligonucleotide
tatctggatgaaggcttttggaggagaacc

SEQ ID NO: 1965 - DNA, 30 bp, Artificial Sequence
  Oligonucleotide
aaaacaactcaagcattctggtggcaacat

SEQ ID NO: 1966 - DNA, 30 bp, Artificial Sequence
  Oligonucleotide
agagttaaccccttatctgtaagttttgaa

SEQ ID NO: 1967 - DNA, 30 bp, Artificial Sequence
  Oligonucleotide
tgctggcctacttcatcacctgggtctcct

SEQ ID NO: 1968 - DNA, 30 bp, Artificial Sequence
  Oligonucleotide
cgacagatgtggcaccgatctttagccaga

SEQ ID NO: 1969 - DNA, 30 bp, Artificial Sequence
  Oligonucleotide
ctcacctgccatccaccttcaactacaacc

SEQ ID NO: 1970 - DNA, 30 bp, Artificial Sequence
  Oligonucleotide
tttggtcccgacaagatgacatagatttgc

SEQ ID NO: 1971 - DNA, 30 bp, Artificial Sequence
  Oligonucleotide
gatggccgccaccctcatgacatcatagat

SEQ ID NO: 1972 - DNA, 30 bp, Artificial Sequence
  Oligonucleotide
cccatctctgtctagcaagcagcctcctaa

SEQ ID NO: 1973 - DNA, 30 bp, Artificial Sequence
  Oligonucleotide
agttcccagctatctcccctgctcctctgc

SEQ ID NO: 1974 - DNA, 30 bp, Artificial Sequence
  Oligonucleotide
gccctcccctcactggaattcttcttgctc

SEQ ID NO: 1975 - DNA, 30 bp, Artificial Sequence
  Oligonucleotide
agtgcagaagttgggcagaaagggaggagg

SEQ ID NO: 1976 - DNA, 30 bp, Artificial Sequence
  Oligonucleotide
aaatcaccactcttcagccccatcccactc

SEQ ID NO: 1977 - DNA, 30 bp, Artificial Sequence
  Oligonucleotide
gctggatttgtttgttttcttgtctgtgtg

SEQ ID NO: 1978 - DNA, 30 bp, Artificial Sequence
  Oligonucleotide
atcatcctggagagcattcccactgacaac

SEQ ID NO: 1979 - DNA, 30 bp, Artificial Sequence
  Oligonucleotide
ttgtctcctactcctgactcctacctgccc

SEQ ID NO: 1980 - DNA, 30 bp, Artificial Sequence
  Oligonucleotide
aggcttgggtgcgttcaagattcagcttca

SEQ ID NO: 1981 - DNA, 30 bp, Artificial Sequence
  Oligonucleotide
gacctgccatttctccactccctacagaca

SEQ ID NO: 1982 - DNA, 30 bp, Artificial Sequence
  Oligonucleotide
cctcagcttttgcacacctccaatatattg

SEQ ID NO: 1983 - DNA, 30 bp, Artificial Sequence
  Oligonucleotide
cacagttttgggttcaggctatgctgcttt

SEQ ID NO: 1984 - DNA, 30 bp, Artificial Sequence
  Oligonucleotide
ttctggatttgtttggtttggtttggttcc

SEQ ID NO: 1985 - DNA, 30 bp, Artificial Sequence
  Oligonucleotide
tgttaggagcagggttgtgtgttggatttg

SEQ ID NO: 1986 - DNA, 30 bp, Artificial Sequence
  Oligonucleotide
acaccgagcgacatcaactcccctcgacac

SEQ ID NO: 1987 - DNA, 30 bp, Artificial Sequence
  Oligonucleotide
acgatgccaagatgactcctgaggactacg

SEQ ID NO: 1988 - DNA, 30 bp, Artificial Sequence
  Oligonucleotide
tcgcttacaaaactcacactctcacaatgc

SEQ ID NO: 1989 - DNA, 30 bp, Artificial Sequence
  Oligonucleotide
ctacccctttgtcaactgctgtgaatgctg

SEQ ID NO: 1990 - DNA, 30 bp, Artificial Sequence
  Oligonucleotide
cagggctatgacacagaggtagacgaggct

SEQ ID NO: 1991 - DNA, 30 bp, Artificial Sequence
  Oligonucleotide
cgctaccacttcctgatcctcctcttctcc

SEQ ID NO: 1992 - DNA, 30 bp, Artificial Sequence
  Oligonucleotide
cattaccgtctgtgattgccatttcttccc

SEQ ID NO: 1993 - DNA, 30 bp, Artificial Sequence
  Oligonucleotide
ggtccatcaggttaccccacagacacactt

SEQ ID NO: 1994 - DNA, 30 bp, Artificial Sequence
  Oligonucleotide
gtcggctcgggctgaaaaagtttctccatg

SEQ ID NO: 1995 - DNA, 30 bp, Artificial Sequence
  Oligonucleotide
tgcagtagaggtactcttctgtcccttccg

SEQ ID NO: 1996 - DNA, 30 bp, Artificial Sequence
  Oligonucleotide
cattcgggagttcctggaccagtacgatgc

SEQ ID NO: 1997 - DNA, 30 bp, Artificial Sequence
  Oligonucleotide
ctcggaagacaaaccccacacacactcaag

SEQ ID NO: 1998 - DNA, 30 bp, Artificial Sequence
  Oligonucleotide
actctcaaaattcaggatgcctcagccctc

SEQ ID NO: 1999 - DNA, 30 bp, Artificial Sequence
  Oligonucleotide
taccataaagagacgggtttgagggtttgc

SEQ ID NO: 2000 - DNA, 30 bp, Artificial Sequence
  Oligonucleotide
tgctcaaccaggatttcactcttcaaagcc

SEQ ID NO: 2001 - DNA, 30 bp, Artificial Sequence
  Oligonucleotide
gactctggaccctcgtgtctttctttagga

SEQ ID NO: 2002 - DNA, 30 bp, Artificial Sequence
  Oligonucleotide
gctccactttgaggctctgatgaacattcc

SEQ ID NO: 2003 - DNA, 30 bp, Artificial Sequence
  Oligonucleotide
atggtagtagagaagcaccgtgagtcccga

SEQ ID NO: 2004 - DNA, 30 bp, Artificial Sequence
  Oligonucleotide
ggatacatctcgccattacctgccactctc

SEQ ID NO: 2005 - DNA, 30 bp, Artificial Sequence
  Oligonucleotide
cctgcgagactcacaagatgggaagctgac

SEQ ID NO: 2006 - DNA, 30 bp, Artificial Sequence
  Oligonucleotide
cgtccggtcaataaaatccgcctgactcct

SEQ ID NO: 2007 - DNA, 30 bp, Artificial Sequence
  Oligonucleotide
agtgaagcacccctttattgtggaactggc

SEQ ID NO: 2008 - DNA, 30 bp, Artificial Sequence
  Oligonucleotide
catgaggttctgcccgtttgctgagaggac

SEQ ID NO: 2009 - DNA, 30 bp, Artificial Sequence
  Oligonucleotide
agggtggagaacgtggacctgacctctgtg

SEQ ID NO: 2010 - DNA, 30 bp, Artificial Sequence
  Oligonucleotide
tcttccccagtctccatatgcagctctctc

SEQ ID NO: 2011 - DNA, 30 bp, Artificial Sequence
  Oligonucleotide
acagcatcatcaaggacttcaccaagcaga

SEQ ID NO: 2012 - DNA, 30 bp, Artificial Sequence
  Oligonucleotide
caagtccagatccgcacgaaggtccaagtc

SEQ ID NO: 2013 - DNA, 30 bp, Artificial Sequence
  Oligonucleotide
agcatcttcccatttcctcagtacccacaa

SEQ ID NO: 2014 - DNA, 30 bp, Artificial Sequence
  Oligonucleotide
caatgccctaagccccaaggagttctatga

SEQ ID NO: 2015 - DNA, 30 bp, Artificial Sequence
  Oligonucleotide
cccttccacccctccagttagtccctatct

SEQ ID NO: 2016 - DNA, 30 bp, Artificial Sequence
  Oligonucleotide
gcaagagatcaacaagaagctgaacaccca

SEQ ID NO: 2017 - DNA, 30 bp, Artificial Sequence
  Oligonucleotide
ccccacacaccgatttctgagtagcgatag

SEQ ID NO: 2018 - DNA, 30 bp, Artificial Sequence
  Oligonucleotide
tgactggatgttctcagccccttgttctgg

SEQ ID NO: 2019 - DNA, 30 bp, Artificial Sequence
  Oligonucleotide
gtgatgaagccccaggagtcgggaagcagt

SEQ ID NO: 2020 - DNA, 30 bp, Artificial Sequence
  Oligonucleotide
gtggtggaagagttgaagaagtacctgtcg

SEQ ID NO: 2021 - DNA, 30 bp, Artificial Sequence
  Artificial Sequence
accattgtcttgttctgtgatgaggggagg

SEQ ID NO: 2022 - DNA, 30 bp, Artificial Sequence
  Oligonucleotide
aaaagcccattaacgagaaagtgcctgccc

SEQ ID NO: 2023 - DNA, 30 bp, Artificial Sequence
  Oligonucleotide
cagagagatcaacaagcaacccacccgagg

SEQ ID NO: 2024 - DNA, 30 bp, Artificial Sequence
  Oligonucleotide
ccacaactacatggtgttcggatctttgga

SEQ ID NO: 2025 - DNA, 30 bp, Artificial Sequence; identical to SEQ ID NO: 1638
  Oligonucleotide

SEQ ID NO: 2026 - DNA, 30 bp, Artificial Sequence
  Oligonucleotide
tcaacaaggcttccactaacatgctgagga

SEQ ID NO: 2027 - DNA, 30 bp, Artificial Sequence
  Oligonucleotide
ccatttgtcagggttgtgtctccagtcctc

SEQ ID NO: 2028 - DNA, 30 bp, Artificial Sequence
  Oligonucleotide
gaagcctcggactacattcctgacgaccac

SEQ ID NO: 2029 - DNA, 30 bp, Artificial Sequence
  Oligonucleotide
cacatctgaagacctgctatcccctggagt

SEQ ID NO: 2030 - DNA, 30 bp, Artificial Sequence
  Oligonucleotide
cgcctgctccaaaagttcagaggactcaaa

SEQ ID NO: 2031 - DNA, 30 bp, Artificial Sequence
  Oligonucleotide
gctctaaccaggctcatttgctctctccac

SEQ ID NO: 2032 - DNA, 30 bp, Artificial Sequence
  Oligonucleotide
ttggatcatttagatctcttgcatcctttg

SEQ ID NO: 2033 - DNA, 30 bp, Artificial Sequence
  Oligonucleotide
agaagtatgaggaaaaggagaagacggggc

SEQ ID NO: 2034 - DNA, 30 bp, Artificial Sequence
  Oligonucleotide
attcagcactgtgttcctgttgtcgtggtt

SEQ ID NO: 2035 - DNA, 30 bp, Artificial Sequence
  Oligonucleotide
agatgctccccttgtgccagatgatacctc

SEQ ID NO: 2036 - DNA, 30 bp, Artificial Sequence
  Oligonucleotide
tatccagtggcacttgtaatggcgtcttca

SEQ ID NO: 2037 - DNA, 30 bp, Artificial Sequence
  Oligonucleotide
gattggtctctggcccagcccagtctcttc

SEQ ID NO: 2038 - DNA, 30 bp, Artificial Sequence
  Oligonucleotide
gttgtcctttctggcttccctgatggtgtc

SEQ ID NO: 2039 - DNA, 30 bp, Artificial Sequence
  Oligonucleotide
gtctgtggatgcaactgttaatgaagatgg

SEQ ID NO: 2040 - DNA, 30 bp, Artificial Sequence
  Oligonucleotide
ttgctatcaatacccttgtcctcctggtcc

SEQ ID NO: 2041 - DNA, 30 bp, Artificial Sequence
  Oligonucleotide
tgctggggatgactttgacttaggagatgc

SEQ ID NO: 2042 - DNA, 30 bp, Artificial Sequence
  Oligonucleotide
tggcaaggcctttaagcgctcctctatcct

SEQ ID NO: 2043 - DNA, 30 bp, Artificial Sequence
  Oligonucleotide
gttctccttgggtgacccccatgatgcctg

SEQ ID NO: 2044 - DNA, 30 bp, Artificial Sequence
  Oligonucleotide
atttcgctccctccattgtctgctctatcc

SEQ ID NO: 2045 - DNA, 30 bp, Artificial Sequence
  Oligonucleotide
gccaagttcctttgttcagtattccgtggg

SEQ ID NO: 2046 - DNA, 30 bp, Artificial Sequence
  Oligonucleotide
acaagatggacagggatgataattgggcct

SEQ ID NO: 2047 - DNA, 30 bp, Artificial Sequence
  Oligonucleotide
gctatggttgacttcttgcttgtgcttccc

SEQ ID NO: 2048 - DNA, 30 bp, Artificial Sequence
  Oligonucleotide
tggtgggcaaaccaagctgattttccagaa

SEQ ID NO: 2049 - DNA, 30 bp, Artificial Sequence
  Oligonucleotide
tcactatctgaagggtcacggagcgcaaaa

SEQ ID NO: 2050 - DNA, 30 bp, Artificial Sequence
  Oligonucleotide
tggggtcatcttactcttgctgattggaca

SEQ ID NO: 2051 - DNA, 30 bp, Artificial Sequence
  Oligonucleotide
cttccctcccaccctgtctcctgtctccat

SEQ ID NO: 2052 - DNA, 30 bp, Artificial Sequence
  Oligonucleotide
tccgcaacgactactatcctgacctccaca

SEQ ID NO: 2053 - DNA, 30 bp, Artificial Sequence
  Oligonucleotide
cttcccagcatctttggctgcacagcattt

SEQ ID NO: 2054 - DNA, 30 bp, Artificial Sequence
  Oligonucleotide
tatgcctacttgctccagccctctcagttc

SEQ ID NO: 2055 - DNA, 30 bp, Artificial Sequence
  Oligonucleotide
tgctgtctctgctttttgcatcttgcccag

SEQ ID NO: 2056 - DNA, 30 bp, Artificial Sequence
  Oligonucleotide
atcgggctactacaaagttctgggaaaggg

SEQ ID NO: 2057 - DNA, 30 bp, Artificial Sequence
  Oligonucleotide
agactcgtgcccccattagtgtgcctcttt

SEQ ID NO: 2058 - DNA, 30 bp, Artificial Sequence
  Oligonucleotide
acaggagcaaaagtcgggacagagaacaag

SEQ ID NO: 2059 - DNA, 30 bp, Artificial Sequence
  Oligonucleotide
tccgctacctgaccttcttccacaactaca

SEQ ID NO: 2060 - DNA, 30 bp, Artificial Sequence
  Oligonucleotide
tgcttgaccgtttgggacatcaatcttcca

SEQ ID NO: 2061 - DNA, 30 bp, Artificial Sequence
  Oligonucleotide
ttttccacccgtctttggtatgtattggct

SEQ ID NO: 2062 - DNA, 30 bp, Artificial Sequence
  Oligonucleotide
aggtttgggcttctgttcctttcacttgca

SEQ ID NO: 2063 - DNA, 30 bp, Artificial Sequence
  Oligonucleotide
gtctcacagcaagattcacaagcgatccga

SEQ ID NO: 2064 - DNA, 30 bp, Artificial Sequence
  Oligonucleotide
ccagaaccctgctgatgagcccactctagg

SEQ ID NO: 2065 - DNA, 30 bp, Artificial Sequence
  Oligonucleotide
ggcgctgaacaagaaatccaaacagatcgg

SEQ ID NO: 2066 - DNA, 30 bp, Artificial Sequence
  Oligonucleotide
cctggtgaagatgtggatgataatggtgcc

SEQ ID NO: 2067 - DNA, 30 bp, Artificial Sequence
  Oligonucleotide
tgcgggactcactggatagatgttattcaa

SEQ ID NO: 2068 - DNA, 30 bp, Artificial Sequence
  Oligonucleotide
caggaatctgccacttcttttatgacagcg

SEQ ID NO: 2069 - DNA, 30 bp, Artificial Sequence
  Oligonucleotide
cgcctttggacctcatgctggaaaattcat

SEQ ID NO: 2070 - DNA, 30 bp, Artificial Sequence
  Oligonucleotide
ggagagcctcattttccacttaacgcaatt

SEQ ID NO: 2071 - DNA, 30 bp, Artificial Sequence
  Oligonucleotide
ccgccctagaacttttgccagtgccttttc

SEQ ID NO: 2072 - DNA, 30 bp, Artificial Sequence
  Oligonucleotide
tattgcttgcctcctgcctgttcacaaatc

SEQ ID NO: 2073 - DNA, 30 bp, Artificial Sequence
  Oligonucleotide
actgaaaagaaagcgttgccctggtgattc

SEQ ID NO: 2074 - DNA, 30 bp, Artificial Sequence
  Oligonucleotide
ctacagacaaggtggagcgaatcaaggagc

SEQ ID NO: 2075 - DNA, 30 bp, Artificial Sequence
  Oligonucleotide
gctggagcagccgatgcagctgtacagtgc

SEQ ID NO: 2076 - DNA, 30 bp, Artificial Sequence
  Oligonucleotide
ggacagcagcaaagctataatccccctcag

SEQ ID NO: 2077 - DNA, 30 bp, Artificial Sequence
  Oligonucleotide
agagttttcctgttcagattaccctgccca

SEQ ID NO: 2078 - DNA, 30 bp, Artificial Sequence
  Oligonucleotide
tgccagaaacccttaagaaaaagcaaagga

SEQ ID NO: 2079 - DNA, 30 bp, Artificial Sequence
  Oligonucleotide
ctctgactggctggattctacacttggctg

SEQ ID NO: 2080 - DNA, 30 bp, Artificial Sequence
  Oligonucleotide
tattggaaagaagactcccatcgcagttcg

SEQ ID NO: 2081 - DNA, 30 bp, Artificial Sequence
  Oligonucleotide
gagacgaaactcatctgcctctgtccctct

SEQ ID NO: 2082 - DNA, 30 bp, Artificial Sequence
  Oligonucleotide
tactgaggccttcatagccactgcacccca

SEQ ID NO: 2083 - DNA, 30 bp, Artificial Sequence
  Oligonucleotide
tctgtcaggtgcacaagattaccctccttt

SEQ ID NO: 2084 - DNA, 30 bp, Artificial Sequence
  Oligonucleotide
tgctccaaaactccctctgctgatactcct

SEQ ID NO: 2085 - DNA, 30 bp, Artificial Sequence
  Oligonucleotide
agtcacagccatcctcataatacacaagcg

SEQ ID NO: 2086 - DNA, 30 bp, Artificial Sequence
  Oligonucleotide
tctcccatttagccttaaccccctcttacg

SEQ ID NO: 2087 - DNA, 30 bp, Artificial Sequence
  Oligonucleotide
gcctaagttcctcctgttttctgctgtttg

SEQ ID NO: 2088 - DNA, 30 bp, Artificial Sequence
  Oligonucleotide
gtggcggtggttaggagatcagacactagc

SEQ ID NO: 2089 - DNA, 30 bp, Artificial Sequence
  Oligonucleotide
tgaccgtaattcttgacttcaggctcctcc

SEQ ID NO: 2090 - DNA, 30 bp, Artificial Sequence
  Oligonucleotide
ggctgaatcttctccatttgttgagcgact

SEQ ID NO: 2091 - DNA, 30 bp, Artificial Sequence
  Oligonucleotide
gccctataatttcaaagcccaaacccaaag

SEQ ID NO: 2092 - DNA, 30 bp, Artificial Sequence
  Oligonucleotide
cgccaggaaggtgagatcttcgacacagaa

SEQ ID NO: 2093 - DNA, 30 bp, Artificial Sequence
  Oligonucleotide
agccgctccactttctccacataggcctgt

SEQ ID NO: 2094 - DNA, 30 bp, Artificial Sequence
  Oligonucleotide
cgcacccaccctgttctctacctcttctat

SEQ ID NO: 2095 - DNA, 30 bp, Artificial Sequence
  Oligonucleotide
ccccaccattctacagagttgtactcaaga

SEQ ID NO: 2096 - DNA, 30 bp, Artificial Sequence
  Oligonucleotide
cctcaagtctctctccctctgctcctgcca

SEQ ID NO: 2097 - DNA, 30 bp, Artificial Sequence
  Oligonucleotide
cctgtgatgaccaatactgctgctctgacg

SEQ ID NO: 2098 - DNA, 30 bp, Artificial Sequence
  Oligonucleotide
cggcggagagccgagtgatgaataaatgag

SEQ ID NO: 2099 - DNA, 30 bp, Artificial Sequence; identical to SEQ ID NO: 2098
  Oligonucleotide

SEQ ID NO: 2100 - DNA, 30 bp, Artificial Sequence
  Oligonucleotide
gaccaccctcatttcccagcttcctcgaag

SEQ ID NO: 2101 - DNA, 30 bp, Artificial Sequence
  Oligonucleotide
tgggtttaggaaggatttctctaacactga

SEQ ID NO: 2102 - DNA, 30 bp, Artificial Sequence
  Oligonucleotide
gttcgttctgctctggagacccctgggttg

SEQ ID NO: 2103 - DNA, 30 bp, Artificial Sequence
  Oligonucleotide
tatcaggcttcttcacctcgcactgtcccc

SEQ ID NO: 2104 - DNA, 30 bp, Artificial Sequence
  Oligonucleotide
tttgttcacacagtctctccagctcccgca

SEQ ID NO: 2105 - DNA, 30 bp, Artificial Sequence
  Oligonucleotide
tgggaggagataagaagagaaagggccaag

SEQ ID NO: 2106 - DNA, 30 bp, Artificial Sequence
  Oligonucleotide
caccctgggtagtcgtggacagaagcttgg

SEQ ID NO: 2107 - DNA, 30 bp, Artificial Sequence
  Oligonucleotide
ctcctctccctcccactgcacactcccact

SEQ ID NO: 2108 - DNA, 30 bp, Artificial Sequence
  Oligonucleotide
gcccactatgcacacatcttcccctccaag

SEQ ID NO: 2109 - DNA, 30 bp, Artificial Sequence
  Oligonucleotide
gccttttgtctgtacatactggcctccgtg

SEQ ID NO: 2110 - DNA, 30 bp, Artificial Sequence
  Oligonucleotide
tggaaggagataagagaaagggccaagtga

SEQ ID NO: 2111 - DNA, 30 bp, Artificial Sequence
  Oligonucleotide
accacctccaccctggaagagttccccttc

SEQ ID NO: 2112 - DNA, 30 bp, Artificial Sequence
  Oligonucleotide
tatctcctattctggattagtgccttttgg

SEQ ID NO: 2113 - DNA, 30 bp, Artificial Sequence
  Oligonucleotide
cccatactctcccttatccccatacccaga

SEQ ID NO: 2114 - DNA, 30 bp, Artificial Sequence
  Oligonucleotide
cttcccccagtatcgcacatggttctagtt

SEQ ID NO: 2115 - DNA, 30 bp, Artificial Sequence
  Oligonucleotide
ttacccgcatccttgtgtcaccaggtcctc

SEQ ID NO: 2116 - DNA, 30 bp, Artificial Sequence
  Oligonucleotide
ggactcacactggatagaaaccaaagcagg

SEQ ID NO: 2117 - DNA, 30 bp, Artificial Sequence
  Oligonucleotide
gcagaggtgctcctcacttgccacacaggg

SEQ ID NO: 2118 - DNA, 30 bp, Artificial Sequence
  Oligonucleotide
agcaggactgaacttcaactcacgcctttg

SEQ ID NO: 2119 - DNA, 30 bp, Artificial Sequence
  Oligonucleotide
gcctcctagagcctctggtaagacttctgg

SEQ ID NO: 2120 - DNA, 30 bp, Artificial Sequence
  Oligonucleotide
ctcacctgttgtcactccctcctgctccct

SEQ ID NO: 2121 - DNA, 30 bp, Artificial Sequence
  Oligonucleotide
gggtcctgtctgctctgtgagtccctccaa

SEQ ID NO: 2122 - DNA, 30 bp, Artificial Sequence
  Oligonucleotide
cgtgcagagcaaaaagagcttcctatggga